(19) United States
(12) Patent Application Publication
(10) Pub. No.: US 2013/0346302 A1
(43) Pub. Date: Dec. 26, 2013

(54) Remote Portal Bill Payment Platform Apparatuses, Methods and Systems

(71) Applicant: VISA INTERNATIONAL SERVICE ASSOCIATION, San Francisco, CA (US)

(72) Inventors: Thomas Purves, San Francisco, CA (US); Zubin Vandrevala, Foster City, CA (US); Tamara Romanek, Foster City, CA (US); James Kim, Foster City, CA (US)

(21) Appl. No.: 13/923,113

(22) Filed: Jun. 20, 2013

Related U.S. Application Data
(60) Provisional application No. 61/661,887, filed on Jun. 20, 2012.

(51) Int. Cl. G06Q 20/10; G06Q 20/08

(52) U.S. Cl. CPC G06Q 20/102; G06Q 20/085
USPC 705/40

(57) ABSTRACT

The REMOTE PORTAL BILL PAYMENT PLATFORM APPARATUSES, METHODS AND SYSTEMS (“Bill Pay”) transforms user bill payment request message via Bill Pay components into transaction bill payment transaction settlements, and/or the like and use of the Bill Pay. In one implementation, a method is disclosed, comprising: obtaining a bill payment transaction request from a bill payment component instantiated within a hosting portal site, said bill payment component being operated independent of a billing party, said bill payment transaction request includes bill information of a bill issued by the biller and payer identifying information; determining a type of the bill payment component; verifying the obtained bill information including a payment amount based on the type of the bill payment component; retrieving payer account information based on the obtained payer identifying information; and transferring an approved amount of funds to the biller's account from the payer account.

### METHODS AND SYSTEMS

This application for letters patent disclosure document describes inventive aspects directed at various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### PRIORITY CLAIM

Applicant hereby claims priority under 35 USC §119 to provisional US patent application Ser. No. 61/661,887, filed Jun. 20, 2012, entitled “REMOTE PORTAL BILL PAYMENT PLATFORM APPARATUSES, METHODS AND SYSTEMS,” attorney docket no. 96US01|VISA-148/00US.

The entire contents of the aforementioned application are herein expressly incorporated by reference.

### FIELD

The present innovations are directed generally to electronic payment platforms, and more particularly, to REMOTE PORTAL BILL PAYMENT PLATFORM APPARATUSES, METHODS AND SYSTEMS.

### BACKGROUND

Consumers may have the need to pay bills for their life expenses. For example, a consumer may receive a printed paper bill (e.g., medical service bills, house utility bills, Internet/cable service bills, etc.) in mail from a service provider at his home address. The consumer may then review the paper bill, and upon agreement to pay, he may write a paper check payable to the service provider, and send the check to the service provider. Upon receiving the check payment, the service provider may deposit the check, and obtain an amount indicated on the original paper bill deposited into the bank account of the service provider.

### BRIEF DESCRIPTION OF THE DRAWINGS

The accompanying appendices and/or drawings illustrate various non-limiting, example, innovative aspects in accordance with the present descriptions:

FIGS. 1A-1D provide exemplary block diagrams illustrating aspects of multi-portal bill payment in one embodiment of the Bill-Pay operation;

FIGS. 2A-2G are data flow diagrams illustrating aspects of data message exchange between the Bill-Pay platform and its affiliated entities within one embodiment of the Bill-Pay;

FIGS. 3A-3D are of logic flow diagrams illustrating aspects of payment process for some embodiments of the Bill-Pay;

FIGS. 4A-4F show application user interface diagrams illustrating example features of a web based Bill-Pay portal in some embodiments of the Bill-Pay;

FIGS. 5A-5C show application user interface diagrams illustrating user enrollment in some embodiments of the Bill-Pay;

FIGS. 6A-6B show application user interface diagrams illustrating example features of a mobile Bill-Pay portal in some embodiments of the Bill-Pay;

FIG. 7 shows a user interface diagram illustrating an overview of example features of virtual wallet applications in some embodiments of the Bill Pay;

FIGS. 8A-G show user interface diagrams illustrating example features of virtual wallet applications in a shopping mode, in some embodiments of the Bill Pay;

FIGS. 9A-F show user interface diagrams illustrating example features of virtual wallet applications in a payment mode, in some embodiments of the Bill Pay;

FIG. 10 shows a user interface diagram illustrating example features of virtual wallet applications, in a history mode, in some embodiments of the Bill Pay;

FIGS. 11A-E show user interface diagrams illustrating example features of virtual wallet applications in a snap mode, in some embodiments of the Bill Pay;

FIG. 12 shows a user interface diagram illustrating example features of virtual wallet applications, in an offers mode, in some embodiments of the Bill Pay;

FIGS. 13A-B show user interface diagrams illustrating example features of virtual wallet applications, in a security and privacy mode, in some embodiments of the Bill Pay;

FIG. 14 shows a data flow diagram illustrating an example user purchase checkout procedure in some embodiments of the Bill Pay;

FIG. 15 shows a logic flow diagram illustrating example aspects of a user purchase checkout in some embodiments of the Bill Pay, e.g., a User Purchase Checkout (“UPC”) component 1500;

FIGS. 16A-B show data flow diagrams illustrating an example purchase transaction authorization procedure in some embodiments of the Bill Pay;

FIGS. 17A-B show logic flow diagrams illustrating example aspects of purchase transaction authorization in some embodiments of the Bill Pay, e.g., a Purchase Transaction Authorization (“PTA”) component 1700;

FIGS. 18A-B show data flow diagrams illustrating an example purchase transaction clearance procedure in some embodiments of the Bill Pay;

FIGS. 19A-B show logic flow diagrams illustrating example aspects of purchase transaction clearance in some embodiments of the Bill Pay, e.g., a Purchase Transaction Clearance (“PTC”) component 1900;

FIG. 20 shows a block diagram illustrating an example aspect of using Bill-Pay at checkout in some embodiments of the Bill Pay;

FIG. 21 shows a data flow diagram illustrating further examples of a of a user purchase checkout in some embodiments of the Bill Pay;

FIGS. 22A-B show logic flow diagrams illustrating further examples of examples of a user purchase checkout in some embodiments of the Bill Pay;

FIGS. 23-24 show screenshot diagrams illustrating example checkout settings in some embodiments of the Bill Pay;

FIG. 25 shows a block diagram illustrating example remote checkout from issuer in some embodiments of the Bill Pay;

FIG. 101 shows a block diagram illustrating an example social wallet integration, in some embodiments of the Bill Pay;

FIG. 102 shows a data flow illustrating an example social wallet widget integration, in some embodiments of the Bill Pay;

FIG. 103 shows a logic flow illustrating an example widget designer building component, e.g., a BWD Component 10300, in some embodiments of the Bill Pay;

FIGS. 104A-B show a logic flow illustrating an example social widget assembly and population component, e.g., a PSW Component 10400, in some embodiments of the Bill Pay;

FIG. 105 shows a data flow illustrating an example social wallet widget checkout, in some embodiments of the Bill Pay;

FIG. 106 shows a logic flow illustrating an example store application view rendering component, e.g., a RSAV Component 10600, in some embodiments of the Bill Pay;

FIG. 107 shows an example user interface illustrating overloaded social checkout widget creation and integration, in some embodiments of the Bill Pay;

FIG. 108A shows a block diagram illustrating example digital marketing value chain, in some embodiments of the Bill Pay;

FIG. 108B shows a block diagram illustrating example e-commerce and content integration with wallet, in some embodiments of the Bill Pay;

FIG. 109A shows user interfaces illustrating example integration of checkout widget in social media (e.g., FACEBOOK), in some embodiments of the Bill Pay;

FIGS. 109B-C shows user interfaces illustrating example widget checkout in social media (e.g., FACEBOOK), in some embodiments of the Bill Pay;

FIG. 109D shows a screenshot diagram illustrating example integration of checkout widget in social media (e.g., TWITTER), in some embodiments of the Bill Pay;

FIG. 109E shows a screenshot diagram illustrating example widget checkout in social media (e.g., TWITTER), in some embodiments of the Bill Pay;

FIG. 1010A shows user interfaces illustrating example integration of checkout widget in web/mobile channels, in some embodiments of the Bill Pay;

FIG. 1010B shows user interfaces illustrating example widget checkout in web/mobile channels, in some embodiments of the Bill Pay;

FIG. 1011A shows user interfaces illustrating example integration of checkout widget in a mobile application, in some embodiments of the Bill Pay;

FIG. 1011B shows user interfaces illustrating example widget checkout in a mobile application, in some embodiments of the Bill Pay;

FIG. 1012A shows user interfaces illustrating example integration of checkout widget in a digital catalog, in some embodiments of the Bill Pay;

FIG. 1012B shows user interfaces illustrating example widget checkout in a digital catalog, in some embodiments of the Bill Pay;

FIG. 1012C shows user interfaces illustrating example augmented retail checkout, in some embodiments of the Bill Pay;

FIG. 1013A shows a screenshot diagram illustrating example integration of checkout widget in a content site, in some embodiments of the Bill Pay;

FIG. 1013B shows a screenshot diagram illustrating example widget checkout in a content site, in some embodiments of the Bill Pay;

FIG. 1013C shows diagrams illustrating example checkout widget branding options, in some embodiments of the Bill Pay;

FIG. 1014 shows a logic flow diagram illustrating example widget integration and checkout, in some embodiments of the Bill Pay;

FIG. 1015 shows a block diagram illustrating example checkouts, in some embodiments of the Bill Pay;

FIG. 1016 shows a data flow diagram illustrating dynamic widget generation, in some embodiments of the Bill Pay;

FIG. 1017 shows a logic flow diagram illustrating dynamic widget generation component, in some embodiments of the Bill Pay;

FIG. 1018 shows a data flow diagram illustrating dynamically generated widget purchase, in some embodiments of the Bill Pay;

FIGS. 1019a-c show logic flow diagrams illustrating dynamically generated widget purchase, in some embodiments of the Bill Pay;

FIGS. 1020a-c show screen shots illustrating example widget customization using test tools, in some embodiments of the Bill Pay;

FIGS. 1021a-d show user interfaces illustrating example widget code generator with integrated testing, in some embodiments of the Bill Pay;

FIGS. 1022a-b shows a logic flow diagram illustrating a widget code generator with dynamic content retrieval component, in some embodiments of the Bill Pay;

FIG. 201 shows a block diagram illustrating example service connections in some embodiments of the Bill Pay;

FIG. 202 shows a block diagram illustrating example Bill Pay architecture in some embodiments of the Bill Pay;

FIG. 203 shows a screen shot illustrating example account creation in some embodiments of the Bill Pay;

FIG. 204 shows a screen shot illustrating example merchant account login in some embodiments of the Bill Pay;

FIG. 205 shows a screen shot illustrating example account preference management in some embodiments of the Bill Pay;

FIG. 206 shows a screen shot illustrating an example cross-channel implementation of some embodiments of the Bill Pay;

FIGS. 207a-b show user interfaces illustrating example sign-in and account management in some embodiments of the Bill Pay;

FIGS. 208a-b show user interfaces illustrating example sign-in and checkout in some embodiments of the Bill Pay;

FIGS. 209a-b show data flow diagrams illustrating example bi-directional federation in some embodiments of the Bill Pay;

FIG. 2010 shows a logic flow diagram illustrating an example account creation and management in some embodiments of the Bill Pay;

FIG. 2011 shows a block diagram illustrating an example prepaid card personalization in some embodiments of the Bill Pay;

FIG. 2012 shows a user interface illustrating an example Bill Pay settings control panel in some embodiments of the Bill Pay;

FIG. 2012a is an example user interface illustrating a wallet account interface after the enrollment of new payment account(s).

FIG. 2013a-i show example user interfaces in some embodiments of the Bill Pay.

FIG. 2014 shows a screenshot illustrating an example checkout containing current transactions and a contract for future transactions.

FIG. 2014a is a screenshot illustrating an example login form for accessing a Bill Pay account and optionally creating a virtual wallet account.

FIG. 2014b is a screenshot illustrating the creation of an account with a merchant and, optionally, creating a virtual wallet account.

FIG. 2015 shows a screenshot illustrating an example reference transaction enrollment.

FIG. 2016 shows a user interface illustrating an example embodiment of a reference transaction management console.

FIG. 2017 shows a block diagram depicting example reference failover transaction behavior.

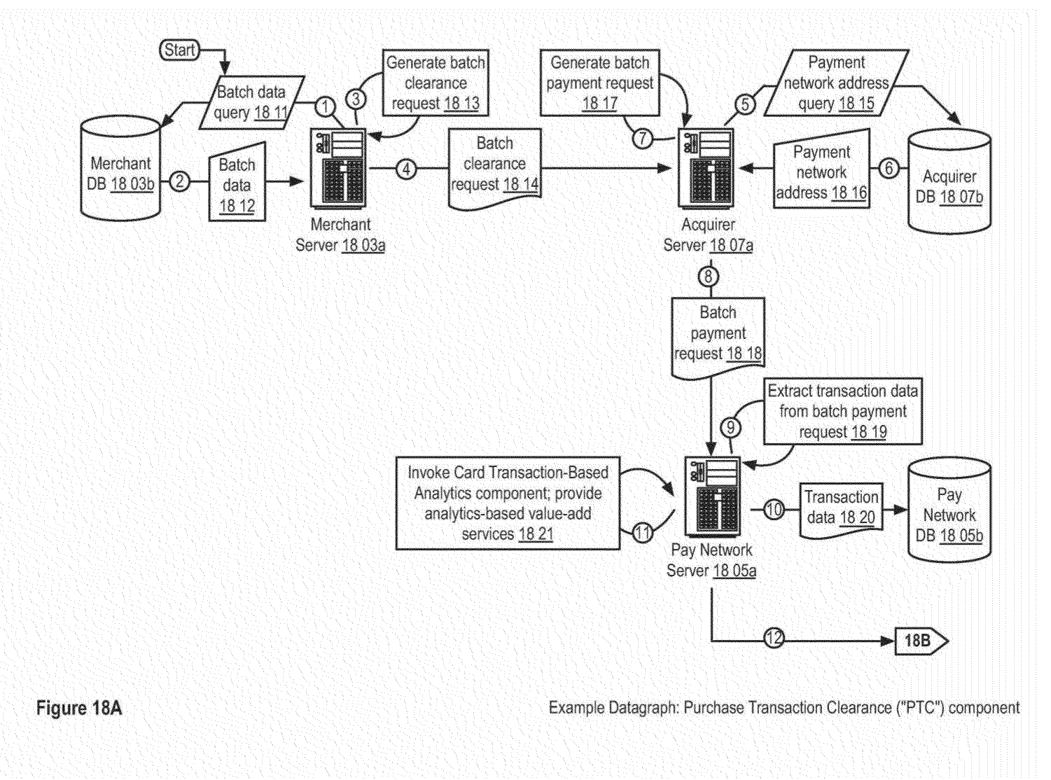

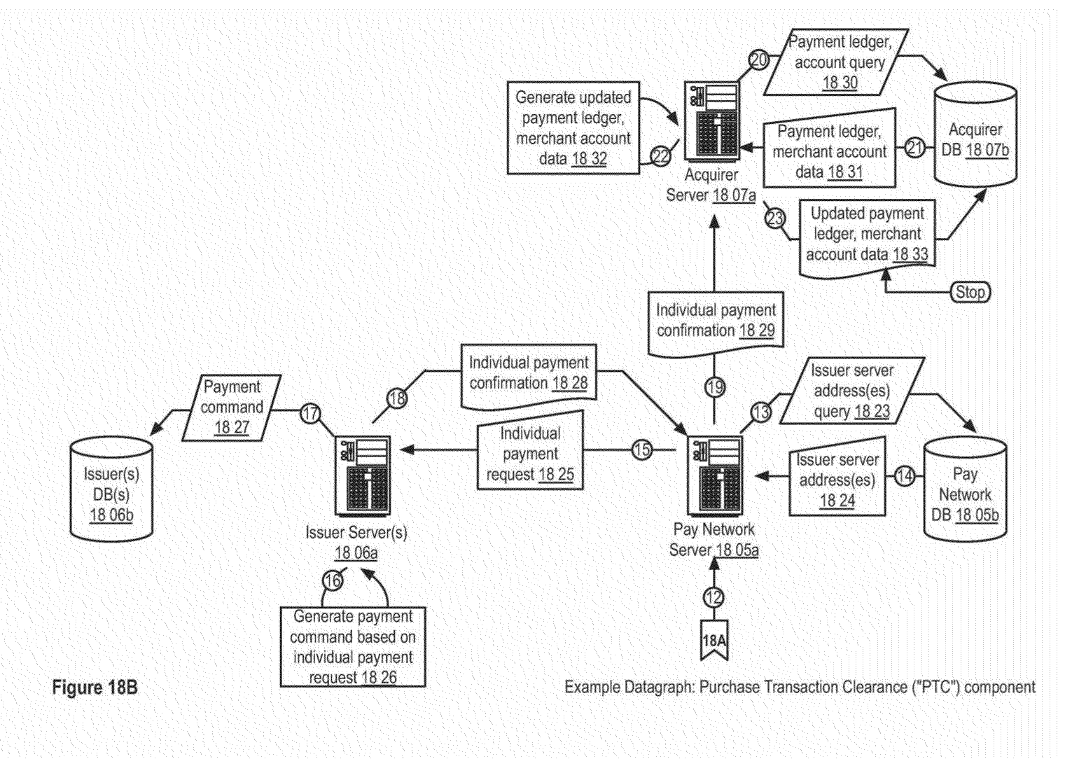

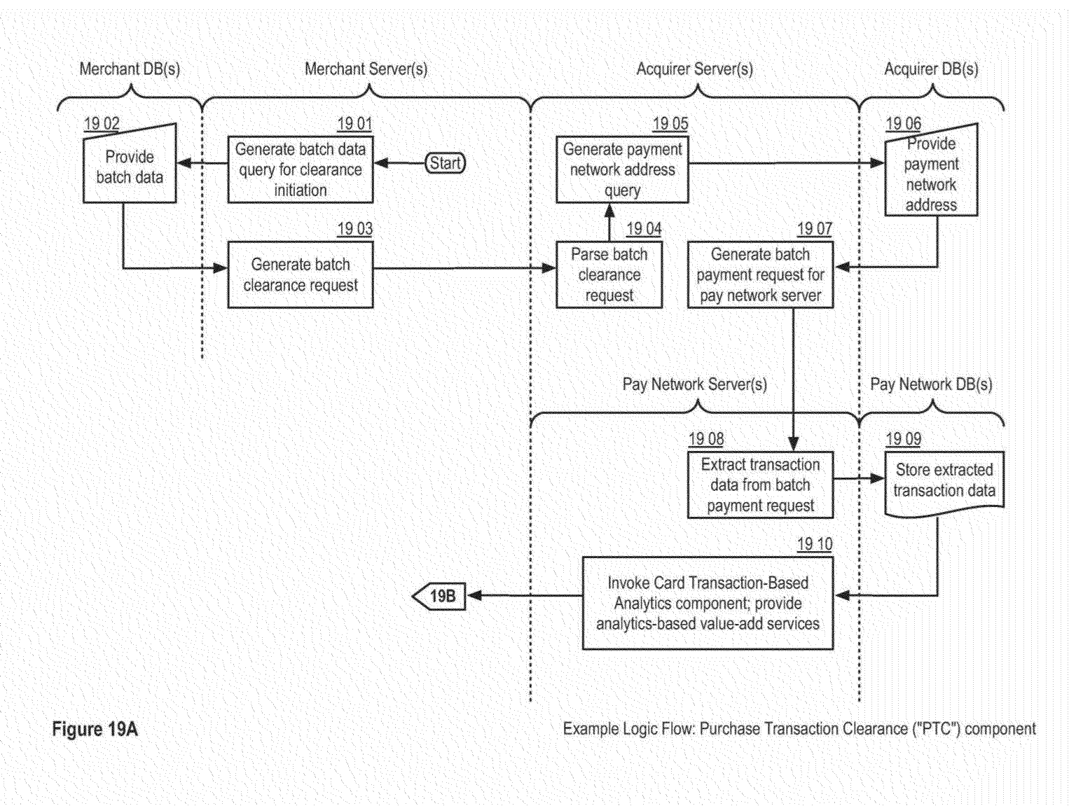

FIGS. 2018-18a shows a logic flow diagram illustrating a reference transaction link creation.

FIG. 2019 shows a user interface illustrating an example embodiment of an issuer web site containing virtual wallet enrollment elements.

FIGS. 2020a-d show a user interface illustrating an example embodiment of a wallet service enrollment interface.

FIG. 2021 shows an example wallet service enrollment data flow.

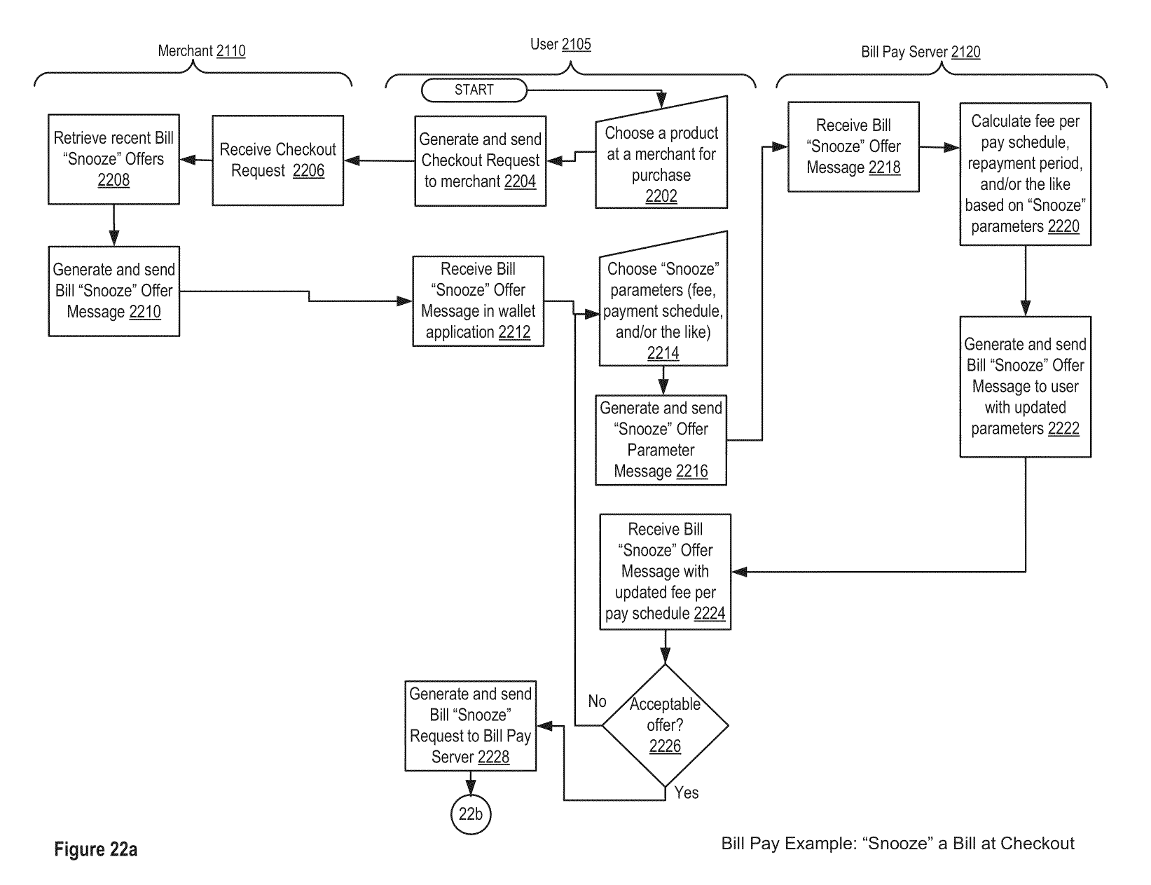

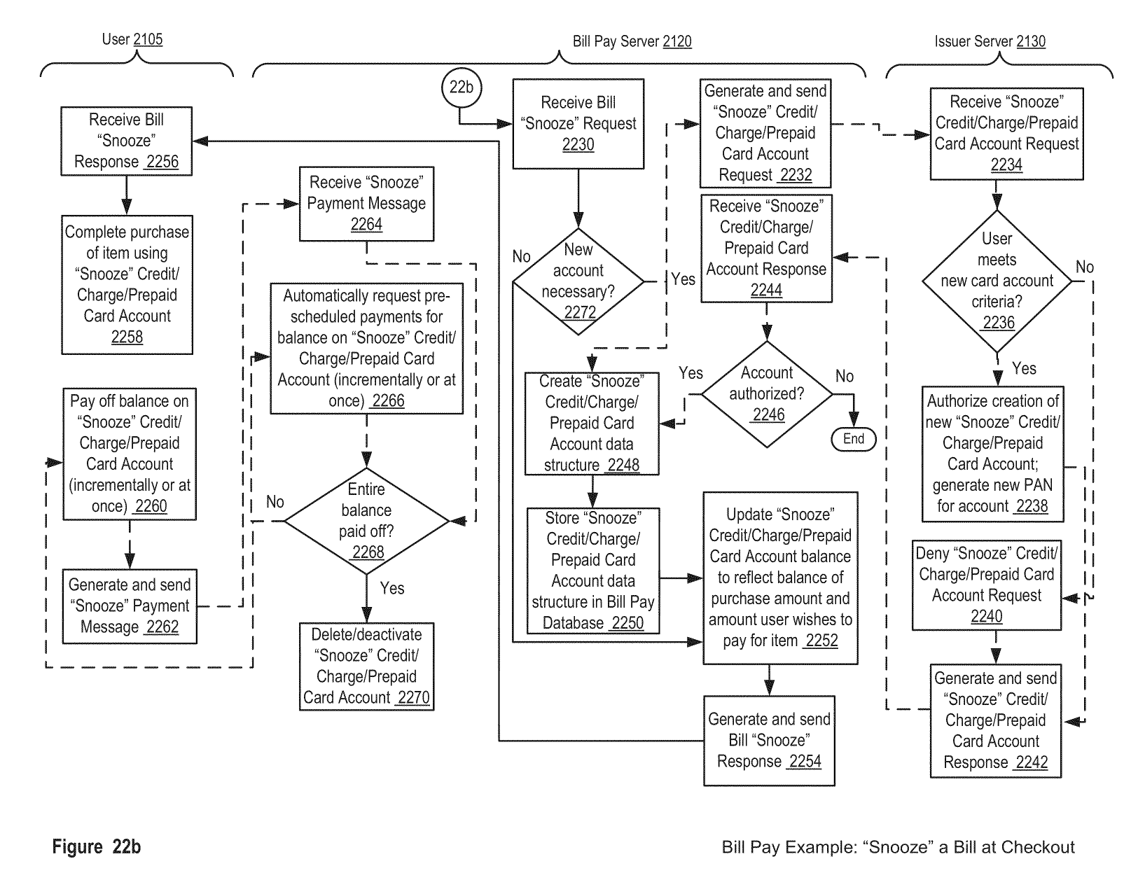

FIGS. 2022a-22b show example wallet account enrollment data flow.

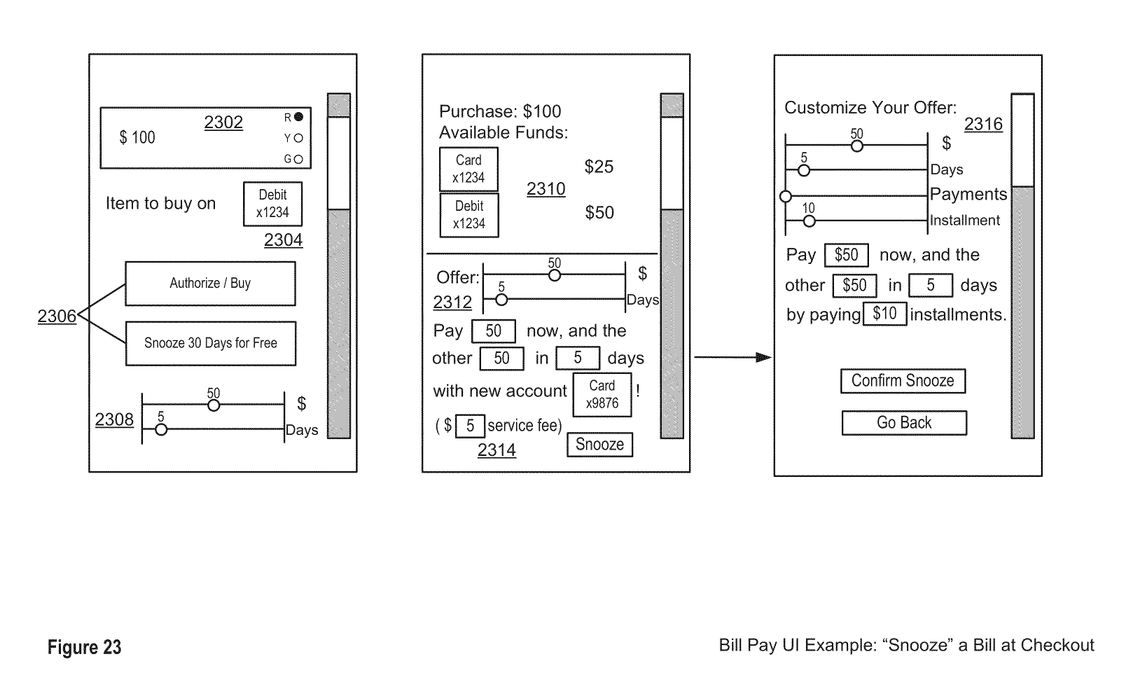

FIGS. 2023a-23b show a logic flow diagram illustrating an example wallet and card enrollment logic flow.

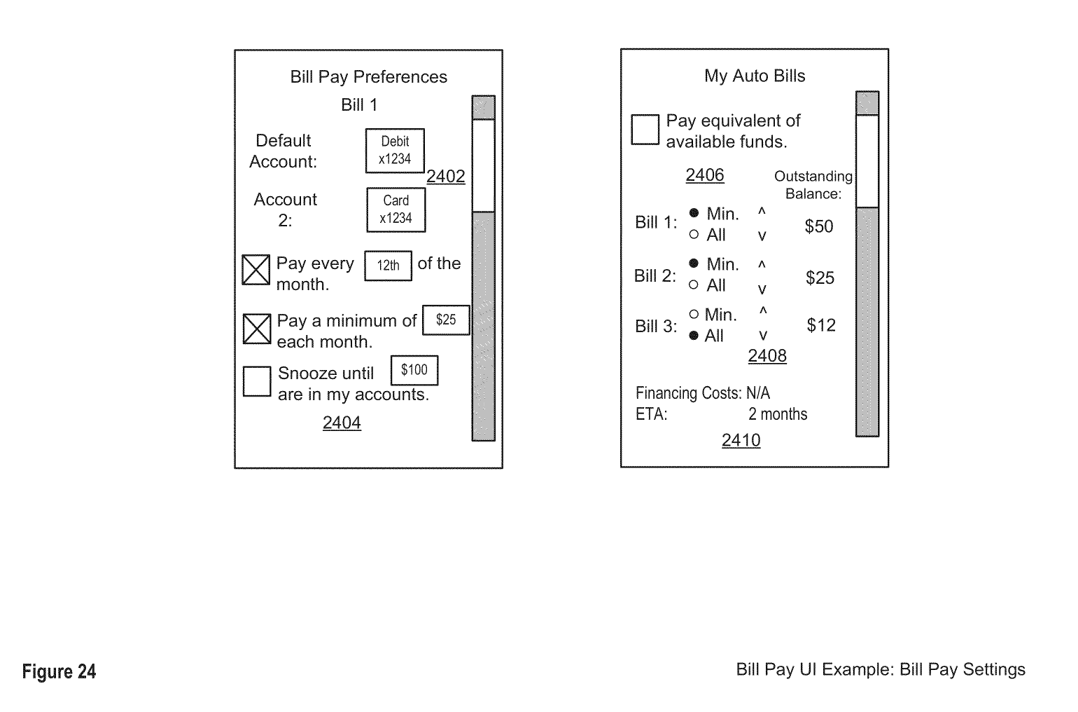

FIGS. 2024a-24j show screenshot diagrams illustrating example wallet and card enrollment.

FIG. 2025 shows a block diagram illustrating example multi-directional service connections in some embodiments of the Bill Pay;

FIGS. 2026A-26C show example user interfaces in some embodiments of the Bill Pay;

FIG. 2027 shows a data flow diagram illustrating example multi-directional connections in some embodiments of the Bill Pay;

FIG. 2028 shows a logic flow diagram illustrating example multi-directional connections in some embodiments of the Bill Pay;

FIGS. 2029A-29G show example access privileges in some embodiments of the Bill Pay;

FIGS. 2030A-30B show example user interfaces illustrating Bill Pay connecting wallet with issuers in some embodiments of the Bill Pay;

FIGS. 2031A-31I show example user interfaces and a logic flow diagram illustrating wallet overlay on mobile devices in some embodiments of the Bill Pay;

FIGS. 2032A-32U show exemplary embodiments of value added wallet features and interfaces in some embodiments of the Bill Pay; and

FIG. 26 shows a block diagram illustrating embodiments of a Bill Pay controller.

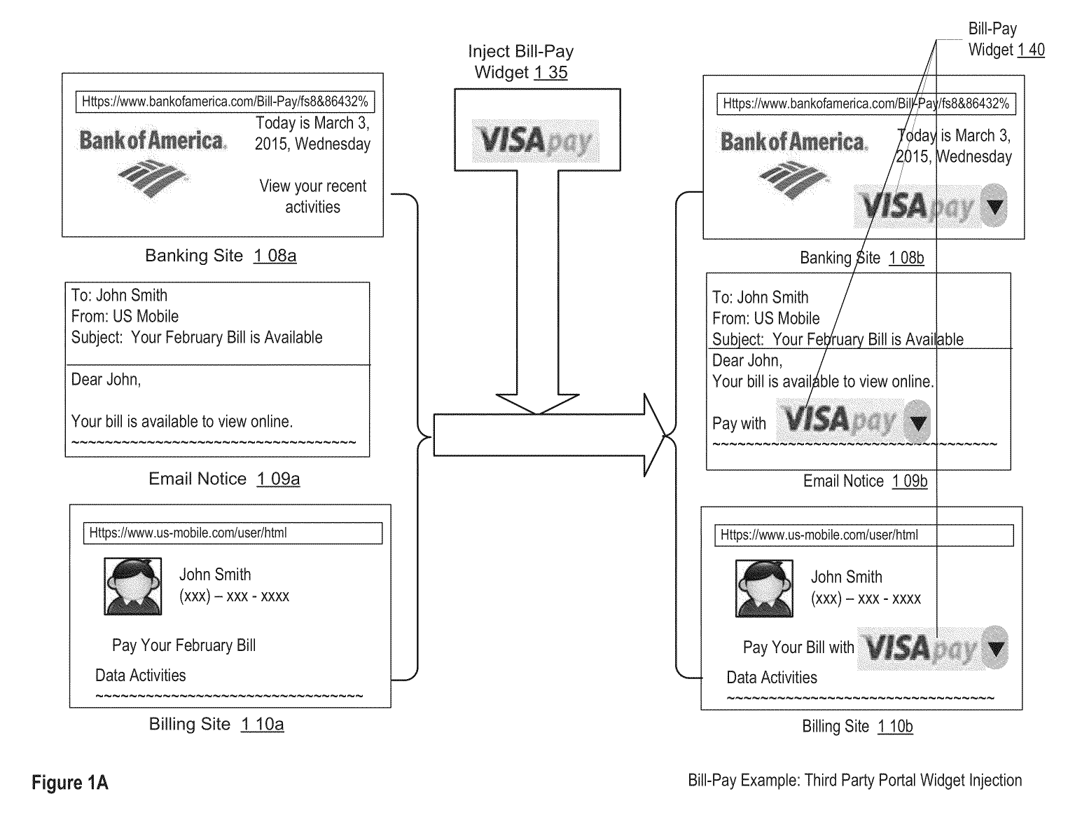

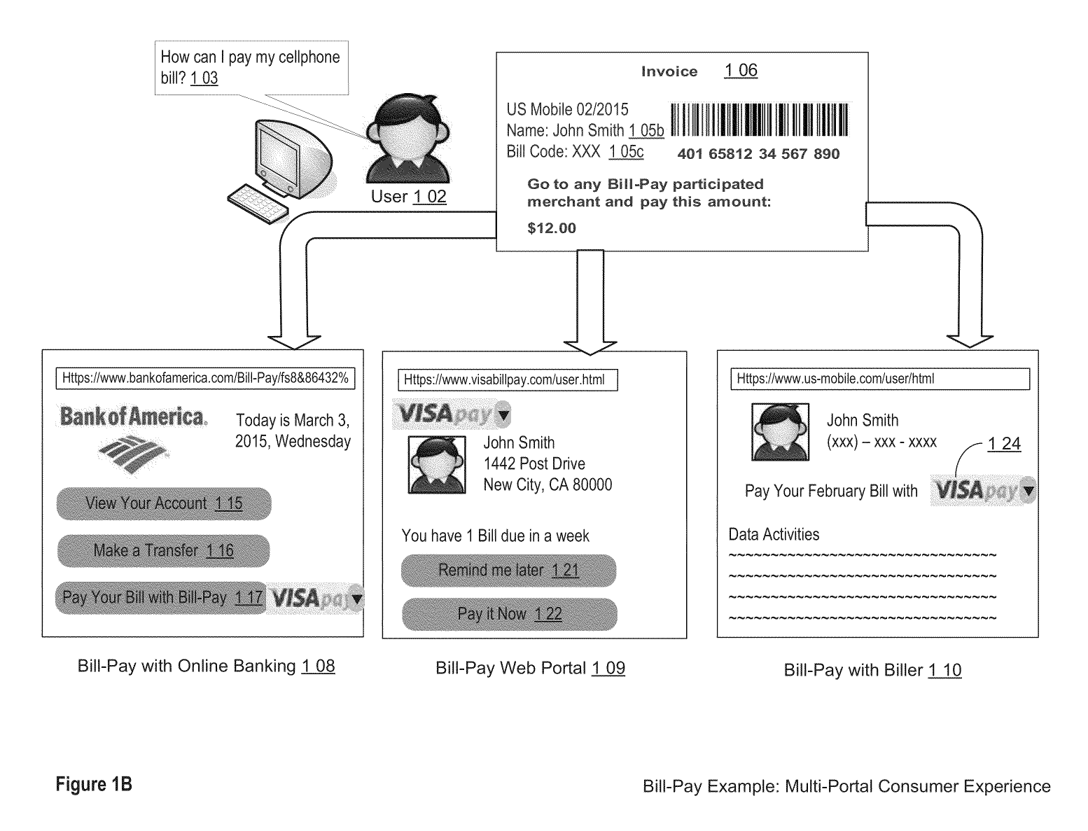

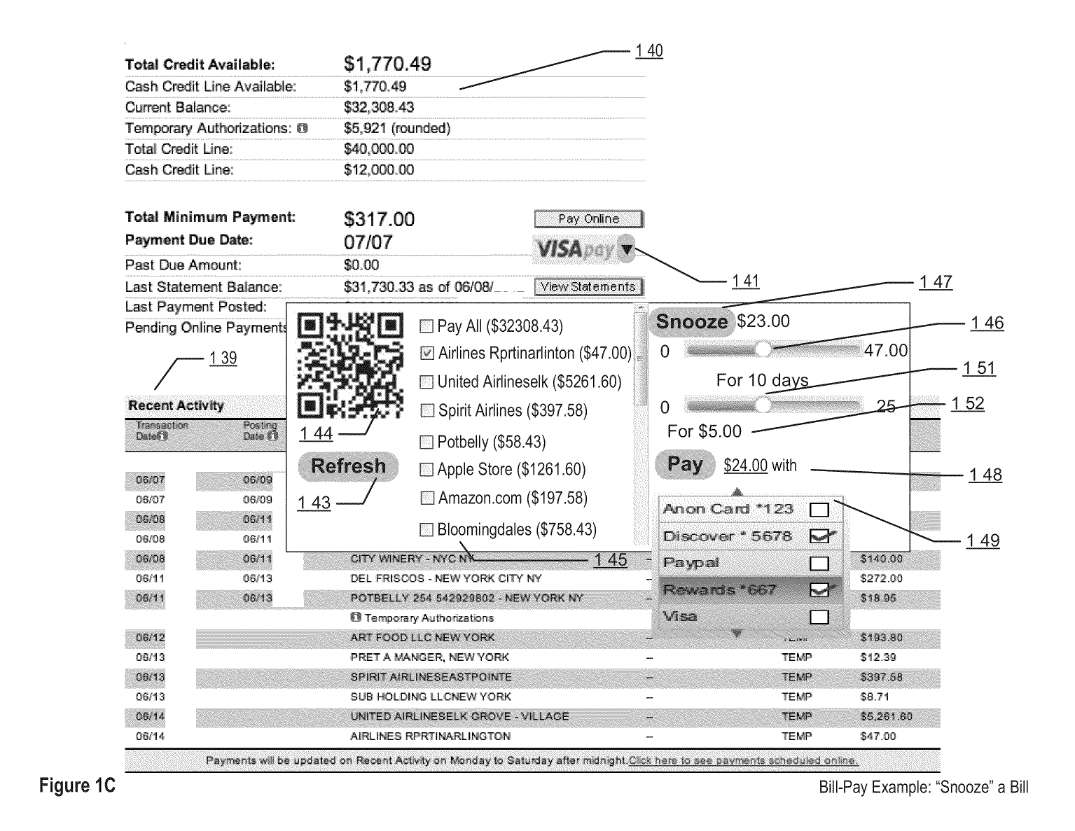

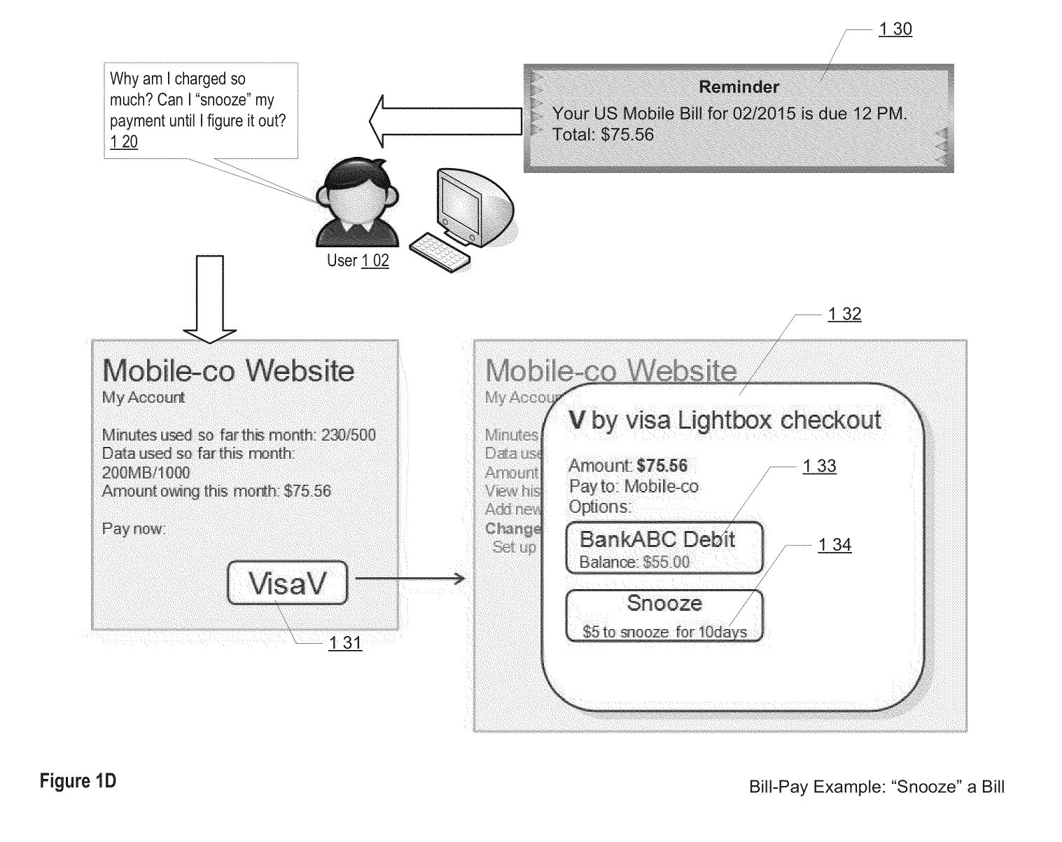

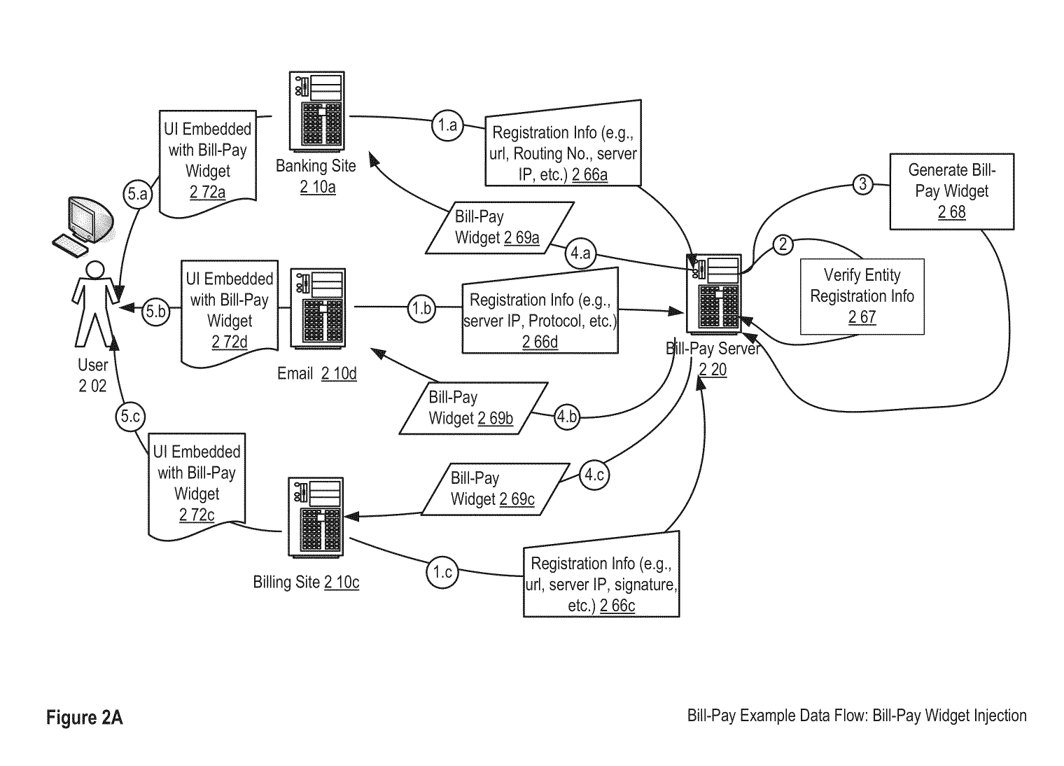

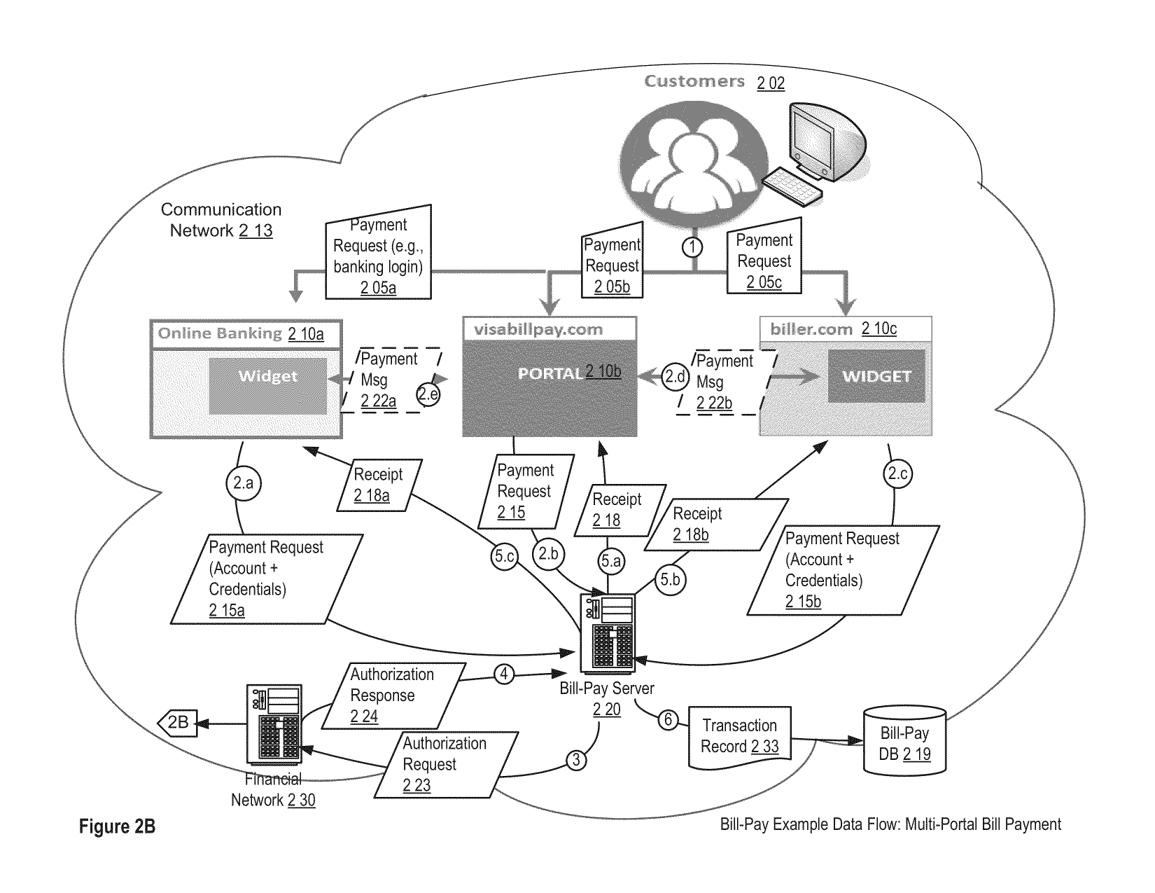

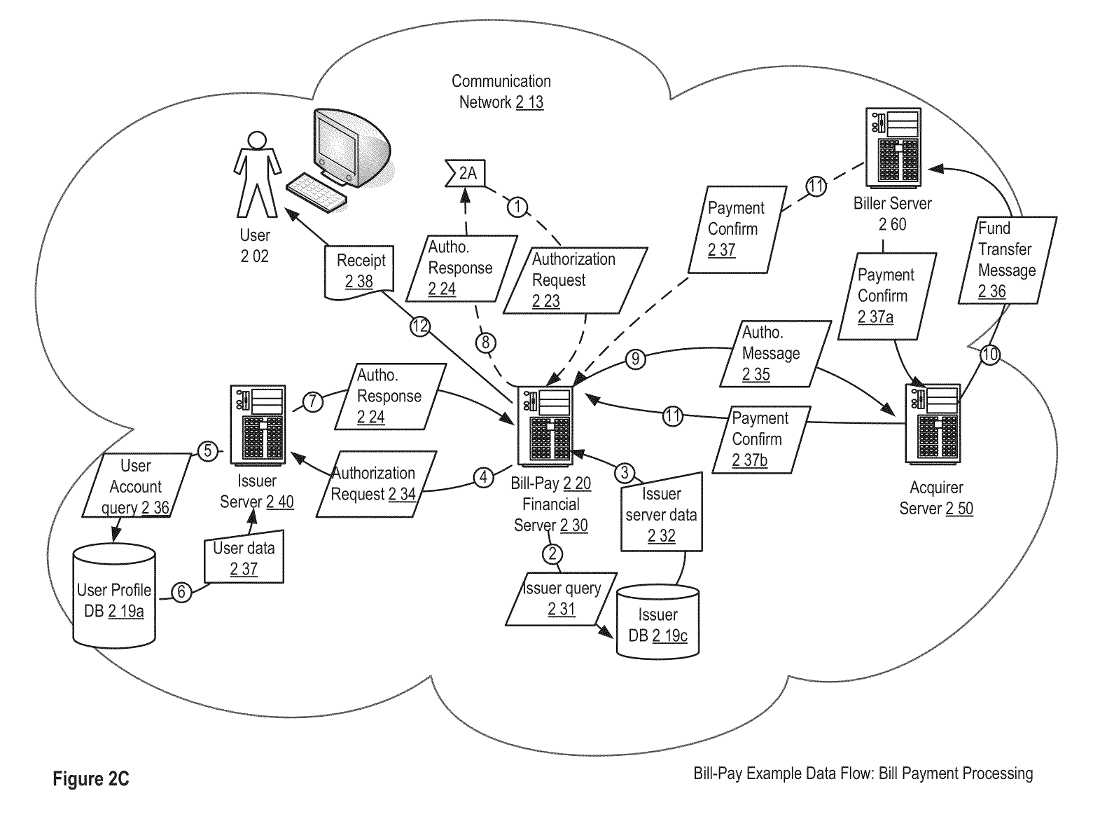

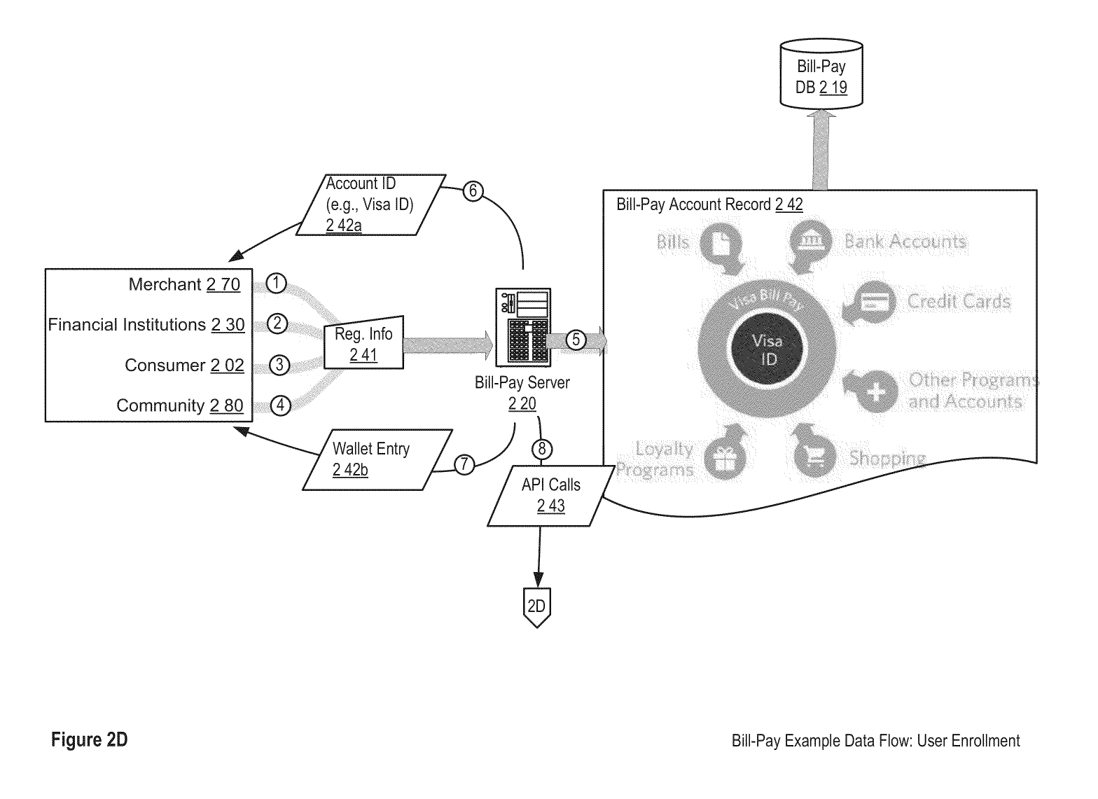

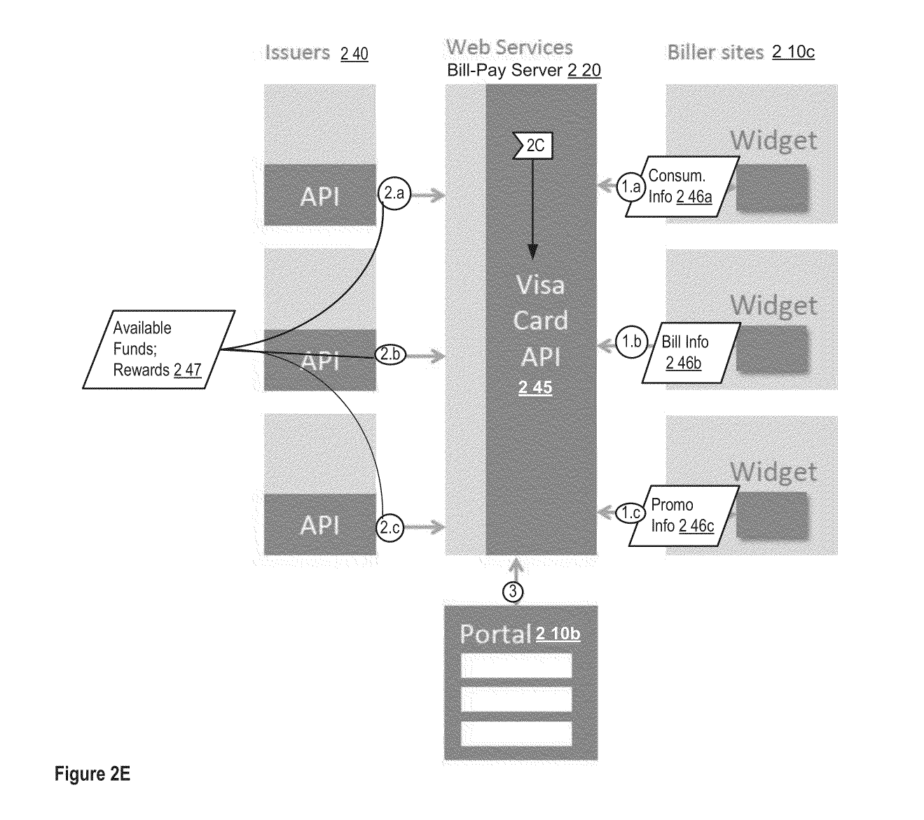

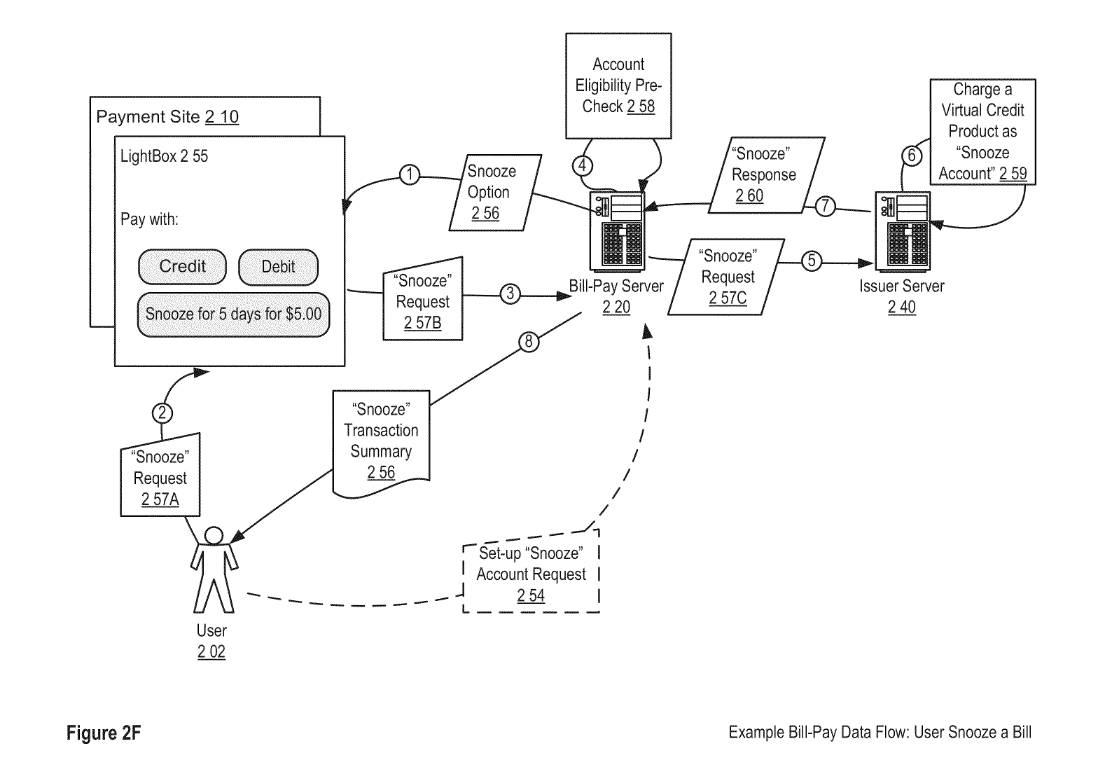

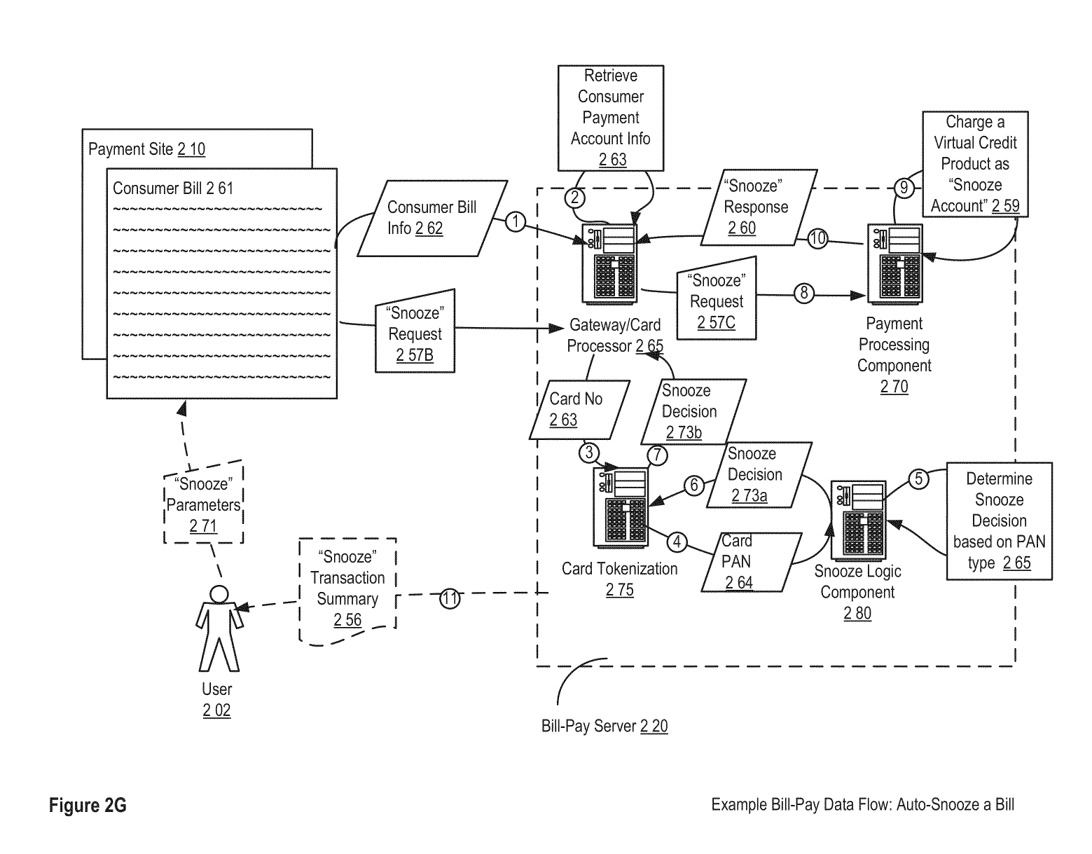

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

The REMOTE PORTAL BILL PAYMENT PLATFORM APPARATUSES, METHODS AND SYSTEMS (hereinafter “Bill-Pay”) facilitates, enhances, enables, creates, generates, and/or provides enhanced transactions, transaction management, data collection, data management and/or analysis, interactions, communications, and/or the like, relating to effectuating payments. In one embodiment, the Bill-Pay may be configured to provide users (e.g., cardholders of cards associated with the Bill-Pay) with the ability to pay bills using reloadable prepaid card accounts at participating merchant locations. Via the Bill-Pay, a cardholder may make bill payments using a reloadable prepaid card account number that is listed on the bill and/or embedded in specified indicia on a bill (e.g., a bar code).

In some embodiments, prepaid card accounts may be associated with reloadable accounts and may be reloaded through a variety of mechanisms, for example, kiosks located at various retail locations such as convenience stores. These cards may be administered by an entity or entities and/or services associated with the cards (e.g., “Visa ReadyLink” system of Visa Inc.). Depending on the implementation, some embodiments may provide the advantages of being safer than cash.

The Bill-Pay provides a fast and efficient bill payment option to consumers. In some embodiments, the Bill-Pay provides cardholders with the ability to pay bills using reloadable prepaid cards at a participating merchant location using specified indicia on the bill (e.g., the invoice number for the bill the Bill-Pay, a cardholder can use a service that provides the customer with a way to add funds to an eligible and participating reloadable prepaid card, and make bill payments using that card. In some implementations, the Bill-Pay may be configured to drive consumer traffic at participating merchant locations.

Within implementations, the Bill-Pay may allow cardholders to defer or “snooze” a payment of a bill for a fixed period of time (e.g., extension of a bill until the next payday). In one implementation, a consumer may opt-in for a temporary line so that they could “Snooze” a portion or an entire bill for a short period of time. There are at least two possible methods of activation of Bill-Pay deference: A) manually by the consumer at the time of checkout from the billers website B) automatically by a processing platform on the consumer's behalf. Additional implementations of the Bill-Pay may comprise tools for the consumer to view and manage payments that have been snoozed and settlement tools for clearing a snooze balance to another primary account such a Visa debit card.

Within implementations, integration of an electronic wallet, a desktop application, a plug-in to existing applications, a standalone mobile application, a web based application, a smart prepaid card, and/or the like in capturing payment transaction related objects such as purchase labels, payment cards, barcodes, receipts, and/or the like reduces the number of network transactions and messages that fulfill a bill payment transaction initiation and procurement of bill payment payment information (e.g., a user and/or a merchant does not need to collect or distribute paper bills or obtain and send digital images of paper bills, send in a physical payment such as payment forms, personal checks, money orders, etc. in order to initiate a bill payment payment transaction, fund transfer, and/or the like). In this way, with the reduction of network communications, the number of transactions that may be processed per day is increased, i.e., processing efficiency is improved.

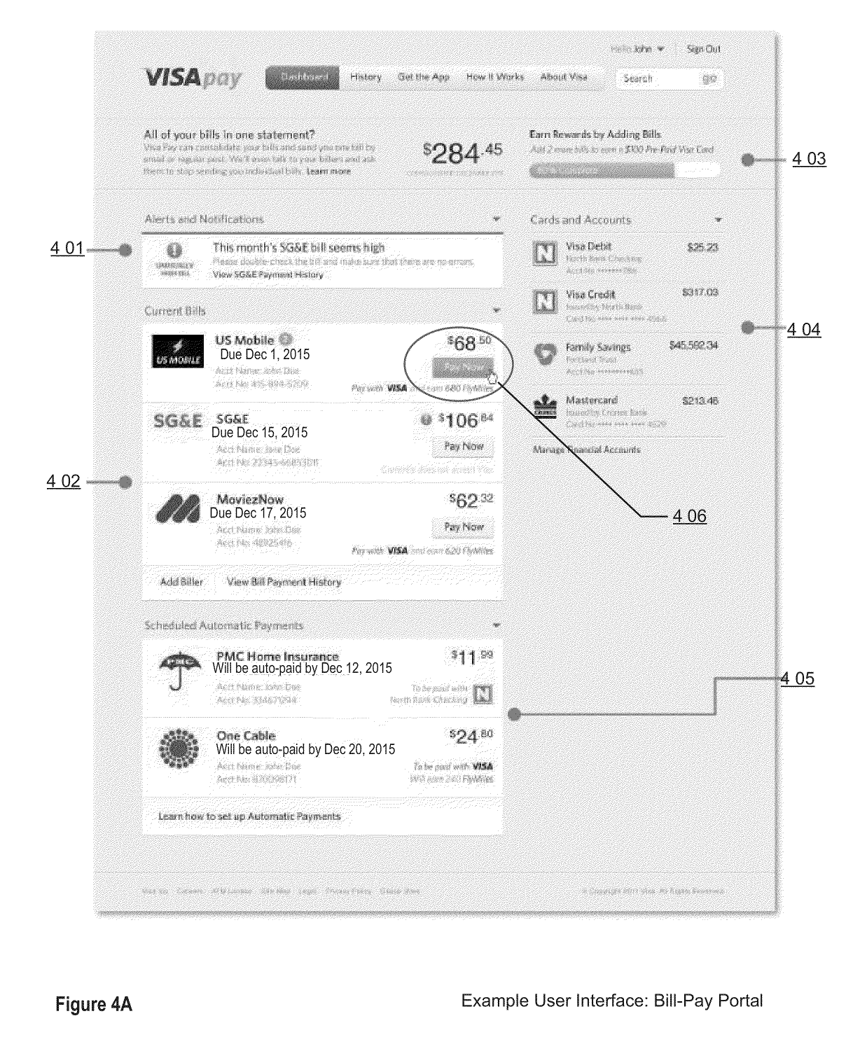

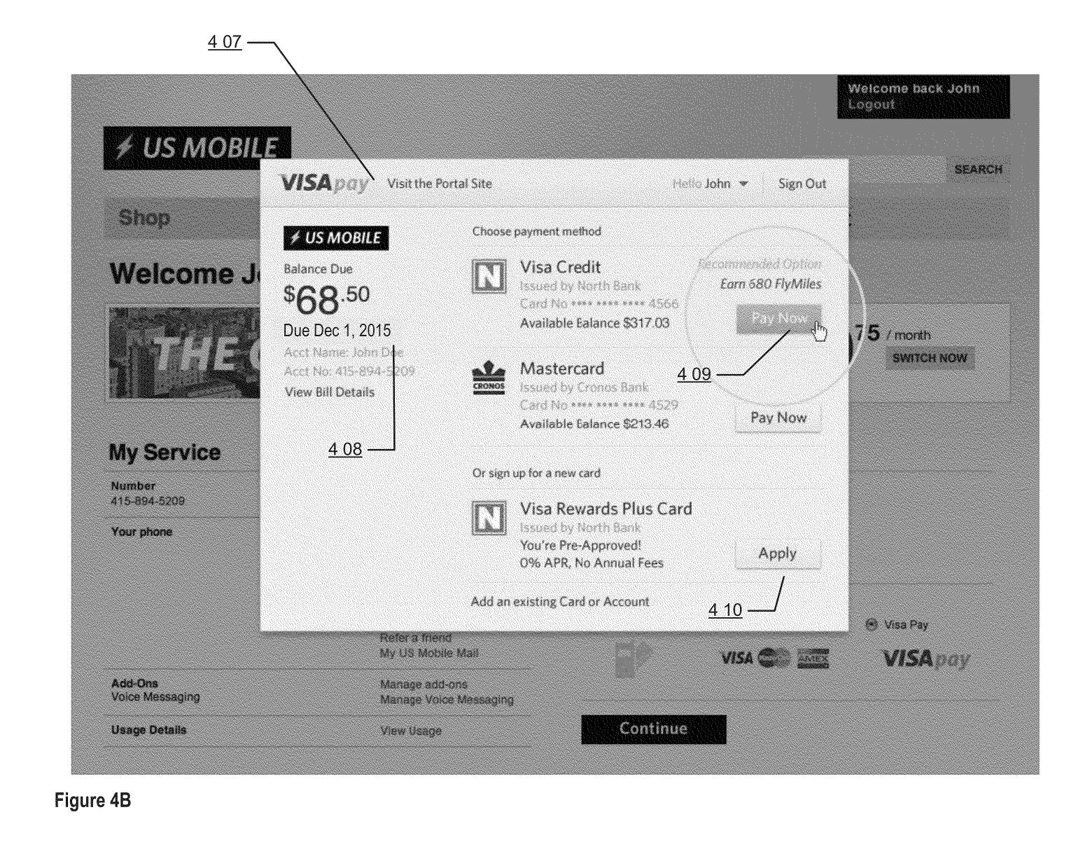

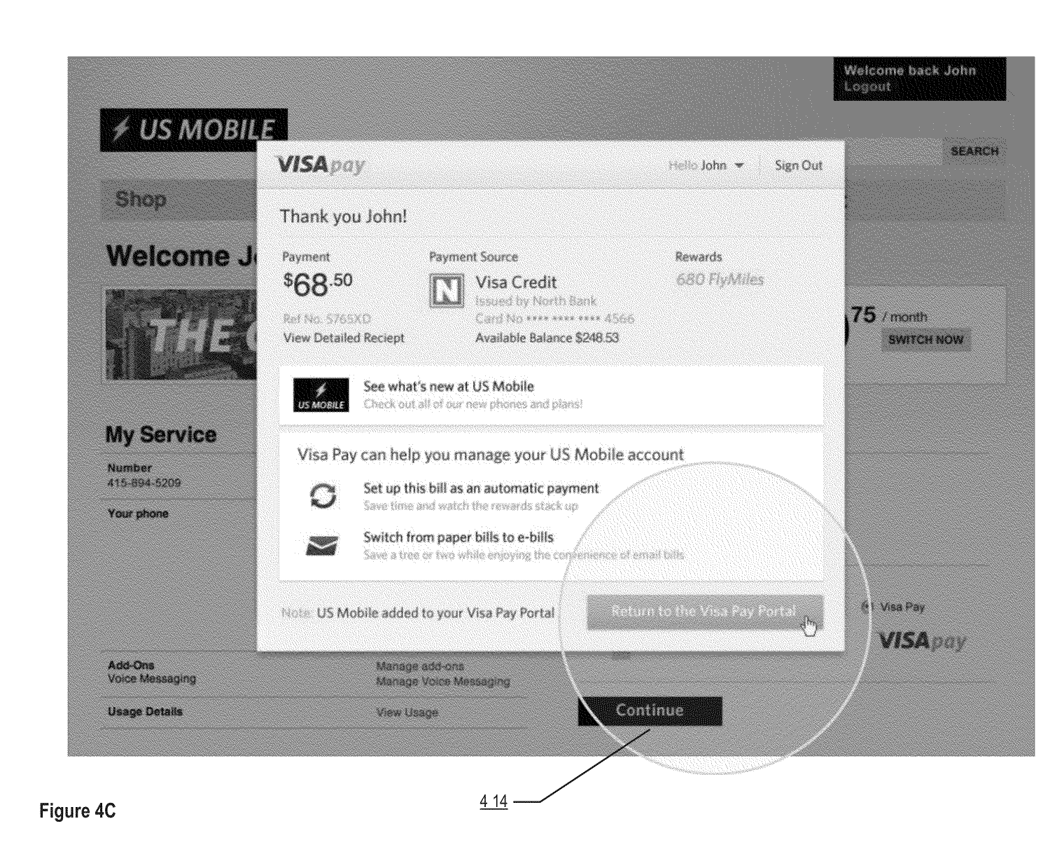

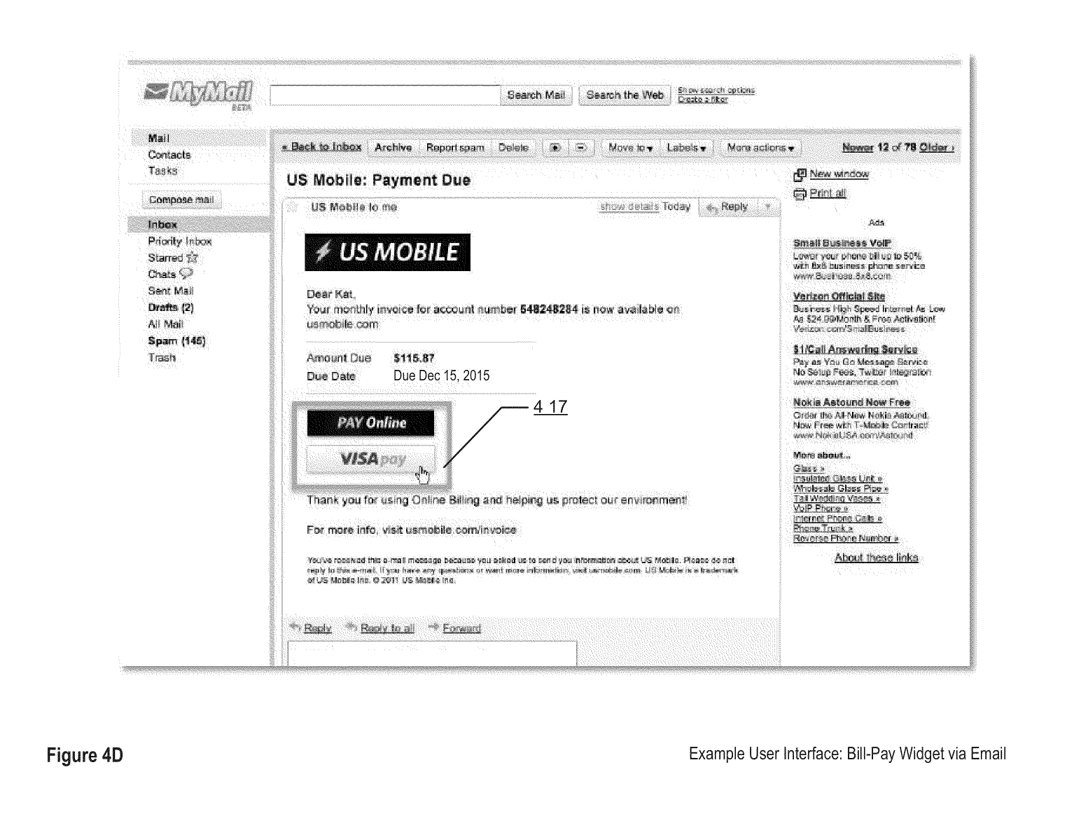

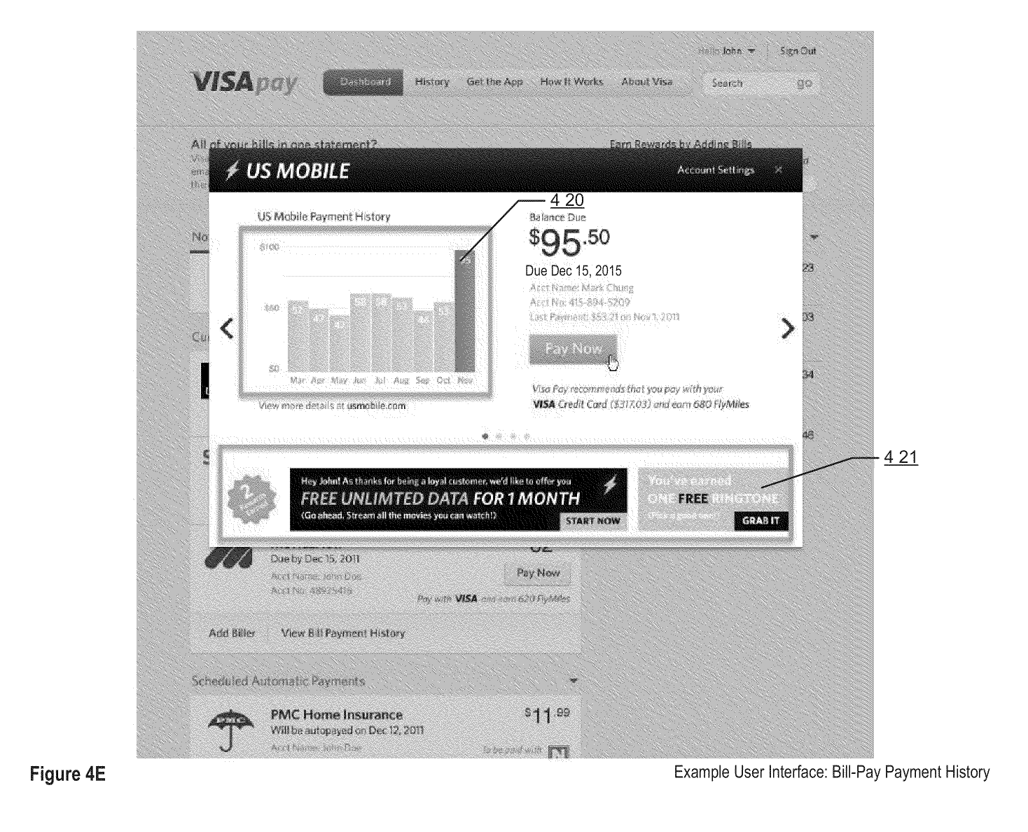

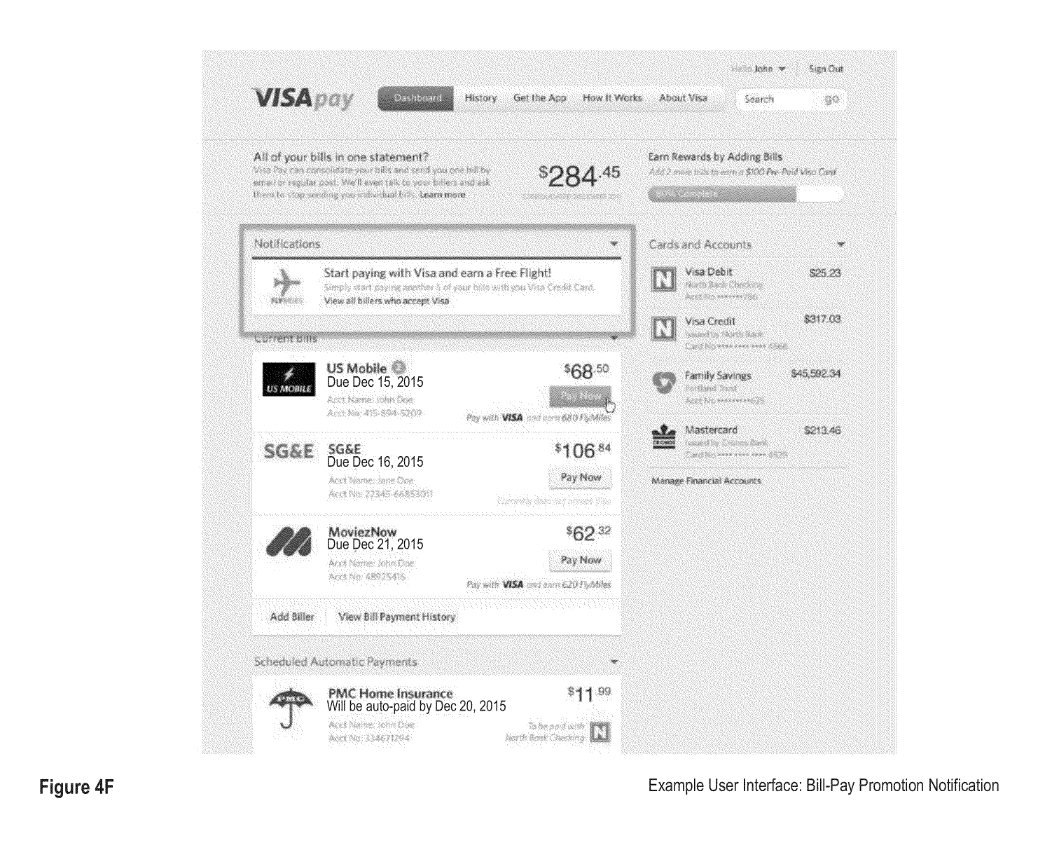

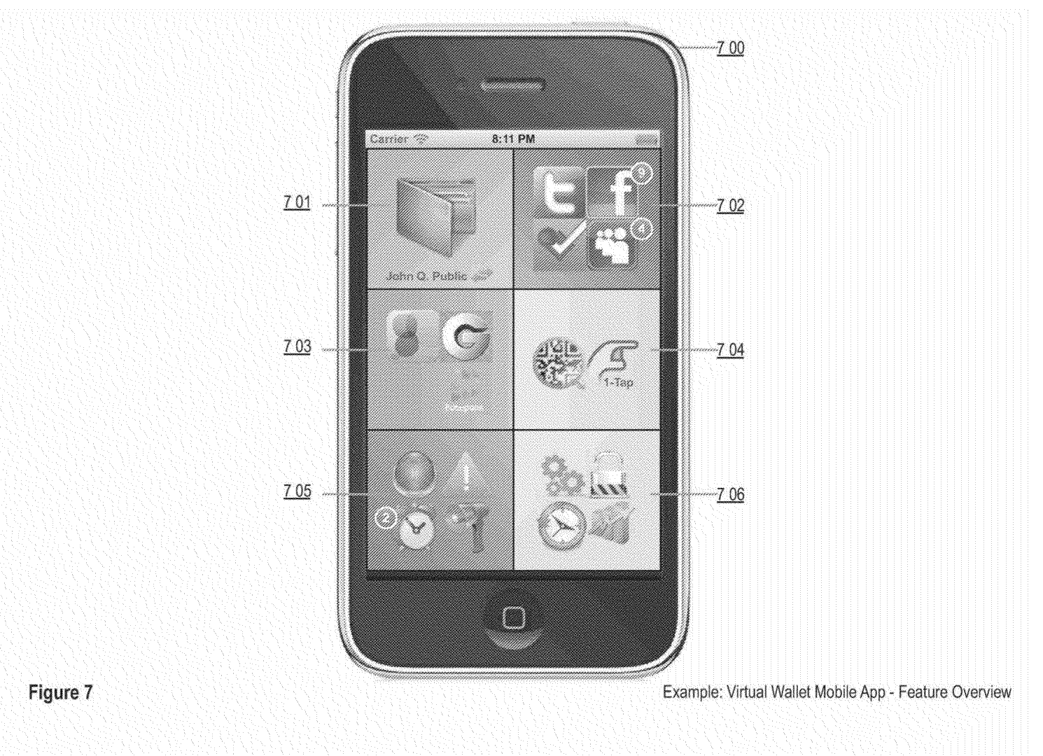

It should be noted that although a mobile wallet platform is depicted (e.g., see FIGS. 7-13B), a digital/electronic wallet, a smart/prepaid card linked to a user's various payment accounts, and/or other payment platforms are contemplated embodiments as well; as such, subset and superset features and data sets of each or a combination of the aforementioned payment platforms (e.g., see FIGS. 4A-6B) may be accessed, modified, provided, stored, etc. via cloud/server services and a number of varying client devices throughout the instant specification. Similarly, although mobile wallet user interface elements are depicted, alternative and/or complementary user interfaces are also contemplated including: desktop applications, plug-ins to existing applications, stand alone mobile applications, web based applications (e.g., applications with web objects/frames, HTML 5 applications/wrappers, web pages, etc.), and other interfaces are contemplated. It should be further noted that the BILL-PAY payment processing component may be integrated with an digital/electronic wallet (e.g., a Visa V-Wallet, etc.), comprise a separate stand alone component instantiated on a user device, comprise a server/cloud accessed component, be loaded on a smart/prepaid card that can be substantiated at a PoS terminal, an ATM, a kiosk, etc., which may be accessed through a physical card proxy, and/or the like.

### Bill Pay

FIG. 1A provides a block diagram illustrating Bill-Pay widget injection into third party sites within embodiments of the Bill-Pay. Within implementations, a user may access various websites to view his financial statement, e.g., banking statement, billing statement, etc. For example, a user may login to his online banking site 108a to view balance, receive an email message from a biller with regard to his billing statement 109a, retrieve and view a billing statement from a billing site 110a, and/or the like. In one implementation, the user may be informed of a billing due date via various platforms 108a-110a, and may desire to pay the outstanding balance. In one implementation, the Bill-Pay may inject a Bill-Pay widget 135 into the various platforms 108a-110a, e.g., by displaying a Bill-Pay button 140 embedded in the webpage.

For example, in one implementation, a user may access his banking site 108b, and click on the Bill-Pay button 140 and directly pay for an outstanding balance. In another example, the user may receive a bill statement in the email 109b, wherein the email may comprise a Bill-Pay button 140 to directly facilitate bill payment. In another example, the user may log into a biller site (e.g., a cellular service, etc.) and click on the Bill-Pay button 140 to engage in bill payment. Further implementations including exemplary user interfaces of the Bill-Pay widget 140 are illustrated in FIGS. 4A-6B.

FIG. 1B provides a block diagram illustrating multi-portal consumer experience within embodiments of the Bill-Pay. Within embodiments, a user 102 may need to pay a bill, e.g., a mobile phone invoice/bill 106. For example, the bill 106 may comprise information such as, but not limited to a title of the biller “US Mobile”, name of the user “John Smith” 105b, bill code 105c, and/or the like. In further implementations, the received bill (e.g., a printed paper bill statement, an electronic bill, etc.) may comprise a barcode.

In one implementation, the user 102 may desire to pay the mobile phone bill 103. The user may pay the bill via various portals. For example, the user may log into a third party site, such as an online banking site 108, wherein the banking site may allow the user to view a bank account 115, make a transfer 116, and/or pay the bill with a Bill-Pay widget 117 within the online banking site 108. In another implementation, the user 102 may log into a Bill-Pay web portal 109 (e.g., visabillpay.com, etc.) wherein the user may elect to pay the bill 122, or request to a reminder for later 121. In another implementation, the user may go to a biller site 110, e.g., the biller “US Mobile” homepage, etc., which is connected to the Bill-Pay via a Bill-Pay widget 124 instantiated within the biller site.

FIG. 1C provides an exemplary user interface of Bill-Pay illustrating bill payment via a credit card statement user interface within implementation of the Bill-Pay. Within implementations, a user may view a credit card statement 140 showing the credit card activities 139 via an electronic user interface, e.g., via a web browser, etc. In one implementation, the user may click on a Bill-Pay widget which includes a bifurcate button 141, and view a pop-up lightbox. In one implementation, the pop-up lightbox may comprise a QR code 144 encoding the bill information. The user may select one or more items on the bill to pay 145, and/or select to pay all the items on the bill. Once the user has selected items to pay, the user may click on the “refresh” button to generate a QR code that corresponds to the selected items.

In one implementation, the user may selects to snooze the selected bill items 147, and may slide the button 146 to determine an amount to “snooze” and a term to snooze 151. In one implementation, the Bill-Pay may provide a dollar amount for the “snooze” fee 152 for the snooze amount and term the user selected. In one implementation, the Bill-Pay may determine a remaining balance 148, and provide a list of accounts 149 for the user to select. The user may select an account to pay the remaining balance.

FIG. 1D provides another example of Bill-Pay, illustrating user postponing a bill payment processing within embodiments of the Bill-Pay. As shown in FIG. 1B, when a user 102 receive a reminder of bill payment 130, the user may desire to postpone the bill payment 120 for various reasons. For example, the user may desire to dispute charges on the bill, figure out specifics of the bill, wait until sufficient funds become available for the payment, and/or the like. In one implementation, the Bill-Pay may allow a user to “snooze” a bill, e.g., to postpone the bill payment past the due date, etc. For example, as shown in FIG. 1B, the user 102 may log into a mobile phone service website to pay for his mobile phone bill, wherein he may click on a Bill-Pay widget 131 to proceed to payment. In one implementation, the Bill-Pay widget 131 may lead to a checkout pop-up window, e.g., 132, which may list available accounts for payment and the current balance 133. In one implementation, the Bill-Pay pop-up window may provide a “snooze” option 134 for the user to pay the Bill-Pay with an additional fee, e.g., to pay an extra “$5 to snooze for 10 days.”

FIG. 2A provides a data flow diagram illustrating data follow between the Bill-Pay server and third party sites for Bill-Pay widget injection within implementations of the Bill-Pay. Within implementations, a third party host site, e.g., a banking site 210a, an email site 210d, billing site 210C, and/or the like, may submit registration information to the Bill-Pay server 220 to register for the Bill-Pay widget, e.g., 140 in FIG. 1A.

For example, in one implementation, a banking site 210a may submit its URL, bank routing number, sever IP address, and/or the like to the Bill-Pay server 220. The email server 210d may submit its server IP address, email protocol, 266d and/or the like. The billing site 210C may submit url, server IP address, signature, and/or the like. For example, the online banking site 210a may generate a Secure Hypertext Transfer Protocol (HTTPS) POST message including the registration information message 266a. An exemplary eXtensible Markup Language (XML) formatted registration information message 266a (or 266c/d) may take a form similar to the following:

POST /RegistrationRequest.php HTTP/1.1
Host: www.bankonline.com
Content-Type: Application/XML
Content-Length: 718
<?XML version = “1.0” encoding = “UTF-8”?>
<PaymentRequest>

<RequestID> BANK-0001 </RequestID>
<RequestDate> 09-09-2015 </BillDate>
<RequestTimeStamp> 14:23:22 </RequestTimeStamp>
<RequestSource> www.bankofamerica.com </RequestSource>
<Profile>

<Name> bank of America </name>
<number> 800-000-0000 </number>
<routing> 000000000 </routing>
<serverIP> 255.000.00.001 </serverIP>
<url> www.bankamerica.com </url>
<security> ... </security>
...

</Profile>
<routing_protocol> ... </routing_protocol>
...
<requested_widget>

<widget_type> bill payment </widget_type>
<widget_format> button </widget_format>
<widget_destination> www.bill-pay.com
</widget_destination>
...

</request_widget>

</PaymentRequest>

Within implementations, the Bill-Pay server 220 may verify the received entity registration information 267 and then generate a Bill-Pay widget 268. For example, the Bill-Pay may verify whether the requesting business entity is an eligible entity that has a business agreement with Bill-Pay, etc.

In one implementation, the Bill-Pay server 220 may deliver a Bill-Pay widget package 269a-c to the requesting entities 210a-c. For example, the widget package may comprise a java widget toolkit, such as but not limited to SWT, JavaFX, and/or the like. In one implementation, the requesting entities 210a-c may incorporate the received widget into its webpage, and present a user interface embedded with the Bill-Pay widget 272a-c to the user 202. For example, the user may see a “Pay with Visa Pay” option button (e.g., 140 in FIG. 1A) on a banking site, email, biller site, and/or the like.

FIG. 2B provides a data flow diagram illustrating data flow between the Bill-Pay portal/server and various Bill-Pay affiliated entities to initiate a multi-portal bill payment within embodiments of the Bill-Pay. Within various embodiments, one or more user(s) (customers) 202, Bill-Pay server 220, Bill-Pay database(s) 219, an online banking site with Bill-Pay widget 210a, a Bill-Pay hosted payment portal 210b, a biller site with Bill-Pay widget 210C, a financial network 230, insurance provider 150, and/or the like are shown to interact via various communication networks 213.

Within various embodiments, the user (e.g., a patient, etc.) 202 may include a wide variety of different communications devices and technologies within embodiments of Bill-Pay operation. For example, in one embodiment, the user 202 may operate personal devices such as, but not limited to, terminal computers, work stations, servers, cellular telephony handsets, smart phones, PDAs, and/or the like. In one embodiment, the Bill-Pay server 220 may be equipped at a terminal computer of the user 202. In another embodiment, the Bill-Pay server 220 may be a remote server which is accessed by the user 202 via a communication network 213, such as, but not limited to local area network (LAN), in-house intranet, the Internet, and/or the like. In a further implementation, the user 202 may access an online banking site 201a, a Bill-Pay payment portal 210b, a biller site 210C, and/or the like via a user interface.

In one embodiment, the customer 202 may submit a payment request 205a/b/c via a Bill-Pay portal 210a/b/c. For example, the user may view an electronic bill via a user interface and click on a Bill-Pay widget instantiated on an online banking site (e.g., see FIG. 4A), a Bill-Pay widget instantiated on a biller site (e.g., see 407 in FIG. 4B), or via a Bill-Pay payment portal (e.g., visabillpay.com, etc.). In one implementation, the Bill-Pay widgets 210a/c and/or the payment portal site 210b may retrieve bill information and user profile information to generate a payment request message 215 to the Bill-Pay server 220. For example, the online banking site 210a, payment portal site 210b and/or the biller site 210C may generate a Secure Hypertext Transfer Protocol (HTTPS) POST message including the payment request 215a/b/c. An exemplary XML formatted payment request message 215a/b/c may take a form similar to the following:

POST /PaymentRequest.php HTTP/1.1
Host: www.bill-pay.com
Content-Type: Application/XML
Content-Length: 718
<?XML version = “1.0” encoding = “UTF-8”?>
<PaymentRequest>

<RequestID> BP-0001 </RequestID>
<RequestDate> 09-09-2015 </BillDate>
<RequestTimeStamp> 14:23:56 </RequestTimeStamp>
<RequestSource> www.bankofamerica.com </RequestSource>
<User>

<UserName> John Smith </UserName>
<UserID> JS0000 </UserID>
<AccountNo> 0000 0000 0000 </AccountNO>
<Password> 0000 </Password>

...
</User>
<Bill>

<BillID> Feb-BB0008PPO </BillID>
<BillerID> USM001 </BillerID>
<BillerName> U.S. Mobile </BillerName>
<BillDueDate> 12-15-2015 </BillDueDate>
<AmountDue> 75.56 </AmountDue>
...

</Bill>
<PaymentPlan>

<AccountSelection>

<Account1> 0000 0000 0000 0001 </Account1>
<Amount1> 30.00 </Amount1>
<Account2> 0000 0000 0000 0002 </Account2>
<Amount2> 45.56 </Amount2>
...

</AccountSelection>
<Snooze>

<term> 15 days </term>
<fee> 5.00 </fee>
...

</Snooze>
...

| | </PaymentPlan> |
|---|---|
| ... | ... |

</PaymentRequest>

In the above example, the payment request includes information fields such as user profile information, bill information and user's payment configuration parameters. For example, the user may elect split the bill payment into more than one account and enter an amount to be charged with the account; the user may further elect to pay the bill instantly without “snoozing” in this example.

In one embodiment, upon receiving the payment request, the Bill-Pay server 220 may generate a payment authorization request 223 to the financial network 230, as further discussed in FIG. 2C. For example, the Bill-Pay server 220 may generate a HTTPS POST message including the payment authorization request message 223 to a financial network 230 (e.g., the issuer network, etc.). An exemplary XML-formatted payment authorization request message 223 may take a form similar to the following:

POST /AuthorizationRequest.php HTTP/1.1
Host: www.bill-pay.com
Content-Type: Application/XML
Content-Length: 718
<?XML version = “1.0” encoding = “UTF-8”?>
<AuthorizationRequest>

<RequestID> AR-BP-0001 </RequestID>
<RequestDate> 09-09-2015 </BillDate>
<RequestTimeStamp> 14:24:56 </RequestTimeStamp>
<IssuerNetwork>
<Payor>

<AccountNo> 0000 0000 0000 </AccountNO>
<AccountHolder> John Smith </AccountHolder>
<ExpirationDate> 09-09-2020 </ExpirationDate>
<RoutingNo> 00000000 </RoutingNo>
<CVV>900 </CVV>

...
</Payor>
<Payee>

<AccountNo> 000000009430424 </AccountNo>
<AccountHolder> U.S. Mobile </AccountHolder>
<RoutingNo> 00000001 </RoutingNo>
...

</Payee>
<Amount> 50.00 </Amount>
<Snooze>

<term> 15 days </term>
<fee> 5.00 </fee>
...

</Snooze>

...

</AuthorizationRequest>

In one embodiment, the Bill-Pay server 220 may be part of, and/or integrated with financial network 230 to process the financial transaction. In another implementation, the financial network 230 may receive the authorization request 223 and generate an authorization response 224 to approve or disapprove the transaction. An exemplary XML-formatted payment authorization request message 223 may take a form similar to the following:

POST /AuthorizationResponse.php HTTP/1.1
Host: www.bill-pay.com
Content-Type: Application/XML
Content-Length: 718
<?XML version = “1.0” encoding = “UTF-8”?>
<AuthorizationRequest>

<RequestID> AR-BP-0001 </RequestID>
<RequestDate> 09-09-2015 </BillDate>
<RequestTimeStamp> 14:24:56 </RequestTimeStamp>
<IssuerNetwork>
<Payor>

<AccountNo> 0000 0000 0000 </AccountNO>
<AccountHolder> John Smith </AccountHolder>
<ExpirationDate> 09-09-2020 </ExpirationDate>
<RoutingNo> 00000000 </RoutingNo>
<CVV>900 </CVV>

...
</Payor>
<Payee>

<AccountNo> 000000009430424 </AccountNo>
<AccountHolder> U.S. Mobile </AccountHolder>
<RoutingNo> 00000001 </RoutingNo>
...

</Payee>
<Amount> 50.00 </Amount>
<Snooze>

<term> 15 days </term>
<fee> 5.00 </fee>
...

</Snooze>
<status> approve </status>
<extension> 12-30-2015 </extension>
<amount> 55.00 </amount>
...

</AuthorizationResponse>

In one implementation, upon approval in the response, the Bill-Pay server 220 may provide a receipt 218a-b to the various payment portal summarizing the bill payment. In another implementation, if a bill snoozing is approved, e.g., as shown in the above example to “snooze” a bill for “15 days,” the Bill-Pay may generate an updated bill for the user, e.g., to notify the user of the new amount due and the extended due date.

In one implementation, when the bill payment transaction is completed, the Bill-Pay may generate a transaction record 233. For example, an example of the transaction record 233 for the Bill-Pay server may take a form similar to the following:

POST /TransactionRecord.php HTTP/1.1
Host: www.bill-pay.com
Content-Type: Application/XML
Content-Length: 718
<?XML version = “1.0” encoding = “UTF-8”?>
<Transaction>

<transaction_ID> BP-0001 </transaction_ID>
<transaction_date> 09-09-2015 </transaction_date>
<transaction_time> 14:23:56 </transaction_time>
<RequestSource> www.bankofamerica.com </RequestSource>
<User>

<UserName> John Smith </UserName>
<UserID> JS0000 </UserID>
<AccountNo> 0000 0000 0000 </AccountNO>
<Password> 0000 </Password>

...
</User>
<Bill>

<BillID> Feb-BB0008PPO </BillID>
<BillerID> USM001 </BillerID>
<BillerName> U.S. Mobile </BillerName>
<BillDueDate> 12-15-2015 </BillDueDate>
<AmountDue> 75.56 </AmountDue>
...

</Bill>
....
<TransferLog>

<Transfer1>

<Amount> 75.56 </Amount>
<Payor> 0000 0000 0000 </Payor>
<Payee> 0000 0000 0002 </Payee>
<Status> Verified </Status>
...

</Transfer1>
...

</TransferLog>

...
</Transaction>

In another implementation, the Bill-Pay database 219 may be a relational database responsive to Structured Query Language (“SQL”) commands. The Bill-Pay server may execute a hypertext preprocessor (“PHP”) script including SQL commands to query the database for user, transaction data, and/or the like. An example PHP/SQL command listing, illustrating substantive aspects of storing a transaction record 233 in the database:

<?PHP
header(′Content-Type: text/plain′);
mysql_connect(″202.155.66.130”,$DBserver,$password); // access
database server
mysql_select(″TRANSACTIONS.SQL″); // select database to append
mysql_query(“INSERT INTO Transactions (transaction_id,
transaction_date, requested_time, receipt_time, user_id, user_name,
account_no, account_type, employer, routing_no, item_code, category,
sub_category, item_name, item_description, item_quantity, unit_price,
total_amount, veritifcation_status, merchant_id, merchant_name,
PoS_id, transfer_log, payee_id, payor_id, transfer_amount ...)
VALUES ($transaction_id$, $transaction_date$, $requested_time$,
$receipt_time$, $user_id$, $user_name$, $account_no$,
$account_type$, $employer$, $routing_no$, $item_code$, $category$,
$sub_category$, $item_name$, $item_description$, $item_quantity$,
$unit_price$, $total_amount$, $veritifcation_status$, $merchant_id$,
$merchant_name$, $PoS_id$, $transfer_log$, $payee_id$, $payor_id$,
$transfer_amount$...); //
add data to table in database
mysql_close(″TRANSACTIONS.SQL″); // close connection to database
?>

With reference to FIG. 2C, continuing on with receiving an authorization request 223, the Bill-Pay server 220, which may be integrated with a financial processing server 230, may send an issuer query 231 to an issuer database 219c, and retrieve issuer server data 232 from the database inquiry, e.g., a bank routing number. In some embodiments, the Bill-Pay server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer.

In some embodiments, the Bill-Pay server may generate a query, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s), e.g., 1606a, of the issuer(s) may maintain details of the user's account(s). In some embodiments, a database, e.g., Bill-Pay database 219c, may store details of the issuer server(s) associated with the issuer(s). In some embodiments, the Bill-Pay server may query a database, e.g., Bill-Pay database 219c, for a network address of the issuer(s) server(s), for example by using a portion of a user payment card number, or a user ID (such as an email address) as a keyword for the database query. An example issuer server address(es) query 231, substantially in the form of PHP/SQL commands, is provided below:

<?PHP
header(′Content-Type: text/plain′);
mysql_connect(“254.93.179.112”,$DBserver,$password); // access
database server
mysql_select_db(“Bill Pay_DB.SQL”); // select database table to
search
//create query
$query = “SELECT issuer_id issuer_address issuer_URL issuer_name
FROM
IssuersTable WHERE card_num LIKE ′%′ $cardnum”;
$result = mysql_query($query); // perform the search query
mysql_close(“Bill Pay_DB.SQL”); // close database access
?>

In response to obtaining the issuer server query, e.g., 231, the Bill-Pay database may provide, e.g., 232, the requested issuer server data to the Bill-Pay server. In some embodiments, the Bill-Pay server may utilize the issuer server data to generate funds authorization request(s), e.g., 234, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. An example listing of a funds authorization request 234, substantially in the form of a HTTP(S) POST message including XML-formatted data, is provided below:

POST /fundsauthorizationrequest.php HTTP/1.1
Host: www.issuer.com
Content-Type: Application/XML
Content-Length: 624
<?XML version = “1.0” encoding = “UTF-8”?>
<funds_authorization_request>

<query_ID>VNEI39FK</query_ID>
<timestamp>2011-02-22 15:22:44</timestamp>
<transaction_cost>$22.61</transaction_cost>
<account_params>

<account_type>checking</account_type>
<account_num>1234567890123456</account_num>

</account_params>
<!--optional parameters-->
<RequestID> AR-BP-0001 </RequestID>
<RequestDate> 09-09-2015 </BillDate>
<RequestTimeStamp> 14:24:56 </RequestTimeStamp>
<IssuerNetwork>
<Payor>

<AccountNo> 0000 0000 0000 </AccountNO>
<AccountHolder> John Smith </AccountHolder>
<ExpirationDate> 09-09-2020 </ExpirationDate>
<RoutingNo> 00000000 </RoutingNo>
<CVV>900 </CVV>

...
</Payor>
<Payee>

<AccountNo> 000000009430424 </AccountNo>
<AccountHolder> U.S. Mobile </AccountHolder>
<RoutingNo> 00000001 </RoutingNo>
...

</Payee>
...

</funds_authorization_request>

In some embodiments, an issuer server may parse the authorization request(s), and based on the request details may query a database, e.g., user profile database 219a, for data associated with an account linked to the user. For example, the merchant server may issue PHP/SQL commands to query a database table (such as FIG. 26, Accounts 2619d) for user account(s) data. An example user account(s) query 237, substantially in the form of PHP/SQL commands, is provided below:

<?PHP
header(′Content-Type: text/plain′);
mysql_connect(“254.93.179.112”,$DBserver,$password); // access
database server
mysql_select_db(“Bill Pay_DB.SQL”); // select database table to search
//create query
$query = “SELECT issuer user_id user_name user_balance
account_type FROM
AccountsTable WHERE account_num LIKE ′%′ $accountnum”;
$result = mysql_query($query); // perform the search query
mysql_close(“Bill Pay_DB.SQL”); // close database access
?>

In some embodiments, on obtaining the user account(s) data, e.g., 237, the issuer server may determine whether the user can pay for the transaction using funds available in the account. For example, the issuer server may determine whether the user has a sufficient balance remaining in the account, sufficient credit associated with the account, and/or the like. Based on the determination, the issuer server(s) may provide a funds authorization response, e.g., 224, to the Bill-Pay server. For example, the issuer server(s) may provide a HTTP(S) POST message similar to the examples above. In some embodiments, if at least one issuer server determines that the user cannot pay for the transaction using the funds available in the account, the Bill-Pay server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the Bill-Pay server may abort the authorization process, and provide an “authorization fail” message to the merchant server, user device and/or client.

In some embodiments, the Bill-Pay server may obtain the funds authorization response including a notification of successful authorization, and parse the message to extract authorization details. Upon determining that the user possesses sufficient funds for the transaction, the Bill-Pay server may invoke a component to provide value-add services for the user.

In some embodiments, the server may also generate a purchase receipt, e.g., 238, and provide the purchase receipt to the user. In some embodiments, the user's wallet device may also provide a notification of successful authorization to the user. For example, the payment portal may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

FIGS. 2D-2E provide exemplary data flow diagrams illustrating interactions between the Bill-Pay server and various affiliated entities for data exchange infrastructure within embodiments of the Bill-Pay. In one embodiment, a Bill-Pay entity, such as a merchant 270, a financial institution 230 (e.g., an issuing bank, etc.), a consumer 202, a community biller 280, and/or the like, may submit registration information 241 to register with Bill-Pay. For example, in one implementation, the Bill-Pay entity may fill in a web-based application form, a mobile based app, and/or the like, to provide registration information such as user profile information, financial account information, and/or the like. In one implementation, an exemplary XML-formatted registration information message 241 from a consumer 202 may take a form similar to the following:

POST /user_registration.php HTTP/1.1
Host: 255.23.234.00
Content-Type: Application/XML
Content-Length: 624
<?XML version = “1.0” encoding = “UTF-8”?>
<user_registration>

<timestamp>2015-02-22 15:22:44</timestamp>
<user_type> consumer </user_type>
<User>

<UserName> John Smith </UserName>
<UserID> JS0000 </UserID>
<AccountNo> 0000 0000 0000 </AccountNO>
<Password> 0000 </Password>

...
</User>
<account>

<account_1>

<account_no> 0000 0000 0000 </account_no>
<bank> bank of America </bank>
<routing_no> 000000000 </routing_no>
...

</account_1>
...

</account>
...

</user_registration>

In another implementation, an exemplary XML-formatted registration information message 241 from a biller 280 may take a form similar to the following:

POST /user_registration.php HTTP/1.1
Host: 255.23.234.00
Content-Type: Application/XML
Content-Length: 624
<?XML version = “1.0” encoding = “UTF-8”?>
<user_registration>

<timestamp>2015-02-22 15:22:44</timestamp>
<user_type> biller </user_type>
<biller>

<BillerName> US mobile </BillerName>
<BillerID> USM-001 </BillerID>
<BillerAddress>

<address_line1> 144 forbes street </address_line1>
<city> new land </city>
<state> New York </state>
<zipcode> 00000 </zipcode>
...

<BillerAddress>
<Password> 0000 </Password>

...
</biller>
<account>

<account_1>

<account_no> 0000 0000 0001 </account_no>
<bank> bank of America </bank>
<routing_no> 000000000 </routing_no>
...

</account_1>
...

</account>
...

</user_registration>

In one embodiment, the Bill-Pay server 220 may issue an account ID (e.g., a Visa ID, etc.) 242a to the registration user, and may issue a token PAN for the user registered bank account. In another embodiment, when a consumer 202 submits a registration request via an electronic wallet, the Bill-Pay server 220 may provide a wallet entry 242b to download. For example, an exemplary XML-formatted wallet entry 242b may take a form similar to the following:

```
POST /wallet_entry.php HTTP/1.1
Host: 255.23.234.00
Content-Type: Application/XML
Content-Length: 624
<?XML version = “1.0” encoding = “UTF-8”?>
<wallet_entry>
    <timestamp>2015-02-22 15:22:44</timestamp>
    <user_type> biller </user_type>
    <biller>
        <BillerName> US mobile </BillerName>
        <BillerID> USM-001 </BillerID>
        <BillerAddress>
            <address_line1> 144 forbes street</address_line1>
            <city> new land </city>
            <state> New York </state>
            <zipcode> 00000 </zipcode>
            ...
        <BillerAddress>
        <Password> 0000 </Password>
    ...
    </biller>
    <account>
        <account_1>
            <account_no> 0000 0000 0001 </account_no>
            <bank> bank of America </bank>
            <routing_no> 000000000 </routing_no>
            ...
        </account_1>
        ...
    </account>
    ...
</wallet_entry>
```

In further implementations, upon receiving registration information 241, the Bill-Pay server 220 may exchange information to various entities, such as issuer, biller sites, and/or the like.

Continuing on with FIG. 2E, Bill-Pay server 220 may exchange information, e.g., via a Visa card API, to biller sites 210C, including consumer information 246a (which may take a form similar to 241), billing information 246b (which may take a form similar to 242), promotion information 246c and/or the like.

In another implementation, the issuer 240 may provide information such as available balance, rewards, etc. 247 via Visa card API 245 to the Bill-Pay server 220. In another implementation, the Bill-Pay server 220 may integrate with issuers to acquire card information, such as balance, limit, conditions, and/or the like. Each issuer may have a different set of APIs for the Bill-Pay to integrate with. In further implementations, the Bill-Pay may establish web services to expose unified card API, which may be accesses by a web portal.

FIG. 2F provides a data flow diagram illustrating aspects of a user snoozing a bill via a payment portal within embodiments of the Bill-Pay. Within implementations, a user 202 may set-up “snooze” account request 254, e.g., by submitting an enrollment request to the Bill-Pay server, as discussed in FIG. 2D. The enrolment may set up a temporary line of credit on a charge card or credit card BIN which may be associated with the consumer's bank account at the issuer 240. The credit decision for this temporary line can be based on a collection of income data points from associated payment account with the issuer 240 and/or transaction history with Bill-Pay. Upon enrollment, the Bill-Pay server may provide a “Snooze” option 256 into an electronic bill payment box, e.g., a button to “snooze for 5 days” in a lightbox 255 that is provided on a payment site 210. In one implementation, the snooze option 256 may comprise a java widget, such as, but not limited to SWT, JavaFX, and/or the like.

In one implementation, the user 202 may submit a “snooze” request 257a, e.g., by clicking on the “snooze for 5 days for $50.00” in the lightbox 255. The payment site 210 may in turn generate a “snooze” request 257b to the Bill-Pay server 220. For example, the “snooze” request 257b may comprise information such as, but not limited to user account number, user name, user id, bill information, billing amount, snooze term, and/or the like. For example, the payment site 210 may generate a Secure Hypertext Transfer Protocol (HTTPS) POST message including the “snooze” request 257b. An exemplary XML formatted “snooze” request message 257b may take a form similar to the following:

```
POST /SnoozeRequest.php HTTP/1.1
Host: www.bill-pay.com
Content-Type: Application/XML
Content-Length: 718
<?XML version = “1.0” encoding = “UTF-8”?>
<SnoozeRequest>
    <RequestID> Snooze-0001 </RequestID>
    <RequestDate> 09-09-2015 </BillDate>
    <RequestTimeStamp> 14:23:56 </RequestTimeStamp>
    <RequestSource> www.bankofamerica.com </RequestSource>
    <User>
        <UserName> John Smith </UserName>
        <UserID> JS0000 </UserID>
        <AccountNo> 0000 0000 0000 </AccountNO>
        <Password> 0000 </Password>
    ...
    </User>
    <Bill>
        <BillID> Feb-BB0008PPO </BillID>
        <BillerID> USM001 </BillerID>
        <BillerName> U.S. Mobile </BillerName>
        <BillDueDate> 12-15-2015 </BillDueDate>
        <AmountDue> 75.56 </AmountDue>
        ...
    </Bill>
    ...
    <Snooze>
            <term> 15 days </term>
            <fee> 5.00 </fee>
            ...
    </Snooze>
        ...
    <SnoozeCardNo> 0000 0000 0000 0001 </SnoozeCardNo>
    ...
...
</SnoozeRequest>
```

In one implementation, the Bill-Pay server may perform account eligibility pre-check with the snooze request 258. For example, the Bill-Pay may verify whether the user has enrolled with the “snooze” service, whether the biller has agreed to participate in the “snooze” service, and/or the like. The Bill-Pay server 220 may then generate a “snooze” request 257c to the issuer server 240 once the eligibility is verified. The issuer server 240 may charge a virtual credit product as “snooze account” 259, e.g., a pre-establish credit account to charge the $50.00 “snooze” fee. In one implementation, the issuer server 240 may generate a “snooze” response 260 to the bill-Pay server. For example, the issuer server 240 may generate a HTTPS POST message including the “snooze” response 260. An exemplary XML formatted “snooze” response message 260 may take a form similar to the following:

```
POST /SnoozeResponse.php HTTP/1.1
Host: www.bill-pay.com
Content-Type: Application/XML
Content-Length: 718
<?XML version = “1.0” encoding = “UTF-8”?>
<SnoozeResponse>
    <ResponseID> SZ-Resp_001 </ResponseID>
    <RequestID> Snooze-0001 </RequestID>
    <ResponseDate> 09-09-2015 </BillDate>
    <ResponseTimeStamp> 14:24:56 </ResponseTimeStamp>
    <RequestSource> www.bankofamerica.com </RequestSource>
    <User>
        <UserName> John Smith </UserName>
        <UserID> JS0000 </UserID>
        <AccountNo> 0000 0000 0000 </AccountNO>
        <Password> 0000 </Password>
    ...
    </User>
    <Bill>
        <BillID> Feb-BB0008PPO </BillID>
        <BillerID> USM001 </BillerID>
        <BillerName> U.S. Mobile </BillerName>
        <BillDueDate> 12-15-2015 </BillDueDate>
        <AmountDue> 75.56 </AmountDue>
        ...
    </Bill>
    ...
    <Snooze>
            <term> 15 days </term>
            <fee> 5.00 </fee>
            <SnoozeAccount> 0000 0000 0000 0001</SnoozeAccount>
            <status> verified </status>
            ...
    </Snooze>
...
</SnoozeResponse>
```

In one implementation, the Bill-Pay server 220 may provide a “snooze” transaction summary 256 to the user, which may take a form similar to the transaction record 233 in FIG. 2B.

FIG. 2G provides a data flow diagram illustrating aspects of Bill-Pay automatically snoozing a bill within alternative embodiments of the Bill-Pay. Within implementations, a user may set up “snooze” parameters 271 at a Bill-Pay portal. For example, the user may elect whether to let the Bill-Pay automatically substantiate the “snooze” component from a “snooze” account. In further implementations, the user may set up rules on “snooze,” e.g., automatically “snooze” bill amount greater than $300.00, automatically “snooze” bill amount due before a specified date, and/or the like.

In one implementation, the payment site 210 may generate a bill to the user 261, and may send consumer bill information 262 to the Bill-Pay server 220. For example, an exemplary XML formatted consumer bill information 262 may take a form similar to the following:

```
POST /bill.php HTTP/1.1
Host: www.us-mobile.com
Content-Type: Application/XML
Content-Length: 718
<?XML version = “1.0” encoding = “UTF-8”?>
<bill>
    ...
    <User>
        <UserName> John Smith </UserName>
        <UserID> JS0000 </UserID>
        <AccountNo> 0000 0000 0000 </AccountNO>
        <Password> 0000 </Password>
    ...
    </User>
    <BillDetails>
        <BillID> Feb-BB0008PPO </BillID>
        <BillerID> USM001 </BillerID>
        <BillerName> U.S. Mobile </BillerName>
        <BillDueDate> 12-15-2015 </BillDueDate>
        <AmountDue> 75.56 </AmountDue>
        ...
    </BillDetails>
...
</bill>
```

A gateway/card processor 265 at the Bill-Pay server 220, or independent of the Bill-Pay server 220, may retrieve consumer payment account information 263 based on the received bill information, and determine a user registered card no 263 for the bill payment. The card processor 265 may send the card number 263 to a card tokenization component 275, which may translate the card number into the corresponding card PAN 264 to a snooze logic component 280. The snooze logic component 280 may in turn determine whether to snooze 265 based on the PAN type, e.g., the received card PAN 264 is a default payment card PAN, or a snooze card PAN. In one implementation, the snooze logic may retrieve user configured auto-snooze rules to determine whether a “snooze” shall take place.

In one implementation, the snooze logic component 280 may generate a snooze decision 273a-b and forward it to the card processor 265. For example, an exemplary XML formatted snooze decision 273a-b may take a form similar to the following:

```
POST /snoozedecision.php HTTP/1.1
Host: www.snooze-logic.com
Content-Type: Application/XML
Content-Length: 718
<?XML version = “1.0” encoding = “UTF-8”?>
<snooze_decision>
    ...
    <User>
        <UserName> John Smith </UserName>
        <UserID> JS0000 </UserID>
        <AccountNo> 0000 0000 0000 </AccountNO>
        <Password> 0000 </Password>
    ...
    </User>
        <Bill>
        <BillID> Feb-BB0008PPO </BillID>
        <BillerID> USM001 </BillerID>
        <BillerName> U.S. Mobile </BillerName>
        <BillDueDate> 12-15-2015 </BillDueDate>
        <AmountDue> 75.56 </AmountDue>
        ...
    </Bill>
    <snooze_rule>
        <auto_min_amount> 300 </auto_min_amount>
        <auto_due_date> 1-1-2016 </auto_due_date>
        ...
    </snooze_rule>
    <snooze>
        <status> yes </status>
        <term> 10 days </term>
        <fee> 5.00 </fee>
        <snoozePAN> %R%R%R% </snoozePAN>
        ...
    </snooze>
...
</snooze_decision>
```

The card processor 265 may then proceed to send a “snooze” request 257c to the payment processing component 270 and/or an issuer 240 to process the snoozing payment, as shown in FIG. 2F.

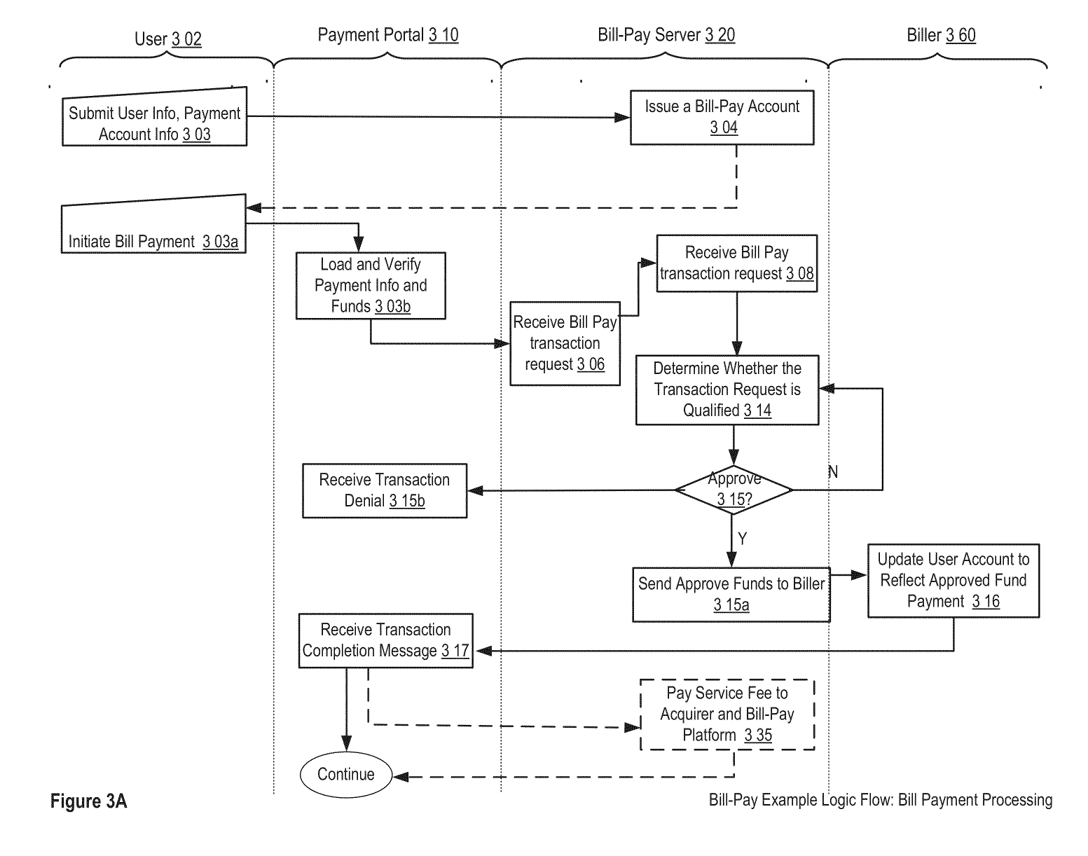

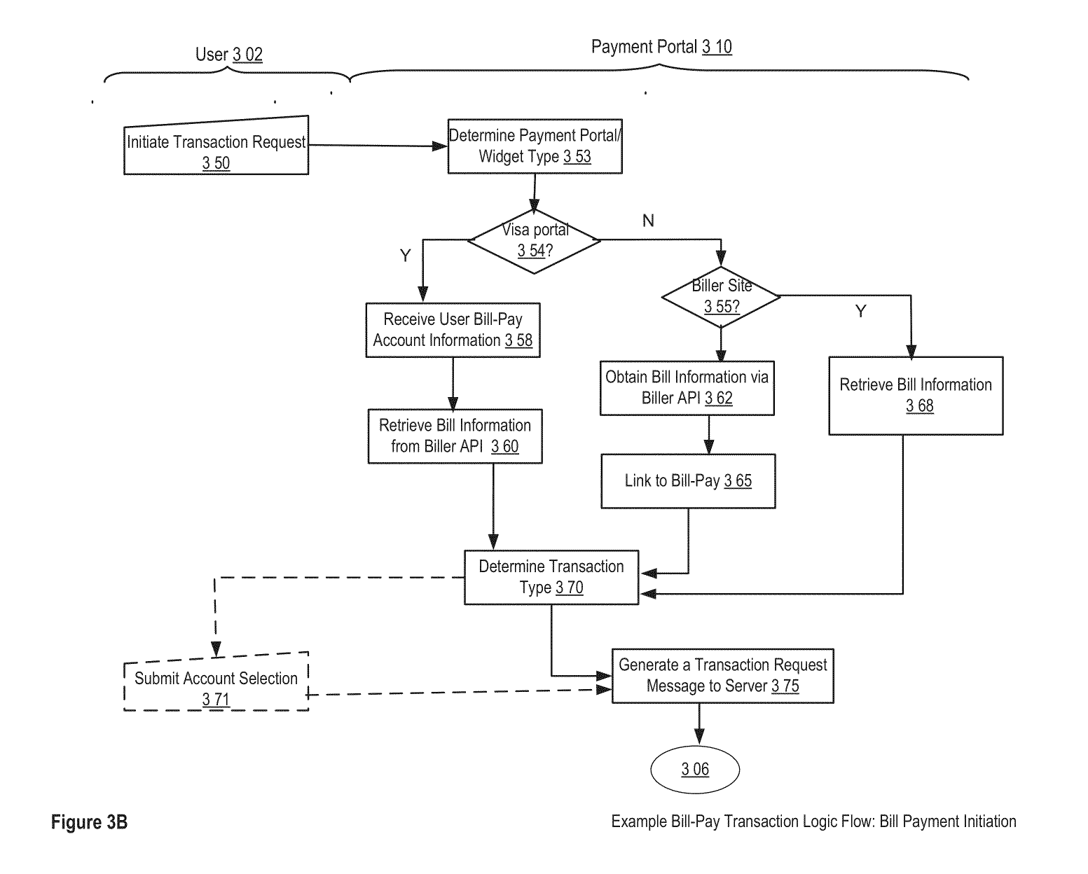

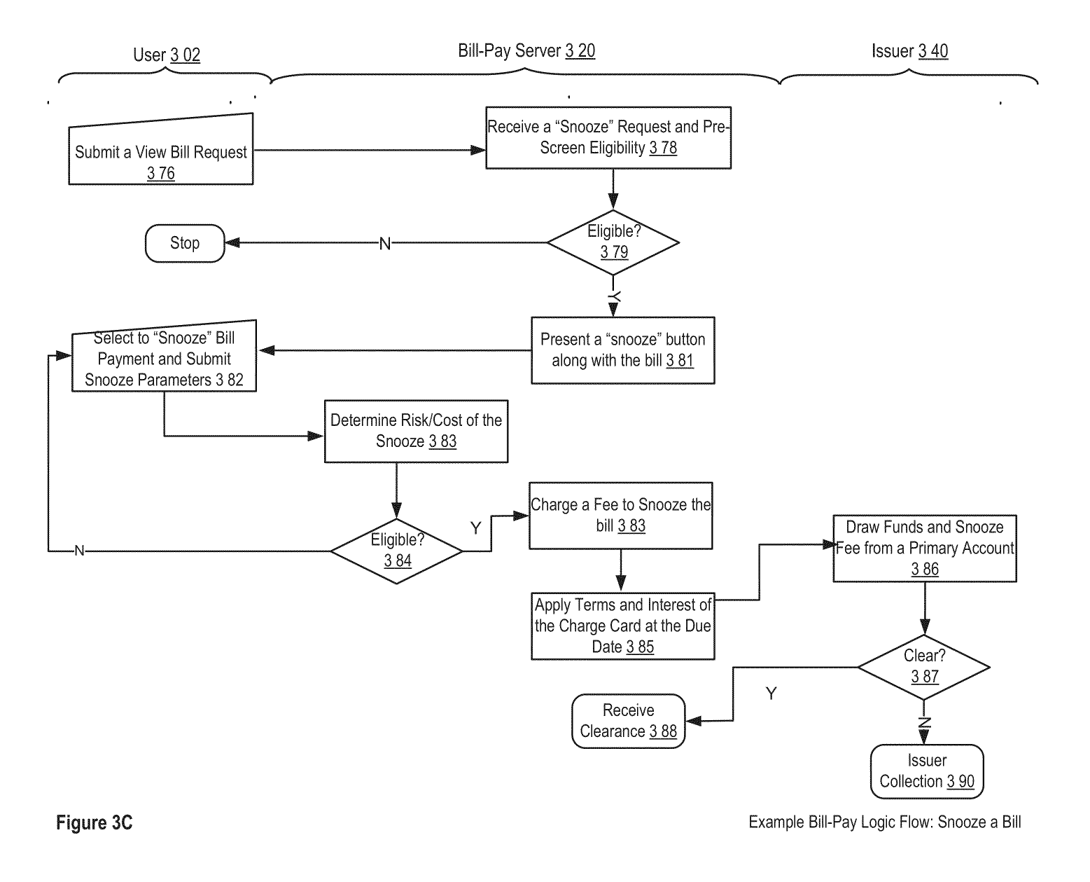

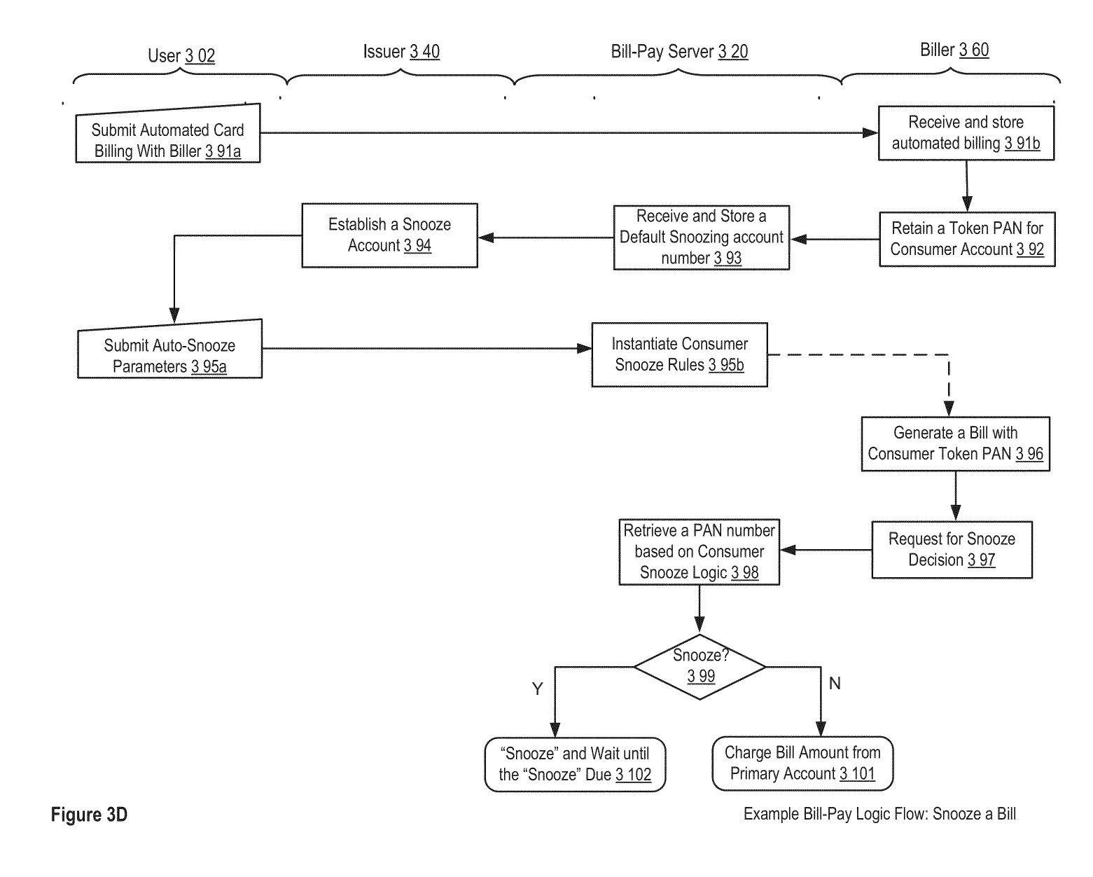

FIGS. 3A-3B provide example logic flow diagrams within embodiments of the Bill-Pay. In one implementation, a user 302 may submit user information and payment account information 303 (e.g., see 241 in FIG. 2C) for registration. Upon receiving the registration information, the Bill-Pay server 320 may issue a Bill-Pay account 304 to the user.

In one implementation, the user may initiate Bill-Pay 303a by submitting a payment request at a payment portal 310, which may load and verify payment information and funds 303b. The Bill-Pay server 320 may receive Bill-Pay transaction request 306, and determine whether the transaction request is qualified 314. For example, in one implementation, if the user has indicated to snooze the bill, the Bill-Pay server may determine whether such a request may be granted.

If the transaction is approved 315, the Bill-Pay server 320 may process a fund transfer request, and send approved funds to the Biller 315a. Otherwise, the payment portal may receive and display a transaction denial message 315b.

In another implementation, upon successful payment, the Biller 360 may update user account to reflect an approved bill payment 316, and send a transaction complete message 317 to the payment portal. In further implementations, the Bill-Pay server 320 may receive a service fee sponsored by the Biller 335.

FIG. 3B provides a logic flow diagram illustrating bill payment initiation at various payment portals within embodiments of the Bill-Pay. In one implementation, upon user initiating a transaction request 350 at a payment portal 310, the payment portal may determine whether it is a payment portal (e.g., a Visa payment website, a biller site, etc.) or a payment widget at a third party site 353. In one implementation, it is a Visa portal site 354, the payment portal may receive user bill-pay account information 358 and retrieve bill information from a biller API 360. In another implementation, if the payment portal comprises a widget within a third party site 355, the payment portal may obtain bill information via a biller API 362 and link to Bill-Pay server 365. In another implementation, if the payment portal is at a biller site, the payment portal may retrieve bill information 368, and proceed to determine a transaction type 370. For example, whether the bill payment transaction request comprises a snooze bill request, etc. In one implementation, the payment portal may generate a transaction request message to the Bill-Pay server 375, and proceed with 306 in FIG. 3A. In another implementation, the portal may receive a user submitted payment account selection 371 from a user, and forward such payment request to the Bill-Pay server 375.

FIG. 3C provides a logic flow diagram illustrating aspects of a user snoozing a bill via a payment portal within embodiments of the Bill-Pay. Within implementations, a consumer 302 may submit a view bill request to opt-in to receive “Snooze” functionality 376. Upon receiving the request, the Bill-Pay 320 may pre-screens consumer, e.g., to decide temporary line of credit and float duration 378. For example, the issuer may pre-screen of one functionality is consider a soft hit on credit bureau, which may be similar to credit card mailer offers. If eligible 379, the Bill-Pay may present a “Snooze” button next to the “Pay Now” button 381 on a pre-approved consumer's bill (e.g., see FIG. 1C) along with the temporary line available and duration of the flow.

In one implementation, the consumer may selects to “Snooze” bill payment as per the offer terms 382. In one implementation, the user may select an amount to snooze, which may be partial or the entire bill amount, e.g., see 146 in FIG. 1C. In another implementation, the user may select a snooze term, e.g., see 154 in FIG. 1C, etc. In one implementation, the Bill-Pay server may calculate a cost of the snoozing parameters 383 and the associated risk, e.g., whether the user has sufficient balance to cover the snooze cost, the user's bill payment and snooze payment history, credit line, and/or the like. In one implementation, if the Bill-Pay server determines the user is eligible to snooze the selected amount for a selected term, a fee may be charged to the consumer to “Snooze” a bill 383 by the Bill-Pay. Within implementations, when the “Snooze” payment becomes due, the Bill-Pay may apply the terms and interest of the credit/charge card 385. For example, at the end of the “snooze” period (e.g. 10 days) the issuer 340 may draw the amount due and the “snooze” fee from the consumer established primary account to settle the snooze account, or by means determined by the issuer and consumer to clear the charge account, e.g., by check, wired transfer, and/or the like.

If the snooze bill account is cleared 387, the Bill-Pay may receive a clearance message 388 from the issuer. Otherwise, collections for any unsettled snooze account may be the responsibility of the issuer of the snooze credit product 390. For example, if the user established a Bank of America credit card account as a “snooze” account, the issuer, Bank of America, may pay a biller and collect the payment amount plus a snooze fee from the user to clear the payment.

FIG. 3D provides a logic flow diagram illustrating aspects of Bill-Pay automatically snoozing a bill within alternative embodiments of the Bill-Pay. Within implementations, an automated service determines when merchant initiated transactions may be “snoozed” based on preferences or instructions setup by the consumer. For example, if a consumer anticipates that an automated recurring bill payments (like a wireless bill) might reach their account before payday when their account may not have sufficient funds, they may desire to postpone the bill payment by way of “snoozing” the bill. In order to remain in good standing with their biller, and/or to avoid any penalties, the consumer might instruct the service to snooze all or designated incoming payments for a certain period of time.

In one implementation, the consumer may need to enroll in Bill-Pay to manage their recurring bill payments. The biller or their payment processor is also enrolled with Bill-Pay, which stores card numbers on behalf of the merchant (e.g., a tokenization service).

In one implementation, a consumer may set up automated card billing with a biller 391a. The biller 360 may receive and store the automated billing request with the user profile 391b, and retain a token representing the consumers default card account 392. The consumers actual default card account numbers may be sent to and stored by the Bill-Pay in the tokenization service 393.

The consumer 302 and an issuer 340 may set up a snooze account 394 via the Bill-Pay. For example, this snooze account may be backed by a virtual credit account with a unique PAN (16 digit card number) which is different than the consumers default account (e.g. a debit PAN).

In one implementation, the consumer 302 may provide parameters and instructions 395a to the Bill-Pay 320 on when to “snooze” payments. These instructions may include criteria based on factors such as: merchant name, merchant category, date/timing of payment, dollar value, available balance in primary account, if a previous transaction was declined by the primary account issuer etc. The Bill-Pay may instantiate consumer auto-snooze rules 395b based on the submitted instructions, e.g., to auto-snooze a bill before a specified due date, a bill with amount due greater than a threshold amount, a bill from a specified biller, and/or the like.

Within implementations, the biller 360 may send instruction to their payment gateway or process to bill the consumer including the consumers unique token 396, and may request the consumers PAN number from the tokenization service managed by the Bill-Pay 397 for a snooze decision. The tokenization service at Bill-Pay 320 may apply snooze logic to return either the default PAN or the snooze PAN to the processor based on consulting the consumers preference for the transaction 398. In alternative implementations, the Bill-Pay 320 may, via the biller's acquirer, complete the transaction to the appropriate account designated by the platform on behalf of the user. For example, if the PAN indicates to snooze 399, the Bill-Pay may “snooze” the bill and wait until the “snooze” due (e.g., the original due date plus a “snooze” period) to charge the amount due plus a snooze fee from the consumer's account 3102. If not, the Bill-Pay may charge the bill amount from the consumer's default primary account 3101.

FIGS. 4A-4F provide exemplary web-based user interfaces illustrating Bill-Pay portal within various embodiments of the Bill-Pay. Within implementations, as shown in FIG. 4A, the Bill-Pay may provide notifications that alert a consumer to high bills (e.g., 401) as well as opportunities to earn rewards, points, or save money with customized merchant offers and discounts, e.g., 403. In one implementation, the Bill-Pay portal may provide upcoming bills associated with the user which is not set to auto-pay in order of due date, e.g., 402, and the user may click on a bill to view bill details. In one implementation, a user may select payment methods by clicking to pay, e.g., 406, with a credit card, a debit card, and bank accounts that have been added by the user to his Bill-Pay account during registration, e.g., 404.

In another implementation, the user may set up automatic bill payment via the Bill-Pay registration, e.g., 405.

With reference to FIG. 4B, the Bill-Pay may provide a bill payment widget, e.g., a pop up window 407, at a biller site. For example, the Bill-Pay widget may provide a link to a Bill-Pay portal site, e.g., a Visa pay site, etc. IN one implementation, a user may view bill information 408 via the payment widget and proceed to bill payment 409. In a further implementation, the Bill-Pay widget may provide issuer promotions, e.g., a user may apply for a new credit card, etc., 410 via the widget.

With reference to FIG. 4C, upon a user proceeding with bill payment, the user may link back to a Bill-Pay portal site (e.g., the Visa pay site, etc.) from the payment widget, e.g., to view a summary of payment record.

With reference to FIG. 4D, a user may view a Bill-Pay widget within an email message. For example, a user may receive an electronic bill from a biller in the email, including a Bill-Pay widget button 417, and by selecting the button, the user may proceed to bill payment at a pop up window (e.g., in a similar form as shown in FIG. 144B).

With reference to FIG. 4E, the Bill-Pay may prioritize notifications and actions with an intelligent hierarchy across bill pay touch points. As shown in FIG. 4E, the bill-Pay may show a chart of past payment history that highlights a bill that is out of the normal pattern, e.g., in a different color in the chart, 420. In another example, the Bill-Pay may provide related offers to the biller, e.g., an offer form US Mobile about a free unlimited data plan, 421.

FIG. 4F provides another example of notifications of offers and rewards for the Bill-Pay customers within embodiments of the Bill-Pay.

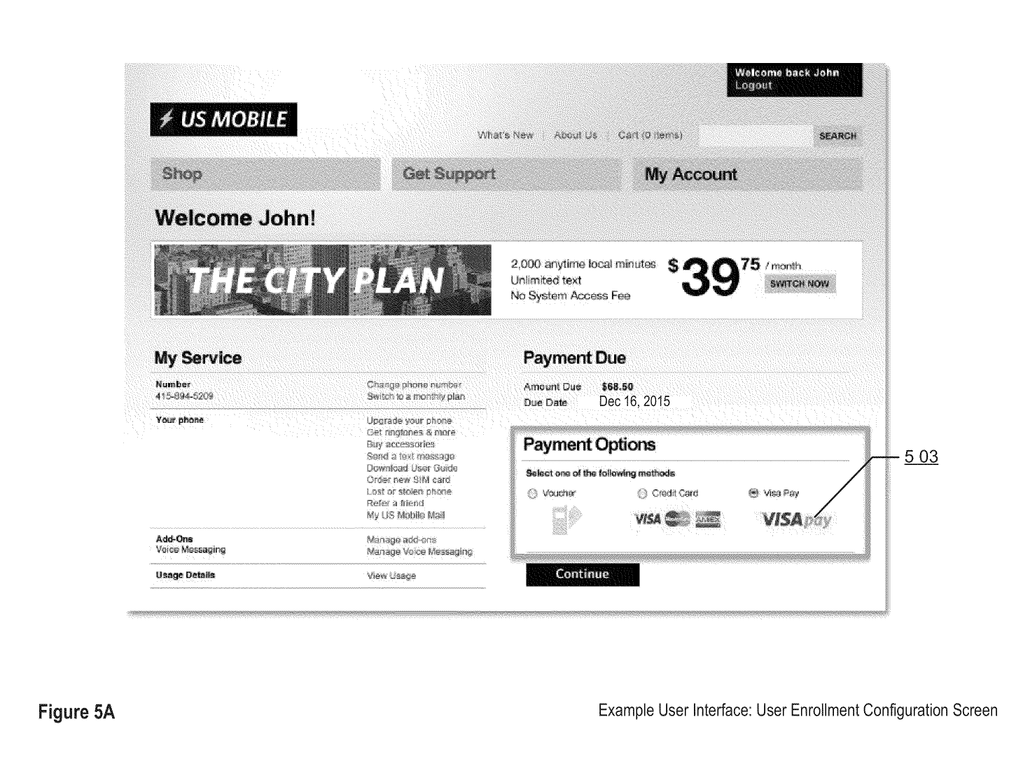

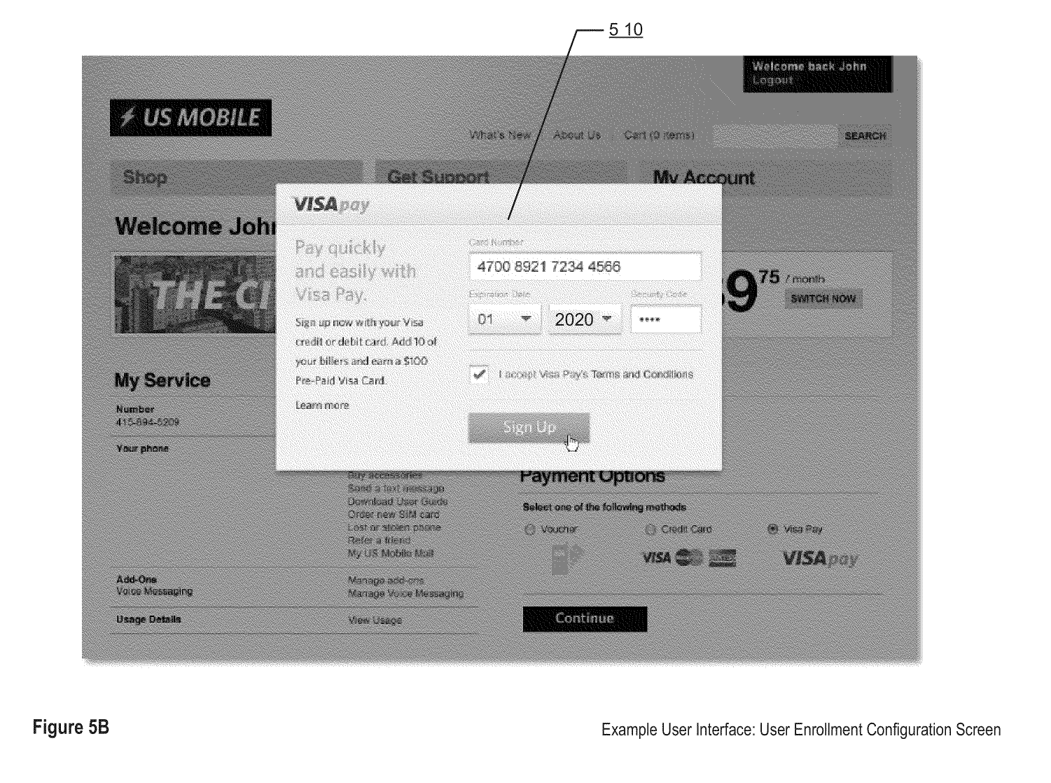

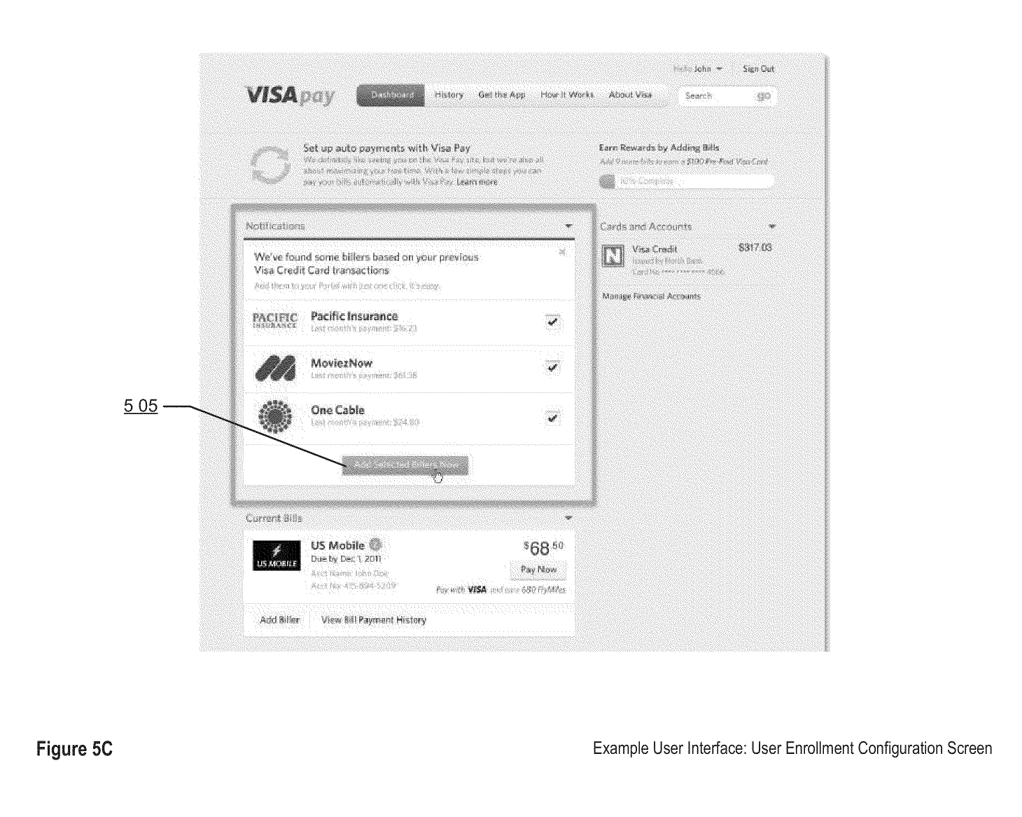

FIGS. 5A-5C provide alternative user interfaces of Bill-Pay at a biller site within embodiments of the Bill-Pay. For example, in one implementation, a user may select an payment option 503 to proceed to pay for a bill retrieved at the biller site. With reference to FIG. 5B, a user may enroll a payment card for Bill-Pay at a biller site by entering card number at a Bill-Pay enrollment widget, e.g., a pop-up window 510. With reference to FIG. 5C, a user may also add biller information within his Bill-Pay account profile 505.

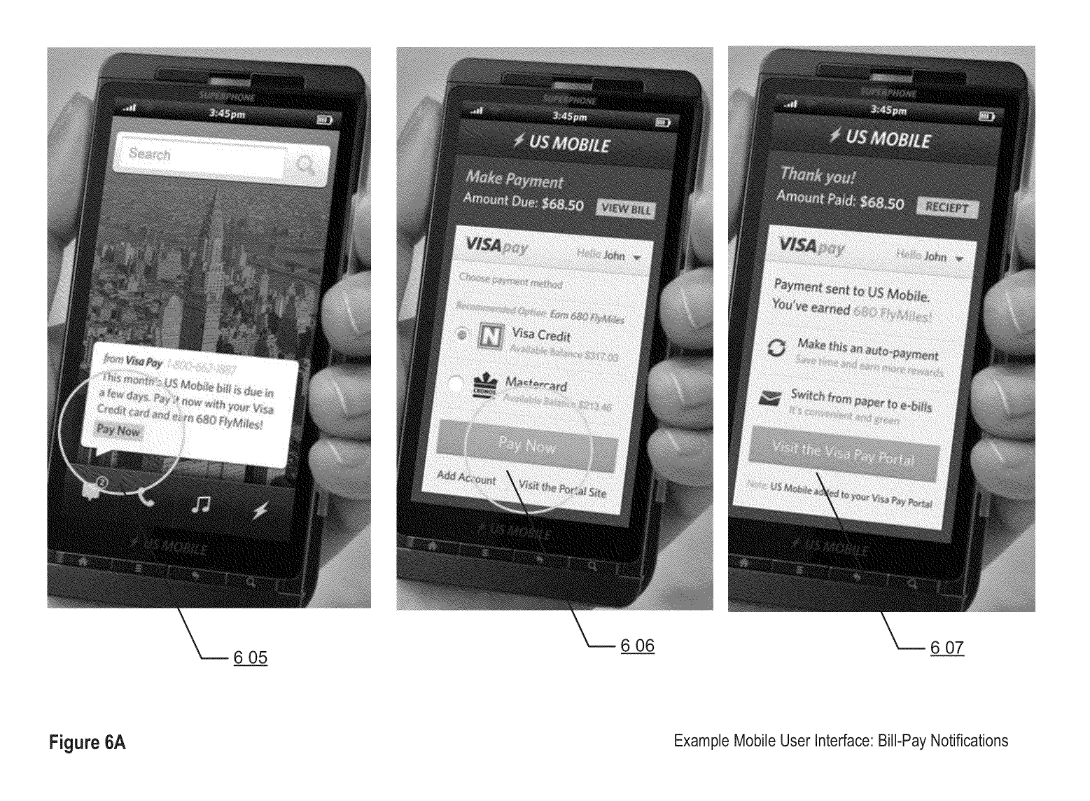

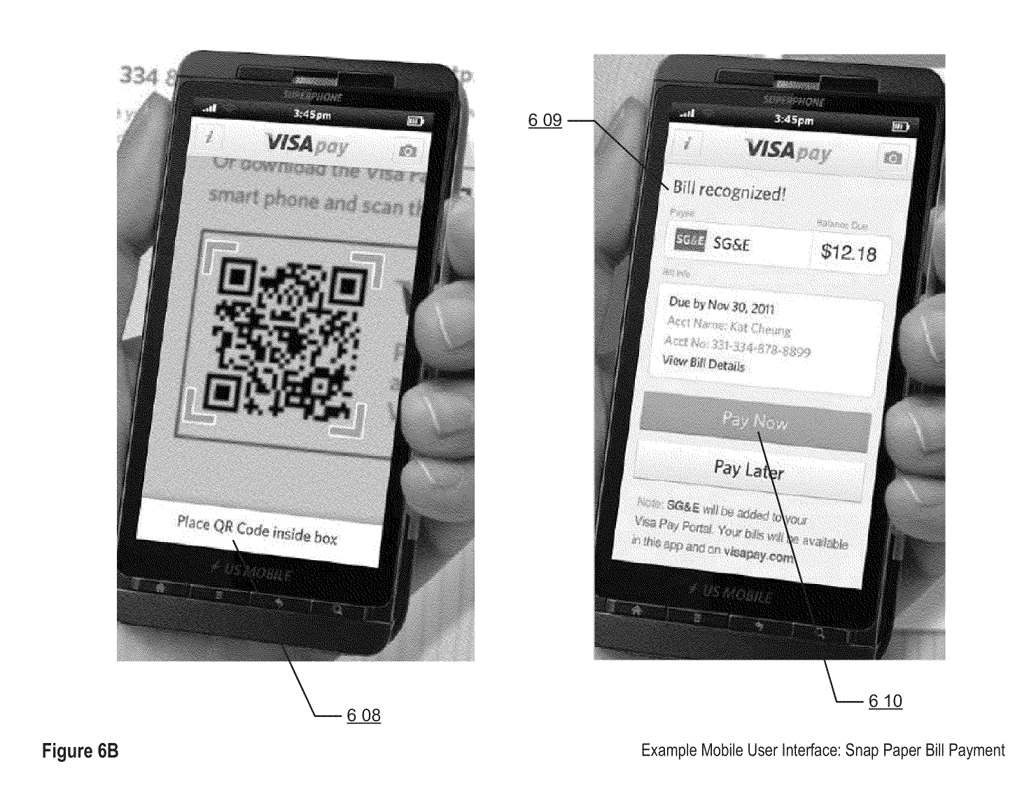

FIGS. 6A-6B provide exemplary mobile user interfaces within embodiments of the Bill-Pay. Within implementations, a user may operate a mobile device and select to pay a bill at a mobile message 605, e.g., sent from the Bill-Pay. In one implementation, the user may be connected to a Bill-Pay widget 606 and have the option to be directed to a Bill-Pay portal site 607.

With reference to FIG. 6B, a user may snap a photo of a QR code printed on a paper bill 608, and submit the image to a Bill-Pay portal, which may recognize the QR code to retrieve bill 609 and facilitate user payment 610.

### Additional Features of a Bill-Pay Electronic Wallet

FIG. 7 shows a user interface diagram illustrating an overview of example features of virtual wallet applications in some embodiments of the Bill Pay. FIG. 7 shows an illustration of various exemplary features of a virtual wallet mobile application 700. Some of the features displayed include a wallet 701, social integration via TWITTER, FACEBOOK, etc., offers and loyalty 703, snap mobile purchase 704, alerts 705 and security, setting and analytics 796. These features are explored in further detail below.

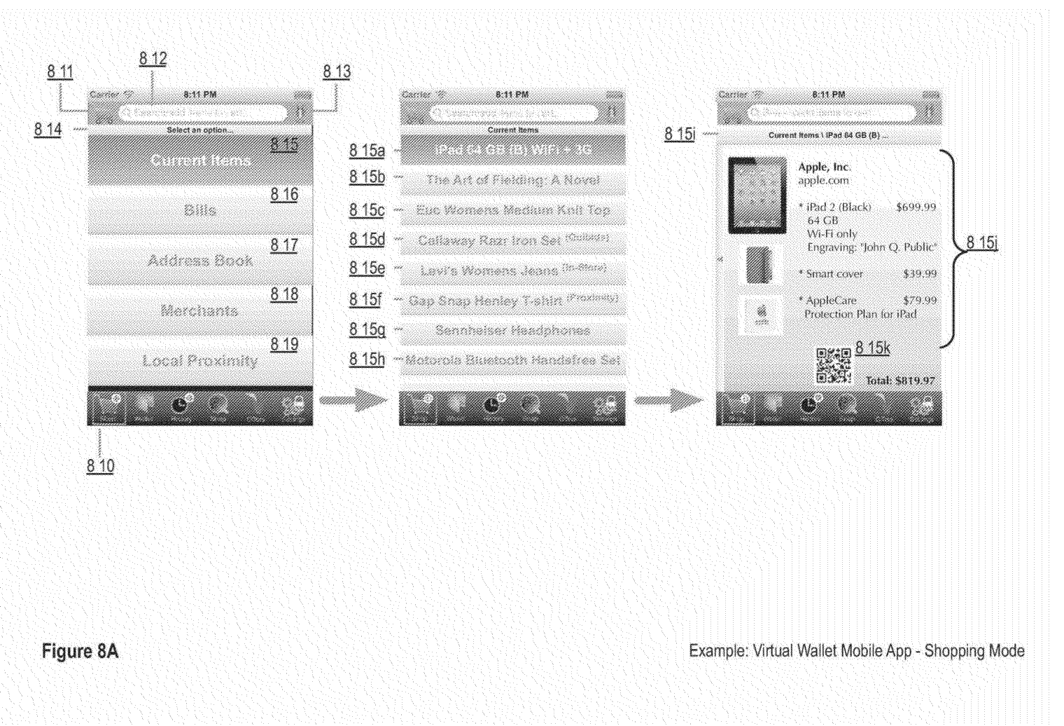

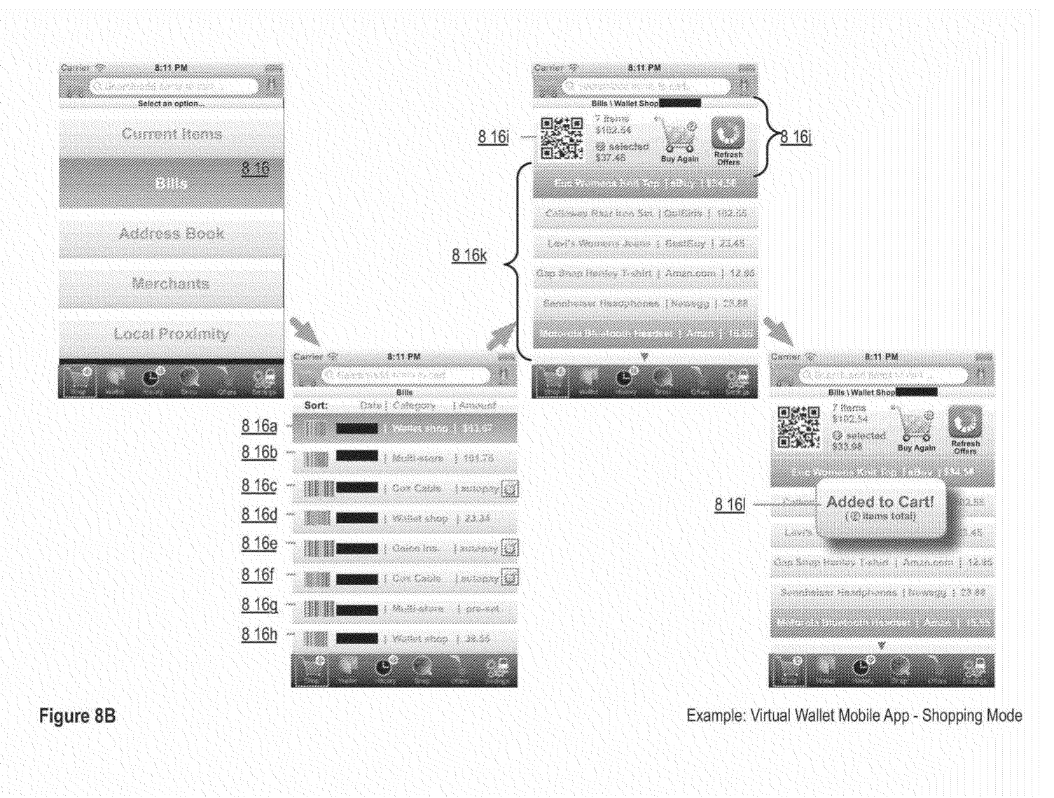

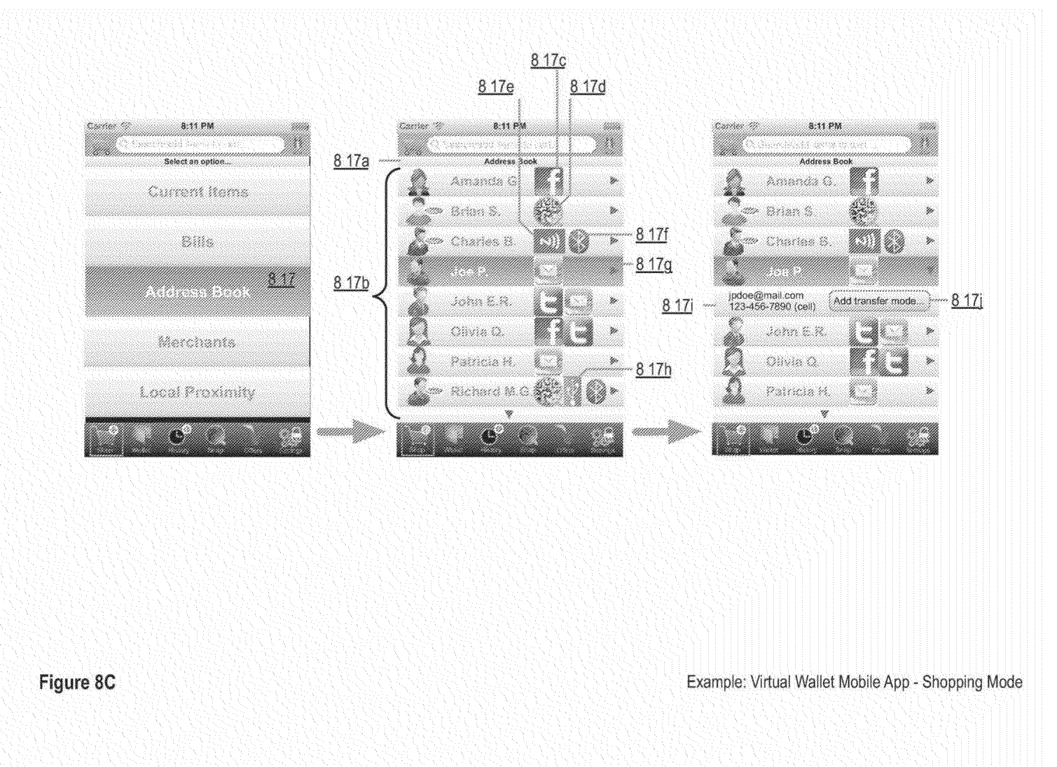

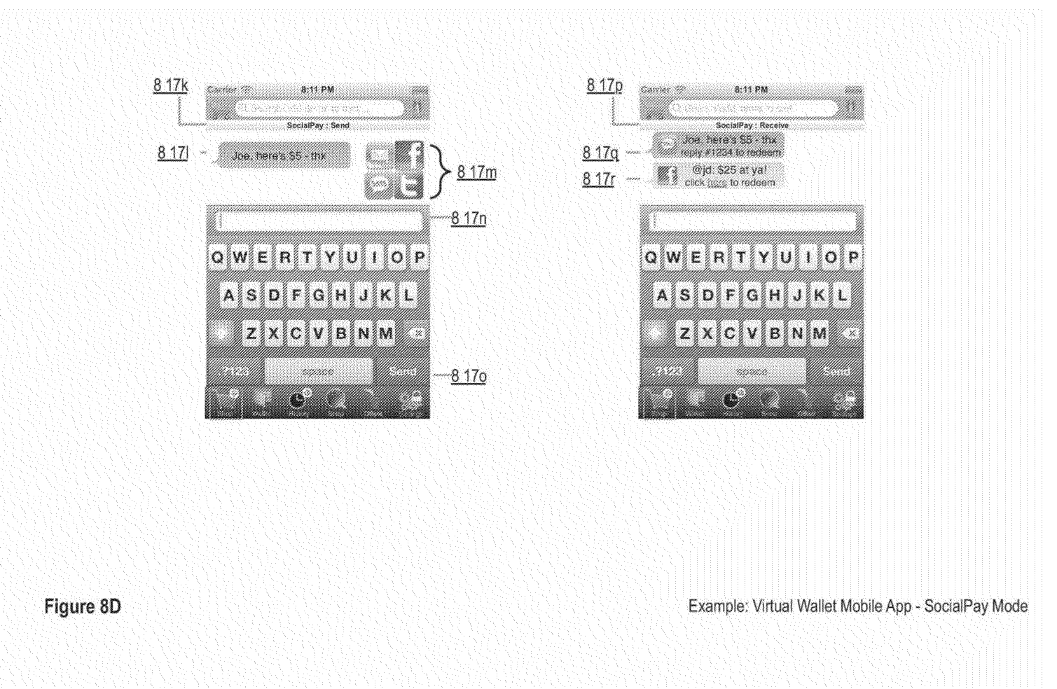

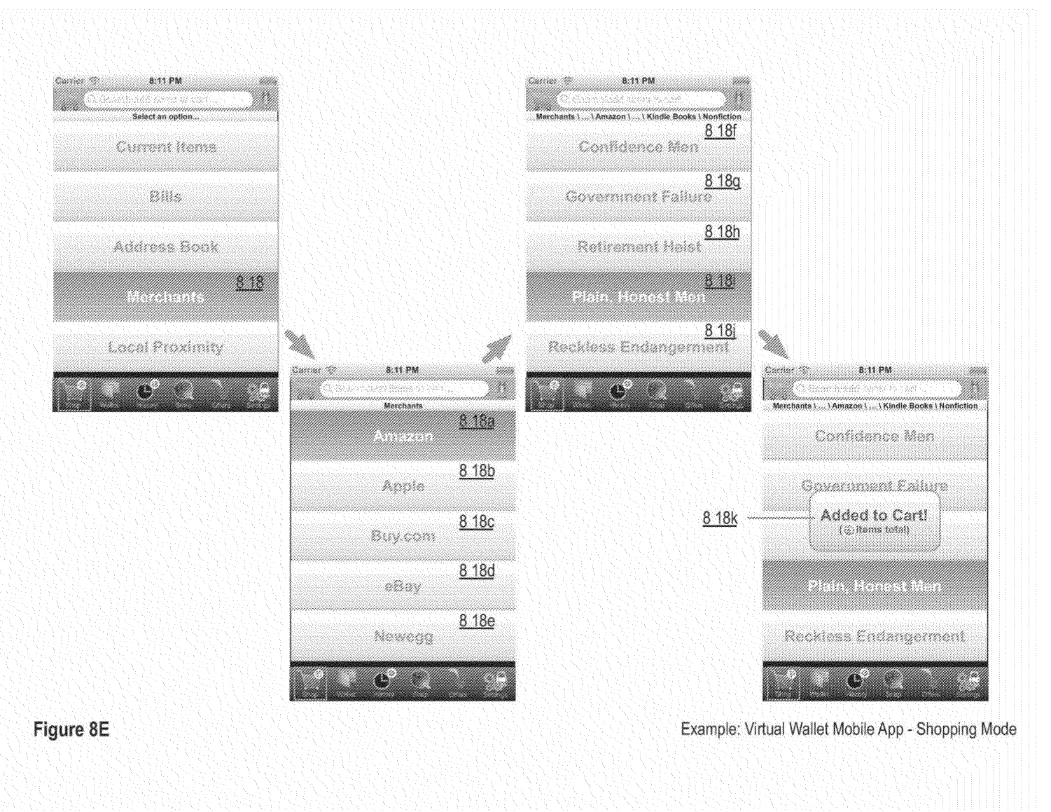

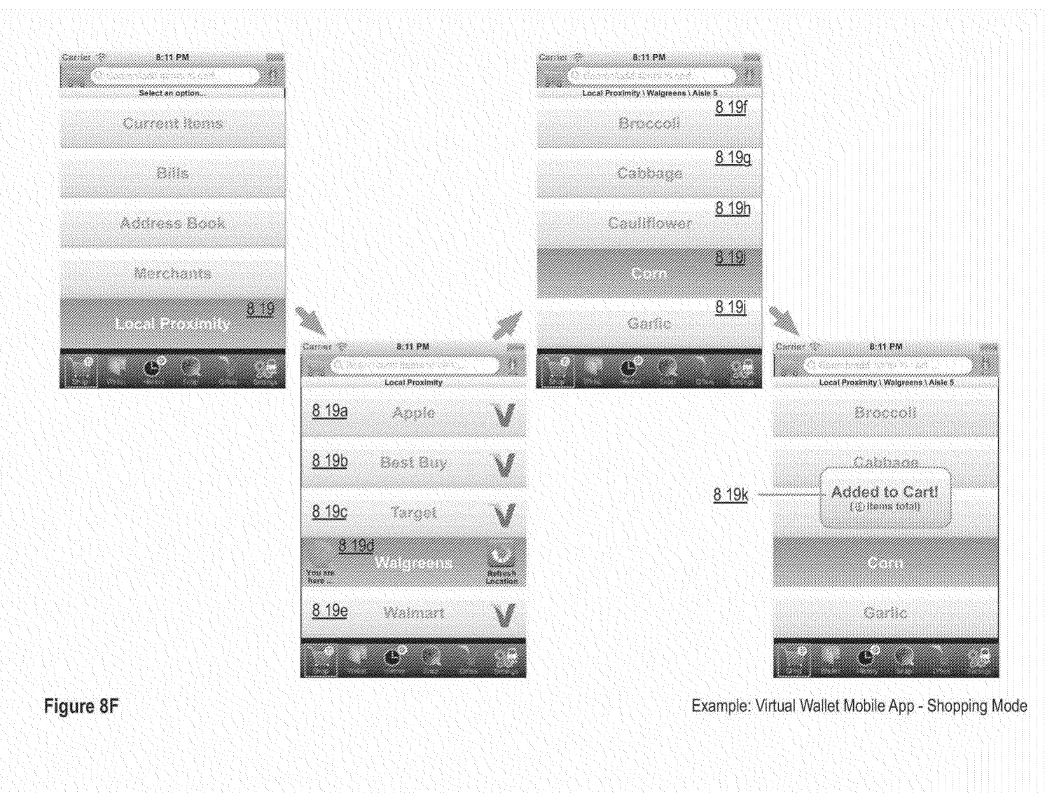

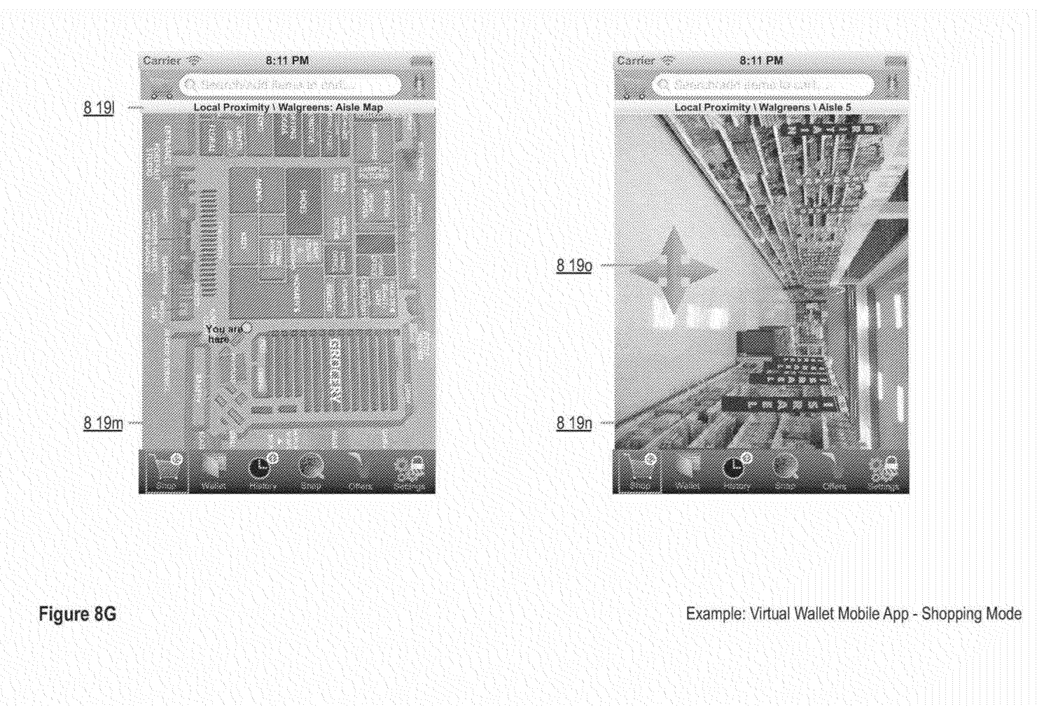

FIGS. 8A-G show user interface diagrams illustrating example features of virtual wallet applications in a shopping mode, in some embodiments of the Bill Pay. With reference to FIG. 8A, some embodiments of the virtual wallet mobile app facilitate and greatly enhance the shopping experience of consumers. A variety of shopping modes, as shown in FIG. 8A, may be available for a consumer to peruse. In one implementation, for example, a user may launch the shopping mode by selecting the shop icon 810 at the bottom of the user interface. A user may type in an item in the search field 812 to search and/or add an item to a cart 811. A user may also use a voice activated shopping mode by saying the name or description of an item to be searched and/or added to the cart into a microphone 813. In a further implementation, a user may also select other shopping options 814 such as current items 815, bills 816, address book 817, merchants 818 and local proximity 819.

In one embodiment, for example, a user may select the option current items 815, as shown in the left most user interface of FIG. 8A. When the current items 815 option is selected, the middle user interface may be displayed. As shown, the middle user interface may provide a current list of items 815a-h in a user's shopping cart 811. A user may select an item, for example item 815a, to view product description 815j of the selected item and/or other items from the same merchant. The price and total payable information may also be displayed, along with a QR code 815k that captures the information necessary to effect a snap mobile purchase transaction.

With reference to FIG. 8B, in another embodiment, a user may select the bills 816 option. Upon selecting the bills 816 option, the user interface may display a list of bills and/or receipts 816a-h from one or more merchants. Next to each of the bills, additional information such as date of visit, whether items from multiple stores are present, last bill payment date, auto-payment, number of items, and/or the like may be displayed. In one example, the wallet shop bill 816a dated Jan. 20, 2011 may be selected. The wallet shop bill selection may display a user interface that provides a variety of information regarding the selected bill. For example, the user interface may display a list of items 816k purchased, <<816i>>, a total number of items and the corresponding value. For example, 7 items worth $102.54 were in the selected wallet shop bill. A user may now select any of the items and select buy again to add purchase the items. The user may also refresh offers 816j to clear any invalid offers from last time and/or search for new offers that may be applicable for the current purchase. As shown in FIG. 8B, a user may select two items for repeat purchase. Upon addition, a message 816l may be displayed to confirm the addition of the two items, which makes the total number of items in the cart 14.

With reference to FIG. 8C, in yet another embodiment, a user may select the address book option 817 to view the address book 817a which includes a list of contacts 817b and make any money transfers or payments. In one embodiment, the address book may identify each contact using their names and available and/or preferred modes of payment. For example, a contact Amanda G. may be paid via social pay (e.g., via FACEBOOK) as indicated by the icon 817c. In another example, money may be transferred to Brian S. via QR code as indicated by the QR code icon 817d. In yet another example, Charles B. may accept payment via near field communication 817e, Bluetooth 817f and email 817g. Payment may also be made via USB 817h (e.g., by physically connecting two mobile devices) as well as other social channels such as TWITTER.

In one implementation, a user may select Joe P. for payment. Joe P., as shown in the user interface, has an email icon 817g next to his name indicating that Joe P. accepts payment via email. When his name is selected, the user interface may display his contact information such as email, phone, etc. If a user wishes to make a payment to Joe P. by a method other than email, the user may add another transfer mode 817j to his contact information and make a payment transfer. With reference to FIG. 8D, the user may be provided with a screen 817k where the user can enter an amount to send Joe, as well as add other text to provide Joe with context for the payment transaction 817l. The user can choose modes (e.g., SMS, email, social networking) via which Joe may be contacted via graphical user interface elements, 817m. As the user types, the text entered may be provided for review within a GUI element 817n. When the user has completed entering in the necessary information, the user can press the send button 817o to send the social message to Joe. If Joe also has a virtual wallet application, Joe may be able to review 817p social pay message within the app, or directly at the website of the social network (e.g., for Twitter™, Facebook®, etc.). Messages may be aggregated from the various social networks and other sources (e.g., SMS, email). The method of redemption appropriate for each messaging mode may be indicated along with the social pay message. In the illustration in FIG. 8D, the SMS 817q Joe received indicates that Joe can redeem the $5 obtained via SMS by replying to the SMS and entering the hash tag value ‘#1234’. In the same illustration, Joe has also received a message 817r via Facebook®, which includes a URL link that Joe can activate to initiate redemption of the $25 payment.

With reference to FIG. 8E, in some other embodiments, a user may select merchants 818 from the list of options in the shopping mode to view a select list of merchants 818a-e. In one implementation, the merchants in the list may be affiliated to the wallet, or have affinity relationship with the wallet. In another implementation, the merchants may include a list of merchants meeting a user-defined or other criteria. For example, the list may be one that is curated by the user, merchants where the user most frequently shops or spends more than an x amount of sum or shopped for three consecutive months, and/or the like. In one implementation, the user may further select one of the merchants, Amazon 818a for example. The user may then navigate through the merchant's listings to find items of interest such as 818f-j. Directly through the wallet and without visiting the merchant site from a separate page, the user may make a selection of an item 818j from the catalog of Amazon 818a. As shown in the right most user interface of FIG. 8D, the selected item may then be added to cart. The message 818k indicates that the selected item has been added to the cart, and updated number of items in the cart is now 13.

With reference to FIG. 8F, in one embodiment, there may be a local proximity option 819 which may be selected by a user to view a list of merchants that are geographically in close proximity to the user. For example, the list of merchants 819a-e may be the merchants that are located close to the user. In one implementation, the mobile application may further identify when the user in a store based on the user's location. For example, position icon 819d may be displayed next to a store (e.g., Walgreens) when the user is in close proximity to the store. In one implementation, the mobile application may refresh its location periodically in case the user moved away from the store (e.g., Walgreens). In a further implementation, the user may navigate the offerings of the selected Walgreens store through the mobile application. For example, the user may navigate, using the mobile application, to items 819f-j available on aisle 5 of Walgreens. In one implementation, the user may select corn 819i from his or her mobile application to add to cart 819k.

With reference to FIG. 8G, in another embodiment, the local proximity option 819 may include a store map and a real time map features among others. For example, upon selecting the Walgreens store, the user may launch an aisle map 819l which displays a map 819m showing the organization of the store and the position of the user (indicated by a yellow circle). In one implementation, the user may easily configure the map to add one or more other users (e.g., user's kids) to share each other's location within the store. In another implementation, the user may have the option to launch a “store view” similar to street views in maps. The store view 819n may display images/video of the user's surrounding. For example, if the user is about to enter aisle 5, the store view map may show the view of aisle 5. Further the user may manipulate the orientation of the map using the navigation tool 819o to move the store view forwards, backwards, right, left as well clockwise and counterclockwise rotation

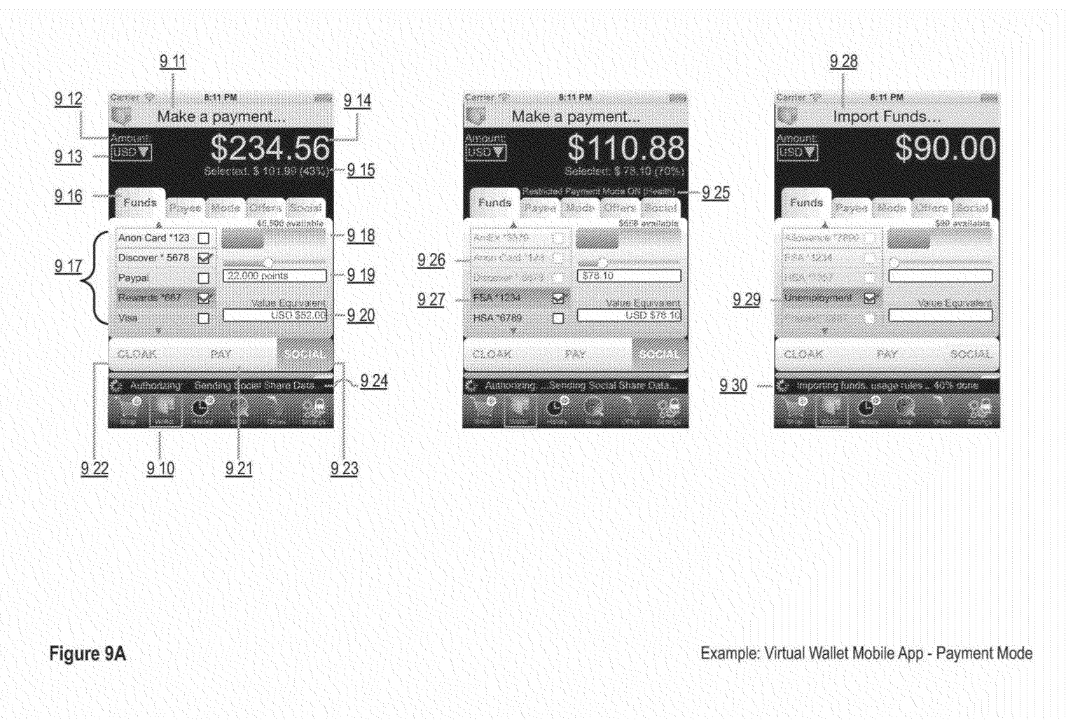

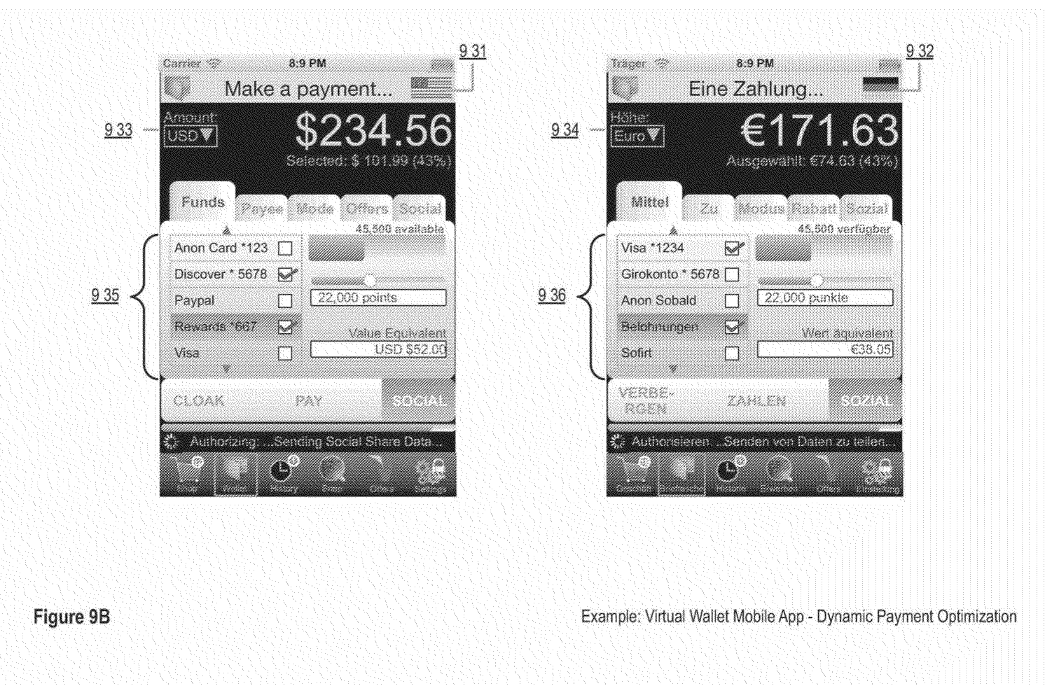

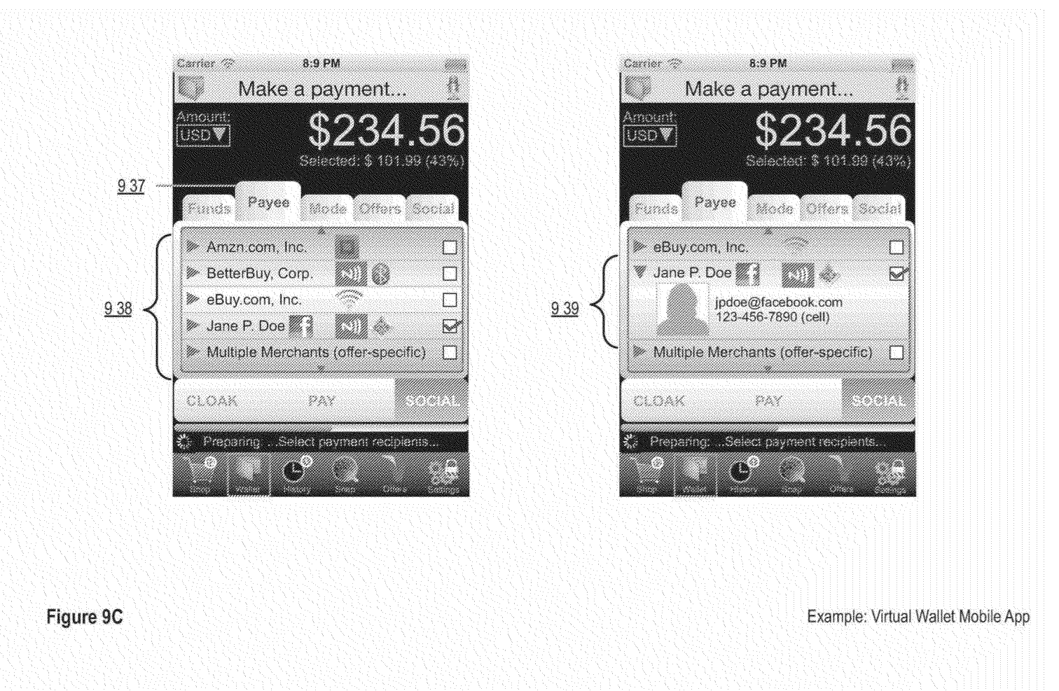

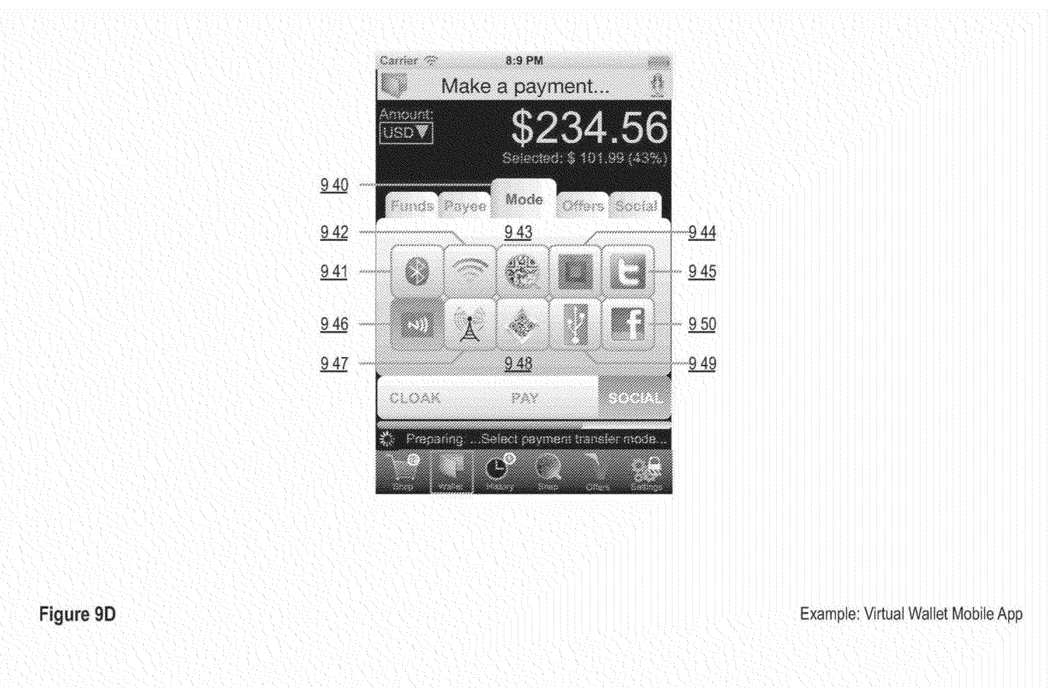

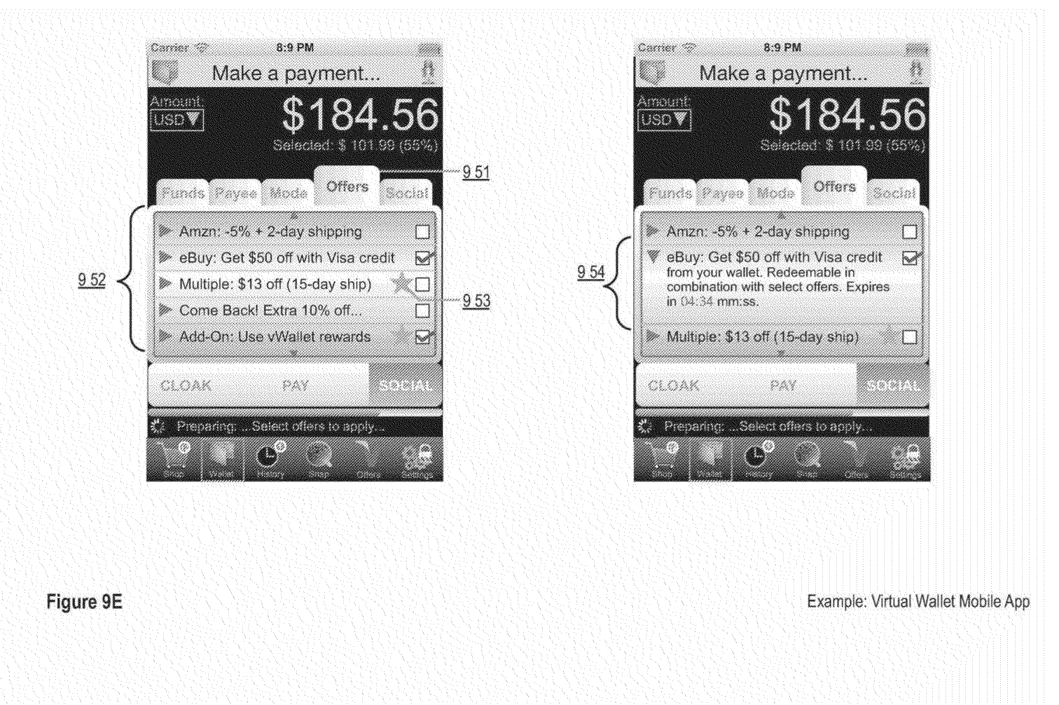

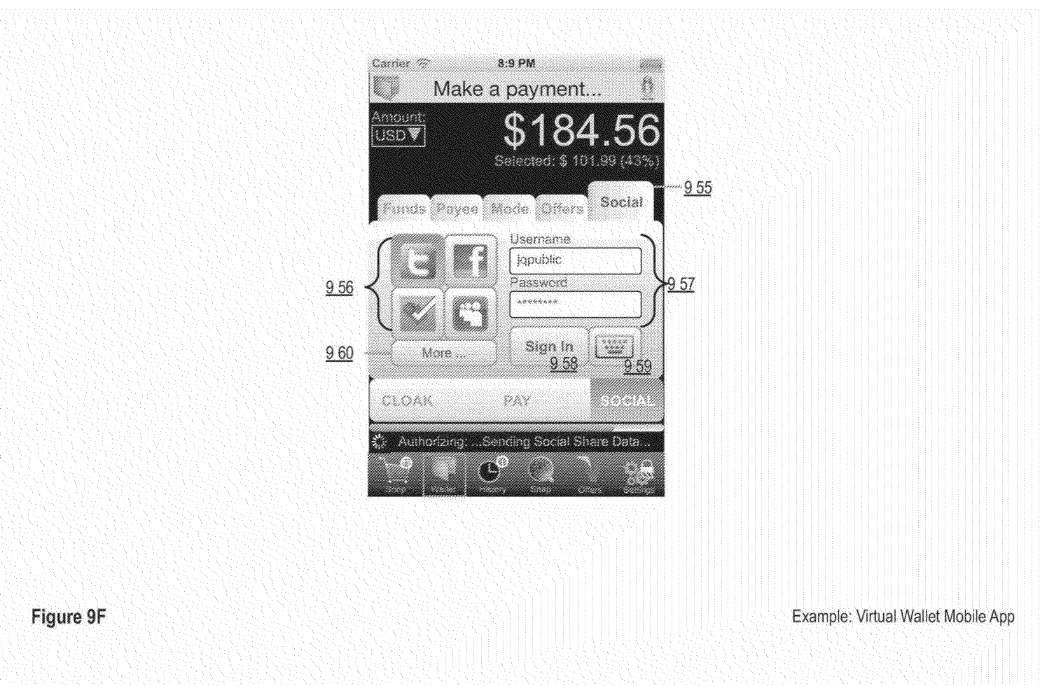

FIGS. 9A-F show user interface diagrams illustrating example features of virtual wallet applications in a payment mode, in some embodiments of the Bill Pay. With reference to FIG. 9A, in one embodiment, the wallet mobile application may provide a user with a number of options for paying for a transaction via the wallet mode 910. In one implementation, an example user interface 911 for making a payment is shown. The user interface may clearly identify the amount 912 and the currency 913 for the transaction. The amount may be the amount payable and the currency may include real currencies such as dollars and euros, as well as virtual currencies such as reward points. The amount of the transaction 914 may also be prominently displayed on the user interface. The user may select the funds tab 916 to select one or more forms of payment 917, which may include various credit, debit, gift, rewards and/or prepaid cards. The user may also have the option of paying, wholly or in part, with reward points. For example, the graphical indicator 918 on the user interface shows the number of points available, the graphical indicator 919 shows the number of points to be used towards the amount due 234.56 and the equivalent 920 of the number of points in a selected currency (USD, for example).

In one implementation, the user may combine funds from multiple sources to pay for the transaction. The amount 915 displayed on the user interface may provide an indication of the amount of total funds covered so far by the selected forms of payment (e.g., Discover card and rewards points). The user may choose another form of payment or adjust the amount to be debited from one or more forms of payment until the amount 915 matches the amount payable 914. Once the amounts to be debited from one or more forms of payment are finalized by the user, payment authorization may begin.

In one implementation, the user may select a secure authorization of the transaction by selecting the cloak button 922 to effectively cloak or anonymize some (e.g., pre-configured) or all identifying information such that when the user selects pay button 921, the transaction authorization is conducted in a secure and anonymous manner. In another implementation, the user may select the pay button 921 which may use standard authorization techniques for transaction processing. In yet another implementation, when the user selects the social button 923, a message regarding the transaction may be communicated to one of more social networks (set up by the user) which may post or announce the purchase transaction in a social forum such as a wall post or a tweet. In one implementation, the user may select a social payment processing option 923. The indicator 924 may show the authorizing and sending social share data in progress.

In another implementation, a restricted payment mode 925 may be activated for certain purchase activities such as prescription purchases. The mode may be activated in accordance with rules defined by issuers, insurers, merchants, payment processor and/or other entities to facilitate processing of specialized goods and services. In this mode, the user may scroll down the list of forms of payments 926 under the funds tab to select specialized accounts such as a flexible spending account (FSA) 927, health savings account (HAS), and/or the like and amounts to be debited to the selected accounts. In one implementation, such restricted payment mode 925 processing may disable social sharing of purchase information.

In one embodiment, the wallet mobile application may facilitate importing of funds via the import funds user interface 928. For example, a user who is unemployed may obtain unemployment benefit fund 929 via the wallet mobile application. In one implementation, the entity providing the funds may also configure rules for using the fund as shown by the processing indicator message 930. The wallet may read and apply the rules prior, and may reject any purchases with the unemployment funds that fail to meet the criteria set by the rules. Example criteria may include, for example, merchant category code (MCC), time of transaction, location of transaction, and/or the like. As an example, a transaction with a grocery merchant having MCC 5411 may be approved, while a transaction with a bar merchant having an MCC 5813 may be refused.

With reference to FIG. 9B, in one embodiment, the wallet mobile application may facilitate dynamic payment optimization based on factors such as user location, preferences and currency value preferences among others. For example, when a user is in the United States, the country indicator 931 may display a flag of the United States and may set the currency 933 to the United States. In a further implementation, the wallet mobile application may automatically rearrange the order in which the forms of payments 935 are listed to reflect the popularity or acceptability of various forms of payment. In one implementation, the arrangement may reflect the user's preference, which may not be changed by the wallet mobile application.

Similarly, when a German user operates a wallet in Germany, the mobile wallet application user interface may be dynamically updated to reflect the country of operation 932 and the currency 934. In a further implementation, the wallet application may rearrange the order in which different forms of payment 936 are listed based on their acceptance level in that country. Of course, the order of these forms of payments may be modified by the user to suit his or her own preferences.

With reference to FIG. 9C, in one embodiment, the payee tab 937 in the wallet mobile application user interface may facilitate user selection of one or more payees receiving the funds selected in the funds tab. In one implementation, the user interface may show a list of all payees 938 with whom the user has previously transacted or available to transact. The user may then select one or more payees. The payees 938 may include larger merchants such as Amazon.com Inc., and individuals such as Jane P. Doe. Next to each payee name, a list of accepted payment modes for the payee may be displayed. In one implementation, the user may select the payee Jane P. Doe 939 for receiving payment. Upon selection, the user interface may display additional identifying information relating to the payee.

With reference to FIG. 9D, in one embodiment, the mode tab 940 may facilitate selection of a payment mode accepted by the payee. A number of payment modes may be available for selection. Example modes include, blue tooth 941, wireless 942, snap mobile by user-obtained QR code 943, secure chip 944, TWITTER 945, near-field communication (NFC) 946, cellular 947, snap mobile by user-provided QR code 948, USB 949 and FACEBOOK 950, among others. In one implementation, only the payment modes that are accepted by the payee may be selectable by the user. Other non-accepted payment modes may be disabled.

With reference to FIG. 9E, in one embodiment, the offers tab 951 may provide real-time offers that are relevant to items in a user's cart for selection by the user. The user may select one or more offers from the list of applicable offers 952 for redemption. In one implementation, some offers may be combined, while others may not. When the user selects an offer that may not be combined with another offer, the unselected offers may be disabled. In a further implementation, offers that are recommended by the wallet application's recommendation engine may be identified by an indicator, such as the one shown by 953. In a further implementation, the user may read the details of the offer by expanding the offer row as shown by 954 in the user interface.

With reference to FIG. 9F, in one embodiment, the social tab 955 may facilitate integration of the wallet application with social channels 956. In one implementation, a user may select one or more social channels 956 and may sign in to the selected social channel from the wallet application by providing to the wallet application the social channel user name and password 957 and signing in 958. The user may then use the social button 959 to send or receive money through the integrated social channels. In a further implementation, the user may send social share data such as purchase information or links through integrated social channels. In another embodiment, the user supplied login credentials may allow Bill Pay to engage in interception parsing.

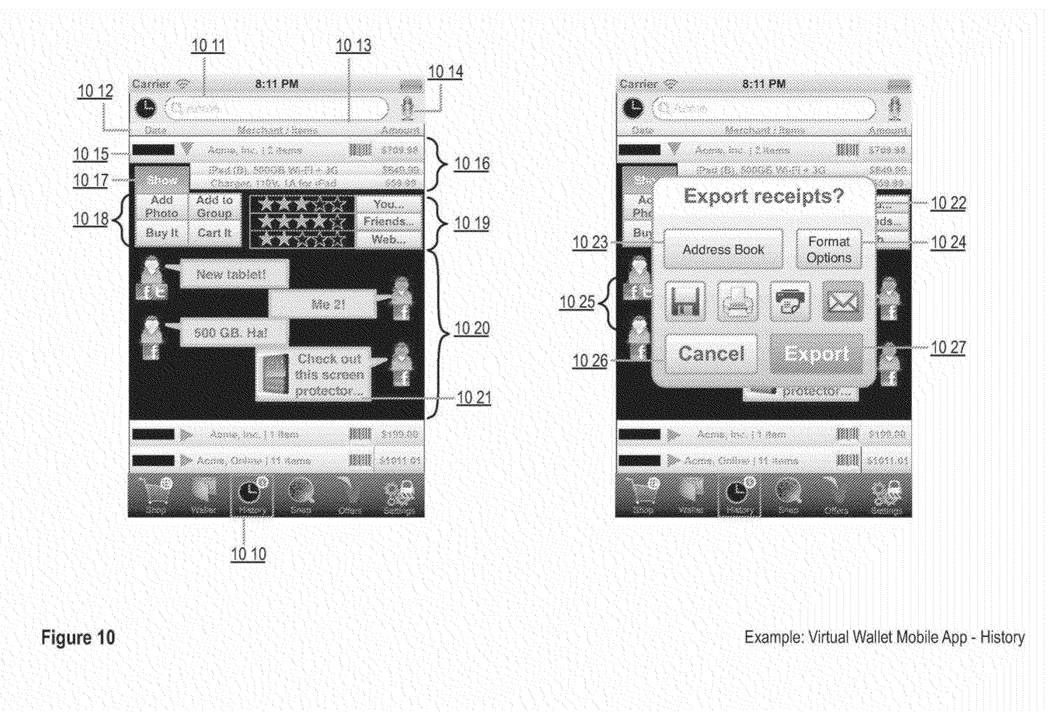

FIG. 10 shows a user interface diagram illustrating example features of virtual wallet applications, in a history mode, in some embodiments of the Bill Pay. In one embodiment, a user may select the history mode 1010 to view a history of prior purchases and perform various actions on those prior purchases. For example, a user may enter a merchant_identifying information such as name, product, MCC, and/or the like in the search bar 1011. In another implementation, the user may use voice activated search feature by clicking on the microphone icon 1014. The wallet application may query the storage areas in the mobile device or elsewhere (e.g., one or more databases and/or tables remote from the mobile device) for transactions matching the search keywords. The user interface may then display the results of the query such as transaction 1015. The user interface may also identify the date 1012 of the transaction, the merchants and items 1013 relating to the transaction, a barcode of the receipt confirming that a transaction was made, the amount of the transaction and any other relevant information.

In one implementation, the user may select a transaction, for example transaction 1015, to view the details of the transaction. For example, the user may view the details of the items associated with the transaction and the amounts 1016 of each item. In a further implementation, the user may select the show option 1017 to view actions 1018 that the user may take in regards to the transaction or the items in the transaction. For example, the user may add a photo to the transaction (e.g., a picture of the user and the iPad the user bought). In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The history mode, in another embodiment, may offer facilities for obtaining and displaying ratings 1019 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 1020 shows FACEBOOK message exchanges between two users. In one implementation, a user may share a link via a message 1021. Selection of such a message having embedded link to a product may allow the user to view a description of the product and/or purchase the product directly from the history mode.

In one embodiment, the history mode may also include facilities for exporting receipts. The export receipts pop up 1022 may provide a number of options for exporting the receipts of transactions in the history. For example, a user may use one or more of the options 1025, which include save (to local mobile memory, to server, to a cloud account, and/or the like), print to a printer, fax, email, and/or the like. The user may utilize his or her address book 1023 to look up email or fax number for exporting. The user may also specify format options 1024 for exporting receipts. Example format options may include, without limitation, text files (.doc, .txt, .rtf, iif, etc.), spreadsheet (.csv, .xls, etc.), image files (.jpg, .tff, .png, etc.), portable document format (.pdf), postscript (.ps), and/or the like. The user may then click or tap the export button 1027 to initiate export of receipts.

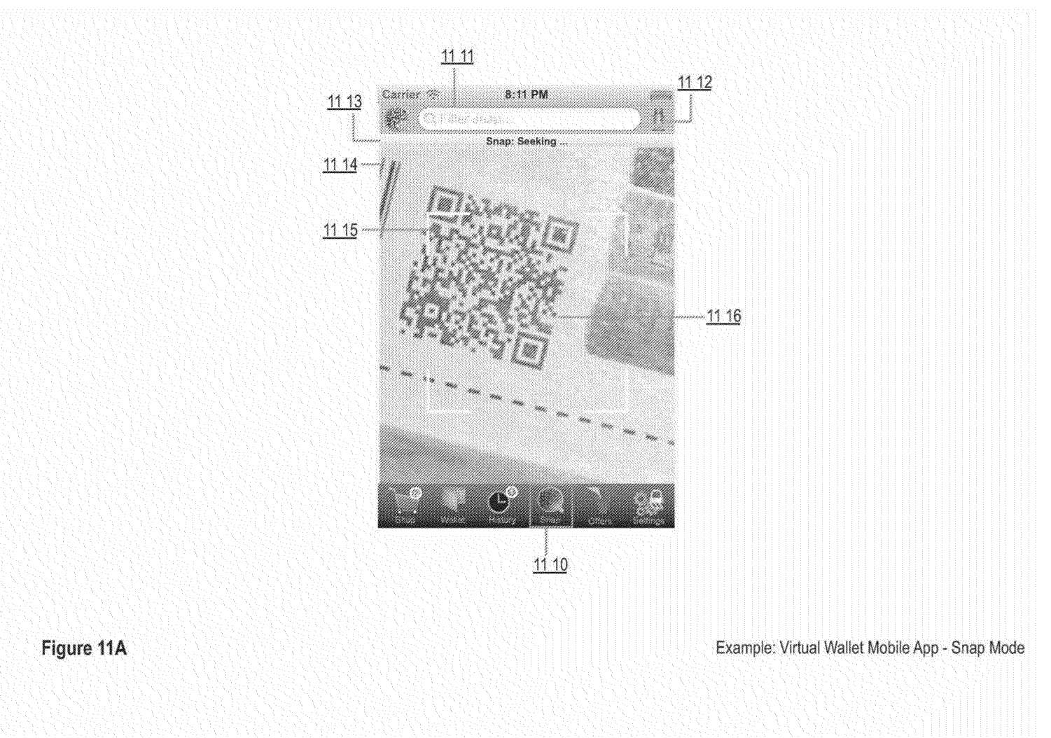

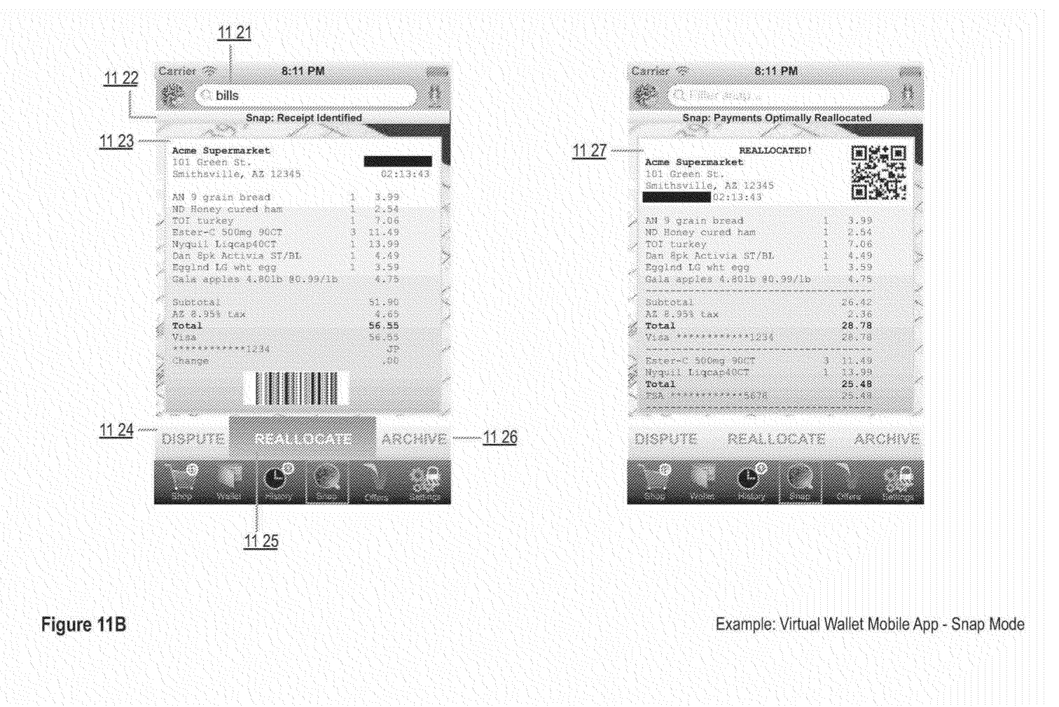

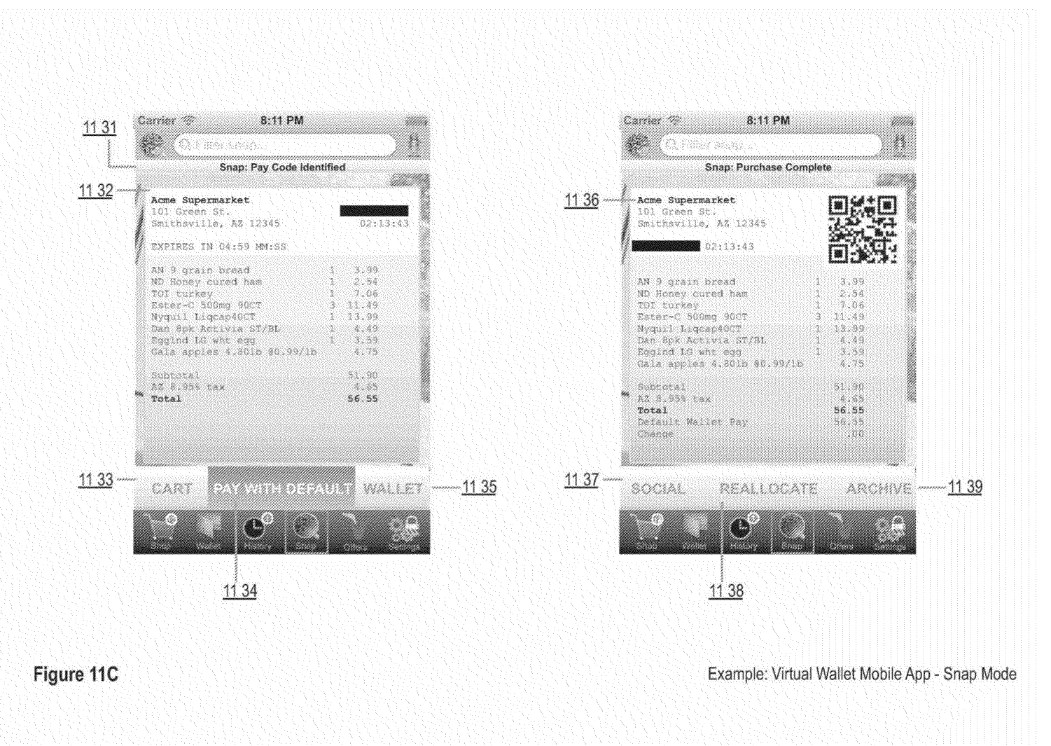

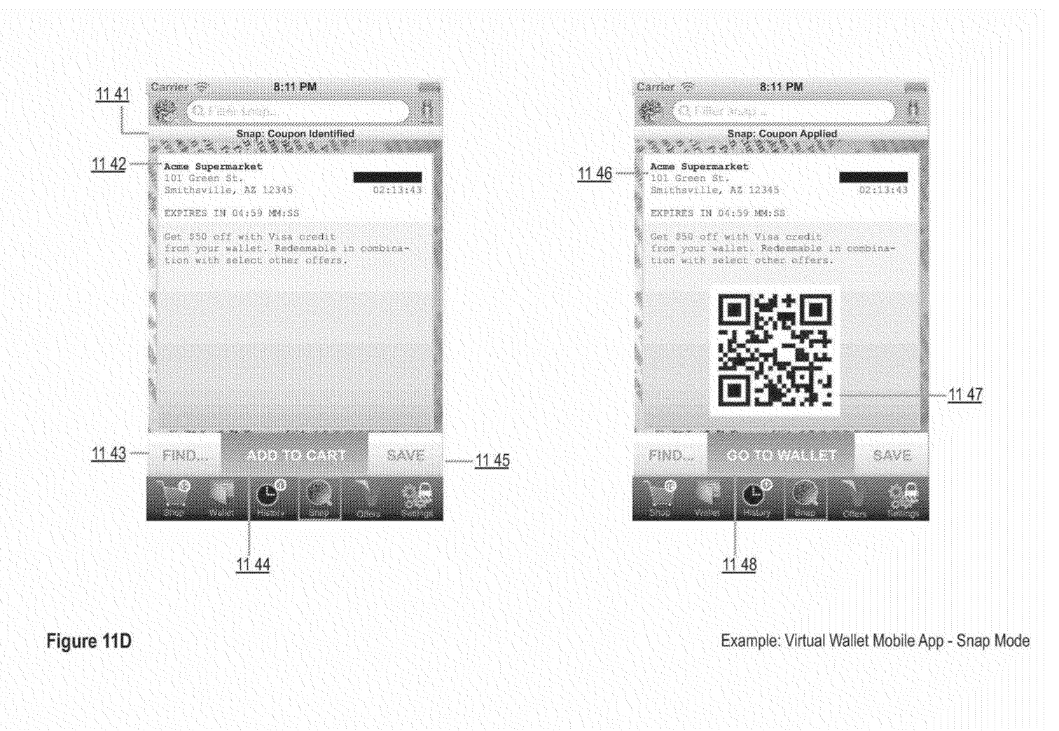

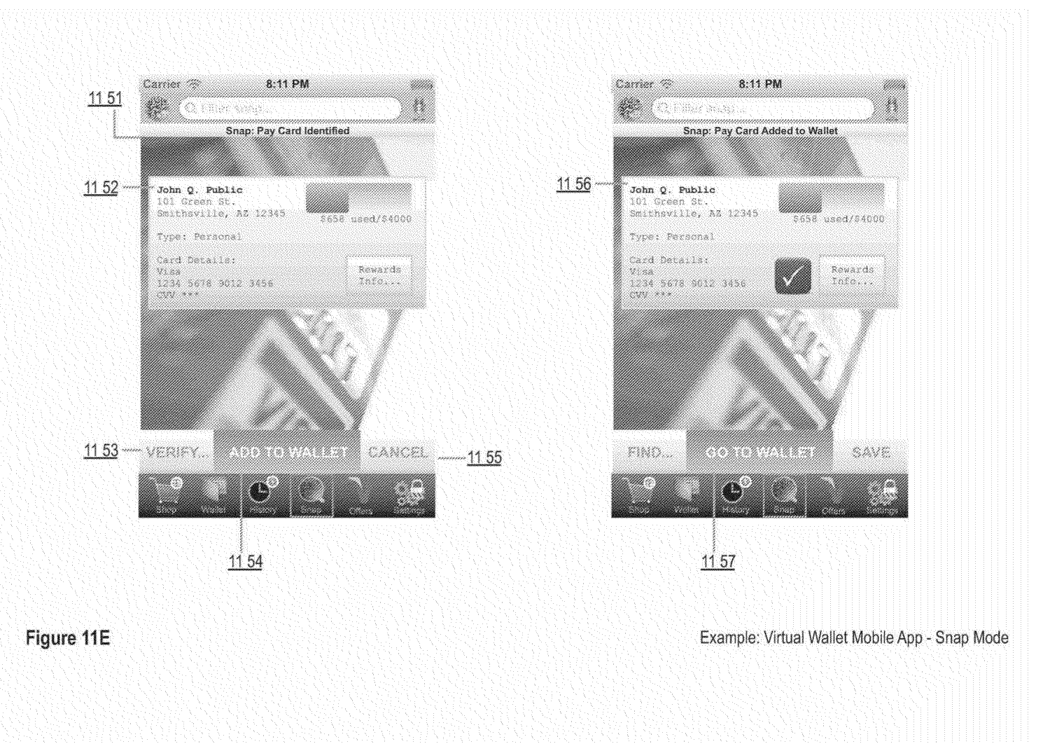

FIGS. 11A-E show user interface diagrams illustrating example features of virtual wallet applications in a snap mode, in some embodiments of the Bill Pay. With reference to FIG. 11A, in one embodiment, a user may select the snap mode 2110 to access its snap features. The snap mode may handle any machine-readable representation of data. Examples of such data may include linear and 2D bar codes such as UPC code and QR codes. These codes may be found on receipts, product packaging, and/or the like. The snap mode may also process and handle pictures of receipts, products, offers, credit cards or other payment devices, and/or the like. An example user interface in snap mode is shown in FIG. 11A. A user may use his or her mobile phone to take a picture of a QR code 1115 and/or a barcode 1114. In one implementation, the bar 1113 and snap frame 1115 may assist the user in snapping codes properly. For example, the snap frame 1115, as shown, does not capture the entirety of the code 1116. As such, the code captured in this view may not be resolvable as information in the code may be incomplete. This is indicated by the message on the bar 1113 that indicates that the snap mode is still seeking the code. When the code 1116 is completely framed by the snap frame 1115, the bar message may be updated to, for example, “snap found.” Upon finding the code, in one implementation, the user may initiate code capture using the mobile device camera. In another implementation, the snap mode may automatically snap the code using the mobile device camera.

With reference to FIG. 11B, in one embodiment, the snap mode may facilitate payment reallocation post transaction. For example, a user may buy grocery and prescription items from a retailer Acme Supermarket. The user may, inadvertently or for ease of checkout for example, use his or her Visa card to pay for both grocery and prescription items. However, the user may have an FSA account that could be used to pay for prescription items, and which would provide the user tax benefits. In such a situation, the user may use the snap mode to initiate transaction reallocation.

As shown, the user may enter a search term (e.g., bills) in the search bar 2121. The user may then identify in the tab 1122 the receipt 1123 the user wants to reallocate. Alternatively, the user may directly snap a picture of a barcode on a receipt, and the snap mode may generate and display a receipt 1123 using information from the barcode. The user may now reallocate 1125. In some implementations, the user may also dispute the transaction 1124 or archive the receipt 1126.

In one implementation, when the reallocate button 1125 is selected, the wallet application may perform optical character recognition (OCR) of the receipt. Each of the items in the receipt may then be examined to identify one or more items which could be charged to which payment device or account for tax or other benefits such as cash back, reward points, etc. In this example, there is a tax benefit if the prescription medication charged to the user's Visa card is charged to the user's FSA. The wallet application may then perform the reallocation as the back end. The reallocation process may include the wallet contacting the payment processor to credit the amount of the prescription medication to the Visa card and debit the same amount to the user's FSA account. In an alternate implementation, the payment processor (e.g., Visa or MasterCard) may obtain and OCR the receipt, identify items and payment accounts for reallocation and perform the reallocation. In one implementation, the wallet application may request the user to confirm reallocation of charges for the selected items to another payment account. The receipt 1127 may be generated after the completion of the reallocation process. As discussed, the receipt shows that some charges have been moved from the Visa account to the FSA.

With reference to FIG. 11C, in one embodiment, the snap mode may facilitate payment via pay code such as barcodes or QR codes. For example, a user may snap a QR code of a transaction that is not yet complete. The QR code may be displayed at a merchant POS terminal, a web site, or a web application and may be encoded with information identifying items for purchase, merchant details and other relevant information. When the user snaps such as a QR code, the snap mode may decode the information in the QR code and may use the decoded information to generate a receipt 1132. Once the QR code is identified, the navigation bar 1131 may indicate that the pay code is identified. The user may now have an option to add to cart 1133, pay with a default payment account 1134 or pay with wallet 1135.

In one implementation, the user may decide to pay with default 1134. The wallet application may then use the user's default method of payment, in this example the wallet, to complete the purchase transaction. Upon completion of the transaction, a receipt may be automatically generated for proof of purchase. The user interface may also be updated to provide other options for handling a completed transaction. Example options include social 1137 to share purchase information with others, reallocate 1138 as discussed with regard to FIG. 11B, and archive 1139 to store the receipt.

With reference to FIG. 11D, in one embodiment, the snap mode may also facilitate offer identification, application and storage for future use. For example, in one implementation, a user may snap an offer code 1141 (e.g., a bar code, a QR code, and/or the like). The wallet application may then generate an offer text 1142 from the information encoded in the offer code. The user may perform a number of actions on the offer code. For example, the user use the find button 1143 to find all merchants who accept the offer code, merchants in the proximity who accept the offer code, products from merchants that qualify for the offer code, and/or the like. The user may also apply the offer code to items that are currently in the cart using the add to cart button 1144. Furthermore, the user may also save the offer for future use by selecting the save button 1145.

In one implementation, after the offer or coupon 1146 is applied, the user may have the option to find qualifying merchants and/or products using find, the user may go to the wallet using 1148, and the user may also save the offer or coupon 1146 for later use.

With reference to FIG. 11E, in one embodiment, the snap mode may also offer facilities for adding a funding source to the wallet application. In one implementation, a pay card such as a credit card, debit card, pre-paid card, smart card and other pay accounts may have an associated code such as a bar code or QR code. Such a code may have encoded therein pay card information including, but not limited to, name, address, pay card type, pay card account details, balance amount, spending limit, rewards balance, and/or the like. In one implementation, the code may be found on a face of the physical pay card. In another implementation, the code may be obtained by accessing an associated online account or another secure location. In yet another implementation, the code may be printed on a letter accompanying the pay card. A user, in one implementation, may snap a picture of the code. The wallet application may identify the pay card 1151 and may display the textual information 1152 encoded in the pay card. The user may then perform verification of the information 1152 by selecting the verify button 1153. In one implementation, the verification may include contacting the issuer of the pay card for confirmation of the decoded information 1152 and any other relevant information. In one implementation, the user may add the pay card to the wallet by selecting the ‘add to wallet’ button 1154. The instruction to add the pay card to the wallet may cause the pay card to appear as one of the forms of payment under the funds tab 916 discussed in FIG. 9A. The user may also cancel importing of the pay card as a funding source by selecting the cancel button 1155. When the pay card has been added to the wallet, the user interface may be updated to indicate that the importing is complete via the notification display 1156. The user may then access the wallet 1157 to begin using the added pay card as a funding source.

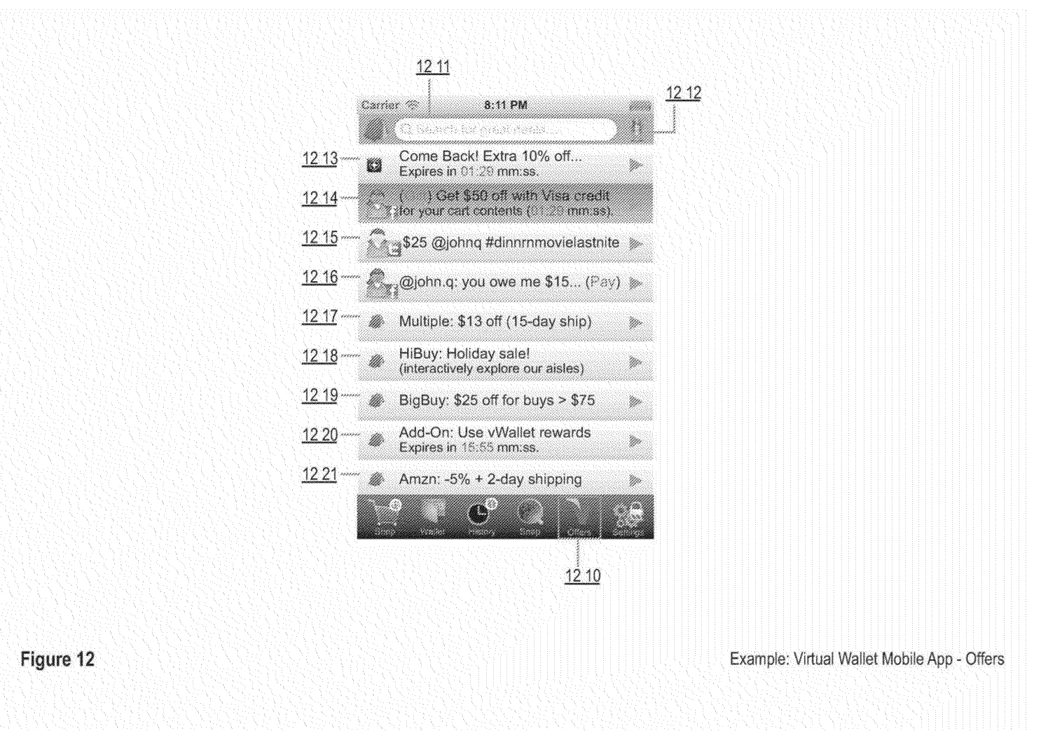

FIG. 12 shows a user interface diagram illustrating example features of virtual wallet applications, in an offers mode, in some embodiments of the Bill Pay. In some implementations, the Bill Pay may allow a user to search for offers for products and/or services from within the virtual wallet mobile application. For example, the user may enter text into a graphical user interface (“GUI”) element 1211, or issue voice commands by activating GUI element 1212 and speaking commands into the device. In some implementations, the Bill Pay may provide offers based on the user's prior behavior, demographics, current location, current cart selection or purchase items, and/or the like. For example, if a user is in a brick-and-mortar store, or an online shopping website, and leaves the (virtual) store, then the merchant associated with the store may desire to provide a sweetener deal to entice the consumer back into the (virtual) store. The merchant may provide such an offer 1213. For example, the offer may provide a discount, and may include an expiry time. In some implementations, other users may provide gifts (e.g., 1214) to the user, which the user may redeem. In some implementations, the offers section may include alerts as to payment of funds outstanding to other users (e.g., 1215). In some implementations, the offers section may include alerts as to requesting receipt of funds from other users (e.g., 1216). For example, such a feature may identify funds receivable from other applications (e.g., mail, calendar, tasks, notes, reminder programs, alarm, etc.), or by a manual entry by the user into the virtual wallet application. In some implementations, the offers section may provide offers from participating merchants in the Bill Pay, e.g., 1217-1219, 1220. These offers may sometimes be assembled using a combination of participating merchants, e.g., 1217. In some implementations, the Bill Pay itself may provide offers for users contingent on the user utilizing particular payment forms from within the virtual wallet application, e.g., 1220.

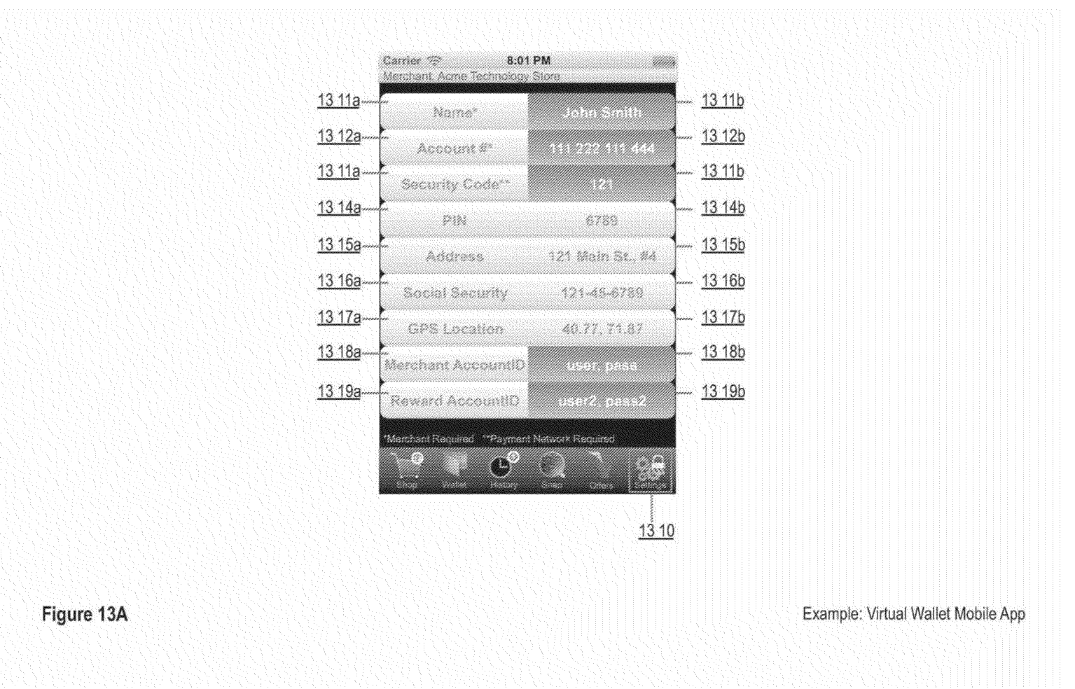

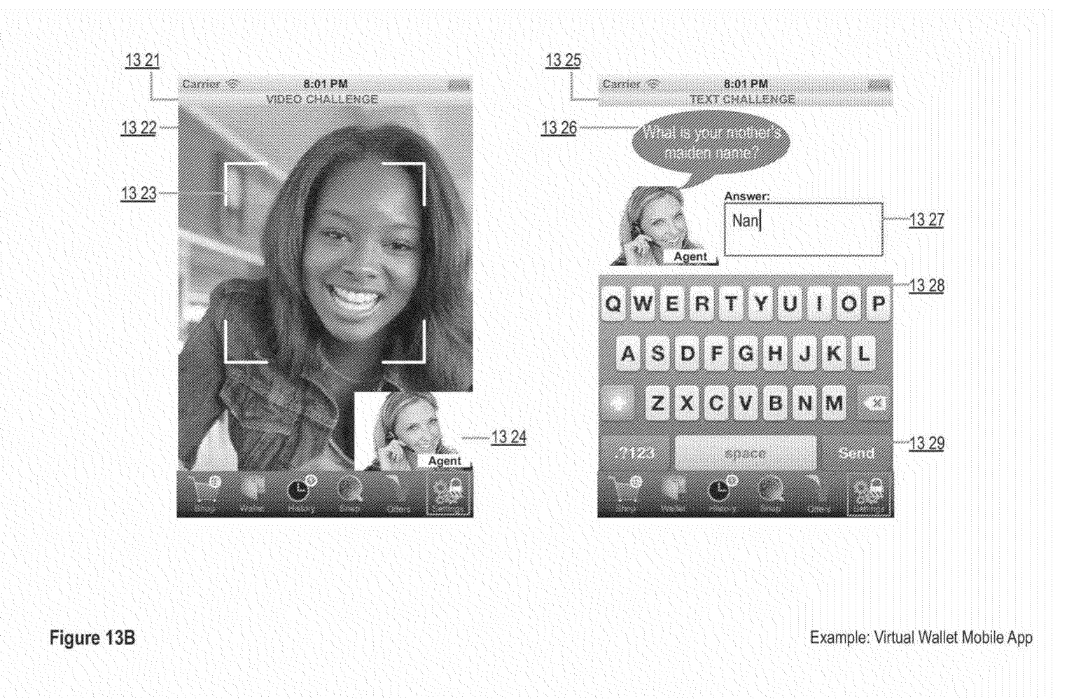

FIGS. 13A-B show user interface diagrams illustrating example features of virtual wallet applications, in a security and privacy mode, in some embodiments of the Bill Pay. With reference to FIG. 13A, in some implementations, the user may be able to view and/or modify the user profile and/or settings of the user, e.g., by activating a user interface element. For example, the user may be able to view/modify a user name (e.g., 1311a-b), account number (e.g., 1312a-b), user security access code (e.g., 1313-b), user pin (e.g., 1314-b), user address (e.g., 1315-b), social security number associated with the user (e.g., 1316-b), current device GPS location (e.g., 1317-b), user account of the merchant in whose store the user currently is (e.g., 1318-b), the user's rewards accounts (e.g., 1319-b), and/or the like. In some implementations, the user may be able to select which of the data fields and their associated values should be transmitted to facilitate the purchase transaction, thus providing enhanced data security for the user. For example, in the example illustration in FIG. 13A, the user has selected the name 1311a, account number 1312a, security code 1313a, merchant account ID 1318a and rewards account ID 1319a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the Bill Pay with the GPS location of the user. Based on the GPS location of the user, the Bill Pay may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

With reference to FIG. 13B, in some implementations, the app executing on the user's device may provide a “VerifyChat” feature for fraud prevention. For example, the Bill Pay may detect an unusual and/or suspicious transaction. The Bill Pay may utilize the VerifyChat feature to communicate with the user, and verify the authenticity of the originator of the purchase transaction. In various implementations, the Bill Pay may send electronic mail message, text (SMS) messages, Facebook® messages, Twitter™ tweets, text chat, voice chat, video chat (e.g., Apple FaceTime), and/or the like to communicate with the user. For example, the Bill Pay may initiate a video challenge for the user, e.g., 1321. For example, the user may need to present him/her-self via a video chat, e.g., 1322. In some implementations, a customer service representative, e.g., agent 1324, may manually determine the authenticity of the user using the video of the user. In some implementations, the Bill Pay may utilize face, biometric and/or like recognition (e.g., using pattern classification techniques) to determine the identity of the user. In some implementations, the app may provide reference marker (e.g., cross-hairs, target box, etc.), e.g., 1323, so that the user may the video to facilitate the Bill Pay's automated recognition of the user. In some implementations, the user may not have initiated the transaction, e.g., the transaction is fraudulent. In such implementations, the user may cancel the challenge. The Bill Pay may then cancel the transaction, and/or initiate fraud investigation procedures on behalf of the user.

In some implementations, the Bill Pay may utilize a text challenge procedure to verify the authenticity of the user, e.g., 1325. For example, the Bill Pay may communicate with the user via text chat, SMS messages, electronic mail, Facebook® messages, Twitter™ tweets, and/or the like. The Bill Pay may pose a challenge question, e.g., 1326, for the user. The app may provide a user input interface element(s) (e.g., virtual keyboard 1328) to answer the challenge question posed by the Bill Pay. In some implementations, the challenge question may be randomly selected by the Bill Pay automatically; in some implementations, a customer service representative may manually communicate with the user. In some implementations, the user may not have initiated the transaction, e.g., the transaction is fraudulent. In such implementations, the user may cancel the text challenge. The Bill Pay may cancel the transaction, and/or initiate fraud investigation on behalf of the user.

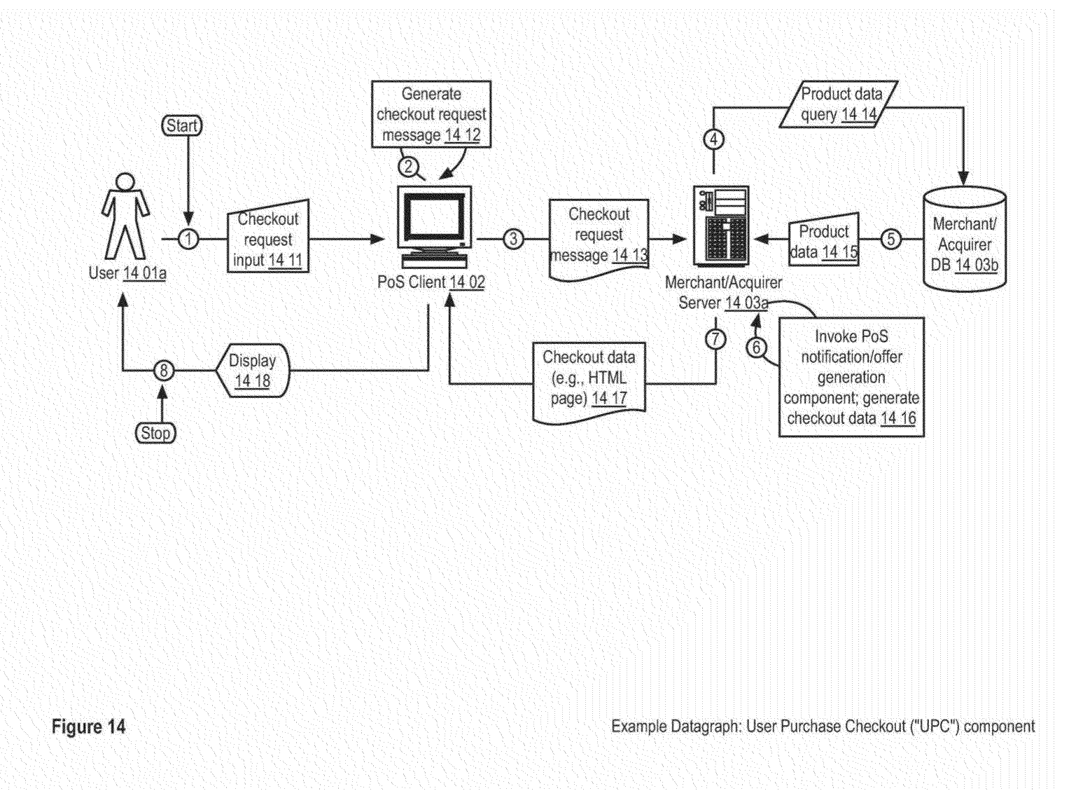

FIG. 14 shows a datagraph diagram illustrating example aspects of transforming a user checkout request input via a User Purchase Checkout (“UPC”) component into a checkout data display. In some embodiments, a user, e.g., 1401a, may desire to purchase a product, service, offering, and/or the like (“product”), from a merchant via a merchant online site or in the merchant's store. The user may communicate with a merchant/acquirer (“merchant”) server, e.g., 1403a, via a client such as, but not limited to: a personal computer, mobile device, television, point-of-sale terminal, kiosk, ATM, and/or the like (e.g., 1402). For example, the user may provide user input, e.g., checkout input 1411, into the client indicating the user's desire to purchase the product. In various embodiments, the user input may include, but not be limited to: a single tap (e.g., a one-tap mobile app purchasing embodiment) of a touchscreen interface, keyboard entry, card swipe, activating a RFID/NFC equipped hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. As an example, a user in a merchant store may scan a product barcode of the product via a barcode scanner at a point-of-sale terminal. As another example, the user may select a product from a webpage catalog on the merchant's website, and add the product to a virtual shopping cart on the merchant's website. The user may then indicate the user's desire to checkout the items in the (virtual) shopping cart. For example, the user may activate a user interface element provided by the client to indicate the user's desire to complete the user purchase checkout. The client may generate a checkout request, e.g., 1412, and provide the checkout request, e.g., 1413, to the merchant server. For example, the client may provide a (Secure) Hypertext Transfer Protocol (“HTTP(S)”) POST message including the product details for the merchant server in the form of data formatted according to the eXtensible Markup Language (“XML”). An example listing of a checkout request 1412, substantially in the form of a HTTP(S) POST message including XML-formatted data, is provided below:

```
POST /checkoutrequest.php HTTP/1.1
Host: www.merchant.com
Content-Type: Application/XML
Content-Length: 667
<?XML version = “1.0” encoding = “UTF-8”?>
<checkout_request>
    <session_ID>4NFU4RG94</session_ID>
<!--optional parameters-->
    <timestamp>2011-02-22 15:22:41</timestamp>
    <user_ID>john.q.public@gmail.com</user_ID>
    <device_fingerprint>
        <device_IP>192.168.23.126</device_IP>
        <device_MAC>0123.4567.89ab</device_MAC>
        <device_serial>312456768798765432</device_serial>
        <device_ECID>00000AEBCDF12345</device_ECID>
        <device_identifier>jqp_air</device_identifier>
        <device_UDID>21343e34-14f4-8jn4-7yfe-
        124578632134</device_UDID>
        <device_browser>firefox 2.2</device_browser>
        <device_type>smartphone</device_type>
        <device_model>HTC Hero</device_model>
        <OS>Android 2.2</OS>
        <wallet_app_installed_flag>true<wallet_app_installed_flag>
    </device_fingerprint>
</checkout_request>
```

In some embodiments, the merchant server may obtain the checkout request from the client, and extract the checkout detail (e.g., XML data) from the checkout request. For example, the merchant server may utilize a parser such as the example parsers described below in the discussion with reference to FIG. 26. Based on parsing the checkout request 1412, the merchant server may extract product data (e.g., product identifiers), as well as available PoS client data, from the checkout request. In some embodiments, using the product data, the merchant server may query, e.g., 1414, a merchant/acquirer (“merchant”) database, e.g., 1403b, to obtain product data, e.g., 1415, such as product information, product pricing, sales tax, offers, discounts, rewards, and/or other information to process the purchase transaction and/or provide value-added services for the user. For example, the merchant database may be a relational database responsive to Structured Query Language (“SQL”) commands. The merchant server may execute a hypertext preprocessor (“PHP”) script including SQL commands to query a database table (such as FIG. 26, Products 2619l) for product data. An example product data query 1414, substantially in the form of PHP/SQL commands, is provided below:

<?PHP
header(‘Content-Type: text/plain’);
mysql_connect(“254.93.179.112”,$DBserver,$password);
// access database server
mysql_select_db(“Bill Pay_DB.SQL”); // select database table to search
//create query
$query = “SELECT product_title product_attributes_list product_price
tax_info_list related_products_list offers_list discounts_list
rewards_list merchants_list merchant_availability_list FROM
ProductsTable WHERE product_ID LIKE ‘%’ $prodID”;
$result = mysql_query($query); // perform the search query
mysql_close(“Bill Pay_DB.SQL”); // close database access
?>

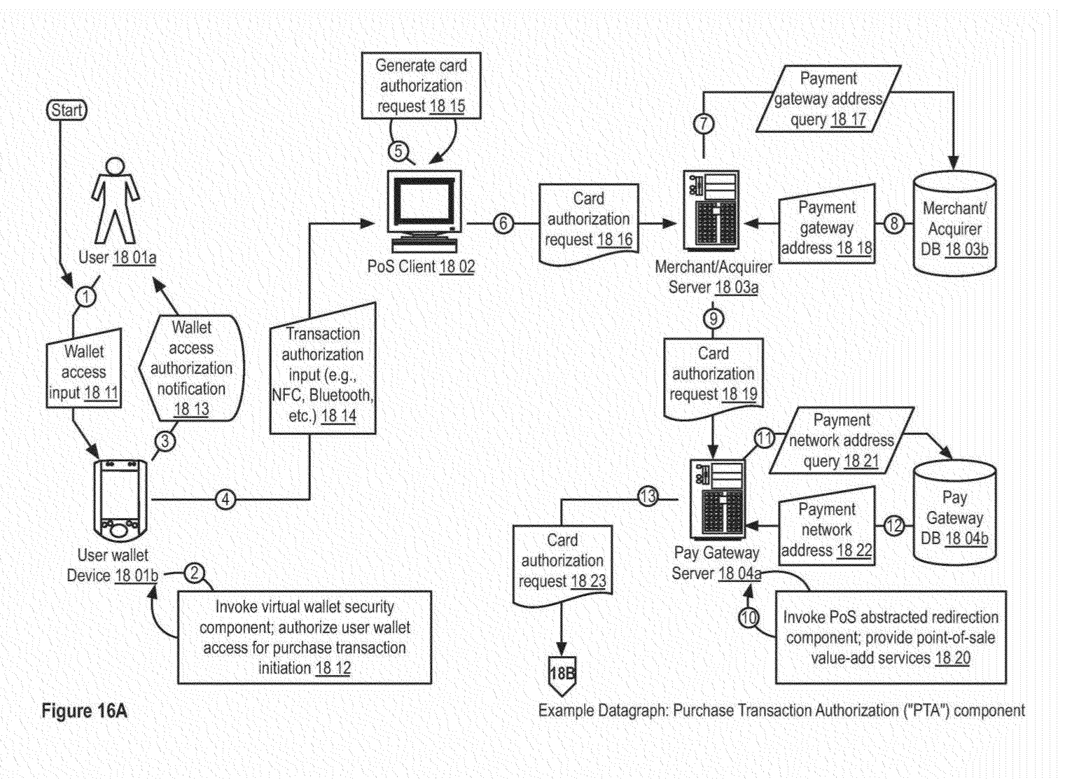

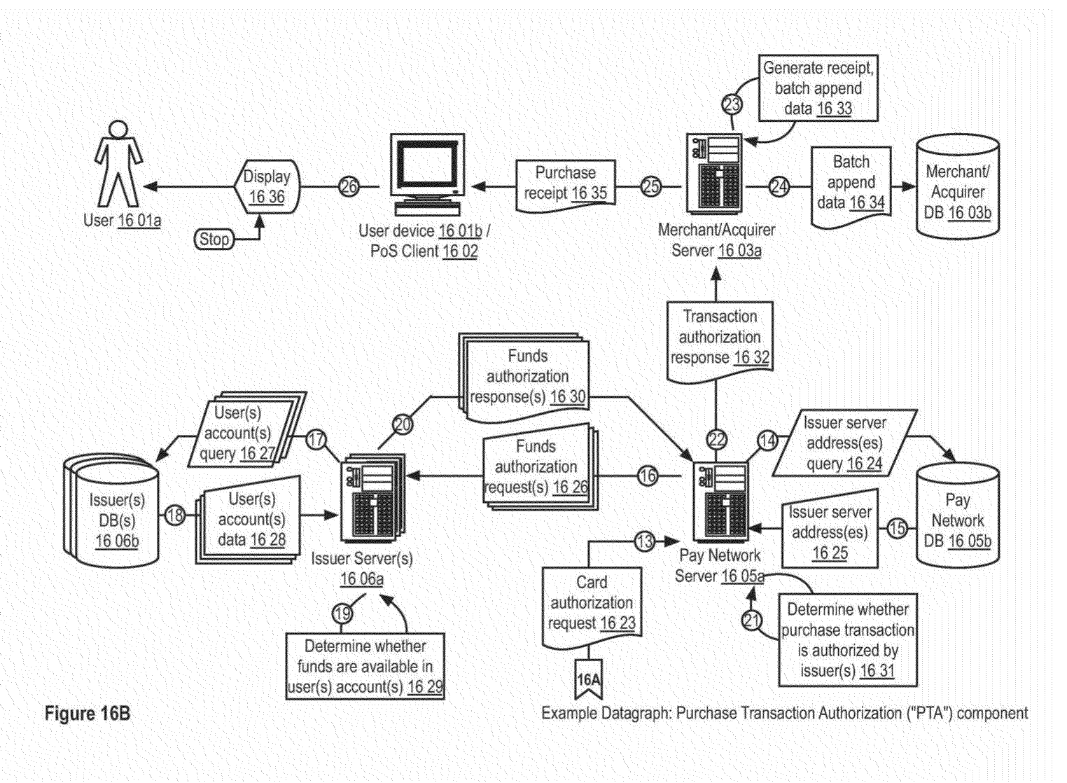

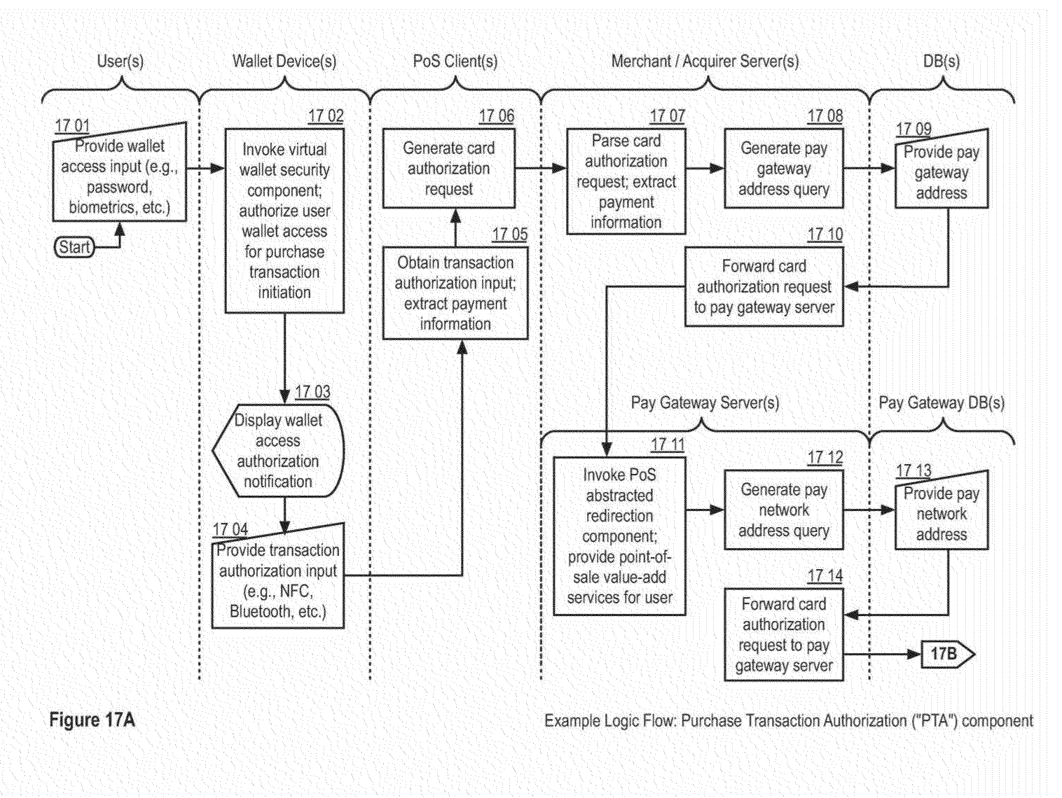

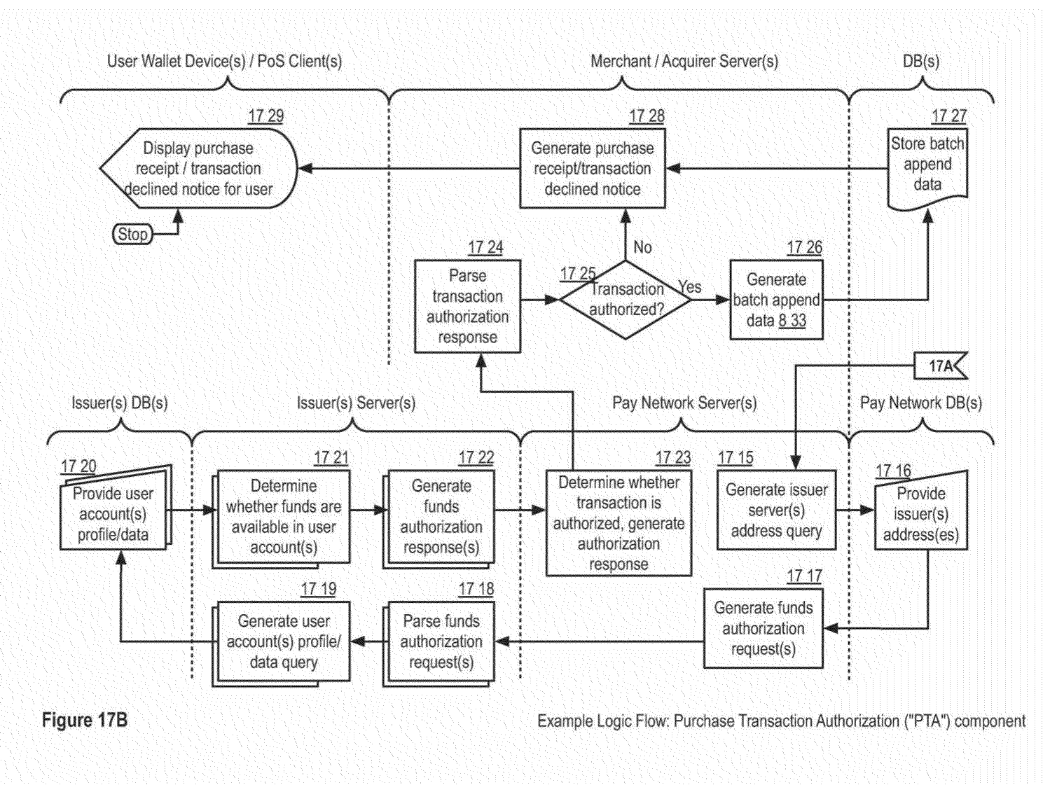

In some embodiments, in response to obtaining the product data, the merchant server may generate, e.g., 1416, checkout data to provide for the PoS client. In some embodiments, such checkout data, e.g., 1417, may be embodied, in part, in a HyperText Markup Language (“HTML”) page including data for display, such as product detail, product pricing, total pricing, tax information, shipping information, offers, discounts, rewards, value-added service information, etc., and input fields to provide payment information to process the purchase transaction, such as account holder name, account number, billing address, shipping address, tip amount, etc. In some embodiments, the checkout data may be embodied, in part, in a Quick Response (“QR”) code image that the PoS client can display, so that the user may capture the QR code using a user's device to obtain merchant and/or product data for generating a purchase transaction processing request. In some embodiments, a user alert mechanism may be built into the checkout data. For example, the merchant server may embed a URL specific to the transaction into the checkout data. In some embodiments, the alerts URL may further be embedded into optional level 3 data in card authorization requests, such as those discussed further below with reference to FIGS. 16-17. The URL may point to a webpage, data file, executable script, etc., stored on the merchant's server dedicated to the transaction that is the subject of the card authorization request. For example, the object pointed to by the URL may include details on the purchase transaction, e.g., products being purchased, purchase cost, time expiry, status of order processing, and/or the like. Thus, the merchant server may provide to the payment network the details of the transaction by passing the URL of the webpage to the payment network. In some embodiments, the payment network may provide notifications to the user, such as a payment receipt, transaction authorization confirmation message, shipping notification and/or the like. In such messages, the payment network may provide the URL to the user device. The user may navigate to the URL on the user's device to obtain alerts regarding the user's purchase, as well as other information such as offers, coupons, related products, rewards notifications, and/or the like. An example listing of a checkout data 1417, substantially in the form of XML-formatted data, is provided below:

```
<?XML version = “1.0” encoding = “UTF-8”?>
<checkout_data>
    <session_ID>4NFU4RG94</session_ID>
    <!--optional data-->
    <timestamp>2011-02-22 15:22:43</timestamp>
    <expiry_lapse>00:00:30</expiry_lapse>
    <total_cost>$121.49</total_cost>
    <alerts_URL>www.merchant.com/shopcarts.php?sessionID=
4NFU4RG94</alerts_URL>
    <user_ID>john.q.public@gmail.com</user_ID>
    <user_device_fingerprint>
        <device_IP>192.168.23.126</device_IP>
        <device_MAC>0123.4567.89ab</device_MAC>
        <device_serial>312456768798765432</device_serial>
        <device_ECID>00000AEBCDF12345</device_ECID>
        <device_identifier>jqp_air</device_identifier>
        <device_UDID>21343e34-14f4-8jn4-7yfe-
        124578632134</device_UDID>
        <device_browser>firefox 2.2</device_browser>
        <device_type>smartphone</device_type>
        <device_model>HTC Hero</device_model>
        <OS>Android 2.2</OS>
        <wallet_app_installed_flag>true</wallet_app_installed_flag>
    </user_device_fingerprint>
    <purchase_detail>
        <cart>
            <product>
                <merchant_params>
                <merchant_id>54TBRELF8</merchant_id>
                <merchant_name>BARNES, Inc.</merchant_name>
                <merchant_auth_key>TMN45GER98
                </merchant_auth_key>
                </merchant_params>
                <product_type>book</product_type>
                <product_params>
                <product_title>XML for dummies</product_title>
                <ISBN>938-2-14-168710-0</ISBN>
                <edition>2nd ed.</edition>
                <cover>hardbound</cover>
                </product_params>
                <quantity>2</quantity>
                <unit_cost>$14.46</unit_cost>
                <coupon_id>AY34567</coupon_id>
            <social_flag>ON</social_flag>
            <social_message>Look what I bought
today!</social_message>
            <social_networks>facebook twitter</social_networks>
            </product>
            <product>
                <merchant_params>
                <merchant_id>3FBCR4INC</merchant_id>
                <merchant_name>Books, Inc.</merchant_name>
                <merchant_auth_key>1N484MCP
                </merchant_auth_key>
                </merchant_params>
                <product_type>book</product_type>
                <product_params>
                <product_title>Sophie's World</product_title>
                <ISBN>955-2-14-112310-0</ISBN>
                <edition>NULL</edition>
                <cover>hardbound</cover>
                </product_params>
                <quantity>1</quantity>
                <unit_cost>$34.78</unit_cost>
                <coupon_id>null</coupon_id>
            <social_flag>OFF</social_flag>
            </product>
        </cart>
        <cart>
            <product>
                <merchant_params>
                <merchant_id>RFH5IB4FT</merchant_id>
                <merchant_name>Amzn, Inc.</merchant_name>
                <merchant_auth_key>44543DSJFG
                </merchant_auth_key>
                </merchant_params>
                <product_type>book</product_type>
                <product_params>
                <product_title>XML - a primer</product_title>
                <ISBN>938-2-14-1436710-0</ISBN>
                <edition>2nd ed.</edition>
                <cover>hardbound</cover>
                </product_params>
                <quantity>1</quantity>
                <unit_cost>$12.93</unit_cost>
                <coupon_id>AY34567</coupon_id>
            <social_flag>ON</social_flag>
            <social_message>Look what I bought
today!</social_message>
            <social_networks>facebook twitter</social_networks>
            </product>
            <product>
                <merchant_params>
                <merchant_id>3FBCR4INC</merchant_id>
                <merchant_name>BestBooks, Inc.</merchant_name>
                <merchant_auth_key>1N484MCP
                </merchant_auth_key>
                </merchant_params>
                <product_type>book</product_type>
                <product_params>
                <product_title>Sophie's Choice</product_title>
                <ISBN>938-2-14-168710-0</ISBN>
                <edition>1st ed.</edition>
                </product_params>
                <quantity>1</quantity>
                <unit_cost>$44.86</unit_cost>
                <coupon_id>null</coupon_id>
            <social_flag>OFF</social_flag>
            </product>
        </cart>
    </purchase_detail>
<checkout_data>
```

Upon obtaining the checkout data, e.g., 1417, the PoS client may render and display, e.g., 1418, the checkout data for the user.

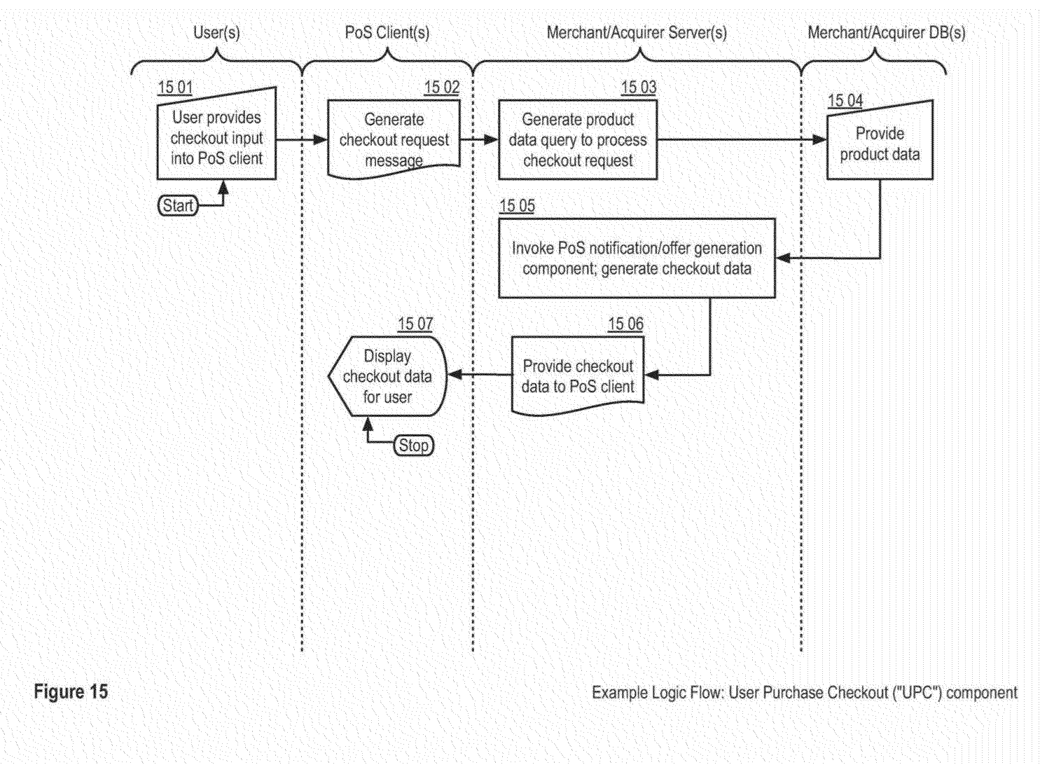

FIG. 15 shows a logic flow diagram illustrating example aspects of transforming a user checkout request input via a User Purchase Checkout (“UPC”) component into a checkout data display. In some embodiments, a user may desire to purchase a product, service, offering, and/or the like (“product”), from a merchant via a merchant online site or in the merchant's store. The user may communicate with a merchant/acquirer (“merchant”) server via a PoS client. For example, the user may provide user input, e.g., 1501, into the client indicating the user's desire to purchase the product. The client may generate a checkout request, e.g., 1502, and provide the checkout request to the merchant server. In some embodiments, the merchant server may obtain the checkout request from the client, and extract the checkout detail (e.g., XML data) from the checkout request. For example, the merchant server may utilize a parser such as the example parsers described below in the discussion with reference to FIG. 26. Based on parsing the checkout request, the merchant server may extract product data (e.g., product identifiers), as well as available PoS client data, from the checkout request. In some embodiments, using the product data, the merchant server may query, e.g., 1503, a merchant/acquirer (“merchant”) database to obtain product data, e.g., 1504, such as product information, product pricing, sales tax, offers, discounts, rewards, and/or other information to process the purchase transaction and/or provide value-added services for the user. In some embodiments, in response to obtaining the product data, the merchant server may generate, e.g., 1505, checkout data to provide, e.g., 1506, for the PoS client. Upon obtaining the checkout data, the PoS client may render and display, e.g., 1507, the checkout data for the user.

FIGS. 16A-B show datagraph diagrams illustrating example aspects of transforming a user virtual wallet access input via a Purchase Transaction Authorization (“PTA”) component into a purchase transaction receipt notification. With reference to FIG. 16A, in some embodiments, a user, e.g., 1601a, may wish to utilize a virtual wallet account to purchase a product, service, offering, and/or the like (“product”), from a merchant via a merchant online site or in the merchant's store. The user may utilize a physical card, or a user wallet device, e.g., 1601b, to access the user's virtual wallet account. For example, the user wallet device may be a personal/laptop computer, cellular telephone, smartphone, tablet, eBook reader, netbook, gaming console, and/or the like. The user may provide a wallet access input, e.g., 1611 into the user wallet device. In various embodiments, the user input may include, but not be limited to: a single tap (e.g., a one-tap mobile app purchasing embodiment) of a touchscreen interface, keyboard entry, card swipe, activating a RFID/NFC equipped hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user.

In some embodiments, upon authenticating the user for access to virtual wallet features, the user wallet device may provide a transaction authorization input, e.g., 1614, to a point-of-sale (“PoS”) client, e.g., 1602. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. For example, the PoS client may obtain, as transaction authorization input 1614, track 1 data from the user's plastic card (e.g., credit card, debit card, prepaid card, charge card, etc.), such as the example track 1 data provided below:

%B123456789012345\hat{ }PUBLIC/J.Q.\hat{ }99011200000000000000**901
******?*
(wherein ‘123456789012345’ is the card number of ‘J.Q. Public’ and has
a CVV number of 901. ‘990112’ is a service code, and *** represents
decimal digits which change randomly each time the card is used.)

In embodiments where the user utilizes a user wallet device, the user wallet device may provide payment information to the PoS client, formatted according to a data formatting protocol appropriate to the communication mechanism employed in the communication between the user wallet device and the PoS client. An example listing of transaction authorization input 1614, substantially in the form of XML-formatted data, is provided below:

```
<?XML version = “1.0” encoding = “UTF-8”?>
<transaction_authorization_input>
    <payment_data>
        <account>
            <charge_priority>1</charge_priority>
            <charge_ratio>40%</charge_ratio>
            <account_type>debit</account_type>
            <value_exchange_symbol>USD
            </value_exchange_symbol>
            <account_number>123456789012345</account_number>
            <account_name>John Q. Public</account_name>
            <bill_add>987 Green St #456, Chicago, IL
            94652</bill_add>
            <ship_add>987 Green St #456, Chicago, IL
            94652</ship_add>
            <CVV_type>dynamic<CVV_type>
    <CVV>http://www.paynet.com/dcvv.php?sessionID=
    4NFU4RG94</CVV>
            <cloak_flag>ON</cloak_flag>
            <alert_rules>tar1 tar4 tar12</alert_rules>
            <mode>NFC</mode>
        </account>
        <account>
            <charge_priority>1</charge_priority>
            <charge_ratio>60%</charge_ratio>
            <account_type>rewards</account_type>
            <value_exchange_symbol>VME
            </value_exchange_symbol>
            <account_number>234567890123456</account_number>
            <account_name>John Q. Public</account_name>
            <bill_add>987 Green St #456, Chicago,
            IL 94652</bill_add>
            <ship_add>987 Green St #456, Chicago, IL
            94652</ship_add>
            <CVV_type>static<CVV_type>
            <CVV>173</CVV>
            <cloak_flag>ON</cloak_flag>
            <alert_rules>tar1 tar4 tar12</alert_rules>
            <mode>Bluetooth</mode>
        </account>
        <account>
            <charge_priority>2</charge_priority>
            <charge_ratio>100%</charge_ratio>
            <account_number>345678901234567</account_number>
            <account_type>credit</account_type>
            <value_exchange_symbol>USD
            </value_exchange_symbol>
            <account_name>John Q. Public</account_name>
            <bill_add>987 Green St #456, Chicago, IL
            94652</bill_add>
            <ship_add>987 Green St #456, Chicago, IL
            94652</ship_add>
            <CVV_type>static<CVV_type>
            <CVV>173</CVV>
            <cloak_flag>ON</cloak_flag>
            <alert_rules>tar1 tar4 tar12</alert_rules>
            <mode>NFC</mode>
        </account>
    </payment_data>
    <!--optional data-->
    <timestamp>2011-02-22 15:22:43</timestamp>
    <expiry_lapse>00:00:30</expiry_lapse>
    <secure_key>0445329070598623487956543322</secure_key>
    <alert_strack_flag>TRUE</alert_strack_flag>
    <device_fingerprint>
        <device_IP>192.168.23.126</device_IP>
        <device_MAC>0123.4567.89ab</device_MAC>
        <device_serial>312456768798765432</device_serial>
        <device_ECID>00000AEBCDF12345</device_ECID>
        <device_identifier>jqp_air</device_identifier>
        <device_UDID>21343e34-14f4-8jn4-7yfe-
        124578632134</device_UDID>
        <device_browser>firefox 2.2</device_browser>
        <device_type>smartphone</device_type>
        <device_model>HTC Hero</device_model>
        <OS>Android 2.2</OS>
        <wallet_app_installed_flag>true</wallet_app_installed_flag>
    </device_fingerprint>
</transaction_authorization_input>
```

In some embodiments, the PoS client may generate a card authorization request, e.g., 1615, using the obtained transaction authorization input from the user wallet device, and/or product/checkout data (see, e.g., FIG. 14, 1415-1417). An example listing of a card authorization request 1615-1616, substantially in the form of a HTTP(S) POST message including XML-formatted data, is provided below:

```
POST /authorizationrequests.php HTTP/1.1
Host: www.acquirer.com
Content-Type: Application/XML
Content-Length: 1306
<?XML version = “1.0” encoding = “UTF-8”?>
<card_authorization_request>
    <session_ID>4NFU4RG94</order_ID>
    <!--optional data-->
    <timestamp>2011-02-22 15:22:43</timestamp>
    <expiry>00:00:30</expiry>
    <alerts_URL>www.merchant.com/shopcarts.php?sessionID=
AEBB4356</alerts_URL>
    <user_ID>john.q.public@gmail.com</user_ID>
    <device_fingerprint>
        <device_IP>192.168.23.126</device_IP>
        <device_MAC>0123.4567.89ab</device_MAC>
        <device_serial>312456768798765432</device_serial>
        <device_ECID>00000AEBCDF12345</device_ECID>
        <device_identifier>jqp_air</device_identifier>
        <device_UDID>21343e34-14f4-8jn4-7yfe-
        124578632134</device_UDID>
        <device_browser>firefox 2.2</device_browser>
        <device_type>smartphone</device_type>
        <device_model>HTC Hero</device_model>
        <OS>Android 2.2</OS>
        <wallet_app_installed_flag>true</wallet_app_installed_flag>
    </device_fingerprint>
    <purchase_details>
        <total_cost>$121.49</total_cost>
        <cart>
            <product>
                <merchant_params>
                <merchant_id>54TBRELF8</merchant_id>
                <merchant_name>BARNES, Inc.</merchant_name>
                <merchant_auth_key>TMN45GER98
                </merchant_auth_key>
                </merchant_params>
                <product_type>book</product_type>
                <product_params>
                <product_title>XML for dummies</product_title>
                <ISBN>938-2-14-168710-0</ISBN>
                <edition>2nd ed.</edition>
                <cover>hardbound</cover>
                </product_params>
                <quantity>2</quantity>
                <unit_cost>$14.46</unit_cost>
                <coupon_id>AY34567</coupon_id>
            <social_flag>ON</social_flag>
            <social_message>Look what I bought
today!</social_message>
            <social_networks>facebook twitter</social_networks>
            </product>
            <product>
                <merchant_params>
                <merchant_id>3FBCR4INC</merchant_id>
                <merchant_name>Books, Inc.</merchant_name>
                <merchant_auth_key>1N484MCP
                </merchant_auth_key>
                </merchant_params>
                <product_type>book</product_type>
                <product_params>
                <product_title>Sophie's World</product_title>
                <ISBN>955-2-14-112310-0</ISBN>
                <edition>NULL</edition>
                <cover>hardbound</cover>
                </product_params>
                <quantity>1</quantity>
                <unit_cost>$34.78</unit_cost>
                <coupon_id>null</coupon_id>
            <social_flag>OFF</social_flag>
            </product>
        </cart>
        <cart>
            <product>
                <merchant_params>
                <merchant_id>RFH5IB4FT</merchant_id>
                <merchant_name>Amzn, Inc.</merchant_name>
                <merchant_auth_key>44543DSJFG
                </merchant_auth_key>
                </merchant_params>
                <product_type>book</product_type>
                <product_params>
                <product_title>XML - a primer</product_title>
                <ISBN>938-2-14-1436710-0</ISBN>
                <edition>2nd ed.</edition>
                <cover>hardbound</cover>
                </product_params>
                <quantity>1</quantity>
                <unit_cost>$12.93</unit_cost>
                <coupon_id>AY34567</coupon_id>
            <social_flag>ON</social_flag>
            <social_message>Look what I bought
today!</social_message>
            <social_networks>facebook twitter</social_networks>
            </product>
            <product>
                <merchant_params>
                <merchant_id>3FBCR4INC</merchant_id>
                <merchant_name>BestBooks, Inc.</merchant_name>
                <merchant_auth_key>1N484MCP
                </merchant_auth_key>
                </merchant_params>
                <product_type>book</product_type>
                <product_params>
                <product_title>Sophie's Choice</product_title>
                <ISBN>938-2-14-168710-0</ISBN>
                <edition>1st ed.</edition>
                </product_params>
                <quantity>1</quantity>
                <unit_cost>$44.86</unit_cost>
                <coupon_id>null</coupon_id>
            <social_flag>OFF</social_flag>
            </product>
        </cart>
    </purchase_details>
    <account_params>
        <account>
            <charge_priority>1</charge_priority>
            <charge_ratio>40%</charge_ratio>
            <account_type>debit</account_type>
            <value_exchange_symbol>USD
            </value_exchange_symbol>
            <account_number>123456789012345</account_number>
            <account_name>John Q. Public</account_name>
            <bill_add>987 Green St #456, Chicago, IL
            94652</bill_add>
            <ship_add>987 Green St #456, Chicago, IL
            94652</ship_add>
            <CVV_type>dynamic<CVV_type>
    <CVV>http://www.paynet.com/dcvv.php?sessionID=
    4NFU4RG94</CVV>
            <cloak_flag>ON</cloak_flag>
            <alert_rules>tar1 tar4 tar12</alert_rules>
            <mode>NFC</mode>
        </account>
        <account>
            <charge_priority>1</charge_priority>
            <charge_ratio>60%</charge_ratio>
            <account_type>rewards</account_type>
            <value_exchange_symbol>VME
            </value_exchange_symbol>
            <account_number>234567890123456</account_number>
            <account_name>John Q. Public</account_name>
            <bill_add>987 Green St #456, Chicago, IL
            94652</bill_add>
            <ship_add>987 Green St #456, Chicago, IL
            94652</ship_add>
            <CVV_type>static<CVV_type>
            <CVV>173</CVV>
            <cloak_flag>ON</cloak_flag>
            <alert_rules>tar1 tar4 tar12</alert_rules>
            <mode>Bluetooth</mode>
        </account>
        <account>
            <charge_priority>2</charge_priority>
            <charge_ratio>100%</charge_ratio>
            <account_number>345678901234567</account_number>
            <account_type>credit</account_type>
            <value_exchange_symbol>USD
            </value_exchange_symbol>
            <account_name>John Q. Public</account_name>
            <bill_add>987 Green St #456, Chicago, IL
            94652</bill_add>
            <ship_add>987 Green St #456, Chicago, IL
            94652</ship_add>
            <CVV_type>static<CVV_type>
            <CVV>173</CVV>
            <cloak_flag>011</cloak_flag>
            <alert_rules>tar1 tar4 tar12</alert_rules>
            <mode>NFC</mode>
        </account>
    </account_params>
    <shipping_info>
        <shipping_adress>#ref-ANON-123-45-678</shipping_address>
        <ship_type>expedited</ship_type>
        <ship_carrier>FedEx</ship_carrier>
        <ship_account>ANON-123-45-678</ship_account>
        <tracking_flag>true</tracking_flag>
        <sign_flag>false</sign_flag>
    </shipping_info>
</card_authorization_request>
```

In some embodiments, the card authorization request generated by the user device may include a minimum of information required to process the purchase transaction. For example, this may improve the efficiency of communicating the purchase transaction request, and may also advantageously improve the privacy protections provided to the user and/or merchant. For example, in some embodiments, the card authorization request may include at least a session ID for the user's shopping session with the merchant. The session ID may be utilized by any component and/or entity having the appropriate access authority to access a secure site on the merchant server to obtain alerts, reminders, and/or other data about the transaction(s) within that shopping session between the user and the merchant. In some embodiments, the PoS client may provide the generated card authorization request to the merchant server, e.g., 1616. The merchant server may forward the card authorization request to a pay gateway server, e.g., 1604a, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., merchant/acquirer database 1603b, for a network address of the payment gateway server, for example by using a portion of a user payment card number, or a user ID (such as an email address) as a keyword for the database query. For example, the merchant server may issue PHP/SQL commands to query a database table (such as FIG. 26, Pay Gateways 2619h) for a URL of the pay gateway server. An example payment gateway address query 1617, substantially in the form of PHP/SQL commands, is provided below:

<?PHP
header(‘Content-Type: text/plain’);
mysql_connect(“254.93.179.112”,$DBserver,$password);
// access database server
mysql_select_db(“Bill Pay_DB.SQL”); // select database table to search
//create query
$query = “SELECT paygate_id paygate_address
paygate_URL paygate_name FROM PayGatewayTable
WHERE card_num LIKE ‘%’ $cardnum”;
$result = mysql_query($query); // perform the search query
mysql_close(“Bill Pay_DB.SQL”); // close database access
?>

In response, the merchant/acquirer database may provide the requested payment gateway address, e.g., 1618. The merchant server may forward the card authorization request to the pay gateway server using the provided address, e.g., 1619. In some embodiments, upon receiving the card authorization request from the merchant server, the pay gateway server may invoke a component to provide one or more services associated with purchase transaction authorization. For example, the pay gateway server may invoke components for fraud prevention, loyalty and/or rewards, and/or other services for which the user-merchant combination is authorized. The pay gateway server may forward the card authorization request to a pay network server, e.g., 1605a, for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., pay gateway database 1604b, for a network address of the payment network server, for example by using a portion of a user payment card number, or a user ID (such as an email address) as a keyword for the database query. For example, the pay gateway server may issue PHP/SQL commands to query a database table (such as FIG. 26, Pay Gateways 2619h) for a URL of the pay network server. An example payment network address query 1621, substantially in the form of PHP/SQL commands, is provided below:

<?PHP
header(‘Content-Type: text/plain’);
mysql_connect(“254.93.179.112”,$DBserver,$password);
// access database server
mysql_select_db(“Bill Pay_DB.SQL”); // select database table to search
//create query
$query = “SELECT payNET_id payNET_address
payNET_URL payNET_name FROM PayGatewayTable WHERE
card_num LIKE ‘%’ $cardnum”;
$result = mysql_query($query); // perform the search query
mysql_close(“Bill Pay_DB.SQL”); // close database access
?>

In response, the payment gateway database may provide the requested payment network address, e.g., 1622. The pay gateway server may forward the card authorization request to the pay network server using the provided address, e.g., 1623.

With reference to FIG. 16B, in some embodiments, the pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer.

In some embodiments, the pay network server may generate a query, e.g., 1624, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s), e.g., 1606a, of the issuer(s) may maintain details of the user's account(s). In some embodiments, a database, e.g., pay network database 1605b, may store details of the issuer server(s) associated with the issuer(s). In some embodiments, the pay network server may query a database, e.g., pay network database 1605b, for a network address of the issuer(s) server(s), for example by using a portion of a user payment card number, or a user ID (such as an email address) as a keyword for the database query. For example, the merchant server may issue PHP/SQL commands to query a database table (such as FIG. 26, Issuers 2619f) for network address(es) of the issuer(s) server(s). An example issuer server address(es) query 1624, substantially in the form of PHP/SQL commands, is provided below:

<?PHP
header(‘Content-Type: text/plain’);
mysql_connect(“254.93.179.112”,$DBserver,$password); // access
database server
mysql_select_db(“Bill Pay_DB.SQL”); // select database table to search
//create query
$query = “SELECT issuer_id issuer_address issuer_URL issuer_name
FROM
IssuersTable WHERE card_num LIKE ‘%’ $cardnum”;
$result = mysql_query($query); // perform the search query
mysql_close(“Bill Pay_DB.SQL”); // close database access
?>

In response to obtaining the issuer server query, e.g., 1624, the pay network database may provide, e.g., 1625, the requested issuer server data to the pay network server. In some embodiments, the pay network server may utilize the issuer server data to generate funds authorization request(s), e.g., 1626, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. An example listing of a funds authorization request 1626, substantially in the form of a HTTP(S) POST message including XML-formatted data, is provided below:

```
POST /fundsauthorizationrequest.php HTTP/1.1
Host: www.issuer.com
Content-Type: Application/XML
Content-Length: 624
<?XML version = “1.0” encoding = “UTF-8”?>
<funds_authorization_request>
    <request_ID>VNEI39FK</request_ID>
    <timestamp>2011-02-22 15:22:44</timestamp>
    <debit_amount>$72.89</debit_amount>
    <account_params>
        <account>
            <account_type>debit</account_type>
            <value_exchange_symbol>USD</
            value_exchange_symbol>
            <account_number>123456789012345</account_number>
            <account_name>John Q. Public</account_name>
            <bill_add>987 Green St #456, Chicago,
            IL 94652</bill_add>
            <ship_add>987 Green St #456, Chicago,
            IL 94652</ship_add>
            <CVV>1234</CVV>
        </account>
    </account_params>
    <!--optional parameters-->
    <user_device_fingerprint>
        <device_IP>192.168.23.126</device_IP>
        <device_MAC>0123.4567.89ab</device_MAC>
        <device_serial>312456768798765432</device_serial>
        <device_ECID>00000AEBCDF12345</device_ECID>
        <device_identifier>jqp_air</device_identifier>
        <device_UDID>21343e34-14f4-8jn4-7yfe-
        124578632134</device_UDID>
        <device_browser>firefox 2.2</device_browser>
        <device_type>smartphone</device_type>
        <device_model>HTC Hero</device_model>
        <OS>Android 2.2</OS>
        <wallet_app_installed_flag>true</wallet_app_installed_flag>
    </user_device_fingerprint>
</funds_authorization_request>
```

In some embodiments, an issuer server may parse the authorization request(s), and based on the request details may query a database, e.g., user profile database 1606b, for data associated with an account linked to the user. For example, the merchant server may issue PHP/SQL commands to query a database table (such as FIG. 26, Accounts 2619d) for user account(s) data. An example user account(s) query 1627, substantially in the form of PHP/SQL commands, is provided below:

<?PHP
header(‘Content-Type: text/plain’);
mysql_connect(“254.93.179.112”,$DBserver,$password); // access
database server
mysql_select_db(“Bill Pay_DB.SQL”); // select database table to search
//create query
$query = “SELECT issuer user_id user_name user_balance
account_type FROM
AccountsTable WHERE account_num LIKE ‘%’ $accountnum”;
$result = mysql_query($query); // perform the search query
mysql_close(“Bill Pay_DB.SQL”); // close database access
?>

In some embodiments, on obtaining the user account(s) data, e.g., 1628, the issuer server may determine whether the user can pay for the transaction using funds available in the account, 1629. For example, the issuer server may determine whether the user has a sufficient balance remaining in the account, sufficient credit associated with the account, and/or the like. Based on the determination, the issuer server(s) may provide a funds authorization response, e.g., 1630, to the pay network server. For example, the issuer server(s) may provide a HTTP(S) POST message similar to the examples above. In some embodiments, if at least one issuer server determines that the user cannot pay for the transaction using the funds available in the account, the pay network server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the pay network server may abort the authorization process, and provide an “authorization fail” message to the merchant server, user device and/or client.

In some embodiments, the pay network server may obtain the funds authorization response including a notification of successful authorization, and parse the message to extract authorization details. Upon determining that the user possesses sufficient funds for the transaction, e.g., 1631, the pay network server may invoke a component to provide value-add services for the user.

In some embodiments, the pay network server may generate a transaction data record from the authorization request and/or authorization response, and store the details of the transaction and authorization relating to the transaction in a transactions database. For example, the pay network server may issue PHP/SQL commands to store the data to a database table (such as FIG. 26, Transactions 2619i). An example transaction store command, substantially in the form of PHP/SQL commands, is provided below:

<?PHP
header(‘Content-Type: text/plain’);
mysql_connect(“254.92.185.103”,$DBserver,$password); // access database server
mysql_select(“Bill Pay_DB.SQL”); // select database to append
mysql_query(“INSERT INTO TransactionsTable (PurchasesTable (timestamp,
purchase_summary_list, num_products, product_summary, product_quantity,
transaction_cost, account_params_list, account_name, account_type, account_num,
billing_addres, zipcode, phone, sign, merchant_params_list, merchant_id,
merchant_name, merchant_auth_key)
VALUES (time( ), $purchase_summary_list, $num_products, $product_summary,
$product_quantity, $transaction_cost, $account_params_list, $account_name,
$account_type, $account_num, $billing_addres, $zipcode, $phone, $sign,
$merchant_params_list, $merchant_id, $merchant_name, $merchant_auth_key)”); //
add data to table in database
mysql_close(“Bill Pay_DB.SQL”); // close connection to database
?>

In some embodiments, the pay network server may forward a transaction authorization response, e.g., 1632, to the user wallet device, PoS client, and/or merchant server. The merchant may obtain the transaction authorization response, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 1633, and store the XML data file, e.g., 1634, in a database, e.g., merchant database 404. For example, a batch XML data file may be structured similar to the example XML data structure template provided below:

```
<?XML version = “1.0” encoding = “UTF-8”?>
    <merchant_data>
    <merchant_id>3FBCR4INC</merchant_id>
    <merchant_name>Books & Things, Inc.</merchant_name>
    <merchant_auth_key>1NNF484MCF59CHB27365</
    merchant_auth_key>
    <account_number>123456789</account_number>
</merchant_data>
<transaction_data>
    <transaction 1>
        ...
    </transaction 1>
    <transaction 2>
        ...
    </transaction 2>
        .
        .
        .
    <transaction n>
        ...
    </transaction n>
</transaction_data>
```

In some embodiments, the server may also generate a purchase receipt, e.g., 1633, and provide the purchase receipt to the client, e.g., 1635. The client may render and display, e.g., 1636, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

FIGS. 17A-B show logic flow diagrams illustrating example aspects of transforming a user virtual wallet access input via a Purchase Transaction Authorization (“PTA”) component into a purchase transaction receipt notification. With reference to FIG. 17A, in some embodiments, a user may wish to utilize a virtual wallet account to purchase a product, service, offering, and/or the like (“product”), from a merchant via a merchant online site or in the merchant's store. The user may utilize a physical card, or a user wallet device to access the user's virtual wallet account. For example, the user wallet device may be a personal/laptop computer, cellular telephone, smartphone, tablet, eBook reader, netbook, gaming console, and/or the like. The user may provide a wallet access input, e.g., 1701, into the user wallet device. In various embodiments, the user input may include, but not be limited to: a single tap (e.g., a one-tap mobile app purchasing embodiment) of a touchscreen interface, keyboard entry, card swipe, activating a RFID/NFC equipped hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user, e.g., 1702-1703.

In some embodiments, upon authenticating the user for access to virtual wallet features, the user wallet device may provide a transaction authorization input, e.g., 1704, to a point-of-sale (“PoS”) client. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. In embodiments where the user utilizes a user wallet device, the user wallet device may provide payment information to the PoS client, formatted according to a data formatting protocol appropriate to the communication mechanism employed in the communication between the user wallet device and the PoS client.

In some embodiments, the PoS client may obtain the transaction authorization input, and parse the input to extract payment information from the transaction authorization input, e.g., 1705. For example, the PoS client may utilize a parser, such as the example parsers provided below in the discussion with reference to FIG. 26. The PoS client may generate a card authorization request, e.g., 1706, using the obtained transaction authorization input from the user wallet device, and/or product/checkout data (see, e.g., FIG. 14, 1415-1417).

In some embodiments, the PoS client may provide the generated card authorization request to the merchant server. The merchant server may forward the card authorization request to a pay gateway server, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., 1708, for a network address of the payment gateway server, for example by using a portion of a user payment card number, or a user ID (such as an email address) as a keyword for the database query. In response, the merchant/acquirer database may provide the requested payment gateway address, e.g., 1710. The merchant server may forward the card authorization request to the pay gateway server using the provided address. In some embodiments, upon receiving the card authorization request from the merchant server, the pay gateway server may invoke a component to provide one or more service associated with purchase transaction authorization, e.g., 1711. For example, the pay gateway server may invoke components for fraud prevention (see e.g., VerifyChat, FIG. 3E), loyalty and/or rewards, and/or other services for which the user-merchant combination is authorized.

The pay gateway server may forward the card authorization request to a pay network server for payment processing, e.g., 1714. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., 1712, for a network address of the payment network server, for example by using a portion of a user payment card number, or a user ID (such as an email address) as a keyword for the database query. In response, the payment gateway database may provide the requested payment network address, e.g., 1713. The pay gateway server may forward the card authorization request to the pay network server using the provided address, e.g., 1714.

With reference to FIG. 17B, in some embodiments, the pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer. In some embodiments, the pay network server may generate a query, e.g., 1715, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s) of the issuer(s) may maintain details of the user's account(s). In some embodiments, a database, e.g., a pay network database, may store details of the issuer server(s) associated with the issuer(s). In some embodiments, the pay network server may query a database, e.g., 1715, for a network address of the issuer(s) server(s), for example by using a portion of a user payment card number, or a user ID (such as an email address) as a keyword for the database query.

In response to obtaining the issuer server query, the pay network database may provide, e.g., 1716, the requested issuer server data to the pay network server. In some embodiments, the pay network server may utilize the issuer server data to generate funds authorization request(s), e.g., 1717, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. In some embodiments, an issuer server may parse the authorization request(s), e.g., 1718, and based on the request details may query a database, e.g., 1719, for data associated with an account linked to the user.

In some embodiments, on obtaining the user account(s) data, e.g., 1720, the issuer server may determine whether the user can pay for the transaction using funds available in the account, e.g., 1721. For example, the issuer server may determine whether the user has a sufficient balance remaining in the account, sufficient credit associated with the account, and/or the like. Based on the determination, the issuer server(s) may provide a funds authorization response, e.g., 1722, to the pay network server. In some embodiments, if at least one issuer server determines that the user cannot pay for the transaction using the funds available in the account, the pay network server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the pay network server may abort the authorization process, and provide an “authorization fail” message to the merchant server, user device and/or client.

In some embodiments, the pay network server may obtain the funds authorization response including a notification of successful authorization, and parse the message to extract authorization details. Upon determining that the user possesses sufficient funds for the transaction, e.g., 1723, the pay network server may invoke a component to provide value-add services for the user, e.g., 1723.

In some embodiments, the pay network server may forward a transaction authorization response to the user wallet device, PoS client, and/or merchant server. The merchant may parse, e.g., 1724, the transaction authorization response, and determine from it that the user possesses sufficient funds in the card account to conduct the transaction, e.g., 1725, option“Yes.” The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 1726, and store the XML data file, e.g., 1727, in a database. In some embodiments, the server may also generate a purchase receipt, e.g., 1728, and provide the purchase receipt to the client. The client may render and display, e.g., 1729, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

FIGS. 18A-B show data flow diagrams illustrating example aspects of transforming a merchant transaction batch data query via a Purchase Transaction Clearance (“PTC”) component into an updated payment ledger record. With reference to FIG. 18A, in some embodiments, a merchant server, e.g., 1803a, may initiate clearance of a batch of authorized transactions. For example, the merchant server may generate a batch data request, e.g., 1811, and provide the request, to a merchant database, e.g., 1803b. For example, the merchant server may utilize PHP/SQL commands similar to the examples provided above to query a relational database. In response to the batch data request, the database may provide the requested batch data, e.g., 1812. The server may generate a batch clearance request, e.g., 1813, using the batch data obtained from the database, and provide, e.g., 1814, the batch clearance request to an acquirer server, e.g., 1807a. For example, the merchant server may provide a HTTP(S) POST message including XML-formatted batch data in the message body for the acquirer server. The acquirer server may generate, e.g., 1815, a batch payment request using the obtained batch clearance request, and provide, e.g., 1818, the batch payment request to the pay network server, e.g., 1805a. The pay network server may parse the batch payment request, and extract the transaction data for each transaction stored in the batch payment request, e.g., 1819. The pay network server may store the transaction data, e.g., 1820, for each transaction in a database, e.g., pay network database 1805b. In some embodiments, the pay network server may invoke a component to provide value-add analytics services based on analysis of the transactions of the merchant for whom the Bill Pay is clearing purchase transactions. Thus, in some embodiments, the pay network server may provide analytics-based value-added services for the merchant and/or the merchant's users.

With reference to FIG. 18B, in some embodiments, for each extracted transaction, the pay network server may query, e.g., 1823, a database, e.g., pay network database 1805b, for an address of an issuer server. For example, the pay network server may utilize PHP/SQL commands similar to the examples provided above. The pay network server may generate an individual payment request, e.g., 1825, for each transaction for which it has extracted transaction data, and provide the individual payment request, e.g., 1825, to the issuer server, e.g., 1806a. For example, the pay network server may provide an individual payment request to the issuer server(s) as a HTTP(S) POST message including XML-formatted data. An example listing of an individual payment request 1825, substantially in the form of a HTTP(S) POST message including XML-formatted data, is provided below:

```
POST /paymentrequest.php HTTP/1.1
Host: www.issuer.com
Content-Type: Application/XML
Content-Length: 788
<?XML version = “1.0” encoding = “UTF-8”?>
<pay_request>
    <request_ID>CNI4ICNW2</request_ID>
    <timestamp>2011-02-22 17:00:01</timestamp>
    <pay_amount>$72.89</pay_amount>
    <account_params>
        <account>
            <account_type>debit</account_type>
            <value_exchange_symbol>USD</
            value_exchange_symbol>
            <account_number>123456789012345</account_number>
            <account_name>John Q. Public</account_name>
            <bill_add>987 Green St #456, Chicago,
            IL 94652</bill_add>
            <ship_add>987 Green St #456, Chicago,
            IL 94652</ship_add>
            <CVV>1234</CVV>
        </account>
    </account_params>
</pay_request>
```

In some embodiments, the issuer server may generate a payment command, e.g., 1827. For example, the issuer server may issue a command to deduct funds from the user's account (or add a charge to the user's credit card account). The issuer server may issue a payment command, e.g., 1827, to a database storing the user's account information, e.g., user profile database 1806b. The issuer server may provide an individual payment confirmation, e.g., 1828, to the pay network server, which may forward, e.g., 1829, the funds transfer message to the acquirer server. An example listing of an individual payment confirmation 1828, substantially in the form of a HTTP(S) POST message including XML-formatted data, is provided below:

```
POST /clearance.php HTTP/1.1
Host: www.acquirer.com
Content-Type: Application/XML
Content-Length: 206
<?XML version = “1.0” encoding = “UTF-8”?>
<deposit_ack>
    <request_ID>CNI4ICNW2</request_ID>
    <clear_flag>true</clear_flag>
    <timestamp>2011-02-22 17:00:02</timestamp>
    <deposit_amount>$72.89</deposit_amount>
</deposit_ack>
```

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 1830, an acquirer database 1807b for payment ledger and/or merchant account data, e.g., 1831. The acquirer server may utilize payment ledger and/or merchant account data from the acquirer database, along with the individual payment confirmation, to generate updated payment ledger and/or merchant account data, e.g., 1832. The acquirer server may then store, e.g., 1833, the updated payment ledger and/or merchant account data to the acquire database.

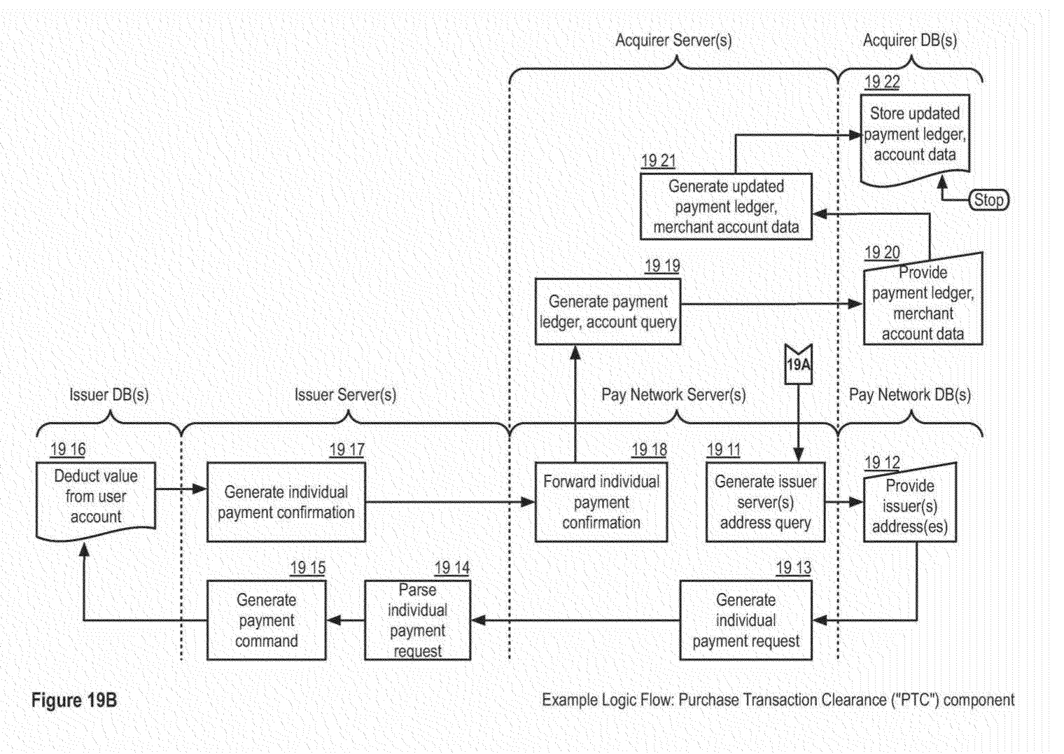

FIGS. 19A-B show logic flow diagrams illustrating example aspects of transforming a merchant transaction batch data query via a Purchase Transaction Clearance (“PTC”) component into an updated payment ledger record. With reference to FIG. 19A, in some embodiments, a merchant server may initiate clearance of a batch of authorized transactions. For example, the merchant server may generate a batch data request, e.g., 1901, and provide the request to a merchant database. In response to the batch data request, the database may provide the requested batch data, e.g., 1902. The server may generate a batch clearance request, e.g., 1903, using the batch data obtained from the database, and provide the batch clearance request to an acquirer server. The acquirer server may parse, e.g., 1904, the obtained batch clearance request, and generate, e.g., 1907, a batch payment request using the obtained batch clearance request to provide, the batch payment request to a pay network server. For example, the acquirer server may query, e.g., 1905, an acquirer database for an address of a payment network server, and utilize the obtained address, e.g., 1906, to forward the generated batch payment request to the pay network server.

The pay network server may parse the batch payment request obtained from the acquirer server, and extract the transaction data for each transaction stored in the batch payment request, e.g., 1908. The pay network server may store the transaction data, e.g., 1909, for each transaction in a pay network database. In some embodiments, the pay network server may invoke a component, e.g., 1910, to provide analytics based on the transactions of the merchant for whom purchase transaction are being cleared.

With reference to FIG. 19B, in some embodiments, for each extracted transaction, the pay network server may query, e.g., 1911, a pay network database for an address of an issuer server. The pay network server may generate an individual payment request, e.g., 1913, for each transaction for which it has extracted transaction data, and provide the individual payment request to the issuer server. In some embodiments, the issuer server may parse the individual payment request, e.g., 1914, and generate a payment command, e.g., 1915, based on the parsed individual payment request. For example, the issuer server may issue a command to deduct funds from the user's account (or add a charge to the user's credit card account). The issuer server may issue a payment command, e.g., 1915, to a database storing the user's account information, e.g., a user profile database. The issuer server may provide an individual payment confirmation, e.g., 1917, to the pay network server, which may forward, e.g., 1918, the individual payment confirmation to the acquirer server.

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 1919, an acquirer database for payment ledger and/or merchant account data, e.g., 1920. The acquirer server may utilize payment ledger and/or merchant account data from the acquirer database, along with the individual payment confirmation, to generate updated payment ledger and/or merchant account data, e.g., 1921. The acquirer server may then store, e.g., 1922, the updated payment ledger and/or merchant account data to the acquire database.

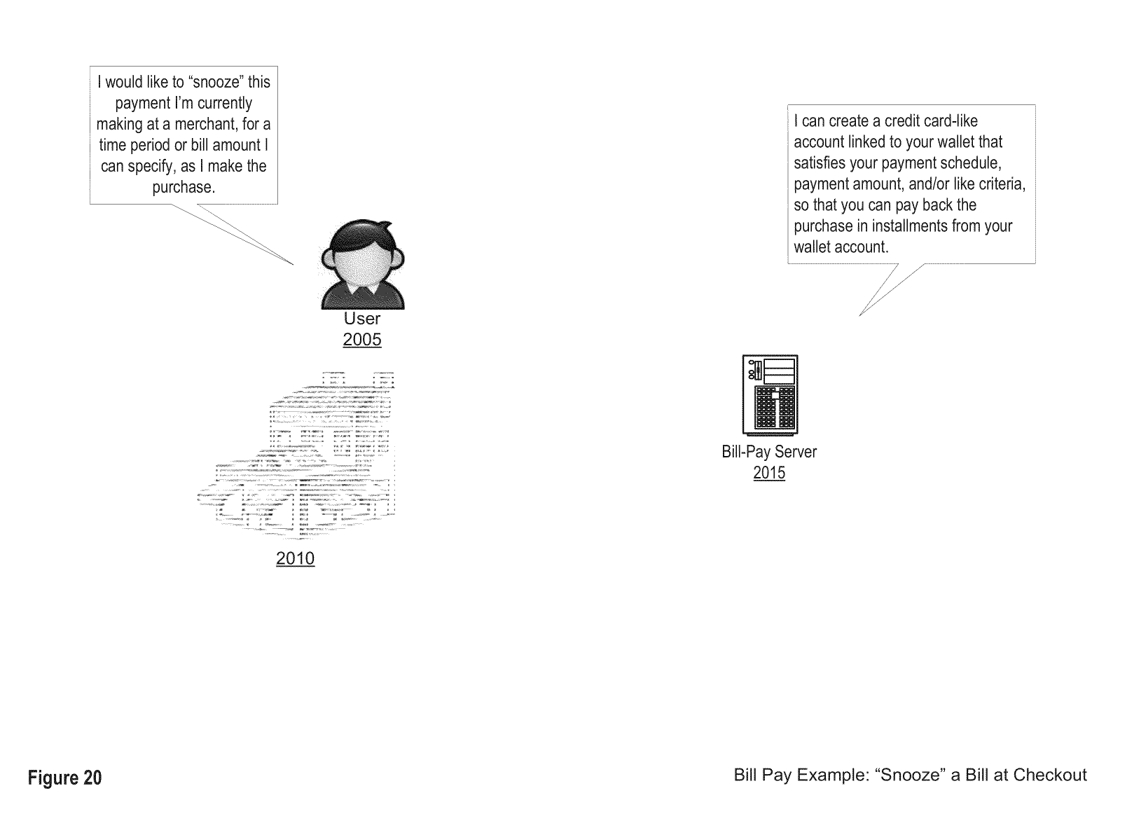

FIG. 20 shows a block diagram illustrating an example aspect of using Bill Pay at checkout in some embodiments of the Bill-Pay. In some embodiments, a user 2005 may wish to make a purchase at a merchant 2010. The user may wish to “snooze” the bill, a part of the bill (e.g., a percentage of a bill, a particular item or set of items in the bill, and/or the like), and/or the like at the time of checkout, rather than after the purchase has been made, and may wish to control the conditions of “snoozing” the bill (e.g., may wish to decide the time period the user has for paying off the bill, may wish to control how much each payment is per pay period, the number of total payments necessary to pay off the bill, the amount to pay at the time of purchase, and/or the like). In some implementations, Bill Pay 2015 may facilitate such a purchase, by generating a credit card-like payment account for the user, which expires after the user has fully paid for the bill, and which may satisfy any criteria that the user provides for determining how to pay off the bill.

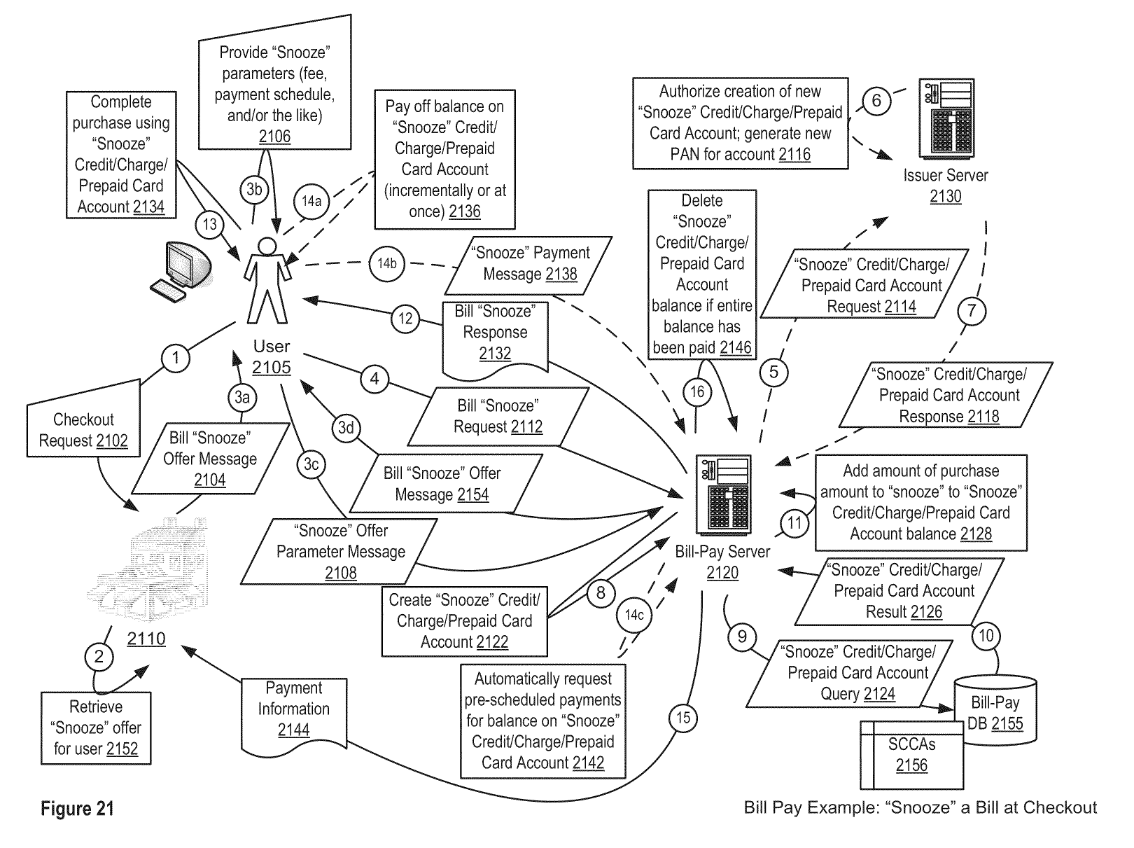

FIG. 21 shows a data flow diagram illustrating further examples of a of a user purchase checkout in some embodiments of the Bill Pay. In some implementations, a user 2105 may wish to check out at a merchant 2110. In some implementations, the merchant may be an online or a brick-and-mortar merchant. In some implementations the user may use a wallet-enabled electronic device to send a checkout request 2102 to the merchant containing information about the products the user would like to purchase. In some implementations, checkout request 2102 may be an XML-encoded message which may take a form similar to the following:

```
POST /checkout_request.php HTTP/1.1
Host: www.BILLPAYproccess.com
Content-Type: Application/XML
Content-Length: 788
<?XML version = “1.0” encoding = “UTF-8”?>
<checkout_request>
<timestamp>2016-01-01 12:30:00</timestamp>
    <user_params>
        <user_ID>123456789</user_ID>
        <user_password>********</user_password>
        <wallet_ID>A2C4E6G8I</wallet_ID>
    </user_params>
    <checkout_params>
        <date_performed>2012-01-01 12:30:00</date_performed>
        <merchant_ID>82719487194</merchant_ID>
        <transaction_total>100</transaction_total>
        <pay_method>wallet</pay_method>
        ...
        <products_list>
            <product>
                ...
            </product>
            ...
            <product>
                ...
            </product>
        </products_list>
    </checkout_params>
</checkout_request>
```

In some implementations, the merchant may retrieve 2152 a “Snooze” offer sent to it by an issuer or by Bill Pay, which may match the user's checkout parameters (e.g. the offer may match the cost of the user's purchase, the offer may match some of the user's provided information, and/or the like). In some implementations, the merchant may retrieve such offers from a database repository, which may receive such offers from Bill Pay, an issuer, and/or the like. In alternative embodiments, the issuer, Bill Pay, and/or the like may directly send offers stored in their respective repositories to the user, rather than having a merchant provide them. The merchant may then send a Bill “Snooze” Offer message 2104 to the user with the retrieved offer. In some implementations, Bill “Snooze” Offer message 2104 may be an XML-encoded message which may take a form similar to the following:

```
POST/snooze_offer_message.php HTTP/1.1
Host: www.BILLPAYproccess.com
Content-Type: Application/XML
Content-Length: 788
<?XML version = “1.0” encoding = “UTF-8”?>
<snooze_offer_message>
<timestamp>2016-01-01 12:30:00</timestamp>
    <merchant_params>
        <merchant_ID>82719487194</merchant_ID>
        <merchant_location>40.1, −70.2</merchant_location>
        <merchant_name>Best Buy</merchant_name>
    </merchant_params>
    <user_params>
        <user_ID>123456789</user_ID>
        <user_password>********</user_password>
        <wallet_ID>A2C4E6G8I</wallet_ID>
    </user_params>
    <offer_params>
        <offer_ID>452813721452719418</offer_ID>
        <offer_balance>50<offer_default_balance>
        <offer_deadline>5, days<offer_default_deadline>
        <offer_num_payments><offer_default_num_payments>
        <offer_installments><offer_installments>
        <offer_min_installment>10<offer_min_installment>
        <offer_fee>5</offer_fee>
        <offer_issuer_ID>937948732010<offer_issuer_ID>
    </offer_params>
</snooze_offer_message>
```

In some implementations, the user may then be able to provide “snooze” parameters in order to alter the default conditions for the deal 2106. For example, the user may be able to choose his own payment schedule, may be able to choose the fees or amount he would like to pay per pay period, the total amount he would like to “snooze” from a particular bill, and/or the like. In some implementations the user may also be able to determine which issuer he chooses to work with in order to “snooze” his bills 4 (e.g., in the event that different issuers require different fees, restrictions, and/or the like). In some implementations, the user's electronic device may send this altered information via a “Snooze” Offer Parameter message 2108 to the Bill Pay server 2120. In some implementations, “Snooze” Offer Parameter message 2108 may be an XML-encoded message which may take a form similar to the following:

```
POST /snooze_offer_param_message.php HTTP/1.1
Host: www.BILLPAYproccess.com
Content-Type: Application/XML
Content-Length: 788
<?XML version = “1.0” encoding = “UTF-8”?>
<snooze_offer_param_message>
<timestamp>2016-01-01 12:30:00</timestamp>
    <merchant_params>
        <merchant_ID>82719487194</merchant_ID>
        <merchant_location>40.1, −70.2</merchant_location>
        <merchant_name>Best Buy</merchant_name>
    </merchant_params>
    <user_params>
        <user_ID>123456789</user_ID>
        <user_password>********</user_password>
        <wallet_ID>A2C4E6G8I</wallet_ID>
        <payment_information>
            <payment_type>credit</payment_type>
            <payment_number>1234567809876543</
            payment_number>
            <payment_exp_date>2020-01-01<payment_exp_date>
            <payment_cvv>123<payment_cvv>
        <payment_information>
    </user_params>
    <default_offer_params>
        <offer_ID>452813721452719418</offer_ID>
        <offer_balance>50<offer_default_balance>
        <offer_deadline>5, days<offer_default_deadline>
        <offer_num_payments><offer_default_num_payments>
        <offer_installments><offer_installments>
        <offer_min_installment>10<offer_min_installment>
        <offer_fee>5</offer_fee>
        <offer_issuer_ID>937948732010<offer_issuer_ID>
    </default_offer_params>
    <user_offer_params>
        <offer_ID>452813721452719418</offer_ID>
        <offer_default_balance>75<offer_default_balance>
        <offer_default_deadline> <offer_default_deadline>
        <offer_default_num_payments>
        <offer_default_num_payments>
        <offer_installments><offer_installments>
        <offer_min_installment><offer_min_installment>
        <offer_fee></offer_fee>
        <offer_issuer_ID>928139827498247<offer_issuer_ID>
    </user_offer_params>
</snooze_offer_param_message>
```

In some implementations, Bill Pay server may then send an updated Bill “Snooze” Offer message 2154 to the user, which includes updated information about the offer based on the user-provided criteria. In some implementations this Bill “Snooze” Offer message may take a form similar to Bill “Snooze” Offer message 2104. In some implementations, for example, user instructions to change the payment schedule for the bill may cause Bill Pay to change the amount due per pay period, the total amount of time allocated to pay back the bill, and/or the like.

In some implementations, the user and the Bill Pay server may continue to communicate with each other until the user has obtained offer conditions that he approves of. In some implementations, the merchant's offer message 2104 may include the parameters Bill Pay may use to update the offer, thus allowing the user's wallet application to automatically calculate the updated offer information without the need to communicate with the Bill Pay server. In other implementations, the user and the merchant may communicate together in order to determine the offer conditions that satisfy the user.

Once the user wishes to accept the “snooze” offer, the user's wallet-enabled device may send a Bill “Snooze” Request 2112 to the Bill Pay server, containing the finalized offer information, payment details, and/or the like. In some implementations, the Bill “Snooze” Request 2112 may be an XML-encoded message which may take a form similar to the following:

```
POST /snooze_reguest.php HTTP/1.1
Host: www.BILLPAYproccess.com
Content-Type: Application/XML
Content-Length: 788
<?XML version = “1.0” encoding = “UTF-8”?>
<snooze_reguest>
<timestamp>2016-01-01 12:30:00</timestamp>
    <merchant_params>
        <merchant_ID>82719487194</merchant_ID>
        <merchant_location>40.1, −70.2</merchant_location>
        <merchant_name>Best Buy</merchant_name>
    </merchant_params>
    <user_params>
        <user_ID>123456789</user_ID>
        <user_password>********</user_password>
        <wallet_ID>A2C4E6G8I</wallet_ID>
    </user_params>
    <checkout_params>
        <checkout_total>100</checkout_total>
    </checkout_params>
    <offer_params>
        <offer_ID>452813721452719418</offer_ID>
        <offer_balance>75<offer_default_balance>
        <offer_deadline>8, days<offer_default_deadline>
        <offer_num_payments>8<offer_default_num_payments>
        <offer_installments>10<offer_installments>
        <offer_min_installment>5<offer_min_installment>
        <offer_fee>3</offer_fee>
        <offer_issuer_ID>928139827498247<offer_issuer_ID>
    </offer_params>
</snooze_request>
```

In other implemenetations, the Bill Pay server may request an external issuer 2130 to create a credit card-like account for the user. In some implementations, the account may carry a balance based on the amount the user will “snooze” from his bill, and wherein Bill Pay may delete or inactivate such an account after the balance has been paid, thus expiring the account after the “snoozed” bill has been handled. In some implementations, the account could be a Credit Card Account, a Charge Card Account, a Prepaid Card Account, and/or the like. In some implementations, the Bill Pay server may send a “Snooze” Credit Card Account Request 2114 to the external issuer server in order to ask for an account. In some implementations, the “Snooze” Credit Card Account Request 2114 may be an XML-encoded message that may take a form similar to the following:

```
POST /snooze_cc_account_request.php HTTP/1.1
Host: www.BILLPAYproccess.com
Content-Type: Application/XML
Content-Length: 788
<?XML version = “1.0” encoding = “UTF-8”?>
<snooze_cc_account_request>
<timestamp>2016-01-01 12:30:00</timestamp>
    <user_params>
        <user_ID>123456789</user_ID>
        <user_password>********</user_password>
        <user_SSN>***-**-****</user_SSN>
        <wallet_ID>A2C4E6G8I</wallet_ID>
        <current_snooze_cc_acounts>209209480280</
        current_snooze_cc_acounts>
    </user_params>
    <checkout_params>
        <checkout_total>100</checkout_total>
    </checkout_params>
    <offer_params>
        <offer_ID>452813721452719418</offer_ID>
        <offer_balance>75<offer_default_balance>
        <offer_deadline>8, days<offer_default_deadline>
        <offer_num_payments>8<offer_default_num_payments>
        <offer_installments>10<offer_installments>
        <offer_min_installment>5<offer_min_installment>
        <offer_fee>3</offer_fee>
        <offer_issuer_ID>928139827498247<offer_issuer_ID>
    </offer_params>
<snooze_cc_account_request>
```

In some implementations, the issuer server may authorize 2116 the creation of a new “Snooze” Credit Card account for the user based on a plurality of criteria (e.g. based on the user's current credit history, based on how many balances or the amount of total funds owed in the user's balances, and/or the like). If the issuer approves the creation of the account, it may create a new virtual PAN number for the account, and may send this information to the Bill Pay server via a “Snooze” Credit Card Account Response 2118.

In some implementations, Bill Pay may create a “Snooze” Credit Card Account data structure 2122 for the user based on the offer conditions provided. The Bill Pay server may store the created data structure in the Bill Pay database 2155 after sending an insert query 2124 to the “Snooze” Credit Card Account table 2156 of the database. In some implementations, an exemplary PHP-encoded “Snooze” Credit Card Account query 2124 may take a form similar to the following:

<?php

...
$PAN = $_POST[‘PAN’];

...

$result = mysql_query(“INSERT INTO SCCA(PAN, user_ID,

issuer_ID, balance, deadline, num_payments, num_installments,
min_installment, fee) VALUES

(mysql_real_escape_string($SCCA.PAN),
mysql_real_escape_string($SCCA.user_ID),
mysql_real_escape_string($SCCA.issuer_ID),
mysql_real_escape_string($SCCA.balance),
mysql_real_escape_string($SCCA.deadline),
mysql_real_escape_string($SCCA.num_payments),
mysql_real_escape_string($SCCA.num_installments),
mysql_real_escape_string($SCCA.min_installment),
mysql_real_escape_string($SCCA.fee),
mysql_real_escape_string($SCCA.exp_date)) );

>

In some implementations, the database may send a “Snooze” Credit Card Account result 2126 to the Bill Pay server indicating that the data structure has successfully been stored in the database. Bill Pay may then update 2128 various parameters of the data structure, such as adding the “snooze” balance to the account balance, updating the payment schedule, fees, and/or the like determined from the offer, and/or the like. The Bill Pay server may send via Bill “Snooze” response 2132 a confirmation to the user indicating that the account was created successfully. Once the user has received confirmation that the account has been created and receives his account information, the user may complete the purchase using his new “Snooze” Credit Card Account 2134.

Over time, the user may pay off the balance on the “Snooze” Credit Card Account, either by setting automatic payments 2142 that request pre-scheduled payments towards the balance, or by providing input to his wallet-enabled device 2136 of how much we would like to pay. In some implementations, payment may be incremental, or the user may pay the entire balance off during any pay period. In some implementation the user's device may send a “Snooze” Payment message 2138 to the Bill Pay server with the manually-inputted payment information. In some implementations, the “Snooze” Payment message 2138 may be an XML-encoded message and may take a form similar to the following:

```
POST /payment_message.php HTTP/1.1
Host: www.BILLPAYproccess.com
Content-Type: Application/XML
Content-Length: 788
<?XML version = “1.0” encoding = “UTF-8”?>
<payment_message>
<timestamp>2016-01-01 12:30:00</timestamp>
    <merchant_params>
        <merchant_ID>82719487194</merchant_ID>
        <merchant_location>40.1, −70.2</merchant_location>
        <merchant_name>Best Buy</merchant_name>
    </merchant_params>
    <user_params>
        <user_ID>123456789</user_ID>
        <user_password>********</user_password>
        <wallet_ID>A2C4E6G8I</wallet_ID>
    </user_params>
    <payment_params>
        <user_payment_method>credit<user_payment_method>
        <user_payment_id>1234567809876543<user_payment_id>
        <user_payment_exp_date>2020-01-
        01<user_payment_exp_date>
        <user_CVV>123<user_CVV>
        <payment_amount>$10</payment_amount>
    </payment_params>
</payment_message>
```

In some implementations, the Bill Pay server may send payment information 2144 (e.g. the user's payment profile, and/or the like) to the merchant so the merchant may receive the payment made by the user. In some implementations Bill Pay may also provide a bonus to the merchant for providing the user with the “snooze” offer. In some implementations, once the entire balance for the “Snooze” Credit Card Account has been paid off by the user, Bill Pay may delete 2146, deactivate, and/or perform a like expiration procedure on the “Snooze” Credit Card Account. For example, Bill Pay may notify the issuer to deactivate the account's PAN number, while Bill Pay may deactivate and/or delete the account record on the Bill Pay database.

FIGS. 22A-B show logic flow diagrams illustrating further examples of examples of a user purchase checkout in some embodiments of the Bill Pay. In some implementations, a user may choose a product at a merchant to purchase 2202, and may use his wallet-enabled device to generate and send 2204 a checkout request to the merchant. The merchant may receive 2206 the checkout request, and may retrieve 2208 recent Bill “Snooze” Offers which may match the user, the user's purchased items, the user's purchase amount, and/or the like. The merchant may send an offer 2210 back to the user, who, once he has received 2212 the offer in their wallet application, may choose a plurality of parameters to alter 2214 in order to construct a new offer (e.g., the user may choose to wish to pay a lower fee, to change his payment schedule, and/or the like). In some implementations, the parameters the user can alter may be determined by Bill Pay or an external issuer. In some implementations, Bill Pay or the issuer may provide default values for the parameters based on the most commonly chosen-parameters for the user's particular circumstances (e.g., the parameters most people choose with the same “snoozed” balance, and/or the like). In some implementations, an estimated time of payment score (e.g ETA score) may be calculated for the user based on how long it may take for the user to pay off all of his “snoozed” bills. For example, Bill Pay may calculate ETA scores based on adding all estimated repayment deadlines for all of the user's “snoozed” bills and subtracting any overlap between the payment schedule. Alternatively, in some embodiments, a user's total monthly payment due for all of the user's payment methods may be used in the ETA score calculation. A “snoozed” payment can, therefore, raise the ETA score. For example, if a user has a typically $200/month average total monthly payment, and an $80 “snooze” total, the ETA score for the user may very low (i.e., it may not take very long for the user to repay the “snooze” total). However, if the user is thinking about “snoozing” a $5000 bill, his ETA score may move from low to medium, as the new bill may significantly raise the amount of time required for the user to be able to pay back his total “snooze” account balances. In some implementations, ETA scores may be low, medium, or high, with low meaning the estimated time for complete repayment is low, and a high score indicating it may take a very long time for complete repayment. In some implementations, this ETA score may also be used to choose the preferred default values for the provided paramenters. In some implementations, the merchant may calculate personalized default values based on issuer guidelines (e.g., the merchant must require a minimum payment of 10% of the bill when the user has a poor ETA score, and/or the like). The user's wallet-enabled device may send 2216 a “Snooze” Offer parameter message. The Bill Pay server may use the received 2218 message in order to calculate 2220 a revised offer for the user (e.g., may calculate a new fee per pay schedule based on a user-provided repayment period, may calculate a new repayment period based on how much the user wishes to pay back in total or wishes to pay back per pay period, may calculate new values based on whether or not the altered parameters change the nature of the user's ETA score, and/or the like), and to send the revised offer 2222 back to the user for approval. When the user receives the updated offer 2224, the user may choose whether or not the offer is acceptable 2226 or not. If the user does not like the updated offer, the user may be prompted to edit his parameters again. If the user likes the updated offer, he may accept the offer, which may prompt his wallet-enabled device to send a Bill “Snooze” Request to the server 2228. Bill Pay may receive 2230 the request, and may either automatically create a new “Snooze” Credit Card Account 2248, or may forward 2232 the request to an issuer server, if Bill Pay determines a new account needs to be made 2272 (e.g., in some implementations, Bill Pay may reuse or add to existing accounts, based on common merchants, dates, user-specified preferences to reuse, combine, or add to existing accounts, and/or the like). After the issuer server receives the request 2234, the issuer may determine whether or not the user meets issuer-specific criteria 2236 for creating a new account (e.g., the user is in good financial standing, the user does not already have more than a pre-determined amount of accounts active, the user does not already have more than a pre-determined balance total, the user's “snooze” bill ETA is green or yellow, and/or the like). In some implementations, if the user meets the critera for the account, the issuer may authorize the creation of a new “Snooze” Credit Card Account 2238, and may generate a new virtual PAN for the new account. If the user does not meet the criteria, the issuer may deny 2240 the user an account. The issuer may then generate and send a “Snooze” Credit Card Account Response 2242 to the Bill Pay server.

Once the Bill Pay server has received 2244 the response, the server may determine whether or not the issuer authorised 2246 the account. If the issuer did not, then the process may end. In some implementations, the server may also send a notification to the user indicating that they were rejected for the new account and offer. If the issuer authorized the new account, the server may create a “Snooze” Credit Card Account data structure 2248 based on the information provided by the issuer (e.g. PAN data, and/or the like). The server may then store 2250 the account data structure in the Bill Pay database, and may update 2252 the account balance to reflect the amount chosen by the user to “snooze,” along with other information received in previous Bill “Snooze” Request 2230. In some implementations the server may then send a Bill “Snooze” response to the user, which may contain the account information, and/or the like. In some implementations, after the user has received 2256 the response, the user may complete his checkout process 2258 using his new “Snooze” Credit Card Account.

In some implementations, the user may use multiple methods to pay back the balance on his new account. The user may set his account to automatically request 2266 a pre-determined amount from the user's payment accounts in order to automatically pay the balance on the “Snooze” Credit Card Account on a pre-specified date and/or timeline. Alternatively, the user may also manually choose to pay off a balance on his account 2260, and may have his device send 2262 this payment information to the Bill Pay server, which may process the payment message once received 2264. In some implementations, the user may pay back the account balance incrementally or all at once. In some implementations, if the user has paid the entire balance off 2268, then the Bill Pay server may delete 2270, deactivate, or otherwise alter the status of the user's “Snooze” Credit Card Account to designate it as expired.

FIGS. 23-24 show screenshot diagrams illustrating example checkout settings in some embodiments of the Bill Pay. In some implementations, the user may be given a checkout window with the total purchase cost and an option to “snooze” his bill, e.g. 2302. The user may also be given an estimated time (e.g. ETA) of how long it may take to pay off all his bills should he “snooze” this bill. In some implementations, Bill Pay may invoke a color system, wherein red may mean the user could be adding too much debt by “snoozing” his bill (e.g., it may take over two years to pay off all “snoozed” bills), yellow may mean the user would have a manageable amount of “snoozed” payments to make (e.g., it may take one to two years to pay off all his “snoozed” bills), and green may mean the user is very capable of “snoozing” the current bill (e.g., it would take less than a year to pay off all his “snoozed” bills).

Bill Pay may allow the user to select a payment device to use for a purchase, e.g., 2304, and may provide options for the user during the time of purchase, such as offers and deals for “snoozing” a bill, for purchasing the item and paying the full amount at checkout, and/or the like (e.g., 2306). In some implementations, the user may be able to alter the conditions of the “snooze” offer (e.g., 2308) via an interface on a checkout screen that may allow for the user to change a plurality of parameters, such as the amount of the bill to “snooze,” may change the number of days the user has to “snooze” the full payment of the bill, and/or the like.

In some implementations, selecting an offer to “snooze” a bill may provide the user with a more detailed interface for altering “snooze” options and altering the conditions of the deal. For example, the user may be able to view his available funds (e.g. 2310) on all payment devices or financial accounts connected with the user's wallet, in addition to the checkout total. The user may be able to alter the conditions of the offer via selecting new parameters, e.g. 2312, for the amount of the bill to “snooze,” the number of days to “snooze” the bill, and/or the like. In some implementations, Bill Pay will automatically recalculate other conditions for the offer when the user changes a condition to the offer. For example, if a user chooses to “snooze” $50 of his current bill, Bill Pay may calculate, based on its or an issuer's offer criteria, determine that the user may “snooze” the bill for 5 days. Alternatively, if the user chooses to “snooze” his bill for days, Bill Pay may determine that the user may “snooze” up to $50 of his current bill. Alternatively, if the user chooses to pay $50 of his $100 bill at the time of checkout, Bill Pay may automatically calculate a payment schedule for the rest of the bill based on the remaining amount and its or an issuer's “snooze” offer criteria. The user may also be able to view any fees or extra costs associated with creating the “Snooze” Credit Card Account (e.g. 2314), which may also automatically be recalculated based on the user's altering of offer conditions (e.g. by altering the payment period, installments, and/or the like), and may then choose to “snooze” his bill once he is satisfied with the offer conditions.

In some implementations, the user may be able to further customize his offer conditions via a plurality of other editable options (e.g. 2316). For example, the user, in addition to controlling the amount to “snooze” or the time frame in which to pay the bill, the user may also be able to control how many payments the user may wish to pay in total, how much the user wishes to have to pay per payment interval, and/or the like. The user may also be able to view how changing an option may change the conditions of the offer, and may be able to accept the offer once the user is satisfied with the option conditions.

In some implementations, e.g. in FIG. 24, the user may be able to further control the settings of the “Snooze” Credit Card Account once it has been created. The user may be able to select a default payment method (e.g., 2402) for paying off the balance in his “Snooze” Credit Card Account, and may also wish to select alternative methods of payment from which to procure funds should the default payment method not contain sufficient funds for a payment. Other settings 2404 may include choosing which day of the month to pay the bill, the minimum amount the user wishes to pay each pay period (e.g. the issuer-specified minimum payment, the entire current balance for the account, and/or the like), to further “snooze” a bill until the user has a specified amount of funds in his payment accounts, to further “snooze” a bill after a specified amount has been paid, and/or the like. In some implementations, options may also exist for ranking payments for different “Snooze” Credit Card Accounts (e.g., to give payment priority to larger balances, smaller balances, balances due earlier, balances with larger minimum payments, and/or the like.

In some implementations, the user may also be able to set automatic bill payment settings (e.g. 2406). In some implementations, the user may wish to determine whether or not he should allocate all available funds towards the payment of his pending balances. The user may also be able to view each bill from each “Snooze” Credit Card Account, and may be able to alter settings for each individually on the same page. For example, the user may be able to set whether each bill should have the minimum payment applied to it at the next payment deadline, or whether the entire amount should be paid off, and/or the like. In some implementations, the user may also be able to alter the exact payment amount (e.g. 2408), and may be able to view the outstanding balance for each bill. The user may also see any fees that the user has accrued for “snoozing” his bill, as well as the estimated time until the user has completely paid off all “snooze” account bills (e.g. 2410).

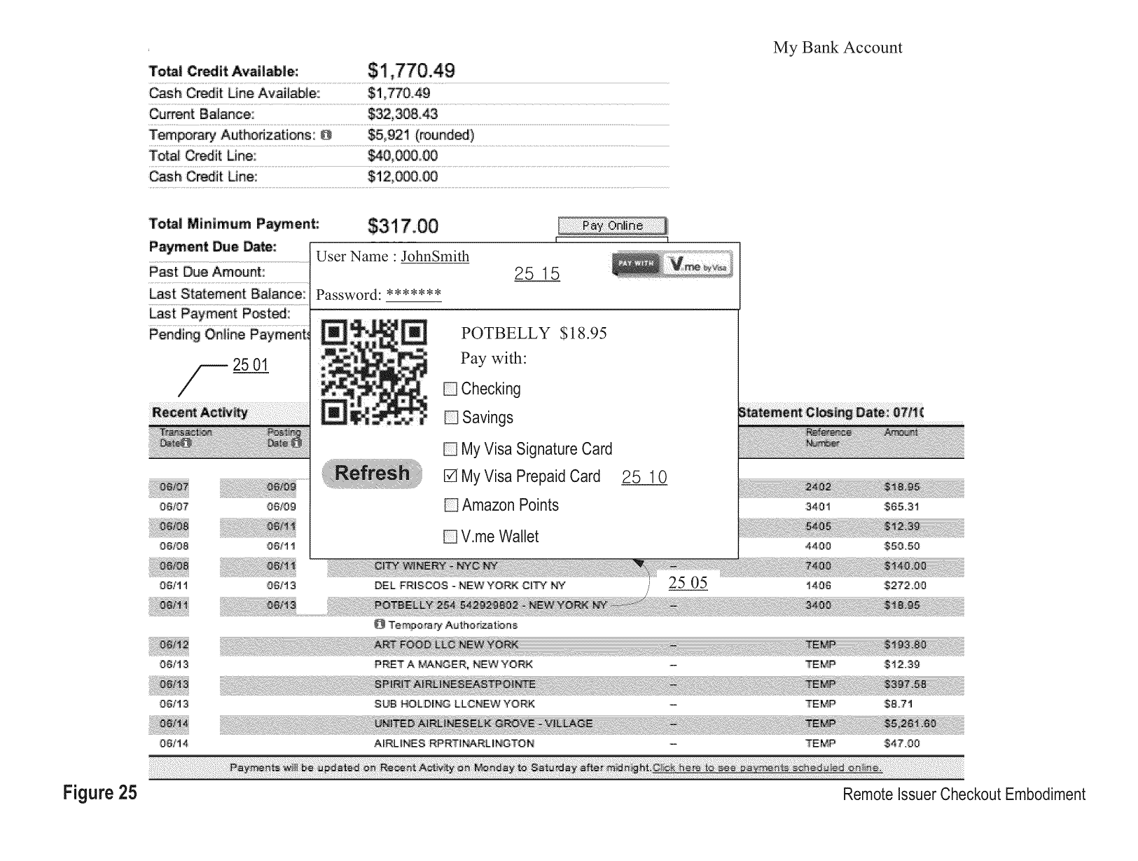

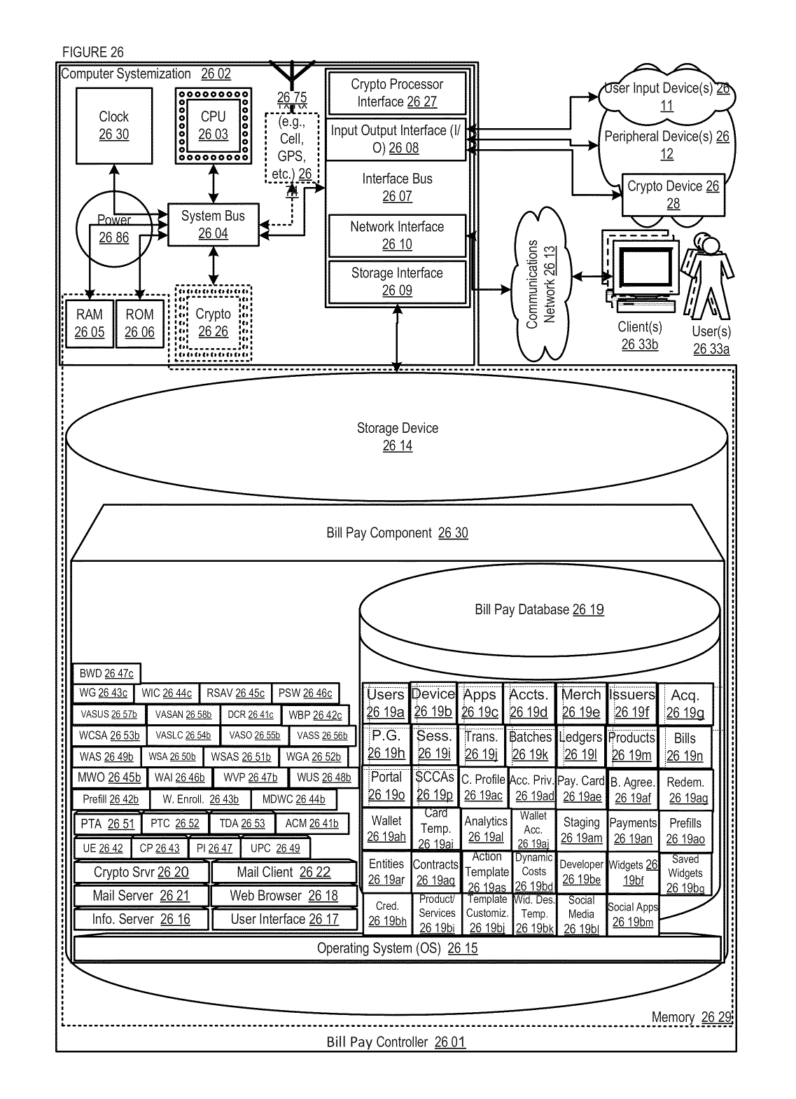

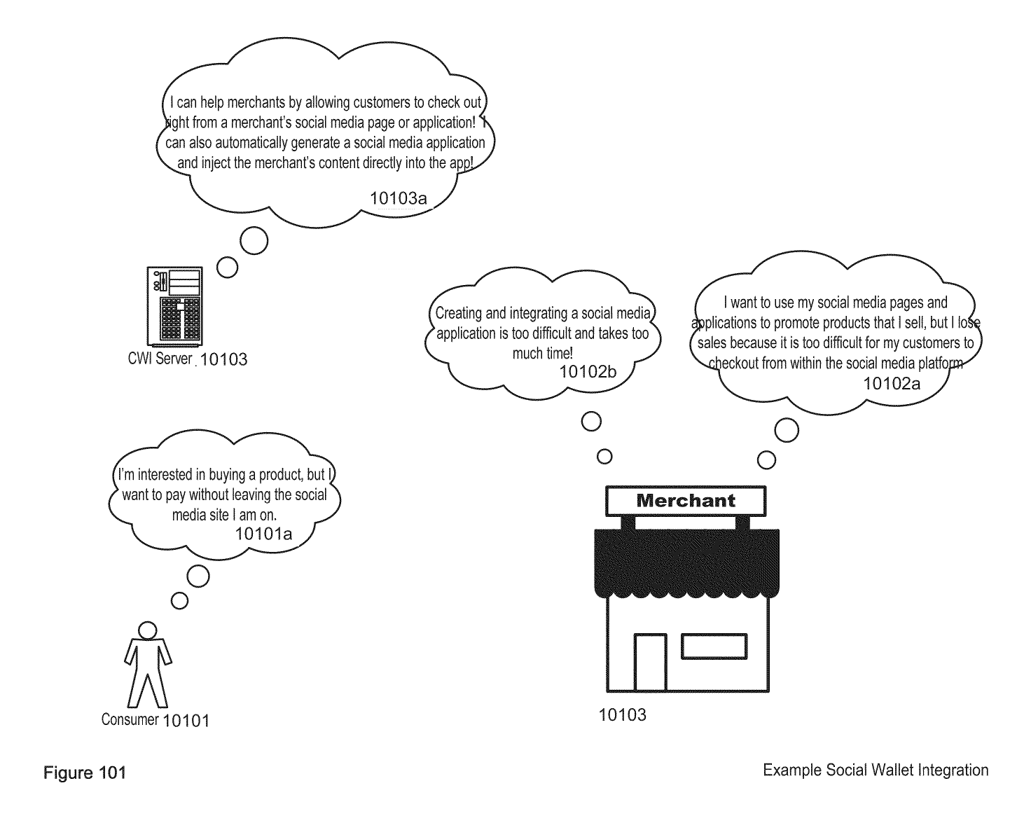

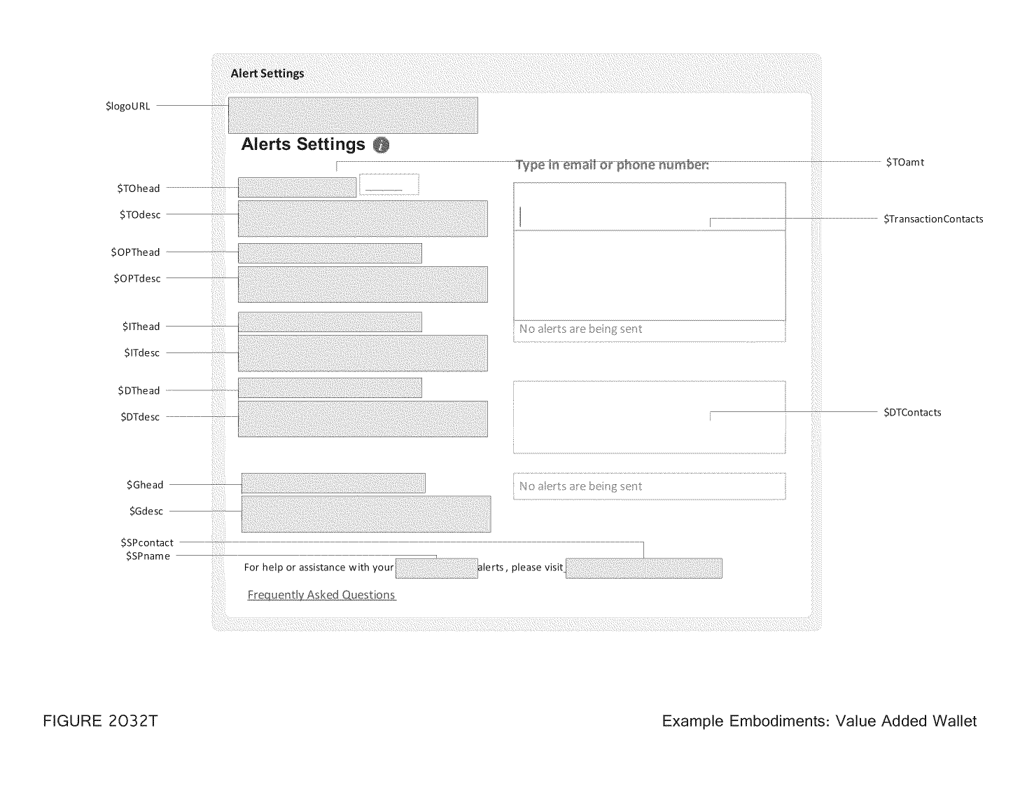

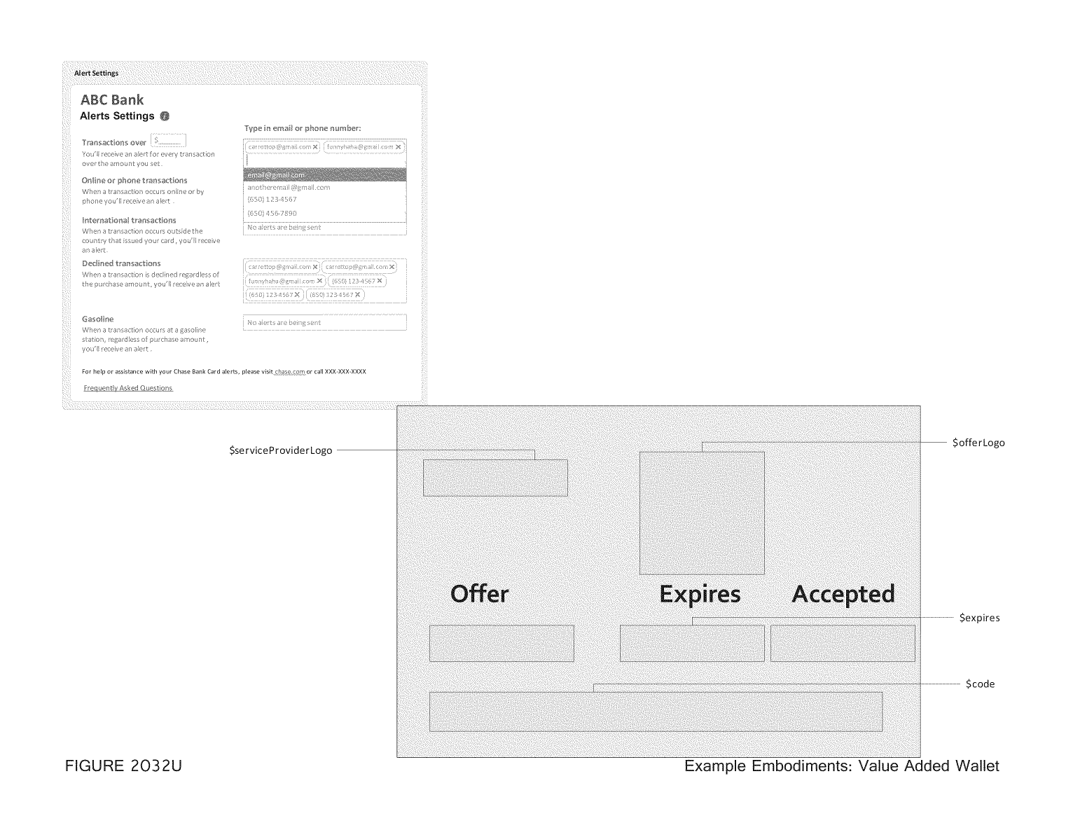

FIG. 25 shows a block diagram illustrating example remote checkout from issuer in some embodiments of the Bill-Pay In some embodiments, a consumer may pay a bill from the issuer's website. For example, a list of recent activities 2501 may be displayed in the consumer's bank account. The consumer may pay all the bills from the bank's account. Alternatively, the consumer may choose to pay part of the bill from a different account, a credit card a prepaid card, a loyalty program points, a digital wallet, and/or the like. For example, the consumer may choose the POTBELLY transaction 2505, and a widget may display for the consumer to enter the consumer's log in information 2515. The widget generation embodiment is discussed in FIGS. 101-1022B. In some embodiments, the consumer may check the “pay with my visa prepaid card” box 2510 to pay this bill with this payment card. And the Bill-Pay may facilitate the funds distribution between the merchant, the issuer, and the consumer.

Various aspects of the Bill Pay facilitates a multi-channel and multi-party merchandising and checkout from content publishing platforms. Examples of publishing platforms include online publishing systems, web and mobile publishing platforms, and/or the like that can support one or more data sources and user interfaces. In one embodiment, the Bill Pay provides content publishers an avenue for monetizing content by offering merchandising and commerce marketplaces to their audiences. In another embodiment, the Bill Pay supports content publishing platforms by providing a checkout solution that enables management of multiple content publishers and participating merchants. In a further embodiment, the Bill Pay supports merchants by providing them a new distribution channel for their storefronts closer to potential customers within the applications or websites where those audiences spend their time online. The Bill Pay may further support merchants by driving customers to their own websites or mobile applications by enabling merchants to embed or inject their storefront within destination applications or sites that their potential customers already use. In yet another embodiment, the Bill Pay may provide digital wallet providers new channels for acquiring consumer enrollments, reselling, merchant acceptance and driving new sources of volume.

In some embodiments, aspects of the Bill Pay provides merchants with a consolidated payment processing integration for all of their transactions and facilitate third parties such as acquirers, processors, payment service vendors, and/or the like to integrate to the transaction processing application programming interface (API) such as V.me transaction processing API to provide reporting and analytics, including federated and/or integrated access to a merchant control panel (e.g., V.me merchant control panel). For example, depending on business and/or technology model, merchants and/or their provider of shopping cart/hosted order page solutions may integrate to a payment widget or checkout widget (e.g., V.me payment widget) using one or more integration methods. In some implementations, follow-on transactions, which may include authorization, capture, reversal, refund, and/or the like, may be sent through the merchant's existing payment processing connection, thereby eliminating the need to support two separate payment APIs and ensure a consolidated view of their transactions.

In some embodiments, aspects of the Bill Pay provides merchants facilities to distribute checkout facilities anywhere and everywhere on the web beyond their primary website, thereby facilitating “instant checkout.” For example, merchants, using the facilities of the Bill Pay, can add instant checkout to their FACEBOOK landing page, advertising banners, search results, web and mobile applications, and/or the like. The instant checkout, in some implementations, allows merchants to widgetize and distribute all or part of their e-commerce website to reach potential customers. Furthermore, the instant checkout may facilitate merchants to transform all of their digital and marketing channels into sales channels by providing low friction or instant on-the-spot checkout.

In some embodiments, aspects of the Bill Pay facilitates publishers, content site owners, destination site owners, mobile/web application developers, and/or the like to better monetize their traffic and increase their value proposition to their publishers and sponsors. In one implementation, the facilities of the Bill Pay allow acquisition of distribution and developer partners and merchant by establishing a new channel where the merchants may run a program (e.g., V.me program) within an online, mobile or social campaign without disrupting their primary ecommerce website.

In various embodiments, the Bill Pay may be platform agnostic and may fit in well with mobile, tablet and various other device commerce.

FIG. 101 shows a block diagram illustrating an example social wallet integration, in some embodiments of the Bill Pay. In one embodiment, a consumer 10101 may be interested in buying a product without leaving a social media site that they are currently on, e.g., 10101a. In one embodiment, a merchant 10102 may desire to use their social media pages and applications to promote products that they sell but find that customers are lost because of the difficulty in facilitating checkout from a social media platform, e.g., 10102a. In still other embodiments, a Bill Pay server 10103 may provide a capability to merchants, consumers and/or the like that allows consumers to checkout directly from a social media page or application. In one embodiment, the Bill Pay may enable a merchant to create a social media application and inject merchant selected content into the application, e.g., 10103a.

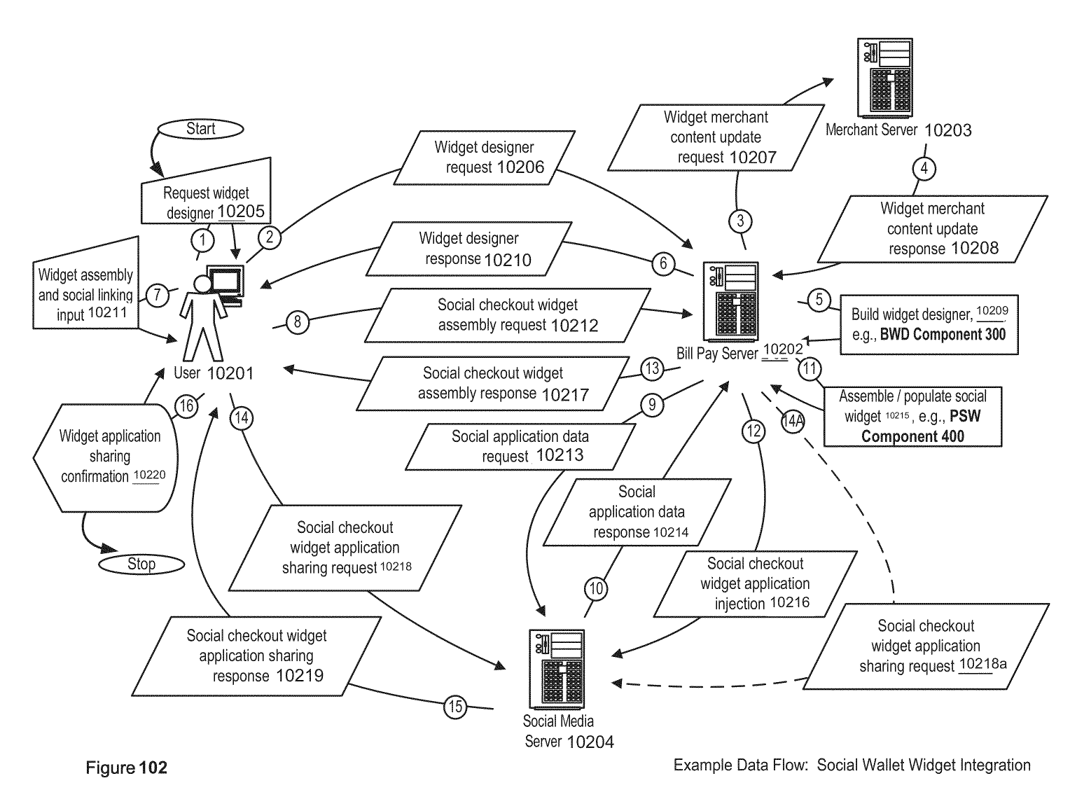

FIG. 102 shows a data flow illustrating an example social wallet widget integration, in some embodiments of the Bill Pay. In one embodiment, user 10201 may use a client to request a widget designer interface, e.g., 10205, configured with capabilities to allow the user to customize a widget, generate a social media application, inject an existing social media application with content, provide widget checkout capabilities from within a social media site or within a social media application, share the user's injected content or social media application on the user's social media feed for viewing by other users who “follow” the user, and/or the like. In one embodiment, the client may generate a widget designer request 10206. A widget designer request may be a request to render an interface that allows social media and/or widget customization. An example widget designer request 10206, substantially in the form of an HTTP(S) POST message including XML-formatted data, is provided below:

```
POST /widget_designer_request.php HTTP/1.1
Host: www. Bill Pay server.com
Content-Type: Application/XML
Content-Length: 667
<?XML version = “1.0” encoding = “UTF-8”?>
<widget_designer_request>
  <timestamp>2020-12-12 15:22:43</timestamp>
  <auth>
    <user_id>7654353</user_id>
    <password>secretpass</password>
    <device_id type=”Mac”>E76565</device_id>
    <user_info>
      <name>John Consumer</name>
      <email>john.consumer@foo.com</email>
      <phone>645-123-4567</phone>
    </user_info>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <designer val=”do_render />
  <merchant_to_query method=”web_site_scrape”>
    <merchant_id val=”5454” />
    <url val=”http://www.merchant.com/” />
    <scrape_template id=”87564” />
    <item_div val=”item” />
    <item_price_div val=”sell_price” />
  </merchant_to_query>
  <social_media_credentials>
    <social_media type=”facebook” post=”auto”>
      <user val=”myfbusername” />
      <pass val=”myfbpass” />
  </social_media>
  <social_media type=”twitter”>
      <user val=”mytwitterusername” />
      <pass val=”mytwitterpass” />
    </social_media>
    <social_media>
      ...
    </social_media>
  </social_media_credentials>
</widget_designer_request>
```

In one embodiment, the Bill Pay server 10202 may require updated content from the merchant before rendering a widget designer response. For example, the Bill Pay may have pricing or item information that is stale and requires refreshing. In one embodiment, the Bill Pay server may call a merchant provided Application Programming Interface (e.g., a RESTful service, via SOAP, and/or the like) in order to update item information, pricing information, current inventory information, item descriptions, item prices, and/or the like, e.g., 10207. In one embodiment, the merchant server 10203 may retrieve current pricing information in response to the update request, such as by querying an item and/or pricing database or invoking a pricing procedure stored in memory, and provide the updated information to the Bill Pay server, e.g., a widget merchant content update response 10208. An example widget merchant content update response 10208, substantially in the form of an HTTP(S) POST message including XML-formatted data, is provided below:

```
POST /widget_merchant_content_update_response.php HTTP/1.1
Host: www. Bill Pay server.com
Content-Type: Application/XML
Content-Length: 667
<?XML version = ″1.0″ encoding = ″UTF-8″?>
<widget_merchant_content_update_response>
<timestamp>2020-12-12 15:24:43</timestamp>
  <auth>
    <user_id>7654353</user_id>
    <password>secretpass</password>
    <device_id type=”Mac”>E76565</device_id>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <store value=”online”>
    <item sku=”8768675” type=”physical”>
      <inventory quantity=”53” packing=”1” />
      <current_price value=”9.54” />
      <description>An item description</description>
      <shipping_lag_time value=”2-days” />
      <backordered value=”false” />
    </item>
    <item>
      ...
    </item>
  </store>
  <store value=”physical_store”>
    ...
  </store>
</widget_merchant_content_update_response>
```

In another embodiment, the Bill Pay server may semi-autonomously obtain the merchant pricing information without a dedicated merchant item/pricing API interface. In so doing, the Bill Pay may for example query a publically available merchant web page (e.g., merchant ecommerce pages) and extract information such as items available, item inventory levels, pricing, description, user reviews, and/or the like. For example, the Bill Pay server may employ a web scraping capability, such as by using Webharvest, Scrappy, and/or the like. Example Scrappy program code suitable for retrieving information from a merchant's web site, substantially in the form of Python executable commands is:

```
#!/usr/bin/env python
from scrapy.spider import BaseSpider
from scrapy.http import Request
from scrapy.http import FormRequest
from scrapy.selector import HtmlXPathSelector
from scrapy import log
class MerchantSpider(Spider):
    name = “merch_spider”
    allowed_domains = [“www.merchant.com”]
    start_urls = [
    “http://www.merchant.com/store/start”
]
def parse(self, response):
    pass
```

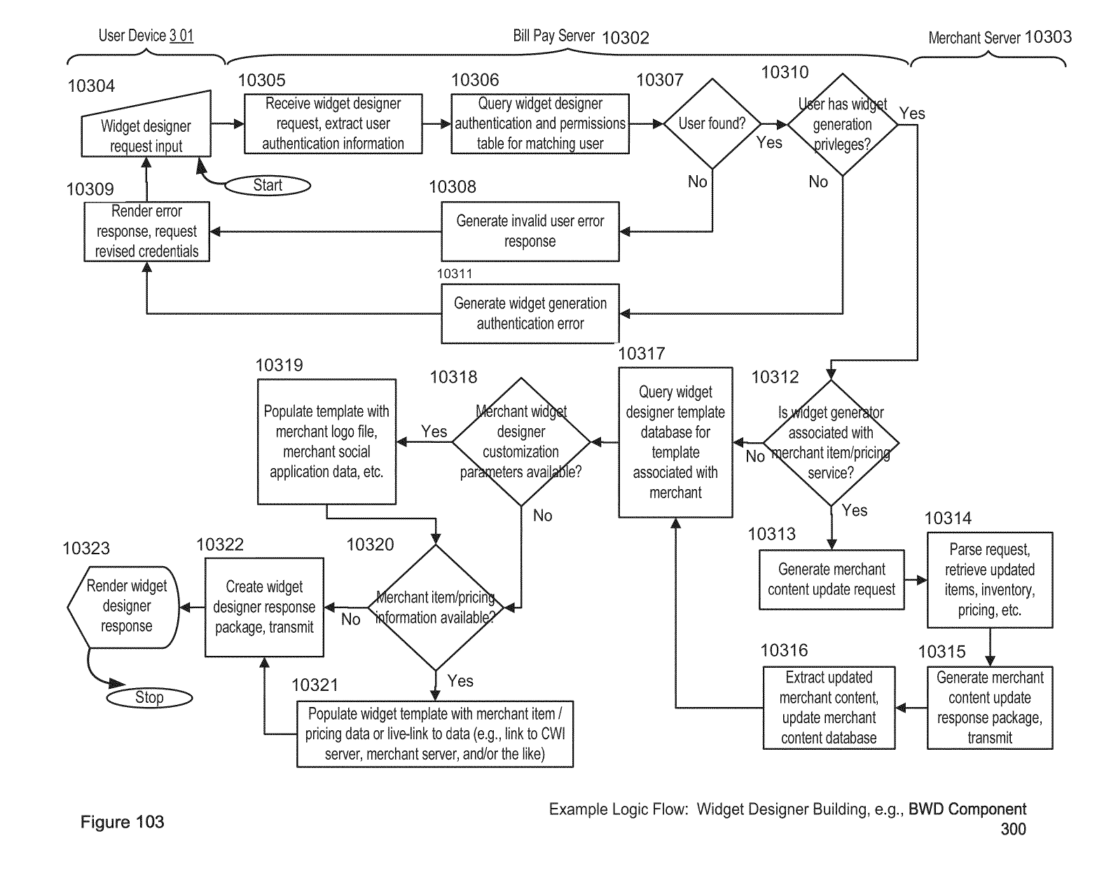

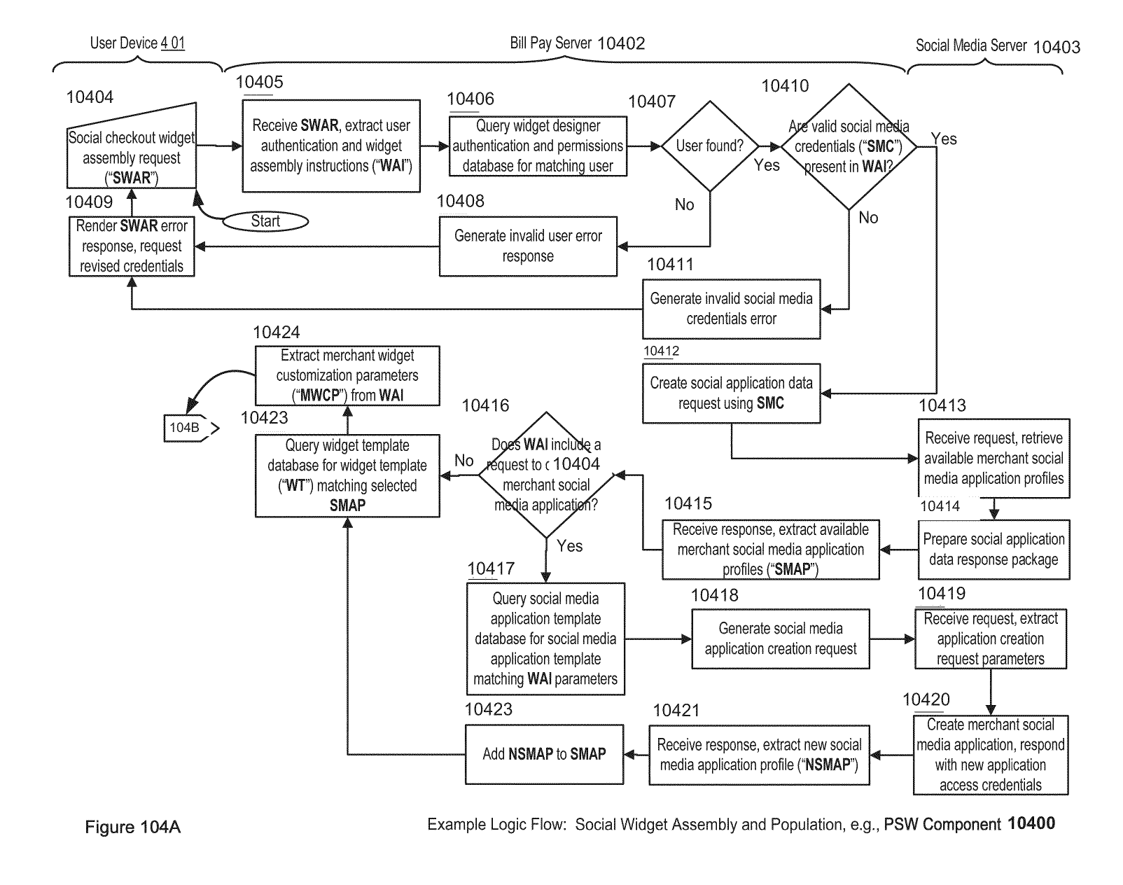

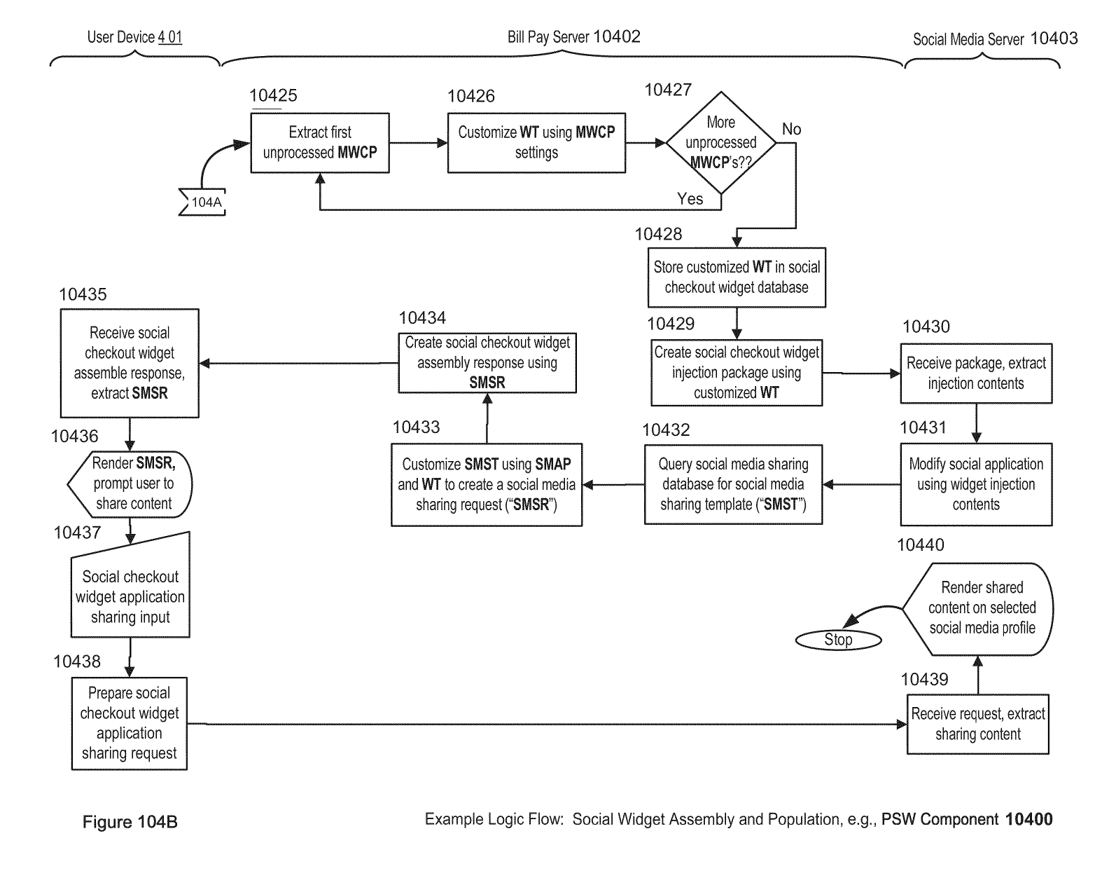

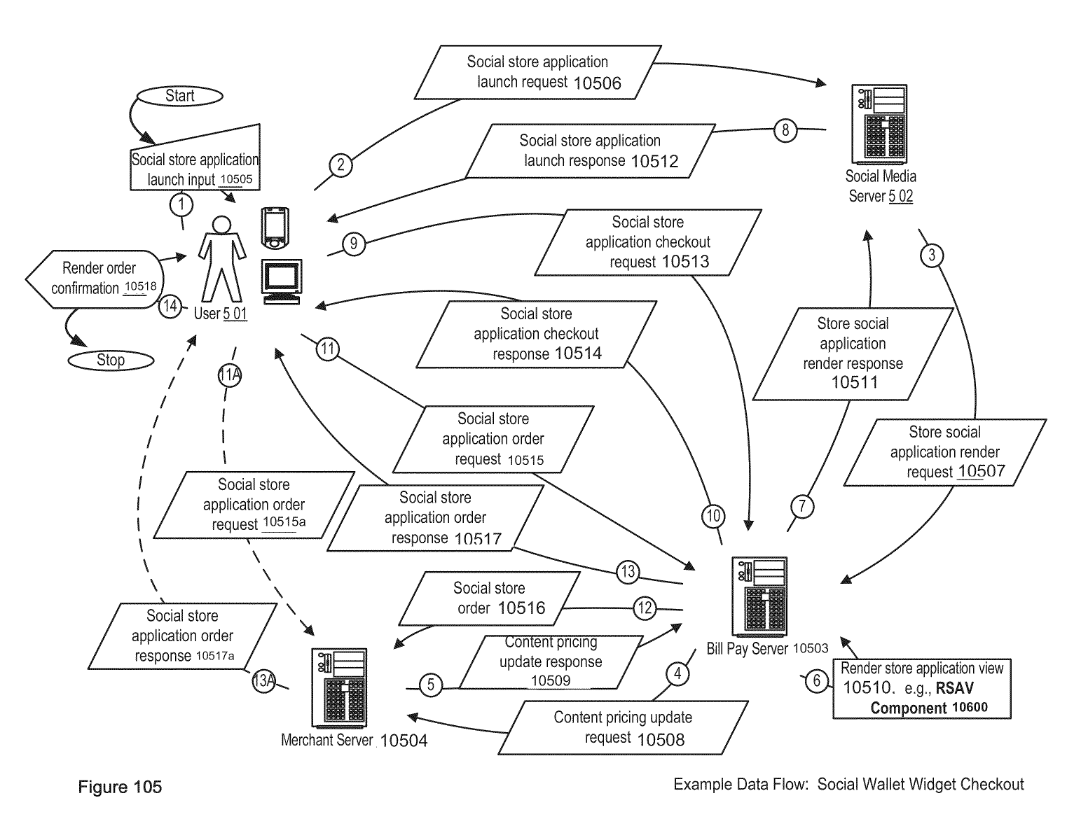

In one embodiment, the Bill Pay server may build and/or render the widget designer. For example, the Bill Pay may utilize a widget template and substitute values such as merchant item values retrieved above into the template. Further detail with regard to building the widget designer may be found with respect to FIG. 103, e.g., a BWD Component 10300.

Upon building or rendering the widget designer, the Bill Pay server may return the designer to the user device so that the user may interact with the designer and customize widgets and/or applications, e.g., a widget designer response 10210. A widget designer response may contain renderable commands substantially in the form of HTML statements, client-executable commands (such as, for example, PHP interpreter commands), or compiled code suitable for execution on a client device (such as Java bytecode capable of rendering a widget designer).

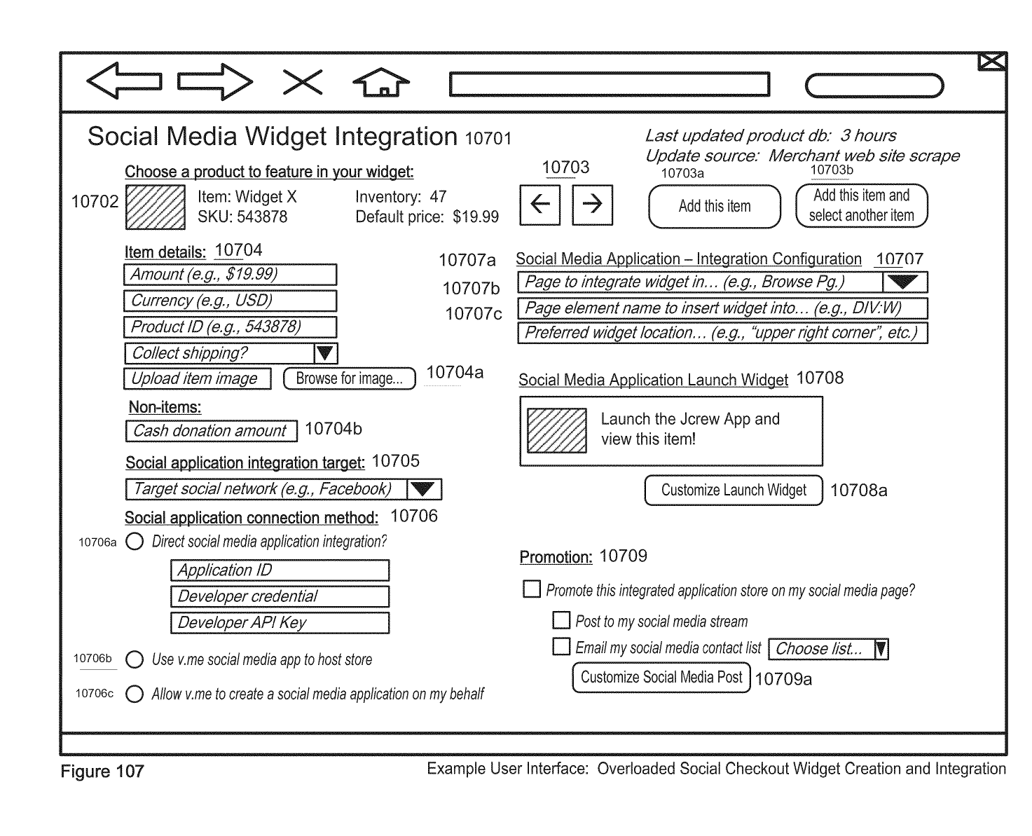

In response to the widget designer response, the user's client device may render a widget designer interface, such as that described with respect to FIG. 107. The user may thereafter use the interface in order to customize a widget assembly request and/or a social media linking request, e.g., a widget assembly and social linking input 10211. In response to the user's input, the client device may transmit a message to the Bill Pay server requesting that the Bill Pay create a checkout widget, integrate a checkout widget into a user social application, create a new social application on behalf of the user, share information on the user's social media feed, and/or the like, e.g., a social checkout widget assembly request 10212. An example social checkout widget assembly request 10212, substantially in the form of an HTTP(S) POST message including XML-formatted data, is provided below:

```
POST /social_checkout_widget_assembly_request.php HTTP/1.1
Host: www. Bill Pay server.com
Content-Type: Application/XML
Content-Length: 667
<?XML version = ″1.0″ encoding = ″UTF-8″?>
<social_checkout_widget_assembly_request>
  <timestamp>2020-12-12 15:26:43</timestamp>
  <auth>
    <user_id>7654353</user_id>
    <password>secretpass</password>
    <device_id type=”Mac”>E76565</device_id>
    <user_info>
      <name>John Consumer</name>
      <email>john.consumer@foo.com</email>
      <phone>645-123-4567</phone>
    </user_info>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <widget>
    <widget_type val=”inline_html” />
    <widget_target val=”social_media_application_integration” />
    <widget_template id=”8767” />
    <widget_integration val=”facebook_application”>
      <social_page_to_integrate_widget
            value=”item_display_page”
            populate_template=”default_display”
            template_params=”item_id:E87753”>
```

| | |
|---|---|
| <insert_widget | page_location_type=”div” |
| | Page_location=”widget_insert_div” /> |

```
      <social_application_access_credentials>
        <social_user_id val=”667998867” />
        <master_account user=”my@email.com” pass=”secretpass2”>
        <social_application method=”key”>
          <key>
            TRDTRSERDEFTRED
            CFGRTD6565434YFGT
            KBYTJE3r434WRRDTF
          </key>
        </social_application>
      </social_application_access_credentials>
    </widget_integration>
    <widget_integration>
      ...
    </widget_integration>
    <items_to_feature>
      <item>
        <merchant id=”5454” />
        <item id=”E87753” />
        <selling_price val=”19.99” />
        <feature_on_widget type=”photo”>
          <item_photo id=”55” crop=”25,65” />
        </feature_on_widget>
    </item>
    <item>
      ...
    </item>
    </items_to_feature>
  </widget>
  <widget>
    ...
  </widget>
</social_checkout_widget_assembly_request>
```

In another embodiment, an example social checkout widget assembly request 10212, substantially in the form of an HTTP(S) POST message including XML-formatted data, is provided below:

```
POST /social_checkout_widget_assembly_request.php HTTP/1.1
Host: www. Bill Pay server.com
Content-Type: Application/XML
Content-Length: 667
<?XML version = ″1.0″ encoding = ″UTF-8″?>
<social_checkout_widget_assembly_request>
  <timestamp>2020-12-12 15:26:43</timestamp>
  <auth>
    <user_id>7654353</user_id>
    <password>secretpass</password>
      <device_id type=”Mac”>E76565</device_id>
    <user_info>
      <name>John Consumer</name>
      <email>john.consumer@foo.com</email>
      <phone>645-123-4567</phone>
    </user_info>
    <key>
      TRDTRBKJHujJHGE&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <widget>
    <widget_type val=”inline_html” />
    <widget_target val=”social_media_application_integration” />
    <widget_template id=”8767” />
    <widget_integration val=”twitter_application”>
      <create_application val=”true” />
      <sub_application_of val=”null” />
      <application_creation_template val=”twitter_app4” />
      <developer_api>
        <api_key>T7657568TRDRD</api_key>
        <app_creation_key>876434567</app_creation_key>
      </developer_api>
    </widget_integration>
    <widget_integration>
      ...
    </widget_integration>
    <items_to_feature>
      <item>
        <merchant id=”5454” />
        <item id=”E87753” />
        <selling_price val=”19.99” />
        <feature_on_widget type=”photo”>
          <item_photo id=”55” crop=”25,65” />
        </feature_on_widget>
      </items_to_feature>
    </item>
    <item>
      ...
    </item>
  </widget>
  <widget>
    ...
  </widget>
</social_checkout_widget_assembly_request>
```

In one embodiment, if the Bill Pay server determines that the social checkout widget request contains a request to create or inject content into a user's social media application, the Bill Pay may execute a request to a social media server 10204 in order to obtain information about the user's current social media applications, e.g., a social application data request 10213. In other embodiments, the Bill Pay may host a user's social media application locally in which case a local social media application database may be queried. An example social application data request 10213, substantially in the form of an HTTP(S) POST message including XML-formatted data, is provided below:

```
POST /social_application_data_request.php HTTP/1.1
Host: www.socialmediaserver.com
Content-Type: Application/XML
Content-Length: 667
<?XML version = ″1.0″ encoding = ″UTF-8″?>
<social_application_data_request>
  <timestamp>2020-12-12 15:28:43</timestamp>
  <auth type=”server_to_server”>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <request type=”third_party” />
  <return type=”all_active_user_social_applications” />
  <social_application_access_credentials>
    <social_user_id val=”667998867” />
    <master_account user=”my@email.com” pass=”secretpass2”>
    <social_application method=”key”>
      <key>
        TRDTRSERDEFTRED
        CFGRTD6565434YFGT
        KBYTJE3r434WRRDTF
      </key>
    </social_application>
  </social_application_access_credentials>
</social_application_data_request>
```

In one embodiment, social media server 10204 may receive the social application data request and query a social application database for applications associated with the social application data request parameters. In other embodiments, the social media server may respond with a package containing a template for creating new social media applications on the platform. For example, the social media server 10204 may provide a WSDL file containing the available function calls available to the Bill Pay server (e.g., to be used via a web services call and/or the like) in order to create a social media application. In one embodiment, the Bill Pay server may provide a template itself that contains the application parameters is seeks to map (for example, a checkout container with integrated checkout, a product display page, and/or the like) and the social media server may respond with a mapping of the application parameters to function calls available from the social media server. In so doing, the Bill Pay server may interface with previously unknown social media servers while minimizing the amount of input required from a Bill Pay administrator. An example social application data response 10214, substantially in the form of an HTTP(S) POST message including XML-formatted data, is provided below:

```
POST /social_application_data_response.php HTTP/1.1
Host: www. BILL PAY server.com
Content-Type: Application/XML
Content-Length: 667
<?XML version = ″1.0″ encoding = ″UTF-8″?>
<social_application_data_response>
  <timestamp>2020-12-12 15:28:43</timestamp>
  <auth type=”server_to_server”>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <applications_registered_for>
    <social_user_id val=”667998867” />
  </applications_registered_for>
  <applications>
    <app id=”765765”>
      <date_created value=”2020-01-01” />
      <automatically_created val=”false” />
      <created_by val=”account_owner” />
      <app_profile>
        <app_capabilities_and_restrictions>
          <restriction type=”age_restriction” value=”13+” />
          <restriction type=”purchase_limits” value=”<$100USD” />
          <capability type=”revenue_split_on_purchases”>
            <split entity=”social_network” value=”5%” />
            <split entity=”pay_network” value=”5%” />
            <split entity=”merchant” value=”90%” />
          </capability>
        </app_capabilities_and_restrictions>
        <page id=”1”>
          <title val=”App Home Page” />
          <is_template_based val=”false” />
          <content>
              This is the home page of our merchant
              social media application!
          </content>
        </page>
        <page id=”2”>
          <title val=”App Home Page” />
          <is_template_based val=”true” />
          <template id=”65445” />
          <widget_insertion_capable value=”true” />
          <widget_insertion_point value=”widget_div” />
        </page>
        <page>
          ...
        </page>
      </app_profile>
    </app>
    <app>
      ...
    </app>
  </applications>
</social_application_data_response>
```

In one embodiment, the Bill Pay server may receive the social application data response and create a social application, inject a widget (e.g., a checkout widget, an item widget, and/or the like) into an existing social application, prepare a hosted social application (e.g., an application that is hosted on the Bill Pay or a third-party server), share a social application on a user's social media feed, and/or the like. Further detail with respect to the assembly and population of a socially enabled widget and/or social application may be found with respect to FIG. 104, e.g., a PSW Component 10400.

In one embodiment, the Bill Pay server may inject a social checkout capability into a social application, e.g., a social checkout widget application injection 10216. An example social checkout widget application injection 10216, substantially in the form of an HTTP(S) POST message including XML-formatted data, is provided below:

```
POST /social_checkout_widget_application_injection.php HTTP/1.1
Host: www.socialmediaserver.com
Content-Type: Application/XML
Content-Length: 667
<?XML version = ″1.0″ encoding = ″UTF-8″?>
<social_checkout_widget_application_injection>
  <timestamp>2020-12-12 15:26:43</timestamp>
  <auth type=”server_to_server”>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <application_injection>
    <application>
      <api_key>T7657568TRDRD</api_key>
      <app_creation_key>876434567</app_creation_key>
      <application_pages>
        <page id=”1”>
          <!-- application pages can be injected -->
          This is the application view content. The view
          may contain executable code.
        </page>
        <page id=”2”>
          <page_element
              preferred_location=”top_left_above_browser_fold”
              content_to_inject=”widget_injection:widget_div”>
            <div id=”widget_div” />
          </page_element>
          <page_element preferred_location=”default”>
            Page #2 content...
          </page_element>
        </page>
        <page id=”n”>
          ...
        </page>
      </application_pages>
      <widget_injection page=”2” location=”div:widget_div”>
        <!-- v:buy root container -->
        <div id=“v-root”></div>
        <!-- Initialize Widgets -->
        <v:init apikey=“L3KQEBHEJM4HOKCE2XO5”></v:init>
        <!-- Site content and v:buy buttons (see below) -->
```

| | |
|---|---|
| <script | type=“text/javascript” |
| | src=“https://sandbox-static. |
| | v.me//js/1/v-widgets.js”></script> |

```
        <v:buy
          apikey = ″L3AWQDLKBHYCE2XO5″
          token = ″4a752d0bb67f241a2a567″
          custom_widget_skin = ″FDSRE″
          amount = ″99.95″
          currency = ″USD″
          product-id = ″Testproduct1″
          merch-trans = ″MERCHORDER1234″
          collect-shipping = ″true″
          process = ″validate″>
        </v:buy>
      </widget_injection>
    </application>
</social_checkout_widget_application_injection>
```

In one embodiment, the Bill Pay may then confirm the creation of the social media application, transmit a checkout widget to the user, transmit an interface that allows the user to share details about their widget or application on their social media feed, and/or the like, e.g., a social checkout widget assembly response 10217. In one embodiment, the Bill Pay server will facilitate the rendering of an interface on the user's device that enables the user to seamlessly post the update to the social media feed. An example social checkout widget assembly response 10217, substantially in the form of an HTTP(S) POST message including XML-formatted data, is provided below:

```
POST /social_checkout_widget_assembly_response.php HTTP/1.1
Host: www.userdevice.com
Content-Type: Application/XML
Content-Length: 667
<?XML version = ″1.0″ encoding = ″UTF-8″?>
<social_checkout_widget_assembly_response>
  <timestamp>2020-12-12 15:26:43</timestamp>
  <auth type=”server_to_user_device”>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <response>
    <application_successfully_created val=”true” />
    <application_details>
      <application_id val=”8765764” />
      <application_title val=”Merchant Social App” />
      <application_access_credentials>
        <auth type=”cert”>
            YTFTRDREDRE
            SR$ESERSEW
            IULKYHGUKTFRD
        </auth>
      </application_access_credentials>
    </application_details>
    <share_request>
      <social_target val=”facebook” />
      <share_url val=”https://facebook.com/share/api” />
      <content_to_share>
        <text>
            I just added an item to my Facebook store!
            Click here to view it now
        </text>
        <image type=”application_preview”>
          <source val=”www. Bill Pay .com/img/HJFGTR” />
        </image>
      </content_to_share>
    </share_request>
</social_checkout_widget_assembly_response>
```

In one embodiment, the user may then indicate that they wish to share the provided content on their social media site feed, e.g., a social checkout widget application sharing request 10218. In some embodiments, the user may share information about the social application, the widget integrated into a social application, and/or the like. In other embodiments, the widget may be shared directly on the user's social media feed, allowing viewers to see the widget's content and, in some examples, checkout using the widget controls. An example social checkout widget application sharing request 10218, substantially in the form of an HTTP(S) POST message including XML-formatted data, is provided below:

```
POST /social_checkout_widget_app_sharing_request.php HTTP/1.1
Host: www.socialmediaserver.com
Content-Type: Application/XML
Content-Length: 667
<?XML version = ″1.0″ encoding = ″UTF-8″?>
<social_checkout_widget_app_sharing_request>
  <timestamp>2020-12-12 15:26:43</timestamp>
  <auth type=”user_device_to_server”>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <api type=”share_on_my_wall_api”>
  <api key=”E8767643456” />
  <user_id val=”7657654” />
  <post>
    <text>
      I just added an item to my Facebook store!
      Click here to view it now
    </text>
    <image type=”application_preview”>
      <source val=”www. Bill Pay .com/img/HJFGTR” />
    </image>
  </post>
</social_checkout_widget_app_sharing_request>
```

In one embodiment, the social media server 10204 may confirm that the social media sharing request has been process (e.g., the content has been shared on the user's social media feed), e.g., a social checkout widget application sharing response 10219 and the user device may render a confirmation noting the successful sharing event, e.g., a widget application sharing confirmation 10220. In other embodiments, the Bill Pay server may itself transmit the content to be posted on the user's social media feed such as by using stored or provided user social media access credentials and/or the like, e.g., 10218a.

FIG. 103 shows a logic flow illustrating an example widget designer building component, e.g., a BWD Component 10300, in some embodiments of the Bill Pay. In one embodiment, user device 10301 may transmit a widget designer request input, e.g., 10304, to a Bill Pay server 10302. The Bill Pay server may receive the widget designer request and extract user authentication information, e.g., 10305. Authentication information may be in the form of a clear text username/password, a hashed username/password, a cryptographic key, and/or the like. In one embodiment, the Bill Pay server may query a widget designer authentication and permissions table for authorized widget designer users, e.g., 10306. If the user is not found, e.g., 10307, the Bill Pay server may generate an invalid user error response and transmit the error response to the user device 10301. The user device may render the error response and request revised user credentials, e.g., 10309.

In one embodiment, if the user is found by the Bill Pay server, the Bill Pay server may determine if the user has widget generation privileges, e.g., 10310. For example, users may be permitted by the Bill Pay to generate widgets on behalf of any user or merchant, only a subset of users or merchants, or only on behalf of themselves. If the user does not have the appropriate widget generation privileges (or, after proceeding through any of the component logic, no longer has the required permissions), the Bill Pay server may generate a widget generation authentication error, e.g., 10311, which may cause the user device to prompt the user for updated credentials. In one embodiment, the Bill Pay server may determine if the currently active widget generator session is associated with any third party pricing and/or item information services, e.g., 10312. A single widget designer session (e.g., a user session) may be associated with one or more item pricing or information services. An item pricing or information service may be a service (e.g., a RESTful web service, a SOAP service, and/or the like) provided by a third party server that enables the Bill Pay server to dynamically update its item and pricing database. In other embodiments, the updating may be in the form of a web crawling of a given web site (such as a merchant's ecommerce web site) and not require a separate item pricing or information service for updating. In still other embodiments, when the user or a merchant does not have goods or services to purchase, the Bill Pay may provide a template item such that the user may populate the template item with, for example, a request for a donation or tip. In other embodiments, if the a user wishes to list items for sale but does not have a web site or online store, the Bill Pay may provide a capability such that the user can upload item image(s) and input item details such as description, inventory, pricing, and/or the like into the Bill Pay and the Bill Pay may therefore act as a merchant server. In one embodiment, the Bill Pay server may generate a merchant content update request, e.g., 10313, and transmit the request to merchant server 10303. The merchant server may query and parse the request, retrieve updated item information (such as descriptions, inventory stock levels, store locations stocking the item, warehouse locations that can ship the items, backorder status for an item, next expected shipment receive date, and/or the like), e.g., 10314. In one embodiment, the merchant server may generate an update response package, e.g., 10315, and transmit the package to the Bill Pay server. The Bill Pay server may extract the updated merchant content and update the a local or remote merchant content database, e.g., 10316.

In one embodiment, the Bill Pay server may query a widget designer template database for templates that are associated with a given merchant, e.g., 10317. In other embodiments, the templates may be associated with a plurality of merchants, with a user, with an item type, and/or the like. If merchant widget designer customization parameters are available, e.g., 10318, the template may be populated with a merchant logo file, merchant social application data (e.g., social media credentials, applications running on a social media platform, and/or the like), a description of an item, a description of a merchant or merchant location, dynamically provided user content, and/or the like, e.g., 10319. In one embodiment, if merchant item or pricing information is available, e.g., 10320, the widget template may be populated with the item pricing or item description data, e.g., 10321. In some embodiments, populating the template may include inserting a live-link to the underlying data (e.g., a live Bill Pay or merchant database query link) such that the user device may dynamically retrieve all or portions of the information without having to load all of the information at render time. In one embodiment, a widget designer response package may be generated with the populated widget designer, and transmitted to the user device, e.g., 10322, which may render the widget designer response for use by the user, e.g., 10323

FIGS. 104A-B show a logic flow illustrating an example social widget assembly and population component, e.g., a PSW Component 10400, in some embodiments of the Bill Pay. In one embodiment, user device 10401 may create a social checkout widget assembly request, e.g., 10404, and transmit the request to Bill Pay server 10402. In one embodiment, the Bill Pay server may receive the request and extract user authentication information and widget assembly instructions and/or widget configuration parameters, e.g., 10405. In one embodiment, the Bill Pay server may query a widget designer authentication and permissions database for a user matching the provided user authentication information, e.g., 10406. If the user is not found, e.g., 10407, an invalid user error response may be generated, e.g., 10408, and forwarded to the user device. The user device may render the error response and request the user to provide updated credentials, e.g., 10409. If the user is found, the social checkout widget assembly request may be examined to determine if valid social media credentials (which may be, in some embodiments, credentials to access a user's or third-party's social media feed, to access a user's or third-party's social media application, and/or the like) are present, e.g., 10410. If valid credentials are not present, an invalid social media credentials error may be generated, e.g., 10411, and transmitted to the user device which may then request updated social media credentials. In some embodiments, the social media credentials may be absent, or may be stored on the Bill Pay server or a third-party server and be retrieved in response to receiving a social checkout widget assembly request. In one embodiment, a social application data request may be created using the social media credentials, e.g., 10412. A social application data request may be a request to retrieve a list of social media applications associated with or available using a user or third party's social media credentials. In one embodiment, the social application data request is send to a social media server 10403, which may receive the request and retrieve available social media application profiles, e.g., 10413. For example, in one embodiment a comma delimited list of all applications include an application name, application permission, application widget integration, and/or the like may be returned. The social media server may prepare a social application data response package using the retrieved social media application profiles, e.g., 10414, and transmit the response to Bill Pay server 10402. In one embodiment, Bill Pay server 10402 may receive the response and extract the available social media application profiles, e.g., 10415.

In one embodiment, if the widget assembly instructions include a request to instantiate or create a new social media application, e.g., 10416, the Bill Pay server may query a social media application template database for a social media application template matching the required widget assembly instruction parameters (e.g., the proper application capabilities, application permissions, target user demographic profile, and/or the like), e.g., 10417. An example social media application template, substantially in the form of XML-formatted data, is provided below:

```
<?XML version = ″1.0″ encoding = ″UTF-8″?>
<social_media_application_template>
  <operation type=”create_new_application”>
    <required_parameters>
      <param name=”application_name” />
      <param name=”user_to_create_for” />
      <param name=”user_credentials” />
    <required_parameters>
    <optional_parameters>
      <param name=”application_view_page”
          types_accepted=”PHP,HTML+JavaScript,C++” />
      <param name=”application_config_options”>
        <config val=”user_age_range” type=”integer” />
        <config val=”ecommerce_enabled_store” type=”boolean” />
        <config val=”third_party_render_server” type=”url” />
      </param>
    </optional_parameters>
    <execute>
      <command seq=”1” endpoint=”https://merchant.com/info”
        to_post=”notice_of_new_social_app_being_created” />
      <command seq=”2” endpoint=”https://socialmedia.com/newapp”
```

include=”all_parameters” />

```
      <expect_return from_seq=”2” value=”string:’app_created’” />
      <expect_return_param from_seq=”2”
```

name=”new_app_id” type=”integer” />

```
    </execute>
  </operation>
  <operation>
    ...
  </operation>
</social_media_application_template>
```

In one embodiment, the Bill Pay server may generate a social media application creation request, e.g., 10418, using the social media application template and the widget assembly instructions, and transmit the request to social media server 10403. The social media server may receive the request and extract the application creation request parameters, e.g., 10419, and create a social media application based on the request parameters, e.g., 10420. In one embodiment, the social media server may respond with access credentials for the new social media application (e.g., an API access key, username/password, and/or the like). In one embodiment, the Bill Pay server may receive the response indicating that the new social media application has been created and extract the new social media application profile including access credentials, e.g., 10421. In one embodiment, the new social media application may be added to the available social media applications, e.g., 10422.

In one embodiment, the Bill Pay server may query a widget template database for a widget template corresponding to the social media application profile, e.g., 10423. For example, depending upon the capabilities or renderable types supported by the social media application, a different widget template may be selected. In one embodiment, widget customization parameters may be extracted from the widget assembly instructions, e.g., 10424. Widget customization parameters may include but are not limited to: widget behavior when invoked, widget merchant URL to link to, what checkout or application view to render upon widget invocation, and/or the like. The logic flow may continue with respect to FIG. 104B.

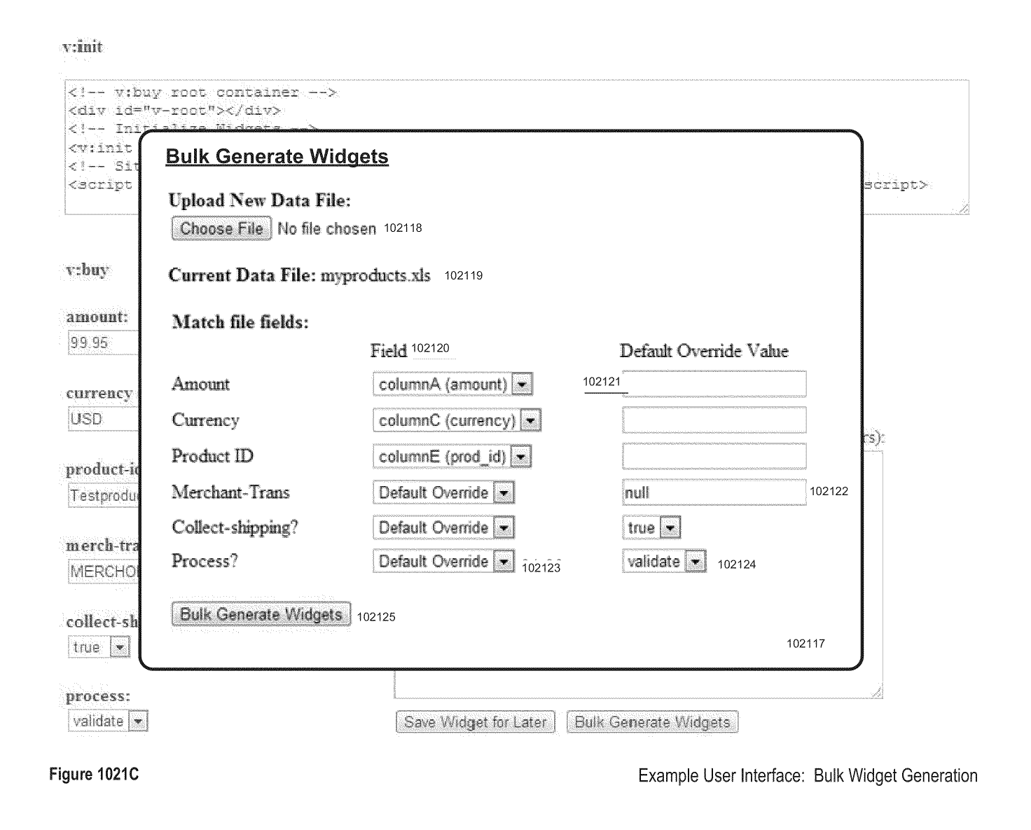

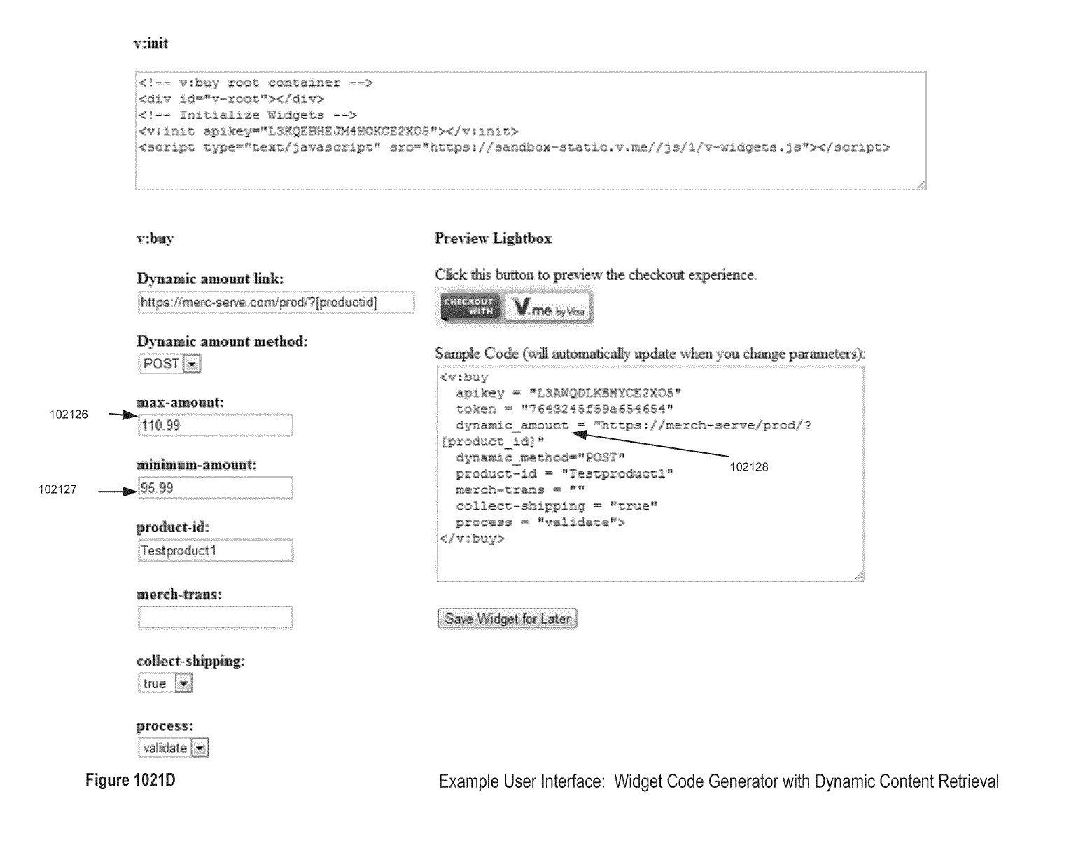

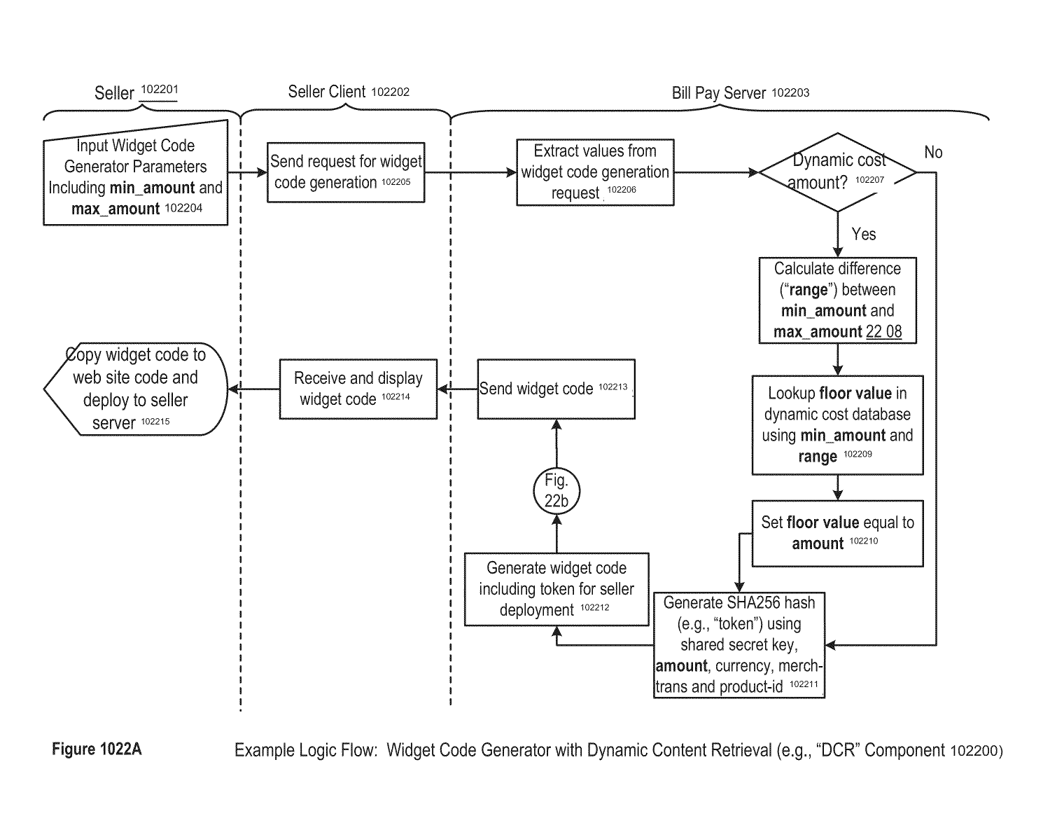

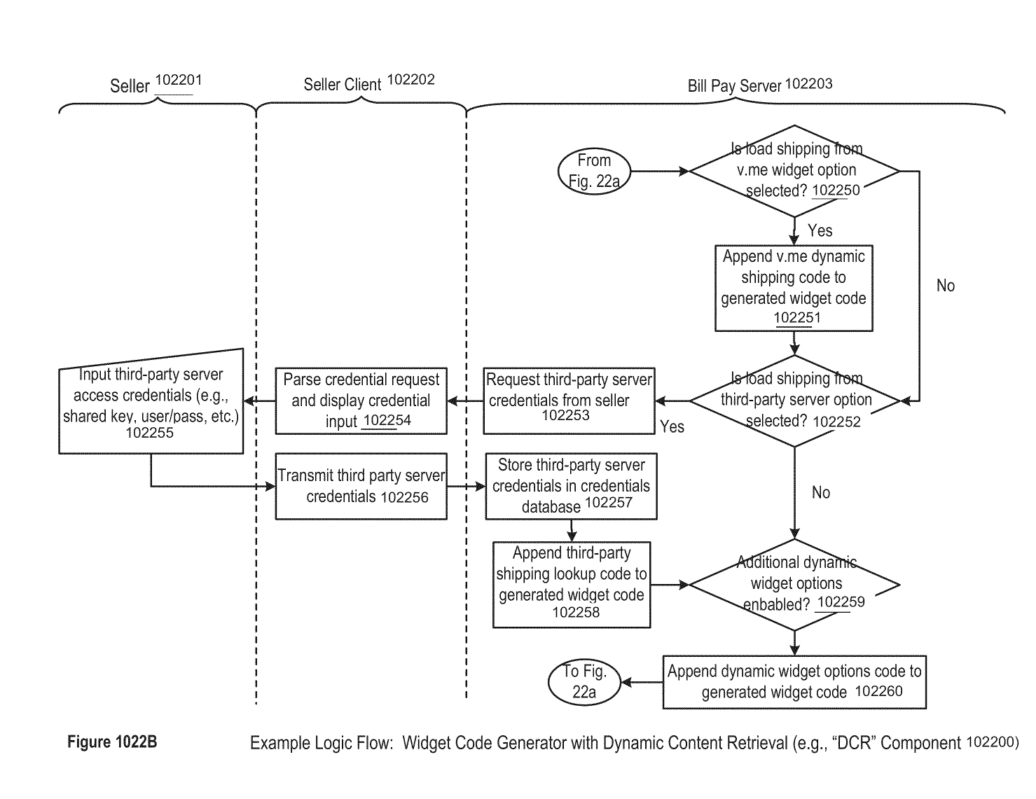

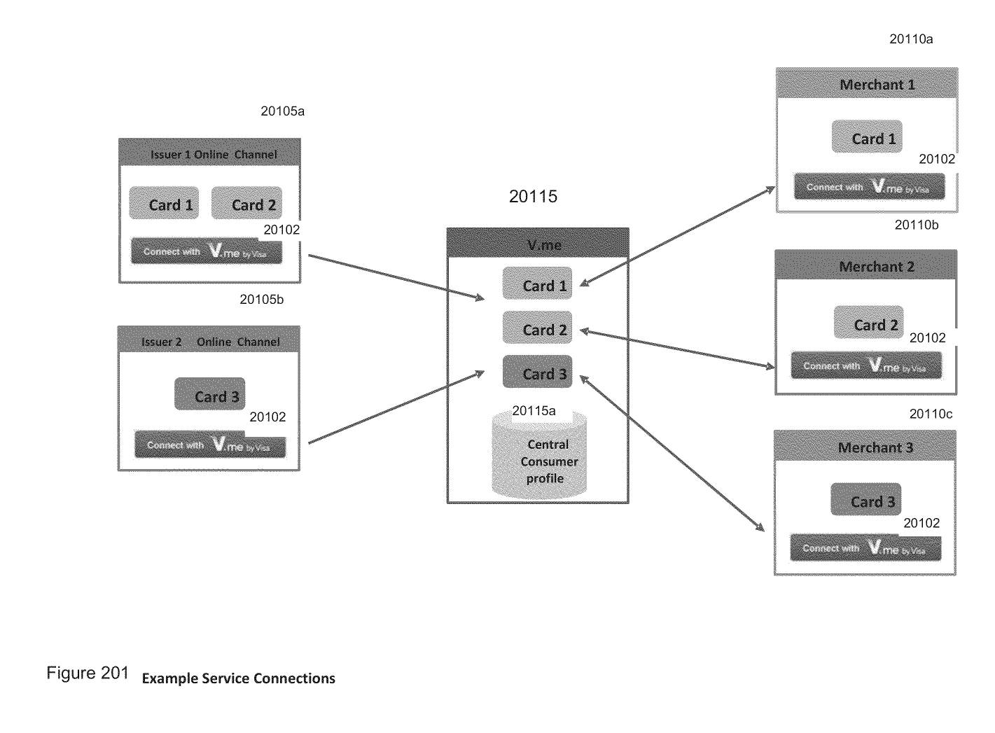

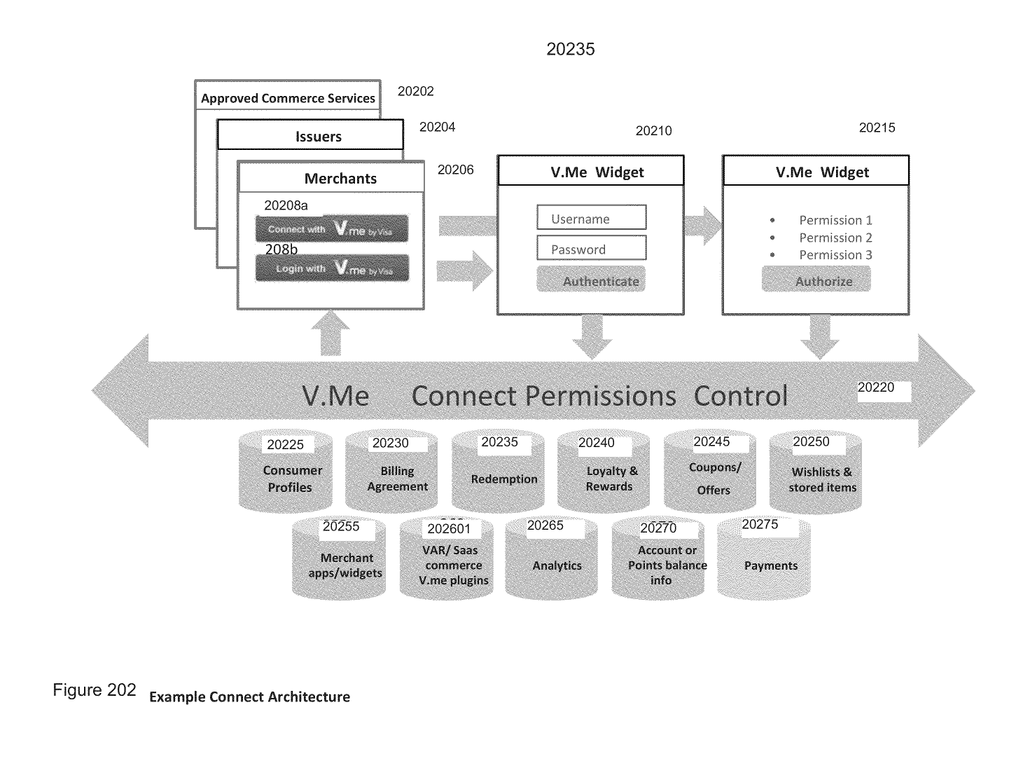

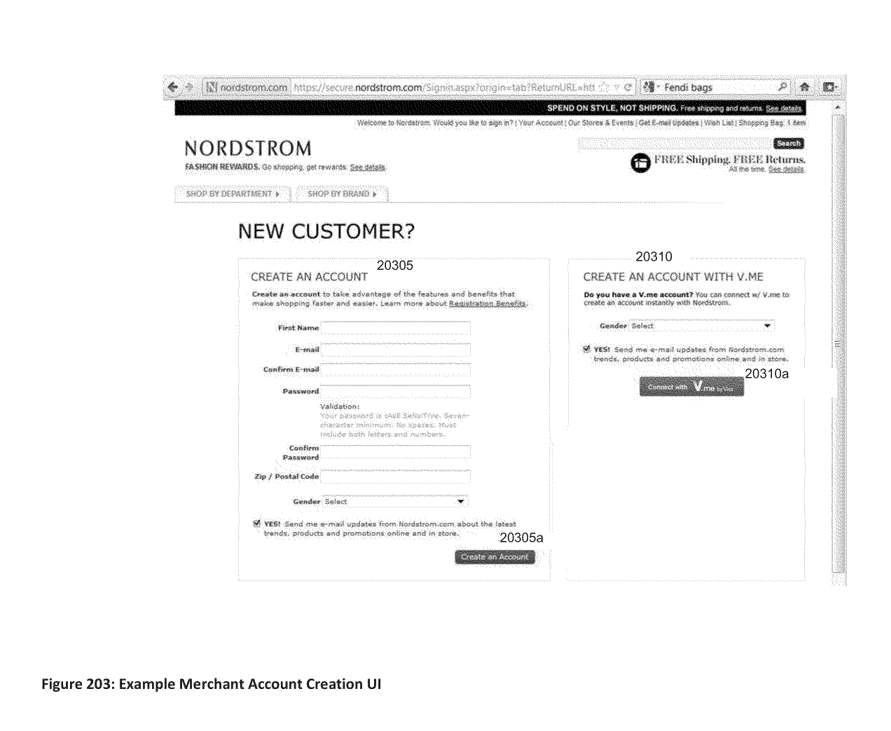

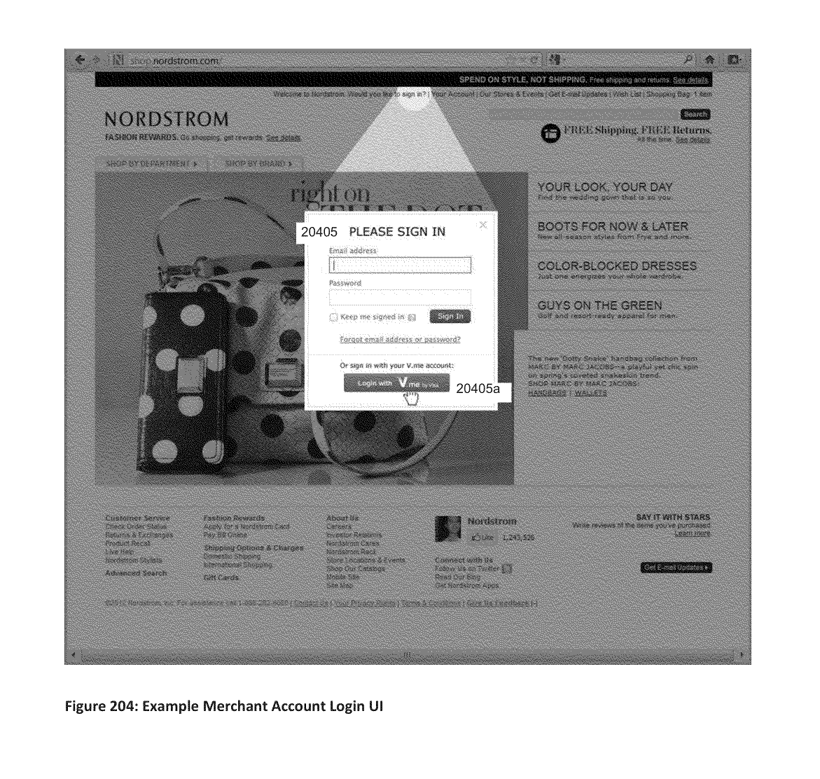

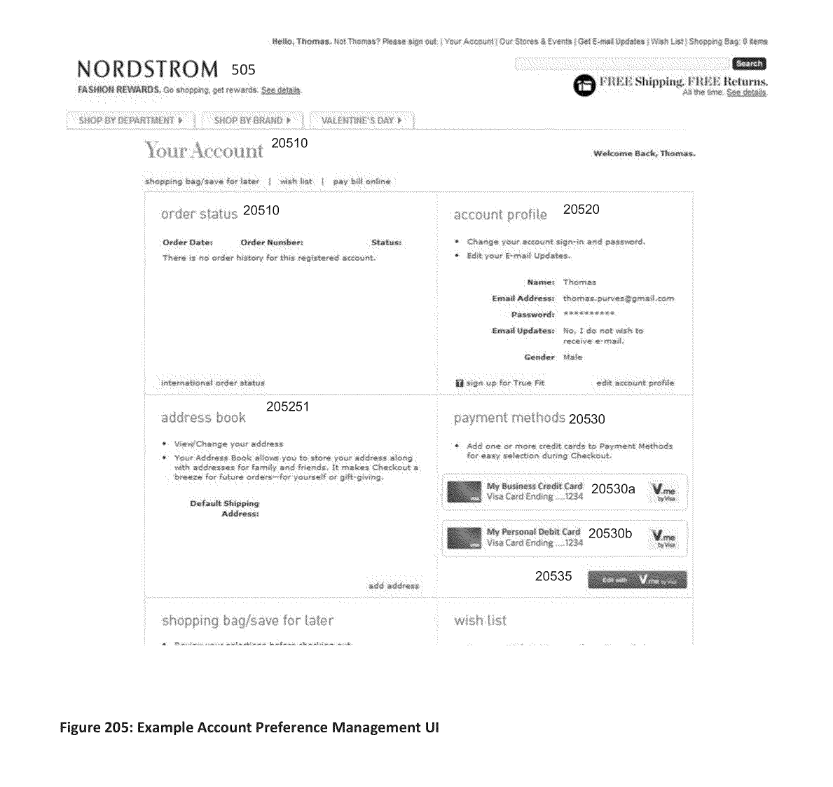

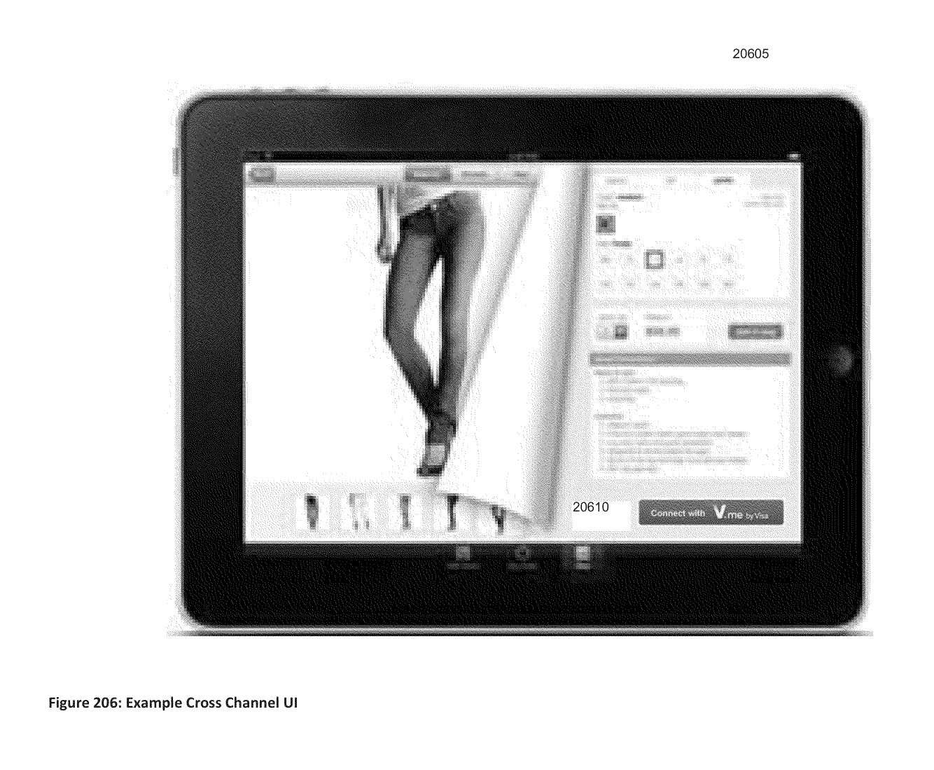

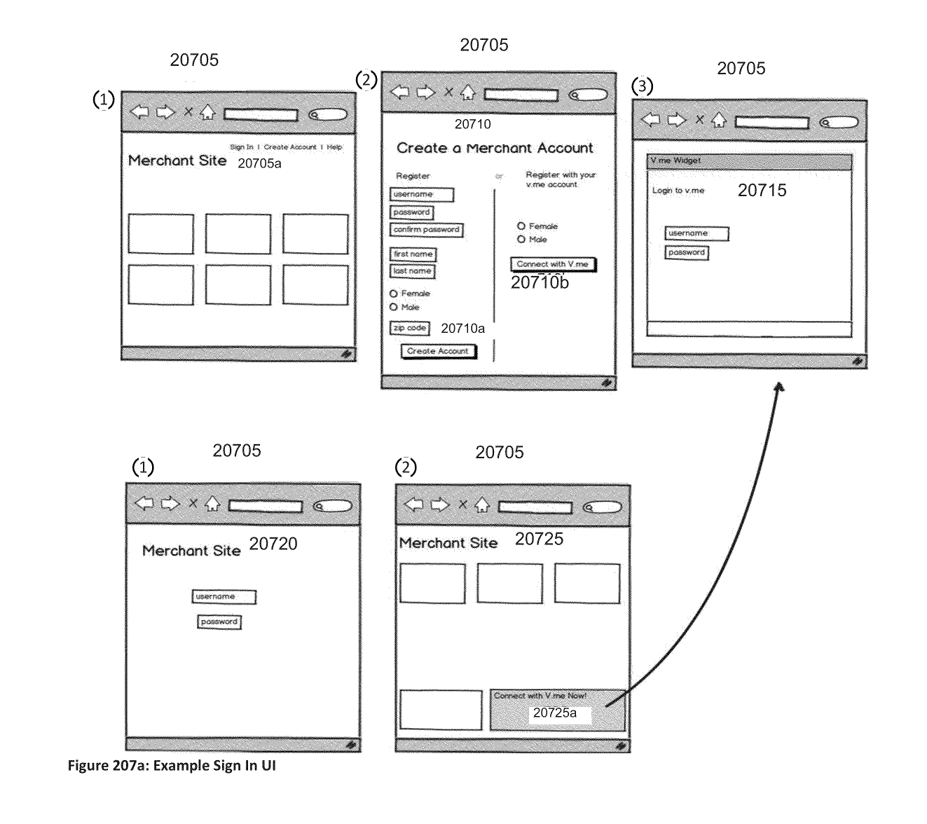

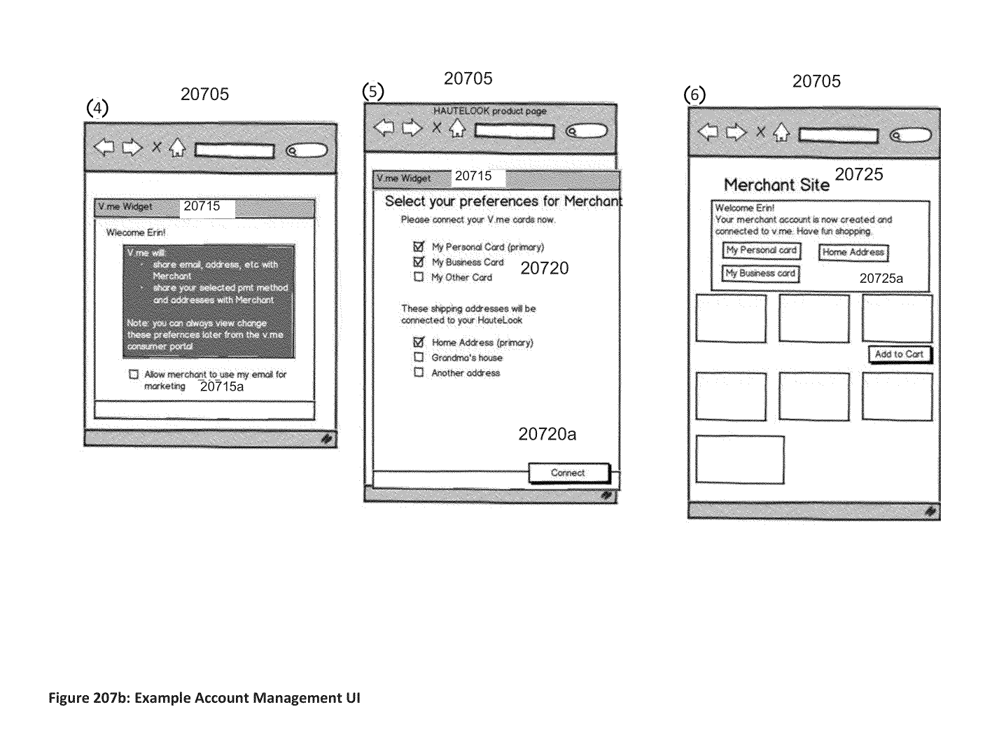

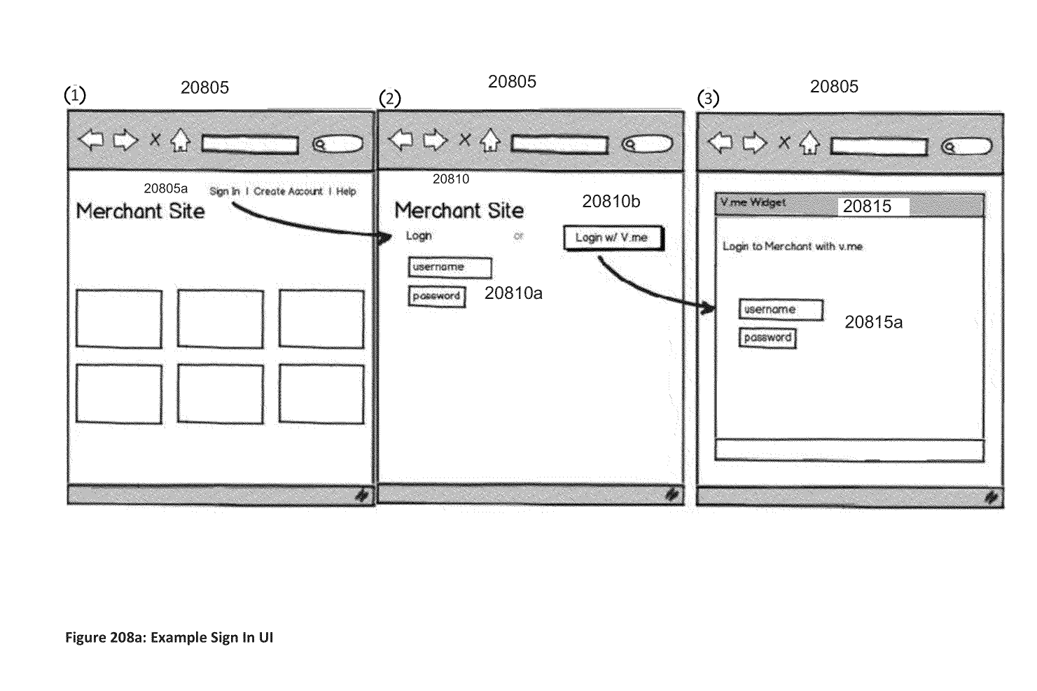

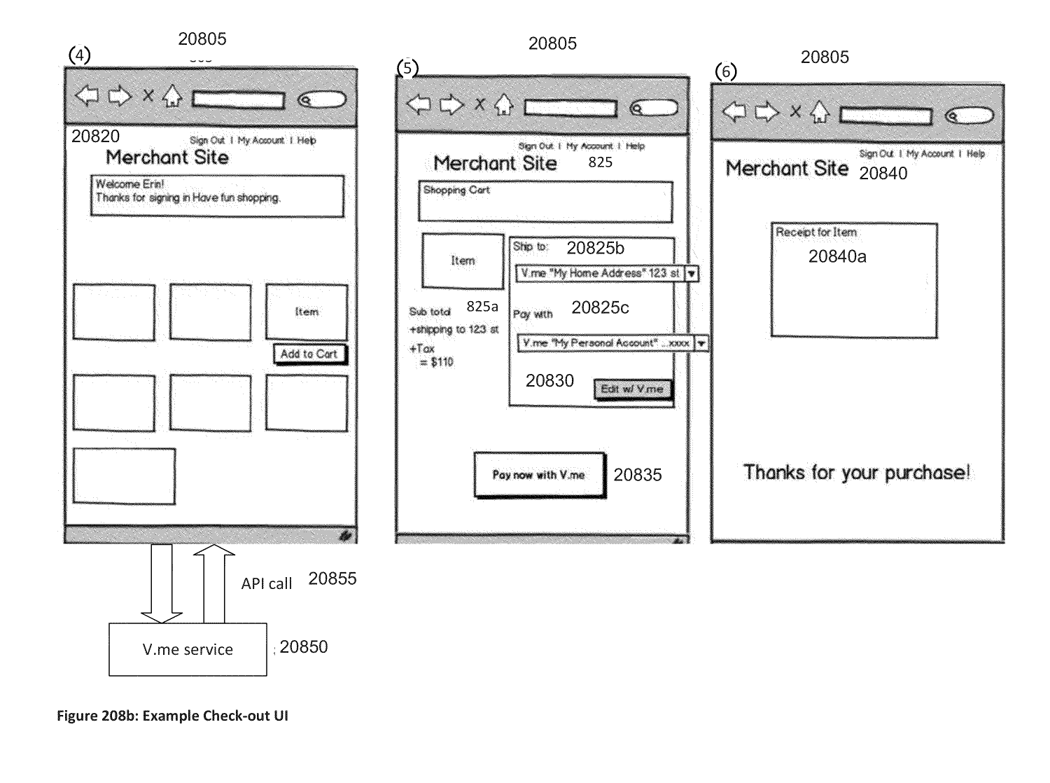

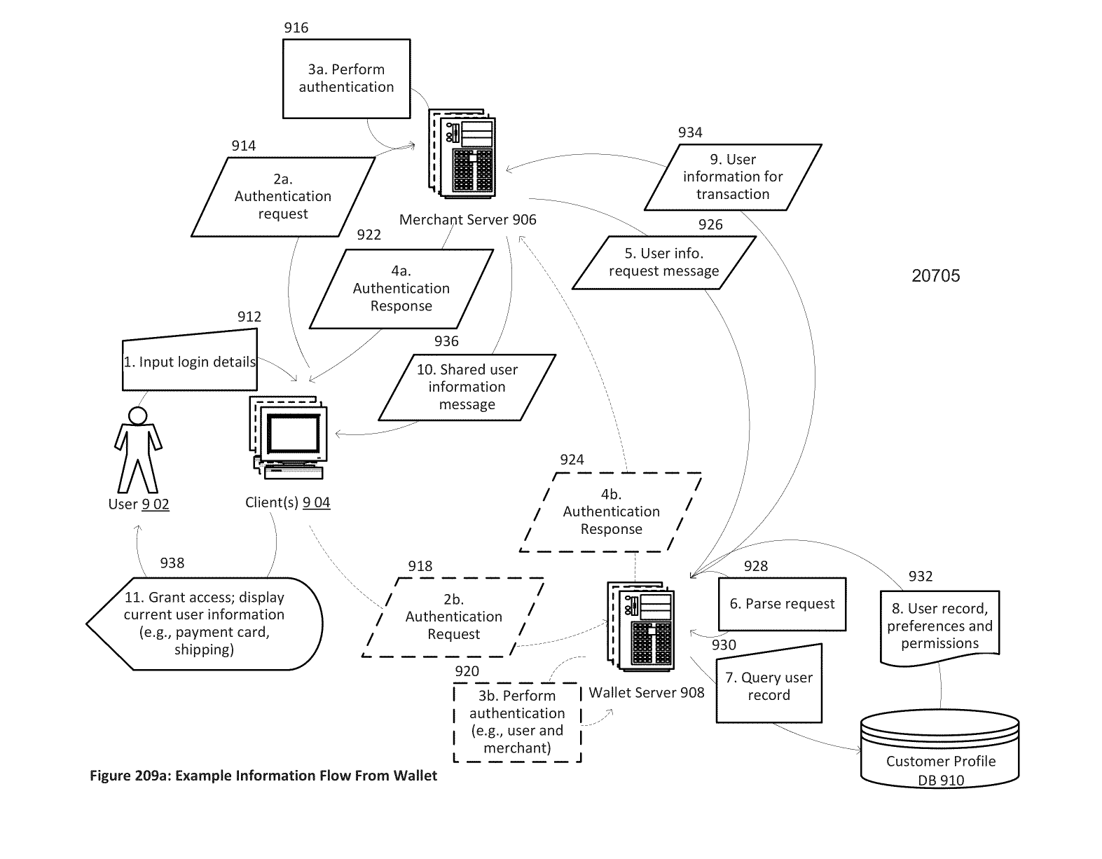

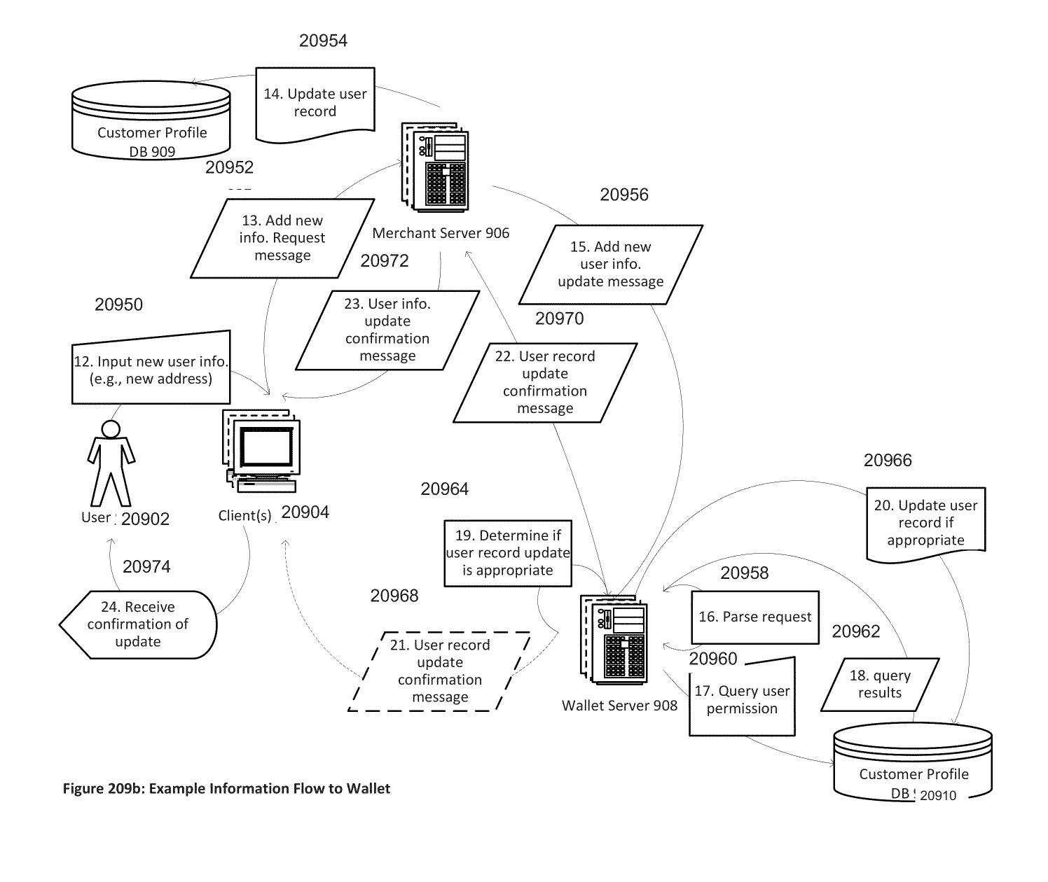

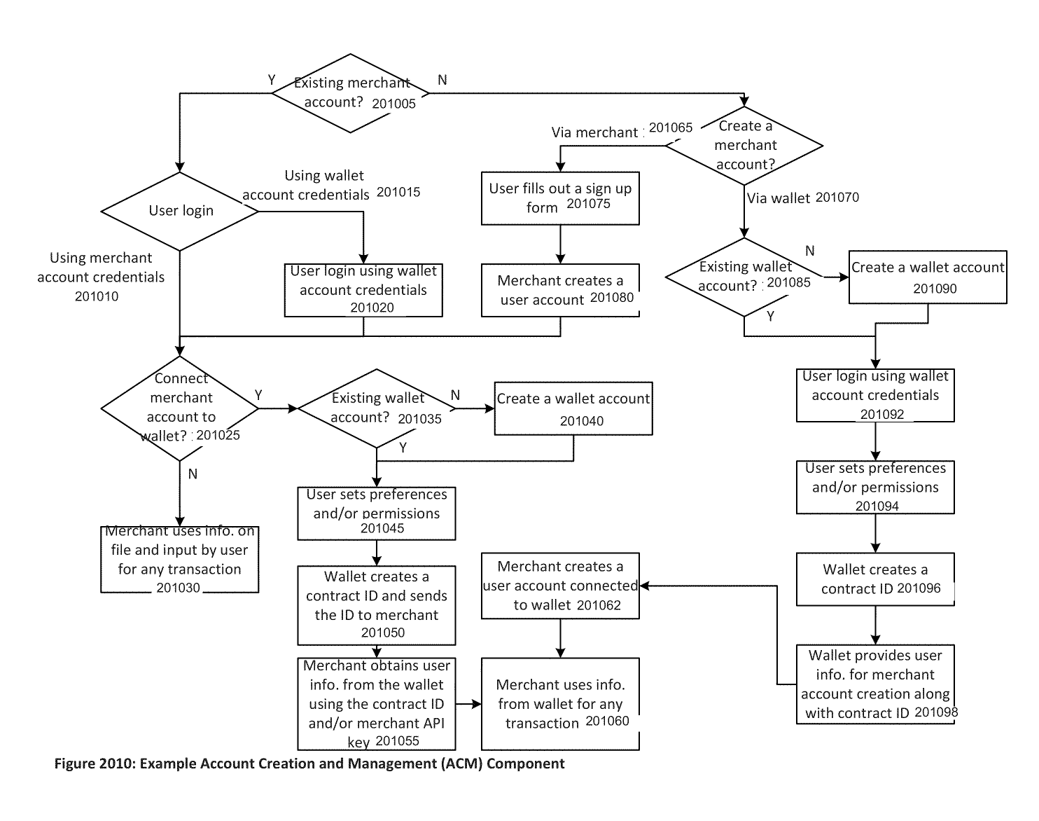

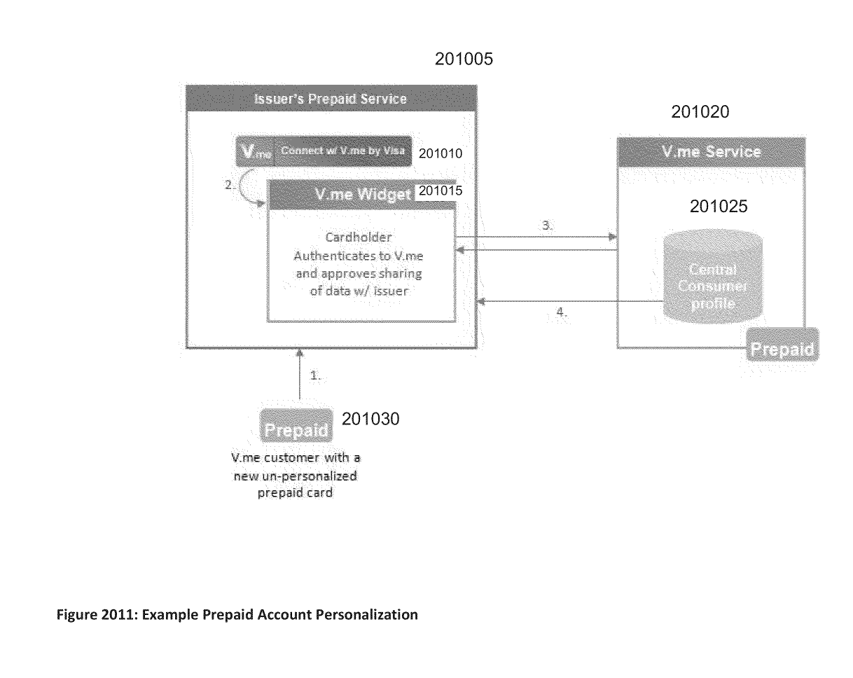

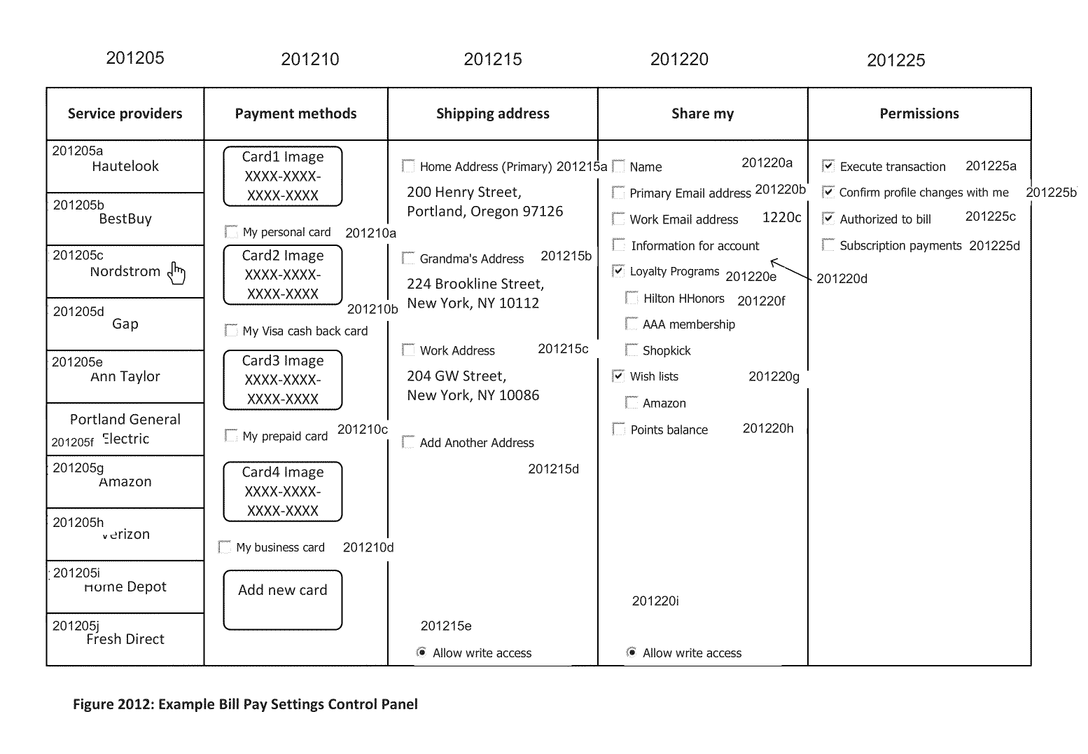

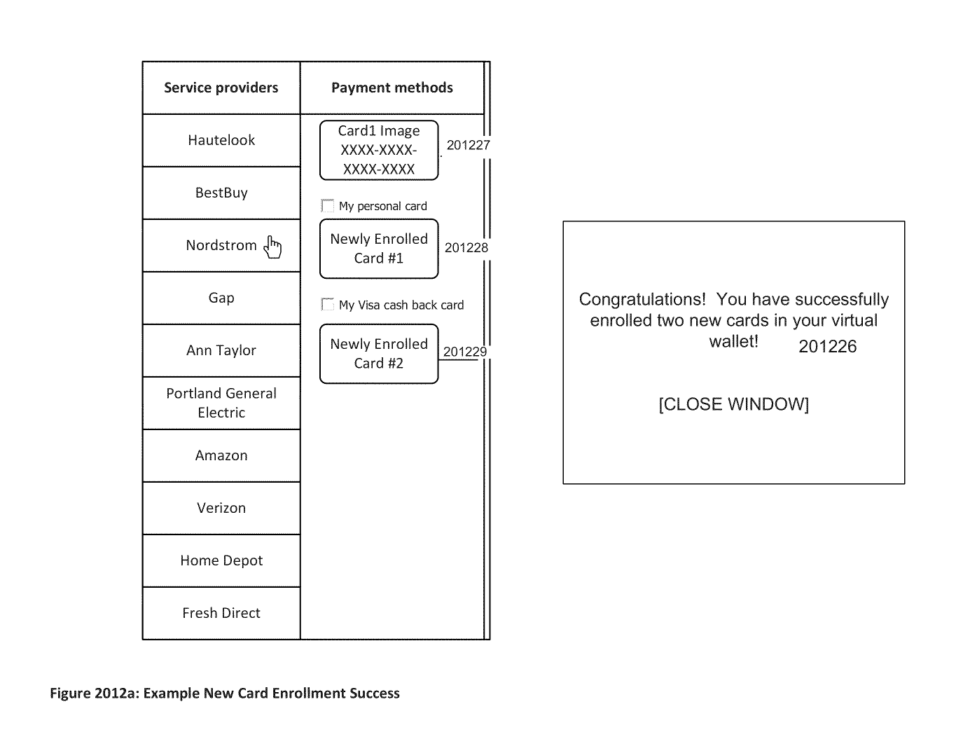

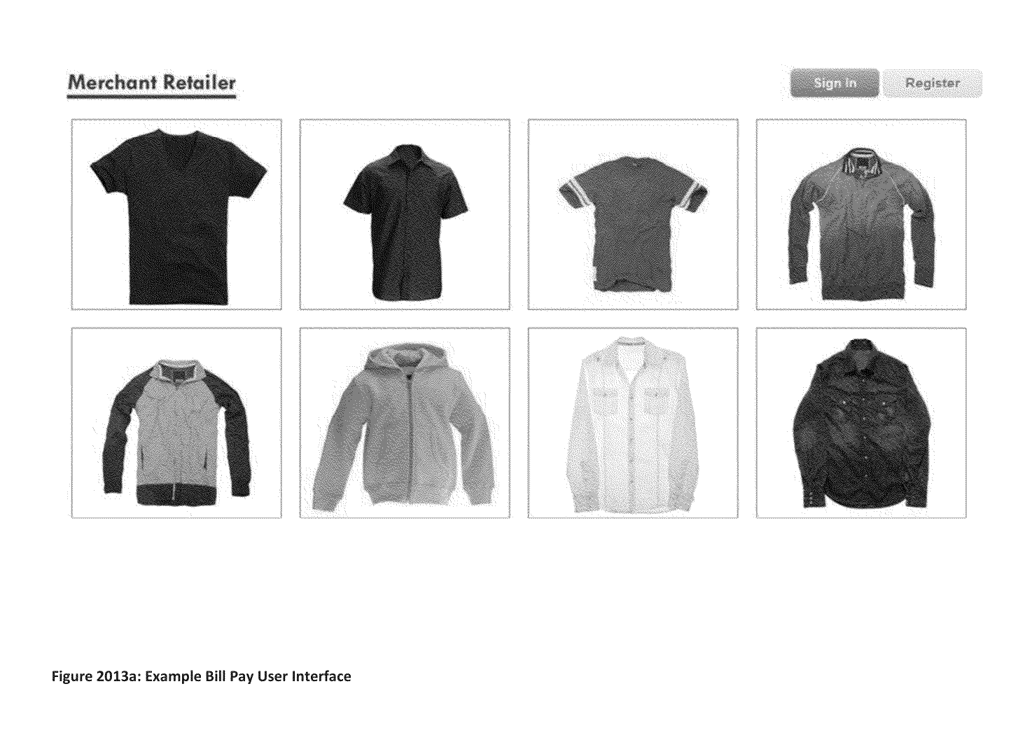

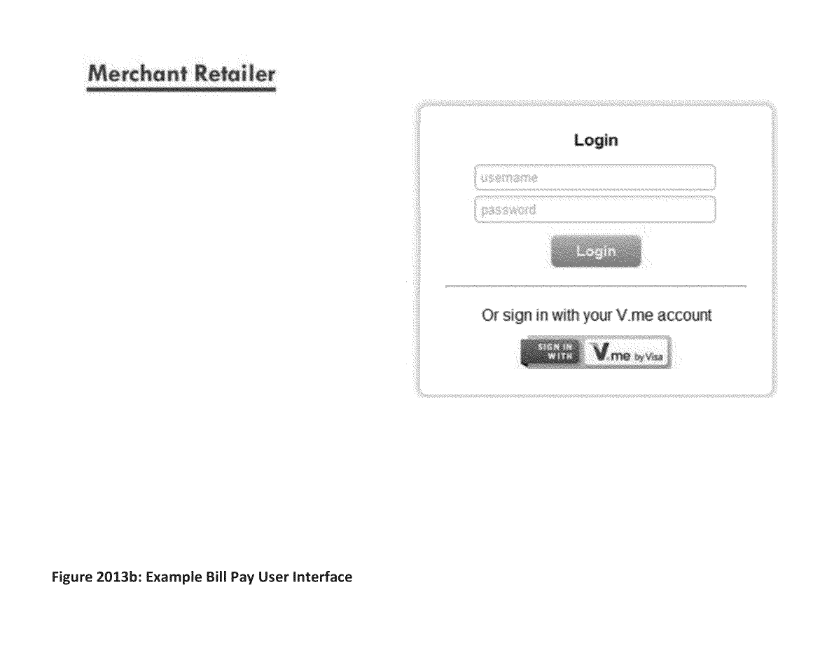

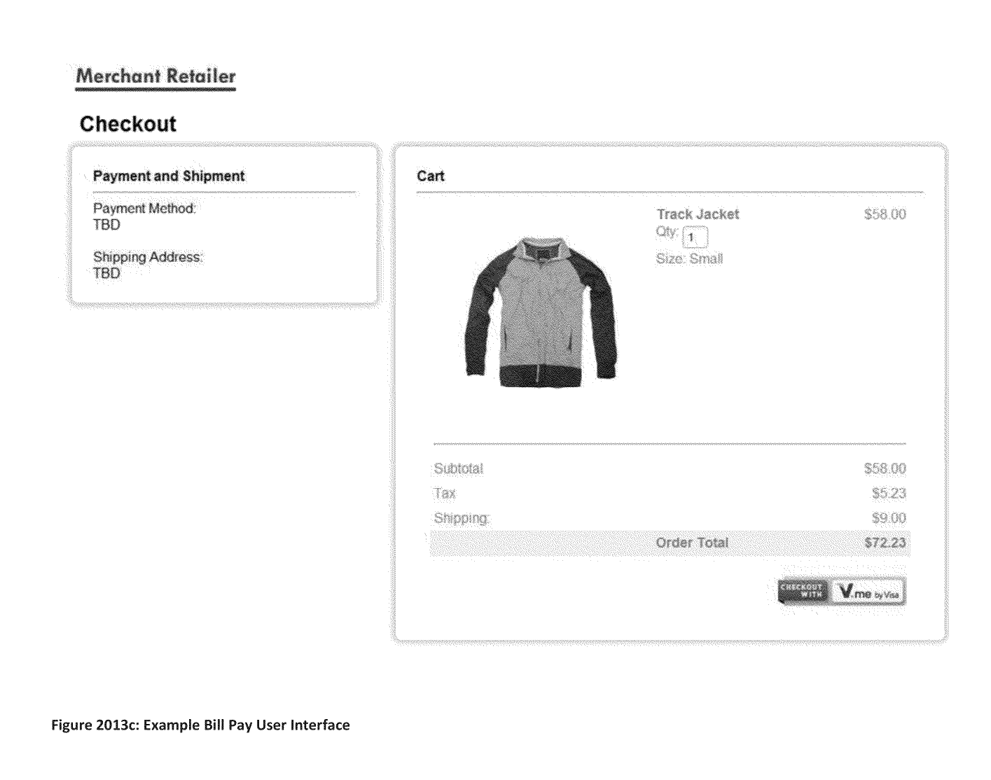

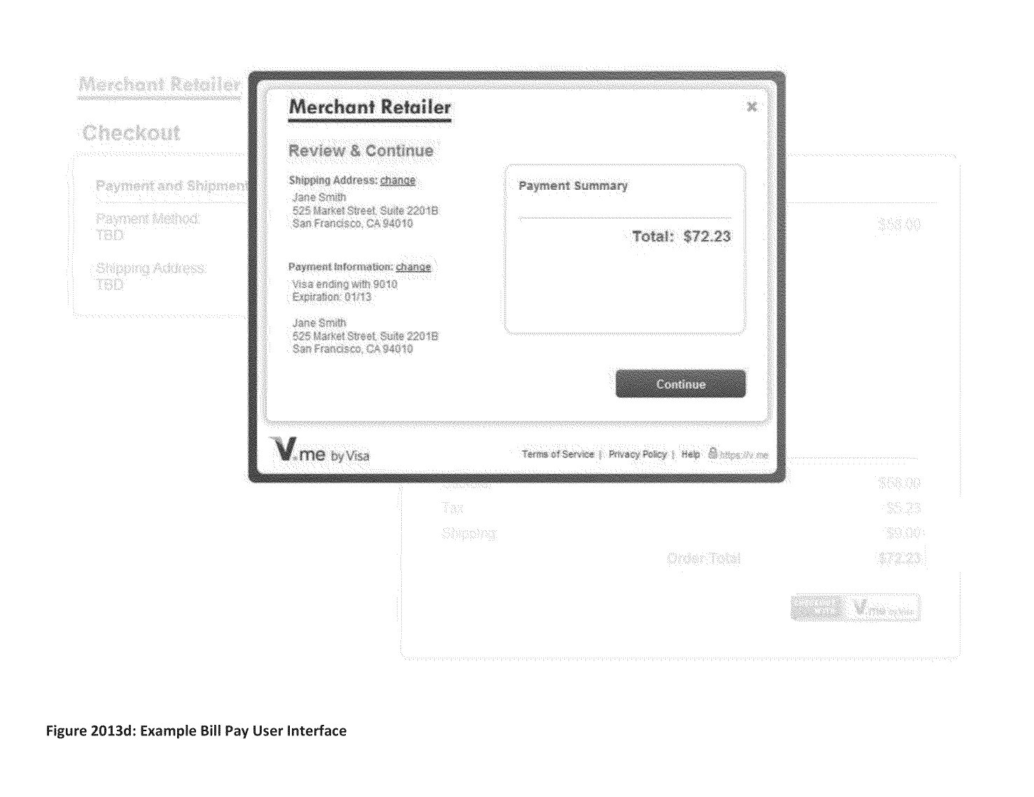

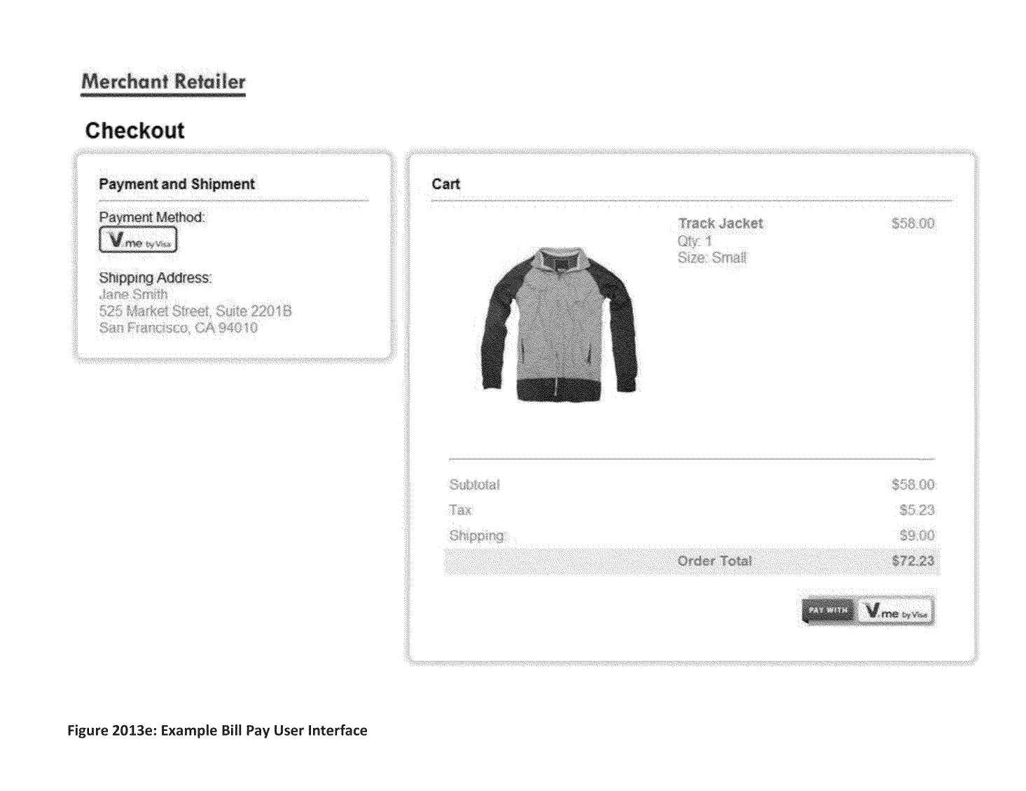

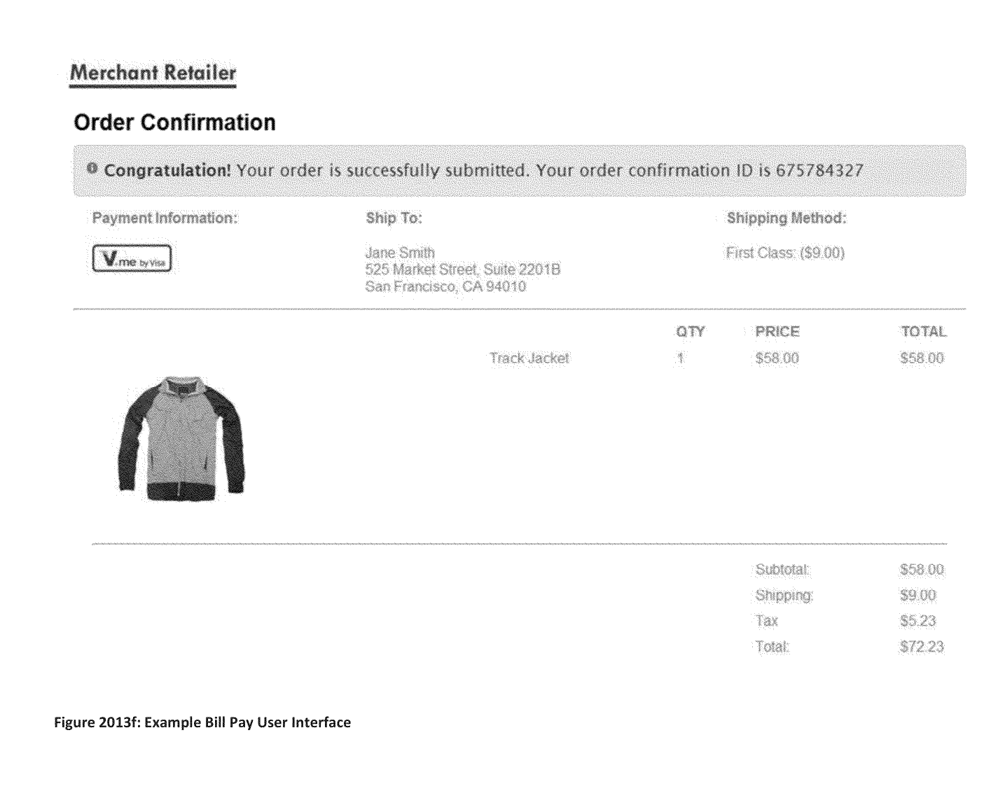

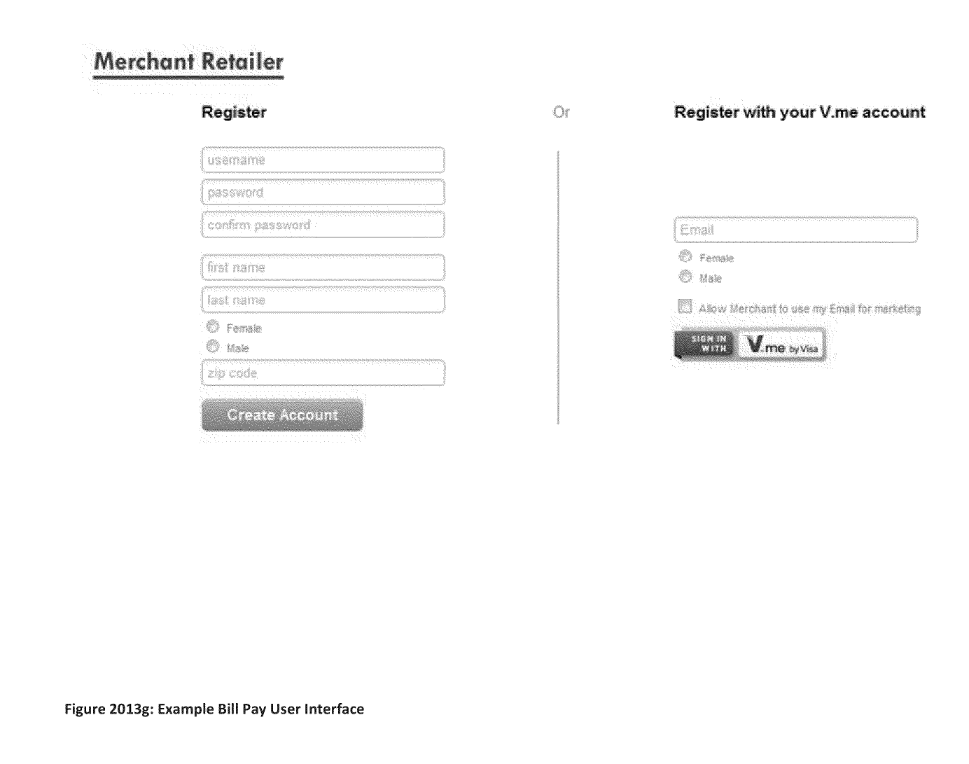

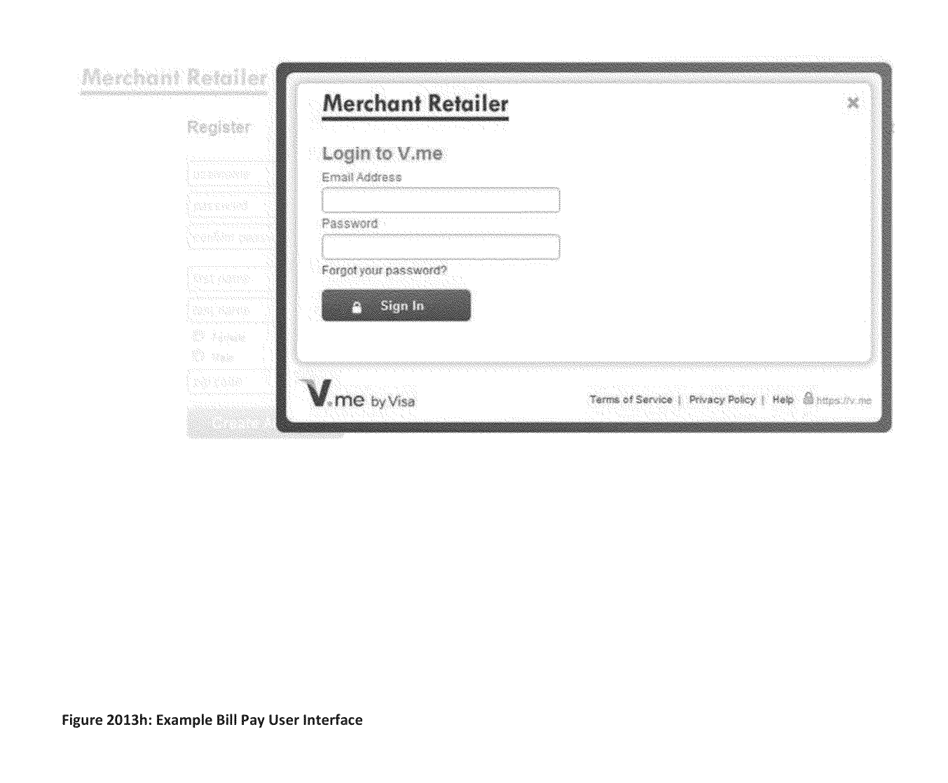

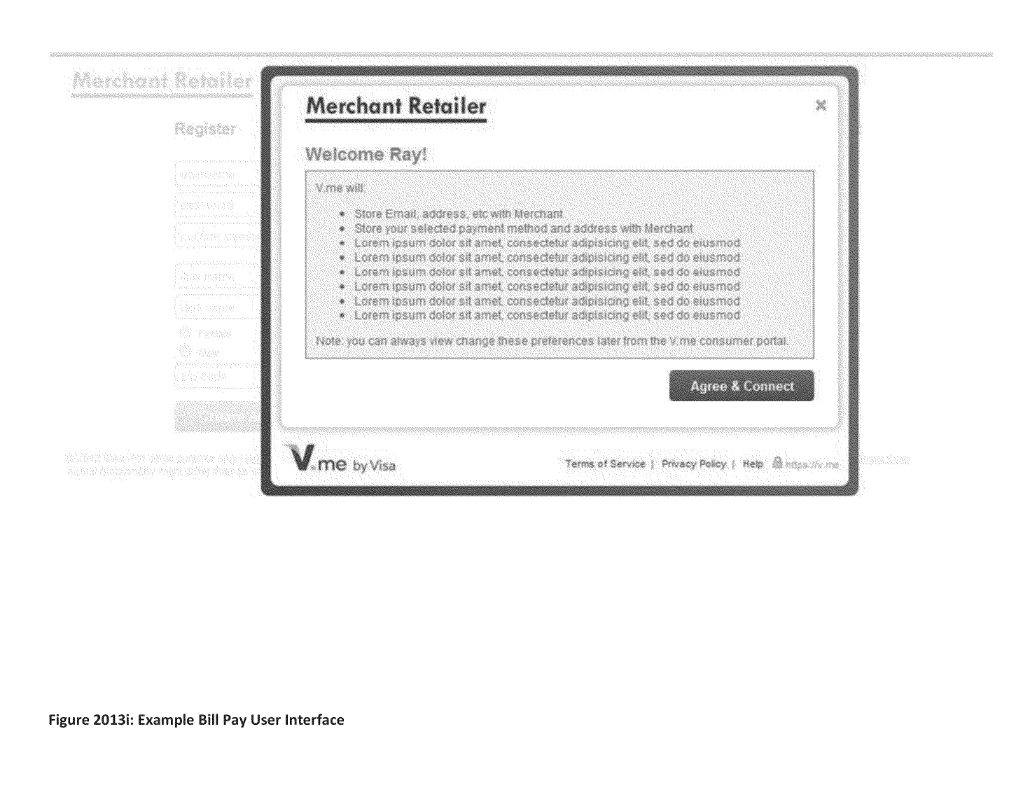

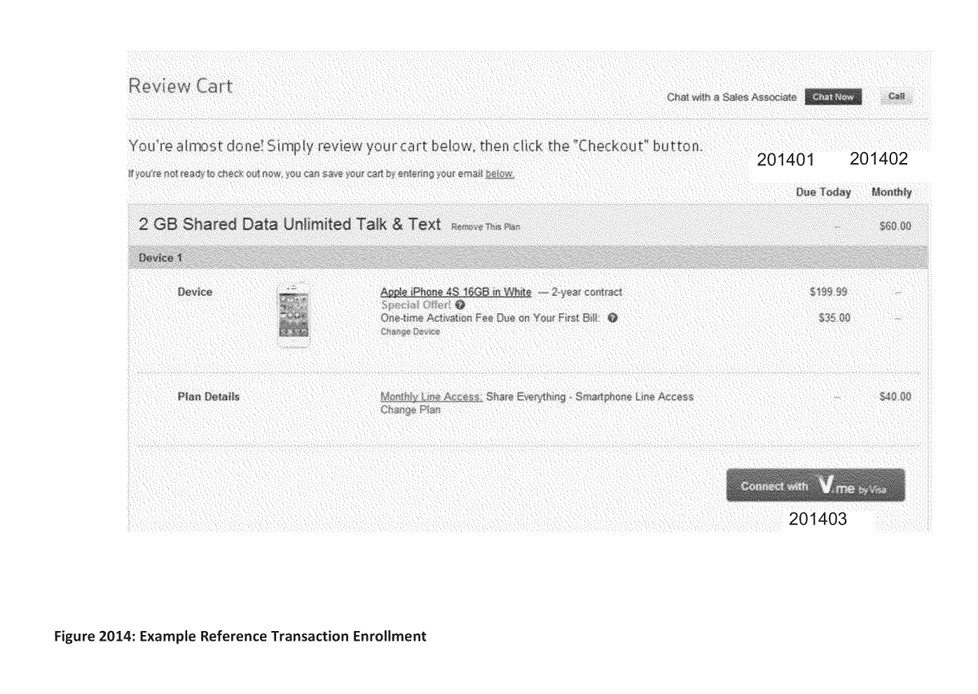

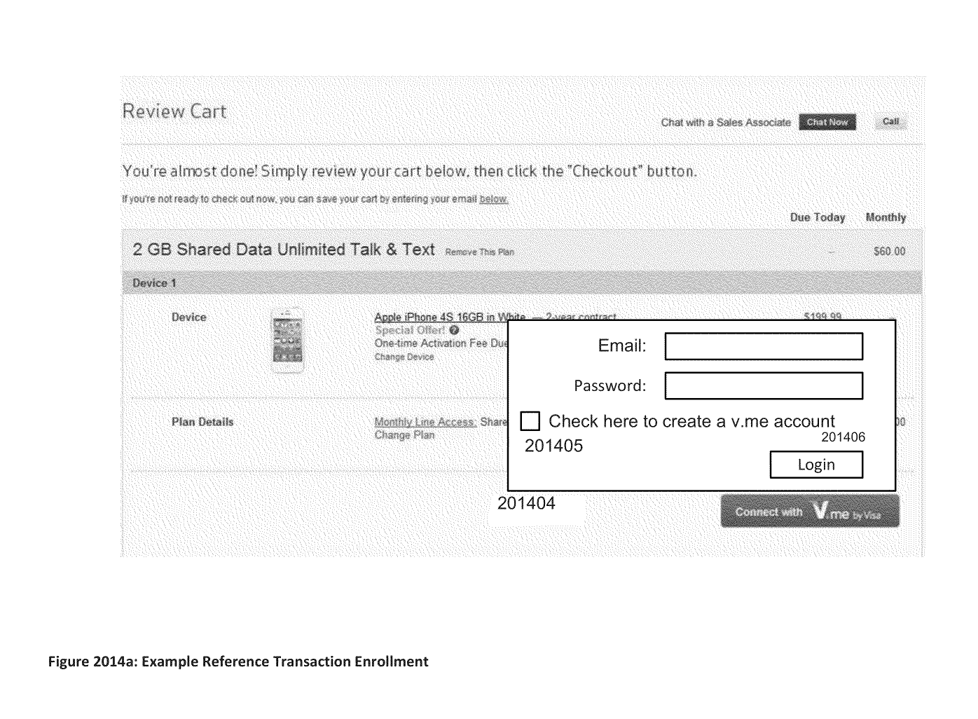

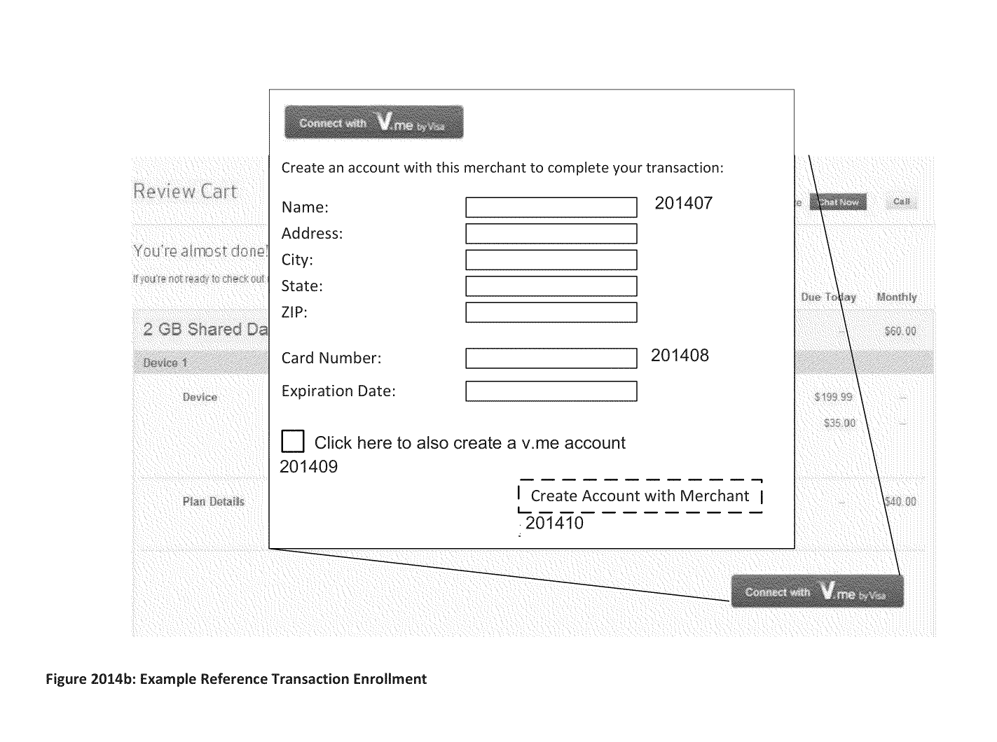

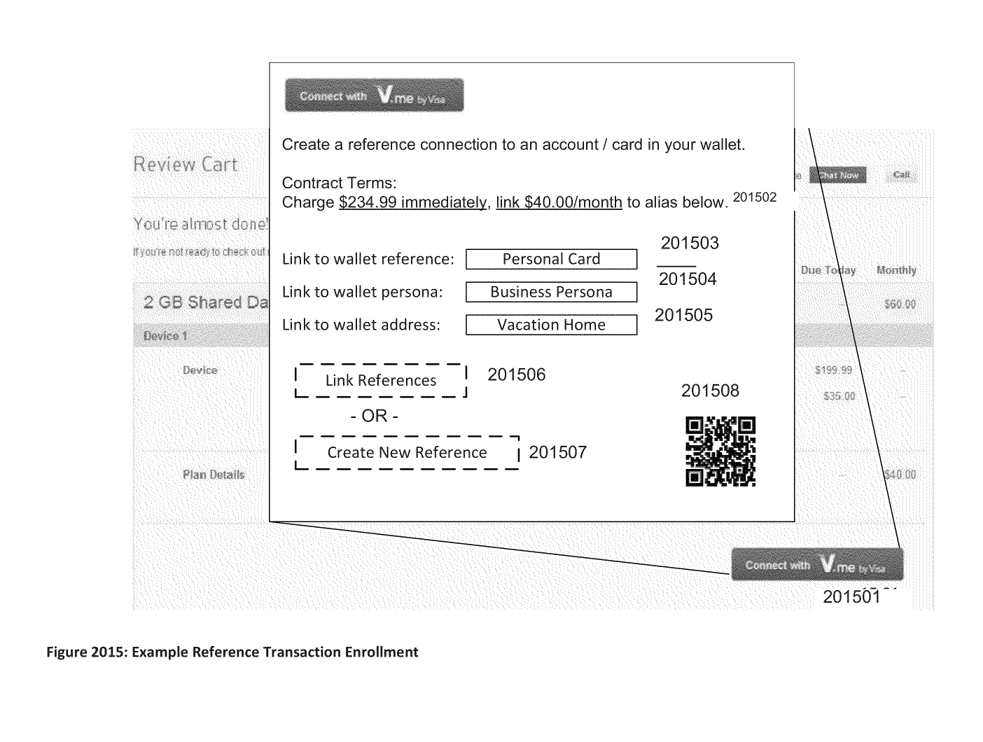

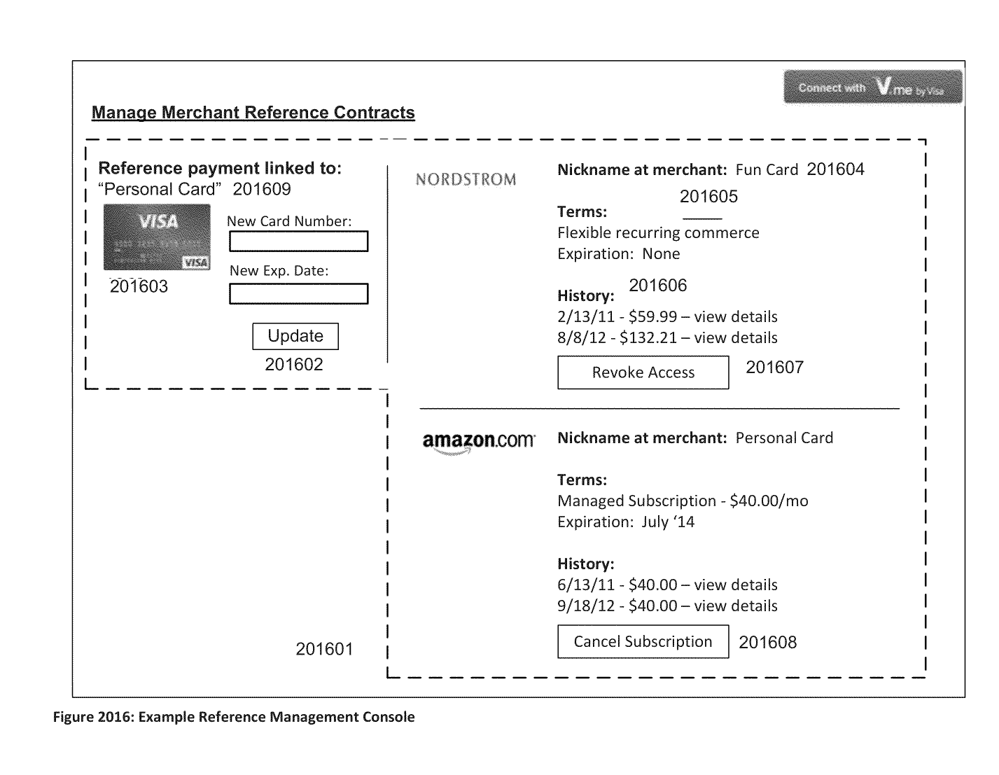

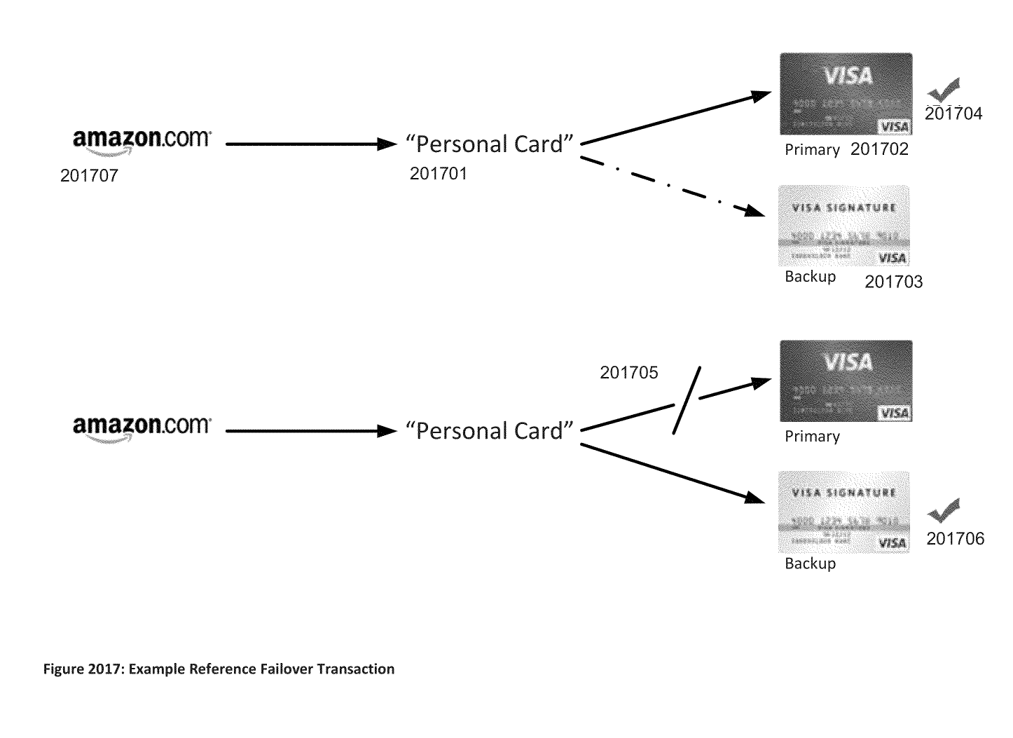

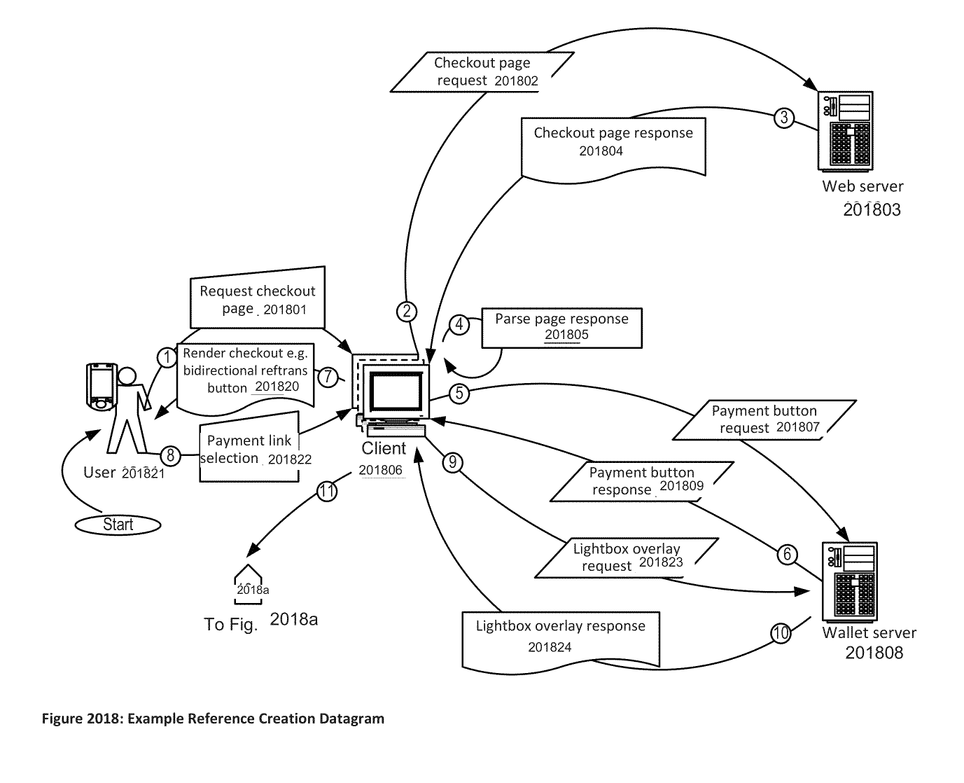

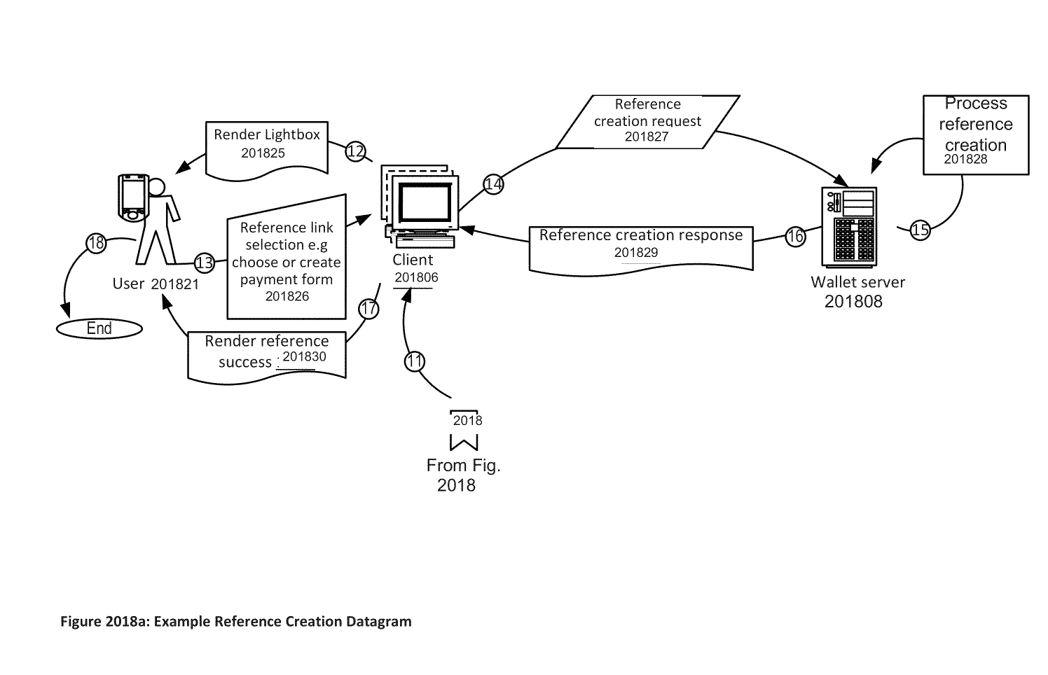

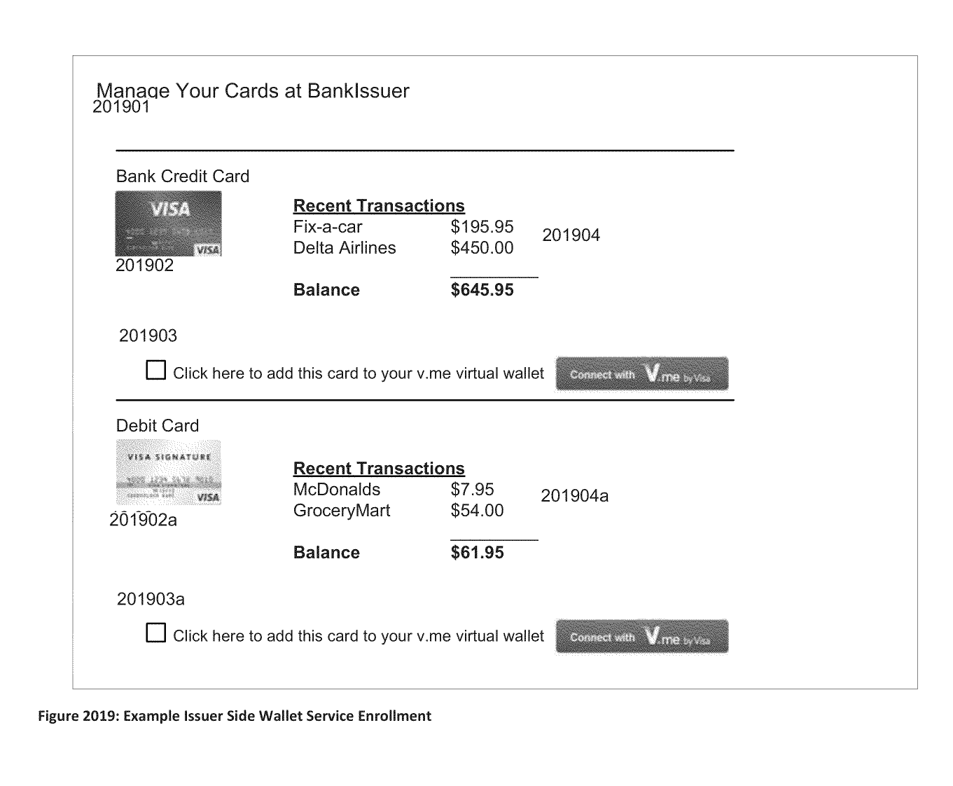

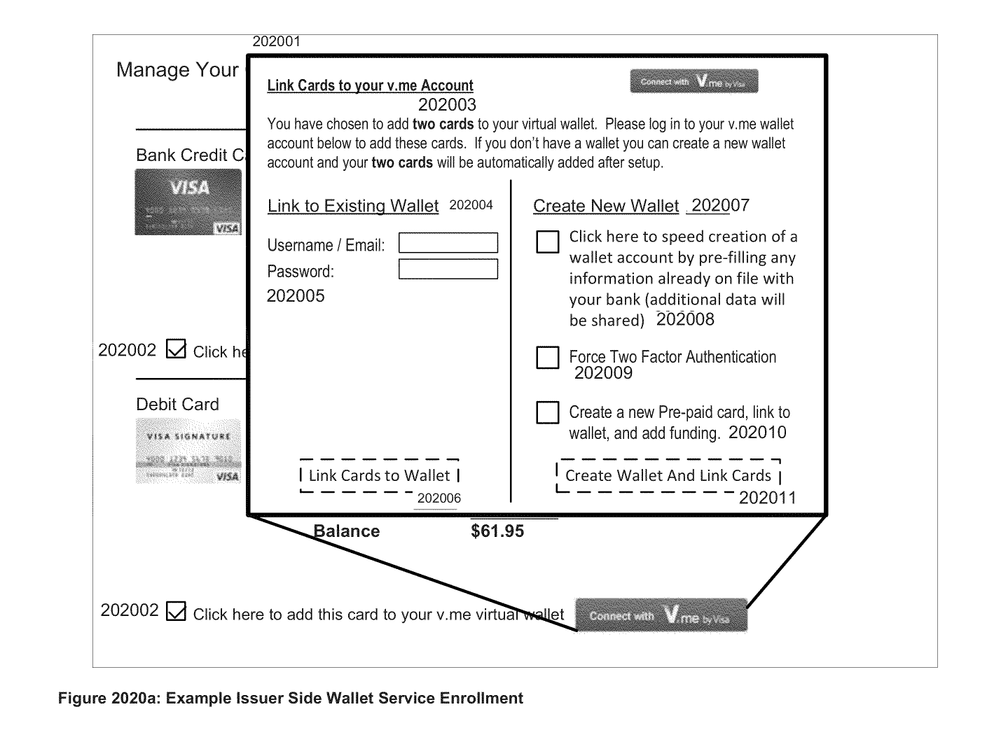

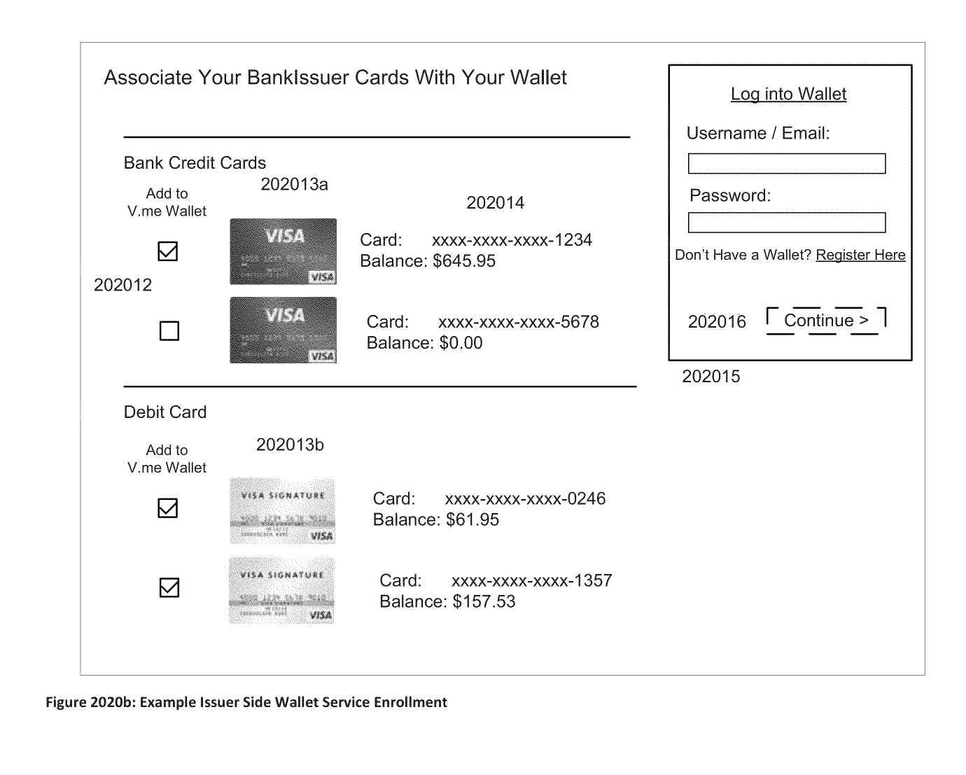

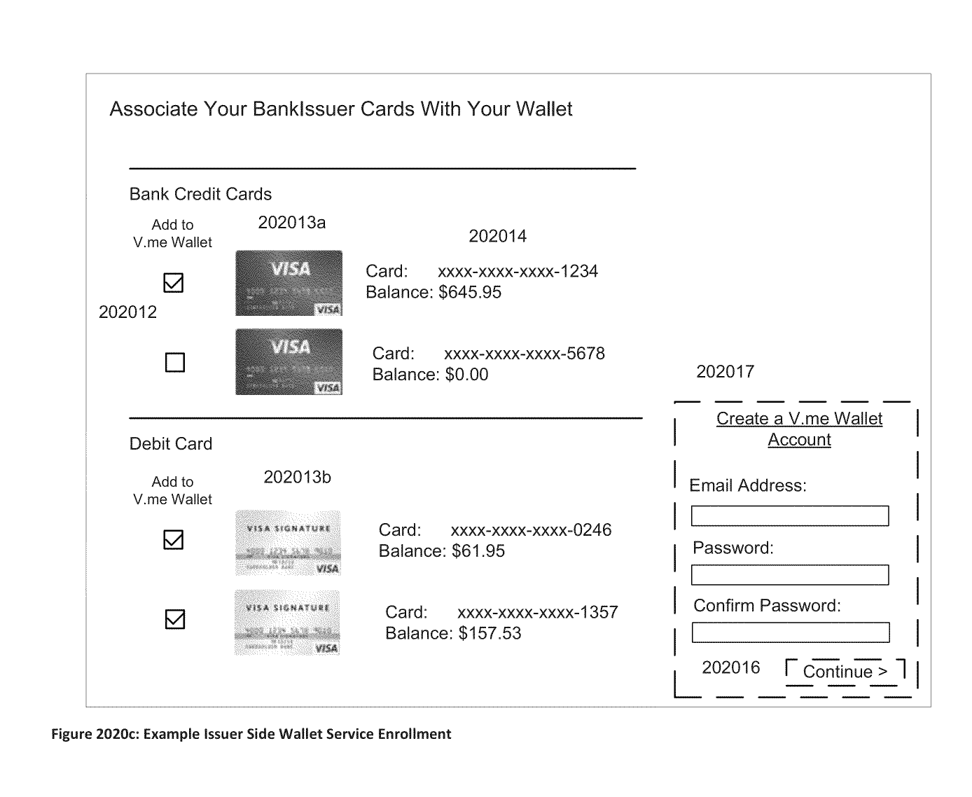

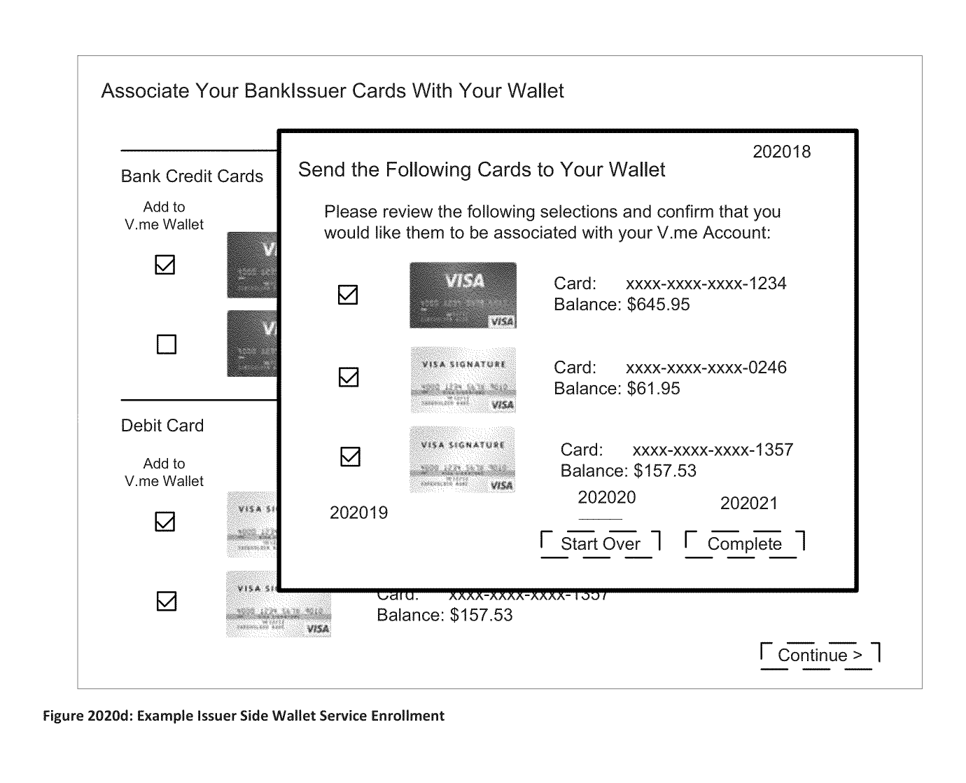

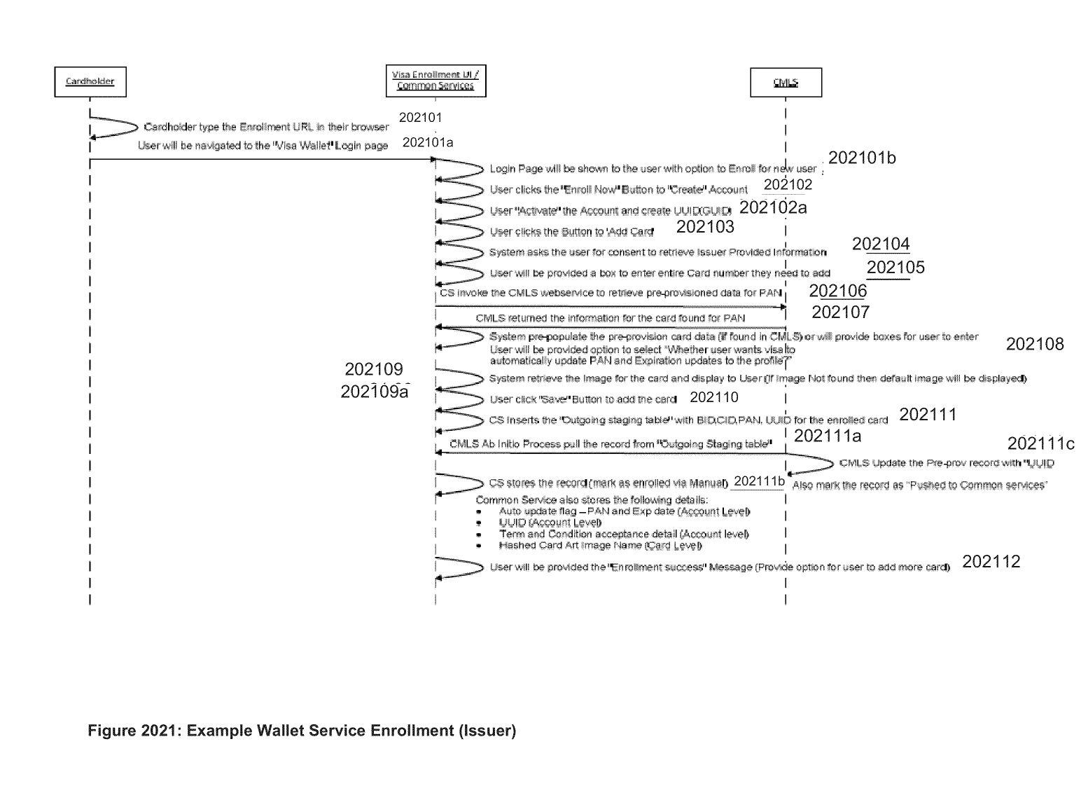

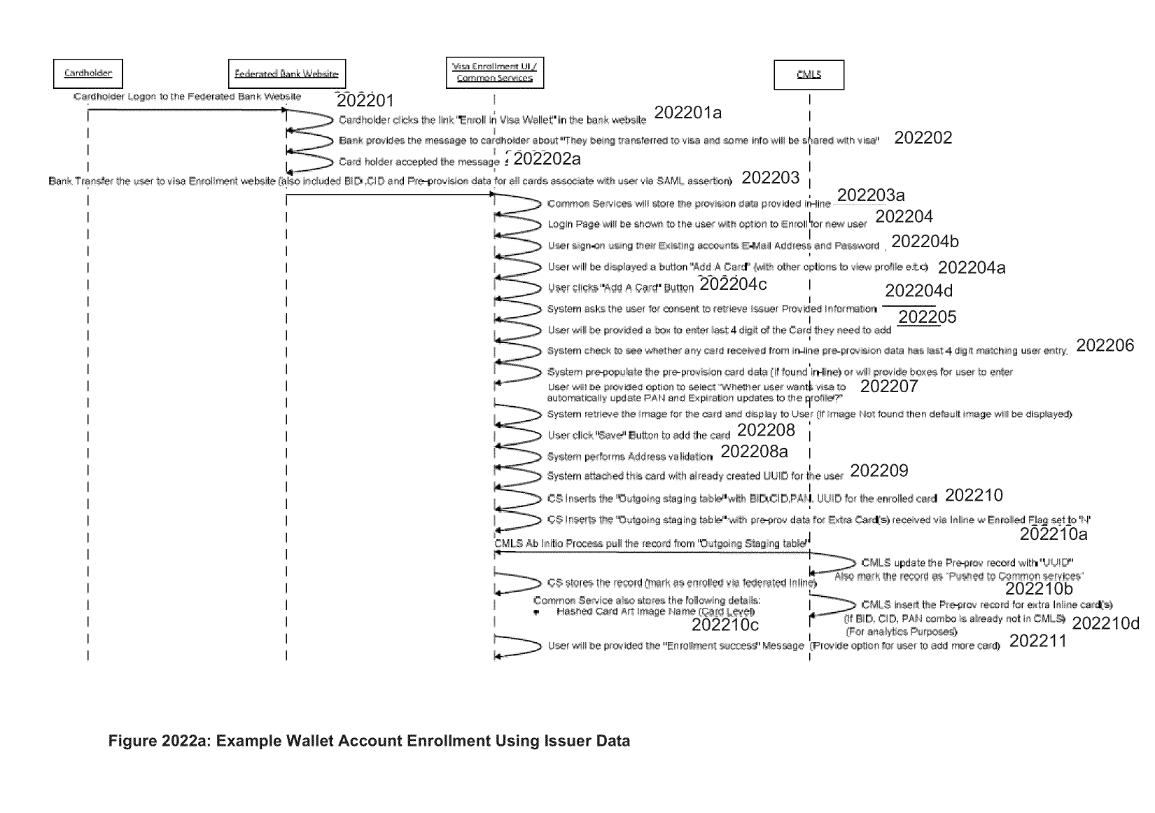

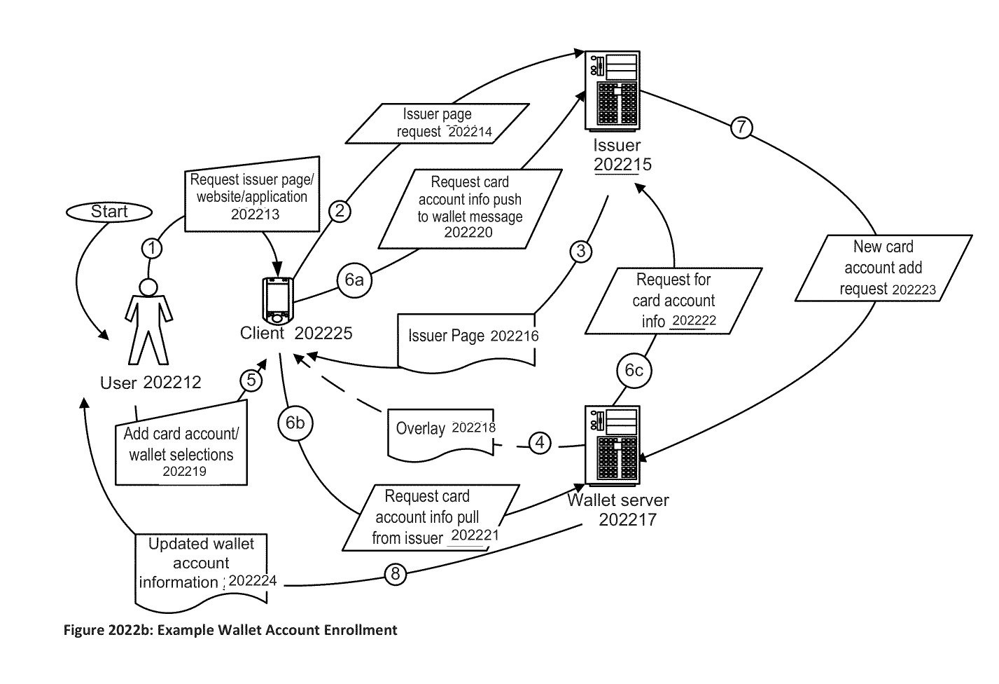

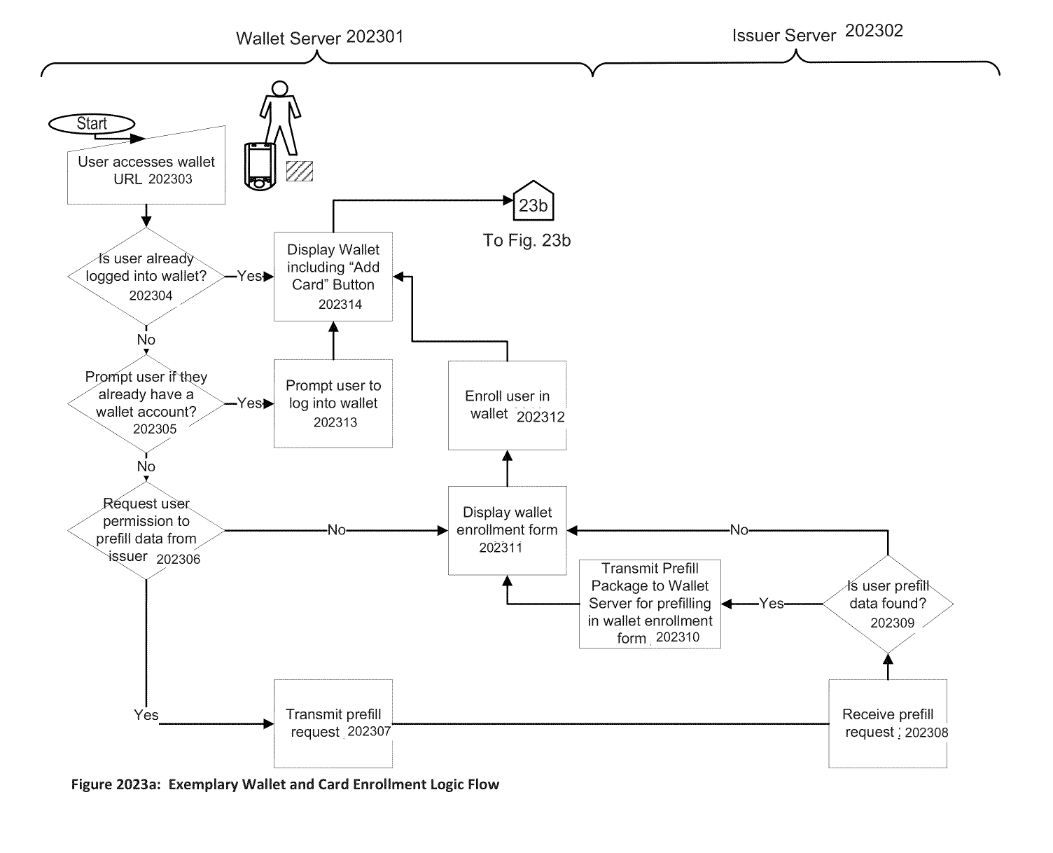

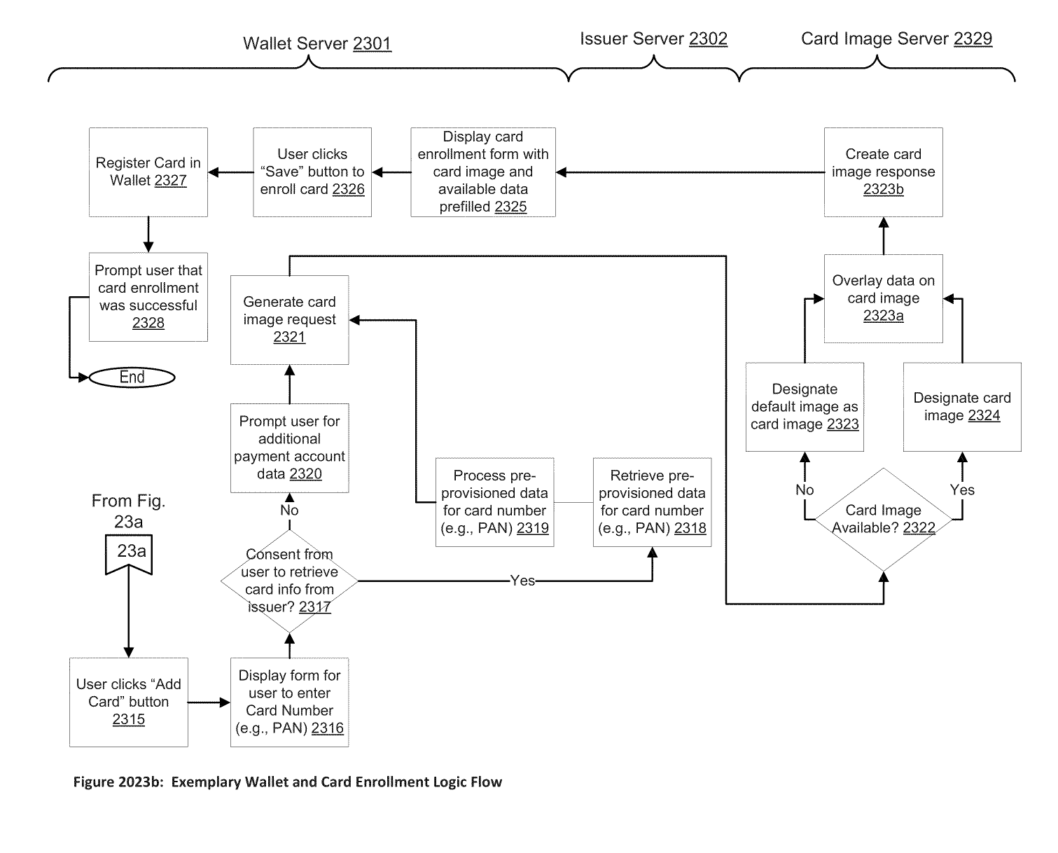

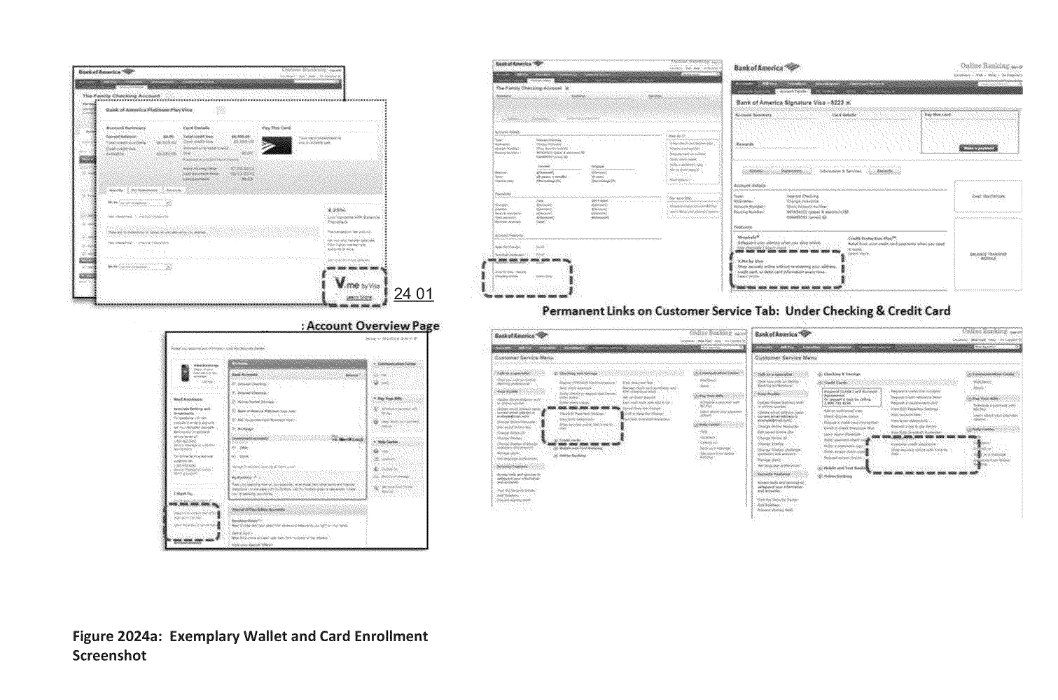

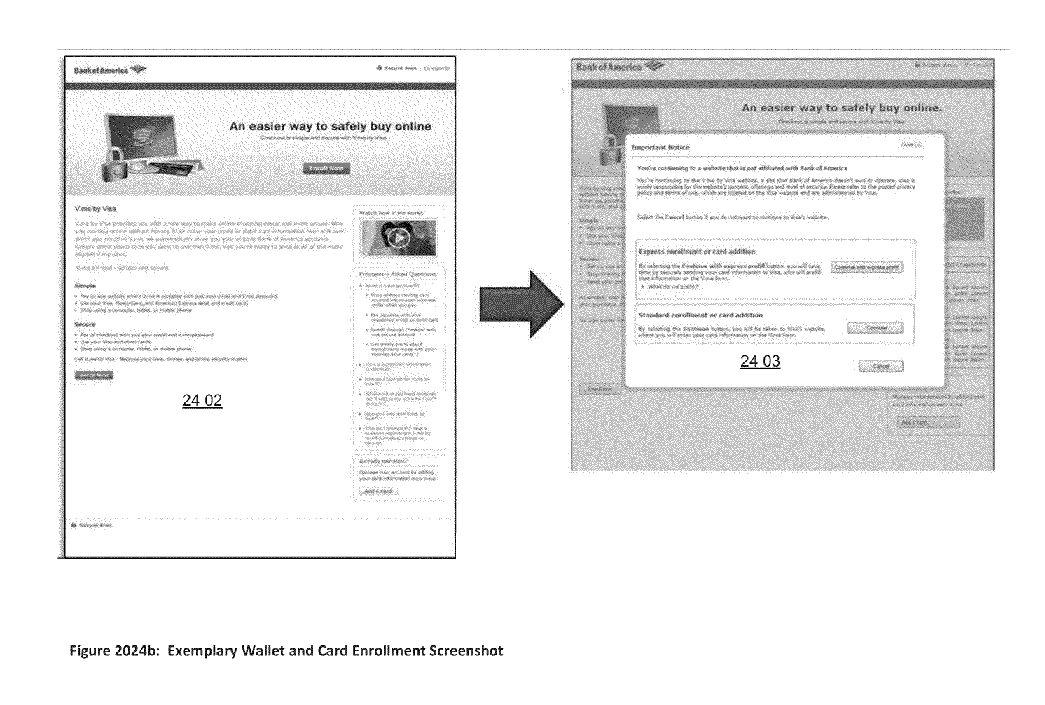

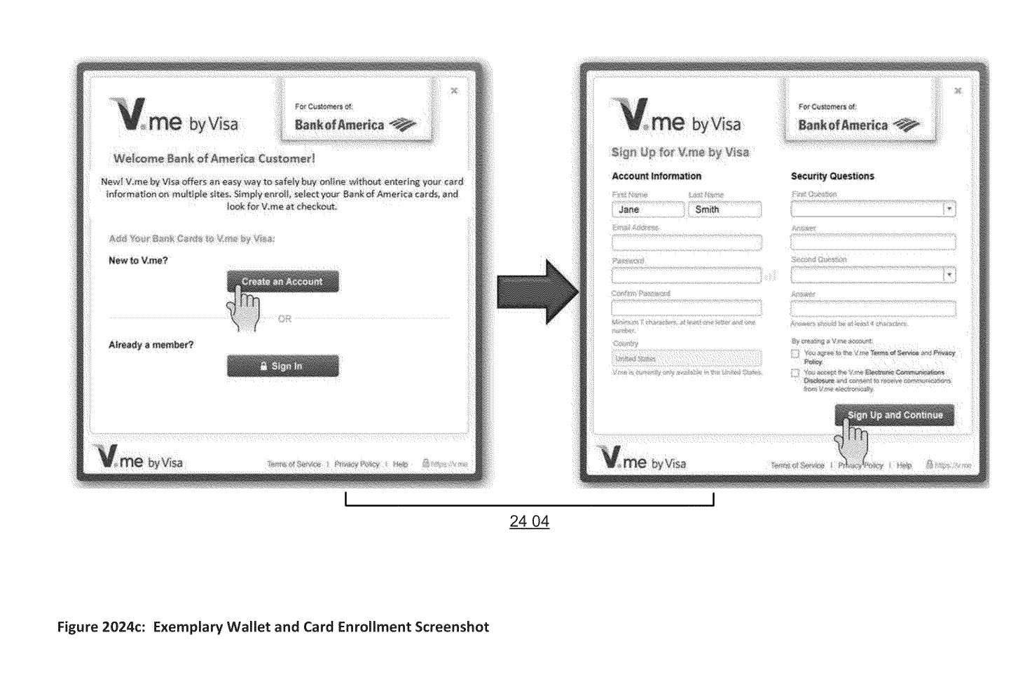

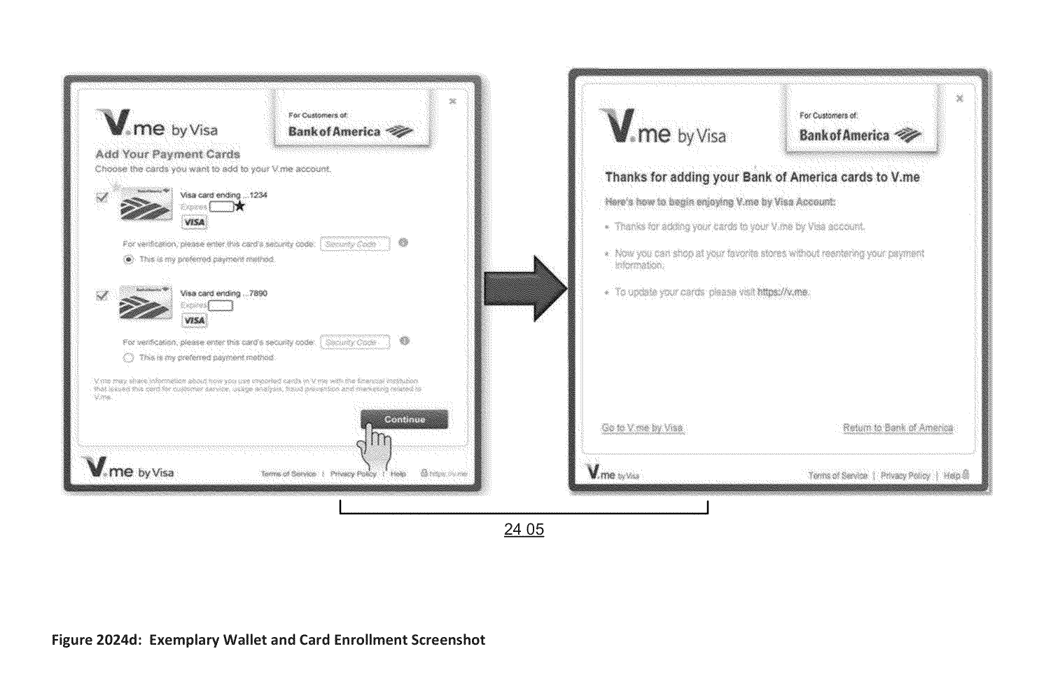

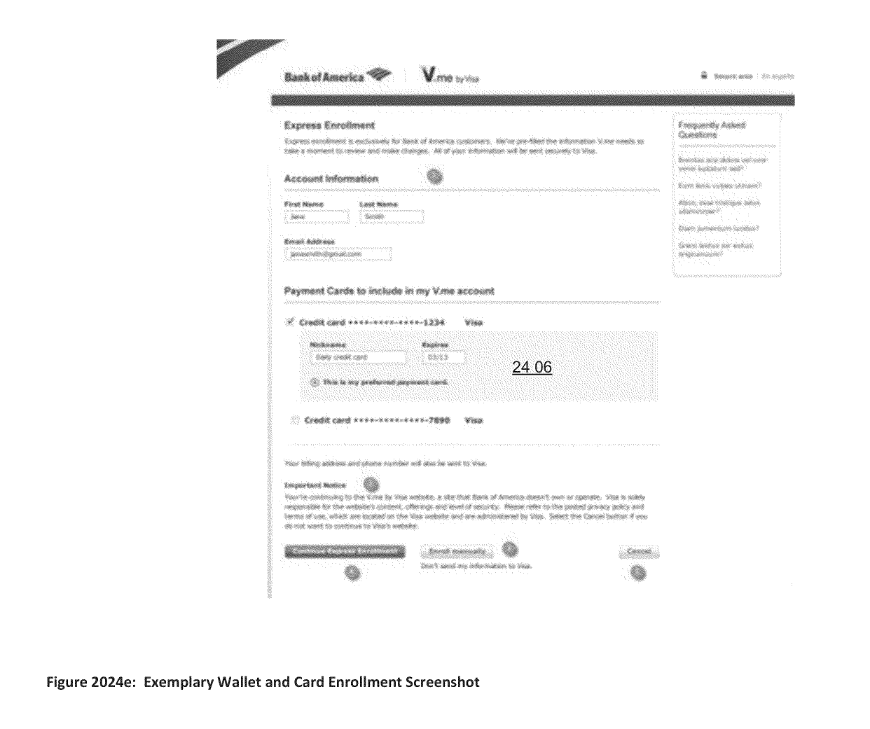

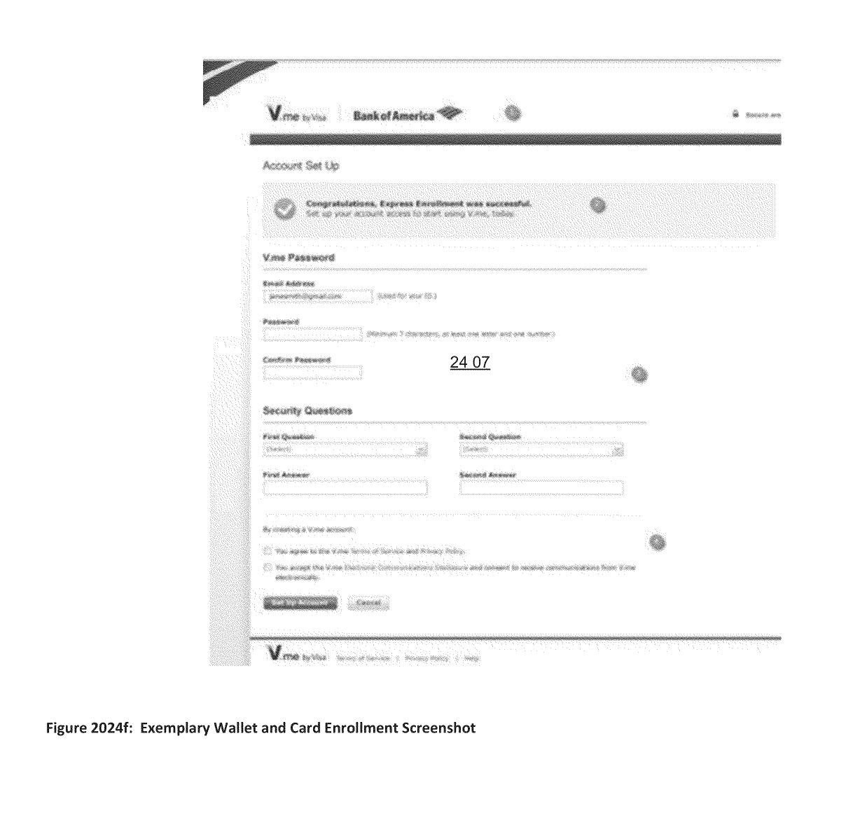

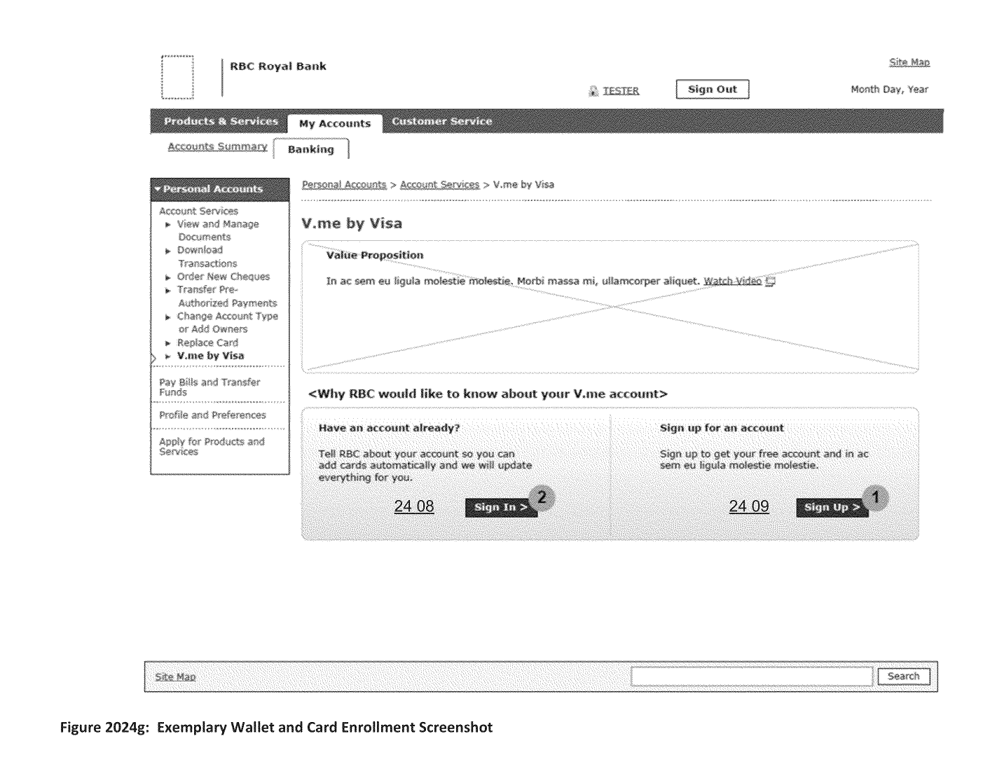

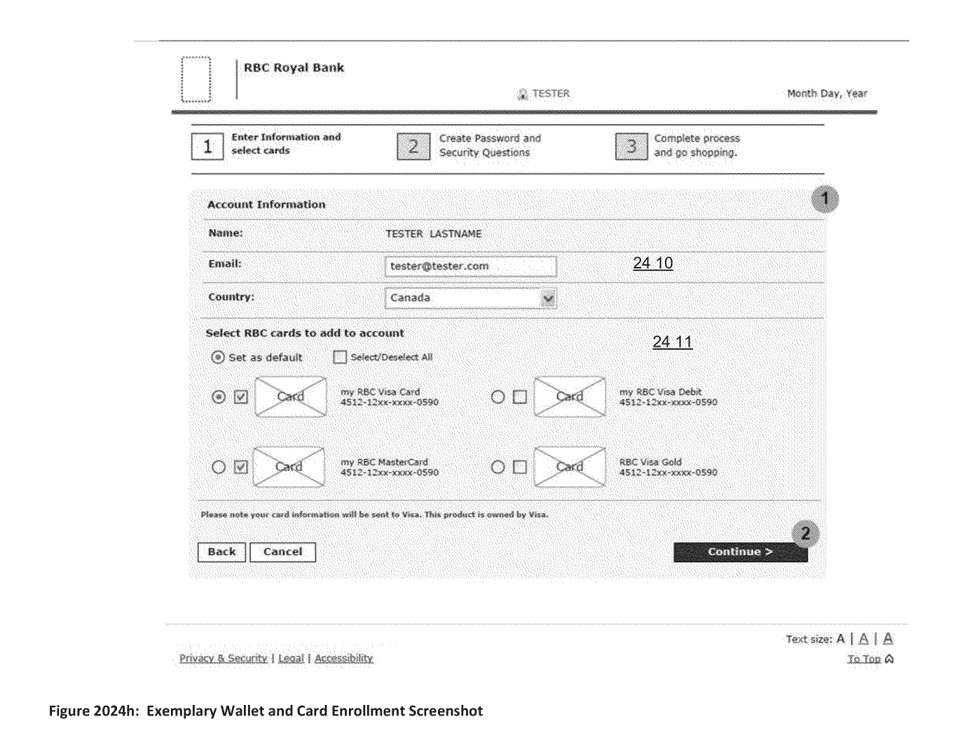

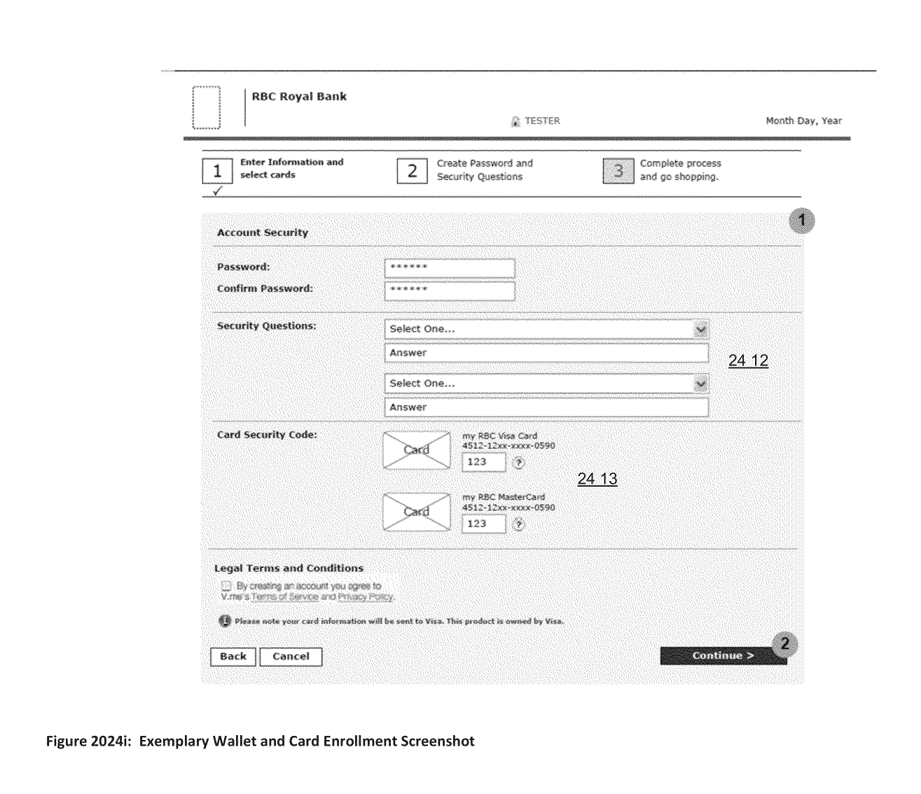

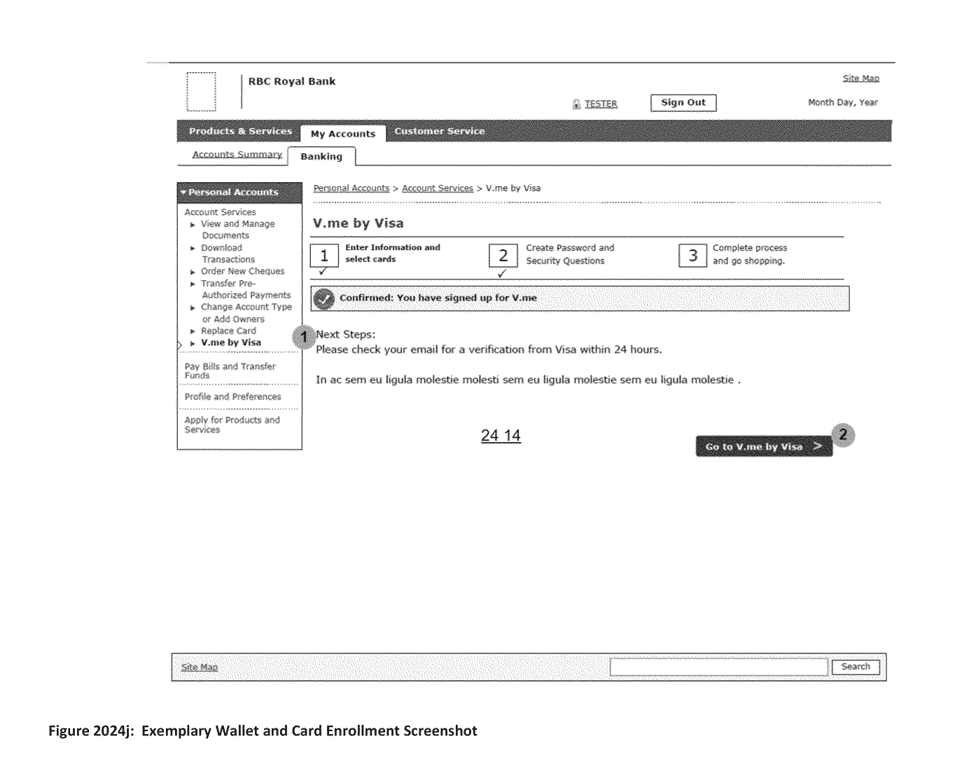

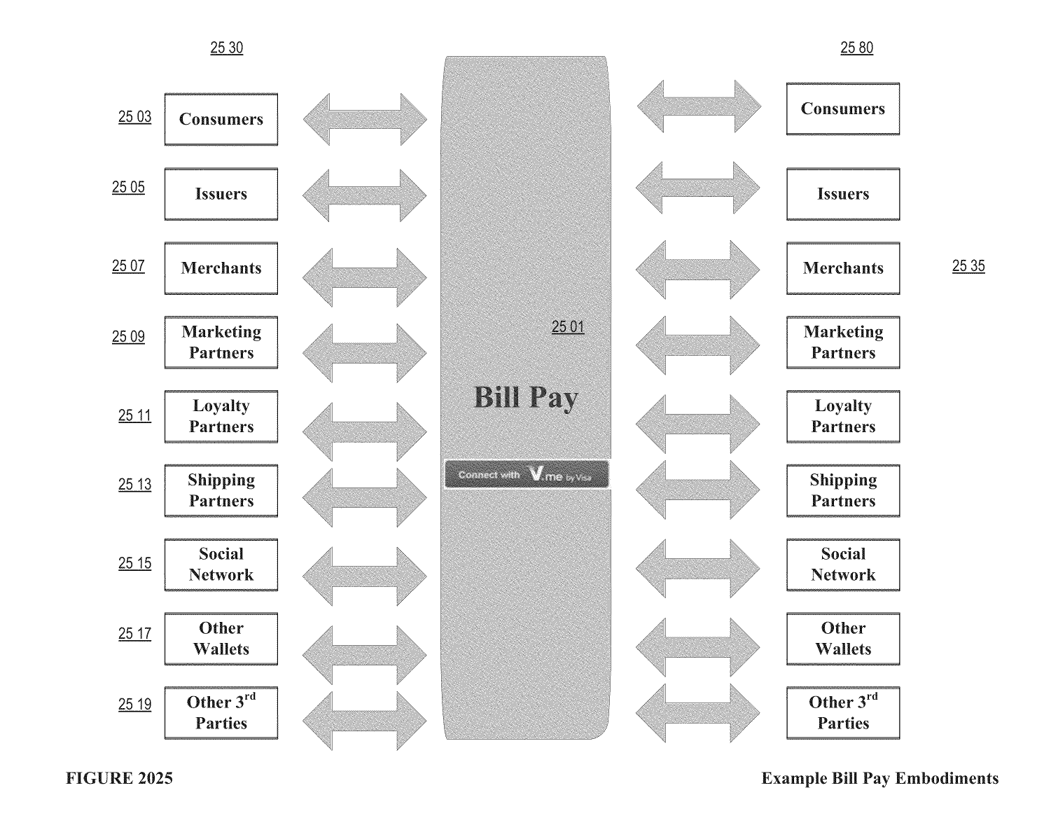

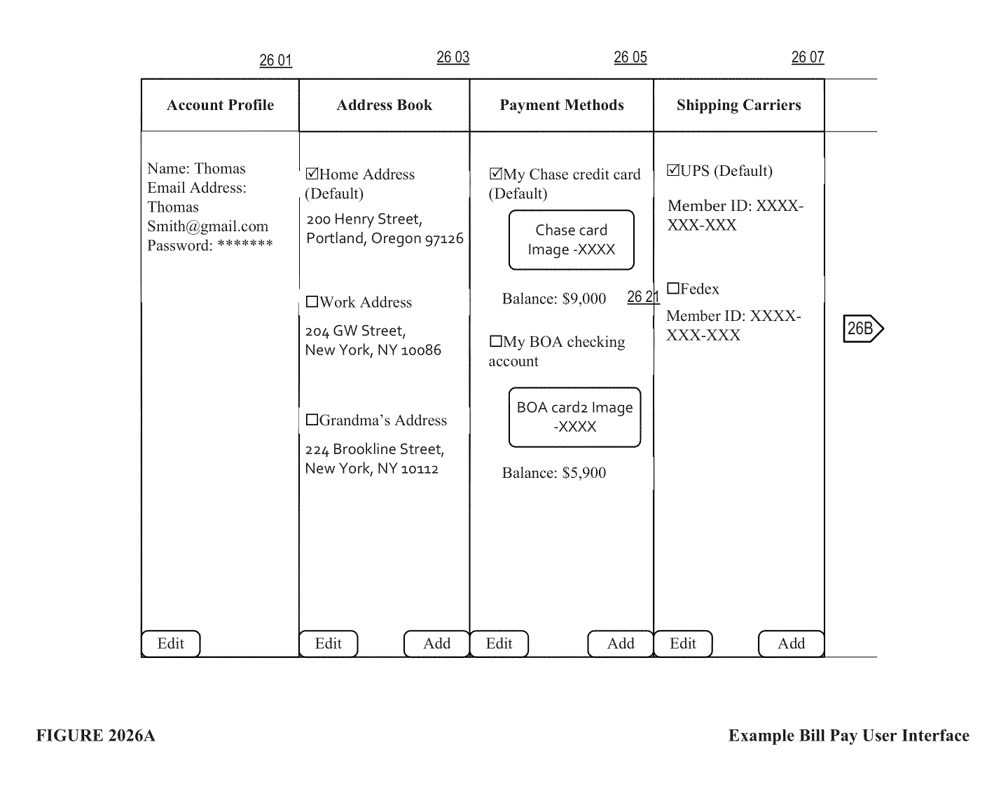

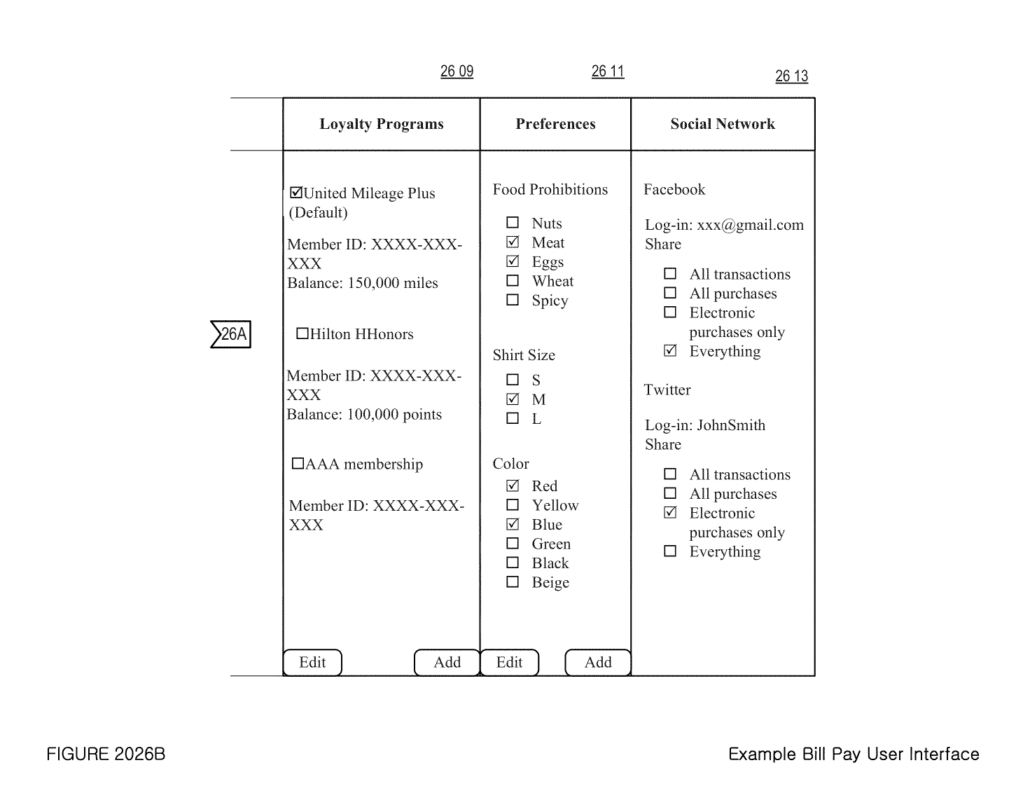

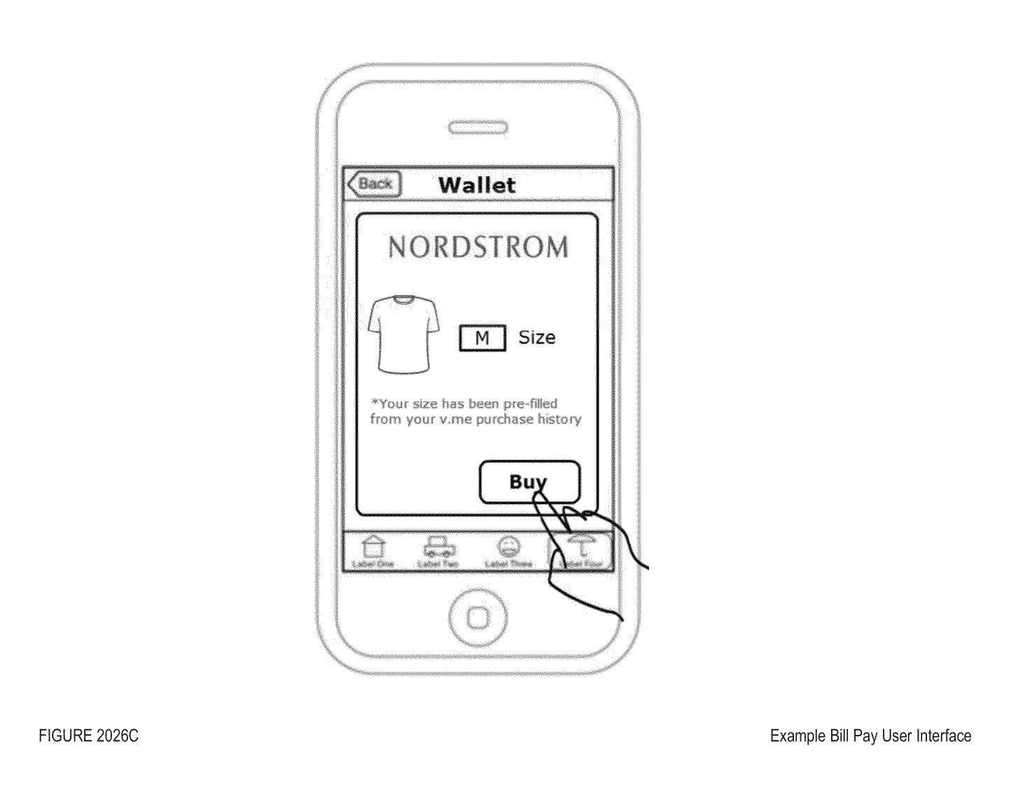

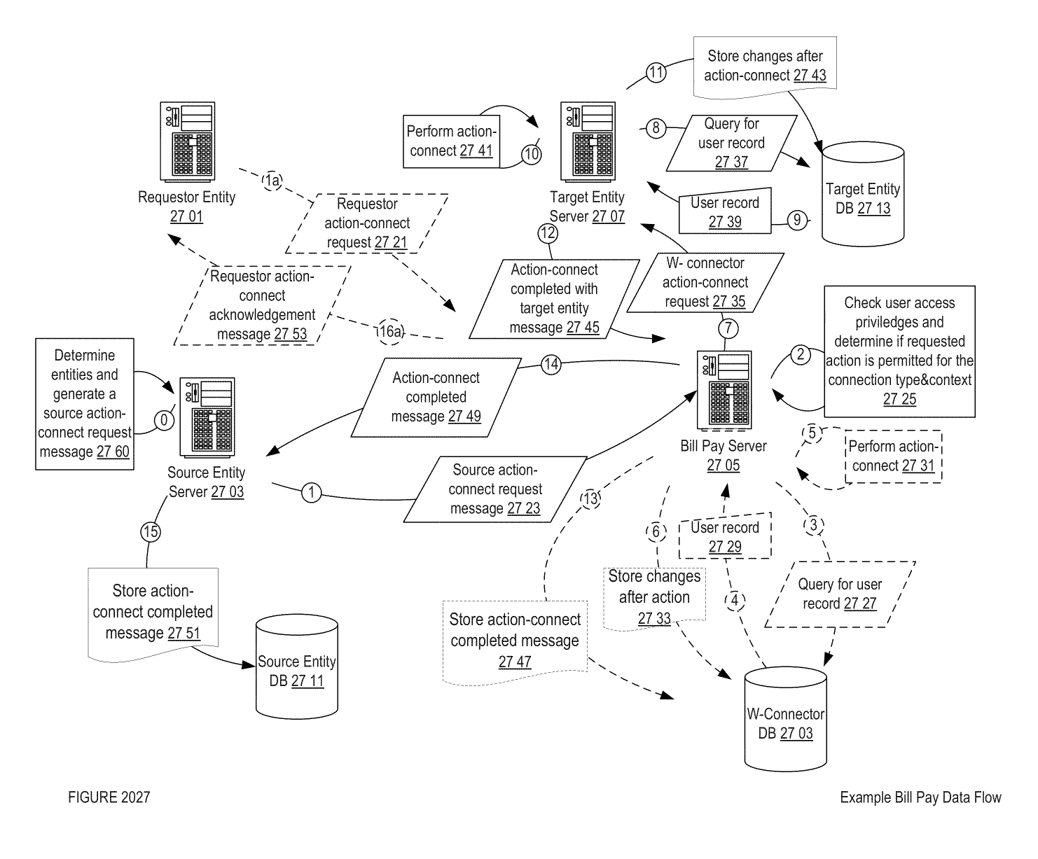

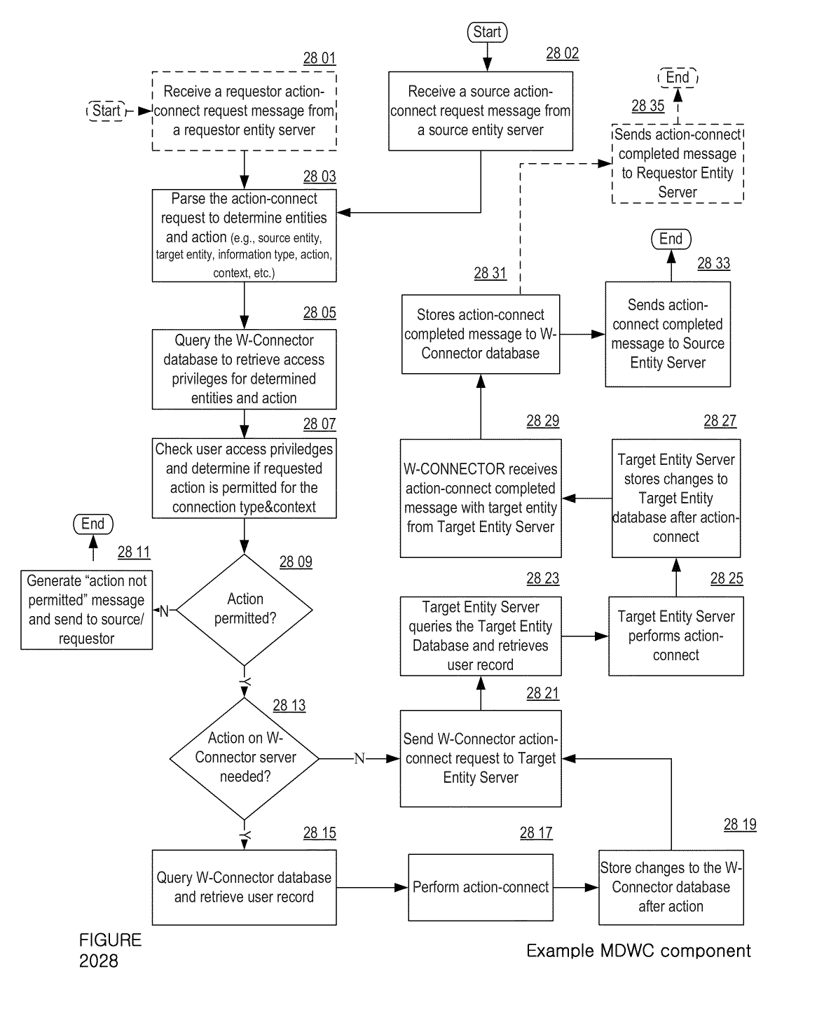

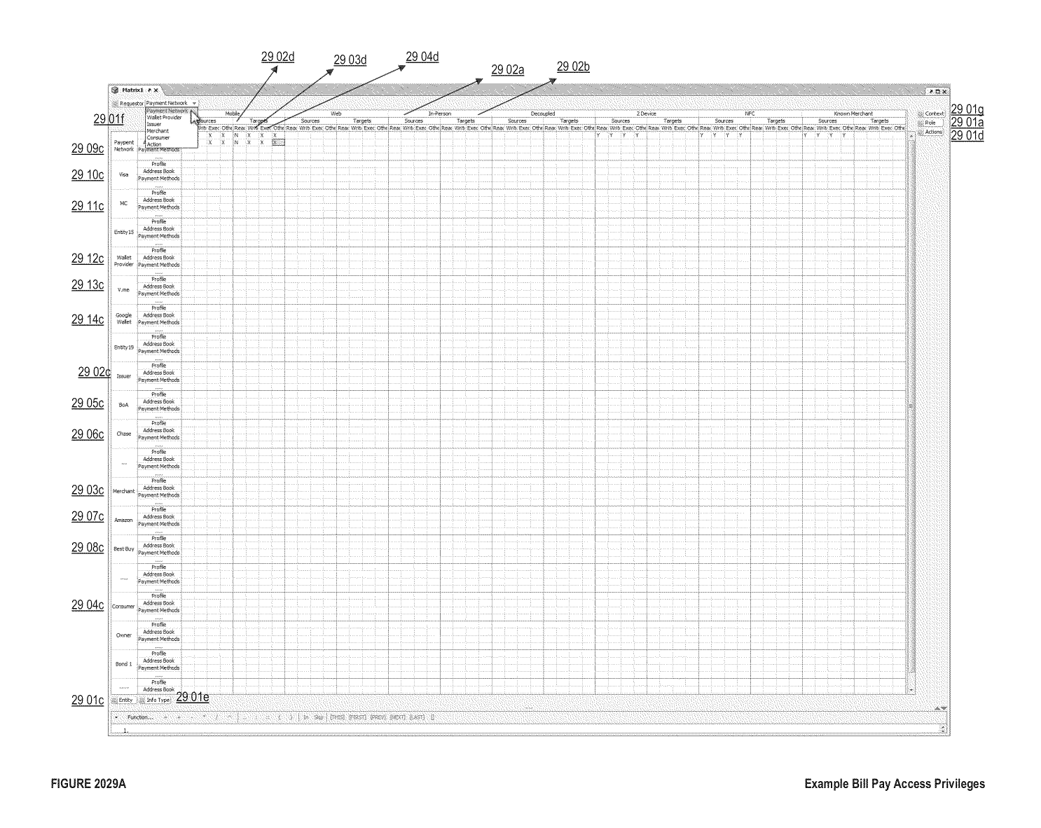

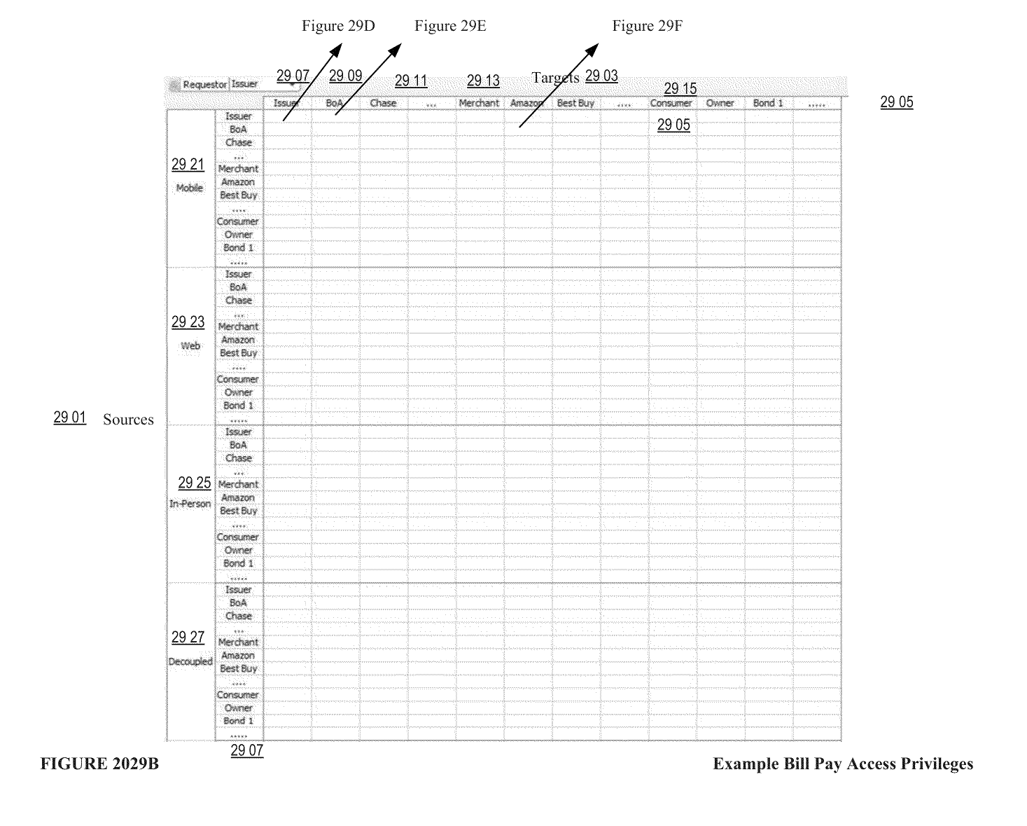

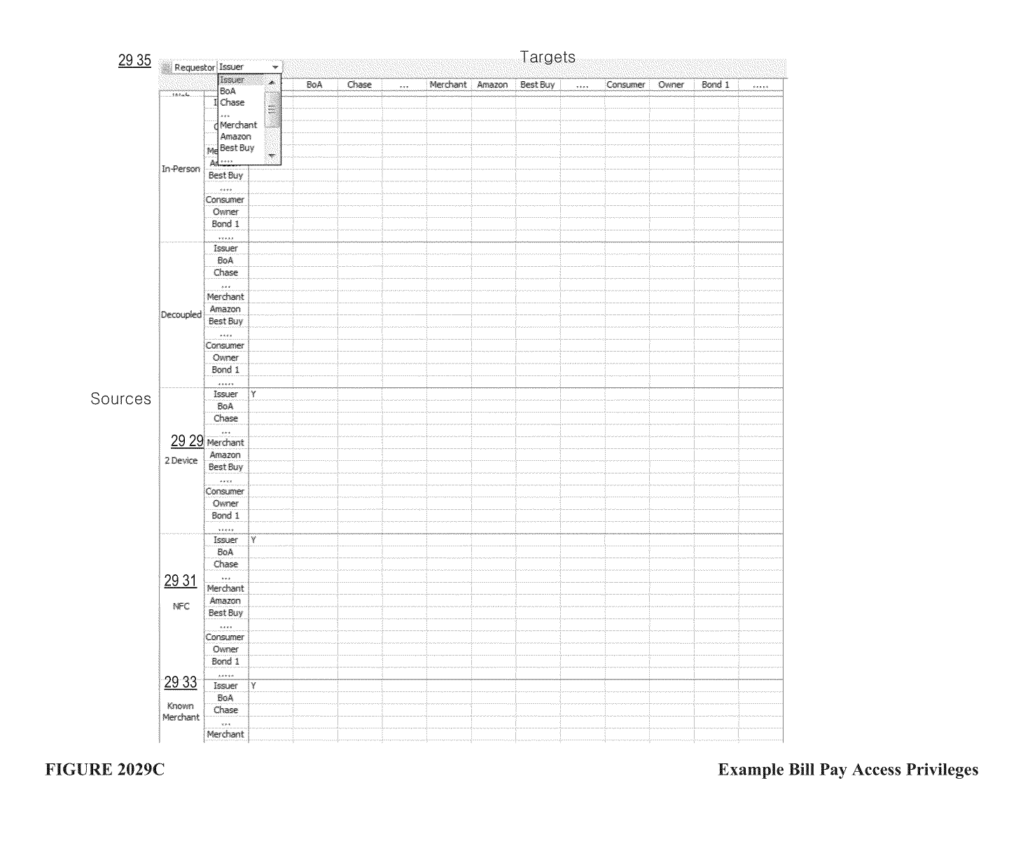

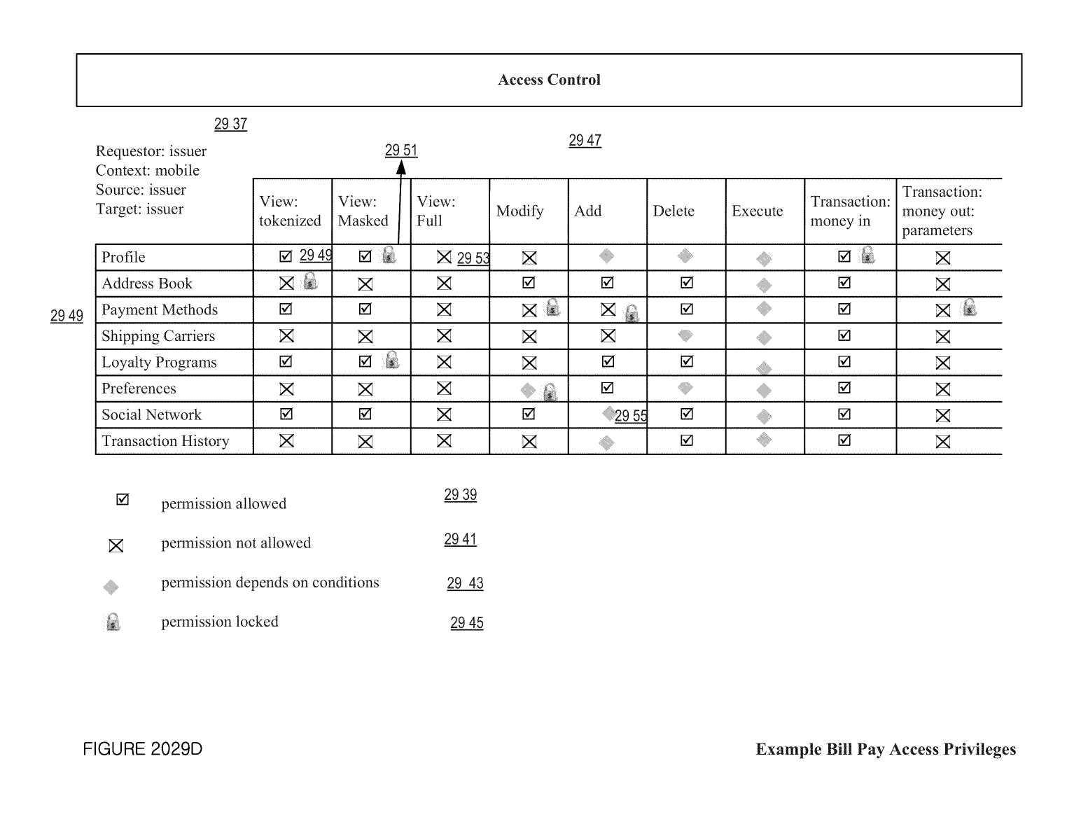

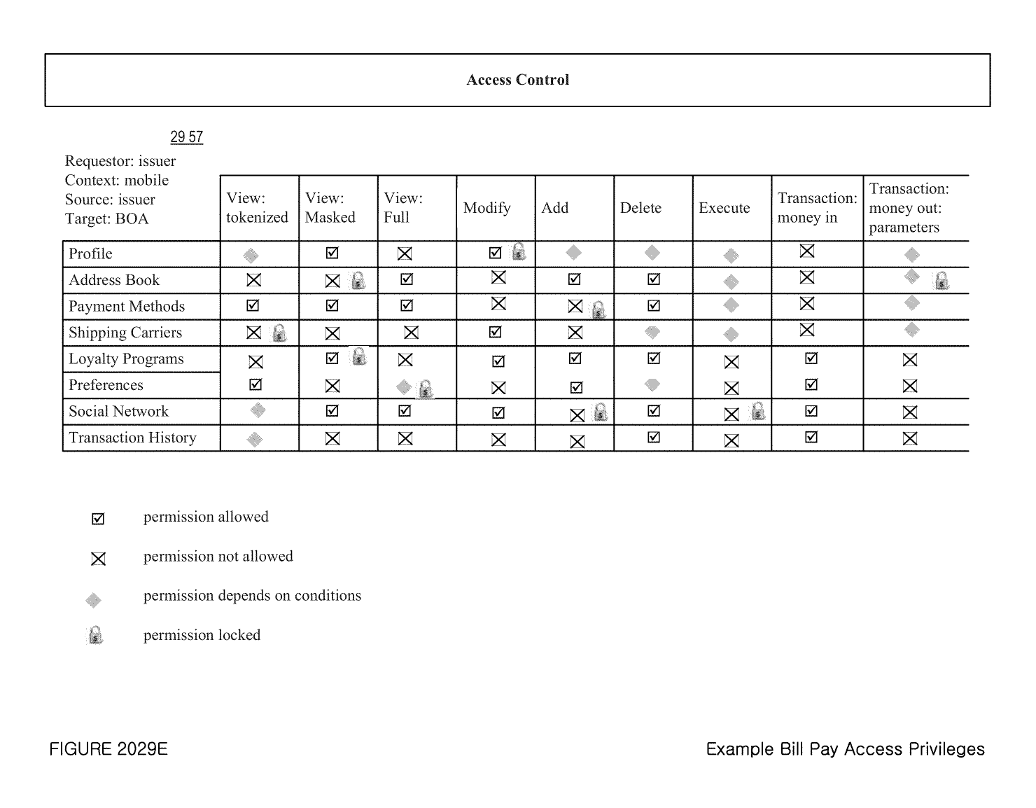

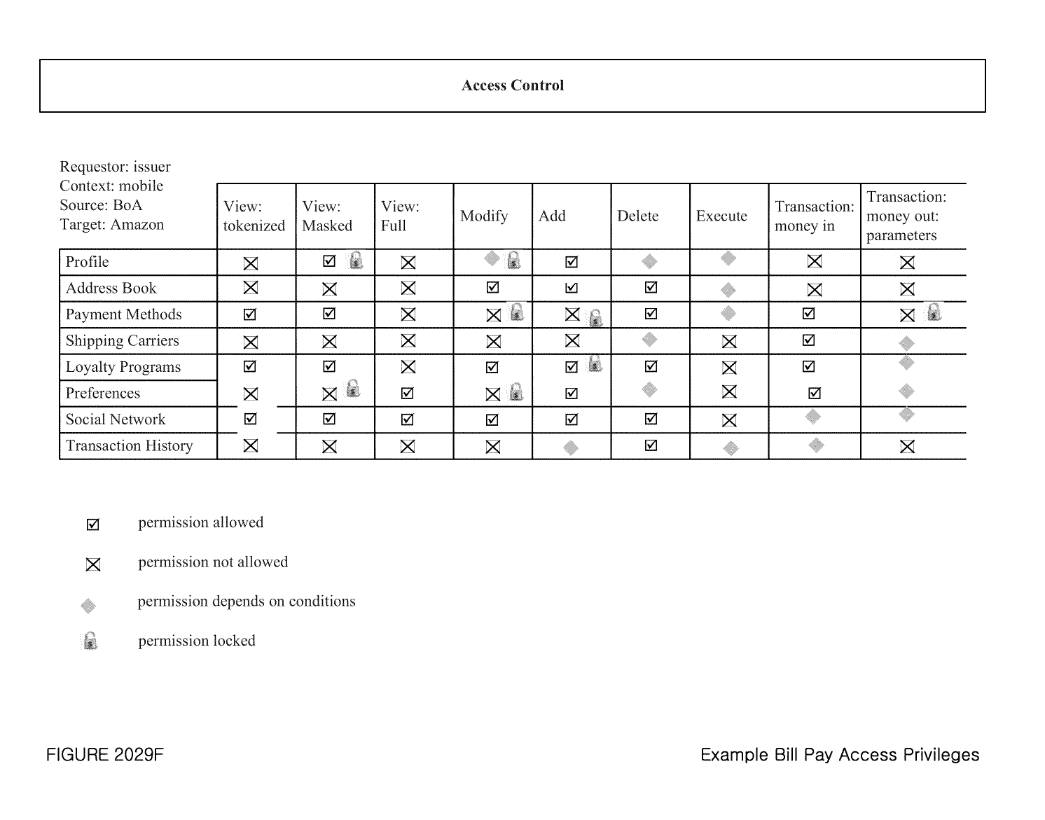

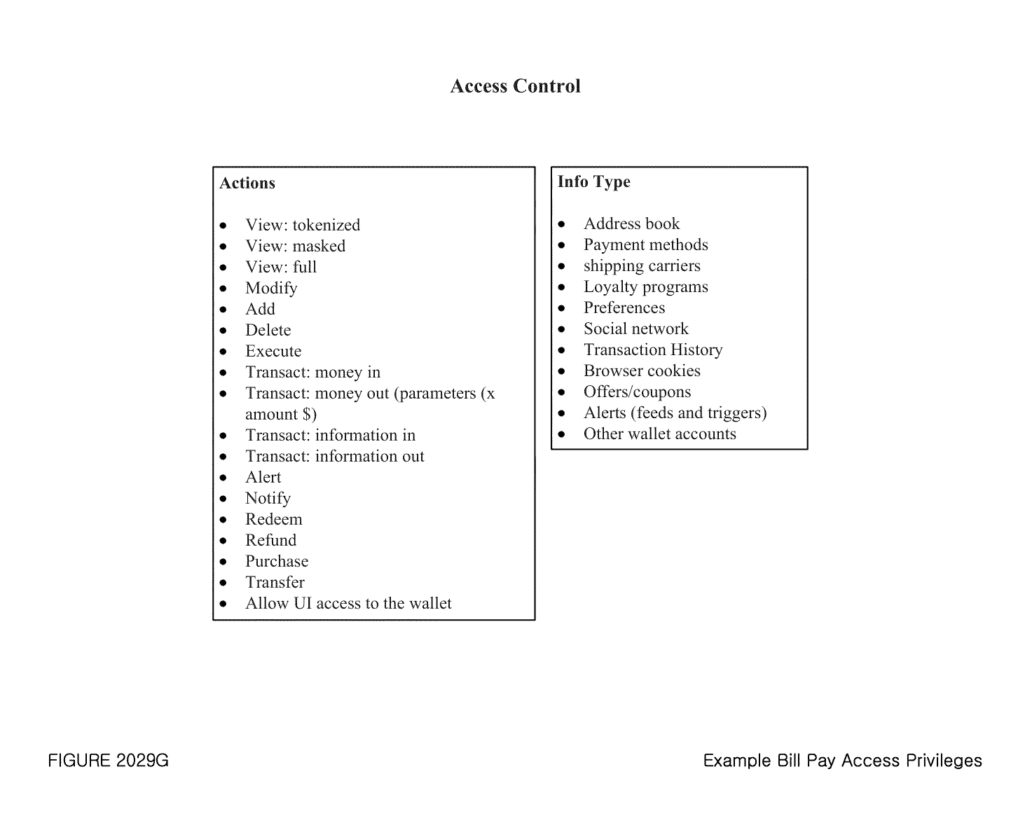

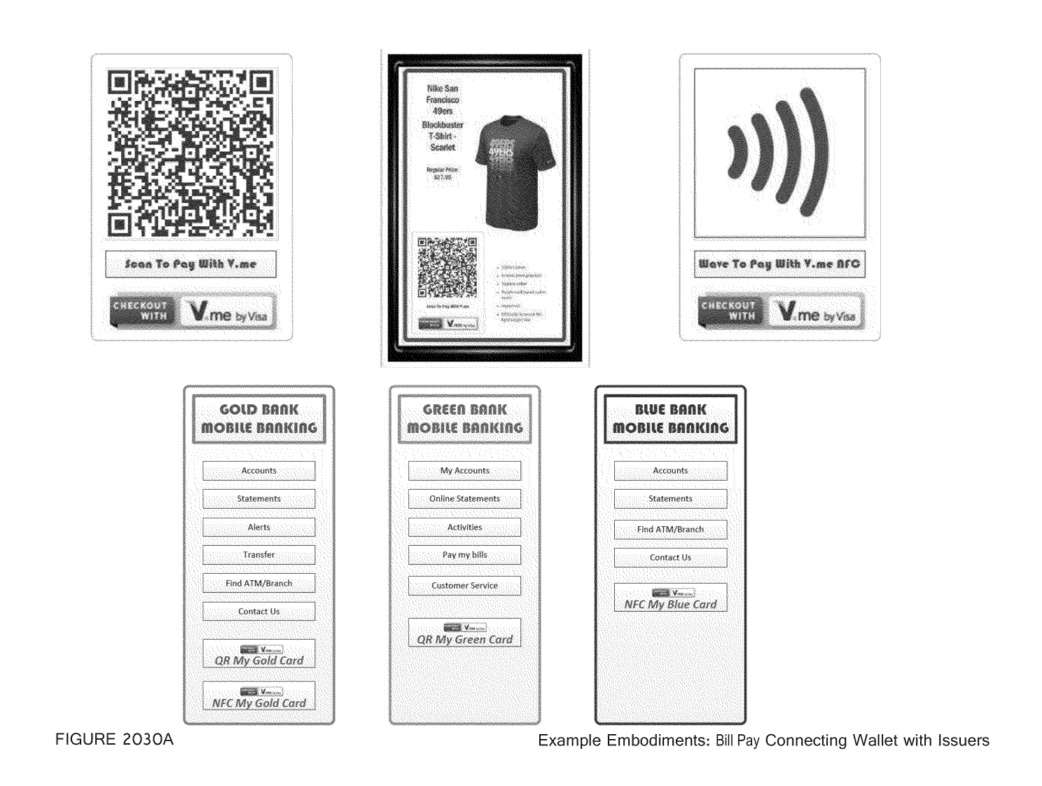

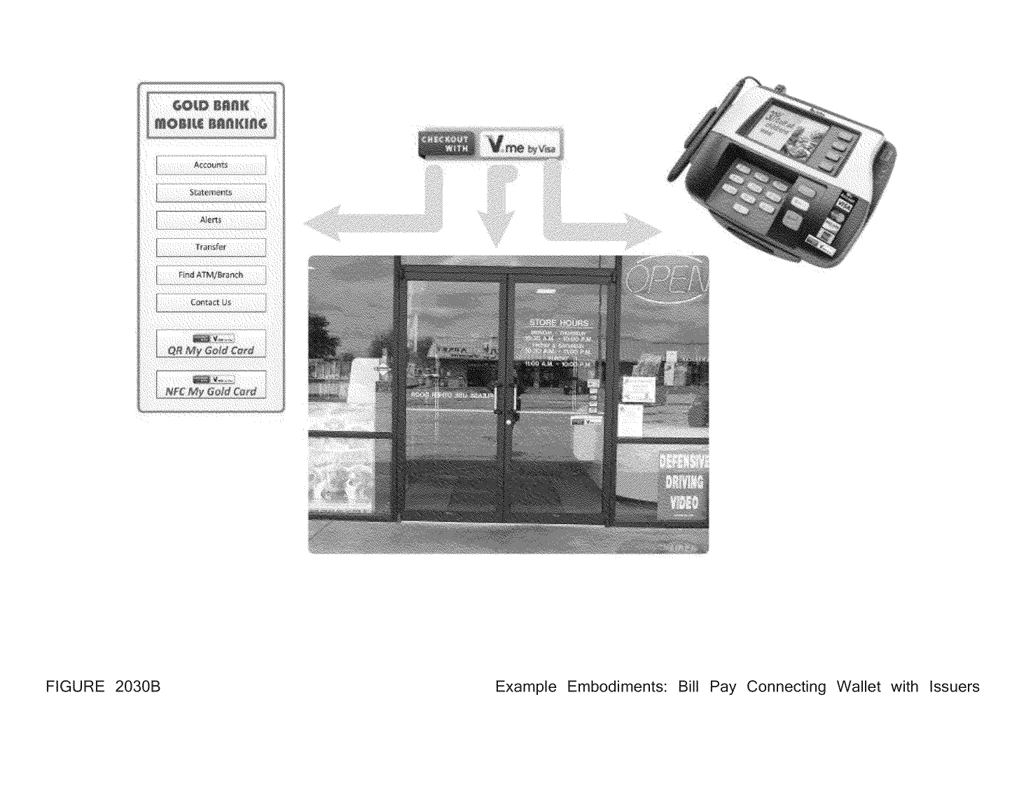

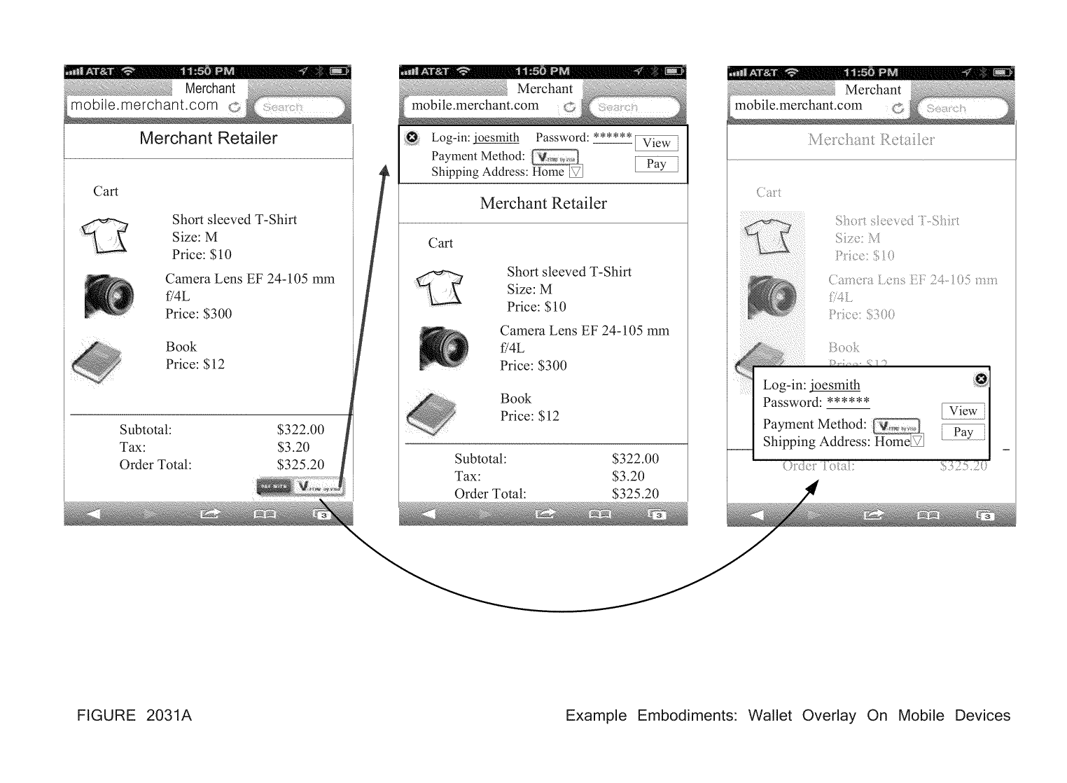

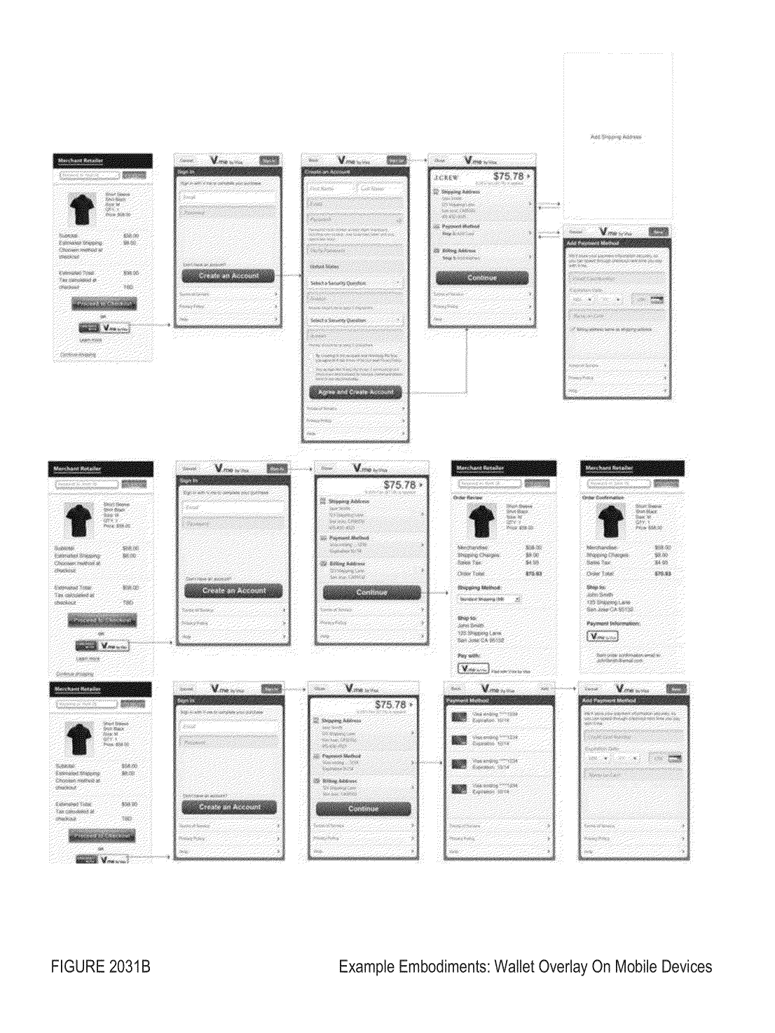

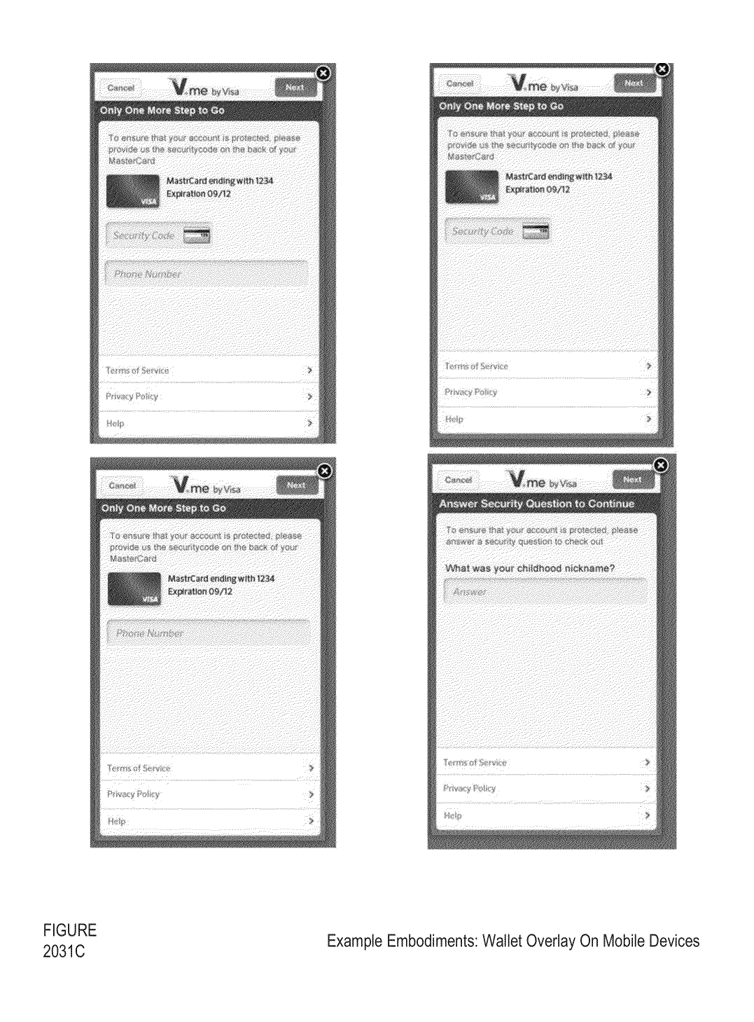

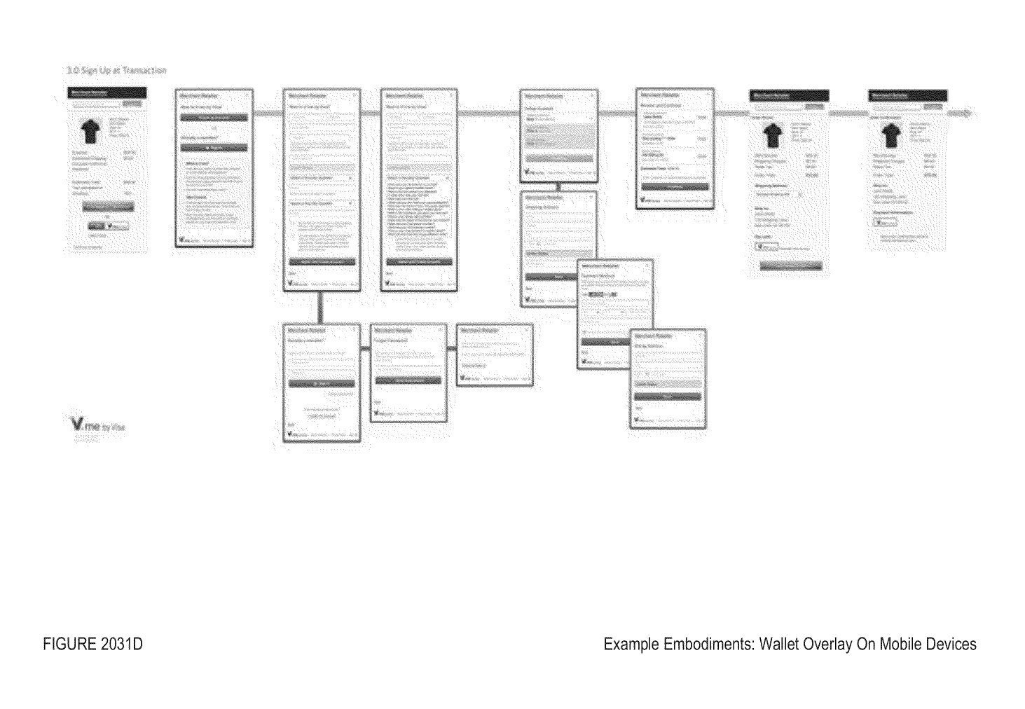

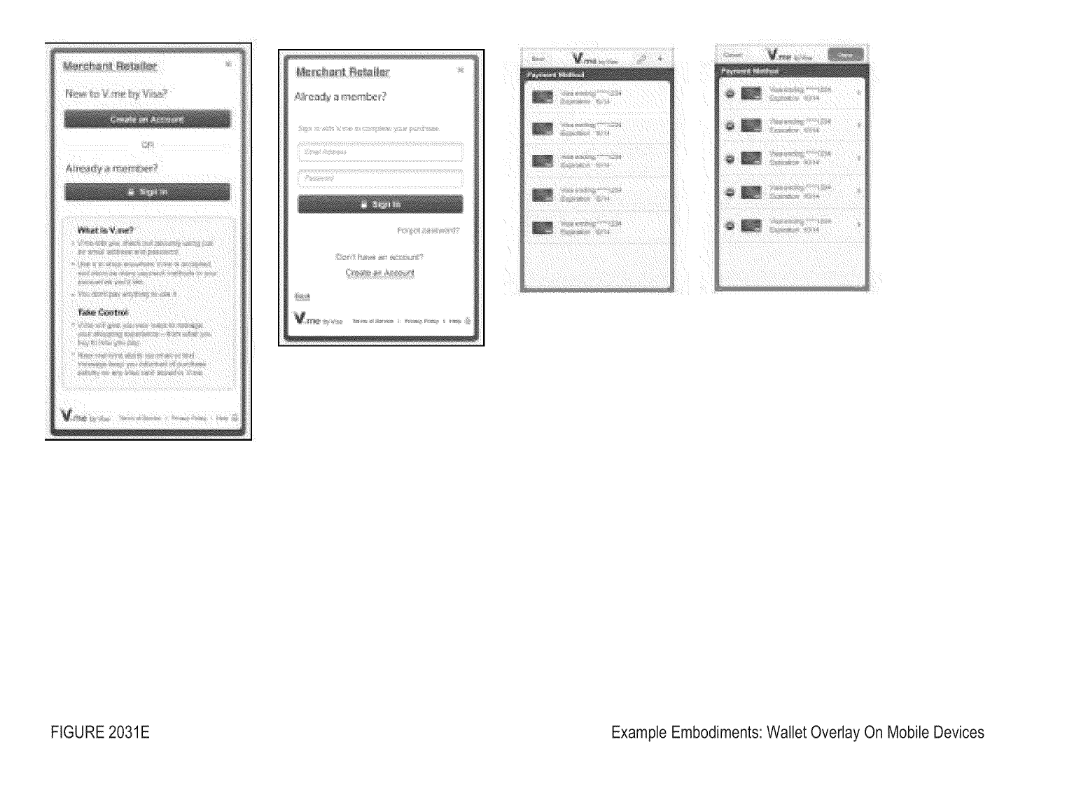

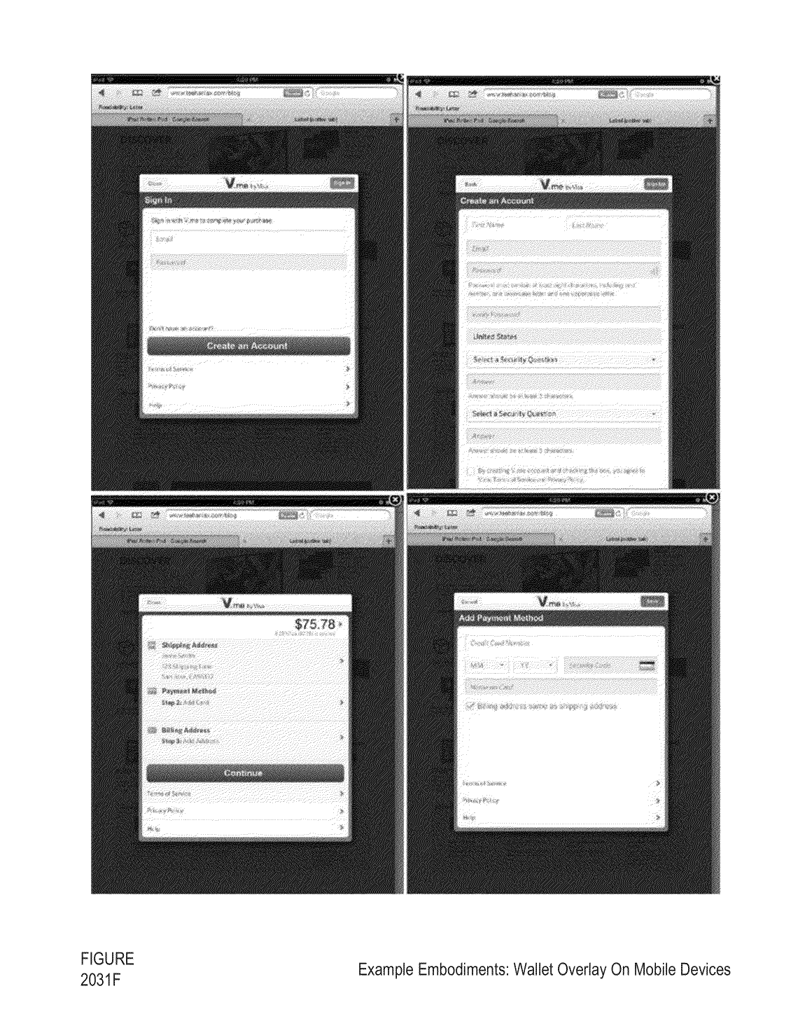

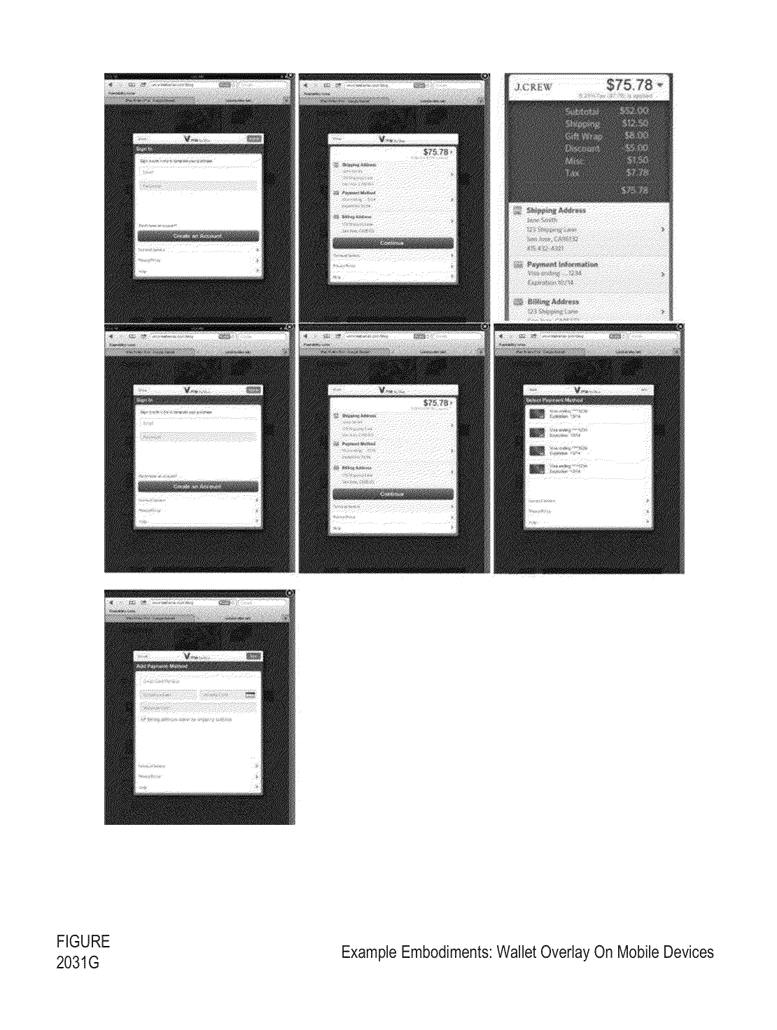

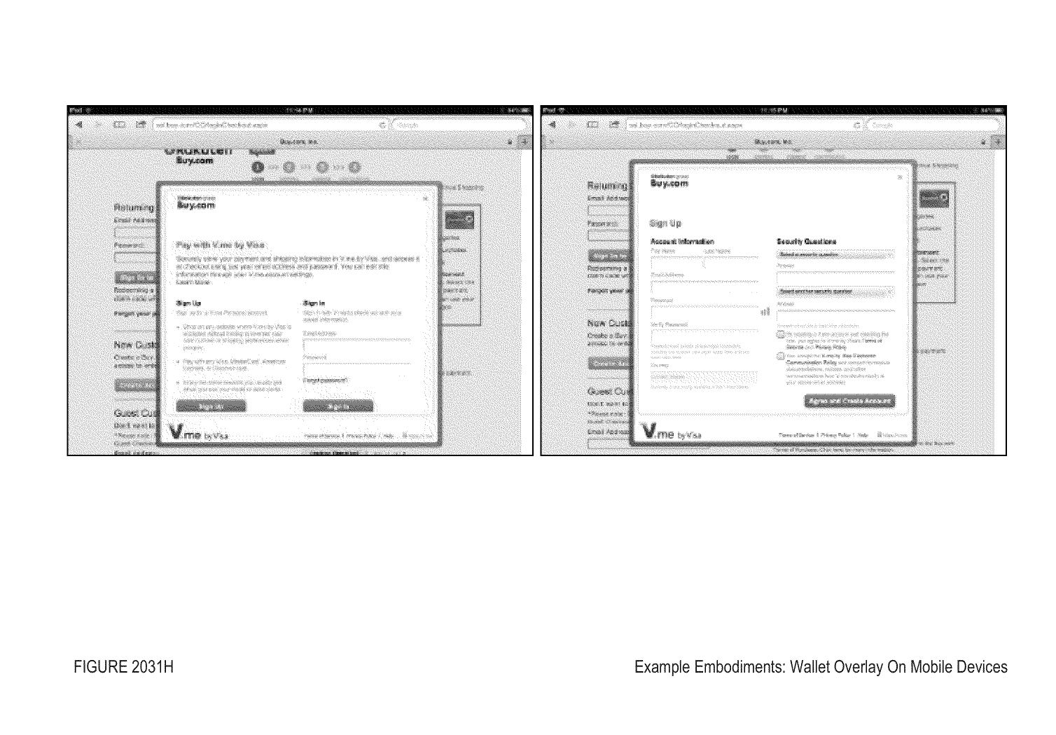

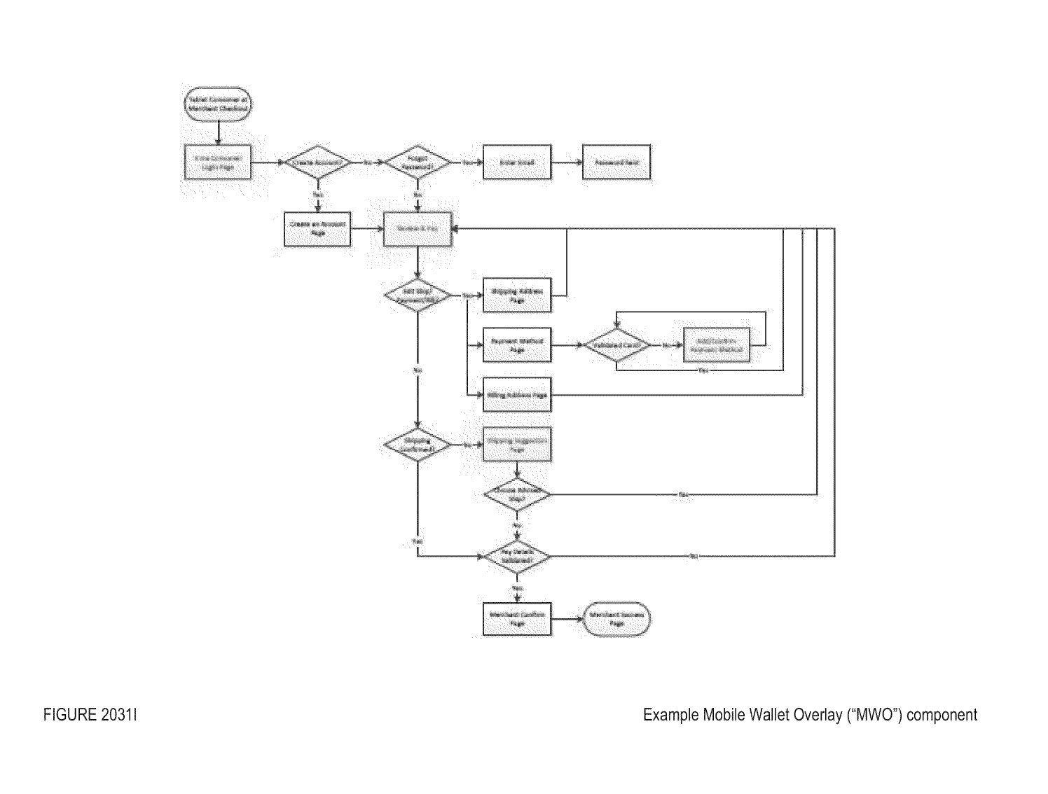

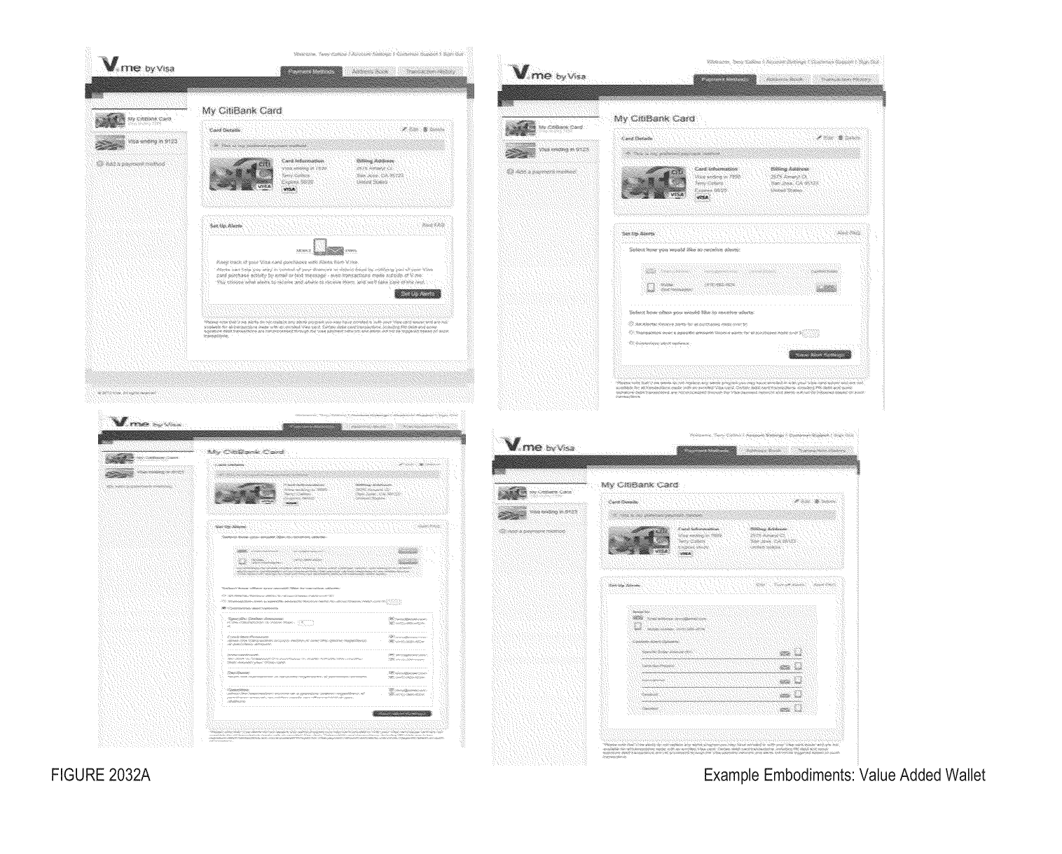

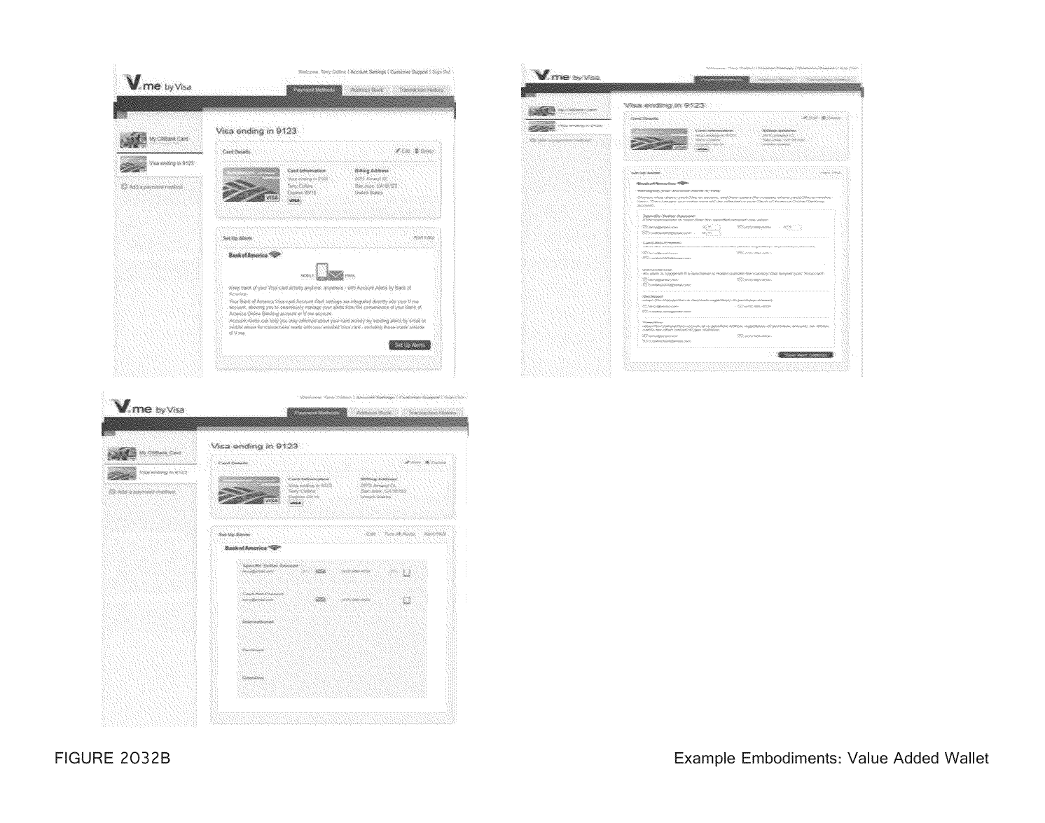

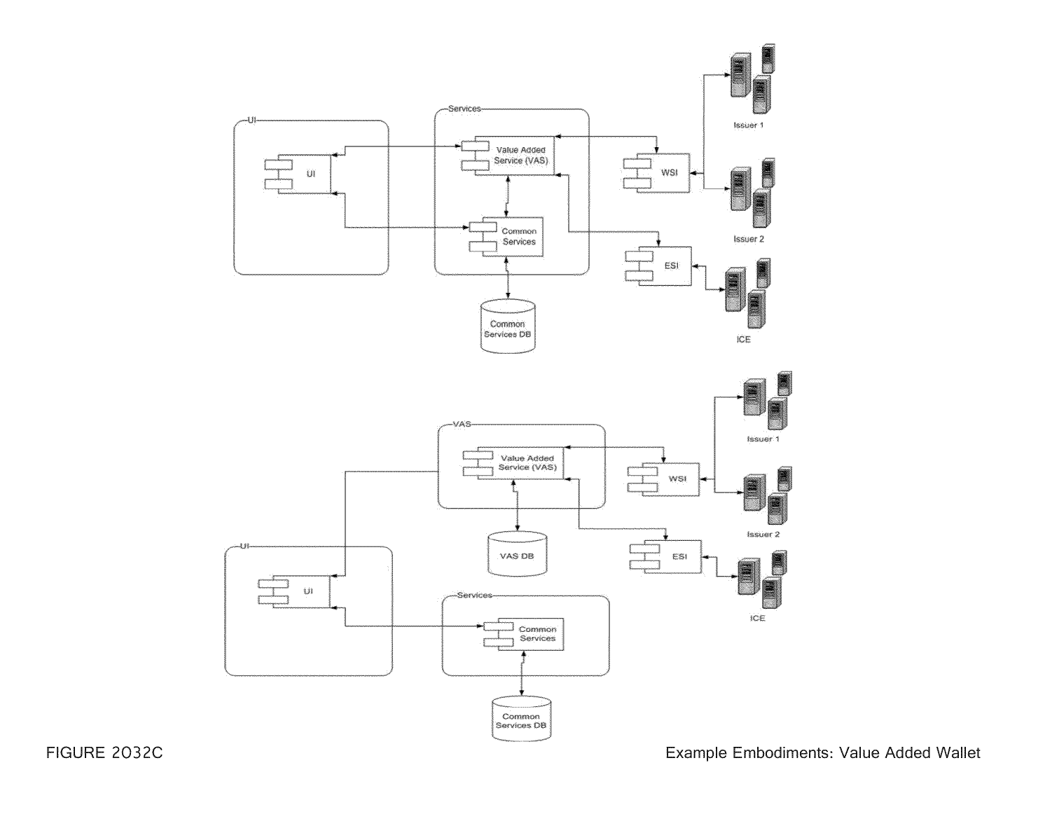

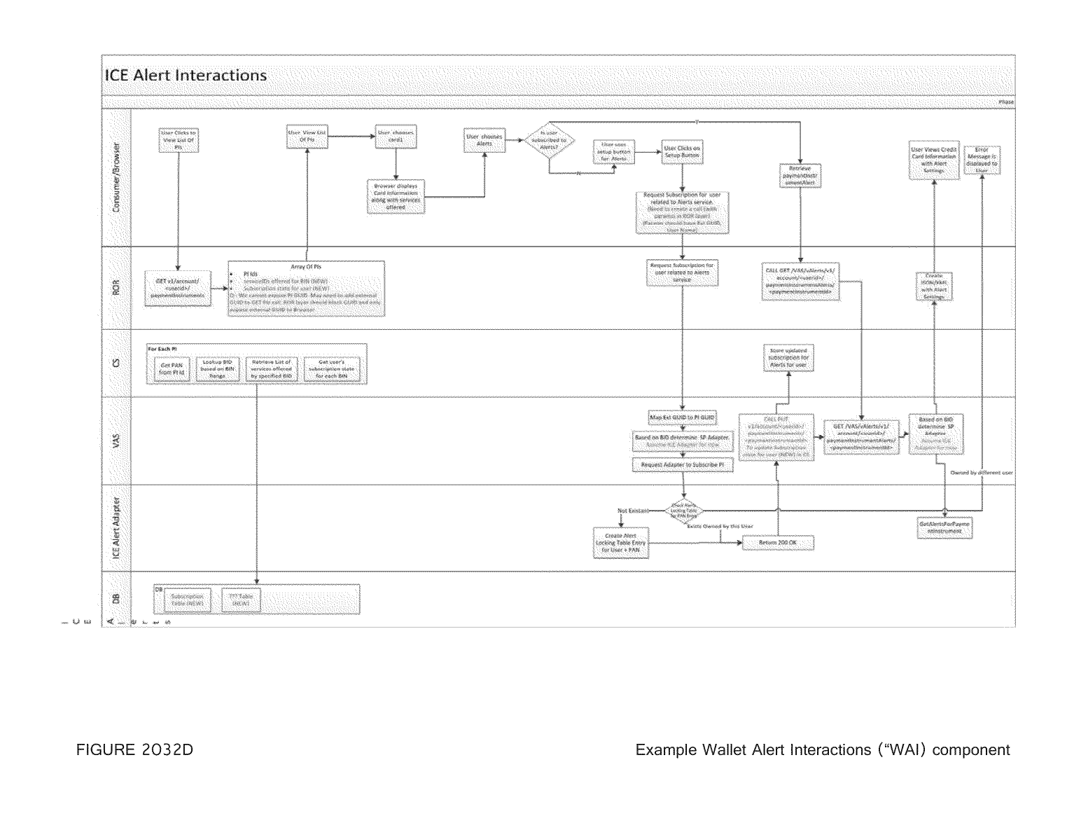

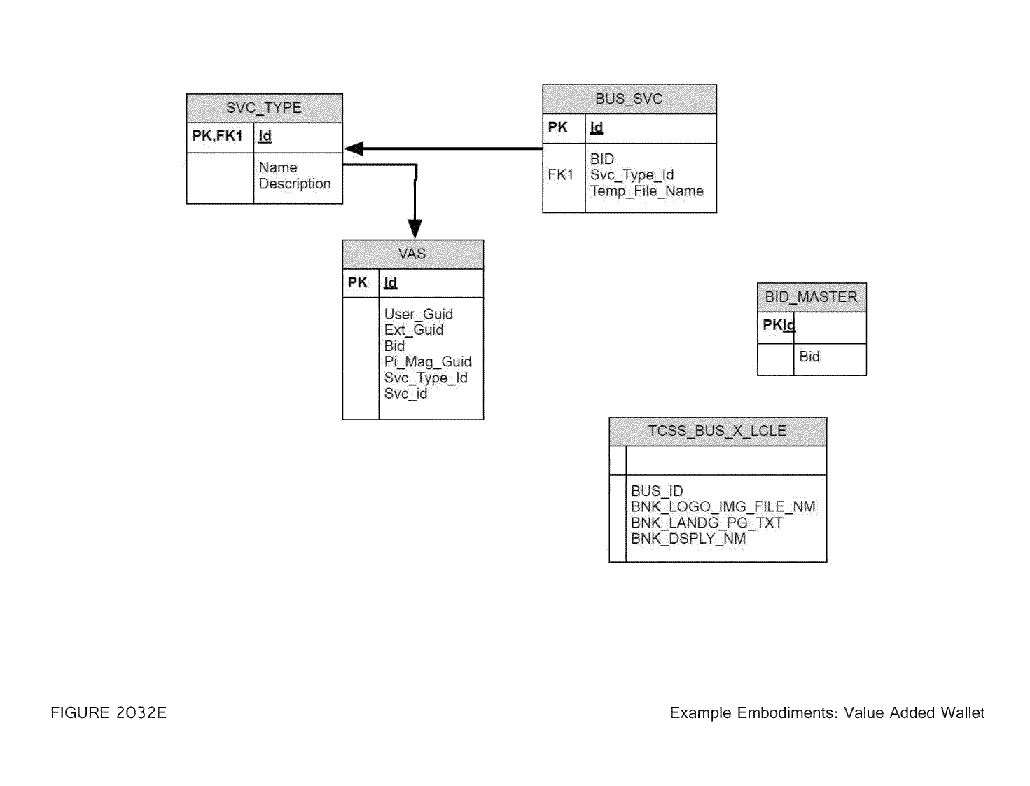

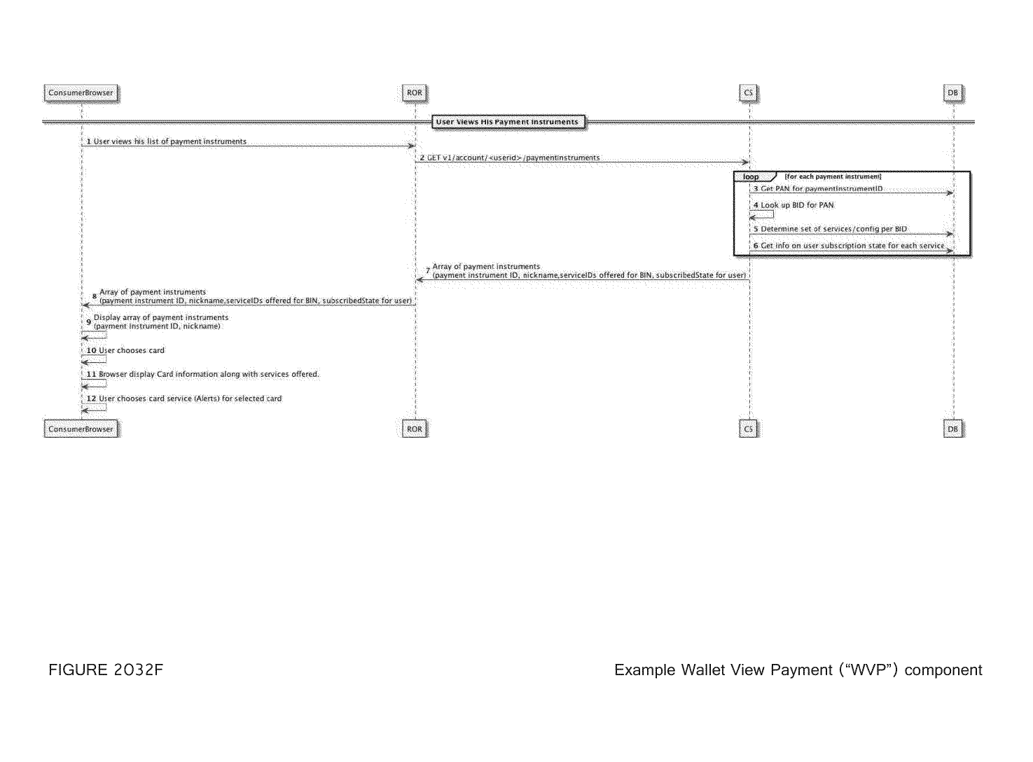

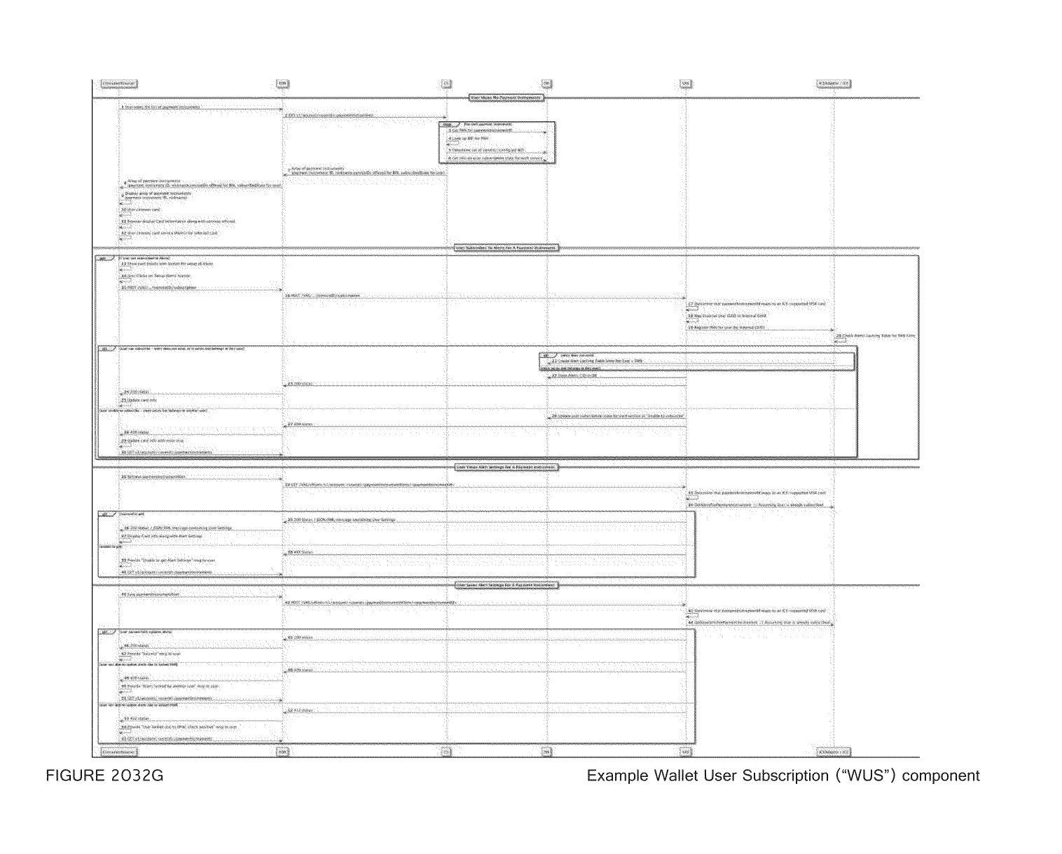

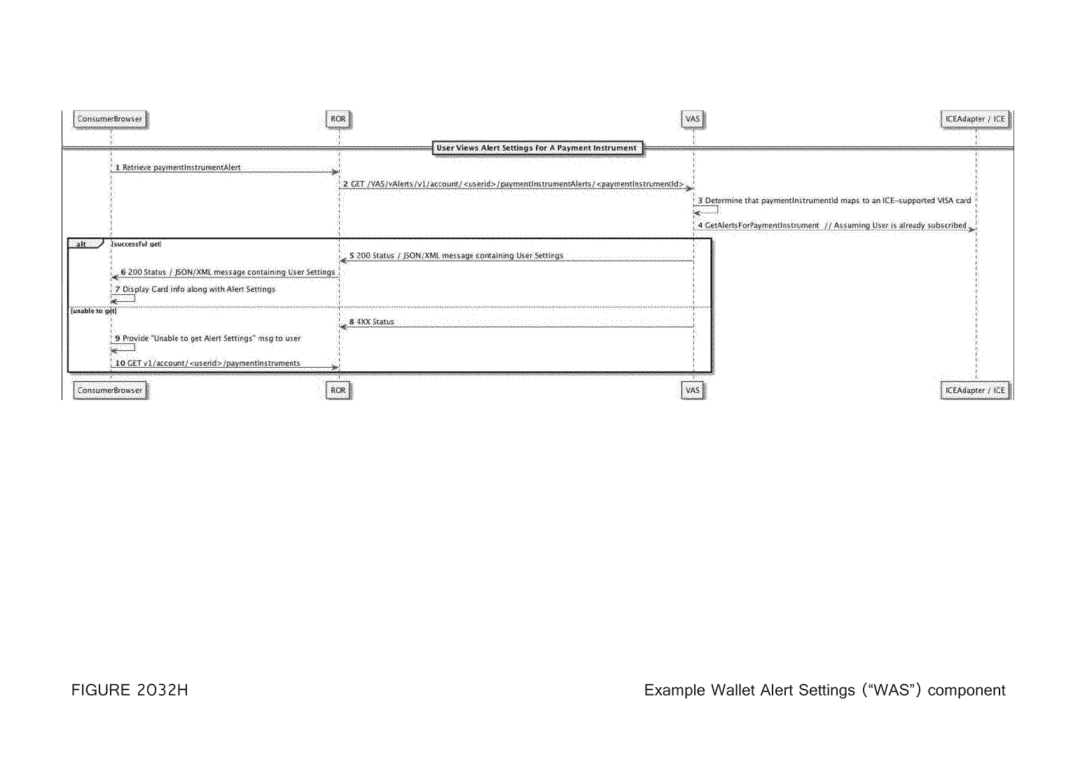

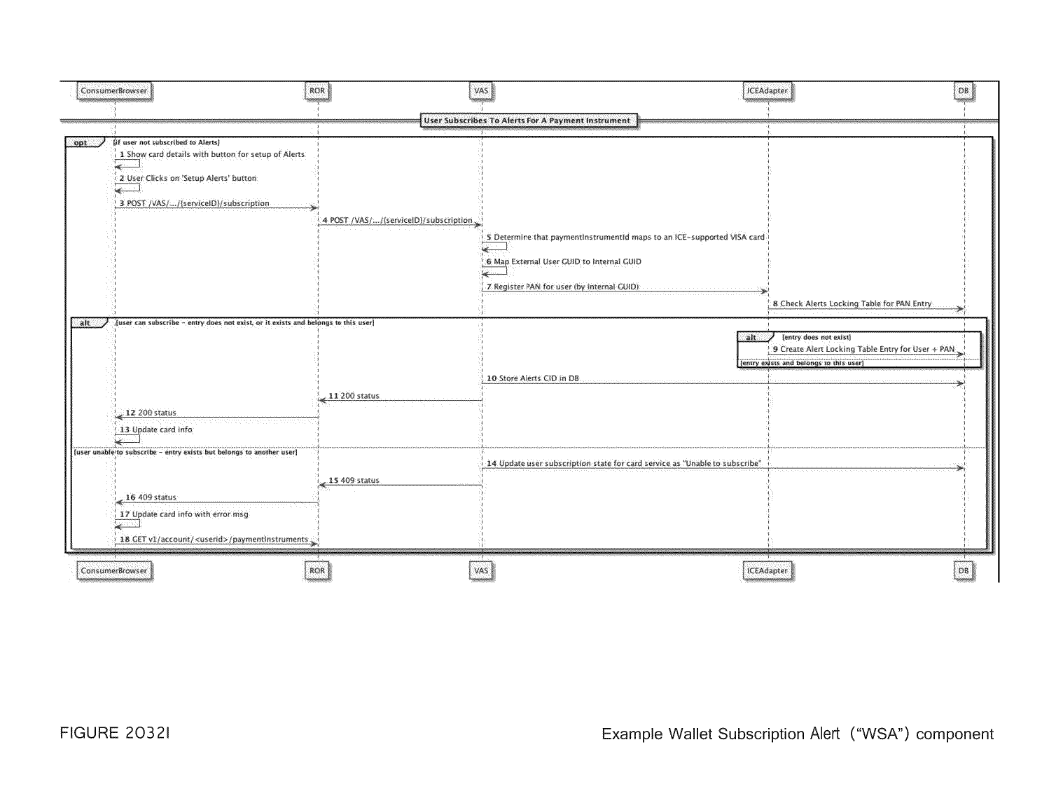

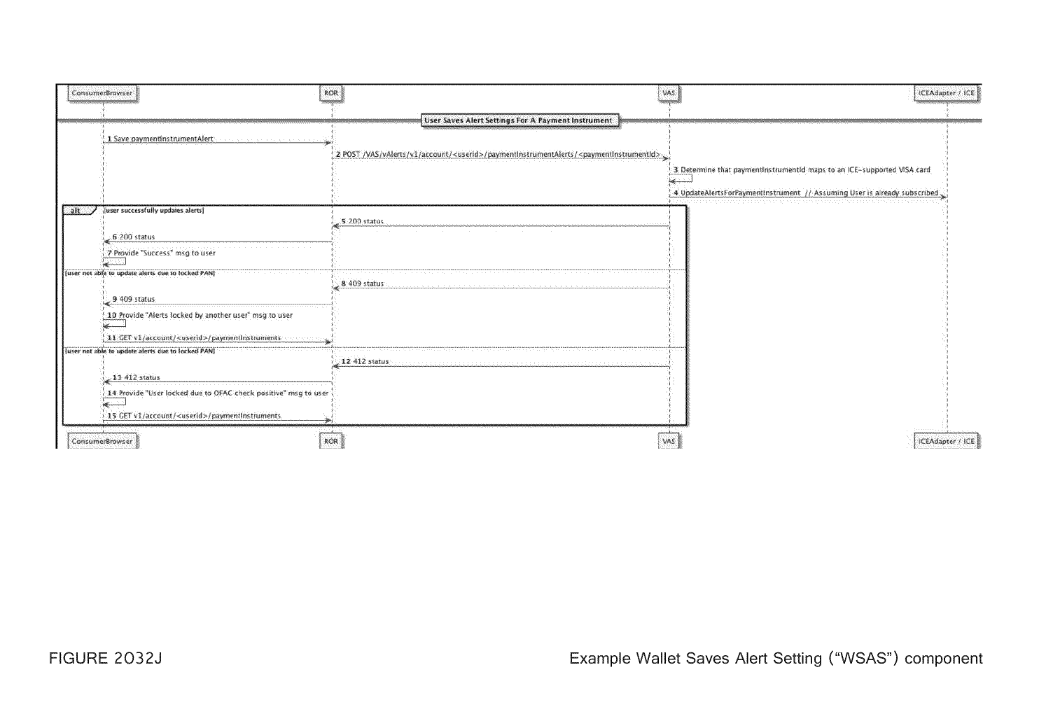

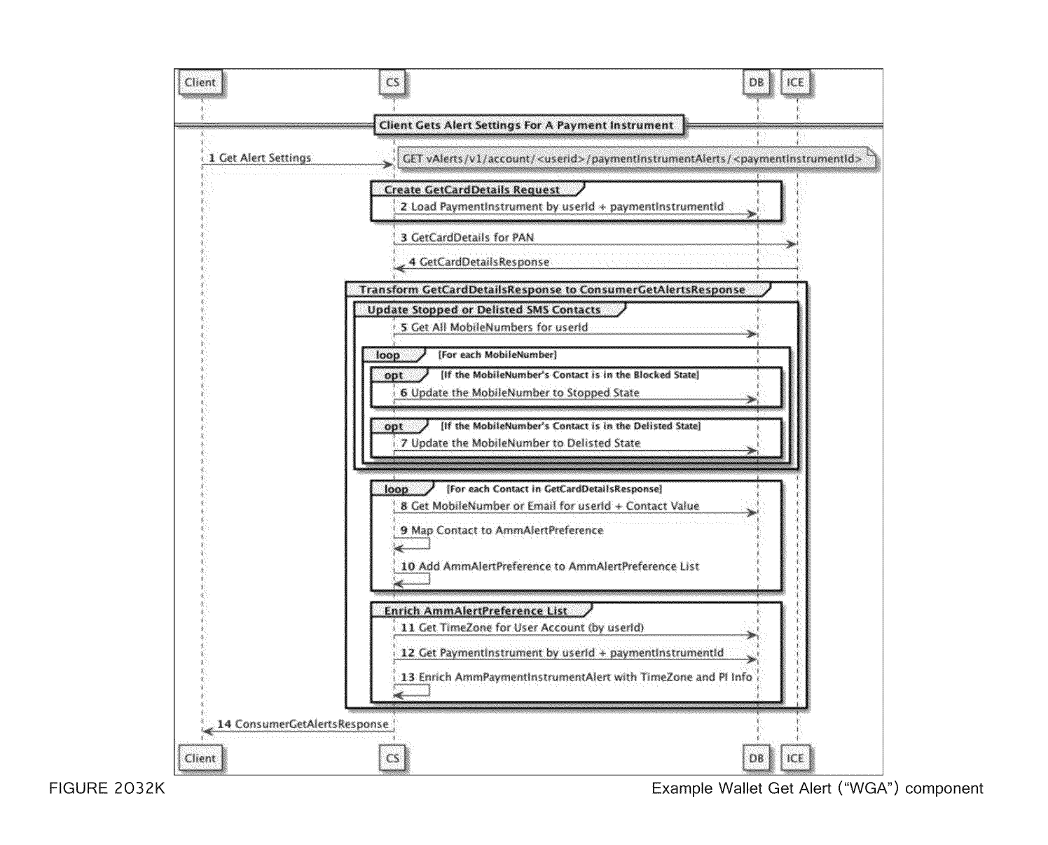

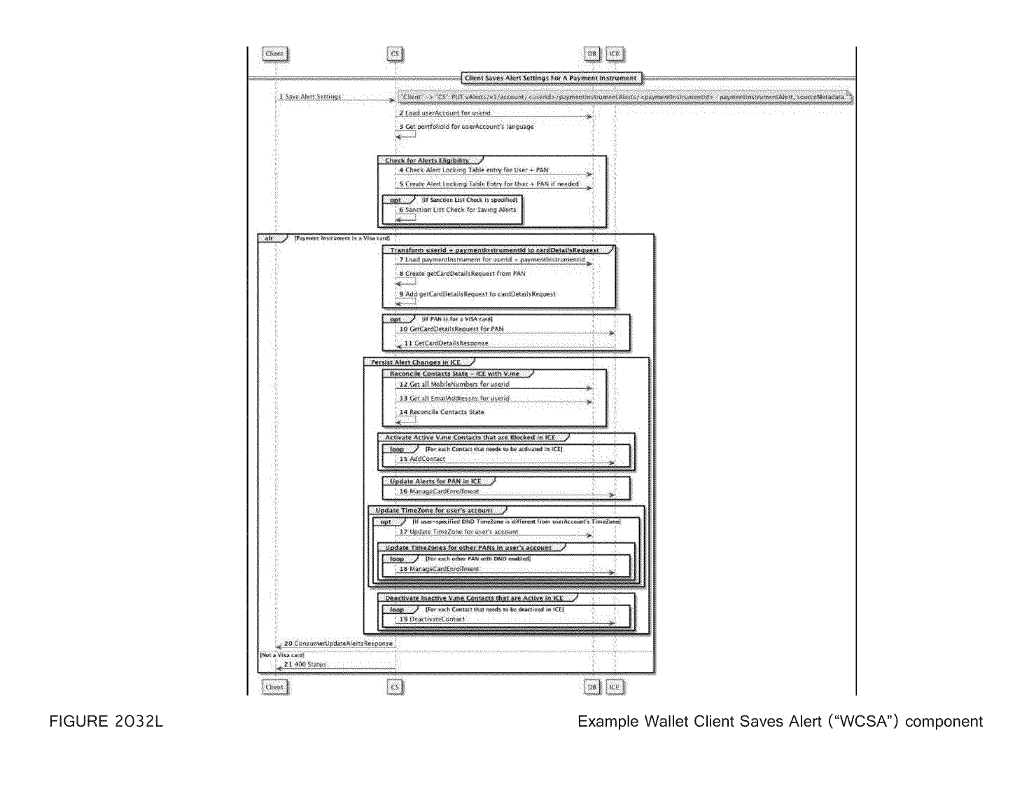

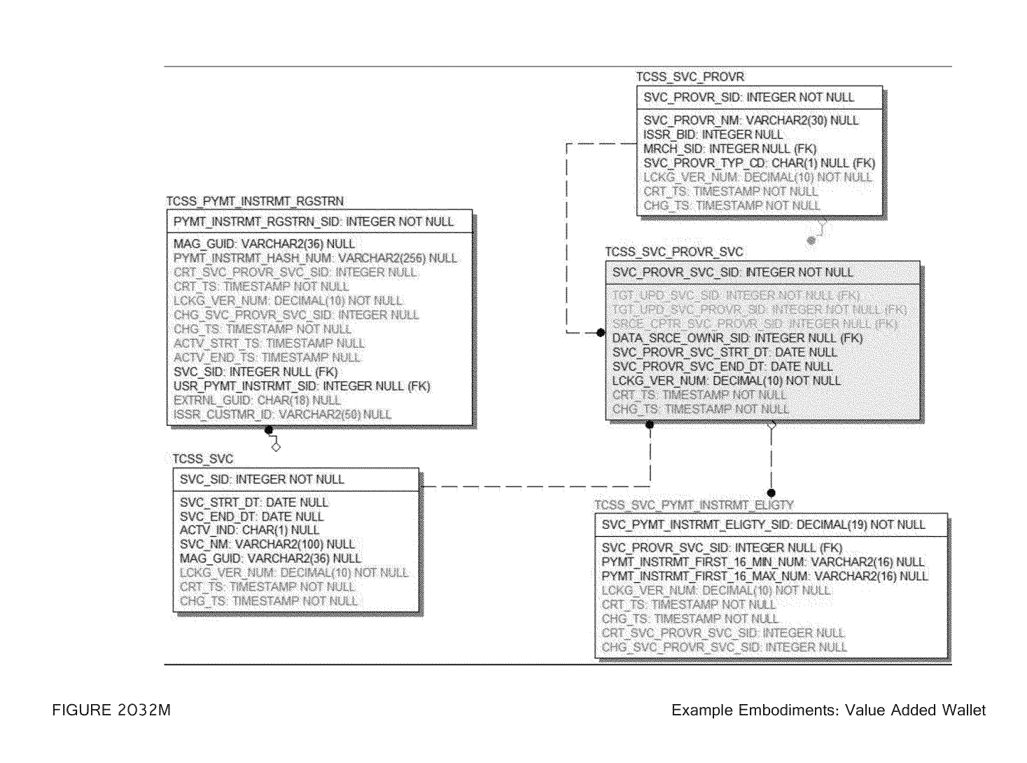

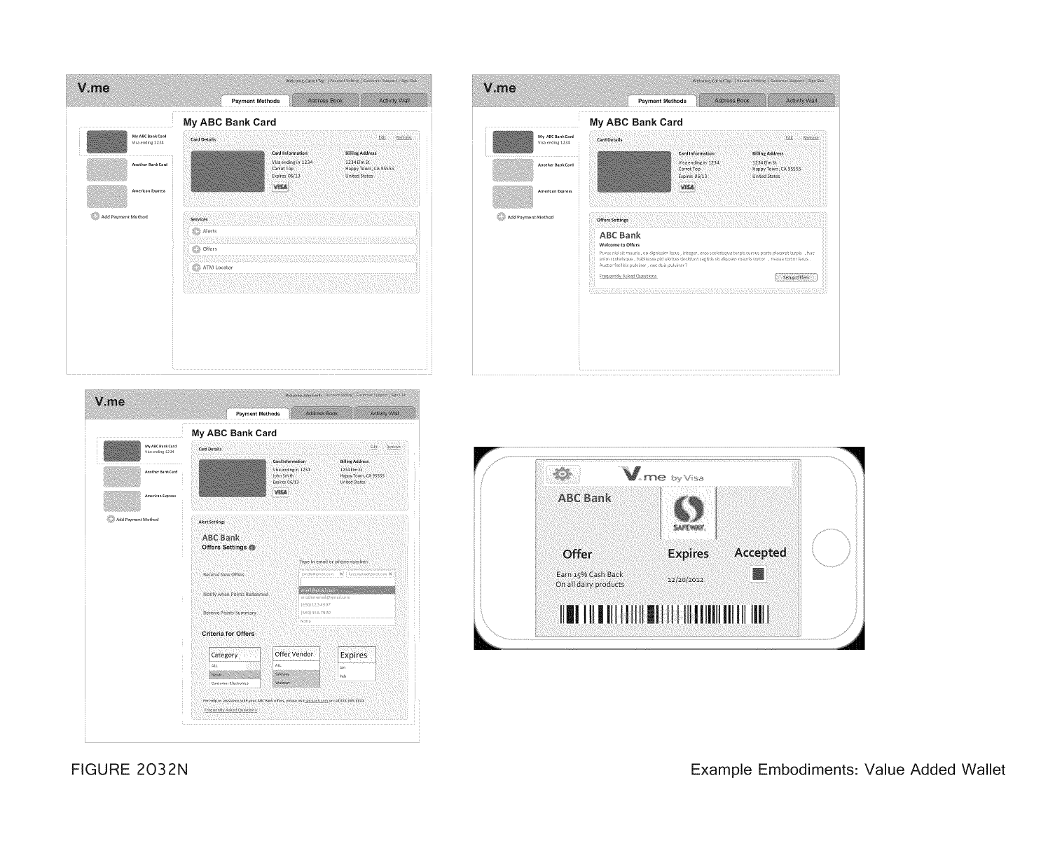

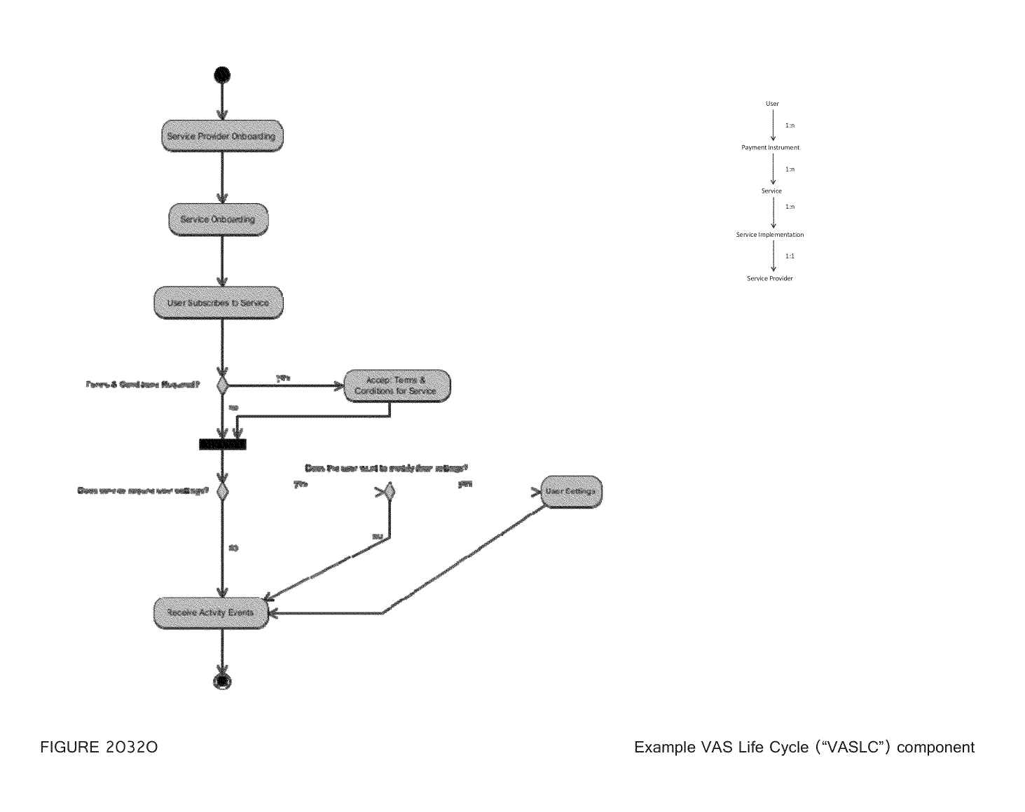

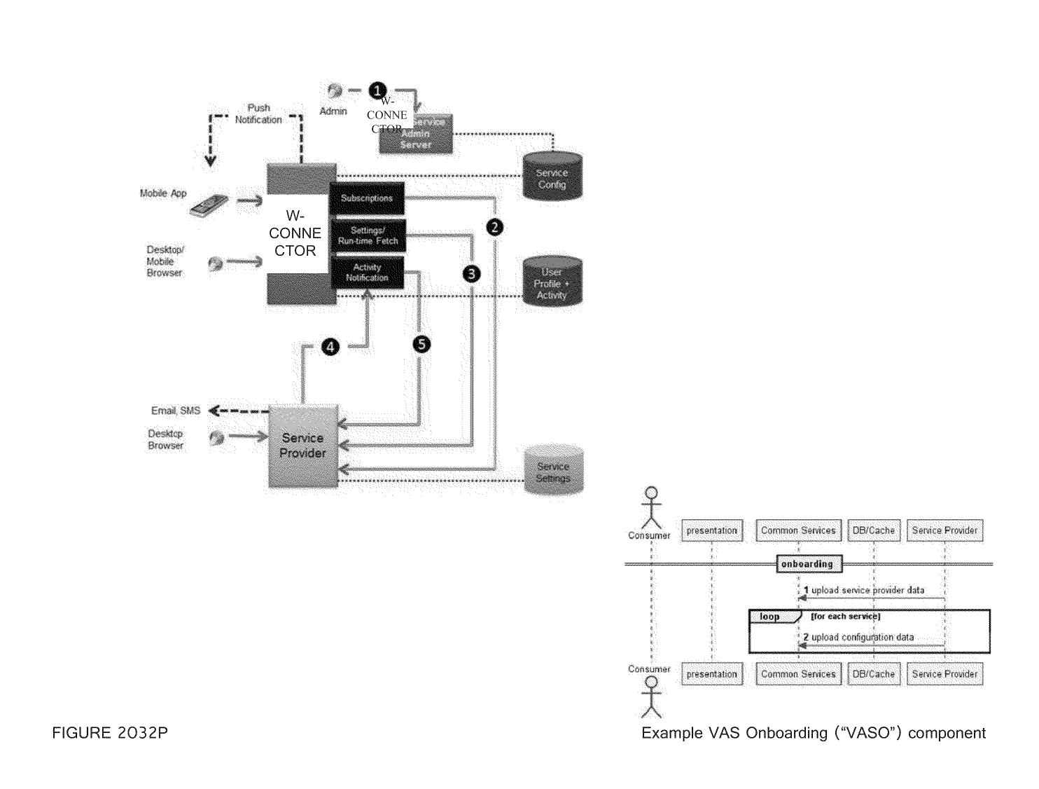

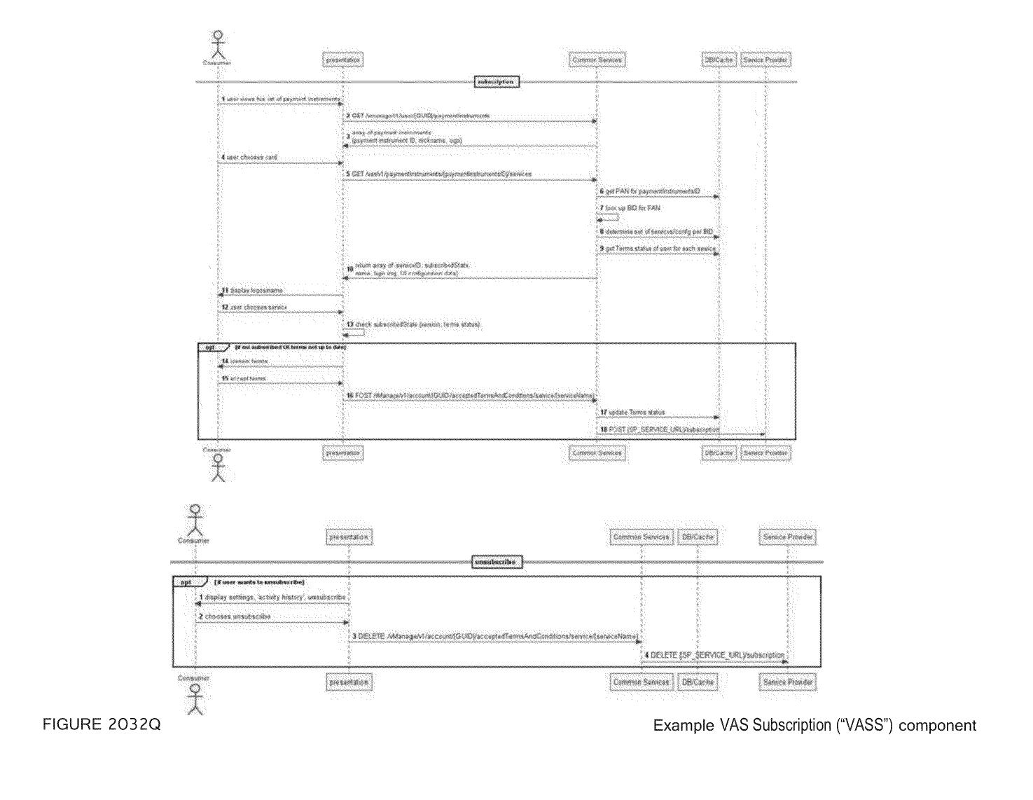

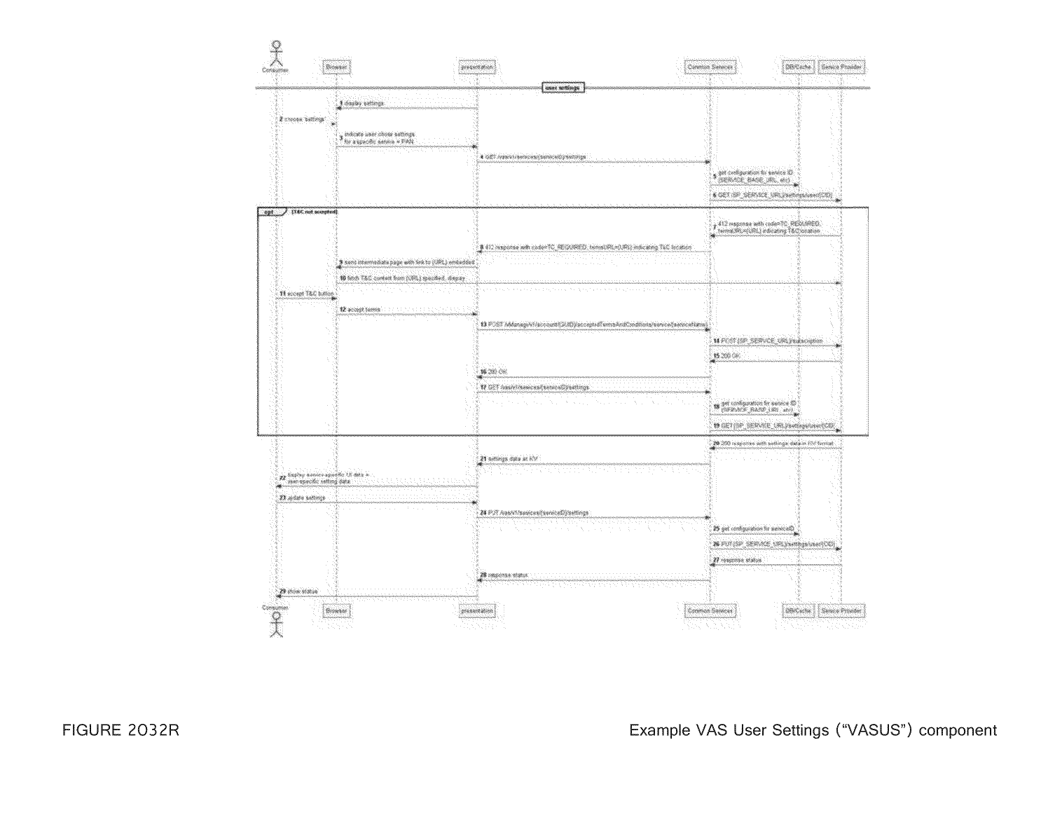

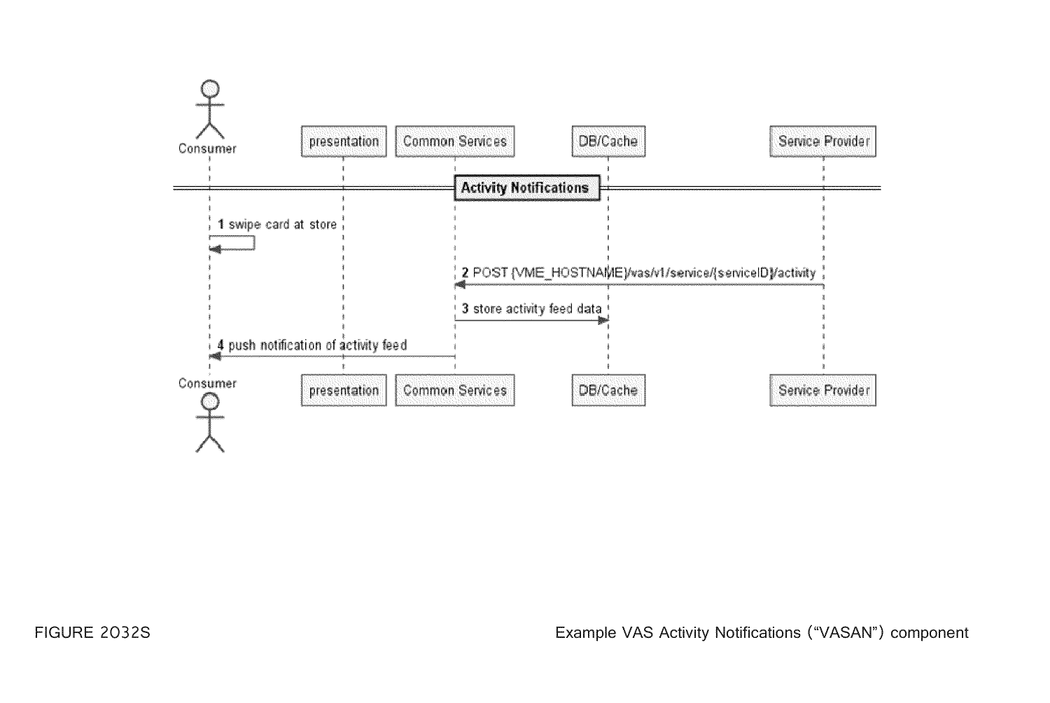

In one embodiment, the Bill Pay server 10402 may extract a first unprocessed widget customization parameter, e.g., 10425 for use in customizing the widget template. The customization parameter may be applied to the widget template (e.g., insertion of content, selection of an item for display by the widget, a price of an item, a behavior of the widget, an application view to invoke when the widget is engaged, and/or the like), e.g., 10426. In one embodiment, if there are more unprocessed widget customization parameters, e.g., 10427, the cycle may repeat. In one embodiment, the Bill Pay server may store the customized widget template in a social checkout widget database, e.g., 10428, for later use by the Bill Pay server or a third-party server in rendering the widget. As a non-limiting example, a customized widget template may be found with respect to FIG. 1021D, e.g., sample updated code 102128. In one embodiment, the widget may additionally be injected directly into a social media application hosted by a social media server 10403. In one embodiment, the Bill Pay server may create a social checkout widget injection package using the customized widget template, e.g., 10429, and transmit the package to a social media server 10403. In one embodiment, the social media server may receive the package and extract the contents for processing, e.g., 10430, and may in turn modify a social media application using the widget injection package contents, e.g., 10431. Modifying a social media application may include injecting widget content into a social media application (such as at a given placeholder or DIV element), the creation or removal of a social media application page or view, the rendering of an application view either partially or fully, otherwise configuring the social media application, and/or the like.

In one embodiment, the Bill Pay server may query a social media sharing database for a social media sharing template, e.g., 10432. A social media sharing template may contain information (e.g., content skeletons, social media parameters to include in a sharing request, and/or the like) that may be used to create a social media sharing request (e.g., a request for a user to share content on a social media site). In one embodiment, the social media sharing template may be customized using the social media application profile (e.g., by injecting or making available a social media application launch button, and/or the like) and/or the customized widget template, e.g., 10433. In one embodiment, the Bill Pay server may create a social checkout widget assembly response using the customized social media sharing request, e.g., 10434, and transmit the request to the user device 10401.

In one embodiment, the user device may receive the social checkout response containing the sharing request, e.g., 10435, and prompt the user to share the included content, e.g., 10436. In one embodiment, the user may accept the request and/or provide a social checkout widget application sharing input, e.g., 10437, in order to share the social media application integration information on a social media feed. In one embodiment, the user device may prepare a social checkout widget application sharing request, e.g., 10438, and transmit the request to social media 10403. The social media server may receive the request and extract the content for sharing, e.g., 10439, and render the shared content on a user or third-party's social media feed, e.g., 10440.

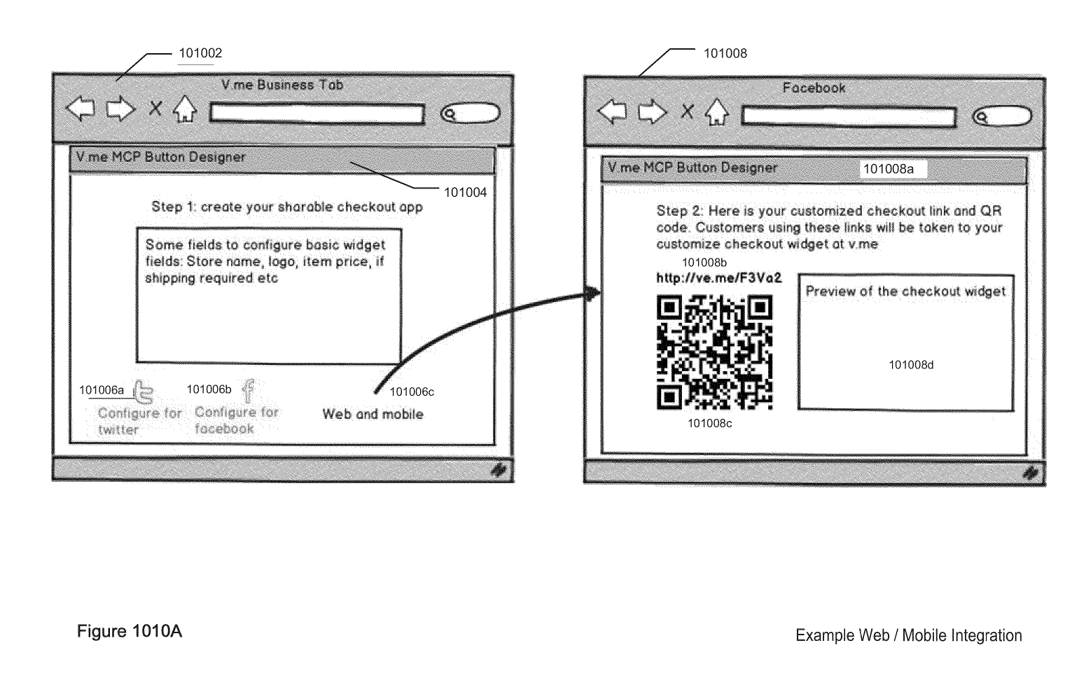

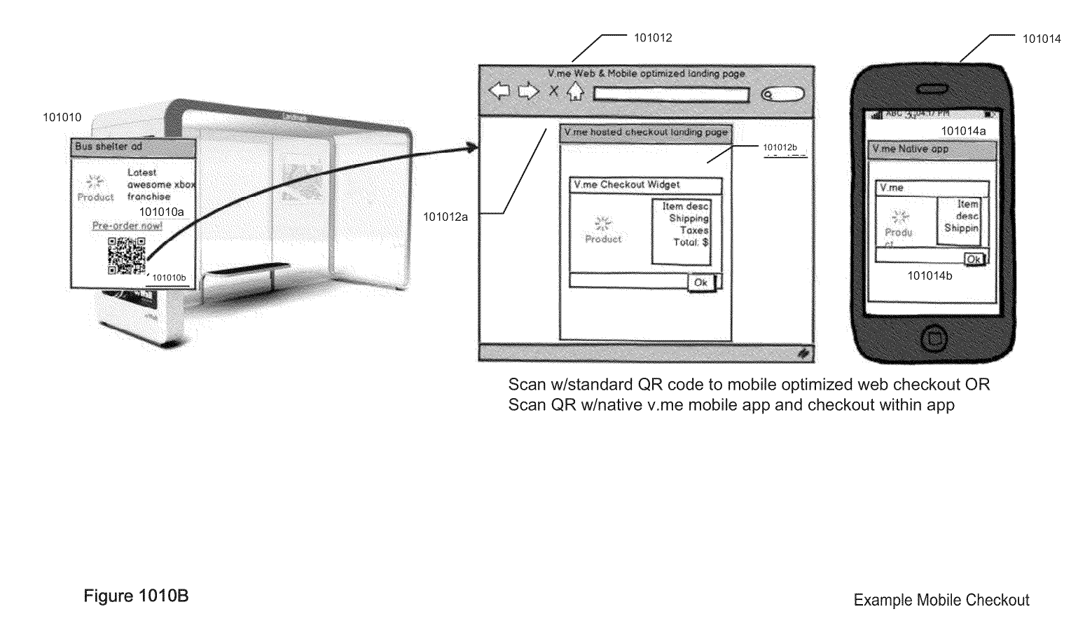

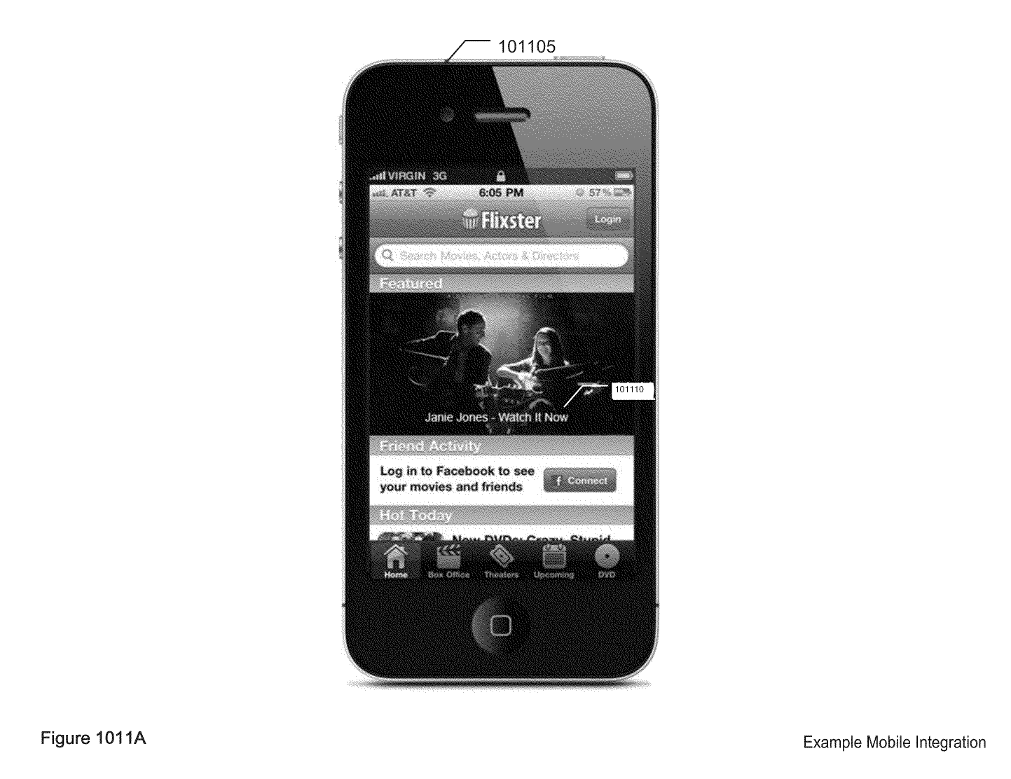

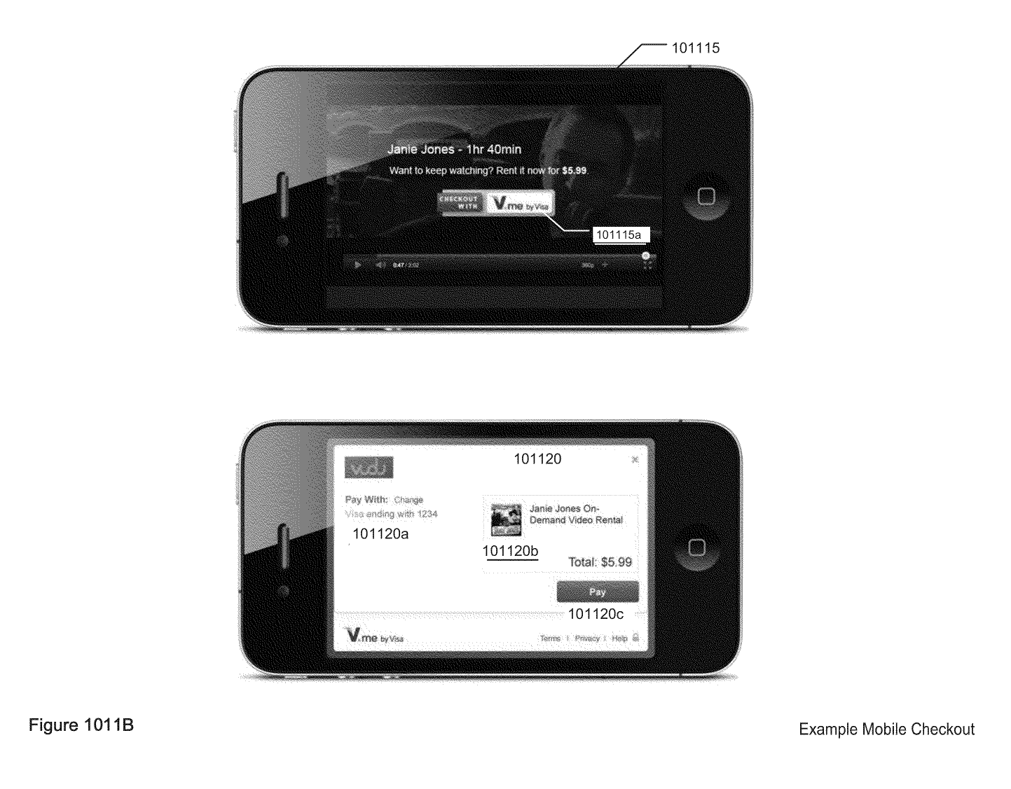

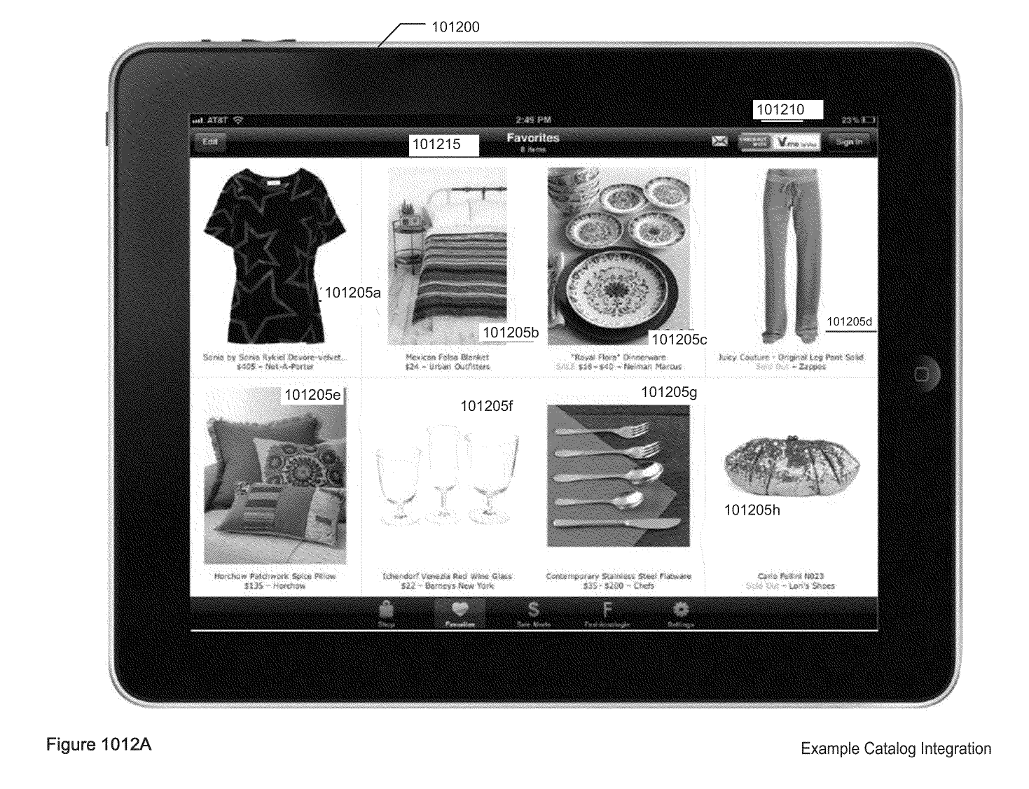

FIG. 10105 shows a data flow illustrating an example social wallet widget checkout, in some embodiments of the Bill Pay. In one embodiment, user 10501 may launch a social media application using their client or mobile device, e.g., social store application launch input 10505. The user's device may transmit a request to launch the social media application to social media server 10502, e.g., a social store application launch request 10506. An example social store application launch request 10506, substantially in the form of an HTTP(S) POST message including XML-formatted data, is provided below:

```
POST /social_store_application_launch_request.php HTTP/1.1
Host: www.socialmediaserver.com
Content-Type: Application/XML
Content-Length: 667
<?XML version = ″1.0″ encoding = ″UTF-8″?>
<social_store_application_launch_request>
  <auth>
    <user_id>7654353</user_id>
    <password>secretpass</password>
    <device_id type=”iPhone”>EIN8876565</device_id>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <application_to_launch val=”merchant_social_app” />
  <application_page_to_view val=”new_item_display” />
  <application_page_parameters val=”item:E18786” />
</social_store_application_launch_request>
```

In one embodiment, social media server 10502 may retrieve a social application record from a social application database stored in communication with the server. The application record may specify an endpoint server that may be used to render the application page(s). For example, the social media server may contact the Bill Pay server 10503 with a request to render an application page. In other embodiments, the social media server may utilize merchant server 10504, a third-party server, and/or the like to render the application view. In still other embodiments, the social media server may itself store the information required to render a social application view on behalf of a third party independently. For example, the third-party may have previously uploaded content to the social media server, the social media server may be in communication with a merchant server 10504, the social media server may screenscrape or otherwise parse a merchant's web page (such as, for example, using an integrated parsing function as described herein with respect to FIG. 1026. In one embodiment, the social media server may contact the Bill Pay server 10503 and request that the Bill Pay render a social media application containing an integrated ecommerce capability, e.g., a store social application render request 10507. An example store social application render request 10507, substantially in the form of an HTTP(S) POST message including XML-formatted data, is provided below:

```
POST /store_social_application_render_request.php HTTP/1.1
Host: www. BILL PAY server.com
Content-Type: Application/XML
Content-Length: 667
<?XML version = ″1.0″ encoding = ″UTF-8″?>
<store_social_application_render_request>
  <auth type=”requesting_user”>
    <key>
      YTGFTYFRYTFYTGFVHUJYTYEXERJHG
      987YHTRFDCTRFGCDYWFDGFTRTD
      YY&&GTFDTGRFDXTRFRERSEW%
    </key>
  </auth>
  <auth type=”social_media_server”>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <application_to_launch val=”merchant_social_app” />
  <application_page_to_view val=”new_item_display” />
  <application_page_parameters val=”item:E18786” />
</store_social_application_render_request>
```

In one embodiment, the Bill Pay server may determine that in order to render the store social application, updated information (e.g., item pricing, inventory levels, descriptions, store locations, and/or the like) is required from merchant server 10504. In one embodiment, Bill Pay server 10503 may initiate a content pricing update request 10508 in order to obtain updated item information. The merchant server may retrieve the requested information, such as by querying an item inventory/pricing database, and forward the updated item information as a content pricing update response 10509. An example content pricing update request 10508 may be substantially in the form of that described with respect to FIG. 102, e.g., a widget merchant content update request 10207. An example content pricing update response 10509 may be substantially in the form of that described with respect to FIG. 102, e.g., a widget merchant content update response 10208.

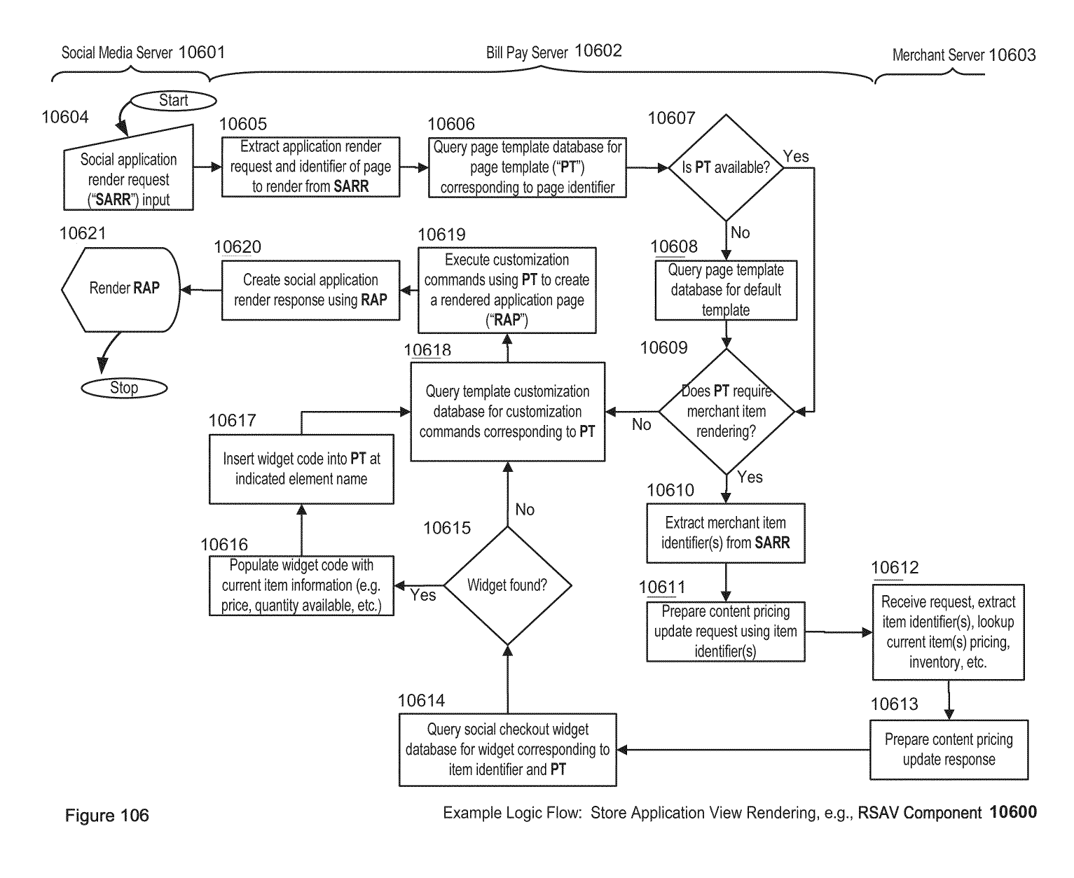

In one embodiment, the Bill Pay server 10503 may then render a store application view. For example, the Bill Pay server may retrieve a view page template and execute logic to apply the received merchant content to the template. The Bill Pay may then generate widget launch code and insert the generated widget launch code into the rendered store application view. In other embodiments, the Bill Pay server may query a third-party source (e.g., a stock market index service, a weather service, and/or the like) in order to render the page view. Further detail regarding rendering a store application view may be found herein and particularly with reference to FIG. 106, e.g., an example RSAV Component.

In one embodiment, the Bill Pay server 10503 may respond with a rendered application view embedded with a widget checkout capability, e.g., a store social application render response 10511. In other embodiments, the Bill Pay server may only return the widget and the social media server may insert the widget into a larger view rendering. An example store social application render response 10511, substantially in the form of an HTTP(S) POST message including XML-formatted data, is provided below:

```
POST /store_social_application_render_response.php HTTP/1.1
Host: www.socialmediaserver.com
Content-Type: Application/XML
Content-Length: 667
<?XML version = “1.0” encoding = “UTF-8”?>
<store_social_application_render_response>
  <auth type=” Bill Pay _server”>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <rendered_application_view id=”6565”>
    <page val=”new_item_display” />
    <page_parameters val=”item:E18786” />
    <page id=”1”>
      <title val=”Item Display Page” />
      <content style_sheet=”merchant_custom_styles.css”>
        <div id=”description”>
          This is the item description.  You can buy the
          product now from directly in the social
          application.  Just click the widget button to
          launch the checkout widget!
        </div>
        <div id=”widget”>
          <div id=“v-root”></div>
        <v:init apikey=“L3KQEBHEJM4HOKCE2XO5”></v:init>
```

| | |
|---|---|
| <script | type=“text/javascript” |
| | src=“https://sandbox-static. |
| | v.me//js/1/v-widgets.js”></script> |

```
        <v:buy
          apikey = ″L3AWQDLKBHYCE2XO5″
          token = ″4a752d0bb67f241a2a567″
          custom_widget_skin = ″FDSRE″
          amount = ″99.95″
          currency = ″USD″
          product-id = ″Testproduct1″
          merch-trans = ″MERCHORDER1234″
          collect-shipping = ″true″
          process = ″validate″>
        </v:buy>
      </div>
    </page>
    <page id=”n”>
      ...
    </page>
  </rendered_application_view>
  <rendered_application_view>
    ...
  </rendered_application_view>
</store_social_application_render_response>
```

In one embodiment, the social media server may then manipulate the returned store social application render response, such as by wrapping the response into a larger response, by applying a template to the response, filtering out non-sharable data, inserting social data into the response (e.g., by replacing placeholders inserted by the Bill Pay server, by appending social data to the response, and/or the like), and/or the like. The social media server may then transmit the social application embedded with a checkout widget functionality to the user device, e.g., a social store application launch response 10512.

In one embodiment, the user may then utilize the rendered application interface to view the requested content. For example the user may be presented with an interface in which to learn about an item that the merchant sells without leaving the social media application. In one embodiment, the user may indicate that they wish to purchase an item from within the social application by clicking the rendered widget checkout button. In so doing, the user device may transmit a checkout request to the Bill Pay server 10503, e.g., a social store application checkout request 10513. In another embodiment, the checkout request may be sent directly to a merchant server, to a social media server, and/or the like. An example social store application checkout request 10513, substantially in the form of an HTTP(S) POST message including XML-formatted data, is provided below:

```
POST /social_store_application_checkout_request.php HTTP/1.1
Host: www. BILL PAY server.com
Content-Type: Application/XML
Content-Length: 667
<?XML version = ″1.0″ encoding = ″UTF-8″?>
<social_store_application_checkout_request>
  <timestamp>2020-12-12 15:22:43</timestamp>
  <auth>
    <user_id>7654353</user_id>
    <password>secretpass</password>
    <device_id type=”iPhone”>EIN8876565</device_id>
    <user_info>
      <name>John Consumer</name>
      <email>john.consumer@foo.com</email>
      <phone>645-123-4567</phone>
    </user_info>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <checkout_request>
    <request_type val=”render_checkout_lightbox” />
    <request_source val=”social_application_widget” />
    <items>
      <item id=”Testproduct1”
            price=”99.95” />
      <item id=”E765765”
            Price=”18.45” />
    </items>
    <device_lightbox_overlay_capabilities>
      <supports_css4 val=”true” />
      <supports_html5 val=”true” />
      <supports_flash val=”false” />
    </device_lightbox_overlay_capabilities>
  </checkout_request>
</social_store_application_checkout_request>
```

In one embodiment, the Bill Pay server may generate a checkout page, such as an HTML page rendered within an IFRAME, a user client specific checkout overlay, and/or the like, e.g., a social store application checkout response 10514. The Bill Pay server may thereafter transmit the generated response to the user device and the user device may render the response. In one embodiment, the consumer may then connect to their virtual wallet, input payment account information directly into the rendered checkout interface, and/or the like. In one embodiment, the user device may initiate an order by transmitting the entered user payment information as well as information regarding what the consumer is ordering (e.g., item numbers, quantities, and/or the like) to the Bill Pay server, e.g., a social store application order request 10515. An example social store application order request 10515, substantially in the form of an HTTP(S) POST message including XML-formatted data, is provided below:

```
POST /social_store_application_order_request.php HTTP/1.1
Host: www. BILL PAY server.com
Content-Type: Application/XML
Content-Length: 667
<?XML version = ″1.0″ encoding = ″UTF-8″?>
<social_store_application_order_request>
  <timestamp>2020-12-12 17:22:43</timestamp>
  <auth>
    <user_id>7654353</user_id>
    <password>secretpass</password>
    <device_id type=”iPhone”>EIN8876565</device_id>
    <user_info>
      <name>John Consumer</name>
      <email>john.consumer@foo.com</email>
      <phone>645-123-4567</phone>
    </user_info>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <order>
    <shipping>
      <name>John Consumer</name>
      <addr>500 Main St.</addr>
      <citystatezip>Anytown, CA 90254</citystatezip>
    </shipping>
    <payment>
      <virtual_wallet id=”E7657664” />
      <virtual_wallet_account id=”act#2” />
      <backup_payment type=”payment_card”>
        <card_num val=”1234123412341234” />
        <card_exp val=”12-2028” />
      </backup_payment>
    </payment>
    <items>
      <item sku=”765765” quantity=”2” price=”10.00”>
        DVD Player
      </item>
      <item sku=”111111” quantity=”1” price=”5.00” />
        Donate $5 to charity or friend
      </item>
    </items>
    <total order=”15.00” shipping=”3.00” final_total=”18.00” />
  </order>
</social_store_application_order_request>
```

In one embodiment, the Bill Pay server may process the order (e.g., charge the users payment account) and forward the order to the merchant, e.g., a social store order 10516. An example social store, substantially in the form of an HTTP(S) POST message including XML-formatted data, is provided below:

```
POST /social_store_order.php HTTP/1.1
Host: www.merchantserver.com
Content-Type: Application/XML
Content-Length: 667
<?XML version = ″1.0″ encoding = ″UTF-8″?>
<social_store_order>
  <timestamp>2020-12-12 17:23:43</timestamp>
  <auth type=”server_to_server_preexchangedkey”>
    <key>
      TRDTRDTRDHG&\hat{ }%BKJBJHVTYEXERJHG
      BJHJUYTYFTYGERJUHYLOPOOIUCFGWFDGFTRTD
      IYUTFRDETFGYHCDYUG{UYTFTYDFGRERSEW%
    </key>
  </auth>
  <order type=”social_media_widget_order”>
    <shipping address=”verified_by_social_media_site”>
      <name>John Consumer</name>
      <addr>500 Main St.</addr>
      <citystatezip>Anytown, CA 90254</citystatezip>
    </shipping>
    <order_amount>
      <total_order_value val=”18.00” />
      <total_items_value val=”10.00” />
      <total_non_items_value val=”5.00” />
      <total_shipping_value val=”3.00” />
      <revenue_share type=”social_media_site” val=”2.00” />
      <revenue_share type=”payment_network” val=”1.00” />
      <status val=”paid_in_full_account_charged” />
      <merchant_total_revenue_from_order val=”15.00” />
    </order_amount>
    <items_to_ship>
      <item sku=”765765” quantity=”2” price=”10.00”>
        DVD Player
      </item>
      <item sku=”111111” quantity=”1” price=”5.00” />
        Donate $5 to charity or friend
      </item>
    </items_to_ship>
  </order>
</social_store_order>
```

In one embodiment the Bill Pay server may then respond to the user device with a confirmation that the order has been processed, e.g., a social store application order response 10517. In other embodiments of the Bill Pay, the user device may directly initiate an order with a merchant server, a social media server, and/or the like, e.g., 10515a, 10517a.

FIG. 106 shows a logic flow illustrating an example store application view rendering component, e.g., a RSAV Component 10600, in some embodiments of the Bill Pay. In one embodiment, social media server 10601 may transmit a social application render request to Bill Pay server 10602, e.g., 10604. A social application render request may be a request from the social network to render a view for an application hosted by the social media server. For example, in some embodiments, the social media server may have application shells that define a subset of all of the application logic for an application available to users of the social media platform. The application shells may indicate that certain portions of an application view should be rendered by contacting a third-party server, such as Bill Pay server 10602, and requesting that the third-party server render portions of the application view. An application view may be substantially in the form of HTML, may be in the form of a combination of HTML and executable scripting commands (e.g., Javascript, and/or the like), may be in a format native to the social media application, and/or the like. In other embodiments, the social media server may itself contain the full application logic necessary to render a social media application view on behalf of a merchant or on behalf of a Bill Pay server. Stated another way, the portion of component execution that is shown as being performed by the Bill Pay server 10602 or merchant server 10603 may in fact be performed by the social media server 10601 or a third-party server not shown, either independently or in communication with the Bill Pay server and/or the merchant server.

In one embodiment, Bill Pay server 10602 may extract the application render request and an identifier of a page to render, e.g., 10605. A page templates database may be queried for a page corresponding to the page identifier, e.g., 10606. In other embodiments, the page template may be associated with the social application, the current user of the application, the social media server, and/or the like. In one embodiment, if a page template is not available, e.g., 10607, a default template may be loaded from the page template database or another source, e.g., 10608. In one embodiment, if the page template requires merchant item rendering, e.g., 10609, one or more merchant item identifiers may be extracted from the social application render request, e.g., 10610. For example, if the application page view render template has a placeholder to represent the selected item, the Bill Pay may substitute the placeholder element for the item information while rendering the application view. In so doing, social media application render requests may be handled by a minimal number of templates and templates may themselves be multifunctional. In one embodiment, the Bill Pay server may determine that the selected item or items for inclusion in the template require updated content such as pricing, inventory, and/or the like. In one embodiment, the Bill Pay server may prepare a content pricing update request 10611, and transmit the request to a merchant server 10603. In one embodiment, the merchant server may receive the request, extract the item identifiers, and retrieve the current item information by querying a database in communication with the merchant server, e.g., 10612. In one embodiment, the merchant server 10603 may generate a content pricing update response containing the updated item information, e.g., 10613, and transmit the response to the Bill Pay server 10602.

In one embodiment, the Bill Pay server may query a social checkout widget database for any generated widgets corresponding to the item or items being included in the application view, e.g., 10614. In other embodiments, the widgets may correspond to the social application, the social application request, the user currently engaged with the social application, and/or the like. If a widget for inclusion is found, e.g., 10615, the widget code may be populated with information relating to the current item (e.g., price, description, quantity, and/or the like), e.g., 10616 and the widget code may be inserted into the page template at a designated point, e.g., 10617. In one embodiment, a template customization database may be queried for customization commands corresponding to the page template, the merchant, the user of the social media application, the social media application itself, and/or the like, e.g., 10618. The commands may include but are not limited to instructions to insert a merchant's logo, insert images from a third party server, insert links to a merchant's web site, and/or the like. In one embodiment, the customization commands are executed on the page template to create a rendered application page suitable for use by the social media server or direct rendering by a user device, e.g., 10619. In one embodiment, the Bill Pay server may create a social application render response using or containing the rendered application page, e.g., 10620, and may transmit the response to social media server 10601 which may render the application page either directly or as part of a larger application view that the social media server is rendering, e.g., 10621.

FIG. 107 shows an example user interface illustrating overloaded social checkout widget creation and integration, in some embodiments of the Bill Pay. In one embodiment, a social media integration interface may be displayed, e.g., 10701. A social media integration interface may allow a user to create a payment widget and inject the widget's content into a social media hosted application, a third-party hosted application, or directly into the user's social media feed (e.g., the user's “Facebook Wall”, “Twitter Stream,” and/or the like). In one embodiment, a user may choose a product or product to feature in the integration, e.g., 10702. Multiple products may be loaded from a third party web site via a web services call (e.g., a RESTful call, a SOAP session, and/or the like). In one embodiment, the user may view various items within the interface, e.g., 10703, and select one or more items for integration. In one embodiment, the user may select to add only the current item to the social media widget integration, 10703a. In other embodiments, the user may select to add the current item and then select another item in addition to the first item (e.g., up to n-items), e.g., 10703b. In one embodiment, the social media widget integration interface may pre-populate item information/item details, e.g., 10704, in response to the user's selection of an item for integration. In some embodiments, the user may override the default text or selections by entering a specific value or values to be used in the particular integration. The user may also upload an image for a product, e.g., 10704a. In some embodiments, the user may build an item entry directly without having any fields pre-filled. In still other embodiments, the item may in fact be a “non-item” such as a cash donation, a tip jar, and/or the like that may solicit money from a user instead of selling a good or service to the user, e.g., 10704b. In one embodiment, the user may choose a social application integration target platform, which is the social media platform or platforms that the user wishes to integrate the widget and/or social media application views into, e.g., 10705. In one embodiment, the user may choose a social media application connection method, e.g., 10706. The connection method is the means by which the widget designer/Bill Pay server may gain access to a user's social media applications so that content may be injected. For example, the user may provide social application connection credentials directly into the interface, e.g., 10706a. In other embodiments, the user may elect to have a third-party server (such as the Bill Pay server, a merchant server, the social media server itself, and/or the like) host the social media application with or without the injected content, e.g., 10706b. In one embodiment, the user may indicate that they desire for the Bill Pay server to create a new social media application on the user's behalf, e.g., 10706c. For example, the Bill Pay server may have predefined profiles for creating a social media application with various social media providers. In other embodiments, the Bill Pay server may prompt the user for details regarding the requirements to create an application on the social media server (e.g., to provide a WSDL file and/or the like). In still other embodiments, the Bill Pay server may autonomously or semi-autonomously scan a social media provider and deduce the requirements for creating an application (e.g., by locating a web services definition file through a web search, by querying standard locations for interface specifications on a social media provider, and/or the like). In one embodiment, the user may conFigure 10the social media application configuration, e.g., 10707, by choosing a page or view within the social media application on which to integrate a widget, e.g., 10707a, an element within which the Bill Pay server should insert or make available the rendered widget, e.g., 10707b, a preferred location for the widget to be inserted into the page in (e.g., “lower left”, “below element x”, “above the browser fold”, and/or the like), e.g., 10707c, and/or the like.

In one embodiment, the user may be presented with an interface that allows them to customize the launch button to launch the social media application and optionally navigate to the injected content page or view, e.g., 10708. In one embodiment, the user may click a customize button, e.g., 10708a, to be presented with an interface that allows the user to specify an item to feature on the launch button, the text to include, a merchant logo, the page within the social application to navigate to when a user clicks the social media application launch button, and/or the like. In one embodiment, the user may choose to promote the newly available integration on one or more social media feeds, e.g., 10709. For example the user may desire to post the integration availability on their social media stream directly, post on the streams of their connections, email their social media connections, message their social media connections through an integrated social media messaging network, and/or the like. In one embodiment, the user may customize the content (e.g., the image, text, and/or the like) to be posted, emailed or messaged to their social network, e.g., 10709a. In one embodiment, the user may have an option to specify the social media feed of a third party, such as a corporate social media feed, on which to post the promotion.

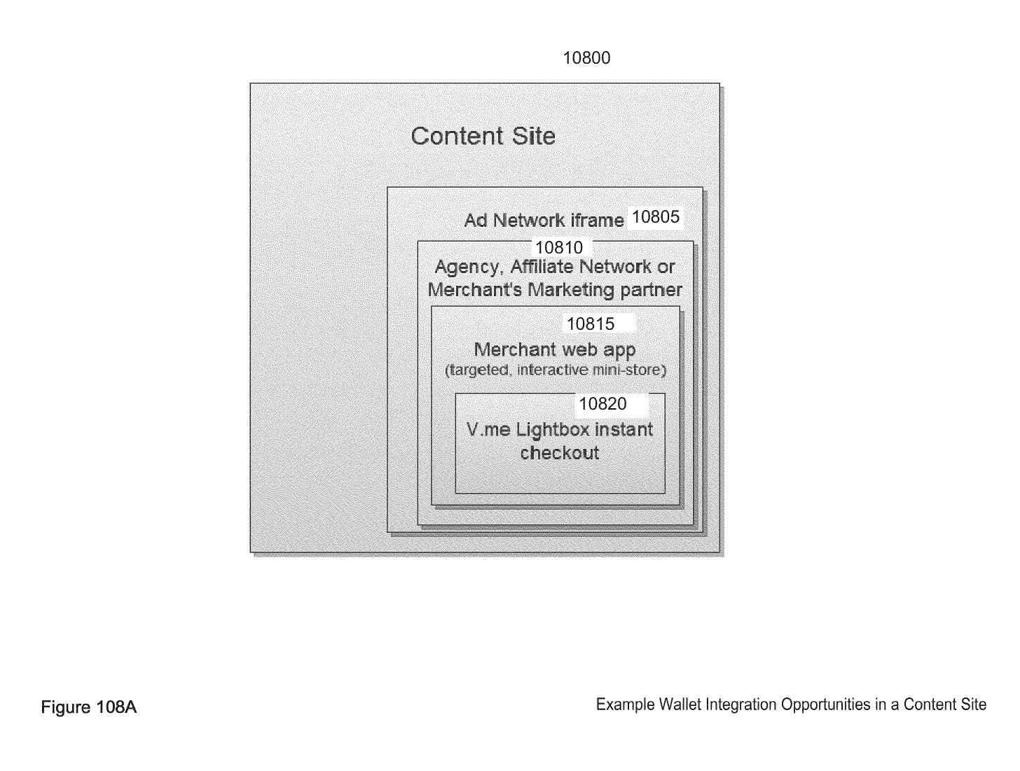

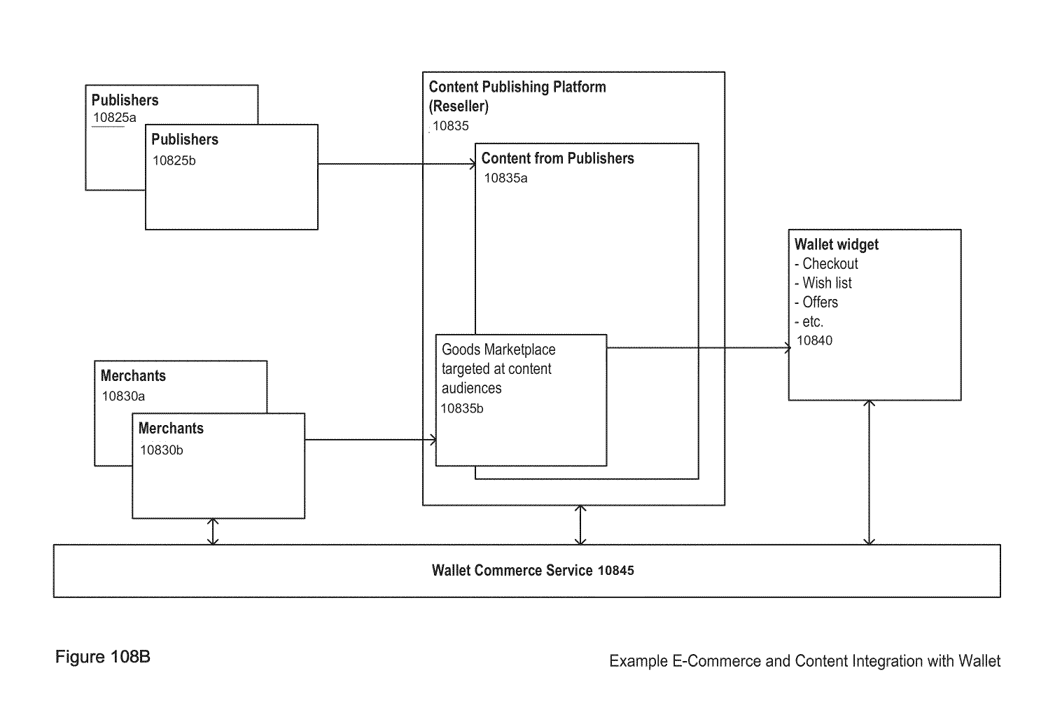

FIG. 108A shows a block diagram illustrating example digital marketing value chain in some embodiments of the Bill Pay. As shown, the Bill Pay digital marketing value chain may include various content providers, distributors and/or other partners, and each layer of the value chain may provide opportunities for wallet integration and/or distribution partnerships. For example, it may include a content site 10800 (e.g., wired.com, facebook.com, etc.). Each site may support advertisements via ad network iframe, JAVASCRIPT and/or image ad tags 10805. Within the content site and/or the ad network iframe, merchant web applications 10810 may be supported. The merchant web applications may be targeted, interactive mini stores that are embedded within the site or ad network iframe. Further within the content site, ad network iframe or merchant web application, a payment widget may be embedded to facilitate wallet lightbox instant checkout 10820.

Publishers of print, TV, radio, online media brands, etc., either build and manage their own websites, mobile and tablet applications or rely on third party publishing platform vendors to distribute their digital content. In either case, and particularly in mobile or tablet environments, content is usually monetized through freemium, subscription, or ad-supported models with no integration with direct merchandizing or commerce. Various embodiments of the Bill Pay may assist publishing platforms in building a complete commerce solution to publishers and merchants. FIG. 108B shows a block diagram illustrating an example content monetization structure in some embodiments of the Bill Pay. As shown, such a structure may connect merchants (10830a, 10830b), publishers (10825a, 10825b) and content publishing platforms 10835 to checkout widget 10840 and wallet commerce service layer 10845, and thereby allow integration of several components needed to facilitate commerce in content publishing channels.

The Bill Pay provides a safe, common, low-friction checkout experience for consumers from a trusted brand, using payment and authentication credentials they already have on file (e.g., if they are v.me wallet subscribers). It allows publishers or their platform vendor to resell wallet merchant acceptance services to merchants and track sales, allows publishing platforms to participate and/or resell wallet value-added services including offers (clipping offers or redeeming offers), integration with wallet wish list for tracking and affiliate revenue schemes for goods added to a wish list from a content site but purchased later through wallet in another channel. For example, in some implementations, the Bill Pay may facilitate aggregation of merchants within a targeted marketplace 10835b (e.g. beauty products and apparel merchants) within a content site (e.g., a fashion magazine iPad application), and provide widget checkout solution to the targeted marketplace, thereby providing a convenient commerce solution to the content publishers and/or merchants. In one implementation, content publishers may leverage the Bill Pay facilities to select partnerships with sponsor brands or advertisers to sell a specific promoted good or service. In another implementation, the Bill Pay may allow advertisers to monetize their marketing by enabling complete checkout within advertisements. The Bill Pay checkout facilities may also be leveraged by classified-like business or person-to-person (P2P) posting for goods and services, publishers acting as merchant themselves, selling their own premium services or subscriptions to their audience at better economics than offered by an application store, selling their own merchandise (e.g., branded t-shirts mugs etc.), and/or the like.

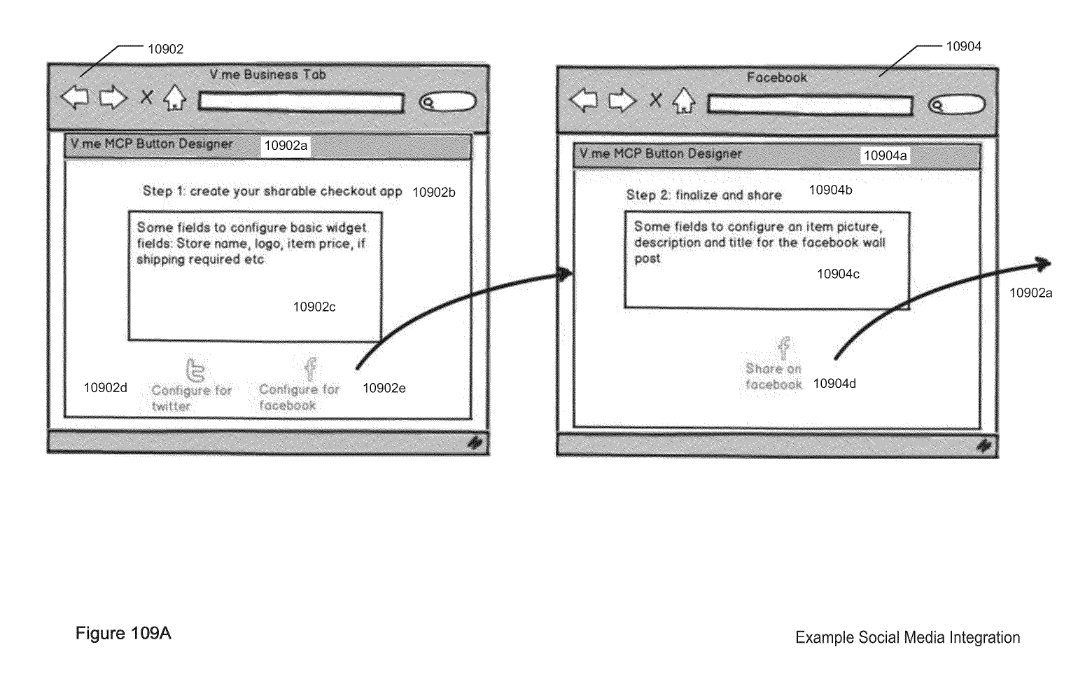

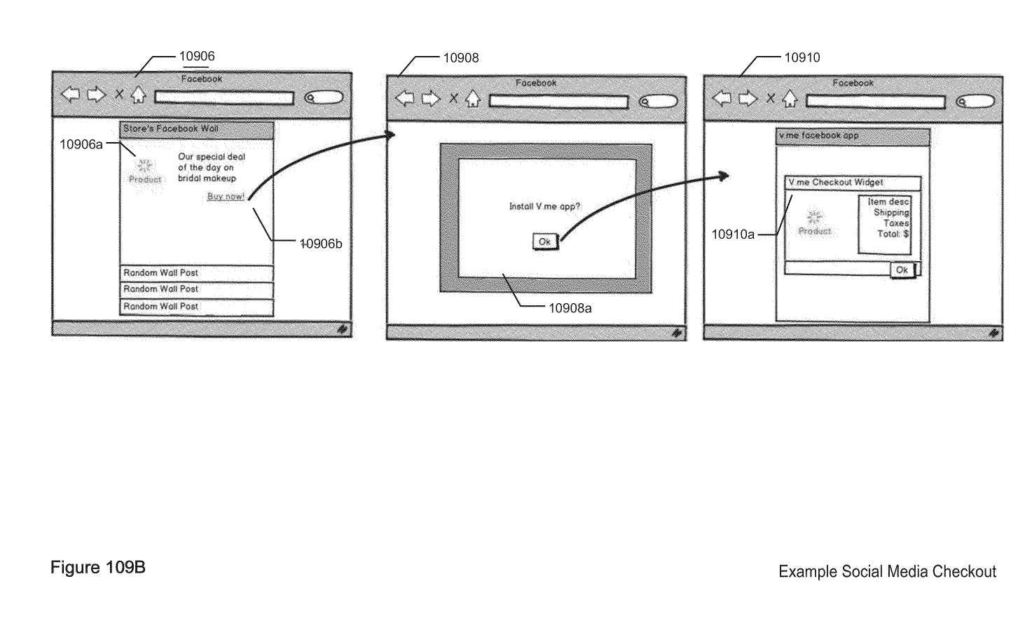

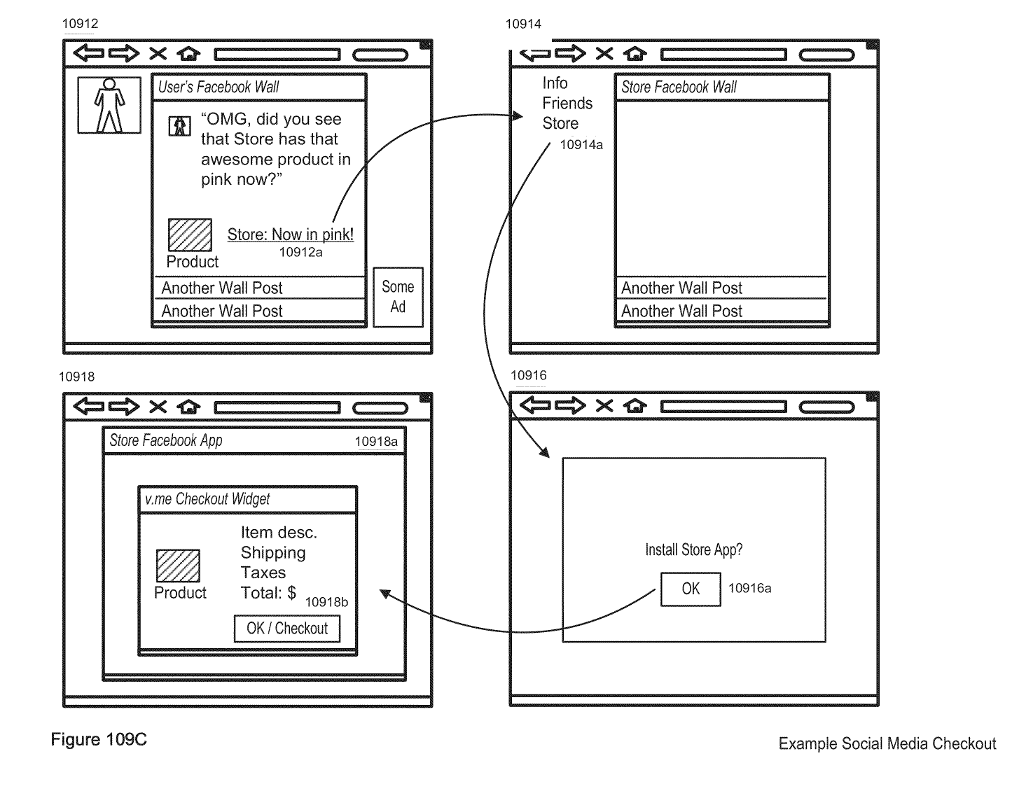

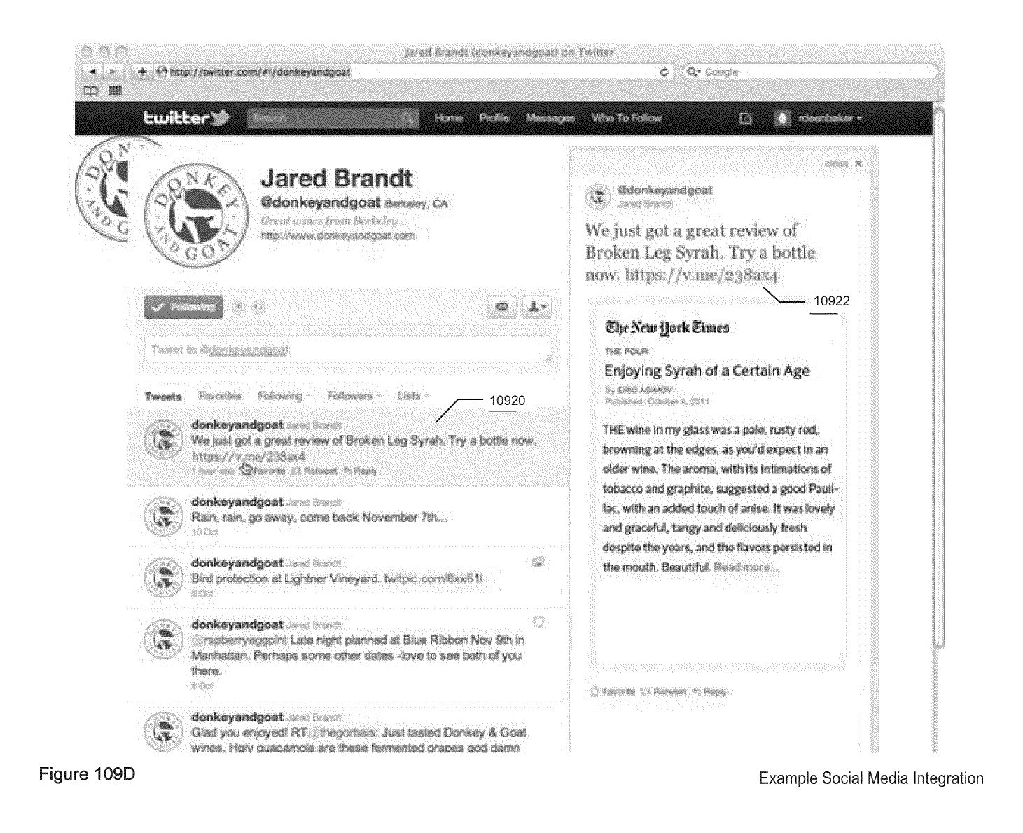

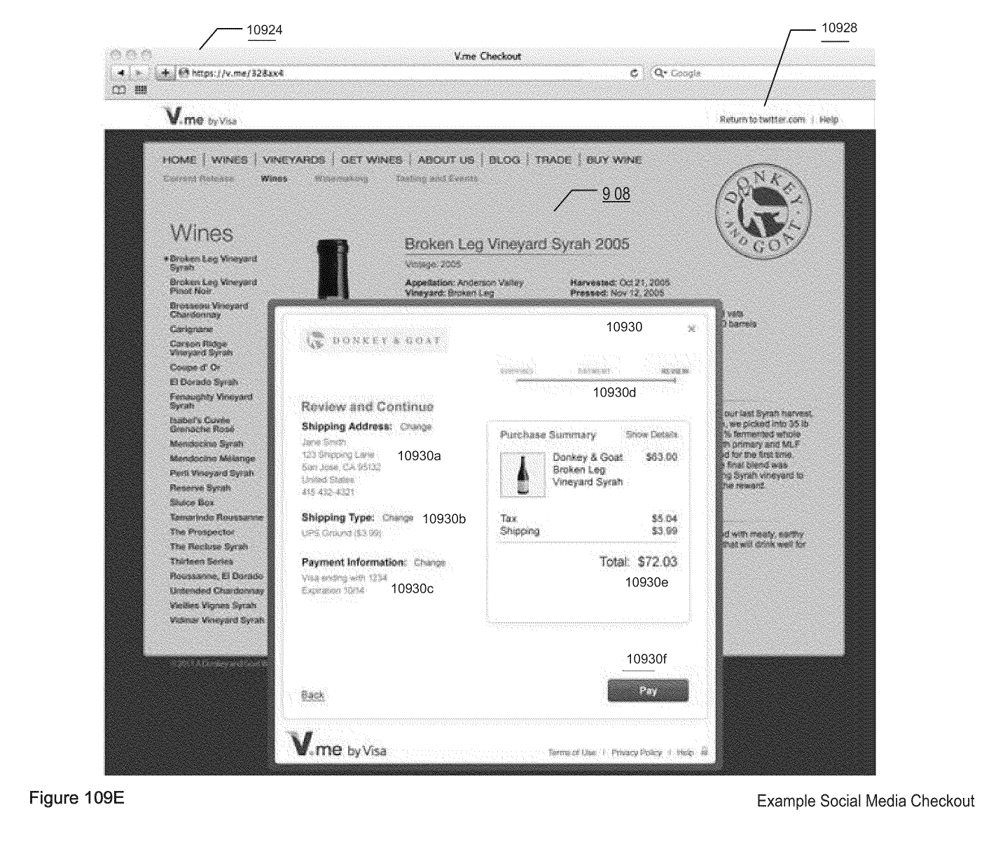

FIG. 109A shows user interfaces illustrating example integration of checkout widget in social media (e.g., FACEBOOK) in some embodiments of the Bill Pay. In one implementation, the Bill Pay may provide a user such as a publisher, merchant, or any party desiring to engage in commerce tools to create, customize and share checkout widget in channels outside of their traditional e-commerce site. In one implementation, a user interface 10902 (e.g., V.me Business Tab) may be provided for configuring and integrating a checkout widget in various social media and other channels. The user interface 10902 may include an option to launch a wallet merchant control panel (MCP) button designer user interface component 10902a (“button designer wizard”) that allows the user to pre-conFigure Iowa checkout widget for a particular Stock Keeping Unit (SKU) item (e.g., a deal of the day, pre-order a product, a donation to a cause, etc.). The component 10902a may request the user to enter information for basic checkout widget fields such as store name, logo, item price, item description, SKU, shipping information, and/or the like in one or more fields 902c provided to create and configure the checkout widget. Social media options (e.g., 10902d, 10902e) where the checkout widget may be distributed or shared may also be provided for selection by the user. In one implementation, when the user selects “conFigure 10 for FACEBOOK” option 10902e, the user may be redirected to their FACEBOOK page 10904, from where the user may continue with the button design. For example, the button designer wizard may request the user to finalize and share (e.g., 10904b) the checkout widget. The user may input item picture, description, title and other information in the fields 10904c provided.

When the user selects the “Share on FACEBOOK” option 10904d, the button designer wizard may provide the merchant a unique URL for that checkout which they can share by the selected social media channel.

FIG. 109B shows user interfaces illustrating example widget checkout in social media (e.g., FACEBOOK) in some embodiments of the Bill Pay. For example, as shown, a wall post 906a including a link 10906b to the product for sale may be published in the user's FACEBOOK page 10906. Once the link to the product is posted, it may be clicked by any consumer to initiate instant checkout. For example, as shown, when a consumer clicks on the checkout link 10906b, a pop up message 10908a may be displayed in the FACEBOOK site 10908 to request the consumer to install a wallet (e.g., V.me) application. When the consumer agrees, a native FACEBOOK application 10910a may be installed in the consumer's FACEBOOK page 10910. A wallet landing page that takes the unique link 10906b and spawns an appropriate checkout widget 910b for the user and the item 10910c may be embedded into the wallet native FACEBOOK application. The consumer may provide wallet credentials or other payment information to the checkout widget and complete a purchase without leaving their FACEBOOK page. Further, consumer may only have to install one wallet FACEBOOK application to checkout from any user or merchant on FACEBOOK.

FIG. 109C shows user interfaces illustrating example widget checkout in social media (e.g., FACEBOOK) in some embodiments of the Bill Pay. As shown, a link 10912a to a product or store may be generated by the wizard and may be posted in a message on a consumer's social network page 10912. The link, when clicked, may redirect to a merchant store landing page 10914 on a social network (e.g., FACEBOOK). From the merchant's social network landing page, a consumer may launch a merchant store application using a link 10914a. In other embodiments, clicking the link 912a may immediately launch the merchant's social store application (e.g., 10918a). Upon clicking the link 10914a, a message window 10916a may pop up in the browser, e.g., 10916, requesting the consumer's permission to install a merchant store application. Upon installation, the merchant store application 10918a may be rendered as an iframe within the merchant store social network landing page 10918. In a further implementation, the initially selected item 10912a may be displayed to the consumer in the store application 10918a, from where the consumer may add the item to a shopping cart (e.g., V.me shopping cart) and checkout. The consumer may also browse through other items in the store application and add one or more items in the shopping cart. When the consumer is ready to check out the items in the shopping cart, the consumer may click on a checkout widget 10918b (e.g., V.me checkout widget) integrated within the store application 10918a. The consumer may simply enter his wallet credentials (e.g., V.me wallet), or information corresponding to other forms of payment such as credit card, debit card, prepaid card, gift card, online account such as PAYPAL account, and/or the like. In some implementations, the consumer may also provide shipping and any other details necessary to conclude the transaction. In this way, by facilitating consumer purchase of products and/or services within a social network framework, the Bill Pay opens up a new sales channel for merchants and provides consumers the convenience of anytime and anywhere checkout.

FIG. 109D shows a screenshot diagram illustrating example integration of checkout widget in social media (e.g., TWITTER) in some embodiments of the Bill Pay. In one implementation, a merchant (or other users) may use TWITTER to tweet/retweet 10920 a unique link 10922 (e.g., https://v.me/238ax4) to a product or service. In one implementation, the link 10922 may be a shortened Universal Resource Locator (URL) generated by the merchant using the button designer wizard.

FIG. 109E shows a screenshot diagram illustrating example widget checkout in social media (e.g., TWITTER) in some embodiments of the Bill Pay. As shown, a consumer may click on the link 10922 (shown in FIG. 109D), which may direct the consumer to a landing page 10924 (e.g., V.me checkout page), where the merchant's website 10908 may be displayed as an iframe. The consumer may then go back the previous page by selecting the link 10928 (e.g., return to twitter.com) or may select a checkout widget (not shown). When the checkout widget is clicked or selected, an overlay similar to overlay 10930 may be displayed where the consumer may enter their wallet login credentials. The consumer provided login credentials may be authenticated by the wallet server, and upon successful authentication, an overlay 10930 may be displayed. As shown, the overlay 10930 may display the consumer's shipping address 10930a on file, shipping type preference 10930b on file, payment information on file 10930c, purchase summary 10930d, total amount 10930e, and/or the like. In one implementation, the overlay may include an option to change any of the information displayed prior to placing the order. In a further implementation, any change of information provided on the overlay may be linked to the information on file at the wallet server, thereby allowing the consumer to update information on the fly. The overlay may also include a pay button 10930 to place order. Upon placing the order, a confirmation message may be displayed in the same overlay. The consumer may then return to their TWITTER page by clicking on the link 10928.

FIG. 1010A shows user interfaces illustrating example integration of checkout widget in web/mobile channels in some embodiments of the Bill Pay. In one implementation, a merchant control panel 101002, similar to those shown in FIGS. 109A and 109C may be provided to a merchant. The merchant control panel may include, among other things, a merchant control panel button designer component wizard 101004 that allows the merchant to create a shareable checkout application. In one implementation, the merchant may be requested to provide button parameters such as store name, logo, item price, if shipping required, shipping methods, product ID, and/or the like necessary to create and customize a checkout widget. In some implementations, an API key and token may also be required to create the checkout widget. The API key may identify the general API access configuration settings, and the token may be an encrypted token for the merchant account. The merchant may have the option to configure the checkout application for various channels including social network (101006a, 101006b) and web and mobile 101006c. In one implementation, when web/mobile configuration is selected, the wizard may generate and provide to the merchant a customized checkout link and/or code such as a bar code, a quick response (QR) code, and/or the like. For example, as shown, the wizard iframe 1008a may display a shortened URL link 101008b and/or a QR code 101008c. In some implementations, a preview 101008d of the checkout widget customized according to the button parameters provided by the merchant may be displayed. In one implementation, the link 101008b may be shared using communication channels including social media channels, email, SMS, MMS, content site and/or the like.

FIG. 1010B shows user interfaces illustrating example widget checkout in web/mobile channels in some embodiments of the Bill Pay. In some implementations, the QR code generated by the wizard may be used for advertisements in print or online. For example, as shown, the QR code 101010b along with product or service information 101010a may be used in a bus shelter advertisement 101010. In one implementation, a consumer may scan the QR code using their mobile device which directs the consumer to a wallet web and mobile optimized landing page 101012. The landing page may display a wallet hosted checkout landing page 101012a. The landing page 101012a may display product/service and/or merchant information, and a checkout widget (not shown). When the checkout widget is selected, a wallet checkout window or iframe 101012b may be displayed where the user may enter wallet credentials, payment and/or shipping information, view purchase details and place order. In an alternate implementation, the landing page may be embedded within a wallet native mobile application 101014a, thereby allowing the consumer to install one wallet mobile application to enable checkout from any merchant accepting mobile checkout. In some implementations, the checkout experience may be optimized for speed, for embedded security, and for a standardized user experience across all merchants on the platform.

FIG. 1011A shows user interfaces illustrating example integration of checkout widget in a mobile application in some embodiments of the Bill Pay. In one implementation, a mobile application 101105 may be integrated with wallet checkout via a link 1110 on a content on the mobile application.

FIG. 1011B shows user interfaces illustrating example widget checkout in a mobile application in some embodiments of the Bill Pay. When a consumer clicks on the link 101110 (shown in FIG. 1011A), a user interface 101115 including a checkout button 101115a may be displayed. The consumer may initiate purchase of the content by clicking on the checkout button 101115a. In one implementation, selection of the checkout button may launch an iframe 101120 that displays the consumer's preferred payment information. The consumer may also change payment information directly from the checkout user interface 101120. The checkout user interface may additionally include product information 101120b and a pay button 101120C to place the purchase order. In an alternate implementation, instead of launching the checkout user interface 101120 when the checkout button 101115a is selected, a native mobile wallet application may be launched. The purchase may then be completed using the wallet application.

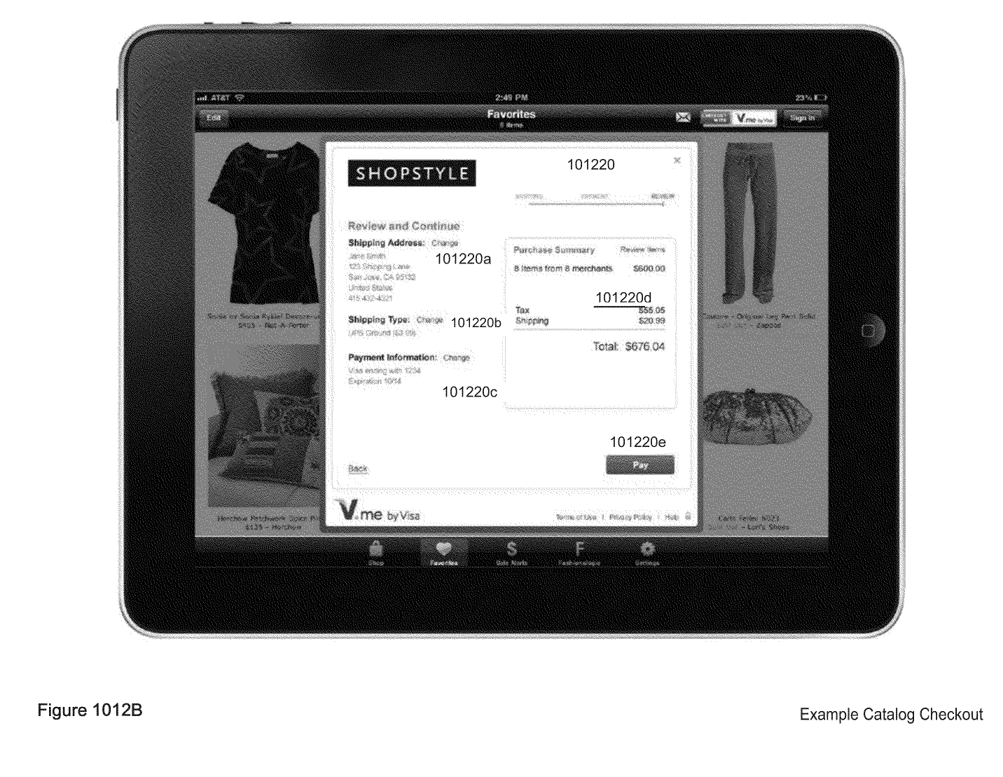

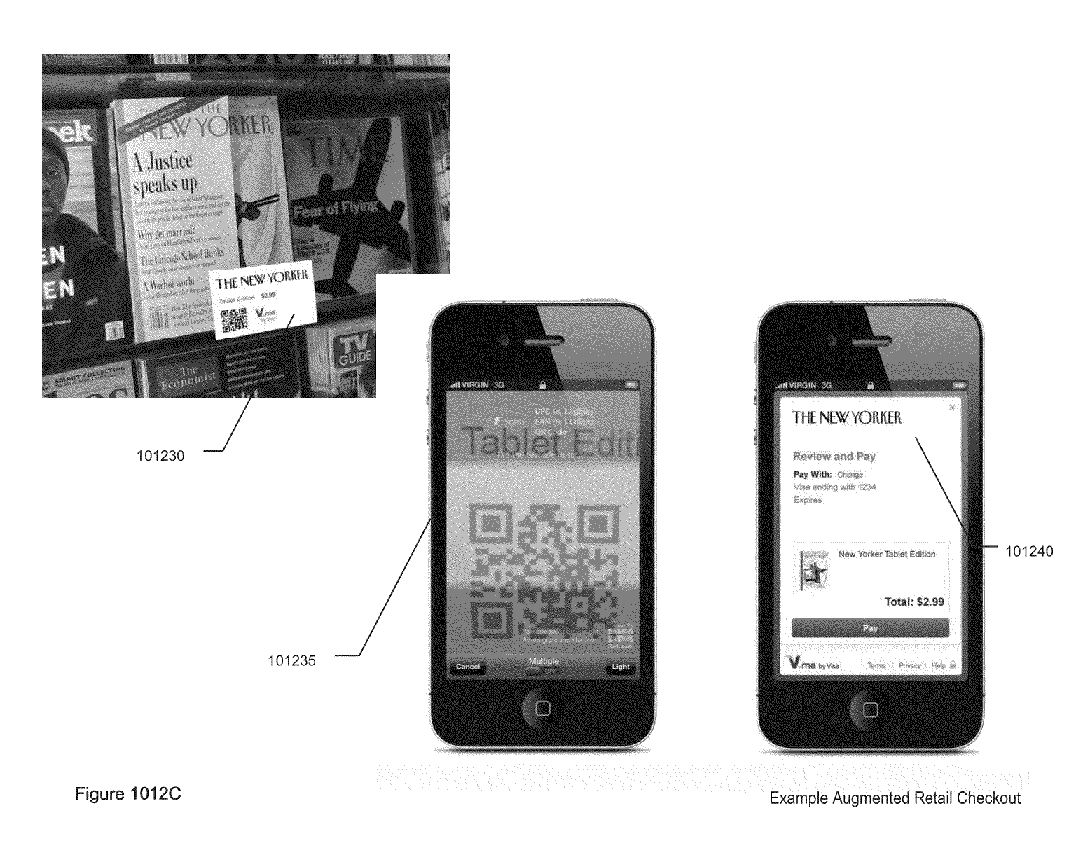

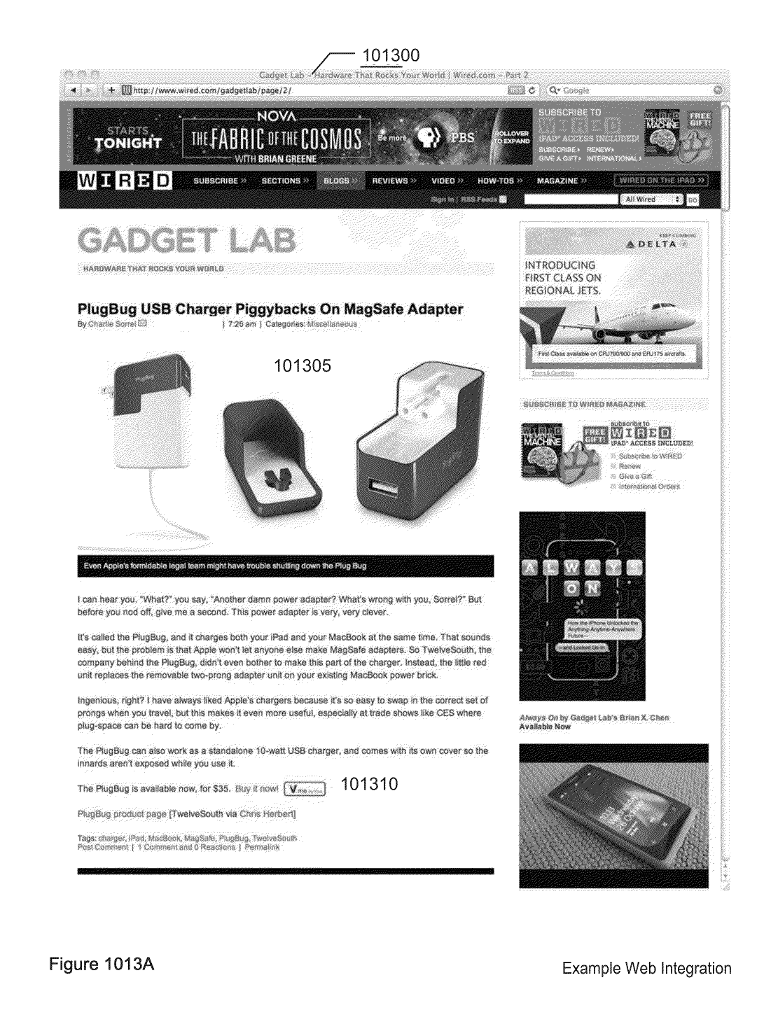

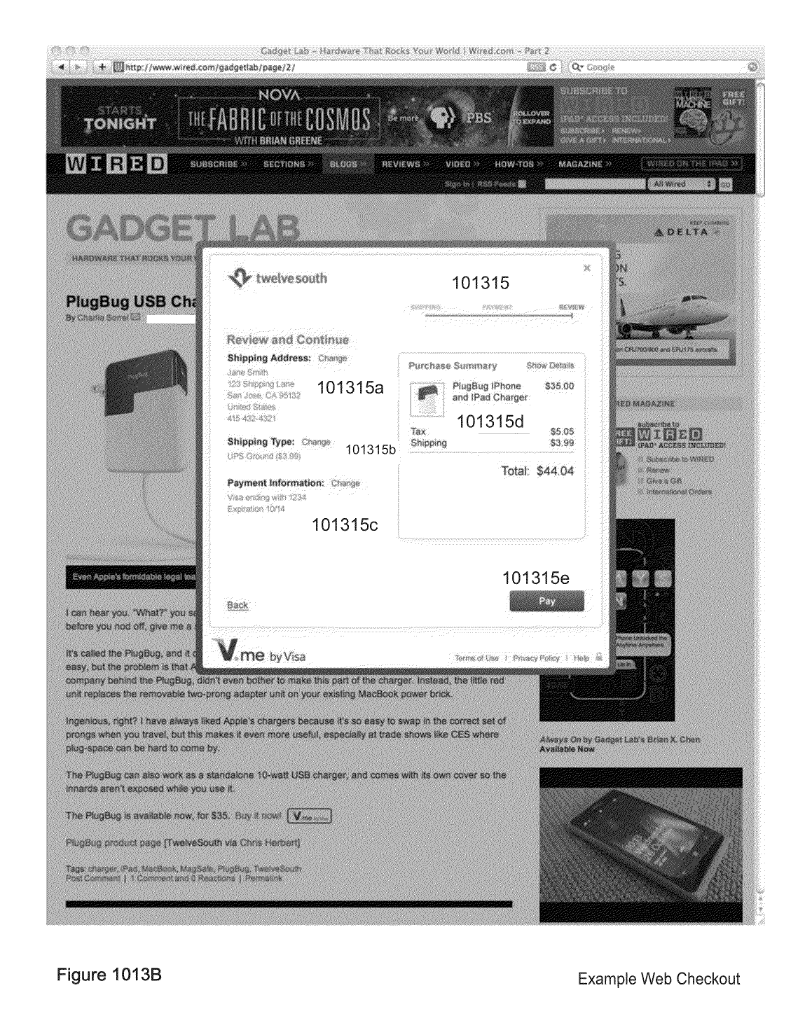

FIG. 1012A shows user interfaces illustrating example integration of checkout widget in a digital catalog in some embodiments of the Bill Pay. The user interface 101200 shows a number of products 101205a-h aggregated from one or more merchants and saved under favorites 101215 or wish list. A checkout widget 101210 may be integrated with such a multi-merchant catalog to allow checkout directly from the catalog, favorites or wish list, without having to visit each of the merchants' stores or application individually.

FIG. 1012B shows user interfaces illustrating example widget checkout in a digital catalog in some embodiments of the Bill Pay. In one implementation, when the checkout widget is clicked, a lightbox 101220 may be launched. Such lightbox may be branded using logo and other information provided by the catalog publisher. The lightbox may include information such as shipping address 101220a, shipping type 101220b, payment information 101220C, purchase summary 101220d, and/or the like retrieved from the consumer's wallet. Such information may also be changed from the same interface, in accordance with permissions and controls for bi-directional federation set up in the wallet. The consumer may then complete the purchase by selecting the pay button 101220d.

Once the purchase transaction has been authorized, and one or more wallet commerce service components communicate with the merchants to provide information regarding purchase, and in some implementations, obtain information regarding products (e.g., inventory information, fulfillment, etc.). In some implementations, the Bill Pay may provide facilities for crediting the aggregated seller such as the catalog publisher for initial lead that results in an interest and/or purchase.

FIG. 1012C shows user interfaces illustrating example augmented retail checkout in some embodiments of the Bill Pay. In some implementations, retail stores selling retail or digital version of the same product may be credited for the initial lead resulting in interest and/or purchase of the digital version of the product. For example, a bookstore that sells “The New Yorker” magazine, may also place a QR code 101230 for purchasing a digital version of the magazine, the retail store effectively becoming a show room for online products. A consumer who wishes to purchase the digital copy of the magazine, instead of the print copy, may scan the QR code using their tablet or mobile devices 101235. The QR code may launch a landing page, a lightbox, or wallet application 101240 where the consumer may enter payment information or wallet credentials to complete the purchase and download a digital copy to their tablets or other mobile devices. At the backend, the wallet services component may identify the merchant associated with the code that was used for the purchase, and may provide a cut or commission for the sale of the digital magazine. In one implementation, any cut or commission may be determined based on agreements between various parties such as the retailer, the publisher, the wallet service provider, and/or the like.

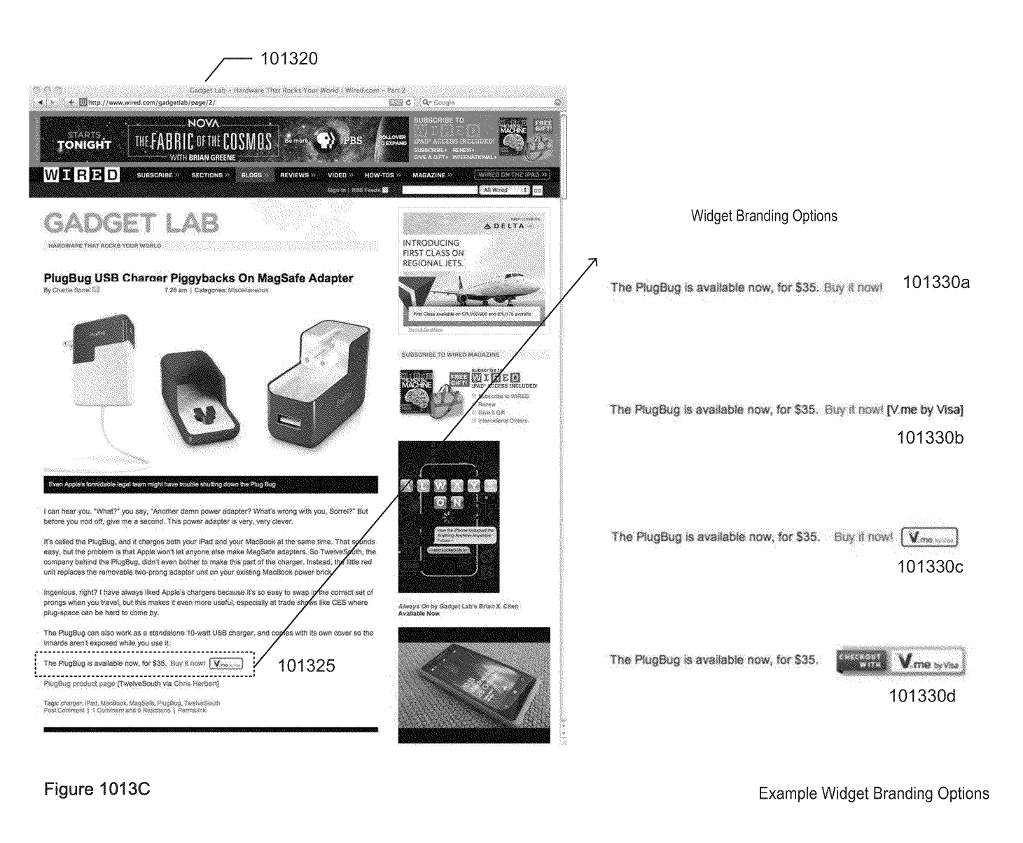

FIG. 1013A shows a screenshot diagram illustrating example integration of checkout widget in a content site in some embodiments of the Bill Pay. As shown, a content site 101300 may publish an article 101305 reviewing a product (“USB charger”). The content site may integrate the product review with a checkout widget 101310 to facilitate purchase of the product directly from the review page.

FIG. 1013B shows a screenshot diagram illustrating example widget checkout in a content site in some embodiments of the Bill Pay. When the checkout widget 101310 is clicked, a lightbox 101315 may be displayed overlaying on top of the site. The lightbox may include shipping information 101315a, shipping type 101315b, payment information 101315c, purchase summary and details 101315d, and/or the like. In some implementations, the lightbox may request wallet credentials from the consumer to retrieve consumer information relating shipping and payment information on file with the wallet. The consumer, upon agreement with the information on the lightbox, may place an order by clicking on the pay button 101315e. Once the purchase transaction is authorized, the wallet services component may, in some implementations, provide the content publisher credit for monetizing the product via product review on the content site.

FIG. 1013C shows diagrams illustrating example checkout widget branding options in some embodiments of the Bill Pay. As shown, a content site 101320 may link content with product and facilitate checkout of the product directly from the content site. In one implementation, the checkout widget 101325 on the content site may be branded in multiple ways. In one implementation, the product may be advertised for checkout simply as a link 101330a with no branding. In some other implementations, the checkout may be implemented as a link with additional description 101330b, a link with a wallet branding 101330c, a checkout widget with wallet branding 101330d, a checkout widget with merchant, issuer, or site publisher branding, and/or the like.

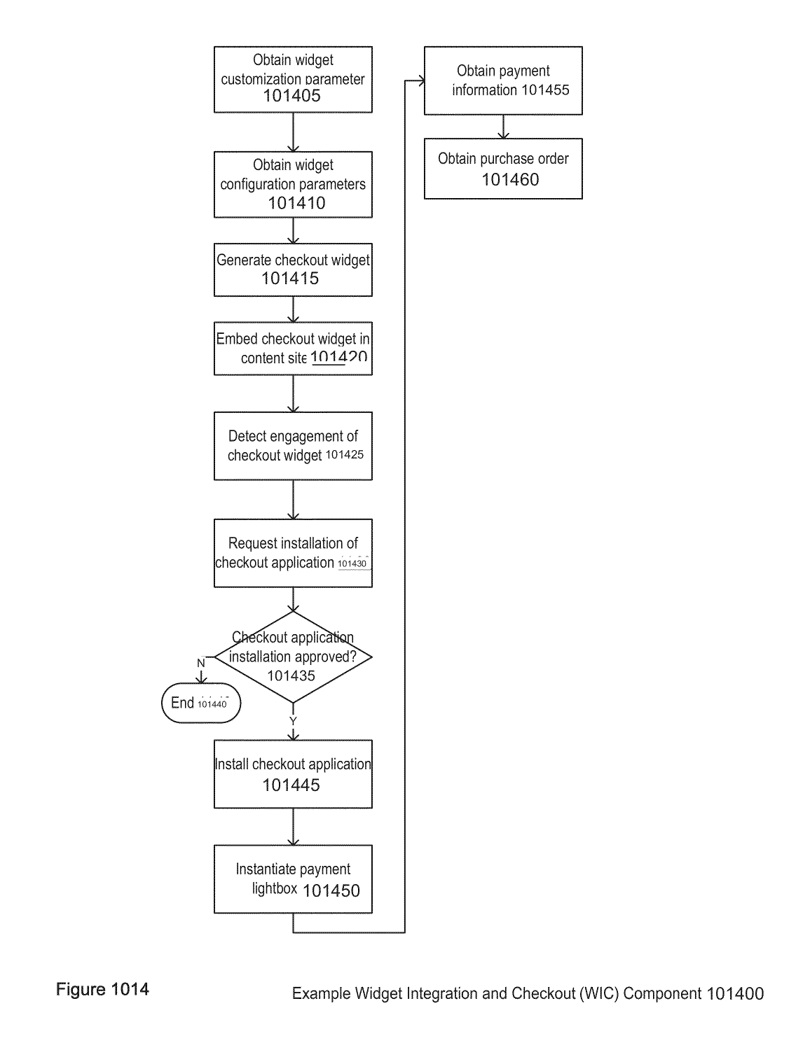

FIG. 1014 shows a logic flow diagram illustrating example widget integration and checkout in some embodiments of the Bill Pay. In one implementation, the Bill Pay may obtain widget customization parameters from a merchant at 101405. The widget customization parameters in some implementations may include parameters for creating a checkout widget, a checkout link, a checkout post or tweet, a URL, a QR code, and/or the like. The customization parameters may be embedded or associated with the widget. At 101410, the Bill Pay may obtain widget configuration parameters. The widget configuration parameters in some implementations include identification of a channel where the widget is to be embedded. For example, a social media channel, a web channel, a mobile channel, a content site channel, a retail channel, and/or the like. At 101415, the Bill Pay may generate a checkout widget using the customization and configuration parameters. At 101420, the Bill Pay may embed the widget in a content site. In some implementations, code snippets of the widget may be provided via APIs to a developer of the site for embedding. In other implementations, the user may copy and paste the widget. At 101425, the Bill Pay may detect engagement of the widget by a consumer who may wish to checkout a product corresponding to the widget. In one implementation, at 101430, the Bill Pay may request the consumer's permission to install a checkout application (e.g., a wallet application). If the installation is not approved at 101435, the consumer may need to use alternate ways to checkout (e.g., FIG. 10109B) or the process may end at 101440. If the installation is approved at 101435, the Bill Pay may install the application at 101446. At 101450, a payment lightbox 101450 may be instantiated to process the purchase transaction. In some implementations, a buy button on the installed application may need to be engaged to launch the payment lightbox. In one implementation, the payment light box may request the consumer's wallet credentials if the consumer has an existing wallet account and wishes to use information in the wallet to conduct the purchase transaction. Additionally, the consumer may input payment and other details necessary for the purchase in various fields in the lightbox. At 101455, the Bill Pay may obtain the payment information and other details necessary for the checkout to be completed. At 101460, the Bill Pay may obtain a purchase order for the consumer confirming the checkout.

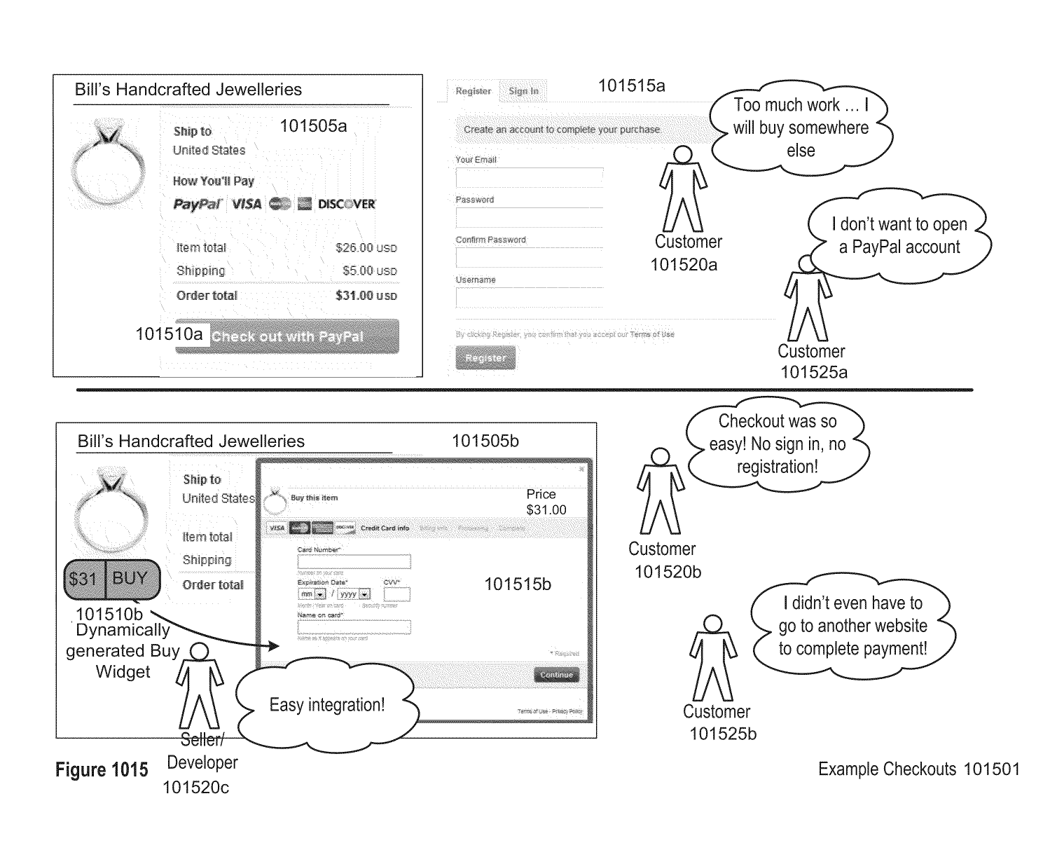

FIG. 1015 is block diagram illustrating an example checkouts in some embodiments of the Bill Pay. As shown in the figure, a web page 101505a has a checkout option using PayPal. Customers 101520a, 101525a may click on the “Check out with PayPal” button 101510a to initiate the transaction. The clicking of the button 1510a may take the customers 101520a, 101525a to another page 101515a where the user may need to register for a new account or sign in. For customers 101520a and 101525a, such a checkout option may be inconvenient and thus may lead to the customers abandoning their shopping carts before completing the purchase.

On the other hand, an example web page 101505b, also shown in FIG. 101015, may have an integrated payment acceptance that allows easy checkout. For example, customers 101520b and 101525b visiting web site or in an application 101505b may want to buy an item. In this case, he or she may click a buy button 101510b (e.g., V.me buy button) that is dynamically generated and coded into the web page. A payment application 101515b (e.g., a lightbox) may be invoked and may be overlayed on top of the web page 101505b. The customers may select a payment method and enter payment information on the payment window 101515b to complete the purchase. The checkout process is thus made simpler for the customer, with no registration or signing in required. In instances where there is a card on file, a wallet functionality may be invoked by the buy button, and the purchase may be completed in one click or action via the wallet. The customer may then receive the item, and the transaction may be settled through the merchant's account.

In addition to the ease of checkout for customers, the seller and/or developer may have obtain the advantages of easy integration of payment acceptance as the seller needs to insert a few Bill Pay platform tags and a few code snippets to generate a buy button that accepts various forms of payments including customer's wallet and gets the seller paid. In some implementations, sellers and/or merchants may obtain and analyze buying trends and other analytics through data collected from the buy widget based purchases.

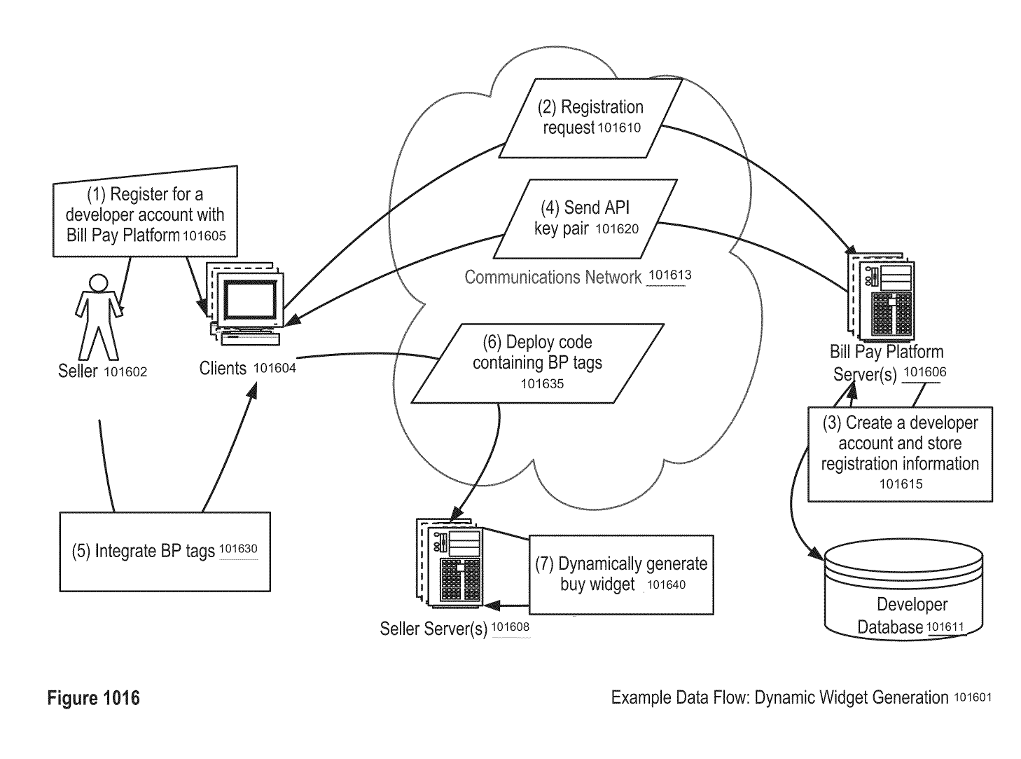

FIG. 1016 shows a data flow diagram illustrating dynamic widget generation in some embodiments of the Bill Pay. In one embodiment, a seller 101602 (or a developer) may use a client 101604 to register as a developer in the Bill Pay Platform at 101605. During registration, the seller may provide login and/or other identifying information such as a name, country, currency, email address, password, userid, postback URL, and/or the like. The client 101604 may then generate a registration request 101610 using the information supplied by the user during registration. An example registration request 101610, substantially in the form of an HTTP(S) POST message including XML-formatted data, is provided below:

```
POST /registration_request.php HTTP/1.1
Host: www.v.me
Content-Type: Application/XML
Content-Length: 667
<?XML version = “1.0” encoding = “UTF-8”?>
<registration_request>
        <request_ID>4NFU4RG94</request_ID>
        <timestamp>2011-12-12 15:22:43</timestamp>
  <user_details>
        <user_ID>JDoe</user_ID>
        <password>JDoeloves2sing</password>
        <firstname>Joe</firstname>
        <lastname>Doe</lastname>
        <email>JDoe@gmail.com</email>
        <country>Canada</country>
        <currency>Canadian dollars</currency>
        <postback_URL>http://billsjewellery.com/response</
        postback_URL>
        <client_detail>
              <client_IP>192.168.23.126</client_IP>
              <client_type>smartphone</client_type>
              <client_model>HTC Hero</client_model>
              <OS>Android 2.2</OS>
              <app_installed_flag>true</app_installed_flag>
        </client_detail>
    </user_details>
</registration_request>
```

Upon receiving the registration request from the seller, the Bill Pay platform server may, at 101615, create a developer account and store the details of the account in a developer database 101611. The Bill Pay platform server may further generate and/or provide an API key pair to the client 101604 at 101620. In one implementation, the API key pair may include a public key and a shared secret key. The public key may be used as an apikey parameter value in an initialization tag and buy button tag discussed in further detail below. The shared secret key may be used to generate encrypted tokens necessary for authenticating the seller with the Bill Pay platform server. Example tags which use the shared secret key as one of the parameters are shown below:

| Tag/ | | |
|---|---|---|
| Widget | Parameters | Description |
| v:init | sharedsecretkey, userid | |
| v:buy | sharedsecretkey, | This token may be generated with these |
| | amount, currency, | required parameters for each product |
| | product-id | with a buy button in an app, as the |
| | | parameters will vary. |

At 101630, upon receiving the API key pair from the Bill Pay platform server(s) 101606, the developer may begin coding. Coding may involve inserting a root tag (v-root) just below the <body> tag of the application or website code. In one implementation, the root tag may be placed elsewhere in the page. In another implementation, the root tag may need to be placed just below the body tag to facilitate proper loading of the lightbox. The placement of the root tag may be relative to the root element in the Document Object Model (DOM) document. An example root tag, substantially in JavaScript, is provided below:

<body>
<div id=“v-root”></div>

The developer may then add an initialize tag (v:init) below the root tag (v-root) and before any buy button tags. The initialize tag may identify the user and page attributes for handling events using various parameters. For example, the initialize tag may set the API key and token to authenticate the seller with the Bill Pay. Exemplary parameters for the initialize tag include, without limitation, apikey, token, userid, logo-url, country and callback. The apikey may be a string value that identifies the general API access configuration and developer settings for the site or application.

The token may be the encrypted token for the user account. It may be a string that is created by the MD5 Message Digest Algorithm hash of API secret shared key and userid. In one implementation, the parameters to the hash may not include any spaces, quotes or delimiters. These tokens may also be used as values for tokenid in Bill Pay's buy button parameters. A Bill Pay MD5 hash may be generated by running an appropriate function on a concatenated string of particular parameter values such as the shared secret key and userid in a proper sequence. In one implementation, the sequence may not have any spaces or delimiters. Example Bill Pay MD5 hash syntax for languages such as JAVA, PHP, RUBY and PYTHON is provided below:

| Language | Standard Syntax for Generating MD5 Hash |
|---|---|
| Java | import org.apache.commons.codec.digest.*; |
| | hash = DigestUtils.md5Hex(string1+string2+string3...); |
| PHP | $hash = md5($string1.$string2.$string3...); |
| Ruby | require ‘digest/md5’ |
| | hash = Digest::MD5.hexdigest(string1+string2+string3...) |
| Python | import md5 |
| | hash = md5.new(string1+string2+string3...) |

The userid parameter is an application or game user registered and/or developer authenticated parameter. The userid may be a string representing a unique non-changing user in the developer's system. The logo-url is a string that indicates the absolute path to an image to be displayed in the payment widget. The logo-url in some implementations may be optional. The country parameter may be a string that sets the country where the application is running and may be auto-detected. The default value may be set to, for example, the United States. The callback parameter may be a string function that listens for events triggered by Bill Pay platform widgets. The callback parameter may, in one implementation, be a globally accessible static JavaScript function. An example initialize tag, substantially in JavaScript, including one or more of the above described parameters is provided below:

<v:init apikey = “bbb8aae57c104cda40c9”

token = “ed0f2847b36f27e19e5613e9e73aeda1”
userid = “JDoe1970”
callback=“handleVmeEvents”>

</v:init>

The initialize tag may also include the userid of the developer and a callback function discussed in further detail below. The developer may continue coding by inserting a script tag just above the </body> tag. The script tag may link to the Bill Pay platform JavaScript Software Development Kit (SDK) for loading the Bill Pay platform JavaScript SDK library into the application or web page. In one implementation, the library may scan a web page for buy button tags and replace them with buy buttons customized for the product items in an application or site. An example script tag, substantially in JavaScript, is provided below:

<script type=“text/javascript”
src=“http://api8.ultimatepay.com/js/1/v-widgets.js”></script>
</body>

The developer may also add a Bill Pay platform buy button tag (v:buy) to dynamically generate a buy button or widget that allows a customer to buy selected products. A number of parameters may be included in the buy button tag. Example parameters include apikey, token, amount, currency, product-id, product-desc, merch-trans, dom-id, callback, and/or the like. These parameters may be of string type. In some implementations, parameters such as product-desc, merchant-trans, dom-id and callback may be optional. An apikey key may identify API access configuration and developer settings for an application and may be the key that is provided during the on-boarding process. A token is an encrypted purchase token for a purchase. It may be created by the md5 hash of API secret shared key, amount, currency, product-id, and/or the like. An amount is the price of an item being purchased. In one implementation, the value of the amount may be displayed on the widget and is the payment that is requested from the customer's account on behalf of the seller. A currency is a parameter that sets the currency for display. A product-id is a unique non-changing identifier for an item or product in the seller's catalog or store. A product-desc is an end user friendly description of goods or services corresponding to a product-id. A merch-trans may be a transaction id for tracking purchase activity. This id may pass through the system and may be available to developers in all status replies. A dom-id may be a DOM element id that is used as a trigger for a purchase action. For example, if a valid dom-id is specified, the default or themed Bill Pay platform buy widget may not be displayed. A callback is a globally accessible static JavaScript function that listens for events triggered by Bill Pay platform widgets. An example buy button or widget tag, substantially in JavaScript, and including some of the parameters discussed above, are provided below:

<v:buy apikey = “aK2Leiv89j2A1_lOn4s1”

token = “12f049788f4b67dc9cc58529769fb9d2”
amount = “100”
currency = “USD”
product-id = “sku856781”
callback = “handleVmeEvents”>

</v:buy>

At 101630, the developer may inset these tags (v:root, v:init, script and v:buy) to the existing code. The completed code may then be deployed to the seller server(s) 101608 at 101635. At 101640, the inserted code snippets may dynamically generate a Bill Pay platform buy button or widget. In some embodiments, the buy button tag may be dynamically generated server-side in the code. For basic product offerings with no changes to any of the values, the buy button may be generated once and used many times. Using a test tool (e.g., such as is described herein and with respect to FIG. 101020), the developer may generate static buy button tags for a site. In some other embodiments, the test tool may be used to check the hashing algorithm in the code, or simply to become better accustomed to the Bill Pay platform buy button fields. In yet other embodiments, the buy button widget may be customized with a logo-url (e.g., in the initialize tag), product description, and/or the like.

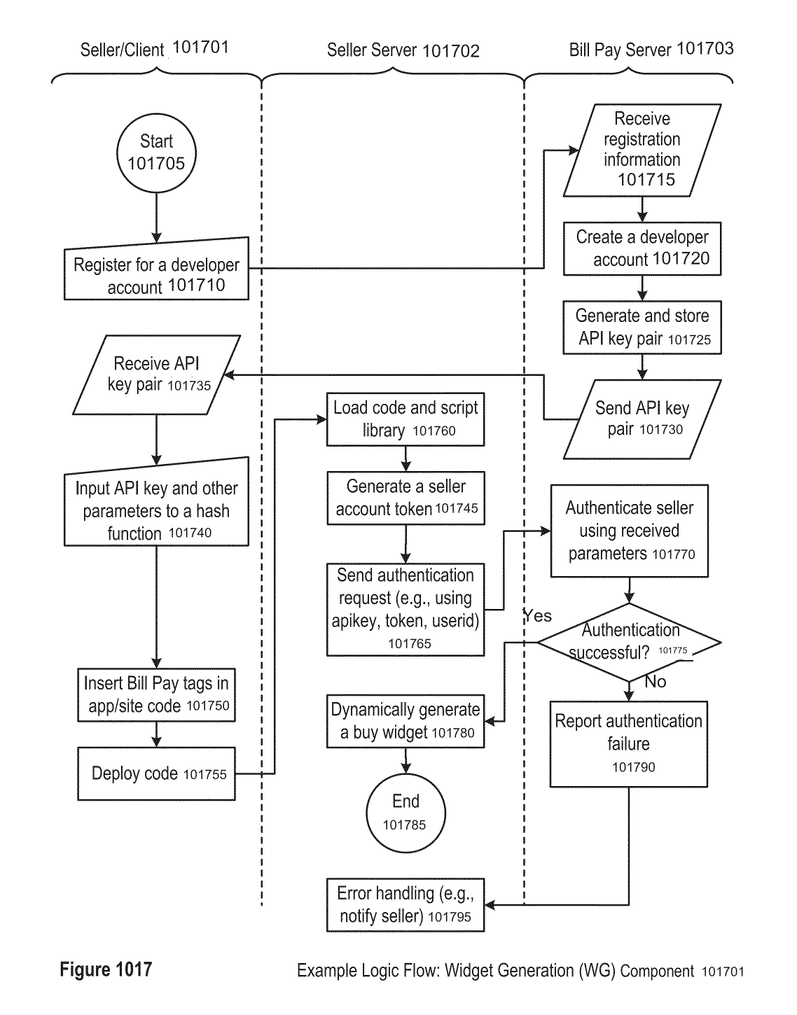

FIG. 1017 shows a logic flow diagram illustrating dynamic widget generation component in some embodiments of the Bill Pay. In one embodiment, starting at 101705, the seller using his or her client device 101701 registers for a developer account with the Bill Pay server 101703 at 101710. The registration includes the seller supplying registration information such as name, email, userid, password, country, currency, postback URL, and/or the like. The registration information is received at 101715 by the Bill Pay server 101703. The Bill Pay server 101703 may then parse the received information and use the parsed information to create a developer account at 101720. At 101725, an API key pair including a public key and a shared secret key may be generated and stored in association with the seller account in one or more databases and/or tables. The API key pair may then be transmitted to the seller at 101730. The seller may, upon receiving the API key pair at 101735, input the shared secret key and other parameters to a hash function (e.g., MD5 hash) at 101740. The seller may, at 101750, insert tags (v:root, v:init, script and v:buy) in his or her app or site code. The completed code may then be deployed at 101755 to the seller server(s) 101702.

The seller server(s) 101702 may load the code and JavaScript libraries at 101760. At 101745, the seller account token may be generated for each product item listed in the application or site. At 101765, an authentication request may be sent to the Bill Pay server(s) 101703 to authenticate the seller. The authentication request may include parameters such as apikey, token, userid, and/or the like. The Bill Pay server(s) 101703 may receive the request and may authenticate the seller using the received parameters at 101770. If the authentication is successful at 101775, the Bill Pay server(s) may transmit a successful authentication message and the seller server(s) 101702 may dynamically generate a buy widget at 101780, ending the process at 101785. If, however, the authentication is unsuccessful, the Bill Pay server(s) 1703 may report authentication failure to the seller server(s) 101702 at 101790. The seller server(s) 101702 receiving authentication failure message may invoke processes for handling error, such as notifying the seller by email, or logging the error.

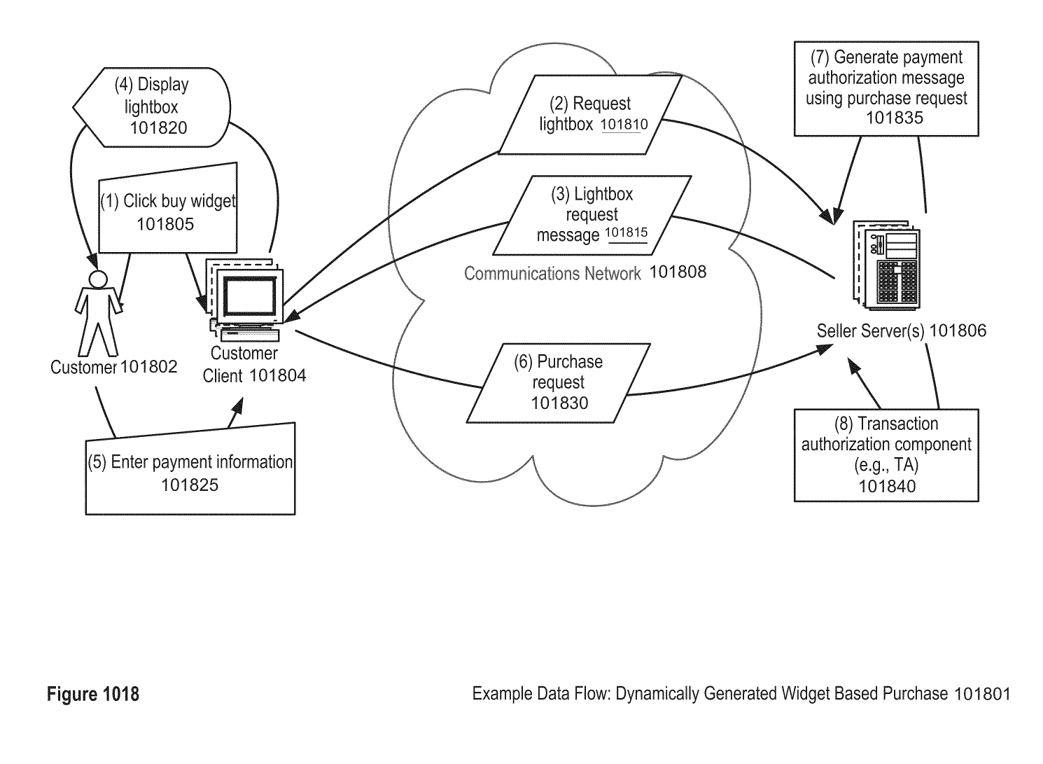

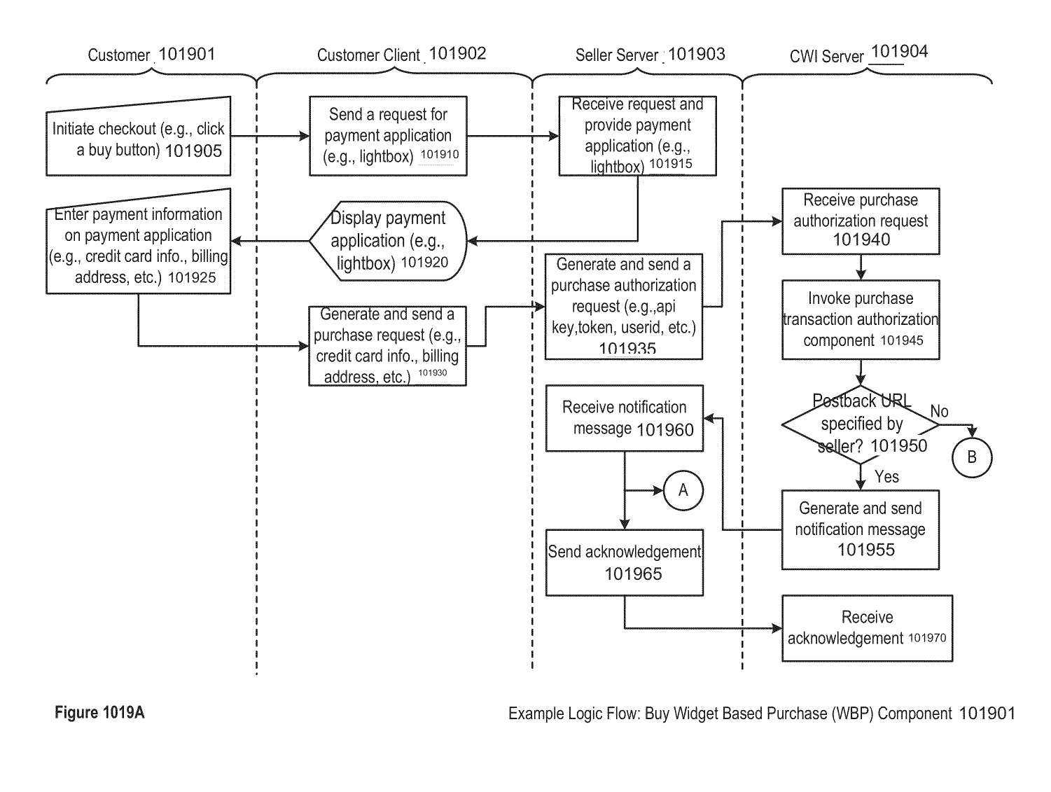

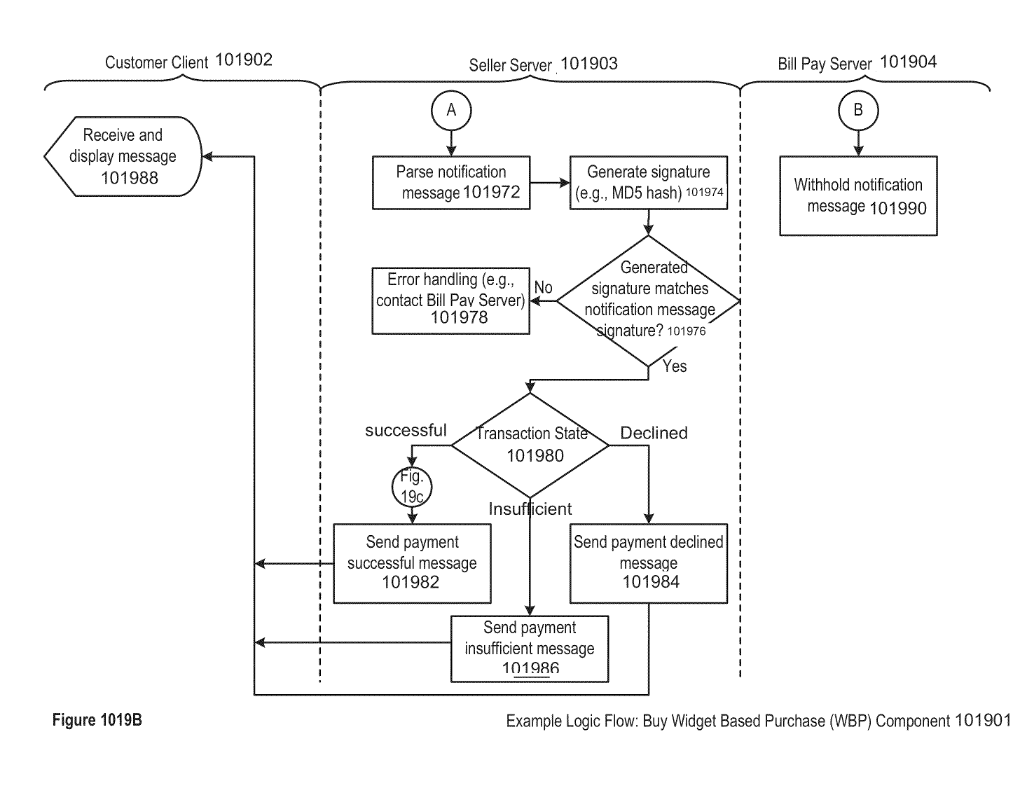

FIG. 1018 shows a data flow diagram illustrating dynamically generated widget based purchase in some embodiments of the Bill Pay. A customer 101802 may wish to check out a product from a seller's web site. The customer may click the buy widget on the seller's web site at 101805 to initiate purchase. The customer's client device 101804 may then generate and send a payment widget (e.g., lightbox) request at 101810 to the seller's server 101806. An example payment widget request 101810, substantially in the form of an HTTP(S) POST message including XML-formatted data, is provided below:

```
POST /paymentwidget_request.php HTTP/1.1
Host: www.bobsjewelleries.com
Content-Type: Application/XML
Content-Length: 667
<?XML version = “1.0” encoding = “UTF-8”?>
<paymentwidget_request>
        <timestamp>2011-12-12 15:22:43</timestamp>
        <amount>100</amount>
        <currency> USD</currency>
        <product-id> sku856781</product-id>
  <client_detail>
        <client_IP>192.168.23.126</client_IP>
        <client_type>smartphone</client_type>
        <client_model>HTC Hero</client_model>
        <OS>Android 2.2</OS>
        <app_installed_flag>true</app_installed_flag>
        </client_detail>
  </client_detail>
</paymentwidget_request>
```

The seller's server 1806 may respond with a payment widget (e.g., lightbox) at 101815. The payment widget (e.g., lightbox) may then be displayed at the client 101804 at 101820. The customer may then enter payment information into the displayed payment widget at 101825. At 101830, the client 101804 may take the entered payment information, and generate a purchase request message for transmission to the seller server(s) 101806 at 101830. An example purchase request 101830, substantially in the form of an HTTP(S) POST message including XML-formatted data, is provided below:

```
POST /purchase_request.php HTTP/1.1
Host: www.bobsjewelleries.com
Content-Type: Application/XML
Content-Length: 667
<?XML version = “1.0” encoding = “UTF-8”?>
<purchase_request>
        <timestamp>2011-12-12 15:22:43</timestamp>
        <nameoncard>John Doe</nameoncard>
        <creditcard_number>4444444444444448</creditcard_number>
        <expiration_month>05</expiration_month>
        <expiration_year>2014</expiration_year>
        <cvv>2345</cvv>
        <street_address>22 Pleasantville</street_address>
        <city>Beverley Hills</city>
        <zipcode>90210</zipcode>
  <client_detail>
        <client_IP>192.168.23.126</client_IP>
        <client_type>smartphone</client_type>
        <client_model>HTC Hero</client_model>
        <OS>Android 2.2</OS>
        <app_installed_flag>true</app_installed_flag>
        </client_detail>
  </client_detail>
</purchase_request>
```

The seller server(s) may generate a payment authorization message using the purchase request at 101835. Further, at 101840, the seller server(s) may invoke purchase transaction authorization component which facilitates payment processing via payment gateway and settlement of funds between associated acquirers and issuers.

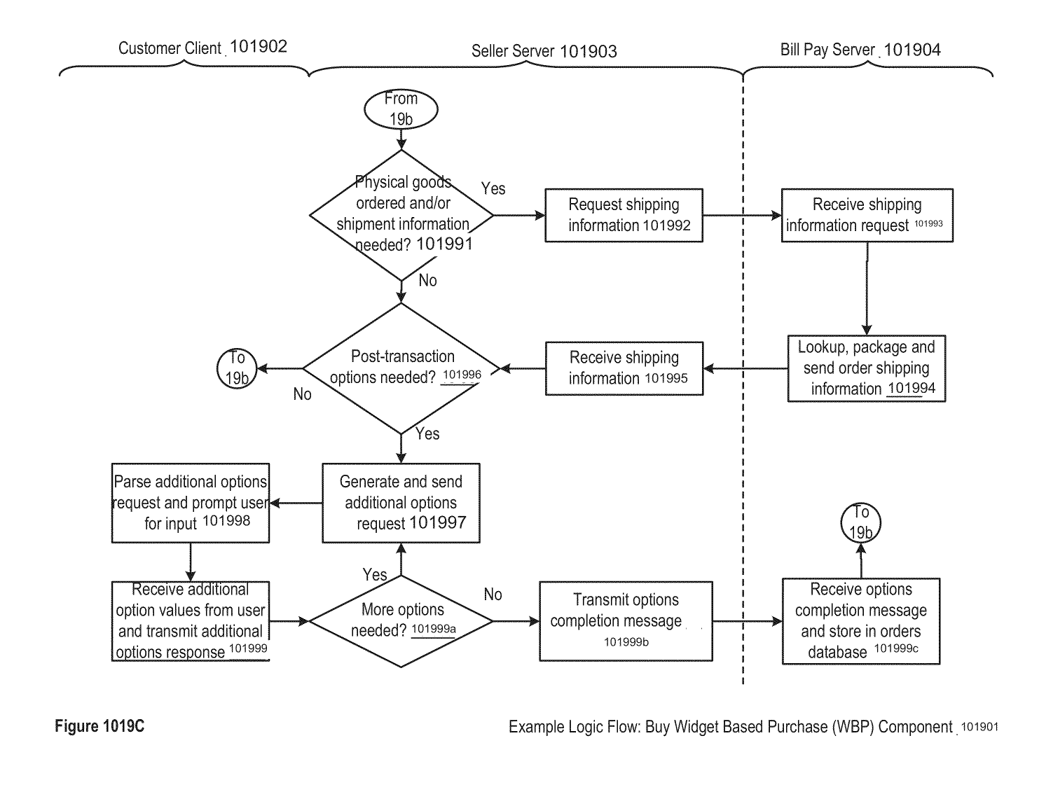

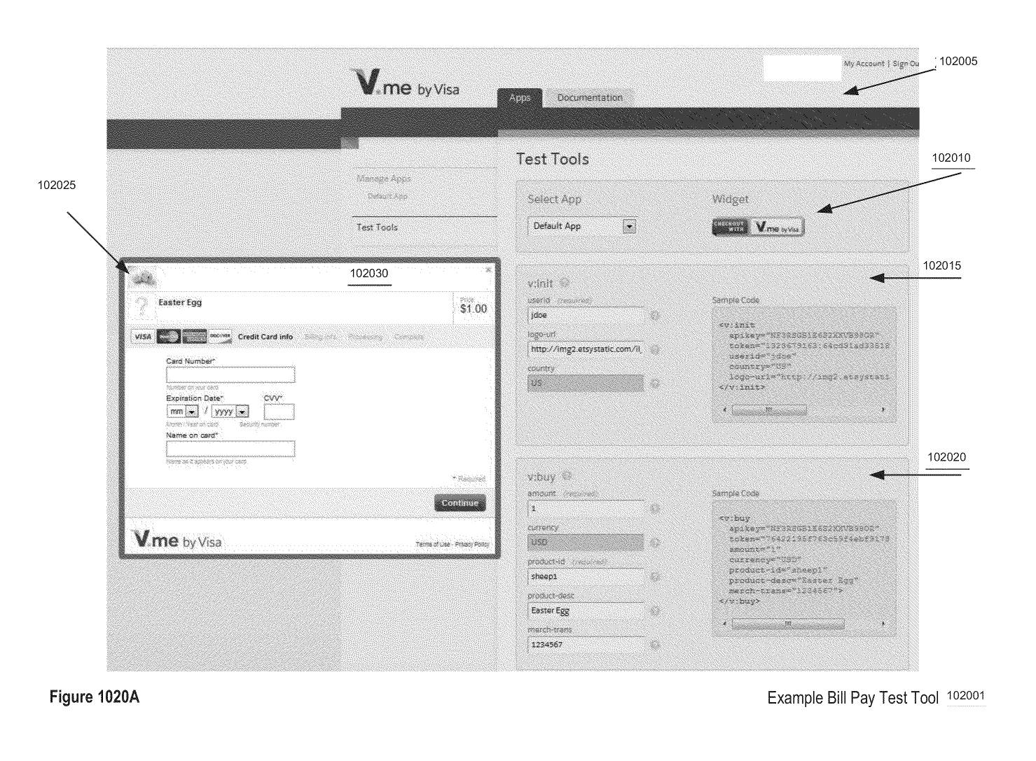

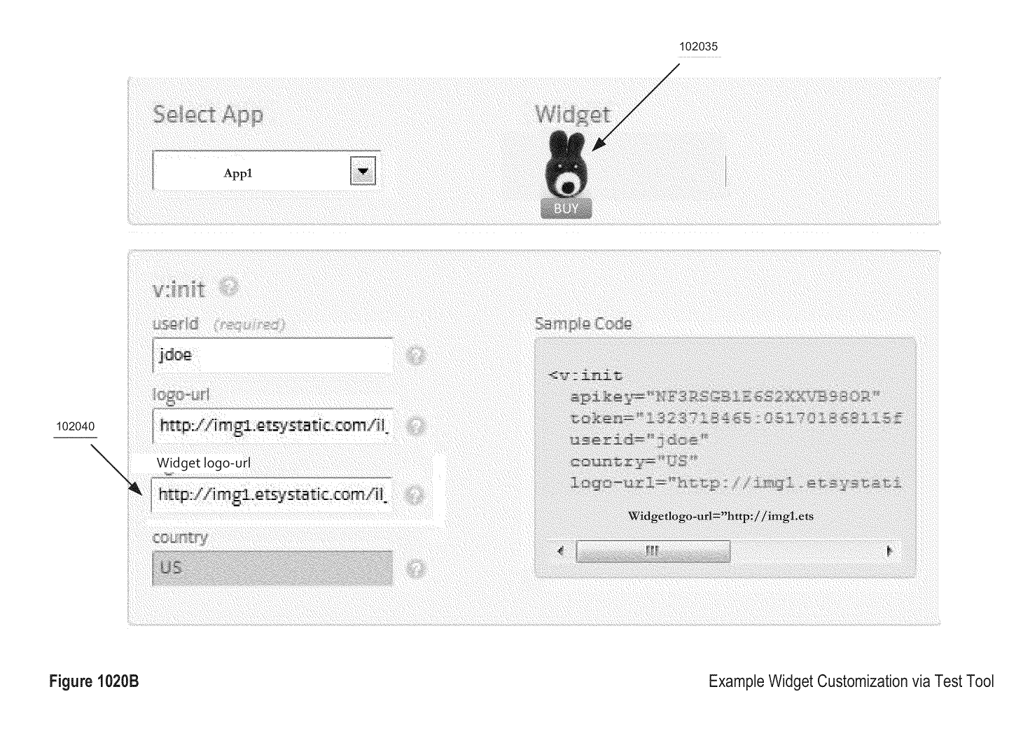

FIGS. 1019a-b show logic flow diagrams illustrating dynamically generated widget purchase in some embodiments of the Bill Pay. In one embodiment, a customer 101901 may initiate checkout of an item from a seller site at 101905. The checkout may be initiated by clicking or tapping on a buy widget using a customer client 101902. The click on the buy widget may generate a request for a payment application (e.g., a lightbox) at 101910 from seller server(s) 101903. At 101915, the seller server(s) 101903 may receive the request and may provide the requested payment application to the customer client 101902 at 101915. The customer client 101902 may display the payment application at 101920. When the payment application is displayed on the customer client 101902, the customer 101901 may enter payment information in one or more fields of the payment application at 101925. Credit card information, billing address, and/or the like may be provided by the customer to complete purchase. The customer client may then take the customer payment information and generate a purchase request at 101930. The purchase request may then be sent to the seller server(s), which may generate a purchase authorization request and send the request to the Bill Pay server(s) 101904 at 101935. The Bill Pay server(s) may receive the purchase authorization request at 101940, and may invoke a purchase transaction authorization component at 101945.

Some embodiments of the Bill Pay platform may handle notifications and callbacks. The notifications and callbacks may facilitate customization of payment experience, data collection and a better user experience. Notifications may be available from the Bill Pay platform for each transaction. There are multiple options for receiving a notification. One of these options are callback functions. Some of the callback methods are discussed in further detail below.

At 101950 the Bill Pay server(s) may determine whether a postback URL has been specified by the seller. If a postback URL has been specified, the Bill Pay server(s) may generate and send a notification message at 101955. The notification message may be received at 101960 by the seller server(s). Upon receiving the notification message, the seller server(s) may send an acknowledgement back to the Bill Pay server(s) at 101965 to confirm receipt of the message. In some implementations, the Bill Pay server(s) may resend the notification message a finite number of times until an acknowledgement is received. If the seller has not set up a postback URL, the Bill Pay server may not be able to communicate any notifications to the seller, and the notification may be withheld at 101990.

After receiving the notification message at 101960, the example logic flow of FIG. 1019a continues at FIG. 1019b, where the seller server(s) parses the notification message at 101972 to extract fields of information including a signature in the notification message. At 101974, the seller server(s) may generate a signature key in the same way the Bill Pay generated the signature key in the notification message. At 101976, the two signatures are compared to determine if they match. If there is no match, error handling processes may be invoked at 101978. For example, the seller may need to contact the Bill Pay server(s) to resolve the issue. On the other hand, if the two signature keys match, the notification message is authenticated. At 101980, the seller server(s) may determine the state of the transaction by examining the parsed notification message. When the transaction state is insufficient or declined, messages 101986 and 101984 respectively may be sent to the client device for display. If the transaction state in the message is successful, the logic flow may continue with respect to FIG. 1019c.

With respect to FIG. 1019C, the seller server may determine if the goods that have been ordered are physical goods or goods that may require the seller to retrieve a shipping address. An example of physical goods may be a DVD player, a product delivered by a commercial carrier such as UPS or FedEx, a hand delivered product such as a gift basket, and/or the like. If physical goods are being ordered, the seller server 101903 may poll the Bill Pay server 101904 for shipping information. For example, the seller server 101903 may issue a request for shipping information, e.g., 101992. In one embodiment, the shipping information request 101992 may be in the form of a web services call, such as SOAP, XML-RPC, or REST. An example shipping information request 101992, substantially in the form of an HTTP(S) POST message including XML-formatted data, is provided below:

```
POST /shipping_info_request.php HTTP/1.1
Host: www.server.com
Content-Type: Application/XML
Content-Length: 667
<?XML version = “1.0” encoding = “UTF-8”?>
<transaction_detail_request>
  <paytxnid>6565E324756</paytxnid>
  <adminid>7643</adminid>
</transaction_detail_request>
```

In one embodiment, the Bill Pay server will then receive the shipping information request, e.g., 101993. The Bill Pay server 101904 may send the shipping information request to a third-party server for processing or may process the request locally. For example, the Bill Pay server may extract the identifier specifying the order for which shipping information is requested, e.g., paytxnid and/or the like, or may look-up the order in an orders database using session information and/or the like. The Bill Pay server may then reply to the seller server with shipping information for the order, and/or other information available about the order. In one embodiment, shipping information is not requested and instead other information about an order processed at the Bill Pay server or elsewhere is requested. For example, user information, session information, product information, and/or the like may be requested. In one embodiment, the response from the Bill Pay server may be sent to the seller server 101903. An example shipping information response, e.g., 101994, 101995, substantially in the form of an HTTP(S) POST message including XML-formatted data, is provided below:

```
POST /response.php HTTP/1.1
Host: www.server.com
Content-Type: Application/XML
Content-Length: 667
<?XML version = “1.0” encoding = “UTF-8”?>
<transaction_detail_response>
  <status>CAPTURED</status>
  <call-id>114564353</call-id>
  <paytxnid>101440637</paytxnid>
  <amount>49.95</amount>
  <currency>USD</currency>
  <products>
    <product>
      <product-id>1234</product-id>
      <product-descrp>Sony DVD Player</product-descrp>
    </product>
    <product>
      <product-id>5478</product-id>
      <product-descrp>14-inch Tablet PC</product-descrp>
    </product>
    <product>
      ...
    </product>
  </products>
  <state-of-transaction>NY</state-of-transaction>
  <reconciliation-id>54874</reconciliation-id>
  <amount_detail>
    <amount>49.95</amount>
    <shipping>5.95</shipping>
    <handling>2.00</handling>
    <shippingHandling>7.95</shippingHandling>
    <tax>8.52</tax>
  </amount_detail>
  <shipping_detail>
    <shipment>
      <products_to_ship_here qty=2>
        <product>
          <product-id>1234</product-id>
          <product-descrp>Sony DVD Player</product-descrp>
        </product>
        <product>
          <product-id>5478</product-id>
          <product-descrip>14-inch Tablet PC</product-descrip>
        </product>
      </products_to_ship_here>
      <addressLine1>500 Main St.</addressLine1>
      <addressLine2>Apt 2A</addressLine2>
      <addressLine3></addressLine3>
      <city>Anytown</city>
      <state>FL</state>
      <postalCode>45784</postalCode>
      <stateProvinceCode>12</stateProvinceCode>
    </shippment>
    <shippment>
      ...
    </shippment>
  </shipping_detail>
  <payment_detail>
    <type>credit_card</type>
    <brand>VISA</brand>
    <pan4>7645</pan4>
    <bin6>547645</bin6>
    <expiration_month>05</expiration_month>
    <expiration_year>2020</expiration_year>
    <avs_response_code>300 - Approved</avs_response_code>
    <psp_ref_id>54874</psp_ref_id>
  </payment_detail>
  <risk_detail>
    <risk_level>Medium</risk_level>
    <risk_advice>
      <advice>Verify signature</advice>
      <advice>Collect drivers license number</advice>
    </risk_advice>
  </risk_detail>
  <partial_billing_details>
    <cardholder_name>John Consumer</cardholder_name>
    <billing_city>Anytown</billing_city>
    <billing_state>FL</billing_state>
    <billing_phone>7184587452</billing_phone>
  </partial_billing_details>
  <full_billing_details>
    <cardholder_name>John Consumer</cardholder_name>
    <billing_addr1>500 Main St.</billing_addr1>
    <billing_addr2>Apt 2A</billing_addr2>
    <billing_city>Anytown</billing_city>
    <billing_state>FL</billing_state>
    <billing_phone>7184587452</billing_phone>
  </full_billing_details>
</transaction_detail_response>
```

In one embodiment, the seller server 101903 may then determine that additional transaction options are needed, e.g., 101996. Additional transaction options may be additional shipping options such as express shipping or bulk-rate, the use of a pre-paid card for a partial or full payment, additional shipping detail such as an apartment number, and/or the like. If no additional transaction options are needed, the logic flow may continue with respect to FIG. 1019b.

If additional transaction options are needed, e.g., 101996, then a request from the seller server may be sent to the customer client 101902 to request the additional options. An example additional options request 101997, substantially in the form of an HTTP(S) POST message including XML-formatted data, is provided below:

```
POST /request.php HTTP/1.1
Host: www.server.com
Content-Type: Application/XML
Content-Length: 667
<?XML version = “1.0” encoding = “UTF-8”?>
<additional_options_request>
  <timestamp>2020-12-12 15:22:43</timestamp>
  <session_id>1e987543578643356</session_id>
  <options_requested>
    <option required=true>
      <id>shipping_options</id>
      <type>shipping</type>
      <values>
        <option>Express Shipping</option>
        <option>Flat Rate Shipping</option>
        <option>Ground</option>
      </values>
      <validation_code>
        <!--inline code returned, e.g., js, for validation -->
        <script>
          var shipping = null;
          if (document.popup.shipping == null)
              alert(“Please input shipping”);
          else shipping = document.popup.shipping;
        </script>
      </validation_code>
    </option>
    <option required=false>
      <id>gift_wrapping</id>
      <type>up_sell</type>
      <values>
        <option>Yes</option>
        <option>No</option>
      </values>
    </option>
    <option>
      ...
    </option>
  </options_requested>
</additional_options_request>
```

The customer client 101902 may then receive the additional options request 1997 and present the options to the user for input, e.g., 101998. For example, the customer client 101902 may display a “pop up” to the user indicating that additional options are required or optional for their order and request the appropriate input. In one embodiment, the additional options request 101997 may contain inline logic such as JavaScript or the like that will be executed by the customer client. In doing so, the seller server may collect very complex input from the user without a page reload. If additional options are needed, e.g., 101999a, the process outlined above may repeat. If no additional options are required, the seller server 101903 may transmit an options completion message to Bill Pay server 101904, e.g., 101999b, indicating that all additional options have been collected. In one embodiment, no message is sent to the Bill Pay server. The Bill Pay server may then, in one embodiment, note that the additional options have been received. In one example, the Bill Pay server 101904 may receive the options for storage or later retrieval, e.g., 101999c. The logic flow may then continue with respect to FIG. 1019b.

Continuing the logic flow with respect to FIG. 1019b, the seller server(s) may send a payment successful message at 101982 for display at the client device at 101988.

As discussed before, the Bill Pay platform supports notifications and callbacks. One way of receiving notifications is via JavaScript implemented callback functions. In some implementations, callback functions are optional for setting up and running the Bill Pay. Callback functions facilitate customization of the payment experience by collecting relevant data and/or make the experience more powerful using a JavaScript event handler function. Using the data returned from the Bill Pay platform, a developer may code the JavaScript event handler in a page to read any data returned by the callback and display it, log it, or take an action based on it. Additionally, developers may present a customized action such as, for example, an offer to a user if the user buy a product now. This type of callback uses a front end push mechanism. Example returned event types that may be handled with the callback functions are provided below:

| Debit | |
|---|---|
| Event | |
| Type | Description |
| debit.init | Always fires. For example, every time a call is made, there |
| | is a debit API in the background. The JSON object returns |
| | the call id, a transaction id, user token, and/or user id. |
| debit.success | Fires when the amount was successfully debited from the |
| | user's account. In other words, the payment was made. |
| debit.cancel | Fires when the Cancel button is clicked in the lightbox. |
| debit.fail | Fires when the payment fails. |

An example code portion including a developer created callback function called handleVmeEvents is shown below. The callback function is triggered in the buy button tag using the callback parameter. The function name is created by the developer, with the only requirement being that it match the value of the callback parameter in the V.me buy button tag.

```
<html>
<head>
<script type=“text/javascript”>
handleVmeEvents = function(eventType,data){
    var MerchantTrans = data.merchTrans;
    if (eventType == “debit.success”){
        alert ( msg );
        mywindow = window.open (“./checkyourorder.php?-
merchTrans=” + MerchantTrans,“Check your Order
ID”,“width=400,height=300”);
        mywindow.moveTo(300,300);
    }
}
</script>
</head>
<body>
<div id=“v-root”></div>
<v:buy apikey = “CG6KBNNKJ5ZSSJC5XTEX”
    token = “eeeeb512b710d0fde173eff8b411ec01”
    amount = “100”
    currency = “USD”
    product-id = “sku29995”
    product-desc = “10 Items, sku: 29995”
    callback = “handleVmeEvents”>
</v:buy>
```

The Bill Pay platform may also support back end push notifications in some embodiments. This may be a mandatory server-to-server communication that sends notifications regarding payment events. The Postback URL for this exchange may be configured during the seller on-boarding process. Back-end notifications are automatically sent from Bill Pay back-end servers to the seller's back-end servers when the seller's customer makes a payment using the v:buy button tag. To confirm the communication, the Bill Pay server(s) expects an acknowledgement back from the seller's server. If the notification is not received, there is an exponentially increasing time between a decreasing number of retries, and eventually it is abandoned. The seller may use the developer console to specify the following configuration parameters that the Bill Pay servers may use to send back-end notifications to the seller's servers:

| Parameter | Description |
|---|---|
| Postback URL | Back-end notifications are sent to the URL specified by |
| | the seller. V.me may not send back-end notifications if |
| | the seller has not specified a back-end URL. |
| Postback | POST or GET |
| Method | |
| Postback | (Only if Postback Method is POST) JSON or XML |
| Contenttype | |

An example back-end notification message sent from the Bill Pay back-end server to a seller's back-end server using the POST method in JSON format is provided below.

```
{ “apikey” : “JZ5K6DNHY2JEUSBUE3Y8”,
  “token” : “aDsL5kJfh8kyWei8UrYk0cmNbatQldy”,
  “userid” : “testuser”,
  “callId” : “101830367”,
  “type” : “DEBIT”,
  “status” : “200”,
  “state” : “PROCESSED”,
  “product-id” : “sku28756”,
  “productDesc” : “Item”,
  “amount” : “1000”,
  “currency” : “USD”
  “merchTrans” : “129446-832362-389”,
  “signature” : “acTf73f590425Bc8913P6a7b9dIb4c26”,
}
```

As discussed with respect to FIG. 1019b, example values of the “state” field may include “processed,” “declined,” or “insufficient” based on the type of activity. In some implementations, the value of the signature key in the notification message above may be the MD5 hash of the ordered concatenated string of the shared secret key and values of certain keys in the message as illustrated by the following pseudocode:

signature=md5(shared secret key+userid+amount+currency+callId+merchTrans+product-id)

In some implementations, the responsibility to recreate the notification message's signature and compare it to the signature in the notification message that was sent from the Bill Pay server(s) may reside with the seller. If the signatures are not an exact match, the seller may need to contact Bill Pay server(s)/contact immediately to determine the reason for the mismatch.

An example back-end notification message sent from the Bill Pay back-end servers to a seller's back-end servers using the POST method in XML format is shown below.

```
<notification-payload>
  <apikey>JZ5K6DNHY2JEUSBUE3Y8</apikey>
  <token>aDsL5kJfh8kyWei8UrYk0cmNbatQldy</token>
  <userid>testuser</userid>
  <call-id>101830367</call-id>
  <type>DEBIT</type>
  <status>200</status>
  <state>PROCESSED</state>
  <product-id>sku28756</product-id>
  <product-desc>Item</product-desc>
  <amount>1000</amount>
  <currency>USD</currency>
  <merch-trans>129446-832362-389</merch-trans>
  <signature>acTf73f590425Bc8913P6a7b9dIb4c26</signature>
</notification-payload>
```

An example back-end notification message sent from the Bill Pay back-end servers to a seller's back-end servers using a non-browser based GET method is shown below.

apikey=JZ5K6DNHY2JEUSBUE3Y8&token=aDsL5kJfh8kyWei8UrYk0
cmNbatQldy&userid=testuser&callid=101830367&type=DEBIT&
status=200&state=PROCESSED&product-id=sku28756&
productdesc=Item&amount=1000&currency=USD&merchtrans=
129446-832362-389&signature=acTf73f590425Bc8913P6a7b9dIb4c26

In some implementations, the notifications that are pushed from Bill Pay server(s) to the seller can be pulled at will by the seller from the same API used by Bill Pay server(s). The pull at will facility may allow the developer the freedom to choose when to view information on a transaction. The Bill Pay server(s) may automatically call the getStatus API for debit events when users purchase something using the buy button. In some implementations, a GET request method for making the call may follow the following syntax:

<UltimatePayServerURL>wallet/api/getStatus?callid=
{callid}&callno={callno}&apikey={apikey}&token>=
{user token}&userid={User id}

An example request using the syntax above is shown below.

http://server1.sitename.com/wallet/api/getStatus?callid=
100006&callno=1&apikey=1&token=u:c6a5941420cf4
cc12486abe8e09a8299&userid=JohnDoe

The Bill Pay server(s) may then send this data to sellers via a POST message in XML format. An exemplary POST message substantially in XML format is shown below.

```
<?xml version=“1.0” encoding=“UTF-8”?>
  <activity>
  <apikey>ksdlkjdf7asdkk3dADT9I8jj5</apikey>
  <token>al3kjdfdkf844WNlkjadfl7kjf939038aUkljd</token>
  <userid>JohnDoe</userid>
  <call-id>3</call-id>
  <type>DEBIT</type>
  <status>200</status>
  <state>FROCESSED</state>
  <product-id>sku744932</product-id>
  <product-desc>Item</product-desc>
  <merch-trans>567456-456456-544</merch-trans>
  <signature>1dec14a5c5c417f69cbd3d30a474519c</signature>
  <transaction>
    <amount>50</amount>
    <currency>USD</currency>
  </transaction>
</activity>
```

Sellers may then parse these messages and handle message data. In some other implementations, sellers may proactively call the getStatus API in case the purchase data does not reach them for some reason.

An example code illustrating various tags, including root tag, initialize tag, buy button tag, JavaScript SDK tag and callback function implemented in JavaScript is shown below.

```
<html>
<head>
<script type=“text/javascript”>
handleVmeEvents = function(eventType,data) {
  var MerchantTrans = data.merchTrans;
  var ProductID = data.product-id;
  if (eventType == “payment.success”) {
    var msg = “Payment Succeeded ” + ProductID + “Order id ” +
MerchantTrans; alert (msg); }
}
</script>
</head>
<body>
<div id=“v-root“></div>
<v:init
  apikey = “RGDJIXJW3U63WTCX3PS0”
  token = “98fef8ac38289318a7a4cb661f9fa0d1”
  userId = “JohnDoe”
  callback = “handleVmeEvents”?
</v:init>
<h3> Welcome to Bill's Jewelries Site! Purchase content here!</h3>
<table width=“415” border=“1” width=“50” height=“50”>
<tr><td>Order ID: 1234 , 10 Items, SKU: 29995</td>
<td style=text-align:right>
<b style=font-size:2em>10 Items</b>
<v:buy
  apikey = “CG6KBNNKJ5ZSSJC5XTEX”
  token = “eeeeb512b710d0fde173eff8b411ec01”
  amount = “100”
  currency = “USD”
  product-id = “sku29995”
  product-desc = “Item, sku: 29995”
  callback = “handleVmeEvents”>
</v:buy>
</td></tr>
<br><br>
<script type=“text/javascript” src=“http://sandbox-static.v.me/js/1/v-
widgets.js”?
</script>
</body>
</html>
```

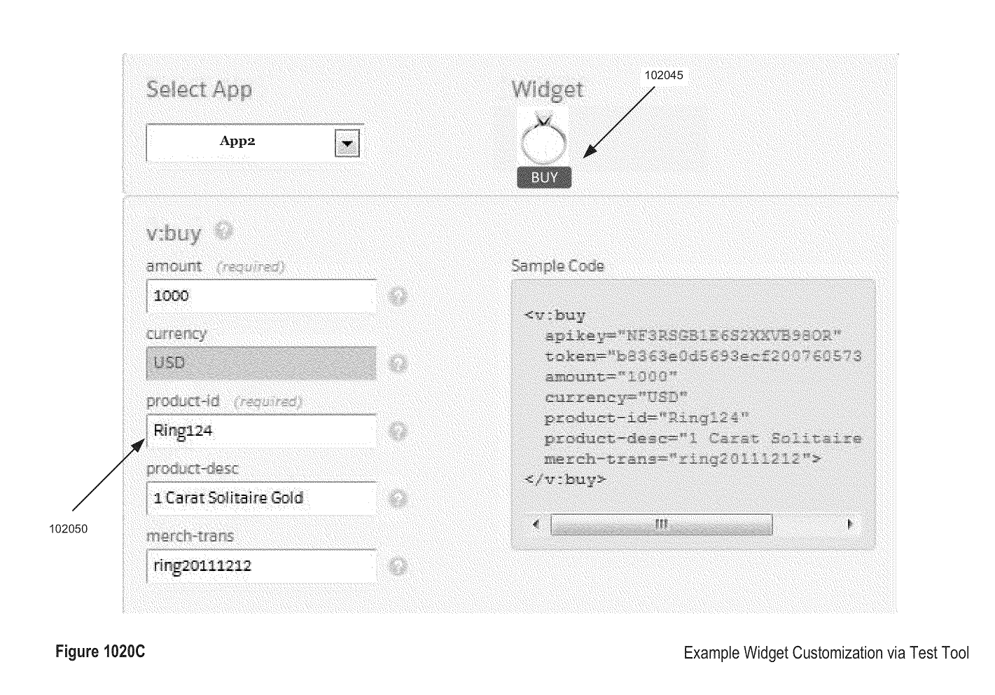

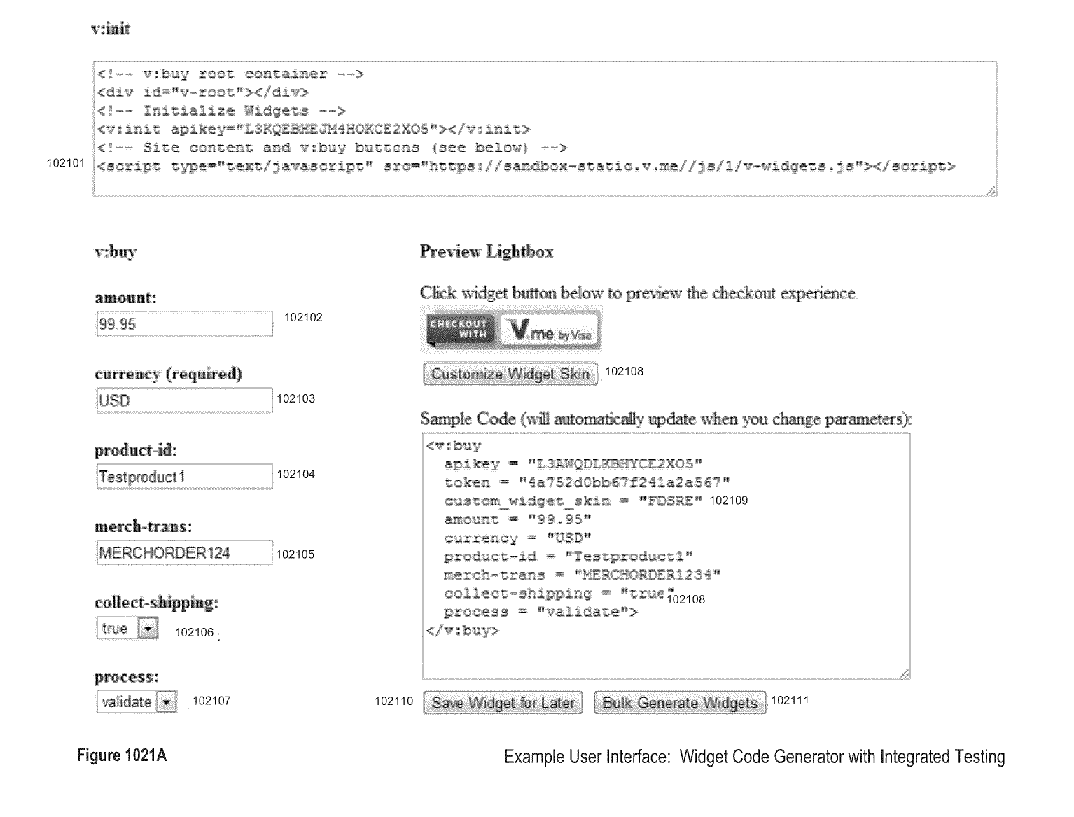

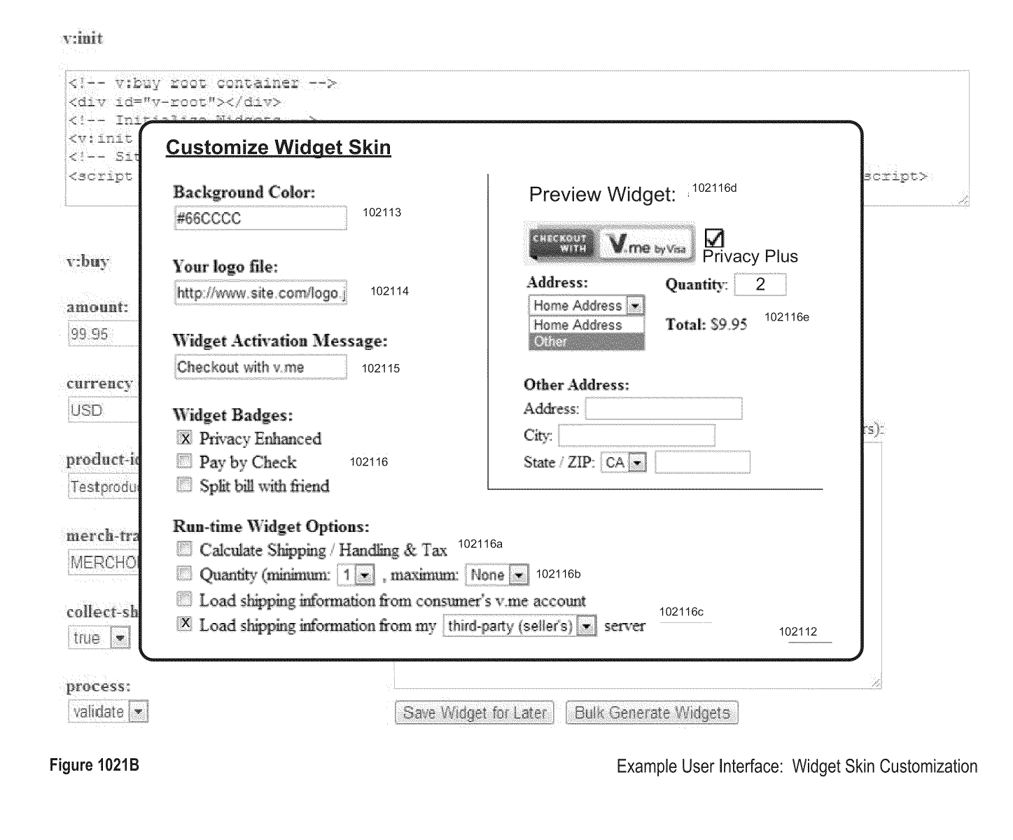

FIGS. 1020a-c show screen shots illustrating example widgets generated via a test tool in some embodiments of the Bill Pay. An example test tool web page 2005 is shown in FIG. 1020a. The test tool web page includes a series of fields for selecting an application and entering values for v:init tag 102015 and v:buy tag 102020. Next to the fields for each tag are corresponding sample code snippets generated on the fly based on the user provided inputs in the fields. The buy widget 102010, in this example, may be a default widget that is not customized. When a user clicks on the buy widget, a lightbox 102030 is displayed. The lightbox 102030 is customized based on user inputs. For example, the image 102025 on the lightbox corresponds to the image in the logo-url specified in the v:init tag 102015. Similarly, the product description “easter egg” corresponds to the product description in the product-desc field of the v:buy tag 102020.

In some embodiments, the seller may have the option to customize the widget. For example, FIG. 101020b shows an example App1 where, a widget logo-url 102040 is specified. The corresponding code then dynamically generates a widget 102035 having the image specified by the widget logo-url 102040. As another example, the widget 102045 shown in FIG. 101020C is dynamically generated and customized based on the product-id code in the v:buy tag, e.g., 102050. Information such as text (e.g., “buy” or “Get it”), shape and/or color may also be specified in the various tags to dynamically generate customized or personalized buy widgets.

FIGS. 1021a-d show example user interfaces of a widget code generator in one embodiment of the Bill Pay. An example user interface showing a widget code generator with integrated testing is show in FIG. 1021a. In one embodiment, code is provided by the widget generator for copy/paste into a seller's web page code (e.g., HTML, PHP, and/or the like). Some of the code, e.g., 102101, is provided for pasting near the “body” tags within the seller's site code and may not vary with respect to the other options of the widget code generator. In one embodiment, the options selected in the widget code generator will cause the v:init code, e.g., 102101, and/or the sample code to automatically change when you update widget parameters using the widget controls, e.g., 102102-102107 and/or the like.

In one embodiment, a seller may enter an amount to be charged for an item, e.g., 102102, a currency, e.g., 102103, and/or a product identifier, e.g., 102104. In some embodiments, a merchant transaction code (e.g., an order number, customer code, transaction identifier, seller identifier, and/or the like) may be entered, e.g., 102105. Options for whether the widget should collect shipping, e.g., 102106, and/or when a transaction should be processed, e.g., 102107, may also be collected. In one embodiment, some of the fields may be pre-populated based on a seller's profile, previous use of the code generator, selling history, and/or the like.

In one embodiment, the options entered into the widget may be saved for later use, e.g., 102110. In doing so, a seller may quickly generate new widget code for rapid integration into their web site code. In some embodiments, the skin of the widget that the provided code will generate may be customized through the code generator, e.g., 2108. For example, a seller may click button 102108 to input options. As a result, in one embodiment, a custom widget skin may be made available to the seller and the widget code may be updated to note the widget skin to display, e.g., 102109. In another embodiment, the widget skin customizations may be stored on the Bill Pay server and therefore not affect the displayed code, e.g., 102109. Further detail with respect to widget skin customization can be found herein and particularly with respect to FIG. 1021b. In one embodiment, the user may be given an option within the widget generator to generate numerous widgets in bulk, e.g., 102111. Further detail with respect to bulk widget generation can be found herein and particularly with respect to FIG. 1021C.

FIG. 1021b is an example user interface depicting widget skin customization in one embodiment of the Bill Pay. In one embodiment, a pop-up may be presented to the seller after the seller indicates that they wish to customize the widget skin. For example, a seller may click a button, e.g., 102108, and be presented with a pop-up widget skin customization interface, e.g., 102112. In one embodiment, the seller may customize the background color of the widget to, for example, better match the background of the seller's site, e.g., 102113. The seller may also, in one embodiment, add a logo file to the widget by providing a URL to a logo file, e.g., 102114. In another embodiment, the user may upload the logo directly to the Bill Pay server from the interface 2112 by way of a file upload control (e.g., HTML inline file upload, Flash file upload, and/or the like).

In one embodiment, the seller may check options to add badges to the widget, e.g., 102116. A badge is a textual or visual enhancement that is added near, on top of, overlapping the main widget body, and/or the like. A badge may be used to indicate that a seller has additional capabilities, accepts certain payment types, allows the consumer to split a bill with a friend, is privacy enhanced, offers credit, and/or the like. In one embodiment, the preview of the widget may be updated in real-time to show the badge(s) that a seller has selected. Additionally, in one embodiment, other options may influence the rendering of the badge with the widget. For example, a widget background color, e.g., 102113, may also be applied to a widget badge, e.g., 102116.

In one embodiment, the seller may specify additional run-time widget options. These options will cause the code generator to inject additional code into the generated widget code that will enable additional widget features. For example, in one embodiment, the widget code may be modified to allow the calculation of shipping/handling and/or tax, e.g., 102116a. In another embodiment, the seller may select an option to have the widget prompt the user for a quantity amount, e.g., 102116b. Optionally, the user may also specify a minimum and maximum amount, which will be validated by the widget prior to or after launching the lightbox. Other fields may also be dynamically loaded into the widget. In one embodiment, shipping information may be already stored in a consumer's v.me account and the seller may desire to have the dynamically generated widget display an address drop down, e.g., 102116c. In still another embodiment, address information may be stored on a third-party server, such as a seller's server. A seller may provide access to their or another server for the purpose of retrieving a consumer's address or other information at the time of widget rendering. In one embodiment, the preview widget, e.g., 102116d, may additionally display a quantity field when a seller indicates that a quantity should be displayed. Additionally, a total transaction cost may be calculated automatically based on the quantity selected, e.g., 102116e. In some embodiments, the widget's calculation of total cost may be modified by the address information selected within the widget, such address information being optionally automatically loaded from a virtual wallet (e.g., v.me and/or the like) or third party server via a dynamic link, e.g., 102116c, the quantity of item selected, tax costs, shipping costs, VAT costs, price changes, real-time commodity prices, and/or the like.

In one embodiment, as the seller selects options within the widget skin customization screen, e.g., 102112, a preview of the widget as it would appear on the seller's commerce site may appear within the interface, e.g., 102116d. In doing so, the seller may see in real-time the effect of their widget customization options and may make both design and content decisions that would provide an optimal user experience. Additionally, in one embodiment, the preview widget may be live and capable of performing a transaction.

FIG. 1021C is an example user interface depicting bulk widget generation in one embodiment of the Bill Pay. In one embodiment, a pop-up may be presented to the seller after the seller indicates that they wish to bulk generate widgets. For example, a seller may click a button, e.g., 102111, and be presented with a pop-up bulk widget generation interface, e.g., 102117. In one embodiment, a seller may upload a file, e.g., 102118, that contains data records to be used in bulk widget generation. Example file formats suitable for this purpose are Excel (.xls, and/or the like), Access (.dbf, and/or the like), or a flat file (e.g., comma-separated, tab-separated, and/or the like). Once uploaded, e.g., 102119, fields may be extracted from the file (such as by using COM integration within or in conjunction with MS Excel, flat-file reading, and/or the like), e.g., 102120. Fields required for widget generation, e.g., 102120, may be displayed to the seller along with an option to choose a field from the uploaded file that matches the field. The names of the required fields and the selected fields need not match. In one embodiment, a default override value option, e.g., 102121, may be provided to the seller. By inputting a value in the default override, the value of the field in widget generation will be dictated by the default field and not by a value in the uploaded file. In one embodiment, the user may specify a null value as a default override, e.g., 102122. In another embodiment, only valid values for a field may be presented to the user as a default override, e.g., 102124. Upon filling out all of the required information, the user may then indicate that they wish to bulk generate a widget code snippet for all of the entries in the uploaded data file, e.g., 102125.

In one embodiment, the Bill Pay server will receive the bulk widget generation options and will proceed to create the widget code as described herein. Each widget code may be stored in an Excel, database, or other suitable file. In one embodiment, the bulk generated widget code may be automatically uploaded to a seller's web site server. For example, the seller may designate a template file on their server which has a placeholder suitable for replacement by the bulk widget generator. For example, the template may contain code such as:

<!-- BULK WIDGET TEMPLATE SNIP START -->
BULK_WIDGET_REPLACEMENT($PRODUCT_ID)
<!-- BULK WIDGET TEMPLATE SNAP END -->

In one embodiment, the bulk widget generation, e.g., 102125, may then copy the template file to another location on the seller's server and replace the appropriate section of the template file with the generated widget code. In order to facilitate this operation, the seller may provide the Bill Pay access to their server, such as by providing SFTP credentials, a shared key, and/or the like.

FIG. 1021d is an example user interface depicting a widget code generator with dynamic content retrieval, in one embodiment of the Bill Pay. In some embodiments of the Bill Pay, sellers may desire to integrate widget code into their web sites that allows one or more of the widget option values to vary and/or be changed at the time of widget generation. In one embodiment, the option may vary within a range. For example, a seller may desire to generate a widget that automatically updates the price for an item by polling a pricing database. Additionally, instead of being required to re-generate widget code (including a shs256 hashed token) every time an item's price changes, it may be more advantageous for the seller to specify a range of sale prices within which the widget should still accept the transaction. In one embodiment, a maximum amount, e.g., 102126, and a minimum amount, e.g., 102127) may be specified. A dynamic link, e.g., 102128, may also be specified by the seller. When polled, the link may return the current price of an item, such price optionally being within the range specified above. In so doing, the widget generator may generate a token that is not tied to a single price of an item, but rather is suitable for use with items of varying prices. Further detail regarding the generation of a token using a range of item cost amounts is provided with respect to FIG. 1022.

FIG. 1022a is an example logic flow depicting a widget code generator with dynamic content retrieval, e.g., DCR component 102200, in one embodiment of the Bill Pay. In one embodiment, seller 102201 inputs the widget code generator parameters (e.g., currency, product id, merchant transaction value, collect shipping option, and/or the like). In one example, the widget code generator parameters contain a minimum amount and a maximum amount within which the item's cost may vary, e.g., 102204. In other embodiments, the variable portion of the widget code parameters may instead be the product identifier, merchant transaction value, and/or the like.

In one embodiment, the seller client 102202 may then send a request for widget code generation to the Bill Pay server 102203, e.g., 102205. An example widget code generation request 102205, substantially in the form of an HTTP(S) POST message including XML-formatted data, is provided below:

```
POST /widget_code_request.php HTTP/1.1
Host: www.server.com
Content-Type: Application/XML
Content-Length: 667
<?XML version = ″1.0″ encoding = ″UTF-8″?>
<widget_code_generation_request>
  <timestamp>2020-12-12 15:22:43</timestamp>
  <api_key>LAWQDLK</api_key>
  <max_amount>110.99</max_amount>
  <min_amount>95.99</min_amount>
  <product_id>CU8765</product_id>
  <merch_trans>987545</merch_trans>
  <collect_shipping value=true />
  <process_on>capture</process_on>
  <dynamic_data field=”amount”>
    <dyn_link>https://merc-serve/prod/?[productid]</dyn_link>
    <substitute value=”productid”>[productid]</substitute>
    <request_method>GET</request_method>
    <return_type>JSON</return_type>
    <return_variable>price</return_variable>
  </dynamic_data>
</widget_code_generation_request>
```

The server may then extract the widget generator parameters, e.g., 102206, and determine if a dynamic cost amount has been provided, e.g., 102207. In one embodiment, the Bill Pay server 102203 can determine if a dynamic cost amount has been specified by the presence of a minimum amount and maximum amount in the request for widget code generation, e.g., 102205 and/or the extracted values, e.g., 102206. In one embodiment, the Bill Pay server then calculates a difference or range between the minimum amount and maximum amount, e.g., 102208. Then a floor value may be looked up in a dynamic cost database, e.g., 102209. An example listing, substantially in the form of PHP/SQL commands, for querying a dynamic database for a floor value is provided below:

<?PHP
header(‘Content-Type: text/plain’);
mysql_connect(“locaohost”,$DBserver,$password); // access database
server
mysql_select_db(“dynamic_cost.sql”); // select database table to search
//create query for token arbitrators
$query = “SELECT floor_value FROM dynamic_cost WHERE
minimum_amount >
$min_amount AND maximum_amount − minimum_amount <
$range AND permissions LIKE ‘%’ $user_permissions”;
$result = mysql_query($query); // perform the search query
mysql_close(“dynamic_cost.sql”); // close database access
?>

In one embodiment, the floor value is a value that is based on the minimum amount and the range between the minimum amount and maximum amount. In another embodiment, the floor value is based on only the range, only the maximum value, only the minimum value, and/or the like. In still other embodiments, the floor value is specified by a Bill Pay server administrator based on business risk tolerance (e.g., the tolerance of the issuer for risk, the tolerance of the seller for risk, the size of the transaction, the history of the buyer, and/or the like). In one example, the determined floor value is then set equal to the amount, e.g., 102210.

In one embodiment, a token is generated that represents a unique combination of widget parameters. As described herein, one or more of the unique widget parameters (e.g., amount, and/or the like) may be representative of a range of acceptable values, one value, and/or the like. In one embodiment, a token is generated using an SHA256 hashing algorithm that hashes the string combination of a shared secret key, the amount calculated above or provided by the seller, the currency, a merchant transaction identifier and a product identifier, e.g., 102211. In other embodiments, the hash is generated using MD5, Whirlpool, Gost, Haval, and/or the like. An example hash command suitable for token generation, e.g., 2211, substantially in the form of PHP is provided below:

$token = “”;
$token = hash(‘sha256’, $shared_secret_key . $amount . $currency .
$merch_trans . $product_id);

In one embodiment, the generated token will then be placed in a widget code template, and other values in the template will be populated based on user inputs, values looked up, and/or the like, e.g., 102212. A widget code template is a widget code shell that may contain placeholders for the insertion of specific widget customization parameters. The widget code and/or the widget code template may then be further customized with respect to FIG. 1022b.

FIG. 1022b is an example logic flow of a widget code generator with dynamic content retrieval, in one embodiment of the Bill Pay. In one embodiment, the Bill Pay will determine if the seller has selected that the widget should load shipping information for a consumer from the v.me virtual wallet (see, e.g., FIGS. 1021b, 2116c), e.g., 102250. If the seller has chosen to have the widget load v.me shipping information dynamically, then additional code to dynamically load the shipping information into the widget at the time of rendering may be appended and/or inserted into the generated widget code, e.g., 102251. Example code, substantially in the form of JavaScript/jQuery, suitable for injection into the widget code for dynamic address retrieval is:

```
//wait until DOM has loaded to trigger dynamic address loading
//then load up the address information from remote
//server (v.me, etc.)
//and build a SELECT with content
<script language=”JavaScript”>
jQuery(document).ready(function($) {
  $.get(
    ‘https://www.v.me/’,
    {doing: “get_shipping_addresses”, seller_id: “1254874”,
    version: 5.1}, function(response){
      //injection code begin
      inj_code = “<select name=shipping>”;
      //for each returned address, create a dropdown menu item
      for(i=0; i<response.length; i++) {
        inj_code = inj_code + “<option>” + response[i] + “</option>”;
      }
      //injection code end
    inj_code = inj_code + “</select>”;
    },
    ″json”
  );
});
</script>
```

In one embodiment, shipping information may be loaded from an external server, such as a third-party server, e.g., 102252. In some embodiments, the widget code generator may then require credential information (such as a username/password, shared key, fingerprint authentication, and/or the like) for the third-party server the seller has access to and may request that the seller client 102202 solicit this information from the seller, e.g., 102253.

In one embodiment, the seller client 102202 may parse the credential request and display a prompt to the seller 2201 for the credential information for the third-party shipping information server, e.g., 102254. The seller may then input the information directly into the widget code generator, e.g., 102255, or otherwise upload or store the information in a location accessible by the Bill Pay server 102203. The seller client 2202 may then transmit the credentials to the Bill Pay server, e.g., 102256. In one embodiment, the Bill Pay server will then store the credentials in a credentials database in a secure format, such as by one-way cryptographically hashing the credential password, e.g., 102257. The Bill Pay server may then append third-party server shipping lookup code to the generated widget code, e.g., 102258. Example code, substantially in the form of JavaScript/jQuery, suitable for injection into the widget code for third-party address retrieval is:

```
//wait until DOM has loaded to trigger dynamic address loading
//then load up the address information
//from remote server (v.me, etc.)
//and build a SELECT with content
<script language=”JavaScript”>
jQuery(document).ready(function($) {
  $.get(
    ‘https://www.third-party.com/?credential=87HASH654’,
    {doing: “get_shipping_addresses”,
      user_name: ″shippingAccessUserName″,
      password: “timeLimitedPassword”},
    function(response){
      //injection code begin
      inj_code = “<select name=shipping>”;
      //for each returned address, create a dropdown menu item
      for(i=0; i<response.length; i++) {
        inj_code = inj_code + “<option>” + response[i] + “</option>”;
      }
      //injection code end
    inj_code = inj_code + “</select>”;
    },
    ″json”
  );
});
</script>
```

In one embodiment, additional dynamic data may be loaded into the widget generator generated code, e.g. 102259 using code substantially similar to the appended code described herein. For example, default quantity information may be solicited from a costing server based on a consumer's past buying behavior and dynamic retrieval of same incorporated into the dynamically generated widget code. In one embodiment, the additional injected widget generation code may load items from a user's “wish list” at a merchant, facilitating low friction commerce opportunities via a seller based widget, e.g. 102260.

Returning to FIG. 1022a, the widget code may then be set by the Bill Pay server 2203 to the seller client 102202, e.g., 102213. An example widget code generation response, e.g. 102213, substantially in the form of an HTTP(S) POST message including XML-formatted data, is provided below:

```
POST /widget_code_response.php HTTP/1.1
Host: www.server.com
Content-Type: Application/XML
Content-Length: 667
<?XML version = ″1.0″ encoding = ″UTF-8″?>
<widget_code_response>
  <timestamp>2020-12-12 15:22:43</timestamp>
  <api_key>LAWQDLK</api_key>
  <code content_type=”Javascript / HTML 5.0”>
        <v:buy
        apikey = ″L3AWQDLKBHYCE2XO5″
        token = ″7643245f59a654654″
        dynamic_amount = ″https://merch-serve/prod/?[product_id]″
        dynamic_method=″POST″
        product-id = ″Testproduct1″
        merch-trans = ″″
        collect-shipping = ″true″
        process = ″validate″>
        </v:buy>
      <script language=”JavaScript”>
        jQuery(document).ready(function($) {
          //dynamic shipping code, e.g., 2258
        }
      </script>
  </code>
</widget_code_response>
```

The seller client 102202 may receive and display the widget code, e.g., 102214. In one embodiment, the seller may then copy and paste the generated widget code from the widget generator into their web site code (e.g., HTML, PHP code, and/or the like), e.g., 102215. The seller's web site code containing the generated widget code may then be deployed to the sellers server (e.g., by SFTP upload, using shared keys, using a live WYSIWYG code editor, and/or the like). in one embodiment the widget code generator generation step is performed by the seller's server, seller client 102202 (such as dynamically generating the widget code directly using JavaScript, and/or the like), the seller 102201 (such as by manually inserting the appropriate widget code and calculating the token), and/or the like.

Various embodiments of the Bill Pay may be configured to facilitate the creation of a virtual wallet account. For example, a financial institution may already have information in their records such as payment accounts, billing address, credit history reports and/or the like. By providing this information to the wallet service provider, a wallet account may be established on behalf of the user. In some embodiments, the information provided by the financial institution may be sufficient itself to enable the creation of a virtual wallet account. This would be the case where the information requirements of the virtual wallet provider are such that the financial institution is able to provide sufficient information about the user to enable creation of a wallet account. In other embodiments, the information provided by the financial institution may only partly fulfill the information requirements of the virtual wallet provider, in which case the user may be prompted for additional information before the virtual wallet is created.

Other embodiments of the Bill Pay enable frictionless enrollment of a consumer's payment accounts in a virtual wallet. In some embodiments, customers logged into a financial institution web site, such as an account issuer's web site, may desire to enroll payment accounts already established with that financial institution in their virtual wallet. In one embodiment, a consumer may be logged into the web site of its local bank and be able to access both a credit card and a debit card previously opened with that bank. Advantageously, the issuer bank may already have important information about the user that may facilitate the enrollment of the two payment accounts in a virtual wallet (e.g., billing address, PAN number, mother's maiden name, etc.) and/or the creation of a virtual wallet account. In one example, the consumer may indicate to the issuer that it desires for the issuer to transmit the account information the issuer has on file to a virtual wallet provider in order to pre-fill information in an enrollment form that may be used to enroll one or more payment accounts in a virtual wallet. The issuer may then share or transmit data to the wallet service provider to enable this enrollment. In one embodiment, the user may then provide additional information before the payment account is enrolled in the wallet. In other embodiments, no additional information may be provided by the user and the payment account may be automatically enrolled in the wallet after the issuer's transmission of the data. In still other embodiments, the issuer may be a merchant bank, pre-paid account provider, a non-financial institution, or an individual (i.e., a peer-to-peer enrollment facilitation).

In some embodiments of the Bill Pay, the creation of a virtual wallet account or the enrollment of a payment account in a virtual wallet account may be supplemented by allowing the user to create a pre-paid payment account. In doing so, the user may fund the pre-paid account immediately or open the pre-paid account with no funding. In one embodiment, the consumer desires to add an existing payment account to their virtual wallet while logged into an issuer's web site. The consumer may therefore select an established account for enrollment in the virtual wallet. Additionally, the consumer may then also be prompted to create a pre-paid account in their virtual wallet. In some embodiments, after choosing to create a pre-paid account, the consumer may then choose an account with a financial institution from which to fund their pre-paid account. Advantageously, in this example, the consumer may also desire for the information about the pre-paid funding source account to be shared with the virtual wallet provider to enable the wallet provider to simultaneously create and fund a pre-paid account. In other embodiments, the Bill Pay may allow a wallet service provider to retain information (e.g., account number, routing number, billing address, and/or the like) to enable future funding of the pre-paid account to occur without additional sharing of data from financial institution to wallet service provider. In still other embodiments, the consumer may create a funding threshold rule that would indicate to the wallet service provider to re-fill or top-up the pre-paid account from a designated funding source on the occurrence of a certain event, such as low funds. In doing so, the Bill Pay enables a consumer to create a pre-paid account seamlessly while enrolling other payment accounts in the virtual wallet.

In other embodiments of the Bill Pay, the creation of the pre-paid account may happen independently of a consumer's interaction with a third-party financial institution. For example, in some embodiments the virtual wallet may be accessed through a mobile application. In this embodiment, the wallet application on the user's mobile phone may prompt the user to establish a pre-paid account when it detects that the consumer has just received a large credit to one of their financial accounts. In doing so, the establishment of pre-paid accounts may be encouraged and facilitated by the Bill Pay.

In some embodiments of the Bill Pay, the virtual wallet account enrollment facility may be configured to automatically retrieve an image of the payment account being enrolled in the virtual wallet. In doing so, consumers may be presented with an image of the card representation of the payment account being enrolled. In some embodiments, this image may be used by the consumer to verify the authenticity of the payment account being added. In other embodiments, the image may be displayed to facilitate the selection of payment accounts for addition to the virtual wallet.

Various embodiments of the Bill Pay facilitate the creation of persistent and re-assignable links between the consumer's virtual wallet and a merchant or other entity. In some embodiments, the Bill Pay may allow the customer to link their virtual wallet to a merchant using reference aliases that are not permanently linked to a single payment account or method. In doing so, a consumer's accounts may change over time without breaking the persistent reference links that have been created to various merchants. This capability may facilitate a low friction user experience for payment transactions. In some embodiments, the consumer may designate a reference for an account using a merchant's web site. In doing so, the consumer may agree to allow future transactions to occur without requiring future affirmative consent. The consumer may then manage the reference connection through a virtual wallet or web site and update the reference aliases without requiring another visit to the merchant's web site.

Alternative embodiments of the Bill Pay may also allow the consumer to create reference links between other information in their virtual wallet. For example, a consumer may desire to create a reference alias for an address frequently used in commerce transactions. Alternatively, the consumer may wish to create a reference alias to a name or persona that they may use in commerce. In doing so, the Bill Pay may enable the consumer to maintain a degree of privacy while still enabling low friction commerce transactions.

In some embodiments of the Bill Pay, the consumer may agree to or designate certain payment options to be used in recurrent transactions. For example, the consumer may permit flexible recurring commerce, wherein future transactions from a merchant may be billed to the reference alias without further intervention from the user. In other embodiments, the consumer may permit managed subscription commerce wherein the consumer and/or merchant agrees to various terms or conditions that may govern the current and/or future reference transactions with the consumer's virtual wallet account. For example, the consumer may designate a pre-set amount which the merchant may bill through the reference link monthly. For example, a consumer may enroll in a “Jam of the Month” club. In one embodiment, the consumer may choose to create a reference transaction authorization of $40.00 per month for 3 varieties of jam. In another embodiment, the jams may have variable prices (such as a rare Jam for $199.00) and the consumer may authorize full payment or partial payment with the remainder billed later through a reference transaction or alternative mechanism. Alternatively, the consumer may agree to allow the merchant to bill a capped total amount to their virtual wallet reference account before requiring affirmative consent from the consumer for future transactions. For example, the user may authorize a one year “Jam of the Month” subscription for $199.99 which may prompt the user in one year to optionally renew the subscription.

In some embodiments, the Bill Pay may provide payment security features to the merchant. For example, the merchant may be given assurances that at least one payment account may be available for a given period of time using a reference link. Alternatively, the merchant may be alerted when a reference link is updated or revoked by a consumer.

In some embodiments, the Bill Pay can enable the payment account issuer to update various parts of a reference transaction link without the intervention of the consumer. For example, if a consumer's card number is compromised as a result of fraud, the payment account issuer can automatically issue a new account number and update any references using that payment account. Additionally, a payment account issuer may change a consumer's account type (i.e. from ‘Gold’ to ‘Platinum’) and associate the updated account type with the reference transaction link. Advantageously, these capabilities may enable higher transaction clearance rates for consumers, merchants and payment account issuers.

In some embodiments, the Bill Pay may provide enhanced security features to the consumer. For example, the consumer may be given additional options for restricting reference transactions if the merchant is a new merchant, located in a foreign country, has a history of fraudulent transactions, or other conditions are present that may be cause for enhanced security. In alternative embodiments, the consumer may receive alerts when a transaction is posted through a reference link. For example, the consumer may be alerted after every transaction, or only if the transaction is suspicious. In some embodiments, the consumer may be given the option to approve or cancel the reference transaction.

In some embodiments, the Bill Pay may provide a control panel through which the consumer may manage the reference account links. For example, the consumer may desire to remove a payment account from their virtual wallet and re-assign any reference connections previously using that payment account to instead use another payment account. In other embodiments, a consumer may desire to simultaneously add a new payment account to their virtual wallet and use the newly added account to replace another account in their virtual wallet. In some embodiments, when a consumer deletes a payment account from their wallet they may be prompted to update any reference transaction links that use that reference payment account. In doing so, the consumer can provided uninterrupted linkage to payment references. In still other embodiments, the consumer may be permitted to view reports regarding their historical usage of a reference alias or any accounts linked thereto. In some embodiments, the consumer can update, edit, or revoke links between reference account aliases and various merchants.

Various embodiments of the Bill Pay may enable the consumer to create rules governing the administration and use of reference aliases. As such, the consumer may be able to designate a hierarchy of payment accounts to be used for one reference alias in the event that some payment accounts are not available. In other embodiments, the consumer may be able to designate alternative reference payment methods such as frequent flyer accounts, merchant points accounts, coupons, virtual currencies, government benefits, future paychecks, accounts receivable, loans or lines of credit.

In some embodiments, the Bill Pay may enable a merchant offering a checkout option to display a button on their web page including enhanced information. For example, the button may include text indicating that the transaction may be fulfilled using a reference alias in the consumer's virtual wallet. Alternatively, the button may display a reference address that the consumer has previously designated for use in such transactions. In some embodiments the consumer may interact with the button directly to change, update or view reference transaction information.

Various embodiments of the Bill Pay facilitate a common, low friction user experience for consumers wishing to link a financial account, a merchant account, or any other participating commerce services to a digital wallet. In some embodiments, the Bill Pay provides a standardized common user experience and control panel for allowing customers to view, grant and manage permissions for financial institutions, merchants or participating commerce-related services to interact with their digital wallet. In other embodiments, the Bill Pay eliminates the need for consumers to remember and maintain multiple authentication passwords across many merchant, commerce and payment domains. In yet other embodiments, the Bill Pay maintains an up-to-date payment and other relevant personal data across multiple merchants and commerce-related services. Various Bill Pay embodiments may also solve for a usability friction for both merchants and consumers of having to authenticate twice, once to a merchant and once to wallet provider in order to conduct a wallet ecommerce transaction. Using Bill Pay, consumers may log in once either via the merchant or the wallet and conduct an ecommerce transaction.

Embodiments of the Bill Pay may also facilitate storage and management of customer identity and other relevant information for merchants and other commerce related services. Some Bill Pay embodiments may provide a faster and low friction new customer enrollment for customers who already have a wallet account. Other Bill Pay embodiments may provide consumers their own centralized cloud-based account having a master copy of commerce-related personal and account information protected by a trusted brand. Some Bill Pay embodiments may provide issuers branding and/or communication opportunities with cardholders even in shopping experiences like card-on-file purchases.

Some embodiments of the Bill Pay may provide consumers facilities for easily and conveniently personalizing new prepaid accounts with their issuer using previously verified personal information stored in an online wallet, and expediting provisioning a prepaid account to a digital wallet. Once a prepaid card is connected with the wallet, the Bill Pay provides the consumer an easy to remember authentication tool to sign on to view and manage their prepaid account either at the wallet destination website/application or through limited federation to the prepaid issuers online (or mobile) prepaid service application.

These and other embodiments of the Bill Pay provide a secure and trusted bidirectional federation with a digital wallet by instituting a permissions system that allows services certain access privileges (e.g., read, write, transact, etc.) to the wallet only when appropriate and subject to both systematic and customer-managed controls.

### Bill Pay

FIG. 201 shows a block diagram illustrating example service connections in some embodiments of the Bill Pay. In one implementation, the Bill Pay button 20102 may be an OAuth based button that allows users to sign in and connect their wallet profile 20115a in the wallet 20115 with their accounts at issuers 20105a, 20105b and merchants 20110a, 20110b, 20110C. Once connected, a bidirectional link may be established between the services (e.g., issuers, merchants, etc.; hereinafter “merchant”) and the wallet with ongoing permissions explicitly agreed to by the user. In some implementations, the bi-directional link may facilitate, for example, updating of card information (e.g., expire date, new identifier, increased spending limit, and/or the like) from the issuer to the corresponding card slot in the wallet, and from the wallet to the merchant. Similarly, in some other implementations, change in customer information initiated by the customer from a merchant interface may flow to the wallet and from the wallet to the issuer, for example. In some embodiments, Bill Pay may facilitate addition of an account or payment method and personal data to the wallet from an issuer website or an application, set up of default payment method and sharing of relevant info (e.g. contact and shipping information) with a merchant for an ongoing billing relationship, set up of one-way identity federation with a merchant to enable a customer to log in to a merchant through the wallet, real-time API calls for merchants to be able to display rich information about payment methods linked to customer relationship, and/or the like. In one implementation, for example, if a user provides a retailer Nordstrom with their nicknamed “personal card” and “business card”, Nordstrom would be able to display those nicknames and a thumbnail of the issuer card-art (if provided by a connected issuer). Similarly the user could provide Nordstrom with their wallet nicknamed “home shipping address” and “work shipping address”. If later on through the customer wallet application or portal, the customer updates their address or makes changes to their card nickname etc., those changes would be immediately reflected next time the customer visits Nordstrom because those accounts are connected by the Bill Pay. In some implementations, the same frame work may facilitate any sort of customer-initiated unidirectional or bidirectional connection between the wallet and an outside service.

In some embodiments, various service providers may leverage the Bill Pay to provide a variety of services. For example, an issuer connected to the wallet may provision card accounts to a wallet, dynamically update account status, card art, and/or the like, provide real-time balance data, publish targeted offers to customers, publish and update issuer “apps” or gadgets to the customer's wallet, and/or the like. A merchant connected to the wallet may allow customers to quickly link existing merchant accounts to a wallet account, allow customers to quickly create a merchant account by drawing information (with customer's permission) from the customer's wallet account, allow merchants to set up open authorization, recurring billing, subscription billing relationships with the customer, keep records up to date and access current information on file for their connected customers, show customers an inline display of current accounts (e.g. including card art) for accounts liked to their merchant relationship, allow returning customer to login to their merchant account with through wallet login widget, and/or the like. A loyalty provider connected to a wallet may add a loyalty account to a wallet, provide real-time points/currency balance, publish targeted rewards offers, access a loyalty account through a wallet login, and/or the like. A transit authority connected to a wallet may load or associate transit passes with the wallet, allow returning customer to login to their transit account or purse through the wallet login widget, allow redemption of transit passes or tickets from the wallet, and/or the like.

FIG. 202 shows a block diagram illustrating example Bill Pay architecture in some embodiments of the Bill Pay. In some embodiments, the Bill Pay architecture may be a cross-channel and cross-entity framework comprising widget-based authentication and permission management between various commerce solution components and the wallet. In one implementation, for example, various approved commerce services 20202, issuers 20204, merchants 20206, and/or the like may have embedded a Bill Pay button (e.g., 20208a, 20208b) in their native applications or sites. When the button is invoked on the web or on a mobile device, the button may trigger a Bill Pay widget (e.g., 20210, 20215) to either connect a new service (e.g., 20202, 20204, 20206) to the wallet or authenticate the user. A user may input username and password credentials into the wallet widget (2.g., 20210) to get authenticated. The user may have control (e.g., create, view, manage, cancel, etc.) over the individual relationships and may configure permissions for each service they connect to. In one embodiment, the Bill Pay may allow approved services, issuers and merchants permissions to obtain various information relating to the user and wallet such as consumer profile 20225, billing agreement 20230, redemption 20235, loyalty and rewards 20240, coupons/offers 20245, wish lists and stored items 20250, merchant applications/widgets 20255, Value Added Resellers (VAR)/Software-as-a-service (SaaS) commerce wallet plug-ins 20260, analytics 20265, account or points balance information 20270, payments 20275, and/or the like. In one implementation for example, the Bill Pay may manage which services can connect to the wallet. In a further implementation, the Bill Pay may pass along information from an approved and connected service such as a loyalty program (e.g., Star Woods Points program) to a merchant such that the merchant may provide the customer a special deal, offer or an opportunity to use or exchange points/currency when transacting. In one implementation, approved commerce services, issuers and merchants may be able to push information relating to any of the above to the wallet.

FIG. 203 shows a screen shot illustrating example account creation in some embodiments of the Bill Pay. In one embodiment, the Bill Pay may facilitate acceleration of an account creation with a merchant by drawing customer data such as name, addresses, email, etc., from the wallet. Once connected, the wallet may keep the customer data up to date and provide an easy way for the customer to sign in to the merchant account. For example, as shown in FIG. 203, a new customer may create an account with a merchant (e.g., Nordstrom) by filling out the form fields 20305 (e.g., first name, last name, email, password, zip/postal code, gender, email preference, and/or the like). In one implementation, all of these fields may be replaced with information from the Bill Pay and persistently linked to the customer's wallet profile when the customer opts to create an account via the Bill Pay facilities of the wallet (e.g., Wallet wallet). The data entry 20205 for creating an account with the wallet is much less with the Bill Pay.

In some embodiments, the initial connection between an entity and Wallet creates a customer identifier unique to that relationship. Unlike storing card information with a merchant, which, if compromised, could be used at any merchant, the customer identifier can only be used by the designated entity. Any other entity attempting to use another entities identifier to access a customer's wallet account would be denied. In some implementations, the merchant may use this unique identifier to make calls to the wallet to retrieve and/or update commerce-relevant or other customer data. The customer has the option to maintain, in one place, address book, payment methods, and payment preferences. If the customer moves addresses for example, or obtains a new payment card, these changes may be remotely propagated to all the merchants they do ongoing business with. In some implementations, the merchant has a set of callbacks that the merchant can invoke to the wallet in order to offer seamless and uninterrupted service to the customer. Under the appropriate permissions, the merchant may make these calls independently and/or under certain triggers such as the appearance of the customer starting a new shopping session.

FIG. 204 shows a screen shot illustrating example merchant account login in some embodiments of the Bill Pay. The Bill Pay in some embodiments may facilitate expedited merchant sign in, where customers can skip merchant's login and password 20405 with the click of the Bill Pay button 20405a. The one click Bill Pay check-in means customers log in with less friction and do not have to type, remember or forget and have to retrieve merchant passwords. The Bill Pay may return the merchant's customer ID (or contract ID) to the merchant, and facilitate the customer login to the merchant account.

FIG. 205 shows a screen shot illustrating example account preference management in some embodiments of the Bill Pay. The Bill Pay, in some embodiments, may maintain dynamic linkage and branding for issuers, merchants and the wallet whether or not a lightbox (i.e., a payment widget) is used for every purchase flow. For example, in a merchant site 20505, under the customer account 20510, information relating to order status 20515, account profile 20520, address book 20525, payment methods 20530, and/or the like may be displayed. The merchant may have their own set of customer information (e.g., order information or size information) that they maintain in their customer database. However, other information such as primary shipping address and payment methods may be dynamically linked and synced to Bill Pay such that the merchant has access to the customer's preferred shipping address and payment methods. For example, address book 20525 may display the default shipping address and the payment methods 20530 may display a list of payment methods that are stored with the merchant for faster checkout. Using callbacks, the Bill Pay may obtain not only payment methods and addresses, but also loyalty accounts, payment authorizations, entitlements, payment preferences, and/or the like.

In one implementation, each callback may include the customer ID that is unique to the customer-merchant relationship. In a further implementation, API calls to the Bill Pay may include one or more API keys such as a public key and/or a shared secret key. An API key may be a string value that identifies the general API access configuration and settings for the site. In some embodiments, callbacks for Bill Pay may include, without limitation, the following:

TABLE 1
Example Callbacks

Get Payment methods (returns card nicknames, brand and last 4 digits)
Get addresses (returns full addresses that customer has shared with
merchant, address nickname, and indicator for default/primary address)
Get Loyalty accounts (returns active loyalty programs that customer has
shared with merchant, program names and indicator for current default/
primary loyalty program)
Make Payment authorizations (request to instantiate a purchase against the
customer ID)
Get/Add Entitlements (retrieve and redeem previous purchase records for
the customer, e.g. tickets, passes, pre-paid purchases, subscription codes,
or other product codes defined by the merchant)
Get Payment preferences (e.g. receipting preferences and preferred
shipping carriers)

Various methods of callbacks may be utilized. In some embodiments of the Bill Pay, API and inline widget methods, among others, may be implemented. Using the API method, the merchant server may make API calls to the V-Connect server to retrieve customer data. For example, a customer may log in to a merchant account to view their account preferences with the merchant. The merchant server may execute an API call to get payment methods from the Bill Pay server. The merchant may then display the currently active payment method is a wallet (e.g., Wallet wallet) with account nickname and ending in digits xxxx. For example, referring to FIG. 205, the merchant may obtain payment methods 20530a and 20530b from Bill Pay and display them using their nicknames such as “My Business Credit Card PaymentCard Ending . . . 1234” (e.g., 20530a) and “My Personal Debit Card PaymentCard Ending . . . 1234” (e.g., 20530b). In this way, via API calls, the merchant may display rich, up to date account information including card art.

Using the inline widget method, the merchant may display a wallet rendered “window” into a user's wallet account. Inline widgets may display rendered or interactive elements that are injected into the merchant's website. An example would be a widget that displays the nickname and associated card-art for payment methods stored on file with a merchant, similar to 20530a, 20530b shown in FIG. 205. A JAVASCRIPT call from the merchant may indicate the type, parameters, and customer ID for rendering the widget.

Referring again to FIG. 205, a customer may also edit payment methods and other information in the wallet via the Bill Pay button 20535. Using the edit option, the customer may add, modify, delete, link/delink accounts and addresses, and, at a glance, confirm any new card they added to their wallet account last week is active with the merchant and their bill may process correctly.

FIG. 206 shows a screen shot illustrating an example cross-channel implementation of some embodiments of the Bill Pay. In one implementation, the Bill Pay button may be embedded in various channels including, for example, web sites, mobile devices, tablets, smart phones, web applications, mobile device application, and/or the like, as long as partners using the channels are enrolled in the Bill Pay, and in some implementations, agreed to access control restrictions. Referring to FIG. 206, a Bill Pay button 20610 is placed in a tablet channel 20605. Invoking the Bill Pay button may trigger a wallet widget to either authenticate the customer or authenticate and connect the service, merchant, or application to the customer's wallet account. In some embodiments, the Bill Pay button may be implemented in other channels and physical world scenarios such as point of sale interactions. For example, using a physical card swipe or chin/pin interaction may trigger a wallet account connection or login. As another example, using a quick response (QR) code scan, a near-field communication (NFC) tap or other mobile trigger in lieu of a Bill Pay button may also trigger a wallet connection or login. As yet another example, using a voice password, repeatable gestures or action, biometrics, and/or the like may trigger a wallet connection or login.

FIGS. 207a-b show user interfaces illustrating example sign-in and account management in some embodiments of the Bill Pay. Referring to FIG. 207a, in one implementation, a customer may launch a merchant site 20705 and select the create account option 20705a. Selection of the create account option may direct the customer to a merchant account creation page10 in the merchant site 20705. The customer may register for a merchant account by filling out the form 20710a. Alternately, the customer may register a merchant account with the wallet account using the connect with wallet button 2071ob. When the connect with wallet button is selected, a wallet widget 20715 may be launched within the merchant site 20705. The customer may enter their wallet username and password (or other credentials) to gain access to the wallet widget configuration page 20715a shown in FIG. 207b. Referring to FIG. 207a, in some implementations, the customer may already have a merchant account. The customer may enter their merchant site account credentials 20720 and login to the merchant site page 20725. The customer may, at this point, connect to the wallet by selecting the connect with wallet now button 20725a which may launch the wallet widget 20715.

Referring to FIG. 207b, the customer may configure merchant linkage to the wallet starting with option 20715a for example. In one implementation, the customer may select preferences 20720 for the merchant account in a more granular manner. For example, the customer may specify, for example, payment methods and shipping addresses to link to the merchant. Other preference management is discussed in further detail with respect to FIG. 2012. Upon completing the preferences set up, the customer may select the connect button 20720a to create the link between the merchant and the wallet. The wallet widget may then direct the customer to the merchant site 20725. The wallet may also share or load or dynamically inject to the merchant site information according to the customer preferences. The merchant site 20725 may obtain the shared information and display the shared payment methods, address, and other information 20725a to the customer to confirm the connection between the merchant account and the wallet.

FIGS. 208a-b show user interfaces illustrating example sign-in and checkout in some embodiments of the Bill Pay. Referring to FIG. 208a, in one implementation, a customer may launch a merchant site 20805 (or merchant application). Using the merchant sign in 20805 option, the customer may be directed to a sign in page 20810 in the merchant site 20805, where the customer may login to the merchant site using username and password 20810a for the merchant site. Alternately, the customer may login with the wallet using the login with wallet button 20810b. When the login with wallet button is selected, a wallet widget 20815 may be launched within the merchant site 20805. The customer may provide wallet username and password 20815a to login to the merchant site via the wallet. Referring to FIG. 208b, once the customer is authenticated via the wallet, the wallet may send the merchant the customer ID corresponding to the relationship between the customer and the merchant. The merchant, upon receiving the customer ID, and verifying that the customer ID corresponds to a customer record in their customer database, may allow the customer access to their merchant account 20820. In one implementation, the customer sign in may be a trigger for the merchant to make an API/JAVASCRIPT call 20855 to the wallet service 20850 to obtain shipping details 20825b, payment method 20825c, and/or the like. The merchant site page 20825 may use the shipping detail obtained from the wallet to calculate and display shipping and tax information. In one implementation, the payment method 20825c obtained from the wallet may be a payment method nickname (e.g., my personal account). The merchant may not have the actual card or account number. The actual card or account number is resolved by the wallet once the customer selects the pay now with wallet button 20835. In one implementation, the customer may also edit shipping address, payment method and other details directly from the merchant site using the edit with wallet button 20830. Upon successful transaction authorization, the merchant site 20805 may display the page 20840, including information such as receipt 20840a relating to the transaction.

FIGS. 209a-b show data flow diagrams illustrating example bi-directional federation in some embodiments of the Bill Pay. Referring to FIG. 209a, in one implementation, a user 20902 may input login credentials (e.g., merchant account or wallet account username and password) at the merchant site or application on their client device 20904 at 20912. The client device may take the login credentials and generate an authentication request 20914 for transmission to a merchant server 20906. For example, the client may provide a (Secure) Hypertext Transfer Protocol (“HTTP(S)”) POST message including data formatted according to the eXtensible Markup Language (“XML”). An example authentication request 20914, substantially in the form of a HTTP(S) POST message including XML-formatted data, is provided below:

```
POST /authrequest.php HTTP/1.1
Host: www.merchant.com
Content-Type: Application/XML
Content-Length: 667
<?XML version = “1.0” encoding = “UTF-8”?>
<auth_request>
  <timestamp>2013-02-22 15:22:43</timestamp>
  <user_details>
    <user_name>JDoe@gmail.com</user_name>
    <password>Tomcat123</password>
  </user_details>
  <client_details>
    <client_IP>192.168.23.233</client_IP>
    <client_type>smartphone</client_type>
    <client_model>HTC Hero</client_model>
    <OS>Android 2.2</OS>
    <app_installed_flag>true</app_installed_flag>
  </client_detail>
</auth_request>
```

The merchant server 20906 may receive the authentication request 20914, and may parse the request to obtain user and/or client details such as username and password. The merchant server may perform authentication of the user and/or client details at 20916. In one implementation, the merchant server may query its user/customer database to verify that the username and the password (or other credentials) are correct, and the user is authorized to access the account with the merchant (i.e., merchant account).

In another implementation, the user credentials may be authenticated by the wallet server 20908. The user may select sign in with wallet button and may input wallet credentials in the wallet widget launched. The client 20904 may generate an authentication request 20918 using the user provided login credentials. An example wallet authentication request 20918, substantially in the form of a HTTP(S) POST message including XML-formatted data, is provided below:

```
POST /authrequest.php HTTP/1.1
Host: www.wallet.com
Content-Type: Application/XML
Content-Length: 667
<?XML version = ″1.0″ encoding = ″UTF-8″ ?>
<auth_request>
  <timestamp>2013-02-22 15:22 : 43</timestamp>
  <user_details>
    <user_name>JDoe1984</user_name>
    <password>thistryion56</password>
  </user_details>
  <widget_param>
    <apikey>aK2Lejj89J2A1_1On4s2</apikey>
  </widget_param>
  <client_details>
    <client_IP>192.168.23.233</client_IP>
    <client_type>smartphone</client_type>
    <client_model>HTC Hero</client_model>
    <OS>Android 2.2</OS>
    <app_installed_flag>true</app_installed_flag>
  </client_detail>
</auth_request>
```

At 20920, the wallet server may authenticate the user. In one implementation, OAuth protocol may be utilized to authenticate the user on behalf of the merchant. In one implementation, the wallet server may use the username and/or password, one or more widget parameters such as API key in the authorization request 20918b, and/or the like to obtain a customer ID associated with the user/customer and the merchant. The wallet server may send the customer ID in an authorization response 20924 to the merchant. In one implementation, the authorization response 20924 may be a back-end notification message sent from the wallet server to the merchant. An example notification message in POST method in XML format is provided below:

```
<?XML version = ″1.0″ encoding = ″UTF-8″?>
<notification-auth>
        <timestamp>2013-02-22 15:22:43</timestamp>
        <customer_ID>56470898786687</customer_ID>
        <apikey>aK2Lejj89j2A1_1On4s2</apikey>
</notification-auth>
```

The merchant server may receive the customer ID in the authorization response message 20924, and query their database to confirm that the customer ID matches a customer record in their customer database. Upon verification or successful authentication at 20916, the merchant server may send an authentication response 20922 to the client 20904. The authentication response, in one implementation, may be the requested web page that is rendered by the client 20904 and displayed to the user at 20938.

In one implementation, the merchant server may use the user sign as a trigger to request current user information from the wallet server. The merchant server may generate and send a user information request message 20926 to the wallet server. The user information request message 20926 may include, without limitation, the customer ID that is unique to the customer and the merchant relationship, a token, an API key, a digital certificate, and/or the like. In one implementation, the token may be generated using one or more parameters such as the merchant's API key, customer ID, merchant ID, merchant name, customer name, and/or the like. In a further implementation, the token may be encrypted. In one implementation, the token may be a string that is created by the MD5 Message Digest algorithm hash of one or more of the parameters listed above. In one implementation, the merchant server may utilize callbacks via APIs, inline widgets, etc., to pull user information from the wallet. For example, the merchant server may call the getPayment API to obtain payment method details such as card nicknames, brand, last 4 digits, etc. An exemplary GET request method for making the call is provided below.

http://server1.vwallet.com/wallet/api/getPayment?callid=
100008&callno=1&apikey=aK2Lejj89j2A1_lOn4s2&token=
u:c6a5941420cf67578986abe8e09a8299&customerid=564708
98786687

The wallet server may obtain the request 20926 and may parse the request at 20928. In one implementation, the wallet server may validate the request by confirming the customer ID, API key and/or the token are correct. At 20930, the wallet server may use the customer ID, for example, to query one or more databases (e.g., customer profile database 20910) for user records. The wallet server may retrieve the user record, preferences, and/or permissions 20932 from the customer profile database. In one implementation, the wallet server may use the associated preferences and permissions specified by the user to determine payment methods that the user has approved for sharing with the merchant. The wallet server may then generate the user information response message 20934 for transmission to the merchant. An example response message 20934 substantially in the form of a HTTP(S) POST message including XML-formatted data, is provided below:

```
<?XML version = ″1.0″ encoding = ″UTF-8″?>
<payment_methods>
  <timestamp>2013-02-22 15:22:43</timestamp>
  <customer_ID>56470898786687</customer_ID>
  <call_ID>3</call_ID>
  <card1_details>
    <nickname>My personal card</nickname>
    <brand>Visa</brand>
    <digits>4554</digits>
  </card1_details>
  <card2_details>
    <nickname>My cashback card</nickname>
    <brand>Visa</brand>
    <digits>4557</digits>
  </card2_details>
  <card3_details>
    <nickname>My prepaid card</nickname>
    <brand>Amex</brand>
    <digits>5555</digits>
  </card3_details>
</payment_methods>
```

The merchant server may receive the response message 20934, and may send the shared user information message 20936 to the client, which renders the received message to display the current user information to the user at 20928. Although only getPayment API call is discussed in detail, other API calls such as those listed in Table 1 may also be called by the merchant server to obtain information including address nick name, indicator for default/primary address, active loyalty programs, program names, indicator for current/primary loyalty program, request to instantiate a purchase against the customer ID, retrieve and redeem previous purchase records for the customer, and/or the like. In an alternate implementation, instead of the merchant making the API calls to obtain the user information, the wallet server may push user information to the merchant. In some implementations, the information push may be a one-time event, for example, when the user connects a new service (e.g., a merchant) to a wallet. In other implementations, the information push may be triggered by events such as the user signing in to a service account via the wallet.

Referring to FIG. 209b, in one implementation, the user may input new information to their merchant account. For example, the user may add a new shipping address to their merchant account. The client may take the user input and package it as an add new information request 20952 to the merchant server. An example add new information request 20952, substantially in the form of a HTTP(S) POST message including XML-formatted data, is provided below:

```
POST /addnewinfo.php HTTP/1.1
Host: www.merchant.com
Content-Type: Application/XML
Content-Length: 667
<?XML version = ″1.0″ encoding = ″UTF-8″?>
<auth_request>
  <timestamp>2013-02-22 15:22:43</timestamp>
  <user_details>
    <user_name>JDoe@gmail.com</user_name>
    <password>Tomcat123</password>
  </user details>
  <new_info>
    <shipping_address>
      <street_name>400 Turtle bay road</street_name>
      <apt_unit>6H</apt_unit>
      <city>New York</city>
      <zip_code>10086</zip_code>
    </shipping_address>
  </new_info>
  <client_details>
    <client_IP>192.168.23.233</client_IP>
    <client_type>smartphone</client_type>
    <client_model>HTC Hero</client_model>
    <OS>Android 2.2</OS>
    <app_installed_flag>true</app_installed_flag>
  </client_detail>
</auth_request>
```

In one implementation, after receiving the new information request 20952, the merchant server may parse the message, and retrieve the user record from the one or more databases and/or tables (e.g., customer profile database 20909). The merchant server may then update the user record and store the updated user record 20954 to the customer profile database 20909. An exemplary listing, written substantially in the form of PHP/SQL commands, to update the user record 20954 in the customer profile database, is provided below:

<?PHP
header(′Content-Type: text/plain′);
// store input data in a database
mysql_connect (″201.408.185.132″, $DBserver, $password);
// access database server
mysql_select (″Customer_Profile_DB.SQL″); //
select database to append
mysql_guery (″UPDATE UserTable
SET street_name = ′400 Turtle bay road′, apt_unit =
′6H′, city = ′New York′,
zip_code = ′10086' timestamp = 2013-02-22 15:22:43′
WHERE username = ′JDoe@gmail.com′ ″);
mysql_close (″CSF_DB.SQL″); // close
connection to database
?>

In one implementation, the merchant may send the new user information message 20956 to the wallet server. An example new user information message 20956, substantially in the form of a HTTP(S) POST message including XML-formatted data, is provided below:

```
POST /addnewinfo.php HTTP/1.1
Host: www.vwallet.com
Content-Type: Application/XML
Content-Length: 667
<?XML version = ″1.0″ encoding = ″UTF-8″ ?>
<add_newinfo>
    <timestamp>2013-02-22 15:22:43</timestamp>
    <apikey>aK2Lejj89j2A1_1On4s2</apikey>
    <token>u:c6a5941420cf67578986abe8e09a8299
    </token>
    <customer_ID>56470898786687</customer_ID>
    <new_info>
      <shipping_address>
        <street_name>400 Turtle bay road</street_name>
        <apt_unit>6H</apt_unit>
        <city>New York</city>
        <zip_code>10086</zip_code>
      </shipping_address>
    </new_info>
</add_newinfo>
```

The wallet server may receive the new user information message 20956 from the merchant, along with customer ID. The wallet server may parse the received information at 20958. Using the customer ID extracted from the received information, the wallet server may query one or more customer profile databases at 20960. At 20962, the server may obtain query results. In one implementation, the query may be performed to determine whether the field of new user information is a field that is permitted for updating using information from the merchant source. For example, in one implementation, shipping information may not be a field that is permitted for updating based on information from the connected service such as the merchant while other information such as a new telephone number received from the merchant may be used to update the customer record in the database (e.g., 20910). Such permissions for adding, removing, changing, updating, etc., information to and from the wallet may be specified by the user via the permission control panel discussed in detail with respect to FIG. 2012. In some other implementations, whether information flowing from the merchant to the wallet server can be accepted by the wallet server, and used to update the customer records, may depend on the merchant trust level, how critical the update or change is (e.g., changing a payment method versus changing a telephone number), and/or the like. At 20966, depending on whether it is appropriate to update the customer record, the wallet server may or may not update the record. At 20970, the wallet server may send a confirmation message to the merchant server to confirm whether the new information was accepted, and the current information that is on the records in the wallet. At 20972, the merchant server may send the client a confirmation message whether the update was successful or not. The client may display the confirmation message at 20974. In one implementation, the wallet server may directly communicate with the user (e.g., via email, SMS, MMS, phone, etc.,) at 20968 and solicit and/or provide confirmation of the addition of the new information.

FIG. 2010 shows a logic flow diagram illustrating an example account creation and management in some embodiments of the Bill Pay. In one implementation, at 201005, if a customer has an existing merchant account, the customer may login using merchant account credentials 201010. Alternately, the customer may login using their wallet account credentials 201015. If the customer selects login via the wallet, a wallet widget may be provided at 201020 for the customer to enter their wallet credentials. At 201025, if the customer does not wish to connect their wallet to their merchant account, the merchant may use the customer's information on file or solicit information from the customer to complete a transaction at 201030. On the other hand, if the customer requests connection between the merchant account and the wallet account, and the customer is already authenticated by the wallet at 201035, the customer may set preferences and permissions at 201045. If the customer has not been authenticated, a wallet widget may be launched to obtain wallet credentials from the user for authentication at 201040. At 201050, the wallet may create a customer ID as a record of the relationship between the customer and the merchant, and the associated preferences and permissions. The customer ID may be sent to the merchant. Using the customer ID and/or API keys or tokens, the merchant may request customer information such as shipping address, payment method, and/or the like at 201055. The wallet may provide the merchant the information that is permitted for sharing by the customer preferences and permissions. At 201060, the merchant may use the information from the wallet to conduct a transaction. In one implementation, the transaction may be via the wallet. In another implementation, the transaction may be via a lightbox widget rendered within the merchant site.

In one implementation, if there is no existing merchant account as determined at 201005, the customer may create a new merchant account. In one implementation, the customer may create a new merchant account via the merchant 201065 where the user may fill out a form with fields for name, address, email, username, password, and/or the like at 201075. At 201080, the merchant may use the customer provided information to create a new account for the customer and the decision may move to 201025. If, on the other hand, the customer selects an option to create a new merchant account via the wallet 201070, the Bill Pay may determine whether the customer has an existing wallet account at 201085. If the customer does not have a wallet account, the Bill Pay may request the user to create a wallet account at 201090. Once there is an existing wallet account, the Bill Pay may obtain customer wallet credentials, and may authenticate the user at 201092. At 201094, the Bill Pay may obtain preferences and/or permissions for the merchant account. At 201096, the Bill Pay may create a customer ID that establishes the relationship between the merchant and the customer. In one implementation, the Bill Pay may store the preferences and/or permissions along with the customer ID in its customer database. At 201098, the Bill Pay may provide user information allowed by the preferences and permissions to the merchant along with the customer ID. At 201062, the merchant may receive the provided information and may create a merchant account for the customer. At 201060, the merchant may use the wallet provided information to transact with the customer.

In some embodiments, the Bill Pay framework may be leveraged for prepaid card provisioning and personalization. An online wallet service such as Wallet by Paymentmay store consumer information for a number of purposed including for expediting online shopping and checkout. Cardholder information (such as name, account number, contact information, billing and shipping addresses etc.) flows originally from an issuer through a provisioning process to the wallet and then by instruction of the consumer to a merchant at the time of checkout. Some embodiments of the Bill Pay entail reversing the flow of information, such that an online wallet may provision account information with an issuer and at the same time link the account records at the wallet with the account records of the prepaid issuer.

FIG. 2011 shows a block diagram illustrating an example prepaid card personalization in some embodiments of the Bill Pay. In one implementation, a consumer having a wallet account may obtain a new gift card (open loop or closed loop) or a reloadable prepaid card 201130. The consumer may personalize the card for online or offline usage and be able to view and service the account with the issuer. In one implementation, through the issuer's online or mobile service channel 201105, the consumer may click a Bill Pay button 201110. In a further implementation, the Bill Pay button may spawn a modal widget 201115 powered by the wallet. The consumer may authenticate to the wallet and may confirm their wish to personalize the new card and share the personalization information with the issuer. In one implementation, the personalization information may include information from the consumer profile in the wallet's central consumer profile database 201125 such as name, contact information, billing address, shipping address, card nickname, and/or the like. The wallet, upon receiving confirmation from the consumer, may share the consumer's personalization information with the issuer's prepaid platform service 201105. The prepaid card may then be loaded and stored in the consumer's wallet profile. In one implementation, once the prepaid card is linked to the wallet, the consumer may log in to the issuer's prepaid service using their wallet credentials (saving them having to remember additional usernames and passwords for every prepaid account). In a further implementation, the Bill Pay provides an option for prepaid platforms to integrate all prepaid card management and services directly into wallet platform. In some implementations, APIs for the wallet platform may be available to query current available balances and transaction history from issuer cards linked to the wallet service.

FIG. 2012 shows a user interface illustrating an example Bill Pay settings control panel in some embodiments of the Bill Pay. The Bill Pay control panel may provide common customer experiences across different parties that are connected via the Bill Pay facilities to the wallet. Using the Bill Pay control panel, the customer may manage permissions and preferences for all parties connected to the wallet and establish a set of flexible standards to define which parties can read, write, update/modify or publish what customer profile information, which parties can execute transaction against the wallet account, or inject plug-ins and widgets to the wallet, and/or the like. Customers, including those who are concerned about how much data they should trust with various parties they do business with or use their services, may leverage the framework of the Bill Pay control panel to manage their identities and payments at various service providers such as merchants, utility providers, loyalty providers, money transfer services, and any other service providers (“merchants”). The components of the permissions/settings control panel may enforce terms of connection relations. For example all API calls by the service may be validated against the permissions and business rules expressly agreed to by the customer.

In one implementation, the Bill Pay control panel may include several panels such as service providers 201205, payment methods 201210, shipping address 201215, share 201220, permissions 201225, and/or the like. The service providers may include, without limitation, any party that a customer may do business with. The customer may have an identity, payment relationship, etc., established with such parties. The customer may select any one, multiple or all of the service providers 201205a-j for individual or group preference and permission management. In one implementation, the customer may select the merchant NORDSTROM 201205c. The customer may then configure each of the payment methods, shipping addresses, share, and permissions for the selected merchant 201205c. The payment methods panel 201210 may list one or more payment methods 201210a-d that are present in the wallet. The panel 201210 may display an image of the card (e.g., from the issuer), a nickname for the card, card identifier, card brand, and/or the like. The payment methods may also include bank or other financial accounts, debit cards, credit cards, prepaid cards, gift cards, and/or the like. In some implementations, the customer may also add new card to the wallet directly from the control panel interface. The customer may select one or more of these payment methods for sharing with the merchant 201205c. When the wallet provides the shared payment method to the selected service provider, only select information such as the nickname, brand, and last four digits of the card number, etc., may be shared. In some implementations, the actual card or account number may not be shared with the service provider.

The customer, using the permissions panel 201225, may authorize the service provider to execute transactions (option 201225a) against the wallet using the selected payment methods. In some implementations, the customer may also set up, using the permissions panel 201225, recurring billing authorization 201225C, subscription payments 201225d, and/or the like. For example, at the end of a month, a merchant (e.g., AT&T) may request authorization from the wallet to bill a monthly charge amount (e.g., $120.55) against the standing instructions for a “default” payment method by a customer having a customer ID. The wallet may be storing the standing payment instructions for “default” payment method in slot 1 of the wallet and a back up payment method in slot 2 of the wallet. The wallet may map slot 1 to an actual payment method and authorize billing using the actual payment method, without the merchant knowing the actual payment method. In one implementation, depending on the merchant request, a tiered authentication may be employed to more rigorously authenticate the merchant/customer. For example, a merchant that usually transacts against the primary card and primary shipping address may request to execute a transaction against another shipping address (e.g., grandma's address). Such a request may then cause the wallet to step up the authentication protocol (e.g., get customer confirmation, request digital certification, etc.) to ensure that the transaction being executed is not a fraudulent transaction.

In one embodiment, the Bill Pay may leverage its facilities to determine liability for transactions that happen based on trust relationships. For example, depending upon whether the merchant tries to bill the customer with or without popping up an extra widget to log on could affect the liability for the transaction. Using TSM (trusted service manager) protocols where a secure key from a issuer is passed to put on a phone or other client device, so that the wallet knows a secure key from the issuer was present during the transaction, may also prevent fraud and affect the liability for the transaction. Similar trust relationship could also be used for liabilities relating to change requests, for card not present transactions, and/or the like.

In some implementations, the customer may set up shipping address preferences for the service provider. The shipping address panel 201215 may display a list of shipping addresses 201215a-1215c stored in the customer profile with the wallet. Each of the shipping addresses may be nick named. The customer may select one or more of the shipping addresses for sharing with the merchant, and may add another address 201215d to the wallet directly from the shipping address panel 201215. In some implementations, the customer may allow shipping address to be a field which the service provider may have write access to by configuring the allow write access option 201215e. Such authorization for write access to the shipping address field of the customer profile record in the wallet's customer database may allow any changes the customer may make to the shipping information from the service provider interface to propagate to the wallet. Such a bi-directional flow of information may ensure true syncing of user information across various service providers and the wallet. In some implementations, the customer may configure, using the permissions panel 201225, that any profile changes may be confirmed with the customer (option 201225b). The wallet, in such a case, may send the customer a request to review and/or confirm the profile change, and may update its customer profile upon explicit approval from the customer.

In some implementations, the control panel's share panel 201220 may display a list of information fields that may be shared by the customer with the service provider. Examples of the fields of information include, without limitation, name 201220a, primary email address 201220b, work email address 201220c, information for account creation 201220d, loyalty programs 201220e, specific loyalty programs 201220f, wish lists 201220g, points balance 201220h, and/or the like. In one implementation, one or more of these fields may be configured for write access 201220i. Using the permissions panel 201225, the customer may further configure whether the service provider is allowed to execute transactions against the wallet 201225a, authorized to bill the customer 201225C, authorized the wallet to make/bill for subscription payments 201225d, require confirmation before modifying the customer profile 201225b, and/or the like. Various other permissions and panels for configuring and managing customer information federation are within the scope of the embodiments of the Bill Pay.

FIG. 2012a is an example embodiment of a Bill Pay configured to display a success confirmation 201226 screen after the enrollment of new payment cards 201228, 201229 in a virtual wallet account. In some embodiments, the wallet account may already been established and contain cards previously added 201227.

FIG. 2013a-i show example user interfaces in some embodiments of the Bill Pay.

FIG. 2014 shows an exemplary screenshot depicting a merchant checkout system. In one embodiment, the Bill Pay may facilitate the administration of payments to merchants that contain a current transaction 201401 and a future transaction 201402. In some embodiments, the merchant may place a button 201403 on their web page that may facilitate the creation of a reference account link. The button may, in some embodiments, contain information from the available reference transaction links previously created by the consumer. For example, the button may designate which reference account may be used for the transaction. In another example, the button may designate a reference for a shipping address to be used for the transaction or a persona that the user may wish to engage in the transaction using. Other embodiments may contain any manner of consumer information that may be subject to change over time.

FIG. 2014a shows an exemplary screenshot depicting an inline login for accessing a consumer's Bill Pay account 201404. In some embodiments, a user may log in using their email address and a password 201406. In other embodiments, the user may optionally choose to create a virtual wallet account 201405 to facilitate future transactions with the current or other merchants.

FIG. 2014b shows an exemplary screenshot depicting a merchant account creation screen facilitated by the Bill Pay. In this and other embodiments, the consumer may choose to create an account 201410 with the merchant and provide contact/shipping information 201407 and/or payment information 201408 to complete the transaction. Optionally, the consumer may choose to simultaneously create a virtual wallet account 201409 to facilitate future transactions with either the current merchant or other merchants.

FIG. 2015 shows an example enrollment lightbox for creating a Bill Pay link between a user's virtual wallet and a merchant. In some embodiments, the enrollment form may contain details about the transactions authorized 201502. The transactions may be one-time transactions, periodic transactions, recurring transactions, or any combination thereof. Additional terms may be included or associated with the reference transaction link. For example, some reference transaction links may have expiration dates, frequency caps, amount caps, alert requirements, heightened security requirements, or other desired limitations. In some embodiments, the user may be prompted to agree to the requirements for the current or future transactions. A consumer may designate a payment account reference 201503 to use for the transactions. In some embodiments, the consumer may choose more than one payment reference account for the transactions. In alternative embodiments, the consumer may choose one payment account reference for the current transaction and a different payment account reference for future transactions. The consumer may also designate other information by reference either alone or in combination with reference payment transactions. For example, the consumer may designate a reference persona 201504 for the transaction. In some embodiments, the reference persona may contain contact information for the consumer. In other embodiments, the reference persona may contain contact information for another party. In still other embodiments, the reference persona may contain privacy enhanced information that limits the merchant's knowledge of some of the consumer's personal information or details. In some embodiments, the consumer may designate a reference address 201505 for use in the transaction. The reference address may be a user's preferred shipping address for a transaction. In other embodiments, the reference address may contain multiple addresses for use in various parts of the transactional relationship with the merchant. In still other embodiments, the reference address may be a designation that resolves to a third party that may then forward shipments to the consumer. In this embodiment, the consumer may advantageously be able to receive shipments using a reference address from a merchant without disclosing their actual address information to the merchant. Third parties may act as intermediaries for different types of reference links in various embodiments. In some embodiments, the consumer may click a button in the lightbox 201506 to link the selected references to the merchant. In other embodiments, the consumer may click a button 201507 to create a new reference. In doing so, the consumer may be prompted for information required to establish the reference link, such as adding a card to the consumer's wallet, adding an address for the reference link, or adding a persona to a virtual wallet. In some embodiments, the consumer may be presented with a QR code 201508, bar code, or other visual element suitable for scanning by a mobile device. In doing so, the user may be able to establish the reference link with heightened security, less user input, or by sharing less information directly with the merchant. In some embodiments, the reference transaction link may be established to facilitate future refunds to the consumer. For example, a user may enroll a reference transaction link with an insurance provider to facilitate future claim refunds to the user's virtual wallet. In other embodiments, the refund reference link may be used by a merchant that has previously charged the user for a transaction. In alternative embodiments, the refund reference link is only used to facilitate refunds and may not be used for payments.

FIG. 2016 shows an example user interface illustrating a reference management console. In some embodiments, the consumer can see the merchants associated with a payment reference 201601. A nickname for a payment reference 201609 may be displayed in some embodiments. A consumer may update the nickname associated with a reference 201609 or the payment account the reference uses 201603 by clicking a button 201602 in one embodiment of the interface. In some embodiments, multiple payment accounts may be linked to one reference account. The nickname the user has chosen for the reference payment link 201609 may also be customized for various merchants using the reference 201604 to facilitate recognition of the reference account in the context of a merchant's web site. In some embodiments, the reference management console may show the terms of the financial relationship 201605 that the consumer has established with the merchants. The terms, in other embodiments, may be other than payment terms. For instance, terms may be product specifications, shipment standards, on-account credit agreements, or other aspects of the consumer's relationship with a merchant. In some embodiments, a transaction history is available in the management console or elsewhere in the Bill Pay. A consumer may also administer the reference transaction links from within the reference management console or elsewhere in the Bill Pay. For example, the consumer may revoke access to a merchant linked to a reference payment 201607. A consumer may also cancel a recurrent subscription with a merchant from within the Bill Pay. In alternative embodiments, the consumer may request more favorable payment terms, incentives, value added services, or a refund through the reference management console or elsewhere throughout the Bill Pay.

FIG. 2017 shows a block level diagram depicting exemplary failover payment capabilities of a reference transaction payment link. In one embodiment, the user may designate a reference name for a collection of payment accounts 201701. The user may choose a primary account to be used if sufficient funds are available 201702 and a backup account to be used in the event the primary account link fails 201703. A failure may be caused by insufficient funds, account closure, or other events. In an example transaction, merchant 201707 may use reference 201701 to execute a transaction that resolves to payment account 201702 and successfully processes the payment 201704. In another example, if the reference link to the primary payment method is broken 201705, the transaction may still resolve to backup payment method 201706. In alternative embodiments, the consumer may designate rules regarding the order in which payment accounts should be used by a reference link and what criteria should determine the order. For example, a consumer may decide that all transactions from a certain type of merchant (i.e., grocery transactions, foreign travel transactions, etc.) should be processed through one payment account associated with the reference payment link. The consumer may also designate other payment accounts to handle transactions of other types.

FIGS. 2018 and 2018a are exemplary datagrams depicting the creation of a reference payment link between a merchant and a user. In FIG. 2018, user 201821 requests a checkout page using a client terminal 201806. The checkout page request 201802 is dispatched to a merchant web server 201803. The merchant web server then replies to client 201806 with a checkout page response 201804. The checkout page response 201804 is embedded with code that causes client to initiate a second request to a wallet server. The client 201806 parses the checkout page response 201805. The client then dispatches a second request 201807 to a wallet server for a payment button. The wallet server responds with a payment button 201809, which is rendered by the client terminal 201820. The user then designates the payment button using an input device such as a mouse or finger 201822. The client 201806 then dispatches a request for a lightbox 201823 to wallet server 201808. The wallet server replies with a lightbox response 201824 containing reference transaction link information. In some embodiments, the lightbox response is substantially in the form of an HTTP(S) message including XML-formatted data, as provided below:

```
Host: www.merchant.com
Content-Type: Application/XML
Content-Length: 667
<?XML version = 1.0″ encoding = ″UTF-8″ ?>
<lightbox_response>
  <timestamp>2013-02-22 15:22:43</timestamp>
  <user_details>
    <username>JDoe@gmail.com</user_name>
    <password>Tomcat123</password>
  </user details>
  <reference>
    <refname>Personal Card</refname>
    <type>reference_payment</type>
    <contract_id>1Z4567248987321</contract_id>
    <contract_trms>234.99, immediate | 40.00, permonth
    </contract_trms>
  </reference>
  <reference>
    <refname>Secret Name</refname>
    <type>reference_persona</>
    <name>Alias Name</name>
  </reference>
  <reference>
    <refname>Vacation Address</refname>g
    <type>reference_address</>
    <addr>500 Main St.</addr>
    <city>Anycity</city>
    <state>NY</state>
    <zip>12345</zip>
  </reference>
</lightbox_response>
```

The datagram in FIG. 2018 then continues in FIG. 2018a. Client 201806 then renders the lightbox 201825. In some embodiments, the lightbox appears overlaid on the merchant's web site. In other embodiments, the lightbox appears in a different window. Upon rendering of the lightbox, user 201821 is then presented with reference links that have already been created. In some embodiments, the user may re-use a previously created reference payment, persona, address, or other link by selecting its alias from the lightbox. In other embodiments, the user can create a new reference link from within the lightbox. In some embodiments, the reference creation request 201827 may be substantially in the form of an HTTP(S) message including XML-formatted data, as provided below:

```
Host: www.merchant.com
Content-Type: Application/XML
Content-Length 667
<?XML version = ″1.0″ encoding = ″UTF-8″ ?>
<reference_creation_request>
  <timestamp>2013-02-22 15:22:43</timestamp>
  <user_details>
    <user_name>JDoe@gmail.com</user_name>
    <password>Tomcat123</password>
  </userdetails>
  <new_reference>
    <refname>New Business Card</refname>
    <type> reference_payment</>
    <card_num>1234123412341234</card_num>
    <contract_trms>234.99, immediate | 40.00,
    permonth</contract_trms>
  </new_reference>
</reference_creation_request>
```

In some embodiments, wallet server 201808 may then process the reference creation request. For example, the wallet server may verify that the reference payment may be linked to the merchant. The wallet server may also verify that the reference payment account has sufficient funds to cover the current or future transactions. The wallet server 201808 then may reply to client 201806 with a reference creation response indication successful or failed reference creation. The client 201806 may then render response 201830.

FIG. 2019 illustrates an example issuer side wallet enrollment interface user interface. In some embodiments of the Bill Pay, a consumer may be logged into their bank issuer's web site or mobile application 201901. The web site may provide a listing of accounts that are associated with the consumer 201902-201902a. Additionally, recent transaction and balance information 201904-201904a may be provided to the consumer. In one embodiment, a consumer may add one or more accounts to a virtual wallet by indicating which accounts from the accounts associated with the issuer should be added to the virtual wallet 201903-201903a. In other embodiments, the consumer may be able to select multiple cards for simultaneous addition to a virtual wallet.

FIG. 2020a illustrates a lightbox window 202001 for linking payment accounts to a virtual wallet, creating a virtual wallet, and/or simultaneously creating a virtual wallet and linking payment accounts to the newly created wallet account. In some embodiments, the lightbox is generated from a third-party provider through the use of Server-Side-Includes, absolute URL's, JavaScript, or other like inclusion mechanism. In other embodiments, the lightbox may instead by displayed after forwarding the user to a third-party web site and/or in a form that encompasses an entire browser window. In some embodiments, the consumer may desire to enroll more than one card 202002 simultaneously in their wallet account. As such, the lightbox may facilitate through one interface the simultaneous addition 202003 of multiple cards to a wallet account. In some embodiments, the user may already have a virtual wallet account that they wish to associate the payment accounts with 202004. As such, the lightbox may solicit from the user credentials sufficient to identify the virtual wallet account to which the payment accounts should be added. In some embodiments, the credentials may be in the form of a user name/password combination, a user name/Email combination, and/or the like 202005. Once the user has entered the appropriate wallet credentials, they may then link the payment accounts to the wallet 202006. This may result in the lightbox (e.g., from an issuer, merchant, and/or a like source) creating message 202221 and pulling the information from the issuer server (see FIG. 2022b). In other embodiments, the consumer may desire to simultaneously create a virtual wallet account and add the selected payment accounts to the wallet 202007. Advantageously, in some embodiments the consumer may desire to allow the issuer of the payment accounts to send information regarding the consumer's financial account with the issuer and/or the consumer's payment accounts with the issuer to the virtual wallet account provider 202008. In doing so, the consumer may be assisted in the creation of a virtual wallet account by avoiding the entry of repetitive data that the issuer already has on file. This pre-fill of data may also be advantageously used in the establishment of other account types, including pre-paid accounts, reward accounts, savings accounts, and/or the like. In other embodiments, the consumer may indicate that the virtual wallet account is to be set up with the requirement for two factor authentication 202009. Two factor authentication is a form of authentication that requires two distinct types of information in order to authenticate a user. For example, a user may be required to provide a user name/password combination and a one-time code generated by their mobile device. Alternatively, the user may be required to identify an image of a friend and provide a thumbprint. Any two types of information that are known to a consumer may be used to enable two-factor authentication using the Bill Pay. In other embodiments, the consumer may be prompted to simultaneously create a pre-paid payment account while they are creating a new wallet and/or linking payment accounts to an existing wallet. In some embodiments, if a consumer chooses to create a pre-paid account they may be prompted to select a payment account from which to fund the pre-paid account. In other embodiments, the consumer may then enter the account information (e.g., account number, billing address, etc.). In still other embodiments, the account information may be retrieved from the account issuer or from the issuer the consumer is currently logged into. In some embodiments, the consumer may desire to create a rule set that may define the conditions in which the pre-paid account may be replenished with funds. Some example rules include the re-filling of the pre-paid account when the account balance reaches a threshold, the re-filling of the pre-paid account when a user's chosen financial account(s) reach a certain balance amount and/or receive a deposit of a certain size, and/or the like. In doing so, the Bill Pay may enable a user to easily create a pre-paid account while linking another account to their virtual wallet, creating a virtual wallet, and/or the like. In some embodiments, the pre-paid card creation request 202010 may be substantially in the form of an HTTP(S) message including XML-formatted data, as provided below:

```
Host: www.foo.com
Content-Type: Application/XML
Content-Length: 667
<?XML version = ″1.0″ encoding = ″UTF-8″?>
<prepaid_creation_request>
    <timestamp>2020-02-22 15:22:43</timestamp>
    <user_details>
      <username>JDoe@gmail . com</user_name>
      <password>Tomcat123</password>
      <billing_address>123 Main St. </billing_address>
      <billing_state>VA/billing_state>
      <billing_zip>12345</billingzip>
    </user_details>
    <prefill_data_source>
    <type>prefill_from_issuer_account_data</type>
    <account_number>456456456456</account_number>
  </prefill_data_source>
  <new_prepaid_card>
    <name>Lunch Money Prepaid Card</name>
    <type>prepaid</type>
    <funding source>
      <type>rewards_points_account</type>
      <initial_deposit>10000points</initial_deposit>
      <currency_value>$124.52</currency_value>
    </funding_source>
    <funding_source>
      <type>savings_account</type>
      <account_number>1234123412341234
      </account_number>
      <routing_number>012345678</routingnumber>
      <initial_deposit>$500.50</initial_deposit>
    </funding_source>
    <funding_source>
      //...n-sources of funding...
    </funding_source>
    <replenishment_rule>
      <type>low_prepaid_balance_initiate_deposit
      </type>
      <trigger_value>$20.00</trigger_value>
      <expires>2010-01-01</expires>
    </replenishment_rule>
    <replenishment_rule>
      <type>date</type>
      <frequency>monthly</frequency>
      <day>15</day>
      <expires>never</expires>
    </replenishment_rule>
  </new_prepaid_card>
</prepaid_creation_request>
```

In some embodiments, the user may desire to simultaneously pre-fill information at the virtual wallet provider, force two-factor authentication before using the virtual wallet account, and/or establish a pre-paid payment account 202011.

FIGS. 2020b-2020d show an example alternate embodiment of the interface as described in FIG. 2020a. In some implementations, the user may be presented to a card management screen (e.g., from an issuer, merchant, and/or like source) that allows the user to select 202012 bank credit cards 202013a and/or debit cards 202013b to be used in the user's virtual wallet. In some implementations, information 202014 related to each card may be displayed with the card selection, including the card number, the card balance, images of the card, and/or like identifying information. After entering sign-in information 202015 for the user's virtual wallet account (e.g., a username or email address, a password, and/or like information), the user may click a button 202016 to submit the chosen cards and to log into the user's virtual wallet account. This may result in the website (e.g., from an issuer, merchant, and/or a like source) creating message 202220 and pushing the information to the virtual wallet server (see FIG. 2022b).

If the user does not have a virtual wallet account, the user may sign up via filling out a form 202017 as shown in FIG. 2020C, which may ask the user for identification information (e.g., a name, username, and/or the like), an email address, a password for the account, other information (e.g. gender, address, and/or the like), and/or like information. Once the user has entered said information, the user may click the continue button 202016 to submit the request for an account and the card selections to be associated with the newly-created account.

In some implementations, the Bill Pay, before submitting the card selections, may present the user with lightbox 202018, which may indicate which cards have been selected. The user may have the ability to confirm the card selections by leaving all of the selections 202019 as-is and clicking the complete button 202021, may deselect one or more of the selected cards and click the complete button, or may click the start over button 202020 in order to clear all selections and to return to the card selection interface. As such, in such implementations, only the accounts checked or otherwise selected by the user may be passed to the virtual server and added to the user's virtual wallet. Once the user has clicked the complete button, the bank issuer may package the information received from the user, and may send it to the Bill Pay. The Bill Pay may then send a request to a virtual wallet server, authenticating the user's account via the submitted login data, and requesting that the virtual wallet server associate the specified cards with the user's virtual wallet. If the user submitted information for creating a new virtual wallet account, the Bill Pay may instead send a request that creates a virtual wallet account for the user and associates the specified cards with the user's virtual wallet.

FIG. 2021 is an example data and logic flow illustrating the enrollment of a consumer account in a virtual wallet service and the utilization of a pre-fill service to pre-populate information necessary for wallet enrollment. In some embodiments, the consumer is directed to the virtual wallet enrollment page by directly typing the enrollment URL in a web browser 202101. In some embodiments, the consumer is navigated to a wallet login page where they may log into a wallet or create a new wallet account 202101a. In other embodiments, the consumer may enroll in the virtual wallet through a link in their issuer's web site, credit card company, rewards online access account, and/or the like. In some embodiments, the user may then create a virtual wallet account 202102. In other embodiments, the user may log into their pre-existing virtual wallet account. The user may then activate the wallet account 202102a. The user may then indicate that they desire to add a new payment account to their virtual wallet 202103. The Bill Pay may then request that the user consent to the retrieval of their payment account information from the payment account issuer 202104. The user may be asked to provide the account number of the payment account that the user wishes to link to their virtual wallet account 202105. The Bill Pay may then use the user's account number or other credential such as a username/password combination or the like to initiate a request for retrieval of pre-provisioned data associated with the payment account 202106. In some embodiments, the request for retrieval of pre-provisioned data 202106 (e.g., “prefill data”) may be in the form of an HTTP(S) message including XML-formatted data containing fields substantially similar to the following:

| | | | | |
|---|---|---|---|---|
| Element | | Field | Element | |
| Name | Description | Size | Type | Business Rule |

| | | | |
|---|---|---|---|
| BID | Business ID of | Numeric | For Federated Scenarios |
| | the issuer | | BID and CID |
| CID | Customer ID of | Numeric | |
| | the Cardholder | | |
| PAN | PAN Number of | Numeric | For Manual scenario |
| | the Cardholder | | PAN entered by the |
| | | | user |

In some embodiments, the request for retrieval of pre-provisioned data 202106 (e.g., “prefill data”) may be substantially in the form of an HTTP(S) message including XML-formatted data, as provided below:

```
Host: www.server.com
Content-Type: Application/XML
Content-Length: 667
<?XML version = ″1.0″ encoding = ″UTF-8″ ?>
<preprovisioned_prefill_request>
        <BID>247581</BID>
        <CID>9854254</CID>
        <PAN>1234123412341234</PAN>
        <wallet_id>RW987856</wallet_id>
</preprovisioned_prefill_request>
```

In some embodiments, the issuer may then use the data in the request to perform a lookup of account and/or prefill information that may be shared with the requesting service. In some embodiments, the issuer may have a permissions rule set that governs what data may be shared with requesting services. Example rules include, “Never share my business account number,” “Default to my personal account,” “Never share my billing address,” and/or the like. In some embodiments, the issuer may then respond to the virtual wallet server 202107 with a prefill data package containing user, user account, user financial account, and/or similar data for use in establishing a virtual wallet account, pre-paid account, enrolling a payment account in a virtual wallet, and/or the like. In some embodiments, the pre-provisioned data response 202107 (e.g., “prefill data”) may be in the form of an HTTP(S) message including XML-formatted data containing fields substantially similar to the following:

| | | | | |
|---|---|---|---|---|
| Element | | Field | Element | |
| Name | Description | Size | Type | Business Rule |

<User Details>

| | | | | |
|---|---|---|---|---|
| BID | Business ID of the | 8 | Alpha Numeric | Identification of the bank |
| | Issuer | | | |
| CID | Customer ID of the | 10 | Numeric | The CID |
| | Cardholder | | | The Customer ID is a unique identifier the user for the |
| | | | | given issuer. This field is used to link the accounts (PANs) for |
| | | | | a given user for the BID |
| Name Prefix | | 5 | Alpha Numeric | |
| First Name | Cardholder first | 15 | Alpha Numeric | |
| | name | | | |
| Middle Initial | Cardholder | 1 | Alpha Numeric | |
| | middle name | | | |
| | initials | | | |
| Last Name | Cardholder last | 25 | Alpha Numeric | |
| | name | | | |
| Name Suffix | Cardholder suffix | 5 | Alpha Numeric | |
| Company Name | | 40 | Alpha Numeric | Company name if the account is help by a company |
| | | | | instead of an individual |
| Country Code | | 3 | Alpha Numeric | County of Residence of the cardholder |
| | | | | Numeric Country code |
| | | | | ISO Numeric Currency Code. |
| | | | | USA: 840 |
| | | | | Canada: 124 |
| Language Code | Cardholder | 8 | Alpha Numeric | Cardholder language as set with the issuer |
| | language as set | | | |
| | with the issuer | | | |

<Card Details>

| | | | | |
|---|---|---|---|---|
| Account Number | PAN Number of the | 19 | Alpha Numeric | Card Number |
| | Cardholder | | | |
| Card Expiry Date | Expiration date of | 4 | UN | The expiration date as provided on the card |
| | the card | | | Format: YYMM |
| Card Brand | | 4 | Alpha Numeric | Sample of the card brand: |
| | | | | Visa |
| Product Identifier | | 2 | Alpha Numeric | |
| Company Name | | 40 | Alpha Numeric | |
| Name on the Card | | 26 | Alpha Numeric | |
| Phone Number on | | 10 | UN | |
| back of the card | | | | |
| Billing Cycle Start | | 8 | UN | Account Billing Cycle start date, used for spend |
| Date | | | | accumulations and remainders |
| Street Number | | 10 | AN | Billing Address street number |
| Address Line 2 | | 40 | AN | |
| Street Name | | 40 | AN | Billing Address street name |
| Unit Number | | 10 | AN | |
| PO Box Number | | 10 | AN | |
| City | | 30 | AN | Billing Address City |
| State | | | AN | Billing Address state |
| | | | | For US |
| Province | | 10 | AN | Billing Address province |
| | | | | For Canada |
| ZIP | | 10 | UN | Billing Address zip code |
| Country | | 3 | AN | Billing Address country |
| Product Type | | 10 | AN | The product type as provided on the card |
| | | | | Credit |
| | | | | Debit |
| | | | | Prepaid |
| Card Image Name | | 50 | AN | |
| Reason code | | | | |

In some embodiments, the pre-provisioned data response 202107 (e.g., “prefill data”) may be in the form of an HTTP(S) message including XML-formatted data substantially similar to the following:

```
Host: www.server.com
Content-Type:  Application/XML
Content-Length:  667
<?XML version =  ″1.0″ encoding = ″UTF-8″?>
<preprovisioned_prefill_response>
        <BID>247581</BID>
        <CID></CID>
        <wallet_id>AK21574</wallet_id>
        <name_prefix></name_prefix>
        //reference link may be used in place of data
        <first_name>
ref_link=http://visanet.com/ ?walletid=AK21574&user_id=9548field=first_name
</first_name>
        <middle initial></middle initial>
        <lastname>Doe</last_name>
        <name_suffix></name_suffix>
        <company_name></company_name>
        <country_code></country_code>
        <languagecode></language_code>
        <account_number>
ref_link=http: //visanet.com/?walletid=AK21574&user_id=9548field=account_number
</account_number>
        //alternatively, parameters (e.g. card expiration date)
        //can be made a live link requiring no parsing
        <card_expiry_date
ref_link=http: //visanet.com/ ?walletid=AK21574&user_id=9548field=card_expiry_date>
09/2020</card_expiry_date>
        <card_brand>Visa< /card_brand>
        <product_identifier></product_identifier>
        <company_name>< / company_name>
        <name_on_card
ref_link=http://visanet.com/ ?walletid=AK21574&user_id=9548field=name_on_card >
John Doe</ name_on_card>
        <phone_number_on_card></phone_number_on_card>
        <billing_cycle_start_date>< / billing_cycle_start_date>
        <street_number
ref_link=http://visanet.com/?walletid=AK21574&user_id=9548field=street_number>
58</street_number>
        <address_line_2>< /address_line_2>
        <street_name
ref_link=http://visanet.com/?walletid=AK21574&user_id=9548field=street_name >
Main St.</street_name>
        <unit_number></unit_number>
        <pobox_number></pobox_number>
        <city
ref_link=http://visanet.com/?walletid=AK21574&user_id=9548field=city_name >
Anytown</city>
        <state
ref_link=http://visanet.com/ ?walletid=AK21574&user_id=9548field=state>VA</state>
        <province></province>
        <zip
ref_link=http://visanet.com/?walletid=AK21574&user_id=9548field=zip>11547</zip>
        <country></country>
        <product_type></product_type>
        <card_image
ref_link=http://visanet.com/ ?walletid=AK21574&user_id=9548field=card_image>http:
//www.imageserver.com/DRESKKJHKUHU/?764765765765</card_image>
        <reason_code></reason_code>
</preprovisioned_prefill_response>
```

In some embodiments, the pre-provisioned data response 202107 may contain reference links (e.g., 201503, 201504, 201505 and/or the like) allowing dynamic updating of the data in the virtual wallet and/or at the payment card issuer. In some embodiments, the virtual wallet may then pre-populate the provided information 202108 into a form for enrollment of the user's payment account, rewards account, and/or like in the user's virtual wallet. In some embodiments, the Bill Pay may then make a request to retrieve an image for the card and/or payment account being added to the virtual wallet 2109. In some embodiments, the card image may be a default image. The wallet server may store the card images locally, in a cache, or retrieve the card images via a web service such as XML-RPC, SOAP, and/or the like. In some embodiments, the image retrieval request 202109 may be in the form of an HTTP(S) message including XML-formatted data containing fields substantially similar to the following:

| Element | | Field | Element | |
|---|---|---|---|---|
| Name | Description | Size | Type | Business Rule |
| Account Number | PAN Number of the | 19 | Alpha Numeric | For Manual scenario PAN |
| | Cardholder | | | entered by the user |

In other embodiments, the image retrieval request 202109 may be substantially in the form of an HTTP(S) message including XML-formatted data, as provided below:

```
Host: www.accountcardimageserver.com
Content-Type: Application/XML
Content-Length: 667
<?XML version = ″1.0″ encoding = ″UTF-8″ ?>
<retrieve_image_request>
  <timestamp>2020-02-22 15:22:43</timestamp>
  <account_number>1234123412341234</account_number>
  <user_identifier>987654874</user_identifier>
  <image_resolution_desired>400x200</image_resolution_desired>
  <image_formats_desired>
    <type preference=1>JPG</type>
    <type preference=2>PNG</type>
    <type preference=3>HTML</type>
  </image_formats_desired>
  <image_formats_accepted>
    <type>JPG</type>
    <type>PNG</type>
    <type>HTML</type>
    <type>GIF</type>
  </image_formats_accepted>
</retrieve_image_request>
```

In some embodiments, the card image server may then query a data store for an image of the card. An example PHP/SQL listing for querying a database for a card image is provided below:

<?PHP
header ( ′Content-Type: text/plain′ );
mysql_connect (″254.93.179.112″ , $DBserver, $password);
// access database server
mysql_select_db (″CARDIMAGES.SQL″);
// select database table to search
//create query for token arbitrators
$query = ″SELECT card_id, file_ location, file_format FROM
CardTemplate WHERE
card_type LIKE ′%′ $usercardtype″ ;
$result = mysql_query ($query); // perform the search query
mysql_close (″ARBITRATORS.SQL″); // close database access
?>

The card may be a card virtually identical to the card the consumer is enrolling, or the card may be of a similar kind but of a more generic type (e.g., “green card,” “gold card,” “loyalty card,” and/or the like). The data store may have multiple versions of the card available in various size/pixel resolutions and/or image formats. In some embodiments, the card image most closely matching the user's request may be returned to the user. In other embodiments, all card images meeting any of the criteria may be returned. In still other embodiments, the card image server may create an image “on the fly” in real-time using a dynamic image creation tool and/or a template tool such as ImageMagik, Gimp, Photoshop droplets, and/or the like. In one embodiment of the invention, the card template image retrieved from 202419i may be overlayed with a logo, photo of the user, or other similar data using Bash ImageMagik UNIX instructions substantially similar to:

# !/bin/bash
composite -compose atop -geometry -13-17 card_ overlay.png card_template.png
card_output.png

The card image server may then return a data package containing descriptive information about the images returned, user data, account data, actual image data, and/or the like. In some embodiments, the image retrieval response 202109a may be substantially in the form of an HTTP(S) message including XML-formatted data containing fields substantially similar to the following:

| Element | | Field | Element | |
|---|---|---|---|---|
| Name | Description | Size | Type | Business Rule |
| BID | Business ID of the | 8 | Alpha Numeric | Identification of the bank |
| | Issuer | | | |
| CID | Customer ID of the | 19 | Numeric | The CID |
| | Cardholder | | | The Customer ID is a unique identifier for the user for the |
| | | | | given issuer. This field is used to link the accounts (PANs) for |
| | | | | a given user for the BID |
| Account Number | PAN Number of the | 19 | Numeric | |
| | Cardholder | | | |
| Card Image File | | 50 | Alpha Numeric | |
| Name | | | | |
| Reason code | | | | |

In still other embodiments, the image retrieval response 202109a may be substantially in the form of an HTTP(S) message including XML-formatted data, as provided below:

```
Host: www.accountcardimageserver.com
Content-Type: Application/XML
Content-Length: 667
<?XML version = ″1.0″ encoding = ″UTF-8″?>
<retrieve_image_response>
  <timestamp>2020-02-22 15:22:43</timestamp>
  <accountnumber>1234123412341234</account_number>
  <image_format>JFG</image_format>
  <image_generatedtype>on-the-fly-generated</image_generated_type>
  <image_binary_data>
    SDFRDTCXREERXFDGXFDXRESRXREX...TREEE#W#E
    JIJGYTFTRCCBBJHGFEER\hat{ }&&\hat{ }YHGJNJKOIBJJVH
    NMJNKJYT%TYFVVYTYVVBGUGUYGUYERSESWCGVU
    VDRTGCDSERFDCVUE$RDTYYYYGVTYFTDGUHIUNI
  </image_binary_data>
  <image_url>http://imageserver.com/abc/image.jpg</image_url>
  <cache_available_until>2030-02-22 15:22:43</cache_available_until>
</retrieve_image_response>
```

In some embodiments, the image response may contain a cache control indication. The image server may indicate that it may cache the image for use by the wallet server, user, and/or like until a certain date or time. Alternatively, the cache date may be set to a date in the past, which indicates that the image may not be cached. By using a cached version of the image, the card image server may advantageously be able to provide individually customized versions of the card images for card image requesters without having to frequently re-generate customized card images (e.g. images containing a logo, or the user's name and/or photo) frequently. After the card image has been retrieved, the user may click a “Save” button to enroll the card in the wallet. In other embodiments, no card image is retrieved. In still other embodiments, the payment account is automatically added to the wallet. Additional logging and/or data storage may take place on the wallet server and/or data may be stored in a staging table 202111, such as delayed processing of card enrollment requests during heavy periods of load. In some embodiments, the enrolled payment account and/or wallet enrollment data may be stored in a staging table for later processing 202111a. In some embodiments, the data stored in the staging table 202111a may be substantially similar to the following:

| Element | | Field | Element | |
|---|---|---|---|---|
| Name | Description | Size | Type | Business Rule |
| BID | Business ID of the | 8 | Alpha Numeric | |
| | Issuer | | | |
| CID | Customer ID of the | 19 | Numeric | |
| | Cardholder | | | |
| Account Number | PAN Number of the | 19 | Alpha Numeric | |
| | Cardholder | | | |
| Replaced Account | | 19 | Alpha Numeric | Old Account Number |
| Number | | | | |
| URI | | | | /vManage/v1/account/{GUID}/paymentInstruments/ |
| | | | | {paymentInstrumentID} |
| Name Prefix | | 5 | Alpha Numeric | |
| First Name | Cardholder first | 15 | Alpha Numeric | |
| | name | | | |
| Middle Initial | Cardholder | 1 | Alpha Numeric | |
| | middle name | | | |
| | initials | | | |
| Last Name | Cardholder last | 25 | Alpha Numeric | |
| | name | | | |
| Name Suffix | Cardholder suffix | 5 | Alpha Numeric | |
| Company Name | | 40 | Alpha Numeric | Company name if the account is help by a company |
| | | | | instead if an individual |
| Country Code | | 3 | Alpha Numeric | Country of Residence of the cardholder |
| | | | | Numeric Country code |
| | | | | ISO Numeric Currency Code |
| | | | | USA: 840 |
| | | | | Canada: 124 |
| Language Code | Cardholder | 8 | Alpha Numeric | Cardholder language as set with the issuer |
| | language as set | | | |
| | with the issuer | | | |
| Primary E-Mail | | 50 | Alpha Numeric | Cardholder primary email address, this field may be |
| Address | | | | used as the user ID in the wallet |
| Primary E-Mail | | 1 | Alpha Numeric | This field indicates whether this email address has |
| Address Verification | | | | been verified as a valid email address for the |
| | | | | cardholder |
| Secondary E-Mail | | 50 | Alpha Numeric | Cardholder alternate or secondary email address |
| Address | | | | |
| Secondary E-Mail | | 1 | Alpha Numeric | This field indicates whether this email address has |
| Address Verification | | | | been verified as a valid email address for the |
| | | | | cardholder |
| Home Phone | | 3 | UN | Country Code prefix |
| Number Country | | | | USA: 001 |
| Code | | | | Canada: 001 |
| Home Phone Number | | 10 | Alpha Numeric | |
| Primary Mobile | | 3 | UN | Country Code prefix |
| Phone Number | | | | USA: 001 |
| County Code | | | | Canada: 001 |
| Primary Mobile | | 10 | UN | |
| Number | | | | |
| Primary Mobile | | 1 | Alpha Numeric | This field indicates whether this mobile number has |
| Number Verification | | | | been verified as a valid mobile number for the |
| | | | | cardholder |
| Alternate Mobile | | 3 | UN | Country Code prefix |
| Phone Number | | | | USA: 001 |
| Country Code | | | | Canada: 001 |
| Alternate Mobile | | 10 | UN | |
| Number | | | | |
| Alternate Mobile | | 1 | Alpha Numeric | This field indicates whether this mobile number has |
| Number Verification | | | | been verified as a valid mobile number for the |
| | | | | cardholder |
| Work Phone | | 3 | UN | Country Code prefix |
| Number Country | | | | USA: 001 |
| Code | | | | Canada: 001 |
| Work Phone Number | | 10 | UN | |
| Work Phone | | 10 | UN | |
| Number Extension | | | | |
| Fax Number | | 3 | UN | Country Code prefix |
| Country Code | | | | USA: 001 |
| | | | | Canada: 001 |
| Fax Number | | 10 | UN | |
| Card Brand | | 4 | Alpha Numeric | Example of the card brand: |
| | | | | Visa |
| Product Identifier | | 2 | Alpha Numeric | |
| Company Name | | 40 | Alpha Numeric | |
| Name on the Card | | 26 | Alpha Numeric | |
| Phone Number on | | 10 | UN | |
| back of the card | | | | |
| Billing Cycle Start | | 8 | UN | Account Billing Cycle start date, used for spend |
| Date | | | | accumulations and reminders |
| Street Number | | 10 | AN | Billing Address street number |
| Address Line 2 | | 40 | AN | |
| Street Name | | 40 | AN | Billing Address street name |
| Unit Number | | 10 | AN | |
| PO Box Number | | 10 | AN | |
| City | | 30 | AN | Billing Address City |
| State | | 2 | AN | Billing Address state |
| | | | | For US |
| Province | | 10 | AN | Billing Address province |
| | | | | For Canada |
| ZIP | | 10 | UN | Billing Address zip code |
| | | | | For United States and Canada |
| Country | | 3 | AN | Billing Address country |
| Product type | | 10 | AN | The product type as provided on the card |
| | | | | Credit |
| | | | | Debit |
| | | | | Prepaid |
| Card Image Name | | 50 | Alpha Numeric | |
| Enroled Indicator | | 1 | Alpha Numeric | |
| Card Added Method | | 25 | Alpha Numeric | Federated |
| | | | | Manual |

The pre-provisioned data record may then be updated with the new wallet UUID 202111C. In some embodiments, the record may be marked with an indication of enrollment method (such as “manual”) and additional data may be associated with the record such as an auto-update flag used in reference transactions, an account level identifier for associating child accounts with a parent account, acceptance of a terms and conditions, and/or a hashed card art image name 202111b. In some embodiments, the user may receive an indication that they have completed the payment account enrollment in the virtual wallet 202112, creation of the wallet account, and/or the like.

FIG. 2022a is an example wallet account enrollment optionally using prefill data from a payment account issuer. In some embodiments, the consumer is logged into an issuer's web site 202201. The consumer may click a button indicating that they wish to enroll payment accounts associated with the issuer in a virtual wallet 202201a. The consumer may indicate that they wish to enroll some or all of their payment accounts with the issuer in a virtual wallet service 202201a. As such, the user may be asked to give their consent to their account information being transferred from the issuer to a virtual wallet provider 202202. The user may accept the message 202202a. In some embodiments, the issuer may then transfer the prefill and/or pre-provision data for all of the cards associated with a consumer user via a SAML assertion or other transfer mechanism 202203, which may be achieved using a data structure for each account similar to the above discussed pre-provisioned data response 202107. In some embodiments, payment account data may by stored by the wallet server 202203a. In other embodiments, the consumer may select which accounts information they desire to be transferred to the virtual wallet provider. In some embodiments, the consumer may then be transferred to the virtual wallet provider's web site 202203. A log-in page is then shown to the consumer 202204 to enable the consumer to log into their virtual wallet account. In some embodiments, the consumer may be automatically logged into their virtual wallet. In some embodiments, the consumer may log into their existing wallet using an email address and password and/or other similar means 202204b. A consumer may then indicate that they wish to enroll a card in a virtual wallet, such as by clicking an “Add Card” button 202204a, 202204C. The Bill Pay may request that the user consent to retrieve card prefill data from an issuer 202204d. In other embodiments, the consumer may be presented with a list of the payment accounts transferred from the issuer and/or images of the card accounts transferred and select which accounts to link to their virtual wallet. In some embodiments, the consumer may type the number of the account that they wish to add to their virtual wallet 202205. The Bill Pay may then verify that the account number is associated with one of the accounts with data transferred from the issuer as pre-fill and/or pre-provision data 202206. In some embodiments, the system may then pre-populate appropriate data in the enrollment form and request that the user indicate if they would like automatic updating of data after enrolled 202207. Examples of automatic updating (references) can include account number (e.g. PAN) and/or expiration dates 202207. In some embodiments, the Bill Pay may then advantageously pre-populate the pre-provision and/or pre-fill data into input boxes for the user to enroll their payment account. The user may then enroll their card in the virtual wallet by clicking a “Save” button 202208. In other embodiments, the payment account is automatically added to the virtual wallet without user interaction. The Bill Pay may perform address validation or verification 202208a prior to attaching the card to a virtual wallet. In some embodiments, the Bill Pay may then associate the added payment account(s) to the user's pre-existing virtual wallet 202209. In other embodiments, a new virtual wallet may be created. The Bill Pay may additionally create an entry in a staging table 202210, using means substantially similar to 202111, 202111a and/or 202111b. The prefilled/preprovisioned data may be inserted into the staging table with an enrolled designation 202210a. Later, records may be pulled from the staging table by an automated process and/or similar means, processed, and pushed to a common services platform 202210b. A record may be stored by the wallet server or otherwise indicating that the consumer was enrolled in a wallet account or payment accounts were enrolled via a federated bank website 202210C. Additionally, data about additional cards may be stored for analytics purposes or other purposes 202210d. The consumer may be presented with a confirmation of successful enrollment after the payment account and/or wallet service has been enrolled and/or the staging table entry has been made 202211 (see FIG. 2012a for an example card account success enrollment interface).

FIG. 2022b is a block diagram showing an exemplary process of enrolling card accounts in a wallet account. In some embodiments, the user 202212 may request an issuer page, website, or application 202213 via their electronic device 202225. The device may send an issuer page request 202214 to the issuer's server 202215, which may return the issuer's page, website, and/or application 202216 to the electronic device (see FIGS. 2024b and 24g).

In some embodiments, the user may provide card account selections to add to the wallet 202219 to the electronic device (see FIGS. 2024e and 24h-i). The electronic device may send said selections to the issuer server via a request card account info push to a wallet message 202220. In some implementations, the XML-encoded push to wallet message 202220 may take a form similar to the following:

```
POST /pushtowalletrequest.php HTTP/1.1
Host: www.merchant.com
Content-Type: Application/XML
Content-Length: 667
<?XML version = ″1.0″ encoding = ″UTF-8″?>
<push_request>
  <timestamp>2013-02-22 15:22:43</timestamp>
  <auth_params>
  <digital_cert>http://cert_request_server.com/cert_request_1236789.
cert</digital_cert>
  </auth_params>
  <wallet_params>
    <wallet_name>Wallet Wallet</wallet_name>
    <wallet_address>http://v.me/</wallet_address>
    <wallet_type>online</wallet_type>
  </wallet_params>
  <wallet_auth_params>
    <wallet_auth_username>myusername</wallet_auth_username>
    <wallet_auth_password>mypassword</wallet_auth_password>
    <wallet_auth_ID>098382093YUI</wallet_auth_ID>
  </wallet_auth_params>
  <user_details>
    <user_name>JDoe@gmail.com</user_name>
    <password>Tomcat123</password>
    <user_ID>12348901</user_ID>
  </user_details>
  <card_details>
    <card_number>1111222233334444</card_number>
    <card_security>123</card_security>
    <card_ID>135792</card_ID>
    <card_address>789 Main Street, AnyCity, AnyState
12345</card_address>
    <card_expire>2025-01-01</card_expire>
  </card_details>
  <card_details>
    <card_number>9999888877776666</card_number>
    <card_security>456</card_security>
    <card_ID>246801</card_ID>
    <card_address>222 Example Street, AnyCity, AnyState
55555</card_address>
    <card_expire>2025-05-10</card_expire>
  </card_details>
</push_request>
```

In some embodiments, the message may contain card selection information, user account information for the issuer, user account information for the wallet service, and/or the like. The issuer server may then push the selection information via a new card account add request 202223 to the wallet server 202217. In some implementations, the XML-encoded request 202223 may take a form similar to the following:

```
POST /newcardrequest.php HTTP/1.1
Host: www.merchant.com
Content-Type: Application/XML
Content-Length: 667
<?XML version = ″1.0″ encoding =″UTF-8″?>
<new_card_request>
  <timestamp>2013-02-22 15:22:43</timestamp>
  <auth_params>
    <passcode>my_password</passcode>
  </auth_params>
  <user_details>
    <user_name>JDoe@gmail.com</account_name>
    <password>Tomcat123</password>
    <user_ID>12348901</user_ID>
  </user_details>
  <card_details>
    <card_number>1111222233334444</card_number>
    <card_security>123</card_security>
    <card_ID>135792</card_ID>
    <card_address>789 Main Street, AnyCity, AnyState
12345</card_address>
    <card_expire>2025-01-01</card_expire>
  </card_details>
  <card_details>
    <card_number>9999888877776666</card_number>
    <card_security>456</card_security>
    <card_ID>246801</card_ID>
    <card_address>222 Example Street, AnyCity, AnyState
55555</card_address>
    <card_expire>2025-05-10</card_expire>
  </card_details>
</new_card_request>
```

The wallet server may then use any information received from the issuer server to modify the user's wallet account via a MySQL database command similar to the following:

INSERT INTO user_cards (number,
security_code, ID, address, expire)VALUES
(card_number, card_security, card_ID,
card_address, card_expire);

In some implementations, the electronic device may instead send the user selections to the wallet server via a request for a pull for card account information from the issuer 202221 that is sent by a wallet overlay 202218 (see FIG. 2024c-d). In some implementations, the XML-encoded pull request 202221 may resemble the following:

```
POST /pullrequest.php HTTP/1.1
Host: www.merchant.com
Content-Type: Application/XML
Content-Length: 667
<?XML version = ″1.0″ encoding = ″UTF-8″?>
<pull_request>
  <timestamp>2013-02-22 15:22:43</timestamp>
  <auth_params>
    <auth_code>123ABC098</auth_code>
  </auth_params>
  <issuer_params>
    <issuer_name>Bank of America</issuer_name>
    <issuer_type>bank</issuer_type>
    <issuer_address>http://bankofamerica.com/accts</issuer_address>
  </issuer_params>
  <issuer_auth_params>
    <issuer_auth_username>my_username1</issuer_auth_username>
    <issuer_auth_password>my_password1</issuer_auth_password>
    <issuer_auth_ID>12678HJK</issuer_auth_ID>
  </issuer_auth_params>
  <user_details>
    <user_name>JDoe@gmail.com</user_name>
    <password>Tomcat123</password>
    <user_ID>12348901</user_ID>
  </user_details>
  <card_details>
    <card_number>1111222233334444</card_number>
  </card_details>
  <card_details>
    <card_number>9999888877776666</card_number>
  </card_details>
</pull_request>
```

The wallet server may use any identifying information (such as the user's account number with the issuer, the user's card number(s), and/or the like) provided in the request for card account information to create a new request 202222 to the issuer server. The wallet server may request any information necessary to link the card account to the wallet service, including permission from the issuer, more information about the card account not provided by the user (e.g., a card account ID, and/or the like). The issuer server may, after receiving such a request, send a new card account add request 202223 which may include all information requested by the wallet server.

FIG. 2023a is an exemplary virtual wallet and card enrollment logic and data flow. In some embodiments, the user accesses a wallet URL using a mobile device 202303. In other embodiments, the wallet URL is accessed from the user's computer, the user's issuer web site, and/or the like. In some embodiments, the wallet may be accessed either via a wallet-implemented JavaScript overlay, via the issuer's site directly, and/or the like. If the wallet is accessed via the overlay, the wallet may pull card account information from the issuer. If the wallet is accessed via the issuer's website, the wallet may push the card account data to the wallet server. If the user is already logged into their wallet account 202304, as indicated in one embodiment by a cookie on the user's computer, the user is directed to a wallet display including an “Add Card” button 202314. If the user is not logged into a virtual wallet account, the Bill Pay may then prompt the user to indicate if they already have a virtual wallet account 202305 and if so, prompt the user to log into their account 202313. In some embodiments, the consumer may be asked to consent to the retrieval of pre-fill data from a payment account issuer 202306. If the user does not consent, they may be directed to a wallet enrollment form with no pre-fill data pre-populated. Should the user consent to the issuer sharing pre-fill data, the wallet server 202301 may transmit a request to the issuer for data 202307 and the issuer server may receive 202308 and process the request. If the user account and/or pre-fill data is found by the issuer 202309, the data may be transmitted to the wallet server 202310 for use in pre-filling/pre-populating fields in the wallet enrollment form 202311. If no pre-fill data is found by the issuer, the user is directed to the wallet enrollment form 202311. In some embodiments, the issuer is a bank. In other embodiments, the issuer is a rewards account provider. In still other embodiments, the issuer is a non-financial company and/or an individual (as in peer-to-peer enrollment). The consumer may then complete any data required by the wallet enrollment form 202311. In some embodiments, the pre-fill data is filled into the enrollment form for the user. Example data is user name, user billing address, user account identifier, mother's maiden name, security question and answer, and/or the like. In other embodiments, some fields of the enrollment form 202311 may be hidden if pre-fill data is available for those fields. Upon completion of the enrollment form, the user is enrolled into the wallet 202312 and logged into the wallet with an option to add accounts 202314. The logic and data flow continues in FIG. 2023b.

FIG. 2023b is a continuation of an exemplary virtual wallet and card enrollment logic and data flow. In some embodiments, the user clicks a button to “Add Card” to their wallet. In other embodiments, no user interaction is required. A user may then be prompted to enter their card number, account number, PAN number, and/or similar 202316. In some embodiments, a user may be asked to consent to the retrieval of the account information from an account issuer 202317. In other embodiments, this user consent may be assumed. If the user does not consent to the retrieval of account information from the issuer 202317, then the user may be prompted to input additional information about the payment account to facilitate enrollment of the account in the wallet 202320. If the user does consent to the retrieval of card information from the issuer 202317, account data such as billing address, user name, credit history, and/or the like is retrieved from the issuer 202318 and processed by the wallet server 202319. In some embodiments, the Bill Pay may generate a request for a card image 202321. The request may be sent to a card image server 202329. If the card image is available 202322, the card image server 202329 may designate a template image for the card 202324. Alternatively, if no image us available a default template image may be used 202323. In some embodiments, the card image server may create an “on the fly” image to represent the card and overlay that image with appropriate consumer specific data such as name, photo, and/or the like 202323a. In some embodiments, confidential data such as PAN number, account number and/or the like may be obscured from the overlaid data using a tool such as ImageMagik. In doing so, the card image server may protect confidential consumer information. The image server may then create a card image response to send the card image data and/or card image(s) to the requesting service. In some embodiments, the card image response is substantially in the form described in 202109a. In some embodiments, the Bill Pay may then display a payment account and/or card enrollment form with the retrieved card image and any data retrieved from the account issuer pre-filled 202325. The consumer may then complete any remaining information required by the enrollment form and save the account in their virtual wallet 202326. In some embodiments, the Bill Pay may then register or associate the payment account with the consumer's virtual wallet 202327 and prompt the user that the account has been linked to their wallet 202328 (see FIG. 2012a for an example card account success enrollment interface).

FIGS. 2024a-j illustrate alternate embodiments of wallet and card enrollment via the Bill Pay. In some embodiments, the wallet and card enrollment may occur on a normal web interface, a mobile web interface, a voice-controlled interface, and/or other interfaces. FIG. 2024a illustrates alternate embodiments of linking 2401 a website for an issuer, merchant, and/or a like web service to the wallet service. FIGS. 2024b-d illustrate example embodiments of providing users a method of enrolling in a wallet program through an issuer's website. For example, in some embodiments, the user may access an introductory screen 202402 which may provide detail on the wallet service, and the user may be presented a number of options in enrolling in the wallet service 202403 (including an express enrollment or card addition option, a standard enrollment or card addition option, and/or the like). The user may then be presented with wallet-implemented overlays 202404 in which to enter wallet account information (either for a new or existing account), wallet-implemented overlays 202404 being alternative overlays to wallet overlay 202003. The user may use card selection overlays 202405 to choose cards to associate with the wallet account, and may confirm the selection. The overlays 202404 and 202405 may send all collected information directly to the wallet server.

FIGS. 2024e-f illustrate further alternate example embodiments of providing users a way of enrolling in the wallet program. For example, the user may, while exclusively using the issuer's website, enter card selections 202406 (alternatively, the user may do so similar to the embodiment provided in FIGS. 2020c-d). While remaining on the issuer's website, the user may also provide information for logging into, or signing up for, a wallet account 202407.

FIGS. 2024g-j illustrate further alternate example embodiments of the interface in FIGS. 2020b-d. In some embodiments, the wallet login and sign-up options 202015 and 202017 may resemble 202408 and 202409, respectively. The sign-up form for a wallet account may be included on the main page as shown at 202410. Similar to 202012, the user may be presented with a set of available cards 202411 which may be selectable for a wallet account. The user may also be able to specify which card to set as a default card for the wallet. In addition to the information collected in FIGS. 2020b-d, the issuer may request that the user provide a set of security questions and answers 202412, as well as security codes 202413. The issuer may provide the user with a confirmation screen 202414 once the process has been completed.

FIG. 2025 shows a block diagram illustrating example multi-directional service connections in some embodiments of the Bill Pay. In some embodiments, the Bill Pay 202501 enables seamless multi-directional connections and communications among multiple entities, including, but not limited to, consumers 202503, issuers 202505, merchants 202507, marketing partners 202509, loyalty partners 202511, shipping partners 202513, social network 202515, other wallet services 202517, and/or other third parties 202519. Entities on the left 202530 may connect to either entity on the right 202580 through the Bill Pay. In one implementation, for example, a consumer may request his bank issuer 202505 to update, through the Bill Pay, the newly issued credit card number with all merchants 202535 on the Bill Pay consumer profile.

FIGS. 2026A-26C show example user interfaces in some embodiments of the Bill Pay. In some embodiments, a consumer may log-in the Bill Pay account and access and/or edit the account information. The account information may include, such as, but not limited to: account profile 202601, address book 202603, payment methods 202605, shipping carriers 202607, loyalty programs 202609, preferences 202611, social network 202613, transaction history, browser cookies, offers, coupons, alerts, other wallet accounts, and/or the like. Account profile 202601 may include such as, but not limited to, user name, user email address, user log-in credentials, user log-in password, and/or the like. The address book may include more than one address, and the user may select an address to use as default shipping and/or billing addresses. The user may provide payment methods 202605 and choose default payment method to use for purchases. In some implementations, the user may request issuers to provide payment methods to the account through the Bill Pay. In some implementations, the balance 202621 of each payment method may display for user's convenience. The user, or the shipping carriers, or other entities, may provide user shipping accounts. Referring to FIG. 2026B, the user or loyalty program providers, or other entities, may provide user's loyalty accounts and respective balance on the loyalty accounts to the Bill Pay account. The user may also provide and/or edit user preferences. The user preferences 202611 may provide user's preferences on any products. It may be provided by the user, or other entities. It may be aggregated from user's prior purchases. For example, when user orders food through a merchant website and noted that user is allergic to peanuts and wishes no peanuts should be contained in any food orders from the user. The Bill Pay may store this food preference into the user's account. When the user makes food orders through this or other merchant, the no-peanuts user preference may be pre-populated to the orders so that the user may not need to enter this again. Other user preferences such as clothes sizes, color, and/or the like may be added. The user or other entities may provide his social network account to the Bill Pay and provide controls as to the share privileges 202613. FIG. 2026C shows an example user interface illustrating Bill Pay pre-populating shirt size during purchase to provide seamless user experience in some embodiment of the Bill Pay.

FIG. 2027 shows a data flow diagram illustrating example multi-directional connections in some embodiments of the Bill Pay. As discussed in FIG. 2025, source entities, target entities, and requestor entities may include entities such as, but not limited to: consumers, issuers, merchants, marketing partners, loyalty partners, shipping partners, social network, other wallet services, and/or other third parties. In some embodiments, the Source Entity Server 202703 may first determine which entities need to be involved in fulfilling the connection, and generate a source action-connect request message 202760. In one embodiment, some entities may give the Bill Pay server a general inquiry regarding a consumer's account and inquire if it needs any updates. The Bill Pay server may access the source entity server information about the account and compare the information with the accounts stemming from the consumer's account and see if the source entity needs any updates. If so, the Bill Pay server may generate an action-connect request 202723 on behalf of the source server. It may provide this action-connect request message allowing the source entity to effect this message. Alternatively, in one embodiment, the Bill Pay server may itself generate this message and send iton behalf of the source entity to the target entity. For example, if it is determined an address at the merchant is a newer address because the modification date for the address field is newer than that stored in the source entity server, the Bill Pay may generate an update action for the address information type by populating the source entity and the target entity information into an action-connect request message (e.g., the source entity being the entity having the newer date address information, and the target entity being the entity having the older date address information). For example, an example PHP/SQL command listing, illustrating substantive aspects of querying the Bank of America database for modification date of default address, is provided below:

<?PHP
header(′Content-Type: text/plain′);
mysql_connect(″254.93.179.112″,$DBserver,$password);
// access database server
mysql_select_db(″BoACustomerProfile.SQL″);
// select database table to search
//create query for BoACustomerprofile data
$query = ″SELECT modification_date FROM
BoACustomerProfileTable WHERE
customer_ID LIKE ′%′ $123abc″ default_address LIKE ′%′ $address″;
$result = mysql_query($query); // perform the search query
mysql_close(″BoACustomerProfile.SQL″); // close database access
?>

An example PHP/SQL command listing, illustrating substantive aspects of querying the Amazon database for modification date of address, is provided below:

<?PHP
header(′Content-Type: text/plain′);
mysql_connect(″254.93.179.112″,$DBserver,$password);
// access database server
mysql_select_db(″AmazonCustomerProfile.SQL″);
// select database table to
search
//create query for AmazonCustomerProfile data
$query = ″SELECT modification_date FROM
AmazonCustomerProfileTable WHERE
customer_ID LIKE ′%′ $123abc″ default_address LIKE ′%′ $address″;
$result = mysql_query($query); // perform the search query
mysql_close(″AmazonCustomerProfile.SQL″); // close database access
?>

First, the Bill Pay may load an action template from an action template table of the Bill Pay database. An example of the action template is provided as follows:

```
POST /updateaddress.php HTTP/1.1
Host: www. BILL PAY .com
Content-Type: Application/XML
Content-Length: 667
<?XML version = ″1.0″ encoding = ″UTF-8″?>
<security_template_level>subclass:abc 3.5
</security_template_level>
<wallet_customer_ID>xyz123</wallet_customer_ID
<requestor>
  <context>
    <role1>source
      <entity1> </entity1>
      <info_type></info_type>
      <action></action>
    </role1>
    <role2>target
      <entity2> </entity2>
      <info_type></info_type>
      <action> </action>
    </role2>
  </context>
</requestor>
```

When the return values are newer for BoA, the Bill Pay may determine (e.g., as a role) that any newer modified entity is a source for that information type. As such, it will pre-populate a request as follows:

```
POST /updateaddress.php HTTP/1.1
Host: www. BILL PAY .com
Content-Type: Application/XML
Content-Length: 667
<?XML version = ″1.0″ encoding = ″UTF-8″?>
<security_template_level>subclass:abc 3.5
</security_template_level>
<wallet_customer_ID>xyz123</wallet_customer_ID
<requestor>BoA
  <context>mobile
    <role1>source
      <entity1>BoA</entity1>
        <BOA_ID>abc123</BOA_ID>
        <BOA_account_number>PAN 5678 1234
9012</BOA_account_number>
      <info_type>Address</info_type>
        <current_default_address>123 peace st., New York,
NY 10001</current_default_address>
      <action>update:BoA_address value$</action>
    </role1>
    <role2>target
      <entity2> </entity2>
      <info_type> </info_type>
      <action> </action>
    </role2>
  </context>
</requestor>
```

Then the Bill Pay may determine which fields require updates at target and pre-populate the request info as follows:

```
POST /updateaddress.php HTTP/1.1
Host: www. BILL PAY .com
Content-Type: Application/XML
Content-Length: 667
<?XML version = ″1.0″ encoding = ″UTF-8″?>
<security_template_level>subclass:abc 3.5</security_template_level>
<wallet_customer_ID>xyz123</wallet_customer_ID
<requestor>BoA
  <context>mobile
    <role1>source
      <entity1>BoA</entity1>
        <BOA_ID>abc123</BOA_ID>
        <BOA_account_number>PAN 5678 1234
9012</BOA_account_number>
      <info_type>Address</info_type>
        <current_default_address>123 peace st., New York,
NY 10001</current_default_address>
      <action>update:address value$</action>
    </role1>
    <role2>target
      <entity2>Amazon</entity2>
        <Amazon_ID>joesmith@gmail.com</AmazonID>
        <Amazon_password>jkwe%d134</Amazon_password>
      <info_type>Address</info_type>
#Current address on file prior to updadte: 567 Fashion Avenue,
Charlotte, NC 270001#
      <action>update:address value$</action>
#Address now updated to: 123 peace st., New York, NY 10001#
    </role2>
  </context>
</requestor>
```

In some embodiments, the Source Entity Server 202703 may send a source action-connect request message 202723 (e.g., see examples below associated with messages 2022735 and 202721) to the Bill Pay Server 202705. The source action-connect request message is constructed based on the determined entities, role and context. Then the Bill Pay Server may check the user access privileges and determine if the requested action is permitted for the connection type and context. Following that the Bill Pay Server may query for user record 202727 from the Bill Pay Database 202703. For example, the database may be a relational database responsive to Structured Query Language (“SQL”) commands. The Bill Pay server may execute a hypertext preprocessor (“PHP”) script including SQL commands to query the database for details of the user record. For example, if an address needs to be updated between entities (as discussed below in example message 202721), an example PHP/SQL command listing, illustrating substantive aspects of querying the Bill Pay database 202727, is provided below:

<?PHP
header(′Content-Type: text/plain′);
mysql_connect(″254.93.179.112″,$DBserver,$password);
// access database server
mysql_select_db(″CustomerProfile.SQL″);
// select database table to search
//create query for Customerprofile data
$query = ″SELECT Address_book FROM
CustomerProfileTable WHERE customer_ID LIKE
′%′ $123abc″;
//other info type may be put here depending on the context
$result = mysql_query($query); // perform the search query
mysql_close(″CustomerProfile.SQL″); // close database access
?>

Then the Bill Pay Database may reply with the user record 202729. After receiving the user record the Bill Pay Server may perform action-connect 202731. Then the W-CONNECTOR Server may store the changes after the action 202733. For example, the Bill Pay server may issue PHP/SQL commands similar to the example listing below to store the changes after action data 202733 in a database:

<?PHP
header(′Content-Type: text/plain′);
mysql_connect(″254.92.185.103″,$DEserver,$password);
// access database server
mysql_select(″CustomerProfile.SQL″);
// select database to append
mysql_query(″INSERT INTO CustomerProfileTable
(timestamp Address_book)
VALUES (time( ),$Address_book″);
// add data to table in database
mysql_close(″CustomerProfile.SQL″);
// close connection to database
?>
//other info type may be put here depending on the context

After that the Bill Pay Server may send a Bill Pay action-connect request 202735 (e.g., see examples below associated with messages 202721) to the Target Entity Server 202707. When the Bill Pay action-connect request is received, the Target Entity Server may query for user record 202737 from Target Entity Database 202713. An example command listing, illustrating querying the Target Entity Database 202737 may be at least the same form as 202727. Then the Target Entity Database may return the user record 202739. After that the Target Entity Server may perform the action-connect 202741. Following that the Target Entity Server may store the changes after the action-connect 202743 to the Target Entity Database. Then the Target Entity Server may send an action-connect completed message with the target entity 202745 to the Bill Pay Server. After receiving the action-connect completed message the Bill Pay Server may store the message 202747 in the Bill Pay Database. Following that the Bill Pay Server may send an action-connect completed message 202749 to the Source Entity Server. An example action-connect completed message substantially in the form of a HTTP(S) POST message including XML-formatted data, 202749, is provided below:

```
POST /actioncomplete.php HTTP/1.1
Host: www. BILL PAY .com
Content-Type: Application/XML
Content-Length: 667
<?XML version = ″1.0″ encoding = ″UTF-8″?>
<wallet_customer_ID>xyz123</wallet_customer_ID
<action_request>
  <requestor>BoA</requestor>
  <source>BoA</source>
  <target>Amazon</target>
  <action>update: address value$</action>
<action_request>
<action_acknowledgment>
  <timestamp>2006-01-12 12:00</timestamp>
  <current_default_address>123 peace st., New York, NY
10001</current_default_address>
  <updated_entities>Amazon</updated_entities>
</action_acknowledgment>
```

Finally the Source Entity Server may store the action-connect completed message 202751 to the Source Entity Database 202711. Alternatively, the Requestor Entity 202701 may send a requestor action-connect request 202721 to the Bill Pay Server. An example action-connect request (e.g., issuer Bank of America (“BoA”) requests the issuer Bank of America to update default address with merchant Amazon), substantially in the form of a HTTP(S) POST message including XML-formatted data, (e.g., 202723, 202721, 202735), is provided below:

```
POST /updateaddress.php HTTP/1.1
Host: www. BILL PAY .com
Content-Type: Application/XML
Content-Length: 667
<?XML version = ″1.0″ encoding = ″UTF-8″?>
<security_template_level>subclass:abc 3.5</security_template_level>
<wallet_customer_ID>xyz123</wallet_customer_ID
<reguestor>BoA
  <context>mobile
    <role1>source
      <entity1>BoA</entity1>
        <BOA_ID>abc123</BOA_ID>
        <BOA_account_number>PAN 5678 1234
9012</BOA_account_number>
      <info_type>Address</info_type>
        <current_default_address>123 peace st., New York,
NY 10001</current_default_address>
      <action>update:BoA_address_value$</action>
    </role1>
    <role2>target
      <entity2>Amazon</entity2>
        <Amazon_ID>joesmith@gmail.com</Amazon_ID>
        <Amazon_password>jkwe%d134</Amazon_password>
      <info_type>Address</info_type>
//Current address on file prior to updadte: 567 Fashion Avenue, Charlotte, NC
//270001
      <action>update:BoA_address value$</action>
//Address now updated to: 123 peace st., New York, NY 10001
    </role2>
  </context>
</requestor>
```

Another example action-connect request (e.g., payment network Visa requests the issuer Chase to update card new expiration date with merchant Best Buy), substantially in the form of a HTTP(S) POST message including XML-formatted data, (e.g., 202723, 202721, 202735), is provided below:

```
POST /updatecardexpirationdate.php HTTP/1.1
Host: www. BILL PAY .com
Content-Type: Application/XML
Content-Length: 667
<?XML version = ″1.0″ encoding = ″UTF-8″?>
<security_template_level>subclass:yua 1.3</security_template_level>
<wallet_customer_ID>xyz123</wallet_customer_ID
<requestor>payment_network:Visa
  <context>web
    <role1>source
      <entity1>Chase</entity1>
        <Chase_ID>ewal23</Chase_ID>
        <Chase_account_number>PAN 1234 9876
1098</Chase_account_number>
      <info_type>Chase_card_expiration_date</infotype>
      <action>read: Chase_card_expiration_date value$</action>
    </role1>
    <role2>target
      <entity2>Best Buy</entity2>
        <BestBuy_ID>joesmith@gmail.com</BestBuy_ID>
        <BestBuy_password>jkwe%d134</BestBuy_password>
      <info_type>Chase_card_expiration_date</info_type>
//Current Chase card expiration date on file prior to updadte: 10/2005
      <action>update: Chase_card expiration date
value$</action>
//Chase card expiration date now updated to: 10/2010
    </role2>
  </context>
</requestor>
```

Another example action-connect request (e.g., wallet provider Walletrequests the merchant Amazon to T-shirt size profile with V.me), substantially in the form of a HTTP(S) POST message including XML-formatted data, (e.g., 202723, 202721, 202735), is provided below:

```
POST /updateTshirtsize.php HTTP/1.1
Host: www. BILL PAY .com
Content-Type: Application/XML
Content-Length: 667
<?XML version = “1.0” encoding = “UTF-8”?>
<security_template_level>subclass:dfg 2.2</security_template_level>
<wallet_customer_ID>xyz123</wallet_customer_ID
<requestor>wallet_provider: V.me
  <context>mobile
    <role1>source
      <entity1>merchant:Amazon</entity1>
          <Amazon_ID>joesmith@gmail.com</Amazon_ID>
        <Amazon_password>jkwe%d134</Amazon_password>
      <info_type>Preferences: Tshirt_size</info_type>
      <action>read: Preferences: Tshirt_size value$</action>
    </role1>
    <role2>target
      <entity2>wallet_provider: V.me</entity2>
          <Vme_ID>joesmith@gmail.com</Vme_ID>
        <Vme_password>jkwe%d134</Vme_password>
      <info_type> Preferences: Tshirt_size</info_type>
//Currently no T-shirt size on file
      <action>update:tshirt size value$</action>
//T-shirt size now added: large#
    </role2>
  </context>
</requestor>
```

After the requestor action-request is completed, the Bill Pay Server may send a requestor action-connect acknowledgement message 202753 back to the Requestor Entity.

FIG. 2028 shows a logic flow diagram illustrating example multi-directional connections in some embodiments of the Bill Pay. First the Bill Pay Server may receive a source action-connect request message from a source entity server 202802. Then the Bill Pay Server may parse the action-connect request to determine entities and action (e.g., the source entity, target entity, information type, action, context, and so forth) 202803. After that the Bill Pay Server may query the Bill Pay database to retrieve access privileges for the determined entities and action 202805. Following that the Bill Pay Server may check the user access privileges to determine if the requested action is permitted for the connection type and context 202807. If the requested action is not permitted, then the Bill Pay Server may generate an “action not permitted” message and send to the source requestor 202811, and the processor may end. If the requested action is permitted, then the Bill Pay Server may check if any action on it is needed 202813. If an action is needed, then the Bill Pay Server may query the Bill Pay Database and retrieve the user record 202815. After that the Bill Pay Server may perform an action-connect 202817. Following that the Bill Pay Server may store the changes to the Bill Pay Database after the action 202819. Then the Bill Pay Server may send a Bill Pay action-connect request to the Target Entity Server 202821. After receiving the request the Target Entity Server may query the Target Entity Database and retrieve the user record 202823. Then the Target Entity Server may perform an action-connect 202825. Following that the Target Entity Server may store the changes to the Target Entity Database after the action-connect 202827. The Bill Pay Server may receive the action-connect completed message with target entity from the Target Entity Server 202829. After receiving the action-connect completed message the Bill Pay Server may store the action-connect completed messages to the Bill Pay Database 202831. Then the Bill Pay Server may send the action-connect completed message to the Source Entity Server 202833. Finally the Source Entity Server may store the action-connect completed message to the Source Entity Database. Alternatively the W-Connect Server may receive a requestor action-connect request message from a Requestor Entity Server 202801. After the requestor action-connect request is completed the Bill Pay Server may send a requestor action-connect completed message to the Requestor Entity Server 202835.

FIGS. 2029A-2029G show example access privileges in some embodiments of the Bill Pay. Referring to FIG. 2029A, in some embodiments, the user access privileges settings are n-dimensional including axes of settings. For example, one axis of settings may be role1 202901a, which may be sources. One axis may be role2, which may be targets 202902b. One axis may be entity 202901c, which may include general entities such as, but not limited to: issuers 202902C, merchants 202903c, consumers 202904c, payment network 202909c, wallet provider 202912C, and specific entities such as, but not limited, Bank of America 202905c, Chase 202906c, Amazon 202907c, Best Buy 202908c, Visa 202910c, Mastcard 202911c, Wallet2913c, google wallet 202914c, and/or the like. A list of general entities is discussed in FIG. 2025. Another axis of settings may be actions 202901d, which may include read 202902d, write 202903d, execute 202904d, and others. A list of action types 1S discussed in more details in FIG. 2029G. Yet another axis may be information type 202901e, which may include profile, address book, payment methods, and others. A list of information type is discussed in more details in 2029G. Another axis may be requestors 202901f, which may include any entities discussed above. Another axis may be context 202901g, which may include mobile, web, in person, decoupled transactions, 2-device transactions, near field communication, known merchant. All axes may be reconfigured in many different ways and still maintain its settings.

In some embodiments, a data structure may be generated for any cell in the n-dimensional array of settings, where each axis of array may be represented by these visual access handles (e.g., 202901a, 202901e, 202901f, 202901g, etc.). Alternatively, the axes dimensions may be represented by database tables, wherein any of the value fields in the database tables may be key fields that are joinable with other database tables.

Referring to FIGS. 2029B and 2029C, in some embodiments, an access privilege may be defined between a source entity 202901 and a target entity 202903. Access privileges may also be defined for an entity category, for example, issuers 202907, merchants 202913, consumers 202915, and/or the like, and it may also be defined for a specific entity, for example, issuers like Bank of America (BoA) 202909, Chase 202911, merchants like Amazon, BestBuy, consumers like owner, bond 1 (spouse of the owner), bond 202 (child 1 of the owner), shipping carriers like Fedex, UPS, and/or the like. In some embodiments, when the Bill Pay enables a connection between entities, the access privileges may be checked to determine what actions and information types are allowed for this connection. Detailed discussions of access privileges between a source and a target are shown in FIGS. 2029D-29F.

In some embodiments, access privileges may be different for different contexts of the connection. The connection may be requested via contexts including but not limited to, mobile 202921, web 202923, in-person 202925, decoupled transactions 202927, 2-device transactions 202929, near field communication (“NFC”) 202931, known merchant 202933, and/or the like. In some embodiments, decoupled transactions allow decoupling a digital wallet checkout experience from having to completed in the same domain or platform where it started. Decoupled transactions enable consumers to manage and authorize transactions through their own personal preferred channel (e.g., a personal device) regardless of the platform there were on initially. Two-device transactions may allow transactions to be authorized by two difference devices of the owners.

In some embodiments, a connection may be initiated by a source entity or a target entity to communicate between the source and the target through the Bill Pay. In other embodiments, a connection may be initiated by a requestor entity 202935 which requests communication between a source entity and a target entity through the Bill Pay. For example, an issuer may initiate a connection to a target entity to push a newly issued card information to the target entity. For another example, a consumer may initiate a connection and request a merchant, as a source entity, to update address with an issuer, as a target entity. Any entity in FIG. 2025 may be a requestor entity.

FIG. 2029D shows example access privileges when the requestor entity, source entity, and the target entity are issuers, and the transaction context takes place in a mobile environment 202937. Access privilege is shown for each action type 202947 and information type 202949. A list of example actions and information types is discussed in FIG. 2029G. Referring to FIG. 2029D, when connection is requested to be established by a first issuer between a second issuer and a third issuer in a mobile environment, for an example, profile may be viewed with tokenized 202949, while full view is not allowed 202953. Masked view is allowed and also locked 202951 so that this privilege type may not be changed. For another example, social network may be added 202955 based on conditions.

FIG. 2029E shows example access privileges when the requestor entity is an issuer, the source entity is an issuer, the target entity is Bank of America, and the transaction context takes place in a mobile environment 202957. As an issuer, Bank of America may include some access privileges that may be the same as FIG. 2029D, and some access privileges that may be unique. FIG. 2029F shows example access privileges when the requestor entity is an issuer, the source entity Bank of America, the target entity is merchant Amazon, and the transaction context takes place in a mobile environment.

FIG. 2029G shows a list of example actions and information types.

FIGS. 2030A-2030B show example user interfaces illustrating Bill Pay connecting wallet with issuers in some embodiments of the Bill Pay. In some embodiments, consumers have grown accustomed to expect seamless user experience and simplicity at the physical point of sale. Consumers using mobile banking applications on their mobile devices may be authenticated by their issuer using existing issuer credentials. Sensitive information are typically not entered and mainly viewed for enhanced security. Issuer mobile applications may be powered with the Bill Pay capabilities, which may provide the following features: 1) Consumer may be authenticated, provisioned and distributed by the issuer; 2) the features may be embedded within the issuer App; 3) powered by wallet SDK(s); 4) Enabling technologies and preferences selected by the issuer; 5) Issuer embeds the wallet SDK in their mobile app; 6) Issuer updates their existing installed mobile app base; 7) Issuer updates their T&Cs to include the usage of the app for Payment; 8) Issuer may automatically enable the SDK for all the user's cards or prompt the user to select the cards to be enabled with the SDK; 9) Issuer may elect to link other services to the wallet SDK payment; 10) Issuer provides a data feed of the provisioned users to wallet for tracking and analytics. In some embodiments, user experience At Physical Retail: 1) User shops at a Wallet participating merchant store; 2) When the user is ready to pay at the cashier or self checkout; 3) The user selects the bank mobile app he wants to use for this payment; 4) This implicitly implies that the user is electing to use this issuer card for completing this transaction; 5) User is authenticated to his bank using his bank mobile credentials based on the issuer authentication levels settings; 6) Upon successful user authentication, bank enables the Wallet SDK for the given card; 7) User presents his phone to the terminal to complete the payment using card NFC or card QR.

In some embodiments, an issuer mobile app contains only issuer cards (i.e., no competing cards). Payment network provides the issuer the Wallet SDK package and documentation. In some embodiments, issuers may integrate Wallet SDK in their own apps and can test against Payment certification process as usually done for the base Payment network products. In some embodiments, issuers have full view of the transactions and the consumers receive the service and the support directly from their issuers. No federation required in this phase, given it is and issuer provided service for the issuer cards and authenticated by the issuer. In some embodiments, Wallet can provide additional capabilities if requested by the issuer. In some embodiments, Wallet mobile reference app is available for issuers who do not have a mobile app or do not wish to integrate the Wallet SDK into their existing apps. In some embodiments, Wallet may benefit by taking advantage of the installed base of mobile banking. Issuers are vested deeply in promoting Wallet as it is a direct promotion of their own brand and services. Wallet can focus on solving the issues that would accelerate acceptance and differentiate Wallet and Payment network from the competition.

In some embodiments, for Consumers desiring to benefit of the Wallet capability for in-app payment and in e-commerce, the consumer may need: 1) to create a Wallet account, with Wallet credentials. The consumer can create the account directly with Wallet through the Wallet destination site or Wallet mobile app or Lightbox during shopping. The consumer is asked to chose the participating Wallet bank from which to link his information to wallet. 2) Link his information at his issuers to his wallet created account. The consumer is redirected to his issuer where he logs in and data provisioning to Wallet occurs. Some consumers may elect to create a Wallet account and manually enter their information even if their issuer is Participation. For non-participating banks, the consumer may enter the information manually in wallet. If a consumer has established a Wallet account and credentials, the consumer can log on to his Wallet account through his issuer online banking. The consumers logs on to his issuer online banking and clicks on wallet. The consumer is federated from their issuers to wallet. Wallet identifies validates the federation for the given issuer and for the given user. The consumer may see a Wallet view providing a specific issuer only information.

The consumers may not be able to see the cards and services not associated with this issuer. If the consumer elects to see the cards not belonging to this issuer, the consumer may log on to Wallet with the Wallet credentials. Wallet may have multiple SDK, certain SDKs may be for issuers, others may be for merchants and partners. In addition to the core payment functionality, the SDK package may include the ability the enroll, add payment instruments, authentication and credential management, device finger printing all package in a secure hardened. The SDK has a set of modules that the issuer can elect to use or provide their own. The intention is not to create a custom development and ensure that the base is simple and modularized to reduce the future support needs. The VDC may be the storefront for distributing the SDK(s). Wallet may create a reference app that may use the modularized SDK to support the smaller issuers as well other markets outside the US. The issuer may control the user experience based on guidelines provided by wallet. Wallet provides guidelines to match the SDK functionality and to ensure consistent user experience and performance. The merchant SDK may have different merchant features. The user experience and the authentication in a merchant SDK is a Wallet standard and all the credentials used for the payment may be Wallet credentials. the plan is to partner with other third parties to enhance the functionality and the value proposition Package. Make it simple, modularize, enhance security, guide and Certify.

FIGS. 2031A-3031I show example user interfaces and a logic flow diagram illustrating wallet overlay on mobile devices (e.g., mobile phones, tablets, etc.) in some embodiments of the Bill Pay. In some embodiments, Wallet may enable a tablet-optimized checkout to help consumers intuitively and seamlessly checkout online on their iPad by leveraging payment platform. The Bill Pay may increase flow conversion through the tablet checkout channel; Increase overall mobile plus tablet transaction volume; Incremental new consumer adoption through the tablet checkout channel. In some implementations, for the current mobile web checkout experience, apply the updates for the mobile (iPhone & iPad) checkout that includes adding a new payment method, checkout details and other UX updates.

In some embodiments, checkout details treatment includes: display the purchase details such as shipping, discount, etc. as an expand/collapse section in the review page. Other features include: I Increase the dimensions of the checkout lightbox for the iPad flow; reduce number of “touches” into fields with auto-next; use a lightbox overlay from the merchant's site for the iPad flow; maintain the checkout window dimensions in both the landscape and portrait modes; enhancements for the visual design and interaction elements. standard handling of the footer UI.

In some embodiments, in addition to the above, additional framework changes to the mobile checkout experience would improve the user experience and funnel conversion for both new and existing Wallet consumers.

In some embodiments, change the initial landing page that currently displays the “Create an Account” and “Sign In” links to the “Log In” page directly. This page also has a “Create an Account” link and is standard with other Web & mobile sites.

In some embodiments, as upon sign-up or login, the consumer may be directed to the Review & Pay page, without any greyed out areas. There they can submit their shipping, payment and billing details in a non-linear flow. If there is no information yet, the consumer can begin adding in their details.

In some embodiments, the ability to add a new payment method during the checkout flow, and be able to select it for the current checkout. The ability to remove a payment method during the checkout flow, which should then be removed from the consumer's wallet.

In some embodiments, as a consumer, I want to be reduce the number of steps and touches when I checkout on my iPad device. Given: A consumer is shopping on the merchant site via their mobile browser on their iPad And: a merchant has integrated and has the Wallet buy widget available on their site. When: the Wallet checkout lightbox is loaded. Then: the consumer should still see the merchant site behind the lightbox for all pages (sign up, log in, payment). And: the spacing and field formats should be optimized for the iPad retina & non-retina displays for all pages (sign up, log in, payment). And: interaction elements (buttons, links, behaviors) use iOS standard experiences for all pages (sign up, log in, payment).

In some embodiments, as s a consumer, I don't want to be shown multiple pages to choose between logging in and signing up. Given: A consumer is shopping on the merchant site via their mobile browser on their iPad. And: a merchant has integrated and has the Wallet buy widget available on their site. When: the Wallet checkout lightbox is loaded. Then: the consumer should be shown a log in page first that may also have a link to sign up.

In some embodiments, as a Wallet consumer, I want to be able to see what information is required and complete checkout non-linearly to provide the required payment information. Given: A consumer is shopping on the merchant site via their mobile browser on their iPad. And: a merchant has integrated and has the Wallet buy widget available on their site. When: the Wallet checkout lightbox is loaded. And: the consumer has either signed up or logged in successfully. Then: the consumer may first be directed to review page to confirm or provide the ship, pay or bill info individually regardless of having a saved profile or not.

In some embodiments, as a Wallet consumer, I want to be able to add new, remove and edit credit cards in my wallet directly from checkout on my iPad device. Given: A consumer is shopping on the merchant site via their mobile browser on their iPad. And: a merchant has integrated and has the Wallet buy widget available on their site. When: the Wallet checkout lightbox is loaded. And: the consumer has either signed up or logged in successfully. Then: the consumer can click from the review page to the Payment Method page to select or make changes to their wallet. And: the consumer can add additional credit cards to their wallet from the Payment Method page. And: the consumer can edit an existing or newly added credit cards in their wallet from the Payment Method page. And: the consumer can remove any existing or newly added credit cards in their wallet from the Payment Method page.

In some embodiments, as a Wallet merchant, I want an optimized mobile experience for my customers who are transacting on my site on their iPad without having to configure a separate mobile tablet configuration. Given: A merchant who has on-boarded and integrated Wallet on their site. And: the merchant has not configured a separate setting to enable mobile. And: a consumer is shopping on the merchant site via their mobile browser on their iPad. When: the consumer touches the Wallet buy widget after adding items to the cart. Then: the checkout lightbox should display as an overlay on top of the merchant site in an iPad-optimized format and UX for both retina & non-retina display through the end-to-end checkout experience.

In some embodiments, on the Review & Pay page, move the checkout details that lists out the Subtotal, Shipping, Gift Wrap, Discount, Misc, Tax info under the total price as an expand/collapse. Originally this was displayed at the bottom of the page, which forced the consumer to look towards the bottom of the review page in order to confirm the appropriate amount. The amount should be the first value for the consumer to confirm their purchase.

In some embodiments, in both landscape and portrait modes, the checkout lightbox should have the same dimensions regardless of orientation. For retina displays on iPhone & iPad, the display may need to be double the resolution for visual assets (“@2×˜ipad” suffix for images).

In some embodiments, for the tablet checkout, the checkout widget should be displayed as a lightbox overlay on top of the merchant checkout. So both in portrait and landscape views, the lightbox should be overlain over the merchant's site. The background should be greyed out in order to call attention to the checkout lightbox.

In some embodiments, the input fields in the checkout light should focus the text field sequentially for the next responder chain through the form fields. The order should go from left-to-right and top-to-bottom. The widget may recognize the user agent as iPad, which would then render the tablet checkout overlay as a lightbox.

In some embodiments, the mobile checkout may use a full page overlay that covers the screen completely. Currently, the links on the review page use a “Change” hyperlink. Replace the hyperlink with the HTML5 mobile standards to make the enter row a link for the Shipping, Payment Method and Billing update functions.

In some embodiments, the current mobile links for the footer are difficult for consumers to open. So instead of the standard Web hyperlinks for the Terms of Service, Privacy Policy and Help, use the HTML5 mobile standards of using the horizontal bar as the footer links.

In some embodiments, for text or mixed-text fields, display the standard keypad by default. For digit-specific fields like the credit card number field, the keypad should use the numeric keypad only to improve the user experience. Images for issuer card art may be loaded and displayed according to the size ratio specifications. The default card art images for other cards should have the “@2×_ipad” suffix. Images should not change their aspect ratio going from non-retina to retina display, or from portrait to landscape orientation.

In some embodiments of the Non-linear Checkout Flow, from the merchant checkout page, the following page that is displayed in the current mobile flow is the Wallet Create/Sign In page. This page is a redundant step that impedes flow conversion through checkout for the tablet experience. Therefore the Wallet Create/Sign In page should be removed and the initial step should just display the Sign In page directly. That page still allows the user to sign up through a single page following clicking the “Create an Account” link from this page.

In some embodiments, the “Review and Continue” page may now be the central page for the Wallet checkout flow. So immediately following sign in or enrollment, the consumer may be directed to the “Review and Continue” page. If the consumer doesn't have any saved info in CS (getShippingDetail and getPaymentProfile), then the fields for shipping, payment method and billing may be blank. If the consumer does have saved info in CS, then the fields may be pre-populated on the “Review and Continue” page. If the non-Paymentcredit card being used has not yet been validated (CVV) and the consumer tries to complete the transaction from the “Review and Continue” page, then the consumer may be directed to update their payment method info. The credit card form fields may be pre-populated (masking the PAN except for the last four digits) and may be greyed-out/disabled. A message may be displayed to the consumer that they need to enter in their CVV in order to validate their credit card.

The field cursor should be on the CVV field in order for the consumer to complete their validation.

In some embodiments, if the first card returned by CS is expired and the consumer tries to complete the transaction from the “Review and Continue” page, then the consumer may be directed to the payment method page to change or add a new payment method. A visual call-out may be displayed to the consumer for cards that are expired in their wallet. The expired card may be greyed-out/disabled from being selectable. The consumer can then go through completing each of the shipping, payment method and billing in a non-linear flow. Upon every submission for add or update to the shipping, payment method or billing pages, the consumer is return back to the “Review and Continue” page where they can complete the transaction.

In some embodiments, when the consumer enters in their shipping address and selects that they want to use the address as their billing for the purchase, then after continuing back to “Review and Continue” page both the shipping and billing fields should have the addresses. And from the “Review and Continue” page, the shipping address should be validated (“validatePurchase”) with CYBS via CS. If there's a mismatch, then the consumer should be displayed with shipping address suggestion page where the consumer can either choose their own shipping or the system suggestion. If the consumer chooses the system suggestion, then they are redirected to the “Review and Continue” page to re-confirm the transaction. Otherwise, the transaction may be submitted for processing. Enabled for US & Canada only at this time.

In some embodiments, the updated Payment Method page should update the UX treatments for the “Back” button, along with the ability to add a new payment method (“+”). From the same page, a button to edit or remove at the top of the page should be presented. To edit, the consumer should click the top edit button, then select the row of the payment method to make the changes (update back to CS). To remove, the consumer should click the top edit button, then touch the “−” icon button to remove the payment from the wallet (update back to CS). If there are no payment methods in the wallet, then the button should be greyed-out/disabled.

FIGS. 2032A-2032U show exemplary embodiments of value added wallet features and interfaces in some embodiments of the Bill Pay. Referring to FIGS. 2032A-32B, in some embodiments, user clicks the card on the left pane and there are no alerts setup for this card. User may see the “Setup Alerts” button for the first time setup. Once the user clicks the “Setup Alerts” button we may present the user with the available settings for that particular service provider. User clicks on the customize view then he may presented with the current ICE alerts. Once user confirms the alert settings he may be presented with his selections and with menu option to either Edit or Turn Off alerts. This is an example of alerts for an external service provider. User clicks the card on the left pane and there are no alerts setup for this card. User may see the “Setup Alerts” button for the first time setup. Once the user clicks the “Setup Alerts” button we may present the user with the available settings for that particular service provider. Notice that the settings are different as provided by the issuer. Once user confirms the alert settings he may be presented with his selections and with menu option to either Edit or Turn Off alerts.

In some embodiments, architecture consists of the following component interactions: ROR (UI); Common Services API (User profile and Payment Instrument); Value Added Services (VAS) for service provider integration.

Referring to FIG. 2032C, VAS may be part of Common Services deployment. VAS API's may be exposed as REST services and UI layer may make the calls directly instead of going through Common Services. VAS may be responsible for all outbound communications with the service provider. ICE adapter may be developed in order to transform the VAS request to the appropriate ICE request to support the existing Alert feature. VAS may be an independent deployable component. Additional adapters may be developed in order support newly on boarded service providers.

Support future offerings from service providers. For example, offers, gift cards, etc. Independently developed and deployable component. Exposes a defined set of API's while hiding the details of the service provider API using adapters. Extensible to support different service providers through the development of adapters. VAS defines the following set of API's.

Subscription

POST {SP_SERVICE_URL}/subscription
DELETE {SP_SERVICE_URL}/subscription

Settings

GET {SP_SERVICE_URL}/settings/user/{CID}
PUT {SP_SERVICE_URL}/settings/user/{CID}

Referring to FIG. 2032D, the sequence diagram describes a happy case scenario for subscription and settings API through VAS.

In some embodiments, and by way of non-limiting examples only, the following terms may be interpreted as following:

| | |
|---|---|
| Service | A category of service (e.g., Alerts, Offers). |
| | Paymentdefines the UI template, UI |
| | configuration schema, and APIs between |
| | the client and wallet and wallet and the |
| | service provider. |
| Service Implementation | An implementation of a service |
| Service Provider | One who implements a service |
| UI Template | Service-specific UI template, |
| UI Configuration Schema | Service-specific configuration template |
| UI Configuration | Configuration Schema-specific data, |
| | specified by Service Provider for a given |
| | Service Implementation |
| Settings | Service-implementation specific |
| Subscription | Notification to Service Provider that user is |
| | using a specific service implementation |
| | and that the user has accepted the latest |
| | version of the Terms and Conditions |
| Terms | An umbrella term denoting Terms and |
| | Conditions, Privacy Policy, Electronic |
| | Notice for a specific Service |
| | Implementation |

In some embodiments, a 3rd party service provider may integrate to Wallet to provide a value-added service (VAS) to a Wallet consumer. Examples of VAS include alerts, offers, and top-up.

FIGS. 2032N-2032U describes embodiments of the interaction between the Wallet consumer and one or more value-add services; the service lifecycle; the relationships between a consumer, her payment instruments, her available services and service providers; the integration framework between Wallet and a service provider; and this integration framework in detail. Referring to FIG. 2032N, in some embodiments, after the Wallet user logs into V.me, she is presented with a list of payment instruments on file. As illustrated below, the user then chooses a card and sees a list of available services for this card. In this case, the chosen card has three available services—alerts, offers, and ATM locator. If the user then chooses the ‘Offers’ service, she is optionally asked to accept terms and conditions, depending on whether she has previously not accepted this or if the terms have changed. After accepting the latest terms and conditions, the user is then able to configure the offers settings. The settings may be service-specific and could potentially also be service provider-specific; Paymentmay attempt to minimize service provider-specific settings, to ensure a consistent user experience across payment instruments for a given service. Once the offers-specific service settings have been configured by the user, she may start to receive offers at the specified email address and phone number. In addition, the user may choose to receive the offers on her Wallet activity wall, which is accessible from both the Wallet web site and the Wallet mobile app. It illustrates an offer received on the user's mobile device.

Referring to FIG. 2032O, in some embodiments, services within the SPI framework have a generic, defined lifecycle. It describes the relationship between user, his payment instruments, services, implementation of these services, and the service providers that implement these services. The Wallet consumer may have multiple payment instruments. There are a set of services associated with each payment instrument. Each of these services (for a given payment instrument) is associated with a service provider; therefore, multiple service providers can provide the same service. When the consumer chooses a payment instrument, she can subscribe to associated service implementations. Because multiple service providers can provide the same service, there may be some differentiation allowed. For each service, Paymentmay define the parameters of differentiation allowed.

Referring to FIG. 2032P, in some embodiments, there may be five main interactions between Wallet and service providers in this integration: 1) Onboarding: onboarding of the service provider and on-boarding of each service implementation that the service provider provides; 2) Subscription to Service: user subscribes to service implementation, when used for the first time or when service version changes; 3) User Settings: retrieving and updating of user settings for a given service implementation; 4) Activity Notification: activity item for a user related to a service implementation; 5) Activity Settings: updating the settings for a specific activity item. Step 3 specifies settings for the service (the offer service for a payment instrument) while step 5 specifies settings for an individual activity item (e.g., acceptance of an received offer). Step 4 enables Wallet to display activity information (e.g., alerts, offers) in a consolidated manner within a single application, where the user may filter and search, while also enabling Wallet to send push notifications to the Wallet mobile application with this activity information (if configured by the user). These five interactions listed above are described in detail in the following sections. Each section describes the interaction with a sequence diagram and a protocol specification. In addition, both Wallet and each service provider maintain different pieces of the data; this data model is described in each of these sections. Finally, communication between Wallet and the service provider needs to be secure.

Onboarding:

Onboarding consists of two phases: Onboarding of the service provider1; Onboarding of each service implementation that the service provider provides. In some embodiments, two-way communication occurs between Wallet and the service provider; therefore, Phase 1 (service provider onboarding) requires that Wallet submits its X509 certificate, generate a service provider ID/password for the service provider, and distribute it. The service provider submits its X509 certificate and Visa-specific ID/password. Phase 2, onboarding of a service implementation, requires that the service provider: implement a specific service; a XML/JSON file containing the UI configuration for the service. This UI configuration is based on the configuration template provided by Payment for this service. See Section [00599] for the template and related configuration data.; SP_SERVICE_URL; version of the service implementation. In some embodiments, the SP_SERVICE_URL is the common URL path for this service implementation. It is generally of this format:

https://{service_provider_hostname}/v{version}/service/{serviceID}

Payment assigns a serviceID for each service onboarded by the service provider. Payment also specifies the VME_HOSTNAME, which indicates the hostname of the Wallet service. FIG. 2032P describes an example sequence diagram.

Data Model: The UI configuration, service version number, Terms and Conditions, X509 certificate, and service invoker ID/password are provided manually by the service provider; they are uploaded into the V.me. Security: The PaymentID and password provided to the service provider are stored in an X500 Directory; the password is stored as a salted hash. The service provider ID/password, given to Paymentby the service provider, are stored in a database; the password is encrypted. The service provider may in turn store the PaymentID/password and service provider ID/password securely. Process: All onboarding information communicated between Paymentand the service provider is done manually, using an offline process. Information received by Paymentmay be validated and uploaded to the Wallet system. The service provider can initially test in the Wallet sandbox, and once ready, migrate to the production system.

Subscription:

The objective of subscription is to (1) link the user between Wallet and the service provider and to (2) convey the acceptance of the required T&C from Wallet to the service provider. When the user first chooses to use a service, Wallet may send a subscribe message to the service provider, providing sufficient information to enable the service provider to link the Wallet account with the service provider's user account.

Before the user creates or updates her user settings, Wallet requests the service provider for the current user settings. If the user has either not enrolled or not accepted the latest version of the Terms and Conditions for the service implementation then a return code to that effect may be provided by the service provider. Based on this status code, Wallet may direct the user to an intermediate screen which displays the Terms and Conditions hosted by the service provider. On acceptance of the Terms and Conditions, a subscription notice is sent from Wallet to the service provider. Once the subscription is accepted by the SP, any subsequent calls to retrieve user settings should be successful.

Subscription occurs via the following REST call from Wallet to the service provider:

POST {SP_SERVICE_URL}/subscription

Unsubscribing occurs via the following REST call from Wallet to the service provider:

DELETE {SP_SERVICE_URL}/subscription

The body contains the following information: vme_user: user-specific Wallet GUID for external usage (EXTERNAL_GUID) service_provider_cid: customer ID (optional, if available to V.me); lastFour: last 4 digits of PAN; name: full name as specified for PAN; termsURL: url of the T&C accepted (optional, only if user is accepting T&Cs); the service should use the timestamp in the header as the time of acceptance

This information enables the service provider to link the EXTERNAL_GUID to the customer record on its side, either via the CID or the last 4 digits of the PAN and the name. Note that the EXTERNAL_GUID sent by Wallet may always be the same for a Wallet user, irrespective of the service to which the user is subscribing.

Here is an example request body:

```
{
  vme_user: “342342”,
  lastFour: “1234”,
  name: “John Smith”
}
```

If the CID is not available, the service provider should use the userid, lastFour and name fields to attempt to identity the user account on its side. The service provider may return the following HTTP status codes: 200 OK—if success linking the accounts 400 Bad Request—if the URL or body could not be understood by the service provider, if the client sent incorrect data, or if the data failed validation 401 Unauthorized—if incorrect credentials sent 404 Not Found—if URL incorrect, including serviced; 406 Not Acceptable—if the only acceptable content types for the client is not supported by the system 412 Precondition Failed—if the service provider could not resolve the user account based on the CID, userid, lastFour and/or name; or, the user has not accepted the latest Terms and Conditions. In this case, the body may contain the code indicating the exact failure. For T&C acceptance precondition failure code, the body of the response may also contain the URL for the Terms and Conditions to be accepted as a precondition. After displaying this T&C and requiring the user to accept the T&C, Wallet may send a new subscription message with the termsURL field to indicate that the user has accepted this specific T&C. code: precondition failure code termsURL: url of the T&C required to be accepted by the user; 415 Unsupported Media Type—if a content type specified is not supported; 500 Internal Server Error—a server problem is preventing it from fulfilling the request

In case of success, the service provider may return HTTP 200 and the CID. The CID is the foreign key that Wallet may use to reference the user when it communicates with the service provider. Therefore, the CID can be any unique key within this service provider's namespace. If it does not have a local key for the user, the service provider can simply return the EXTERNAL_GUID as the CID value in the response and Wallet may use this as the CID value in future communications.

Here is an example response

HTTP/1.1 200 OK
Content-Type: text/json; charset=utf-8
{
service_provider_cid: “12345abc”
}

In case of 20500 Internal Server Error, Wallet may attempt to retry 3 times, before giving up. Data Model: Terms and Condition/Privacy Policy content as well as their acceptance by users may be managed by the service provider. Security: The subscription REST request is sent from Wallet to the service provider. It is over a SSL channel, with two-factor authentication.

User Settings:

This is used by Wallet to retrieve and update service implementation-specific and user-specific settings data from the service provider:

GET {SP_SERVICE_URL}/settings/user/{CID}
PUT {SP_SERVICE_URL}/settings/user/{CID}

The body contains a set of key-value pairs, where the keys correspond to the UI Configuration data specified during the service implementation onboarding process. See Section [00599] for the body schema. The service provider may return the following HTTP status codes: 200 OK—success 400 Bad Request—if the URL or body could not be understood by the service provider, if the client sent incorrect data, or if the data failed validation 401 Unauthorized—if incorrect credentials sent 404 Not Found—if URL incorrect, including service ID or CID 406 Not Acceptable—if the only acceptable content types for the client is not supported by the system 412 Precondition Failed—if the user is not subscribed or has not accepted the latest Terms and Conditions. The body of the response may contain the URL for the Terms and Conditions to be accepted as a precondition. Wallet may send a subscription message (see Section [00567]) to remove the precondition before attempting a retry. code: recondition failure code termsURL: url of the T&C required to be accepted by the user 415 Unsupported Media Type—if a content type specified is not supported 500 Internal Server Error—a server problem is preventing it from fulfilling the request.

In case of success, the service provider returns HTTP 200 OK. For both the GET and the PUT, the response body contains the key-value settings data. In case of 500 error, the Wallet system does NOT retry; instead, it tells the user that the service provider is unavailable. Data Model The settings data is stored at the service provider and is not stored within V.me. This enables the service provider to provide the same service themselves and the consumer may see the same settings from all places (i.e., if a setting is updated on V.me, then that setting update should be reflected in that same service invoked from the service provider directly). Security: The subscription REST request is sent from Wallet to the service provider. It is over a SSL channel, with two-factor authentication. Performance: These calls occur in the user request path; therefore, their performance directly affects the user experience.

Activity Notifications:

Activity notifications are used to convey service activity information to V.me. This is a REST request sent from the service provider to V.me:

POST {VME_HOSTNAME}/vas/v1/service/{serviceID}

The body contains one or more “settings” data. See Section [00599] for the body schema, which contains a series of settings. Settings may have the following attributes:

ACTION can be

| Action | Description |
|---|---|
| POST | For new activity item |
| PUT | For update on an existing activity |
| | item |
| DELETE | Withdrawal of an activity item |

service_provider_cid: Service provider's customer ID, negotiated during subscription activityID: Unique ID within the service provider's namespace for this activity item; each new activity item may have an unique activityID. Here is an example body:

<settings action=“POST” activityID=“3552” service_provider_cid=“231” >
<setting key=“issuerName” value=“Bank of ABC”/>
<setting key=“issuerLogo” value=“http://www.boa.com//
BANK_america.jpg”/>
<setting key=“offLogo” value=“http://www.safeway.com/offers/logo.gif”/>
<setting key=“off” value=“Earn 15% Cash Back on all Dairy products”/>
<setting key=“exp” value=“2012-07-16T19:20:30” type=DATE/>
<setting key=“acc” value=“unaccepted”/>
<settings>

Wallet may return the following HTTP status codes: 200 OK; 400 Bad Request—if the URL or body could not be understood by V.me, if the client sent incorrect data, or if the data failed validation; 401 Unauthorized—if incorrect credentials sent; 404 Not Found—if URL incorrect, including serviced; 406 Not Acceptable—if the only acceptable content types for the client is not supported by the system; 415 Unsupported Media Type—if a content type specified is not supported; 500 Internal Server Error—a server problem is preventing it from fulfilling the request; In case of 500 Internal Server Error, it is up to the service provider whether it wants to retry a few times before giving up.

Alternative Pull Model:

In case the service provider cannot send activity notifications to V.me, Wallet can be configured to periodically poll the service provider to fetch this data. In this case, Wallet may invoke the following REST call:

GET {SP_SERVICE_URL}/activity/service/{serviceID}

The service provider may return the following HTTP status codes: 200 OK 400 Bad Request—if the URL or body could not be understood by V.me, if the client sent incorrect data, or if the data failed validation 401 Unauthorized—if incorrect credentials sent 404 Not Found—if URL incorrect, including serviced 406 Not Acceptable—if the only acceptable content types for the client is not supported by the system 415 Unsupported Media Type—if a content type specified is not supported 500 Internal Server Error—a server problem is preventing it from fulfilling the request. In case of success, the service provider may return an array of “activity” elements, each containing the following common attributes and child settings that are identical to the push model. In case of 500 Internal Server Error, Wallet may not retry until the next period. Data Model: All activity notification information sent to Wallet is stored in the Wallet database. This data is used for push notifications to mobile devices and for activity feed information.

Protocol:

All communication between Wallet and the service provider is over REST with JSON or XML content. SSL is used for channel security. In addition, two factor authentication is utilized for every request, with one factor being the SSL certificate and the other an ID/password. This information is exchanged during service provider onboarding. The request may have the following headers: For HTTP Basic authentication, the Authorization field is used to convey ID/password credentials. For the authorization string, the ID is followed by a colon and the password for this pair. The resulting string is encoded with the Base64 algorithm. The server may respond with a 401 Unauthorized if the authorization header is not specified.

Authorization: Basic QWxhZGRpbjpvcGVuIHNlc2FtZQ==

Content Type/Length—Several content types are supported for the request message body—XML, JSON, NVP. The server may respond with a 415 Unsupported Media Type if the content type is unacceptable. The content length is optional.

Content-Type: application/json

Content-Length: 311

Accept Type—specifies the preferred response format. XML and JSON are acceptable. It may respond with a 406 Not Acceptable if the accept type only specifies other formats.

Accept: text/xml; application/json; application/soap+xml

Keep Alive: To minimize connection costs between the service provider and V.me, it is recommended that the service provider use HTTP keep-alive connections when connecting to Wallet and that it support HTTP keep-alive connections when Wallet connects to it.

Internationalization: Everything may be encoded in UTF-8. Text may be displayed without automatic conversion.

UI Template Framework:

To display user settings and activity wall data, a templating approach may be used. The templating framework contains three parts: Template—consisting of HTML, CSS, JS; SP-specific configuration—consisting of XML/JSON, User-specific data—consisting of XML/JSON.

Template: A template is constructed using HTML, CSS, JS and contains variables that may be filled in either by the SP-specific configuration or the user-specific data. The fonts and placement of the data is controlled by the template. Here is an example template: FIG. 2032T.

In this template, some text is built into the template and is shown above. For the remaining text strings and input boxes, variables are specified, which can be filled. Each variable, denoted as a key, may be unique within the template. Validation rules for each input box may also be specified here.

Template Configuration Schema

The schema to define the template is specified below:

| | | |
|---|---|---|
| settings | | Outermost element. Attributes include spi_id to specify |
| | | it is service-provider specific, service_provider_cid |
| | | to specify it is user-specific, activity_ID to specify it |
| | | is an activity item specific. The attribute ‘action’ |
| | | indicates whether it is a POST (new) (default), PUT |
| | | (update), or DELETE (removal). |
| locale | | Child of ‘settings’, indicates the applicable locale; |
| | | contains one or more ‘setting’ elements to indicate these |
| | | settings are locale-specific |
| | coun- | 3-digit country code |
| | try | |
| | lang | 2-digit language code |
| setting | | Element may either appear as child of ‘settings’ or |
| | | ‘locale’; if child of ‘settings’, then it is a global setting |
| | | whereas if child of ‘locale’, then it is a locale-specific |
| | | setting |
| | ID | If this setting is referred by another setting (optional); the |
| | | ID may be unique within the service provider's |
| | | namespace |
| | key | key (this corresponds to the variables defined in the |
| | | template) |
| | value | Literal value for the key (optional) |
| | refID | Reference value for the key (optional) |
| | type | Type of value; for a reference value, the type is inferred |
| | | from the type specified in the reference. For literal |
| | | values, if not specified, then type STRING is assumed. |

The configuration data may be specified at the V.me, service provider, user level, or activity item level, based on settings attributes.

Service Provider-Specific Configuration:

Each service provider that chooses to use the template above may specify a configuration file that can fill in service provider-specific strings. In the above template example, all the variables on the left are static strings that should be specified in this configuration file (the variables on the right are user-specific settings data). This is a partial example configuration, in XML, for three of the variables in the template:

```
<?xml version=“1.0” encoding=“UTF-8”?>
<settings spi_id=“abc”>
  <locale country=“840” lang=“en-us”>
    <setting key=“logoURL”
value=“http://www.abcbank.com/images/logo.gif”/>
    <setting key=“TOhead” value=“Transactions over US $”/>
    <setting key=“TOdesc” value=“You'll receive an alert for every
transaction over the amount you set.”/>
    ...
  </locale>
  <locale country=“124” lang=“en-ca”>
    <setting key=“logoURL”
value=“http://www.abcbank.com/images/logo.gif”/>
    <setting key=“TOhead” value=“Transactions over CAN $”/>
    <setting key=“TOdesc” value=“You'll receive an alert for every
transaction over the amount you set.”/>
    ...
  </locale>
  <locale country=“124”lang=“fr-ca”>
    <setting key=“logoURL”
value=“http://www.abcbank.com/images/logo.gif”/>
    <setting key=“TOhead” value=“Transactions sur CAN $”/>
    <setting key=“TOdesc” value=“Vous recevrez une alerte pour
chaque transaction sur le montant que vous définissez.”/>
    ...
  </locale>
</settings>
```

The spi_id attribute indicates it is a service provider implementation-specific configuration. In this example, for English, there is a trivial change between the two countries, in that the “US $” is present for the US and “CAN $” is present for Canada. Additionally, for Canadian French users, the text strings have been translated to French.

User-specific Data: This is a partial example configuration, in XML, for three of the variables in the template:

```
<?xml version=“1.0” encoding=“UTF-8”?>
<settings service_provider_cid=“235”>
    <!-- EMAIL and SMS are predefined constants -->
    <setting ID=“1” type=EMAIL value=“john.smith@yahoo.com” />
    <setting ID=“2” type=SMS value=“6505551212” />
  <paymentInstrument lastFourPAN=“1234”>
      <!- this refers to the email address above -->
    <setting key=“TransactionContacts” refID=“1” />
    <setting key=“TransactionContacts ” refID=“2” />
    <setting key=“DTContacts” refID=“1” />
    <setting key=“DTContacts ” refID=“2” />
    <setting key=“TOamt” value=“50”/>
    <!-this variable is not used in display, but may be used for currency
conversion -->
    <setting key=“TOamtCurrency” value=“US”/>
    </paymentInstrument>
</settings>
```

The service_provider_cid indicates it is user-specific. The refID attribute for the setting elements above associate the alert with the contact. For example the following:

<setting key=“ TransactionContacts” refID=“1” />
<setting key=“ TransactionContacts” refID=“2” />

specifies that for the alert with the key TransactionContacts (relates to Transaction alert in the template provided above) reference ID 1 and 2 (relates to email with address john.smith@yahoo.com and sms for phone number 6505551212) have been selected. The variableSetting specifies any variables necessary for an alert. For example in the above XML, alert with key TOamt (associated with Threshold Over Amount in the template above) represents the minimum value for the alert trigger.

FIG. 2032U shows an example of the display output by combining the template, the service-provider specific configuration and the user-specific settings data.

Activity Item-Specific Data:

An offer or an alert is an example of an activity item. It follows the same template model but the configuration data for this is denoted with a ‘activity_id’ attribute. Since all activity is also user-specific, the service_provider_cid attribute may also be present. If the action attribute is missing, POST is assumed as the default.

For example, FIG. 2032U is an offer activity template; only a few fields are specified here for simplicity. Since the service provider logo is identical for all offers from the same service provider, this information may be specified once and uploaded into Wallet by the service provider during onboarding; hence only a “spi_id” is specified:

<?xml version=“1.0” encoding=“UTF-8”?>
<settings spi_id=“235”>
<setting key=“serviceProviderLogo”
value=“http://www.abcbank.com/images/logo.gif”/>
</settings>

In addition, the offer components that are per-user and per activity item may be specified separately, specifically with “activity_id” and “service_provider_cid” attributes. Therefore, here is a partial example configuration, in XML, for these variables in the template above:

<?xml version=“1.0” encoding=“UTF-8”?>
<settings activity_id=“34525ss” service_provider_cid=“235”>
<setting key=“offerLogo” value=“http://merchant.com/images/logo.gif”/>
<setting key=“expires” value=“2012-07-16T19:20:30” type=DATE/>
</settings>

### Bill Pay Controller

FIG. 26 shows a block diagram illustrating example aspects of a Bill Pay controller 2601. In this embodiment, the Bill Pay controller 2601 may serve to aggregate, process, store, search, serve, identify, instruct, generate, match, and/or facilitate interactions with a computer through various technologies, and/or other related data.

Users, e.g., 2633a, which may be people and/or other systems, may engage information technology systems (e.g., computers) to facilitate information processing. In turn, computers employ processors to process information; such processors 2603 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2629 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the Bill Pay controller 2601 may be connected to and/or communicate with entities such as, but not limited to: one or more users from user input devices 2611; peripheral devices 2612; an optional cryptographic processor device 2628; and/or a communications network 2613. For example, the Bill Pay controller 2601 may be connected to and/or communicate with users, e.g., 2633a, operating client device(s), e.g., 2633b, including, but not limited to, personal computer(s), server(s) and/or various mobile device(s) including, but not limited to, cellular telephone(s), smartphone(s) (e.g., IPhone®, Blackberry®, Android OS-based phones etc.), tablet computer(s) (e.g., Apple IPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Bill Pay controller 2601 may be based on computer systems that may comprise, but are not limited to, components such as: a computer systemization 2602 connected to memory 2629.

### Computer Systemization

A computer systemization 2602 may comprise a clock 2630, central processing unit (“CPU(s)” and/or “processor(s)” (these terms are used interchangeably throughout the disclosure unless noted to the contrary)) 2603, a memory 2629 (e.g., a read only memory (ROM) 2606, a random access memory (RAM) 2605, etc.), and/or an interface bus 2607, and most frequently, although not necessarily, are all interconnected and/or communicating through a system bus 2604 on one or more (mother)board(s) 2602 having conductive and/or otherwise transportive circuit pathways through which instructions (e.g., binary encoded signals) may travel to effectuate communications, operations, storage, etc. The computer systemization may be connected to a power source 2686; e.g., optionally the power source may be internal. Optionally, a cryptographic processor 2626 and/or transceivers (e.g., ICs) 2674 may be connected to the system bus. In another embodiment, the cryptographic processor and/or transceivers may be connected as either internal and/or external peripheral devices 2612 via the interface bus I/O. In turn, the transceivers may be connected to antenna(s) 2675, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing Bill Pay controller to determine its location)); Broadcom BCM4329FKUBG transceiver chip (e.g., providing 802.11n, Bluetooth 2.1+EDR, FM, etc.), BCM28150 (HSPA+) and BCM2076 (Bluetooth 4.0, GPS, etc.); a Broadcom BCM47501UB8 receiver chip (e.g., GPS); an Infineon Technologies X-Gold 618-PMB9800 (e.g., providing 2G/3G HSDPA/HSUPA communications); Intel's XMM 7160 (LTE & DC-HSPA), Qualcom's CDMA (2000), Mobile Data/Station Modem, Snapdragon; and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: floating point units, integer processing units, integrated system (bus) controllers, logic operating units, memory management control units, etc., and even specialized processing sub-units like graphics processing units, digital signal processing units, and/or the like. Additionally, processors may include internal fast access addressable memory, and be capable of mapping and addressing memory 2629 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state/value. The CPU may be a microprocessor such as: AMD's Athlon, Duron and/or Opteron; ARM's classic (e.g., ARM7/9/11), embedded (Coretx-M/R), application (Cortex-A), embedded and secure processors; IBM and/or Motorola's DragonBall and PowerPC; IBM's and Sony's Cell processor; Intel's Atom, Celeron (Mobile), Core (2/Duo/i3/i5/i7), Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code). Such instruction passing facilitates communication within the Bill Pay controller and beyond through various interfaces. Should processing requirements dictate a greater amount speed and/or capacity, distributed processors (e.g., Distributed Bill Pay), mainframe, multi-core, parallel, and/or super-computer architectures may similarly be employed. Alternatively, should deployment requirements dictate greater portability, smaller mobile devices (e.g., smartphones, Personal Digital Assistants (PDAs), etc.) may be employed.

Depending on the particular implementation, features of the Bill Pay may be achieved by implementing a microcontroller such as CAST's R8051XC2 microcontroller; Intel's MCS 51 (i.e., 8051 microcontroller); and/or the like. Also, to implement certain features of the Bill Pay, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the Bill Pay component collection (distributed or otherwise) and/or features may be implemented via the microprocessor and/or via embedded components; e.g., via ASIC, coprocessor, DSP, FPGA, and/or the like. Alternately, some implementations of the Bill Pay may be implemented with embedded components that are configured and used to achieve a variety of features or signal processing.

Depending on the particular implementation, the embedded components may include software solutions, hardware solutions, and/or some combination of both hardware/software solutions. For example, Bill Pay features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the Bill Pay features. A hierarchy of programmable interconnects allow logic blocks to be interconnected as needed by the Bill Pay system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the Bill Pay may be developed on regular FPGAs and then migrated into a fixed version that more resembles ASIC implementations. Alternate or coordinating implementations may migrate Bill Pay controller features to a final ASIC instead of or in addition to FPGAs. Depending on the implementation all of the aforementioned embedded components and microprocessors may be considered the “CPU” and/or “processor” for the Bill Pay.

### Power Source

The power source 2686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2686 is connected to at least one of the interconnected subsequent components of the Bill Pay thereby providing an electric current to all the interconnected components. In one example, the power source 2686 is connected to the system bus component 2604. In an alternative embodiment, an outside power source 2686 is provided through a connection across the I/O 2608 interface. For example, a USB and/or IEEE 1394 connection carries both data and power across the connection and is therefore a suitable source of power.

### Interface Adapters

Interface bus(ses) 2607 may accept, connect, and/or communicate to a number of interface adapters, frequently, although not necessarily in the form of adapter cards, such as but not limited to: input output interfaces (I/O) 2608, storage interfaces 2609, network interfaces 2610, and/or the like. Optionally, cryptographic processor interfaces 2627 similarly may be connected to the interface bus. The interface bus provides for the communications of interface adapters with one another as well as with other components of the computer systemization. Interface adapters are adapted for a compatible interface bus. Interface adapters may connect to the interface bus via expansion and/or slot architecture. Various expansion and/or slot architectures may be employed, such as, but not limited to: Accelerated Graphics Port (AGP), Card Bus, ExpressCard, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), Thunderbolt, and/or the like.

Storage interfaces 2609 may accept, communicate, and/or connect to a number of storage devices such as, but not limited to: storage devices 2614, removable disc devices, and/or the like. Storage interfaces may employ connection protocols such as, but not limited to: (Ultra) (Serial) Advanced Technology Attachment (Packet Interface) ((Ultra) (Serial) ATA (PI)), (Enhanced) Integrated Drive Electronics ((E)IDE), Institute of Electrical and Electronics Engineers (IEEE) 1394, Ethernet, fiber channel, Small Computer Systems Interface (SCSI), Thunderbolt, Universal Serial Bus (USB), and/or the like.

Network interfaces 2610 may accept, communicate, and/or connect to a communications network 2613. Through a communications network 2613, the Bill Pay controller is accessible through remote clients 2633b (e.g., computers with web browsers) by users 2633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed Bill Pay), architectures may similarly be employed to pool, load balance, and/or otherwise increase the communicative bandwidth required by the Bill Pay controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2610 may be used to engage with various communications network types 2613. For example, multiple network interfaces may be employed to allow for the communication over broadcast, multicast, and/or unicast networks.

Input Output interfaces (I/O) 2608 may accept, communicate, and/or connect to user input devices 2611, peripheral devices 2612, cryptographic processor devices 2628, and/or the like. I/O may employ connection protocols such as, but not limited to: audio: analog, digital, monaural, RCA, stereo, and/or the like; data: Apple Desktop Bus (ADB), Bluetooth, IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, DisplayPort, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may be a video display, which may take the form of a Cathode Ray Tube (CRT), Liquid Crystal Display (LCD), Light Emitting Diode (LED), Organic Light Emitting Diode (OLED), Plasma, and/or the like based monitor with an interface (e.g., VGA, DVI circuitry and cable) that accepts signals from a video interface. The video interface composites information generated by a computer systemization and generates video signals based on the composited information in a video memory frame. Another output device is a television set, which accepts signals from a video interface. Often, the video interface provides the composited video information through a video connection interface that accepts a video display interface (e.g., an RCA composite video connector accepting an RCA composite video cable; a DVI connector accepting a DVI display cable, HDMI, etc.).

User input devices 2611 often are a type of peripheral device 2612 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 2612 may be connected and/or communicate to I/O and/or other facilities of the like such as network interfaces, storage interfaces, directly to the interface bus, system bus, the CPU, and/or the like. Peripheral devices may be external, internal and/or part of the Bill Pay controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 2628), force-feedback devices (e.g., vibrating motors), near field communication (NFC) devices, network interfaces, printers, radio frequency identifiers (RFIDs), scanners, storage devices, transceivers (e.g., cellular, GPS, etc.), video devices (e.g., goggles, monitors, etc.), video sources, visors, and/or the like. Peripheral devices often include types of input devices (e.g., microphones, cameras, etc.).

It should be noted that although user input devices and peripheral devices may be employed, the Bill Pay controller may be embodied as an embedded, dedicated, and/or monitor-less (i.e., headless) device, wherein access would be provided over a network interface connection.

Cryptographic units such as, but not limited to, microcontrollers, processors 2626, interfaces 2627, and/or devices 2628 may be attached, and/or communicate with the Bill Pay controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield (e.g., Solo, Connect, etc.), SafeNet's Luna PCI (e.g., 7100) series; Semaphore Communications' 40 MHz Roadrunner 184; sMIP's (e.g., 208956); Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2629. However, memory is a fungible technology and resource, thus, any number of memory embodiments may be employed in lieu of or in concert with one another. It is to be understood that the Bill Pay controller and/or a computer systemization may employ various forms of memory 2629. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In one configuration, memory 2629 may include ROM 2606, RAM 2605, and a storage device 2614. A storage device 2614 may employ any number of computer storage devices/systems. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2629 may contain a collection of program and/or database components and/or data such as, but not limited to: operating system component(s) 2615 (operating system); information server component(s) 2616 (information server); user interface component(s) 2617 (user interface); Web browser component(s) 2618 (Web browser); database(s) 2619; mail server component(s) 2621; mail client component(s) 2622; cryptographic server component(s) 2620 (cryptographic server); the Bill Pay component(s) 2635; UE Component 2642, CP Component 2643, PI Component 2647, UPC Component 2649, PTA 2651, PTC Component 2652, TDA Component 2653, DCR Component 2641c, WBP Component 2642c, WG Component 2643c, WIC Component 2644c, RSAV Component 2645c, PSW Component 2646c, BWD Component 2647c, the account creation and management (ACM) component 2641b; the Prefill component 2642b; Wallet Enrollment Component 2643b; multi-directional wallet connector (MDWC) component 2644b; Mobile Wallet Overlay (“MWO”) 2645b; Wallet Alert Interactions (“WAI)) component 2646b; Wallet View Payment (“WVP”) component 2647b; Wallet User Subscription (“WUS”) component 2648b; Wallet Alert Settings (“WAS”) component 2649b; Wallet Subscription Alert (“WSA”) component 2650b; Wallet Saves Alert Setting (“WSAS”) component 2651b; Wallet Get Alert (“WGA”) component 2652b; Wallet Client Saves Alert (“WCSA”) component 2653b; VAS Life Cycle (“VASLC”) component 2654b; VAS Onboarding (“VASO”) component 2655b; VAS Subscription (“VASS”) component 2656b; VAS User Settings (“VASUS”) component 2657b; VAS Activity Notifications (“VASAN”) component 2658b, and/or the like (i.e., collectively a component collection). These components may be stored and accessed from the storage devices and/or from storage devices accessible through an interface bus. Although non-conventional program components such as those in the component collection may be stored in a local storage device 2614, they may also be loaded and/or stored in memory such as: peripheral devices, RAM, remote storage facilities through a communications network, ROM, various forms of memory, and/or the like.

### Operating System

The operating system component 2615 is an executable program component facilitating the operation of the Bill Pay controller. The operating system may facilitate access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. In addition, emobile operating systems such as Apple's iOS, Google's Android, Hewlett Packard's WebOS, Microsofts Windows Mobile, and/or the like may be employed. Any of these operating systems may be embedded within the hardware of the NICK controller, and/or stored/loaded into memory/storage. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Bill Pay controller to communicate with other entities through a communications network 2613. Various communication protocols may be used by the Bill Pay controller as a subcarrier transport mechanism for interaction, such as, but not limited to: multicast, TCP/IP, UDP, unicast, and/or the like.

### Information Server

An information server component 2616 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Apple's iMessage, Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Bill Pay controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Bill Pay database 2619, operating systems, other program components, user interfaces, Web browsers, and/or the like.

Access to the Bill Pay database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Bill Pay. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Bill Pay as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua and iOS's Cocoa Touch, IBM's OS/2, Google's Android Mobile UI, Microsoft's Windows 2000/2003/3.1/95/98/CE/Millenium/Mobile/NT/XP/Vista/7/8 (i.e., Aero, Metro), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery (UI), MooTools, Prototype, script.aculo.us, SWFObject, Yahoo! User Interface, any of which may be used and) provide a baseline and means of accessing and displaying information graphically to users.

A user interface component 2617 is a stored program component that is executed by a CPU. The user interface may be a graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2618 is a stored program component that is executed by a CPU. The Web browser may be a hypertext viewing application such as Goofle's (Mobile) Chrome, Microsoft Internet Explorer, Netscape Navigator, Apple's (Mobile) Safari, embedded web browser objects such as through Apple's Cocoa (Touch) object class, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Chrome, FireFox, Internet Explorer, Safari Plug-in, and/or the like APIs), and/or the like. Web browsers and like information access tools may be integrated into PDAs, cellular telephones, smartphones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly effect the obtaining and the provision of information to users, user agents, and/or the like from the Bill Pay equipped nodes. The combined application may be nugatory on systems employing standard Web browsers.

### Mail Server

A mail server component 2621 is a stored program component that is executed by a CPU 2603. The mail server may be an Internet mail server such as, but not limited to Apple's Mail Server (3), dovect, sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the Bill Pay.

Access to the Bill Pay mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2622 is a stored program component that is executed by a CPU 2603. The mail client may be a mail viewing application such as Apple (Mobile) Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2620 is a stored program component that is executed by a CPU 2603, cryptographic processor 2626, cryptographic processor interface 2627, cryptographic processor device 2628, and/or the like. Cryptographic processor interfaces will allow for expedition of encryption and/or decryption requests by the cryptographic component; however, the cryptographic component, alternatively, may run on a CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Bill Pay may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the Bill Pay component to engage in secure transactions if so desired. The cryptographic component facilitates the secure accessing of resources on the Bill Pay and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Bill Pay Database

The Bill Pay database component 2619 may be embodied in a database and its stored data. The database is a stored program component, which is executed by the CPU; the stored program component portion configuring the CPU to process the stored data. The database may be any of a number of fault tolerant, relational, scalable, secure databases, such as DB2, MySQL, Oracle, Sybase, and/or the like. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Bill Pay database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the Bill Pay database is implemented as a data-structure, the use of the Bill Pay database 2619 may be integrated into another component such as the Bill Pay component 2635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2619 includes several tables 2619a-o. A Users table 2619a may include fields such as, but not limited to: user_id, ssn, dob, first_name, last_name, age, state, address_firstline, address_secondline, zipcode, devices_list, contact_info, contact_type, alt_contact_info, alt_contact_type, and/or the like. The Users table may support and/or track multiple entity accounts on a Bill Pay. A Devices table 2619b may include fields such as, but not limited to: device_ID, device_name, device_IP, device_GPS, device_MAC, device_serial, device_ECID, device_UDID, device_browser, device_type, device_model, device_version, device_OS, device_apps_list, device_securekey, wallet_app_installed_flag, and/or the like. An Apps table 2619c may include fields such as, but not limited to: app_ID, app_name, app_type, app_dependencies, app_access_code, user_pin, and/or the like. An Accounts table 2619d may include fields such as, but not limited to: account_number, account_security_code, account_name, issuer_acquirer_flag, issuer_name, acquirer_name, account_address, routing_number, access_API_call, linked_wallets_list, and/or the like. A Merchants table 2619e may include fields such as, but not limited to: merchant_id, merchant_name, merchant_address, store_id, ip_address, mac_address, auth_key, port_num, security_settings_list, and/or the like. An Issuers table 2619f may include fields such as, but not limited to: issuer_id, issuer_name, issuer_address, ip_address, mac_address, auth_key, port_num, security_settings_list, and/or the like. An Acquirers table 2619g may include fields such as, but not limited to: account_firstname, account_lastname, account_type, account_num, account_balance_list, billingaddress_liner, billingaddress_line2, billing_zipcode, billing_state, shipping_preferences, shippingaddress_line1, shippingaddress_line2, shipping_zipcode, shipping_state, and/or the like. A Pay Gateways table 2619h may include fields such as, but not limited to: gateway_ID, gateway_IP, gateway_MAC, gateway_secure_key, gateway_access_list, gateway_API_call_list, gateway_services_list, and/or the like. A Shop Sessions table 2619i may include fields such as, but not limited to: user_id, session_id, alerts_URL, timestamp, expiry_lapse, merchant_id, store_id, device_type, device_ID, device_IP, device_MAC, device_browser, device_serial, device_ECID, device_model, device_OS, wallet_app_installed, total_cost, cart_ID_list, product_params_list, social_flag, social_message, social_networks_list, coupon_lists, accounts_list, CVV2_lists, charge_ratio_list, charge_priority_list, value_exchange_symbols_list, bill_address, ship_address, cloak_flag, pay_mode, alerts_rules_list, and/or the like. A Transactions table 2619j may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, account_priority account_ratio, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. A Batches table 2619k may include fields such as, but not limited to: batch_id, transaction_id_list, timestamp_list, cleared_flag_list, clearance_trigger settings, and/or the like. A Ledgers table 2619l may include fields such as, but not limited to: request_id, timestamp, deposit_amount, batch_id, transaction_id, clear_flag, deposit_account, transaction_summary, payor_name, payor_account, and/or the like. A Products table 2619m may include fields such as, but not limited to: product_ID, product_title, product_attributes_list, product_price, tax_info_list, related_products_list, offers_list, discounts_list, rewards_list, merchants_list, merchant_availability_list, and/or the like. A Bills table 2619m may include fields such as, but not limited to: bill_ID, bill_title, bill_user_id, biller_merchant_id, bill_barcode, bill_amount, bill_term, bill_description, Bill Payment option, and/or the like. A Portal table 26190 may include fields such as, but not limited to portal_id, portal_ip, portal_type, portal_widget, portal_url, portal_host_url, portal_merchant_id, portal_api, portal_format_list, and/or the like. A SCCA table 2619p may include fields such as SCCA_PAN, SCCA_user_ID, SCCA_issuer ID, SCCA_balance, SCCA_deadline, SCCA_num_payments, SCCA_num_installments, SCCA_min_installment, SCCA_fee.

In one embodiment, the Bill Pay database may interact with other database systems. For example, employing a distributed database system, queries and data access by search Bill Pay component may treat the combination of the Bill Pay database, an integrated data security layer database as a single database entity.

In one embodiment, user programs may contain various user interface primitives, which may serve to update the Bill Pay. Also, various accounts may require custom database tables depending upon the environments and the types of clients the Bill Pay may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2619a-o. The Bill Pay may be configured to keep track of various settings, inputs, and parameters via database controllers.

The Bill Pay database may communicate to and/or with other components in a component collection, including itself, and/or facilities of the like. Most frequently, the Bill Pay database communicates with the Bill Pay component, other program components, and/or the like. The database may contain, retain, and provide information regarding other nodes and data.

### The Bill Pays

The Bill Pay component 2635 is a stored program component that is executed by a CPU. In one embodiment, the Bill Pay component incorporates any and/or all combinations of the aspects of the Bill Pay discussed in the previous figures. As such, the Bill Pay affects accessing, obtaining and the provision of information, services, transactions, and/or the like across various communications networks. The features and embodiments of the Bill Pay discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the Bill Pay's features and facilities, and in many cases reduce the costs, energy consumption/requirements, and extend the life of Bill Pay's underlying infrastructure; this has the added benefit of making the Bill Pay more reliable. Similarly, many of the features and mechanisms are designed to be easier for users to use and access, thereby broadening the audience that may enjoy/employ and exploit the feature sets of the Bill Pay; such ease of use also helps to increase the reliability of the Bill Pay. In addition, the feature sets include heightened security as noted via the Cryptographic components 2620, 2626, 2628 and throughout, making access to the features and data more reliable and secure.

The Bill Pay component may transform user bill payment request message (e.g., see 205a-c in FIG. 2A, etc.) via Bill Pay components such as user enrollment 2042, card processing 2043, portal interface 2047 and/or the like into transaction bill payment transaction settlements, and/or the like and use of the Bill Pay. In one embodiment, the Bill Pay component takes inputs (e.g., user payment request via various Bill-Pay portals, 205a-c in FIG. 2A etc.; checkout request 1411; product data 1415; wallet access input 1611; transaction authorization input 1614; payment gateway address 1618; payment network address 1622; issuer server address(es) 1625; funds authorization request(s) 1626; user(s) account(s) data 1628; batch data 1812; payment network address 1816; issuer server address(es) 1824; individual payment request 1825; payment ledger, merchant account data 1831; and/or the like) etc., and transforms the inputs via various components (e.g., bill payment processing in FIGS. 3A-B; UPC 2649; PTA 2651; PTC 2652; TDA 2653 and/or the like), into outputs (e.g., fund transfer receipt 239 in FIG. 2E; checkout request message 1413; checkout data 1417; card authorization request 1616, 1623; funds authorization response(s) 1630; transaction authorization response 1632; batch append data 1634; purchase receipt 1635; batch clearance request 1814; batch payment request 1818; transaction data 1820; individual payment confirmation 1828, 1829; updated payment ledger, merchant account data 1833; and/or the like).

The Bill Pay transforms inputs such as user accounts 2619a, issuers 2619k, prefills 2519p, payment cards 2519e and others using the account creation and management (ACM) component 2641b; the Prefill component 2642b; Wallet Enrollment Component 2643b; multi-directional wallet connector (MDWC) component 2644b; Mobile Wallet Overlay (“MWO”) 2645b; Wallet Alert Interactions (“WAI)) component 2646b; Wallet View Payment (“WVP”) component 2647b; Wallet User Subscription (“WUS”) component 2648b; Wallet Alert Settings (“WAS”) component 2649b; Wallet Subscription Alert (“WSA”) component 2650b; Wallet Saves Alert Setting (“WSAS”) component 2651b; Wallet Get Alert (“WGA”) component 2652b; Wallet Client Saves Alert (“WCSA”) component 2653b; VAS Life Cycle (“VASLC”) component 2654b; VAS Onboarding (“VASO”) component 2655b; VAS Subscription (“VASS”) component 2656b; VAS User Settings (“VASUS”) component 2657b; VAS Activity Notifications (“VASAN”) component 2658b; into Wallet 202519h, Wallet accounts 202519j and Prefills 2025190 outputs.

The Bill Pay component may transform social application widget checkout requests, and/or the like and use theBill Pay. In one embodiment, the Bill Pay component 2635 takes inputs (e.g., widget designer request 10206, widget merchant content update request 10207, social application data request 10213, social checkout widget assembly request 10212, registration information 101605, Bill Pay tags and parameters 101630, buy widget click 101805, payment information 101825, and/or the like), and transforms the inputs via various components (e.g., DCR Component 2641c, WBP Component 2642c, WG Component 2643c, WIC Component 2644c, RSAV Component 2645c, PSW Component 2646c, BWD Component 2647c, and/or the like) into outputs (e.g., widget designer response 10210, social checkout widget assembly response 10217, social checkout widget application injection 10216, widget designer response 10210, registration request 101610, deploy code request 101635, lightbox request 101810, purchase request 101830, and/or the like).

The Bill Pay component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery (UI); MooTools; Prototype; script.aculo.us; Simple Object Access Protocol (SOAP); SWFObject; Yahoo! User Interface; and/or the like), WebObjects, and/or the like. In one embodiment, the Bill Pay server employs a cryptographic server to encrypt and decrypt communications. The Bill Pay component may communicate to and/or with other components in a component collection, including itself, and/or facilities of the like. Most frequently, the Bill Pay component communicates with the Bill Pay database, operating systems, other program components, and/or the like. The Bill Pay may contain, communicate, generate, obtain, and/or provide program component, system, user, and/or data communications, requests, and/or responses.

### Distributed Bill Pays

The structure and/or operation of any of the Bill Pay node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the Bill Pay controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c-post http:// Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the Bill Pay controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of message
do {
  $input = “”;
  $input = socket_read($client, 1024);
  $data .= $input;
} while($input != “”);
// parse data to extract variables
$obj = json_decode($data, true);
// store input data in a database
mysql_connect(“201.408.185.132”,$DBserver,$password); // access database
server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/
v2r1/Index.jsp?topic=/com.ibm
.IBMDI.doc/referenceguide295.htm

and other parser implementations:

http://publib.boulder.ibm.com/infocenter/tivihelp/
v2r1/index.jsp?topic=/com.ibm
.IBMDI.doc/referenceguide259.htm

all of which are hereby expressly incorporated by reference herein.

In order to address various issues and advance the art, the entirety of this application for REMOTE PORTAL BILL PAYMENT PLATFORM APPARATUSES, METHODS AND SYSTEMS APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various example embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, processors, services, servers, and/or the like that may execute asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations-in-part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a Bill Pay individual and/or enterprise user, database configuration and/or relational model, data type, data transmission and/or network framework, syntax structure, and/or the like, various embodiments of the Bill Pay may be implemented that allow a great deal of flexibility and customization. For example, aspects of the Bill Pay may be adapted for a virtual shopping assistant, etc. While various embodiments and discussions of the Bill Pay have been directed to remote bill payment, however, it is to be understood that the embodiments described herein may be readily configured and/or customized for a wide variety of other applications and/or implementations.

What is claimed is:

1. A bill payment apparatus, comprising:
a processor; and
a memory disposed in communication with the processor and storing processor-executable instructions to:
obtain a transaction payment postponement request from a user;
wherein the transaction payment postponement request is for postponing a part of a bill; and
wherein the part of the bill is at least one particular item in the bill;
obtain user-provided postponement criteria;
wherein the user-provided postponement criteria includes the temporary postponement payment account balance value repayment period length;
calculate estimated time of repayment score (ETA score);
wherein the ETA score is calculated based on the total repayment period length of all of the user's existing temporary postponement payment accounts; and
provide for display user-controlled ETA score recalculations based on the user's postponement criteria;
calculate for the user a transaction payment postponement offer based on the user-provided postponement criteria;
provide to the user the transaction payment postponement offer;
obtain authorization for creation of a temporary postponement payment account;
generate via a processor a temporary postponement payment account for the user;
update the temporary postponement payment account with a balance value equivalent to a user-specified postponement payment amount;
receive from the user at least one payment for the temporary postponement payment account balance value;
reduce the value of the balance value based on the at least one payment; and
expire the temporary postponement payment account if the balance value reaches zero;
wherein expiring the temporary postponement payment account comprises deleting the account.

2. A bill payment apparatus, comprising:
a processor; and
a memory disposed in communication with the processor and storing processor-executable instructions to:
obtain a transaction payment postponement request from a user;
obtain user-provided postponement criteria;
calculate for the user a transaction payment postponement offer based on the user-provided postponement criteria;
provide to the user the transaction payment postponement offer;
obtain authorization for creation of a temporary postponement payment account;
generate via a processor a temporary postponement payment account for the user; and
update the temporary postponement payment account with a balance value equivalent to a user-specified postponement payment amount.

3. The apparatus of claim 2, further comprising instructions to:
receive from the user at least one payment for the temporary postponement payment account balance value;
reduce the value of the balance value based on the at least one payment; and
expire the temporary postponement payment account if the balance value reaches zero.

4. The apparatus of claim 3, wherein expiring the temporary postponement payment account comprises deleting the account.

5. The apparatus of claim 3, wherein expiring the temporary postponement payment account comprises deactivating the account.

6. The apparatus of claim 2, wherein the user-provided postponement criteria includes the magnitude of the temporary postponement payment account balance value.

7. The apparatus of claim 2, wherein the user-provided postponement criteria includes the temporary postponement payment account balance value repayment period length.

8. The apparatus of claim 2, wherein the user-provided postponement criteria includes a number of desired repayments for the temporary postponement payment account balance value.

9. The apparatus of claim 2, further comprising instructions to:
receive updated user-provided postponement criteria based on the transaction payment postponement offer; and
provide to the user an updated transaction payment postponement offer based on the updated user-provided postponement criteria.

10. The apparatus of claim 2, wherein the transaction payment postponement request is obtained during checkout.

11. The apparatus of claim 2, wherein the transaction payment postponement request is obtained after a purchase has been conducted.

12. The apparatus of claim 2, wherein obtaining authorization for creation of a temporary postponement payment account further comprises instructions to:
obtain authorization from an issuer for creation of a virtual Primary Account Number (PAN).

13. The apparatus of claim 12, wherein authorization of the creation of a temporary postponement payment account depends on at least one of:
the user's current credit history;
the quantity of temporary postponement payment account balances associated with the user; and
an amount of total funds owed in all temporary postponement payment account balances associated with the user.

14. The apparatus of claim 2, wherein the transaction payment postponement request is for postponing a part of a bill.

15. The apparatus of claim 14, wherein the part of the bill is at least one particular item in the bill.

16. The apparatus of claim 2, further comprising instructions to:
calculate estimated time of repayment score (ETA score);
wherein the ETA score is calculated based on the total repayment period length of all of the user's existing temporary postponement payment accounts; and
provide for display user-controlled ETA score recalculations based on the user's postponement criteria.

17. A bill payment apparatus, comprising:
a processor; and
a memory disposed in communication with the processor and storing processor-executable instructions to:
generate via a processor a bill payment lightbox for payment of a user's bill to a first billing party;
display the bill payment lightbox for the first billing party on a bill payment portal for a second billing party;
receive an indication to pay at least a portion of the user's bill using the bill payment lightbox; and
forward the indication to pay at least a portion of the user's bill to the first billing party.

18. The apparatus of claim 17, wherein the first and second billing parties are each one of a merchant, issuer, or a financial account provider.

19. The apparatus of claim 17, wherein the indication to pay at least a portion of the user's bill also contains acceptance of a transaction payment postponement offer.

20. A bill payment system, comprising means for:
obtaining a transaction payment postponement request from a user;
wherein the transaction payment postponement request is for postponing a part of a bill; and
wherein the part of the bill is at least one particular item in the bill;
obtaining user-provided postponement criteria;
wherein the user-provided postponement criteria includes the temporary postponement payment account balance value repayment period length;
calculating estimated time of repayment score (ETA score);
wherein the ETA score is calculated based on the total repayment period length of all of the user's existing temporary postponement payment accounts; and
providing for display user-controlled ETA score recalculations based on the user's postponement criteria;
calculating for the user a transaction payment postponement offer based on the user-provided postponement criteria;
providing to the user the transaction payment postponement offer;
obtaining authorization for creation of a temporary postponement payment account;
generating via a processor a temporary postponement payment account for the user;
updating the temporary postponement payment account with a balance value equivalent to a user-specified postponement payment amount;
receiving from the user at least one payment for the temporary postponement payment account balance value;
reducing the value of the balance value based on the at least one payment; and
expiring the temporary postponement payment account if the balance value reaches zero;
wherein expiring the temporary postponement payment account comprises deleting the account.

21. A bill payment system, comprising means for:
obtaining a transaction payment postponement request from a user;
obtaining user-provided postponement criteria;
calculating for the user a transaction payment postponement offer based on the user-provided postponement criteria;
providing to the user the transaction payment postponement offer;
obtaining authorization for creation of a temporary postponement payment account;
generating via a processor a temporary postponement payment account for the user; and
updating the temporary postponement payment account with a balance value equivalent to a user-specified postponement payment amount.

22. The system of claim 21, further comprising:
receiving from the user at least one payment for the temporary postponement payment account balance value;
reducing the value of the balance value based on the at least one payment; and
expiring the temporary postponement payment account if the balance value reaches zero.

23. The system of claim 22, wherein expiring the temporary postponement payment account comprises deleting the account.

24. The system of claim 22, wherein expiring the temporary postponement payment account comprises deactivaing the account.

25. The system of claim 21, wherein the user-provided postponement criteria includes the magnitude of the temporary postponement payment account balance value.

26. The system of claim 21, wherein the user-provided postponement criteria includes the temporary postponement payment account balance value repayment period length.

27. The system of claim 21, wherein the user-provided postponement criteria includes a number of desired repayments for the temporary postponement payment account balance value.

28. The system of claim 21, further comprising:
receiving updated user-provided postponement criteria based on the transaction payment postponement offer; and
providing to the user an updated transaction payment postponement offer based on the updated user-provided postponement criteria.

29. The system of claim 21, wherein the transaction payment postponement request is obtained during checkout.

30. The system of claim 21, wherein the transaction payment postponement request is obtained after a purchase has been conducted.

31. The system of claim 21, wherein obtaining authorization for creation of a temporary postponement payment account further comprises:
obtaining authorization from an issuer for creation of a virtual Primary Account Number (PAN).

32. The system of claim 31, wherein authorization of the creation of a temporary postponement payment account depends on at least one of:
the user's current credit history;
the quantity of temporary postponement payment account balances associated with the user; and
an amount of total funds owed in all temporary postponement payment account balances associated with the user.

33. The system of claim 21, wherein the transaction payment postponement request is for postponing a part of a bill.

34. The system of claim 33, wherein the part of the bill is at least one particular item in the bill.

35. The system of claim 21, further comprising:
calculating estimated time of repayment score (ETA score);
wherein the ETA score is calculated based on the total repayment period length of all of the user's existing temporary postponement payment accounts; and
providing for display user-controlled ETA score recalculations based on the user's postponement criteria.

36. A bill payment system, comprising means for:
generating via a processor a bill payment lightbox for payment of a user's bill to a first billing party;
displaying the bill payment lightbox for the first billing party on a bill payment portal for a second billing party;
receiving an indication to pay at least a portion of the user's bill using the bill payment lightbox; and
forwarding the indication to pay at least a portion of the user's bill to the first billing party.

37. The system of claim 36, wherein the first and second billing parties are each one of a merchant, issuer, or a financial account provider.

38. The system of claim 36, wherein the indication to pay at least a portion of the user's bill also contains acceptance of a transaction payment postponement offer.

39. A bill payment non-transitory computer-readable medium storing processor-executable instructions, said instructions executable by a processor to:
obtain a transaction payment postponement request from a user;
wherein the transaction payment postponement request is for postponing a part of a bill; and
wherein the part of the bill is at least one particular item in the bill;
obtain user-provided postponement criteria;
wherein the user-provided postponement criteria includes the temporary postponement payment account balance value repayment period length;
calculate estimated time of repayment score (ETA score);
wherein the ETA score is calculated based on the total repayment period length of all of the user's existing temporary postponement payment accounts; and
provide for display user-controlled ETA score recalculations based on the user's postponement criteria;
calculate for the user a transaction payment postponement offer based on the user-provided postponement criteria;
provide to the user the transaction payment postponement offer;
obtain authorization for creation of a temporary postponement payment account;
generate via a processor a temporary postponement payment account for the user;
update the temporary postponement payment account with a balance value equivalent to a user-specified postponement payment amount;
receive from the user at least one payment for the temporary postponement payment account balance value;
reduce the value of the balance value based on the at least one payment; and
expire the temporary postponement payment account if the balance value reaches zero;
wherein expiring the temporary postponement payment account comprises deleting the account.

40. A bill payment non-transitory computer-readable medium storing processor-executable instructions, said instructions executable by a processor to:
obtain a transaction payment postponement request from a user;
obtain user-provided postponement criteria;
calculate for the user a transaction payment postponement offer based on the user-provided postponement criteria;
provide to the user the transaction payment postponement offer;
obtain authorization for creation of a temporary postponement payment account;
generate via a processor a temporary postponement payment account for the user; and
update the temporary postponement payment account with a balance value equivalent to a user-specified postponement payment amount.

41. The medium of claim 40, further comprising instructions to:
receive from the user at least one payment for the temporary postponement payment account balance value;
reduce the value of the balance value based on the at least one payment; and
expire the temporary postponement payment account if the balance value reaches zero.

42. The medium of claim 41, wherein expiring the temporary postponement payment account comprises deleting the account.

43. The medium of claim 41, wherein expiring the temporary postponement payment account comprises deactivaing the account.

44. The medium of claim 40, wherein the user-provided postponement criteria includes the magnitude of the temporary postponement payment account balance value.

45. The medium of claim 40, wherein the user-provided postponement criteria includes the temporary postponement payment account balance value repayment period length.

46. The medium of claim 40, wherein the user-provided postponement criteria includes a number of desired repayments for the temporary postponement payment account balance value.

47. The medium of claim 40, further comprising instructions to:
receive updated user-provided postponement criteria based on the transaction payment postponement offer; and
provide to the user an updated transaction payment postponement offer based on the updated user-provided postponement criteria.

48. The medium of claim 40, wherein the transaction payment postponement request is obtained during checkout.

49. The medium of claim 40, wherein the transaction payment postponement request is obtained after a purchase has been conducted.

50. The medium of claim 40, wherein obtaining authorization for creation of a temporary postponement payment account further comprises instructions to: obtain authorization from an issuer for creation of a virtual Primary Account Number (PAN).

51. The medium of claim 50, wherein authorization of the creation of a temporary postponement payment account depends on at least one of:
the user's current credit history;
the quantity of temporary postponement payment account balances associated with the user; and
an amount of total funds owed in all temporary postponement payment account balances associated with the user.

52. The medium of claim 40, wherein the transaction payment postponement request is for postponing a part of a bill.

53. The medium of claim 52, wherein the part of the bill is at least one particular item in the bill.

54. The medium of claim 40, further comprising instructions to:
calculate estimated time of repayment score (ETA score);
wherein the ETA score is calculated based on the total repayment period length of all of the user's existing temporary postponement payment accounts; and
provide for display user-controlled ETA score recalculations based on the user's postponement criteria.

55. A bill payment non-transitory computer-readable medium storing processor-executable instructions, said instructions executable by a processor to:
generate via a processor a bill payment lightbox for payment of a user's bill to a first billing party;
display the bill payment lightbox for the first billing party on a bill payment portal for a second billing party;
receive an indication to pay at least a portion of the user's bill using the bill payment lightbox; and
forward the indication to pay at least a portion of the user's bill to the first billing party.

56. The medium of claim 55, wherein the first and second billing parties are each one of a merchant, issuer, or a financial account provider.

57. The medium of claim 55, wherein the indication to pay at least a portion of the user's bill also contains acceptance of a transaction payment postponement offer.

58. A processor-implemented bill payment method, comprising:
obtaining a transaction payment postponement request from a user;
wherein the transaction payment postponement request is for postponing a part of a bill; and
wherein the part of the bill is at least one particular item in the bill;
obtaining user-provided postponement criteria;
wherein the user-provided postponement criteria includes the temporary postponement payment account balance value repayment period length;
calculating estimated time of repayment score (ETA score);
wherein the ETA score is calculated based on the total repayment period length of all of the user's existing temporary postponement payment accounts; and
providing for display user-controlled ETA score recalculations based on the user's postponement criteria;
calculating for the user a transaction payment postponement offer based on the user-provided postponement criteria;
providing to the user the transaction payment postponement offer;
obtaining authorization for creation of a temporary postponement payment account;
generating via a processor a temporary postponement payment account for the user;
updating the temporary postponement payment account with a balance value equivalent to a user-specified postponement payment amount;
receiving from the user at least one payment for the temporary postponement payment account balance value;
reducing the value of the balance value based on the at least one payment; and
expiring the temporary postponement payment account if the balance value reaches zero;
wherein expiring the temporary postponement payment account comprises deleting the account.

59. A processor-implemented bill payment method, comprising:
obtaining a transaction payment postponement request from a user;
obtaining user-provided postponement criteria;
calculating for the user a transaction payment postponement offer based on the user-provided postponement criteria;
providing to the user the transaction payment postponement offer;
obtaining authorization for creation of a temporary postponement payment account;
generating via a processor a temporary postponement payment account for the user; and
updating the temporary postponement payment account with a balance value equivalent to a user-specified postponement payment amount.

60. The method of claim 59, further comprising:
receiving from the user at least one payment for the temporary postponement payment account balance value;
reducing the value of the balance value based on the at least one payment; and
expiring the temporary postponement payment account if the balance value reaches zero.

61. The method of claim 60, wherein expiring the temporary postponement payment account comprises deleting the account.

62. The method of claim 60, wherein expiring the temporary postponement payment account comprises deactivaing the account.

63. The method of claim 59, wherein the user-provided postponement criteria includes the magnitude of the temporary postponement payment account balance value.

64. The method of claim 59, wherein the user-provided postponement criteria includes the temporary postponement payment account balance value repayment period length.

65. The method of claim 59, wherein the user-provided postponement criteria includes a number of desired repayments for the temporary postponement payment account balance value.

66. The method of claim 59, further comprising:
receiving updated user-provided postponement criteria based on the transaction payment postponement offer; and
providing to the user an updated transaction payment postponement offer based on the updated user-provided postponement criteria.

67. The method of claim 59, wherein the transaction payment postponement request is obtained during checkout.

68. The method of claim 59, wherein the transaction payment postponement request is obtained after a purchase has been conducted.

69. The method of claim 60, wherein obtaining authorization for creation of a temporary postponement payment account further comprises:
obtaining authorization from an issuer for creation of a virtual Primary Account Number (PAN).

70. The method of claim 69, wherein authorization of the creation of a temporary postponement payment account depends on at least one of:
the user's current credit history;
the quantity of temporary postponement payment account balances associated with the user; and
an amount of total funds owed in all temporary postponement payment account balances associated with the user.

71. The method of claim 59, wherein the transaction payment postponement request is for postponing a part of a bill.

72. The method of claim 71, wherein the part of the bill is at least one particular item in the bill.

73. The method of claim 59, further comprising:
calculating estimated time of repayment score (ETA score);
wherein the ETA score is calculated based on the total repayment period length of all of the user's existing temporary postponement payment accounts; and
providing for display user-controlled ETA score recalculations based on the user's postponement criteria.

74. A processor-implemented bill payment method, comprising:
generating via a processor a bill payment lightbox for payment of a user's bill to a first billing party;
displaying the bill payment lightbox for the first billing party on a bill payment portal for a second billing party;
receiving an indication to pay at least a portion of the user's bill using the bill payment lightbox; and
forwarding the indication to pay at least a portion of the user's bill to the first billing party.

75. The method of claim 74, wherein the first and second billing parties are each one of a merchant, issuer, or a financial account provider.

76. The method of claim 74, wherein the indication to pay at least a portion of the user's bill also contains acceptance of a transaction payment postponement offer.
